(19) United States
(12) Patent Application Publication
(10) Pub. No.: US 2025/0110423 A1
(43) Pub. Date: Apr. 3, 2025

(54) TONER CARTRIDGE, DEVELOPING CARTRIDGE, IMAGE FORMING APPARATUS AND TONER DISCHARGING MEMBER

(71) Applicant: CANON KABUSHIKI KAISHA, Tokyo (JP)

(72) Inventors: TETSUO UESUGI, Shizuoka (JP); TOSHIAKI TAKEUCHI, Shizuoka (JP); JOJI GOTO, Shizuoka (JP); NAOKI MAEDA, Shizuoka (JP); TAKAYUKI YADA, Shizuoka (JP); SHIGEMI KAMOSHIDA, Kanagawa (JP); FUMITO NONAKA, Shizuoka (JP); TERUHIKO SASAKI, Shizuoka (JP); TACHIO KAWAI, Tokyo (JP); NORIYUKI KOMATSU, Shizuoka (JP); NAOYA ASANUMA, Shizuoka (JP); AKINOBU HIRAYAMA, Shizuoka (JP); SHUICHI GOFUKU, Shizuoka (JP); TOSHIKI FUJINO, Kanagawa (JP); SATOSHI KOGA, Shizuoka (JP); GO TORII, Kanagawa (JP)

(21) Appl. No.: 18/980,291

(22) Filed: Dec. 13, 2024

Related U.S. Application Data
(63) Continuation of application No. PCT/JP2023/024098, filed on Jun. 22, 2023.

(30) Foreign Application Priority Data
Jun. 24, 2022 (JP) 2022-101481
Oct. 26, 2022 (JP) 2022-171767

(51) Int. Cl. G03G 15/08; G03G 21/12; G03G 21/16

(52) U.S. Cl. CPC G03G 15/0877; G03G 15/0865; G03G 15/0891; G03G 21/12; G03G 21/1652

(57) ABSTRACT

A cartridge includes a frame, a drive input member, a toner feeding member driven based on a driving force received by a coupling and a discharge member having a discharge opening for discharging toner fed by the toner feeding member, to outside of the cartridge. The discharge opening is capable of orienting opposite from a side where the drive input member is provided, in a longitudinal direction of the cartridge.

### FIELD OF THE INVENTION

The present invention relates to an image forming apparatus and a toner cartridge (cartridge) usable with the image forming apparatus, more particularly to a cartridge including a toner discharge member and usable with the image forming apparatus and with an image forming apparatus employing an electrophotographic type process.

### BACKGROUND ART

Conventionally, an electrophotographic image forming apparatus such as a laser (beam) printer is known as image forming apparatus. A cartridge (toner cartridge) which is dismountable (replaceable) from an image forming apparatus and contains toner to be supplied to a developing means such as a developing roller is known.

The supply of the toner from the cartridge to the toner supply destination is carried out by the interaction between the supply passage and the supply opening (discharge opening) provided on both sides. For example, JP 2017-72703 proposes provision of a shutter which is movable between an open position for opening a toner discharge opening of a cartridge and a closed position for closing the toner discharge opening.

### SUMMARY OF THE INVENTION

### Problem to be Solved

An object of the present invention (this disclosure) is to further develop the conventional technology.

### Means for Solving the Problem

In order to achieve the above object, a representative structure of the present application is a toner cartridge detachably mountable to an apparatus main assembly of an image forming apparatus to which a developing cartridge is mountable, the toner cartridge being mountable to the apparatus main assembly by being inserted into the apparatus main assembly in a first direction, the toner cartridge comprising a frame; a cartridge side coupling engageable with a main assembly side coupling provided on the apparatus main assembly, wherein the cartridge side coupling engages with the main assembly side coupling to receive a driving force from the apparatus main assembly in a state that the toner cartridge is mounted to the apparatus main assembly with the developing cartridge mounted to the main assembly; a toner feeding member operable based on the driving force received by the cartridge coupling; and a toner discharge member provided with a discharge opening for discharging toner fed by the toner feeding member to outside of the toner cartridge, wherein the cartridge side coupling is rotatable about a first axis intersecting the first direction, and wherein in a state that the toner cartridge is mounted to the developing cartridge, the discharge opening is capable of discharging the toner to the developing cartridge side in a direction parallel to the first axis away from the cartridge side coupling.

### Effect of the Invention

The present invention (this disclosure) provides further development to the conventional technology.

### BRIEF DESCRIPTION OF THE DRAWINGS

FIG. 1 is a cross-sectional view illustrating a laser printer as an example of the image forming apparatus according to an embodiment of the present invention.

FIG. 2 is a front view of the process cartridge B according to Embodiment 1 of the present invention, showing the state when a process cartridge B is viewed in the X1 direction indicated in FIG. 1.

FIG. 3 is a major sectional view (cross-section taken along a line c-c in FIG. 2) of the structure of the process cartridge B according to Embodiment 1 of the present invention.

FIG. 4 is a cross-sectional view (cross-section taken along a line b-b in FIG. 2) showing a supply opening of the process cartridge B according to Embodiment 1 of the present invention.

FIG. 5 is a cross-sectional view (cross-section taken along line dd in FIG. 2) showing a second waste toner feed passageway 10c of the process cartridge B according to Embodiment 1 of the present invention.

FIG. 6 is an exploded perspective view of the process cartridge B according to Embodiment 1 of the present invention.

FIG. 7 is a view illustrating an example of a contact state and a spaced state of the developing unit 15 with respect to the photosensitive drum 11 according to Embodiment 1 of the present invention.

FIG. 8 is a side view illustrating a non-drive side of the process cartridge B according to Embodiment 1 of the present invention.

FIG. 9 is a front view of the toner cartridge C according to Embodiment 1 of the invention in a mounted state in the printer main assembly A.

FIG. 10 is a major cross-sectional view (cross-section taken along a line e-e in FIG. 9) of the toner accommodating portion 30 of the toner cartridge C according to Embodiment 1 of the present invention.

FIG. 11 is an exploded perspective view of the toner cartridge C according to Embodiment 1 of the present invention, as viewed from the drive side.

FIG. 12 is a side view of the toner cartridge C according to Embodiment 1 of the present invention as viewed from the drive side.

FIG. 13 is a sectional view (section taken along a line i-i in FIG. 12) based on a center of the rotation axis of a toner accommodating portion screw member 35 of the toner cartridge C according to Embodiment 1 of the present invention.

FIG. 14 is a cross-sectional view (cross-section taken along a line h-h in FIG. 9) for explaining an example of a level-off portion 33al of the toner cartridge C according to Embodiment 1 of the present invention.

FIG. 15 is a sectional perspective view taken along a longitudinal direction of the toner cartridge C according to Embodiment 1 of the present invention.

FIG. 16 is a cross-sectional view (cross-section taken along a line f-f shown in FIG. 9) based on the center of the rotation axis of the shutter member 34 of the toner cartridge C according to Embodiment 1 of the present invention.

FIG. 17 is a sectional view (section taken along a line j-j shown in FIG. 12) based on a center of a rotation axis of a shutter member 34 of the toner cartridge C according to Embodiment 1 of the present invention.

FIG. 18 is a front view, a left side view, a right-side view, a bottom view and various sectional views of a nozzle member 33b according to Embodiment 1 of the present invention.

FIG. 19 is a cross-sectional view (cross-section taken along a line g-g in FIG. 9) of an example of the waste toner storage portion 40 of the toner cartridge C according to Embodiment 1 of the present invention.

FIG. 20 is a sectional view of the shutter member 34 for explaining an example of a feed passageway CP of the shutter member 34 according to Embodiment 1 of the present invention.

FIG. 21 is a perspective view illustrating an example of a method of mounting the process cartridge B and the toner cartridge C to the printer main assembly A according to Embodiment 1 of the present invention.

FIG. 22 is a side view illustrating an example of the method of mounting the process cartridge B and the toner cartridge C to the printer main assembly A according to Embodiment 1 of the invention.

FIG. 23 is a sectional perspective view for explaining an example of a supply opening of the process cartridge B according to Embodiment 1 of the present invention.

FIG. 24 is an exploded perspective view for illustrating a driving means for the developing operation of the process cartridge B according to Embodiment 1 of the present invention.

FIG. 25 is a schematic sectional view of the process cartridge B according to Embodiment 1 of the present invention.

FIG. 26 is a side view and a cross-sectional view (cross-section taken along a line k-k in the drawing) for illustrating a state in which the shutter member 34 of the toner cartridge C blocks the toner according to Embodiment 1 of the present invention.

FIG. 27 is an exploded perspective view of the shutter member 34 and the peripheral portions of the toner cartridge C according to Embodiment 1 of the present invention.

FIG. 28 is a front view, a left side view, a right-side view, a bottom view and cross-sectional views of the shutter member 34 according to Embodiment 1 of the present invention.

FIG. 29 is a front view of the toner cartridge C according to Embodiment 1 of the present invention in a state where the shutter member 34 blocks the toner.

FIG. 30 shows a front view, a left side view, a right-side view, a bottom view and cross-sectional views of a shutter protection member 210 according to Embodiment 1 of the present invention.

FIG. 31 is a view illustrating an example of a structure of a receiving side shutter member 206 of the process cartridge B according to Embodiment 1 of the present invention.

FIG. 32 is a view illustrating an example of the operation of the receiving side shutter member 206 of the process cartridge B according to Embodiment 1 of the present invention.

FIG. 33 is a partial sectional view of the neighborhood of the receiving side shutter member 206 of the process cartridge B according to Embodiment 1 of the present invention.

FIG. 34 is an exploded perspective view of the receiving side shutter member 206 and the peripheral parts thereof according to Embodiment 1 of the present invention.

FIG. 35 is an exploded perspective view of the shutter member 206 and peripheral parts showing a communication hole 206a of the receiving side shutter member 206 according to Embodiment 1 of the present invention.

FIG. 36 is a partial enlarged view of the process cartridge B according to Embodiment 1 of the present invention, as viewed in the mounting direction of the toner cartridge C.

FIG. 37 is a view illustrating an example of a mounting path of a rough guide rib 210d to a rough guide 21f according to Embodiment 1 of the present invention.

FIG. 38 is a view illustrating an example of the mounting trace of a free end 34h1 of the arm of the shutter member 34 according to Embodiment 1 of the present invention.

FIG. 39 is a view illustrating an example of the mounting operation of the actuating projection 34f of the shutter member 34 to the actuation projection receiving portion 206b of the receiving side shutter member 206 according to Embodiment 1 of the present invention.

FIG. 40 is an illustration for illustrating a state in which the toner cartridge C according to Embodiment 1 of the present invention is in the middle of being mounted, as viewed in the mounting direction of the toner cartridge C.

FIG. 41 is an external perspective view of the shutter member 34 according to Embodiment 1 of the present invention.

FIG. 42 is an exploded perspective view of the toner cartridge C according to Embodiment 1 of the present invention, as viewed from the non-drive side.

FIG. 43 is a view illustrating an example of a toner feeding direction by a shutter member 2034 according to Embodiment 2 of the present invention.

FIG. 44 is an external perspective view of the shutter member 2034 according to Embodiment 2 of the present invention.

FIG. 45 is a partial side view of a mounting portion of the shutter member 2034 in the process cartridge B according to Embodiment 2 of the present invention.

FIG. 46 is a view illustrating an example of operation of the shutter member 2034 according to Embodiment 2 of the present invention.

FIG. 47 is an illustration for illustrating an example of a state in which the shutter member 2034 is mounted to the process cartridge B according to Embodiment 2 of the present invention.

FIG. 48 is a perspective view illustrating the appearance of the toner cartridge C2 according to Embodiment 2 of the present invention.

FIG. 49 is a cross-sectional view taken along an axis G2 when the toner cartridge C2 according to Embodiment 2 of the present invention is mounted completely to the process cartridge B.

FIG. 50 is an illustration for illustrating an example of an attachment 2071 according to Embodiment 2 of the present invention.

FIG. 51 is an illustration of an example of an operation when the attachment 2071 according to Embodiment 2 of the present invention is mounted on the process cartridge B.

FIG. 52 is a view illustrating an example of a structure of a shutter member 2072 according to Embodiment 2 of the present invention.

FIG. 53 is an illustration for illustrating an example of the mounting operation of the shutter member 2072 to the process cartridge B according to Embodiment 2 of the present invention.

FIG. 54 is an illustration of an example of a toner feed attachment 3034 forming a part of a toner feeding member according to Embodiment 3 of the present invention.

FIG. 55 is a perspective view of the external appearance of the process cartridge B according to Embodiment 3 of the present invention.

FIG. 56 is a sectional view taken along a XZ plane passing through a center of a through hole 3034k in a state in which the toner feed attachment 3034 is mounted on the process cartridge B.

FIG. 57 is an external perspective view of a toner cartridge C3 according to Embodiment 3 of the present invention.

FIG. 58 is a view of an example of a method of mounting the toner feed attachment 3034 to the toner cartridge C3 according to Embodiment 3 of the present invention.

FIG. 59 is a view of an example of a structure of a toner feed pipe 4034 according to Embodiment 4 of the present invention.

FIG. 60 is a view illustrating an example of an operation of a toner feed pipe 4034 according to Embodiment 4 of the present invention.

FIG. 61 is a perspective view of the external appearance of the process cartridge B according to Embodiment 4 of the present invention with the toner feed pipe 4034 mounted thereto.

FIG. 62 is an external perspective view of a toner cartridge C4 according to Embodiment 4 of the present invention.

FIG. 63 is an illustration of an example of a case where the toner cartridge C4 according to Embodiment 4 of the present invention is mounted on the process cartridge B by way of the toner feed pipe 4034.

FIG. 64 is a view of an example of the structure of a shutter member 5034 according to Embodiment 5 of the present invention.

FIG. 65 is a partially exploded perspective view of a toner cartridge C6, a first toner feeding portion 6034, and a second toner feeding portion 6072 according to Embodiment 6 of the present invention.

FIG. 66 is an exploded perspective view illustrating an example of the structure of a first toner feeding portion 6034 and a second toner feeding portion 6072 according to Embodiment 6 of the present invention.

FIG. 67 is a view illustrating an example of a toner feed passageway from the toner cartridge C6 to the process cartridge B by way of the first toner feeding portion 6034 and the second toner feeding portion 6072 according to Embodiment 6 of the present invention.

FIG. 68 is a view of an example of a first shutter member (first toner feeding member) 7034 according to Embodiment 7 of the present invention.

FIG. 69 is aa illustration of a state in which the first shutter member 7034 according to Embodiment 7 of the present invention is mounted on the process cartridge B.

FIG. 70 is an illustration of an example of a second shutter member (second toner feeding member) 7070 according to Embodiment 7 of the present invention.

FIG. 71 is an illustration of an example of a third shutter member (third toner feeding portion) 7071 according to Embodiment 7 of the present invention.

FIG. 72 is a side view of a first shutter member (toner feeding member) 8034 according to Embodiment 8 of the present invention, as viewed from the side facing a toner discharge opening 8034a.

FIG. 73 is a sectional view of the first shutter member 8034 according to Embodiment 7 of the present invention, taken along a line S8a-S8a shown in FIG. 72.

FIG. 74 is a sectional view taken along a plane passing through the centers of a toner feeding portion 8070b and a toner discharge opening 8070a of a second shutter member (second toner feeding member) 8070, according to Embodiment 8 of the present invention.

FIG. 75 is a perspective view of an outer appearance of a first toner accommodating unit 9030 and a first waste toner unit 9070, according to Embodiment 9 of the present invention.

FIG. 76 is an exploded perspective view including each member in the neighborhood of a shutter member 9034 according to Embodiment 9 of the present invention.

FIG. 77 is an enlarged perspective view of the first waste toner unit 9070 according to Embodiment 9 of the present invention, as viewed from the first toner accommodating unit (9030) side.

FIG. 78 is an enlarged perspective view of the neighborhood of a toner discharge opening 9030a of a first toner accommodating unit 9030 according to Embodiment 9 of the present invention.

FIG. 79 is an enlarged perspective view of the first toner accommodating unit 9030 according to Embodiment 9 of the present invention before a first waste toner storage unit 9070 is connected to the first toner accommodating unit 9030.

FIG. 80 is a sectional view taken along an XY plane passing through the rotation axis R3 of the shutter member 9034 in a state in which the first waste toner storage unit 9070 is connected to the first toner accommodating unit 9030 according to Embodiment 9 of the present invention.

FIG. 81 is a view of an example of a method for transmitting a driving force from a first toner accommodating unit 9030 to a first waste toner storage unit 9070, according to Embodiment 9 of the present invention.

FIG. 82 is a perspective view of an external appearance of a second toner accommodating unit 9072 and a second waste toner storage unit 9073 according to Embodiment 9 of the present invention, as viewed from the front sides of respective units.

FIG. 83 is an external perspective view of the second toner accommodating unit 9072 and the second waste toner storage unit 9073 according to Embodiment 9 of the present invention, as viewed from a Z1 direction.

FIG. 84 is a view for explaining a method for transmitting a driving force from the second toner accommodating unit 9072 to the second waste toner storage unit 9073, according to Embodiment 9 of the present invention.

FIG. 85 is a perspective view illustrating the external appearance of a third toner accommodating unit 9076 and a third waste toner unit 9077 according to Embodiment 9 of the present invention.

FIG. 86 is an external perspective view of a toner cartridge C10 according to Embodiment 10 of the present invention.

FIG. 87 is an external perspective view of the process cartridge B11 according to Embodiment 11 of the present invention.

FIG. 88 is an exploded perspective view of a driving force receiving member 11070 according to Embodiment 11 of the present invention.

FIG. 89 is a sectional view taken along a YZ plane passing through the center of the rotation axis of a driving force receiving member 11070, according to Embodiment 11 of the present invention.

FIG. 90 is an external perspective view of a toner cartridge C11 according to an Embodiment 11 of the present invention.

FIG. 91 is a view for explaining an example of a connection method between a drive input portion 11039 and a driving force receiving member 11070, according to Embodiment 11 of the present invention.

FIG. 92 is a view for explaining an example of a method of mounting each drive transmission mechanism according to Embodiment 12 of the present invention.

FIG. 93 is an illustration of an example of a state in which a drive transmission attachment 12115 is mounted to a first main assembly side coupling 110, according to Embodiment 12 of the present invention.

FIG. 94 is a detailed view of the drive transmission attachment 12115 according to Embodiment 12 of the present invention.

FIG. 95 is an illustration of an example of a drive transmission mechanism for transmission from the printer main assembly A to the toner cartridge C12 according to Embodiment 12 of the invention.

FIG. 96 is a detailed view illustrating an attachment gear 13115 according to Embodiment 13 of the present invention mounted to the first main assembly side coupling 110.

FIG. 97 is a side view of a toner cartridge C13 according to Embodiment 13 of the present invention.

FIG. 98 is a detailed view of the attachment gear 13115 according to Embodiment 13 of the present invention.

FIG. 99 is an illustration of an example of a drive transmission mechanism for transmission from the printer main assembly A to the toner cartridge C12 according to Embodiment 13 of the invention.

FIG. 100 is a view illustrating an example of a mounting method of each drive transmission mechanism according to Embodiment 13 of the present invention.

FIG. 101 is a detailed view of the attachment gear 13115 according to Embodiment 13 of the present invention.

FIG. 102 is an external perspective view of a toner cartridge C13 according to Embodiment 13 of the present invention.

FIG. 103 is a side view of a toner cartridge C14 according to Embodiment 14 of the present invention.

FIG. 104 is an illustration of an example of a drive transmission mechanism for transmission from the printer main assembly A to the toner cartridge C14 according to Embodiment 14 of the invention.

FIG. 105 is an external perspective view of a toner cartridge C14 according to Embodiment 14 of the present invention.

FIG. 106 is an illustration of an example of a method of engagement between the first main assembly side pump coupling 110 and the pump-screw drive input portion 14039, according to Embodiment 14 of the present invention.

FIG. 107 is a side view of a toner cartridge C15 according to Embodiment 15 of the present invention.

FIG. 108 is an illustration for exemplarily explaining a drive transmission mechanism for transmission from the printer main assembly A to the toner cartridge C15 according to Embodiment 15 of the invention.

FIG. 109 is an external perspective view of a toner cartridge C15 according to Embodiment 15 of the present invention.

FIG. 110 is an illustration of an example of a method of engagement between the first main assembly side pump coupling 110 and the pump-screw drive input portion 15039 according to Embodiment 15 of the present invention.

FIG. 111 is an illustration for exemplarily explaining a shutter member 16034 which is the toner feeding member, according to Embodiment 16 of the present invention.

FIG. 112 is an external perspective view of a toner cartridge C17 according to Embodiment 17 of the present invention.

FIG. 113 is an external perspective view of an attachment member 17070 according to Embodiment 17 of the present invention.

FIG. 114 is a view of an example of the process cartridge B17 according to Embodiment 17 of the present invention.

FIG. 115 is an illustration of details of the attachment member 17070 according to Embodiment 17 of the present invention.

FIG. 116 is an illustration for explaining an example of the operation when the toner cartridge C17 according to Embodiment 17 of the present invention is mounted on the process cartridge B17.

FIG. 117 is an external perspective view of a toner cartridge C18 according to an Embodiment 18 of the present invention.

FIG. 118 is a sectional view of a major part of a toner cartridge C18 according to Embodiment 18 of the present invention.

FIG. 119 is a detailed view of a drive transmission attachment 18115 according to Embodiment 18 of the present invention.

FIG. 120 is an illustration of an example of a drive transmission mechanism for transmission from the printer main assembly A to the toner cartridge C18 according to an Embodiment 18 of the invention.

FIG. 121 is a partial external perspective view of a toner cartridge C19 according to Embodiment 19 of the present invention.

FIG. 122 is an exploded perspective view of an attachment unit 19115 according to Embodiment 19 of the present invention.

FIG. 123 is an illustration of an example of a drive transmission mechanism for transmission from the printer main assembly A to the toner cartridge C19 according to Embodiment 19 of the invention.

FIG. 124 is a cross-sectional view taken along an XY plane of a major part of a driving force transmission mechanism according to Embodiment 19 of the present invention.

FIG. 125 is a perspective view of the major parts of the attachment unit 19115 according to Embodiment 19 of the invention mounted to the printer main assembly A.

FIG. 126 is an external perspective view of a toner cartridge C20 according to Embodiment 20 of the present invention.

FIG. 127 is a cross-sectional view (XY plane) of the toner cartridge C20 and the first main assembly side coupling 110 according to Embodiment 20 of the present invention, taken in a direction perpendicular to the rotation axis of the pump-screw coupling portion 20039a.

FIG. 128 is an illustration of an example of a drive transmission mechanism according to Embodiment 20 of the present invention.

FIG. 129 is a partial external perspective view of a toner cartridge C21 according to Embodiment 21 of the present invention.

FIG. 130 is an exploded perspective view including a drive transmission mechanism of the toner cartridge C21 according to Embodiment 21 of the present invention.

FIG. 131 is an illustration of an example of a driving force transmission mechanism according to Embodiment 21 of the present invention and shows the relative positional relationship between a pump-screw coupling portion 21039a and the first main assembly side coupling 110.

FIG. 132 is a partial side view illustrating a part including the pump-screw drive transmission portion 21039 as viewed in a direction facing the first main assembly side coupling 110.

FIG. 133 is an external perspective view of a shutter member 22034 according to Embodiment 22 of the present invention.

FIG. 134 is a sectional view taken along a plane passing through the rotation axis R3 of the shutter member 22034 according to Embodiment 22 of the present invention and parallel to an X-axis.

FIG. 135 is a sectional view taken along a plane parallel to the X-axis passing through the rotation axis R3 of the shutter member 22034 and the second toner discharge portion 22073, according to Embodiment 22 of the present invention.

FIG. 136 is an external perspective view illustrating an example of a state in which the opening operation of the shutter member 34 and the receiving side shutter member 206 according to Embodiment 1 of the present invention is completed.

FIG. 137 is a perspective view of the toner cartridge C according to Embodiment 1 of the present invention, and an enlarged perspective view of the shutter protection member 210 and the sheet member 212.

FIG. 138 is a perspective view illustrating an attachment position of a sheet member 212 mounted to the shutter protection member 210 according to a modified example of Embodiment 1 of the present invention.

FIG. 139 is a cross-sectional view illustrating an example of the arrangement of a shutter protection member 210, a receiving side shutter member 206, a sheet member 212, and a shutter member 34 according to a modified example of Embodiment 1 of the present invention.

FIG. 140 is a view illustrating an example of an attachment position of the sheet member 212 to the shutter protection member 210 according to a modified example of Embodiment 1 of the present invention.

FIG. 141 is a front view illustrating an attachment position of the sheet member 212 to the shutter protection member 210 according to a modified example of Embodiment 1 of the present invention.

FIG. 142 is a side view illustrating an attachment position of the sheet member 212 to the shutter protection member 210 according to a modified example of Embodiment 1 of the present invention.

FIG. 143 is a view illustrating an example of the structure of a seal member 211 according to a modified example of Embodiment 1 of the present invention.

FIG. 144 is a cross-sectional view of the toner cartridge C in the process of mounting to the printer main assembly A, illustrating the shape of the discharge opening seal contact surface, according to Embodiment 1 of the present invention.

FIG. 145 is an external perspective view of a toner cartridge C231 according to Embodiment 23 of the present invention.

FIG. 146 is a partially exploded perspective view of a toner cartridge C231 according to Embodiment 23 of the present invention.

FIG. 147 is an illustration of an example of an accommodation frame 23031 according to Embodiment 23 of the present invention.

FIG. 148 is an illustration of an example of a first internal shutter member 23071 according to Embodiment 23 of the present invention.

FIG. 149 is an illustration for illustrating an example of a switch member 23070 according to Embodiment 23 of the present invention.

FIG. 150 is a view illustrating an example of an accommodation portion lid 23032 according to Embodiment 23 of the present invention.

FIG. 151 is an illustration of an example of the attachment state of the first internal shutter member 23071 and the switch member 23070 according to Embodiment 23 of the present invention.

FIG. 152 is a view illustrating an example of the mounting positions of a partition member 23046 and a nozzle member 33b to the accommodation frame 23031 according to Embodiment 23 of the present invention.

FIG. 153 is a view illustrating an example of a mounting position of an accommodating portion lid 23032 with respect to the accommodation frame 23031 according to the Embodiment 23 of the present invention.

FIG. 154 is an illustration of an example of a structure in which the switch member 23070 is operated by an opening/closing opening/closing door 107 provided in the printer main assembly A, according to Embodiment 23 of the present invention.

FIG. 155 is an illustration of an example of open and closed states of the first internal shutter member 23071 according to Embodiment 23 of the present invention.

FIG. 156 is an external perspective view of a toner cartridge C241 according to Embodiment 24 of the present invention.

FIG. 157 is an exploded perspective view of the toner cartridge C241 according to Embodiment 24 of the present invention.

FIG. 158 is an illustration of an example of an accommodating frame 24031 according to Embodiment 24 of the present invention.

FIG. 159 is an illustration of an example of a second internal shutter member 24071 according to Embodiment 24 of the present invention.

FIG. 160 is an enlarged perspective view of the accommodating frame 24031 to which the second internal shutter member 24071 is mounted, according to Embodiment 24 of the present invention.

FIG. 161 is an illustration of an example of opening and closing operation of the second inner shutter member 2407, 1 according to Embodiment 24 of the present invention.

FIG. 162 is an illustration of an example of a toner discharge passageway in the second internal shutter member 24071, according to Embodiment 24 of the present invention.

FIG. 163 is an exploded perspective view of examples of parts connected to the accommodation frame 25031 of a toner cartridge C251 according to Embodiment 25 of the present invention.

FIG. 164 is an illustration of the details of a screw gear 25072, according to Embodiment 25 of the present invention.

FIG. 165 is a view illustrating an example of the structure of a toner accommodating portion screw member 25035, according to Embodiment 25 of the present invention.

FIG. 166 is a perspective view of a second shutter member 25074, according to Embodiment 25 of the present invention.

FIG. 167 is a perspective view of a brake member 25071 according to Embodiment 25 of the present invention.

FIG. 168 is a view illustrating an example of a method of mounting the brake member 25071 to the accommodation frame 25031 according to Embodiment 25 of the present invention.

FIG. 169 is an illustration of an example of operation of the brake member 25071, according to Embodiment 25 of the present invention.

FIG. 170 is an external perspective view of the toner cartridge C251 according to Embodiment 25 of the present invention, as viewed from above.

FIG. 171 is an illustration of an example of operation of a driving portion, according to Embodiment 25 of the present invention.

FIG. 172 is a view of an example of a structure in which the screw gear 25072 and the toner accommodating portion screw member 25035 are interrelated with each other, according to Embodiment 25 of the present invention.

FIG. 173 is an illustration of an example of a toner cartridge C261 according to Embodiment 26 of the present invention.

FIG. 174 is a view illustrating an example of a discharge valve 27071 according to Embodiment 27 of the present invention.

FIG. 175 is a view illustrating an example of a structure of a shutter member 27034 according to Embodiment 27 of the present invention.

FIG. 176 is an external perspective view of an attachment member 28071 according to Embodiment 28 of the present invention.

FIG. 177 is a view of an example of a method for mounting an attachment member 28071 to a process cartridge B, according to Embodiment 28 of the present invention.

FIG. 178 is an external perspective view of a shutter member 28034, according to Embodiment 28 of the present invention.

FIG. 179 is an external perspective view of a toner cartridge C291 according to Embodiment 29 of the present invention.

FIG. 180 is an illustration of an example of a method for mounting a toner cartridge C291 to a process cartridge B, according to Embodiment 29 of the present invention.

FIG. 181 is an illustration of major parts when the toner cartridge C291 is mounted to the process cartridge B according to Embodiment 29 of the present invention.

FIG. 182 is an external perspective view of a drive side end of the toner cartridge C300 according to Embodiment 30 of the present invention.

FIG. 183 is an exploded perspective view of an air cylinder 30071 according to Embodiment 30 of the present invention.

FIG. 184 is an illustration for explaining of a method of assembling an air cylinder 30071 according to Embodiment 30 of the present invention.

FIG. 185 is a perspective view of an external appearance of major parts of a drive side end portion of the toner cartridge C300 before and after driving the air cylinder 30071 according to Embodiment 30 of the present invention.

FIG. 186 is a sectional view of major parts of the air cylinder 30071 and the neighborhood thereof, according to Embodiment 30 of the present invention.

FIG. 187 is an exploded perspective view of a toner cartridge C310 according to Embodiment 31 of the present invention.

FIG. 188 is an exploded perspective view illustrating the drive side of the toner cartridge C310 according to Embodiment 31 of the present invention.

FIG. 189 is a perspective view of a drive side end of the toner cartridge C310 according to Embodiment 31 of the present invention.

FIG. 190 is an exploded perspective view of a side cover 31050 as viewed in the Z2 direction, according to Embodiment 31 of the present invention.

FIG. 191 is an illustration of an example of a toner cartridge C310 provided with a fan 31080, as a modified example of Embodiment 31 of the present invention.

FIG. 192 is an external perspective view of a driving force receiving portion and neighborhood thereof, of the toner cartridge C320 according to Embodiment 32 of the present invention.

FIG. 193 is an external perspective view of a drive side cover 32050 according to Embodiment 32 of the present invention.

FIG. 194 is an illustration of an example of structure of a movable cover 32071 according to Embodiment 32 of the present invention.

FIG. 195 is a view of an example of the arrangement of a stirring drive receiving portion 32038 and a pump-screw drive receiving portion 32039 in a movable cover 32071 according to Embodiment 32 of the present invention.

FIG. 196 is a perspective view of a pump-screw drive receiving portion 32039 according to Embodiment 32 of the present invention.

FIG. 197 is a partial exploded perspective view of the drive side of the toner cartridge C320 according to Embodiment 32 of the present invention.

FIG. 198 is an illustration of an example of a drive transmission member of the toner cartridge C320 according to Embodiment 32 of the present invention.

FIG. 199 is a view of an example of a method of mounting a movable cover 32071 to an accommodating frame 32031 according to Embodiment 32 of the present invention.

FIG. 200 is a partial side view of an example of engagement state between a pump-screw drive receiving portion 32039, a drive receiving coupling 32076, and a drive transmission gear member 32074, according to Embodiment 32 of the present invention.

FIG. 201 is an external perspective view of the toner cartridge C320 according to the Embodiment 32 of the present invention with the movable cover 32071 mounted to the end portion on the drive side (Z1 direction).

FIG. 202 is an illustration of an example of a method for mounting the drive side cover 32050 to the accommodating frame 32031 according to Embodiment 32 of the present invention.

FIG. 203 is an illustration of an example of a method for engaging the pump-screw drive receiving portion 32039 and the first main assembly side coupling 110 with each other, according to Embodiment 32 of the present invention.

FIG. 204 is an illustration of an example of change in the positions of the first main assembly side coupling 110 and the pump-screw drive receiving portion 32039 depending on the open/closed state of the opening/closing opening/closing door 107, according to Embodiment 32 of the present invention.

FIG. 205 is an illustration of an example of change in the engagement state between the first main assembly side coupling 110 and the pump-screw drive receiving portion 32039 with each other, according to Embodiment 32 of the present invention.

FIG. 206 is a view of an example of relationship between the toner discharging direction and the rotation axis of the pump-screw drive receiving portion 32039, according to Embodiment 32 of the present invention.

FIG. 207 is a partial external perspective view including the drive side of a toner cartridge C330, according to Embodiment 33 of the present invention.

FIG. 208 is an illustration of an example of a movable cover 33071 according to Embodiment 33 of the present invention.

FIG. 209 is an illustration of an example of a method of mounting each part to a movable cover 33071, according to Embodiment 33 of the present invention.

FIG. 210 is an external perspective view of an advance/retract coupling 33072 according to Embodiment 33 of the present invention.

FIG. 211 is a view of an example of a state in which each portion related to the movable cover 33071 is mounted, according to Embodiment 33 of the present invention.

FIG. 212 is a view of an example of a method of mounting each part for transmitting driving force to an accommodation frame 33031, according to Embodiment 33 of the present invention.

FIG. 213 is an exploded perspective view of the drive side of the toner cartridge C330, according to Embodiment 33 of the present invention.

FIG. 214 is an illustration of an example of a state in which a drive side cover 33050 is mounted to an accommodation frame 33031, according to Embodiment 33 of the present invention.

FIG. 215 is a perspective view of an engagement state between a conversion gear 33074 and a second idler gear 33082, according to Embodiment 33 of the present invention.

FIG. 216 is an illustration of an example of a drive transmission method between the advancement/retraction coupling portion 33072 and the first main assembly side coupling 110, according to Embodiment 33 of the present invention.

FIG. 217 is a partial external perspective view of a toner cartridge C340 according to Embodiment 34 of the present invention.

FIG. 218 is a partial external perspective view of the process cartridge B100 according to Embodiment 34 of the present invention.

FIG. 219 is an external perspective view of a first connecting member 34079, according to Embodiment 34 of the present invention.

FIG. 220 is an external perspective view of a second connecting member 34080 according to Embodiment 34 of the present invention.

FIG. 221 is an illustration of an example of a state in which the toner cartridge C340 is mounted (connected) to the process cartridge B100, according to Embodiment 34 of the present invention.

FIG. 222 is an illustration of an example of a method of mounting and dismounting the unit to the printer main assembly A in a state in which the process cartridge B100 and the toner cartridge C340 are connected with each other, according to Embodiment 34 of the present invention.

### EMBODIMENTS

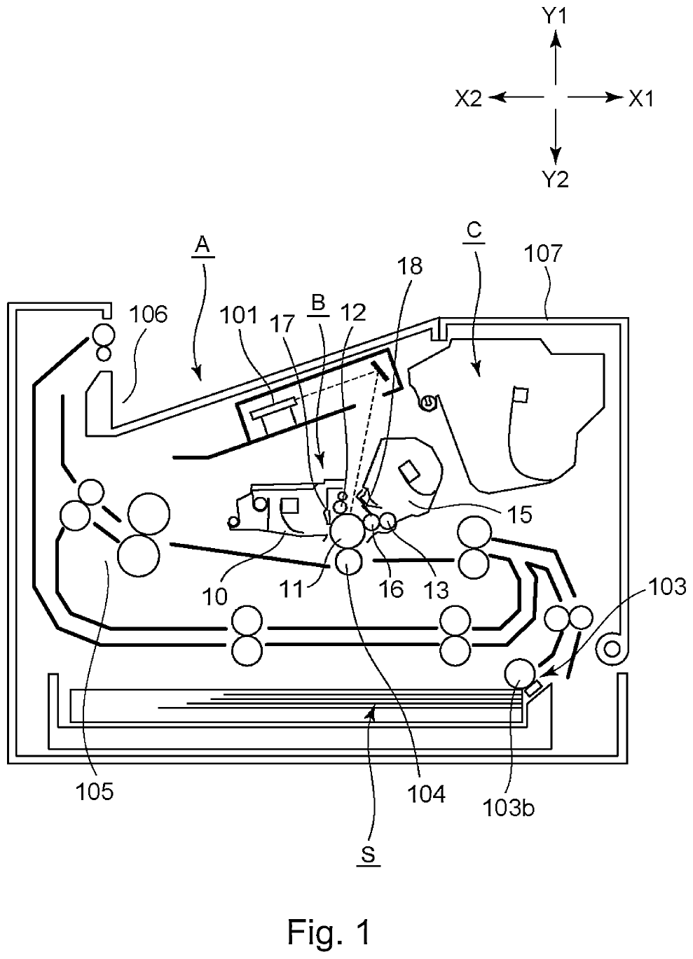

FIG. 1 is a sectional view illustrating a laser printer as an example of an image forming apparatus according to an embodiment of the present invention. The dimensions, materials, shapes, and relative arrangements of the components of the image forming apparatus described in the following embodiments may be modified as appropriate depending on the structure and various conditions of the apparatus to which the present invention is applied. Therefore, unless otherwise specified, the scope of the present invention is not limited thereto.

### (Basic Structure of Laser Printer)

As shown in FIG. 1, the laser printer 1, which is the image forming apparatus according to this embodiment, includes a printer main assembly A as the main assembly of the apparatus, and a process cartridge B and a toner cartridge C are detachably mountable thereto. The method of mounting and dismounting the process cartridge B and the toner cartridge C to and from the printer main assembly A will be described in detail hereinafter.

The printer main assembly A includes a sheet feeding portion 103, a transfer roller 104, a fixing portion 105, and a laser scanner 101. The process cartridge B and the toner cartridge C can be mounted in the printer main assembly A so that they are positioned at the upper and front side of the laser printer 1.

Here, an upper side of the laser printer 1 is a downstream side a Y1 direction shown in FIG. 1. A lower side of the laser printer 1 is d downstream side in a Y2 direction shown in FIG. 1, which is the opposite direction to the Y1 direction described above. A front side of the laser printer 1 is a downstream side in an X1 direction in FIG. 1. A rear side (back side) of the laser printer 1 is a downstream side in the X2 direction shown in FIG. 1, which is the opposite direction to the X1 direction described above. In the set state (normal attitude) of the laser printer 1, the storage portion for sheets S is located on the lower side of the apparatus, and the opening/closing opening/closing door 107 is located on the upper side of the apparatus, and in this state, the bottom side of the laser printer 1 (the storage portion side for sheets S) faces in the direction of gravity.

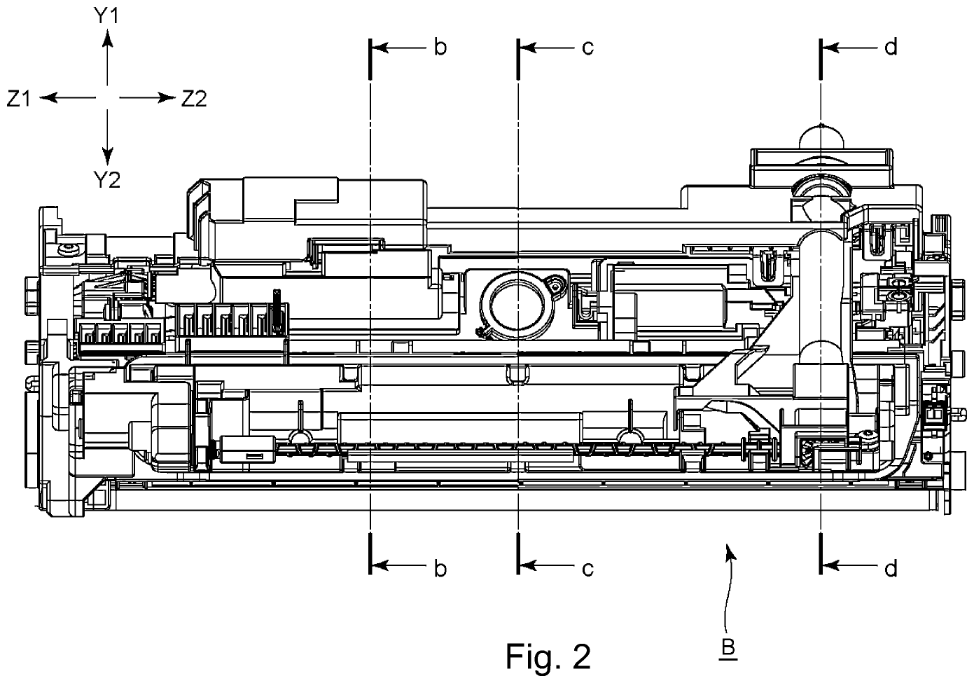

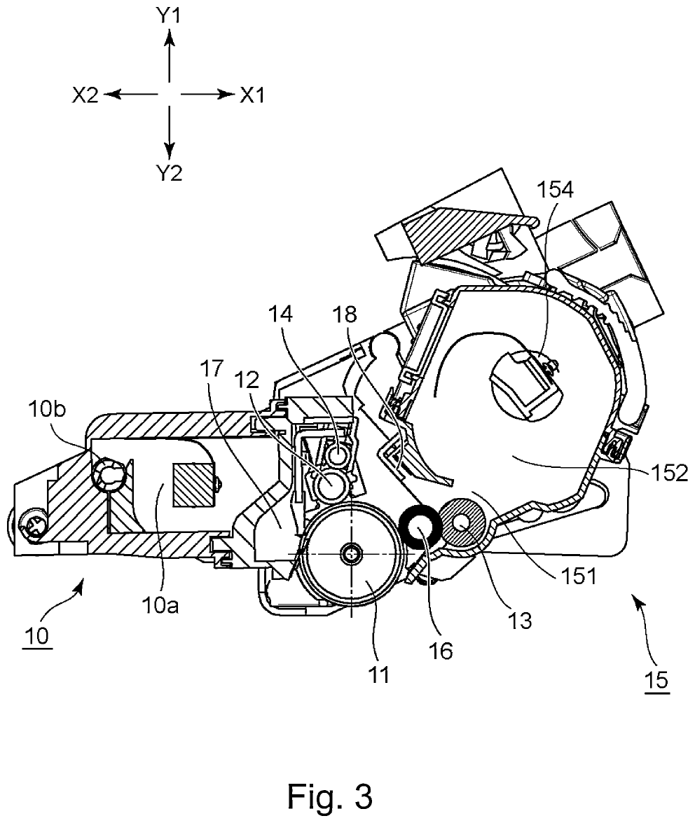

Next, referring to FIGS. 2 and 3, the process cartridge B will be described in detail. FIG. 2 is a front view of the process cartridge B according to Embodiment 1 of the present invention, showing the state when the process cartridge B is viewed in the X1 direction shown in FIG. 1. FIG. 3 is a major sectional view (cross-section taken along a line c-c in FIG. 2) illustrating the structure of the process cartridge B according to Embodiment 1 of the present invention.

As shown in FIG. 3, the process cartridge B according to this embodiment includes a cleaning unit 10 (first unit) including a photosensitive drum (drum unit) 11 as an image bearing member, and a developing unit 15 (second unit). The developing unit 15 includes a developing roller 16 as a developing means for carrying a developer (toner).

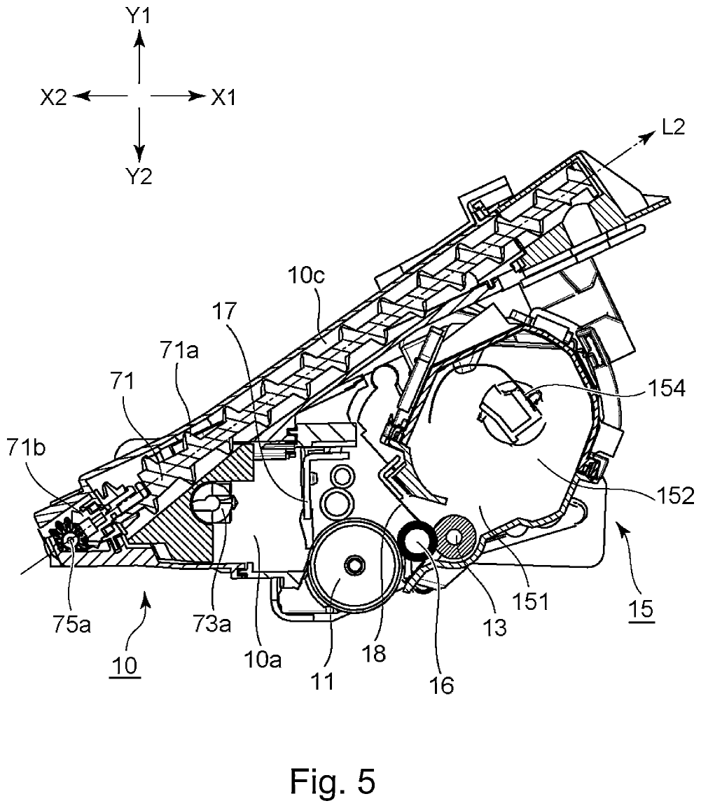

The cleaning unit 10 includes a cleaning blade 17, a charging roller 12, a charging roller cleaner 14, a primary waste toner storage portion 10a, a first waste toner feed passageway 10b, and a second waste toner feed passageway 10c (see FIG. 5), and rotatably supports the photosensitive drum 11. The cleaning blade 17 functions as a cleaning means for the photosensitive drum 11. The charging roller 12 functions as a charging means for the photosensitive drum 11. The charging roller cleaner 14 functions as a cleaning means for the charging roller 12. In this embodiment, an axis parallel to the rotation axis of the photosensitive drum 11 is referred to as a Z axis, and the directionality related to the Z axis is defined as a Z1 direction and a Z2 direction. The Z-axis is perpendicular to the X-axis (X1 direction, X2 direction) and the Y-axis (Y1 direction, Y2 direction). In addition, when the process cartridge B and toner cartridge C are mounted in the printer main assembly A, the X axes (X1, X2 directions), the Y axes (Y1, Y2 directions), and the Z axes (Z1, Z2 directions) of the printer main assembly A, the process cartridge B, and the toner cartridge C are the same, respectively.

The charging roller 12 is disposed so as to be in contact with the outer peripheral surface of the photosensitive drum 11, and the charging roller 12 electrically charges the photosensitive drum 11 by application of a voltage (charging bias) from the printer main assembly A. The charging roller 12 is rotated by the photosensitive drum 11.

The cleaning blade 17 is an elastic member which is disposed so as to be in contact with the outer circumferential surface of the photosensitive drum 11. The cleaning blade 17 has a free end which elastically contacts the photosensitive drum 11 so as to remove the residual toner from the photosensitive drum 11 after a sheet S, which will be described hereinafter, passes between the photosensitive drum 11 and the transfer roller 104. The removed toner (hereinafter referred to as waste toner) is transported from a primary waste toner storage portion 10a (which will be described hereinafter) to a toner cartridge C through a first waste toner feed passageway 10b and a second waste toner feed passageway 10c.

The charging roller cleaner 14 is a roller disposed so as to be in contact with the surface (outer circumferential surface) of the charging roller 12 and is rotated by the charging roller 12 to clean the charging roller.

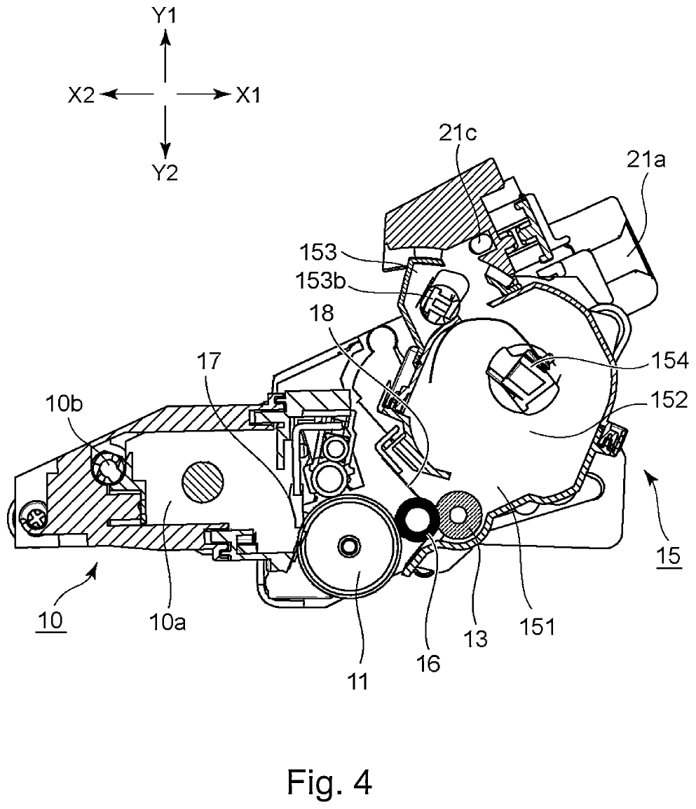

FIG. 4 is a cross-sectional view (cross-section taken along line b-b in FIG. 2) showing the supply opening of the process cartridge B, according to Embodiment 1 of the present invention. As shown in FIG. 4, the developing unit 15 has a developing chamber 151 in which the developing roller 16 is disposed, a developer storing portion 152 which supplies the toner to the developing chamber 151, a toner receiving chamber 153 which receives the toner supplied from the toner cartridge C, and an stirring member 154.

The developing roller 16 is a developing member (developing means) which supplies the toner to the photosensitive drum 11 and develops the electrostatic latent image formed on the photosensitive drum 11 using the supplied toner. The developing blade 18 contacts the surface of the developing roller 16 and regulates the amount of the toner which is deposited on the surface of the developing roller 16. It also applies triboelectric charge to the toner. That is, the developing blade 18 is an adjusting means for adjusting the amount of the toner in the present invention.

The stirring member 154 is a stirring means for stirring the toner supplied inside the developing unit 15 so that the toner is uniformly dispersed. The toner contained within the developer storing portion 152 is fed into the developing chamber 151 by the rotation of the stirring member 154 and is supplied to the developing roller 16.

The amount of the toner remaining in the developer storing portion 152 is detected by a remaining amount detection means (not shown), and when the amount of the toner in the developer storing portion 152 becomes below a predetermined amount, the toner is supplied from the toner cartridge C into the process cartridge B. The toner supplied into the developing unit 15 is supplied into the developer storing portion 152 by way of a supply opening 21c and a delivery opening 21d of a stay 21 and the toner receiving chamber 153.

Next, referring to FIG. 1, the operation of the laser printer 1 will be described. The photosensitive drum 11 is rotated by a driving source (not shown) and is uniformly charged to a predetermined potential by the charging roller 12. After being charged, the surface of the photosensitive drum 11 is exposed to light in accordance with image information by a laser scanner 101, and the charge in the exposed area is removed, thereby forming an electrostatic latent image. To the electrostatic latent image thus formed on the photosensitive drum 11, the toner is supplied from the developing roller 16, thus forming a toner image.

At this time, the sheet S is fed along a sheet feeding portion 103 in parallel with the toner image forming operation. Specifically, a feeding roller 103b rotates to feed the sheet S. Thereafter, the sheet S is fed between the photosensitive drum 11 and the transfer roller 104 in timed relation with the timing of formation of the toner image on the photosensitive drum 11. When the sheet S passes between the photosensitive drum 11 and the transfer roller 104, a voltage for image transfer is applied to the transfer roller 104, so that the toner image is transferred onto the sheet S as an unfixed image.

The sheet S onto which the toner image has been transferred is conveyed into a fixing portion 105. When the sheet S fed to the fixing portion 105 passes through the fixing portion 105, the unfixed image is heated and pressed, and is fixed on the surface of the sheet S. That is, the fixing portion 105 is a fixing means, in the image forming apparatus of the present invention. Thereafter, the sheet S is fed by the sheet feeding portion 103 and discharged to and stacked on a discharge tray 106. The front surface of the printer main assembly A is provided with an opening/closing opening/closing door 107 which is rotatable about a rotation axis (not shown). With the door open, the user can mount and dismount the process cartridge B and the toner cartridge C into and from the inside of the printer main assembly A.

### (Basic Structure of Process Cartridge B)

Next, referring to FIGS. 3-8, the structure of the process cartridge B in this embodiment will be described in detail. Although the process cartridge B in this embodiment is a cartridge provided with the photosensitive drum 11, the photosensitive drum 11 may be provided in a separate cartridge which can be connected to the process cartridge B, for example. In this embodiment, the process cartridge B may be any cartridge capable of mounting the toner cartridge C and including the developing roller 16, regardless of whether it contains the photosensitive drum 11 or not. In other words, in this embodiment, the process cartridge B is synonymous with the developing cartridge.

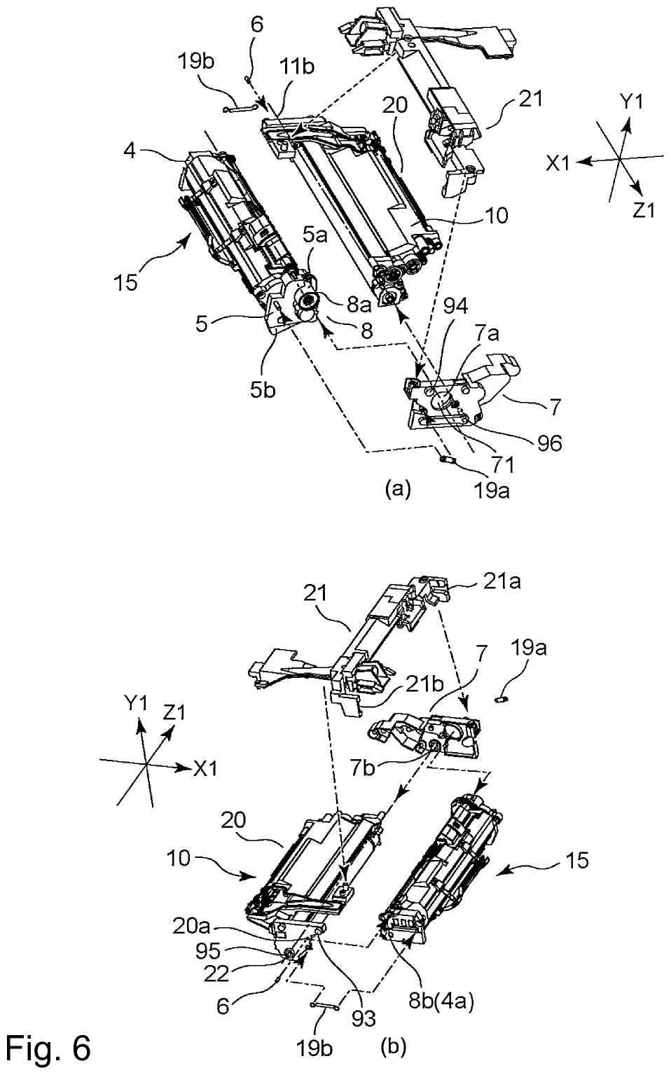

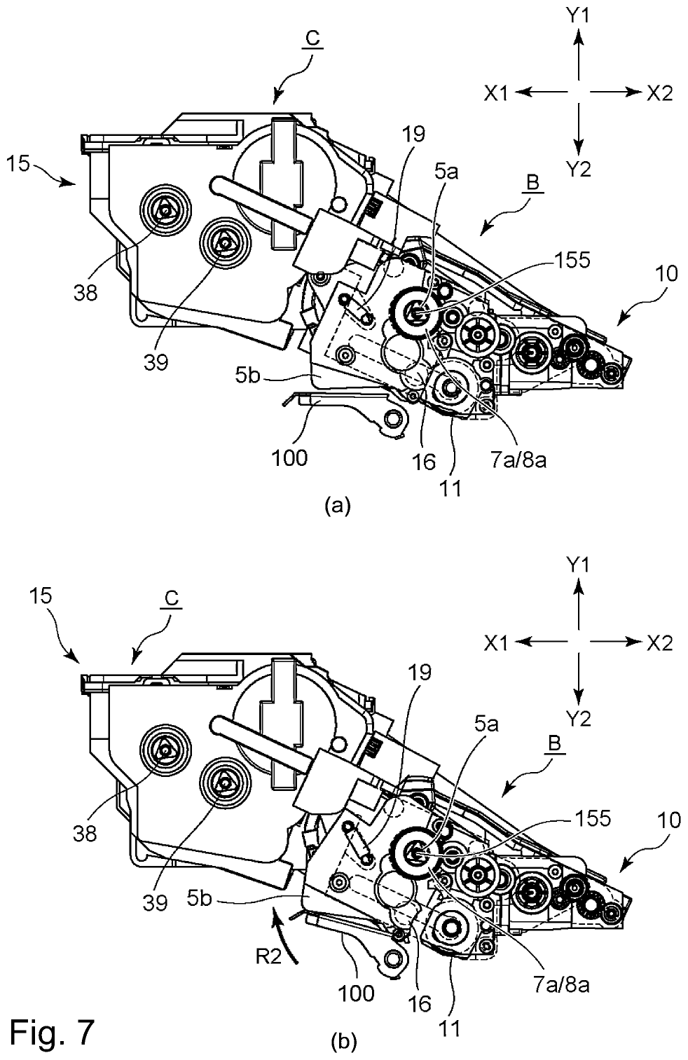

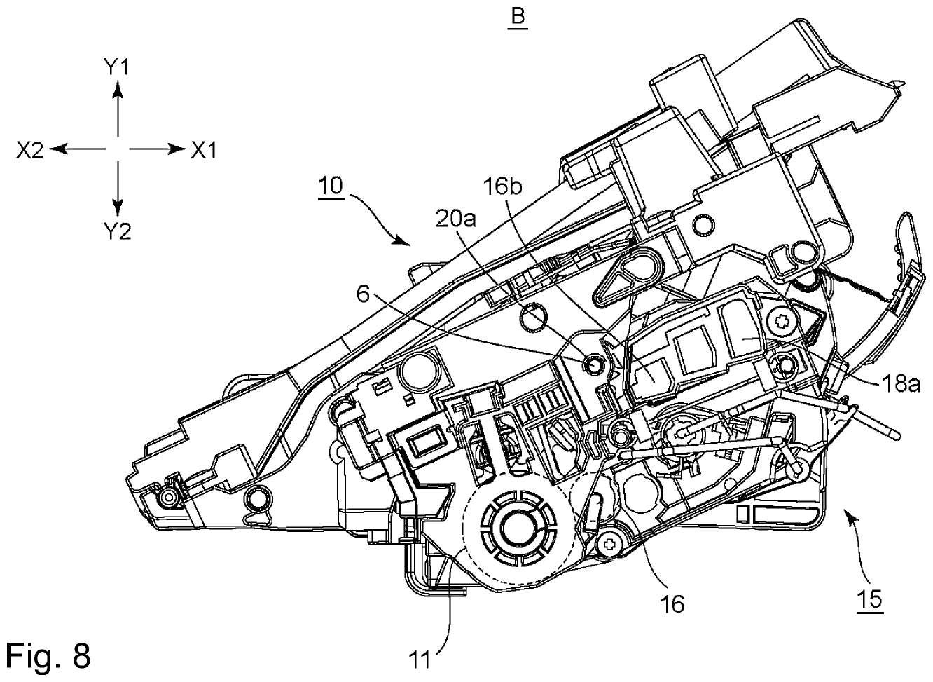

FIG. 5 is a cross-sectional view (cross-section taken along line d-d in FIG. 2) showing the second waste toner feed passageway 10c of the process cartridge B, according to Embodiment 1 of the present invention. Part (a) of FIG. 6 and part (b) of FIG. 6 are exploded perspective views of the process cartridge B according to Embodiment 1 of the present invention, where part (a) of FIG. 6 shows the process cartridge B as viewed from the drive side, and part (b) of FIG. 6 shows the process cartridge B as viewed from the non-drive side. FIG. 7 is an illustration for illustrating an example of a contact state and a spaced state of the developing unit 15 with respect to the photosensitive drum 11 in Embodiment 1 of the present invention. In addition, in FIG. 7, the side cover 7 is omitted, in order to illustrate a spacing mechanism 100 of the printer main assembly A. Part (a) of FIG. 7 shows a state in which the photosensitive drum 11 and the developing roller 16 are in contact with each other, and part (b) of FIG. 7 shows a state in which the photosensitive drum 11 and the developing roller 16 are spaced from each other. Parts (a) and (b) of FIG. 7 are side views of the process cartridge B as viewed from the drive side in the axial direction of the developing roller 16. FIG. 8 is a side view of the non-drive side of the process cartridge B in Embodiment 1 of the present invention. As shown in FIG. 6, in the developing unit 15, a first bearing member 4 and a second bearing member 5 are respectively provided at the axial ends of the developing roller 16, and support the developing roller 16. The first bearing member 4 is placed on the non-drive side of the process cartridge B, and the second bearing member 5 is placed on the drive side of the process cartridge B.

As shown in each of FIGS. 6 to 8, the cylindrical shape 5a of the second bearing member 5 is supported in a cylindrical hole shape 7a provided in the side cover 7 of the cleaning unit 10. The pin 6 is inserted through the cylindrical hole 20a of the cleaning frame 20 and the cylindrical hole 4a of the bearing member 4. The first support shaft 8a is defined by a common axis of the cylindrical hole shape 7a of the side cover 7 and the cylindrical shape 5a of the bearing member 5. The second support shaft 8b is defined by a common axis of the pin 6 and the cylindrical hole shape 4a of the bearing member 4. The developing unit 15 is connected with the cleaning unit 10 so as to be rotatable about a swing axis 8 defined by a straight line including the first support shaft 8a and the second support shaft 8b. In other words, the developing unit 15 is supported rotatably about the pivot axis 8 relative to the cleaning unit 10. The pivot axis 8 is substantially parallel to the rotation axis 11b of the photosensitive drum 11.

On both side surfaces of the process cartridge B (on the longitudinal end sides of the process cartridge B), pressure springs 19 are provided as urging means for urging the developing unit 15 against the cleaning unit 10. A first pressure spring 19a is disposed on the drive side of the process cartridge B, and a second pressure spring 19b is disposed on the non-drive side of the process cartridge B. The developing unit 15 is urged by the first pressure spring 19a and the second pressure spring 19b, so that the developing roller 16 is brought into contact with the photosensitive drum 11.

Next, referring to FIG. 7, the operation of the developing unit 15 into contact with and separation from the cleaning unit 10 will be described. As shown in part (a) of FIG. 7, the bearing member 5 is provided with a projection 5b. As shown in part (a) of FIG. 7, at a position where the projection 5b does not contact with the spacing mechanism 100, the developing roller 16 is in contact with the photosensitive drum 11. In the image forming apparatus of this embodiment, the position shown in part (a) of FIG. 7 is an image forming position (contact position, developing position) where the developing roller 16 and the photosensitive drum 11 are in contact with each other and the electrostatic latent image formed on the surface of the photosensitive drum 11 can be developed.

As shown in part (b) of FIG. 7, by the spacing mechanism 100 provided in the printer main assembly A abutting against the projection 5b and receiving a force, the developing unit 15 is rotated in a direction of an arrow R2 with the swing axis 8 as the center of rotation, and the photosensitive drum 11 and the developing roller 16 are spaced from each other. At this time, the spacing mechanism 100 presses the developing unit 15 against the urging forces of the first pressure spring 19a and the second pressure spring 19b. In the image forming apparatus according to this embodiment, the position shown in part (b) of FIG. 7 is a non-image forming position (separated position) in which the developing roller 16 is retracted (separated) from the image forming position.

When the spacing mechanism 100 returns to its original position, the spacing mechanism 100 moves away from the projection 5b, and the developing roller 16 and the photosensitive drum 11 move again to the image forming position shown in part (a) of FIG. 7 due to the urging forces of the first pressure spring 19a and the second pressure spring 19b.

That is, the image forming apparatus according to this embodiment is provided with the spacing mechanism 100, so that it is possible to switch the process cartridge B between the contact position (image forming position) and the spaced position (non-image forming position). With this structure, the process cartridge B in this embodiment can change (switch) the position of the developing unit 15 relative to the photosensitive drum 11 between the contact position and a separation position, thereby suppressing toner deterioration and toner consumption when no image is formed.

Next, as shown in FIG. 6, the cleaning unit 10 comprises the cleaning frame 20, the stay 21, and the side cover 7. The cleaning frame 20 supports the cleaning blade 17, the charging roller 12, and the charging roller cleaner 14. The photosensitive drum 11 is mounted, at one longitudinal end, to the cleaning frame 20 by a drum pin 22, and is rotatably supported at the other (opposite) end by a photosensitive drum support portion 7b provided in the side cover 7.

As shown in FIG. 5, the cleaning unit 10 has a second waste toner feed passageway 10c for conveying the waste toner collected in the cleaning frame 20 to the toner cartridge C. The feeding direction of the second waste toner feed passageway 10c is the direction L2 in FIG. 5. The feeding direction L2 is parallel to a plane perpendicular to the rotation axis 11b of the photosensitive drum 11. As shown in FIG. 4, the process cartridge B is provided with a supply opening 21c for receiving the toner from the toner cartridge C, as described above. The relationship between the supply opening 21c and the first and second waste toner feed passageways 10b and 10c will be described hereinafter.

### (Basic Configuration of Toner Cartridge C)

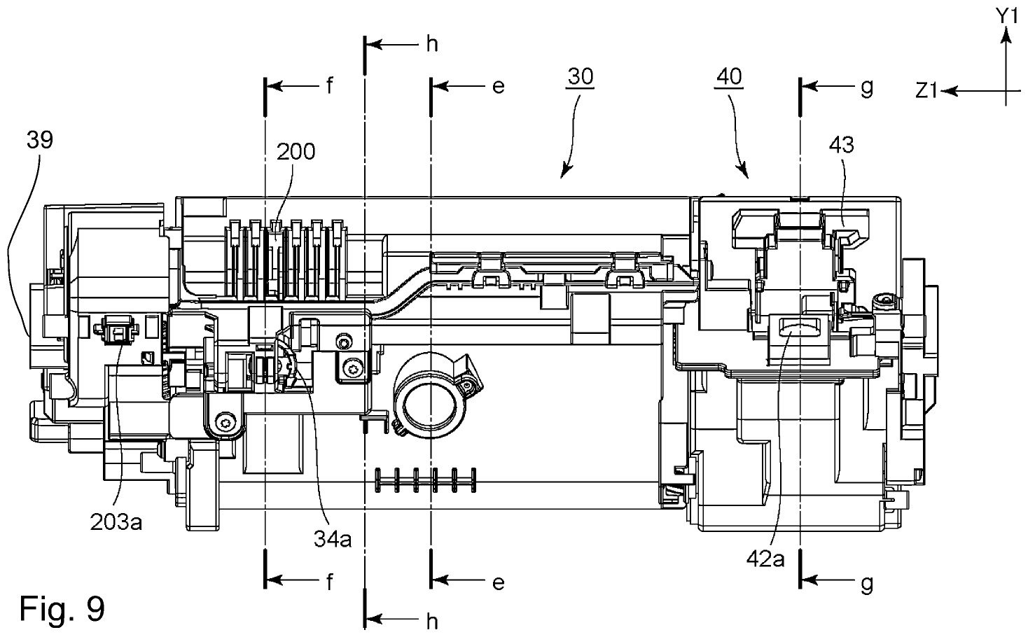

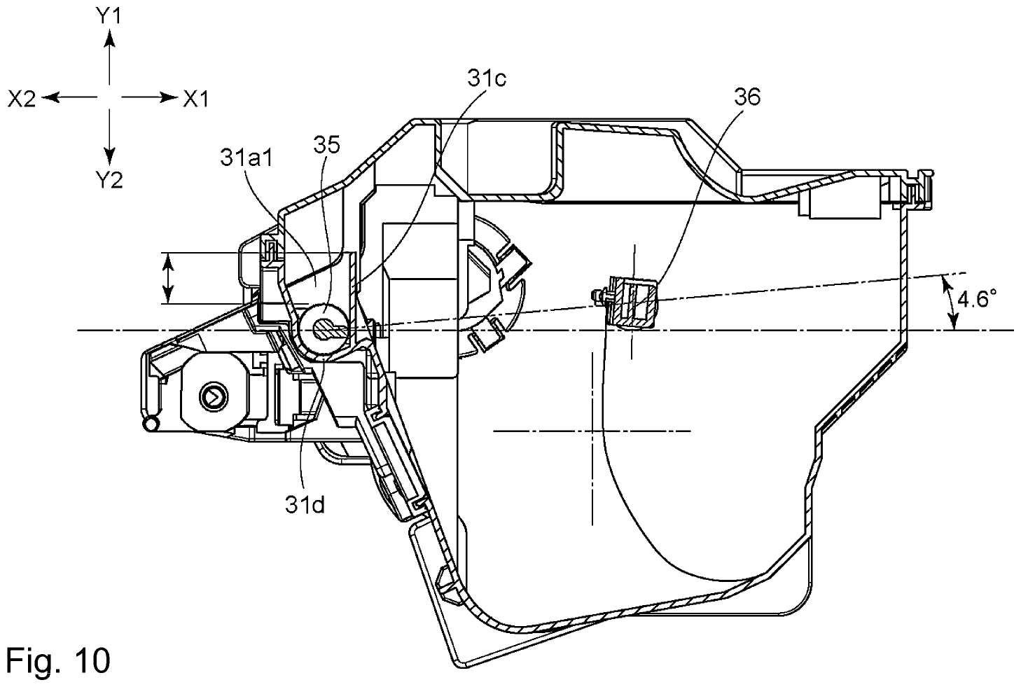

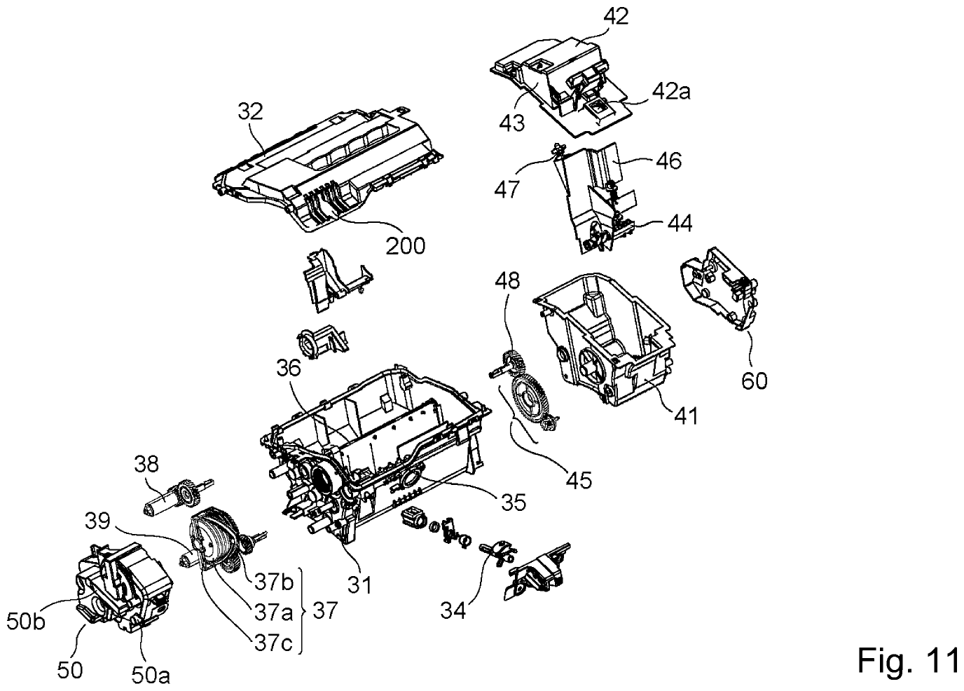

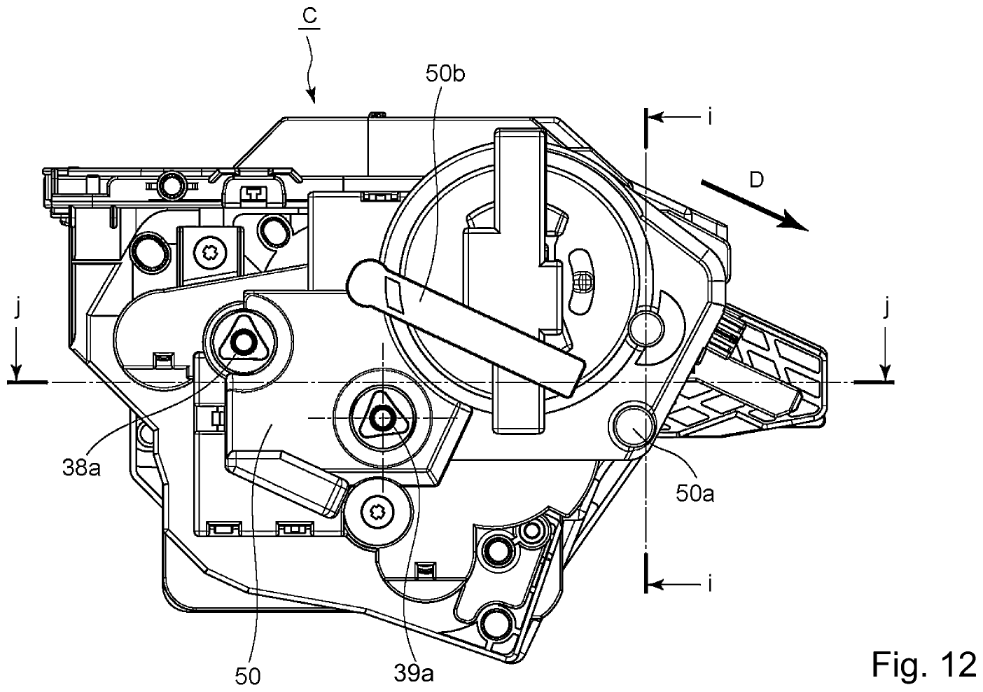

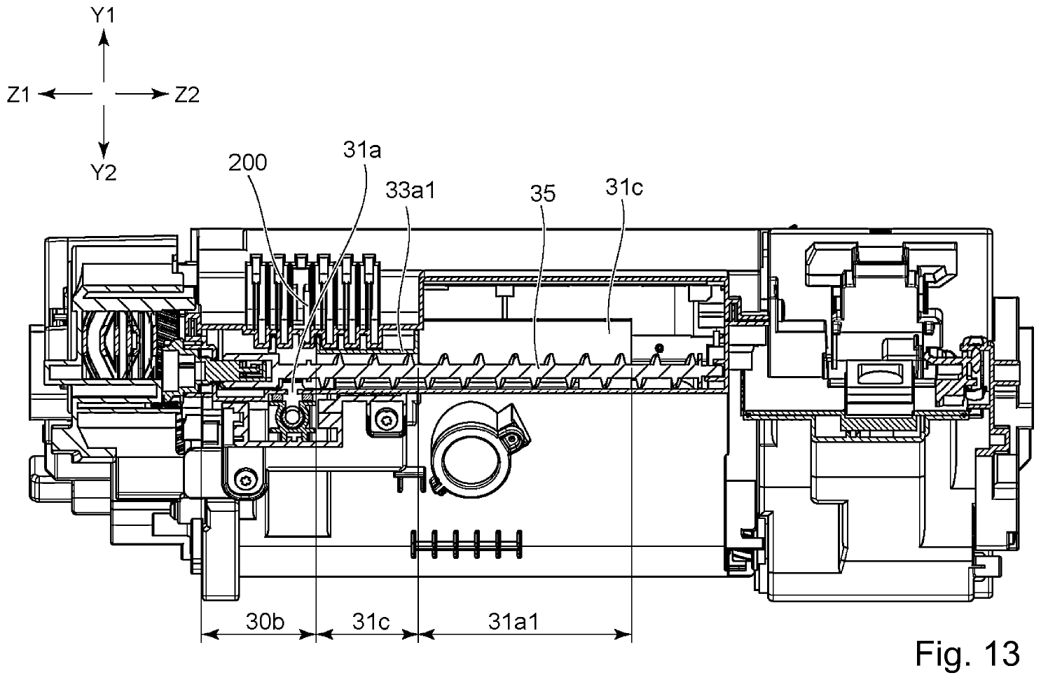

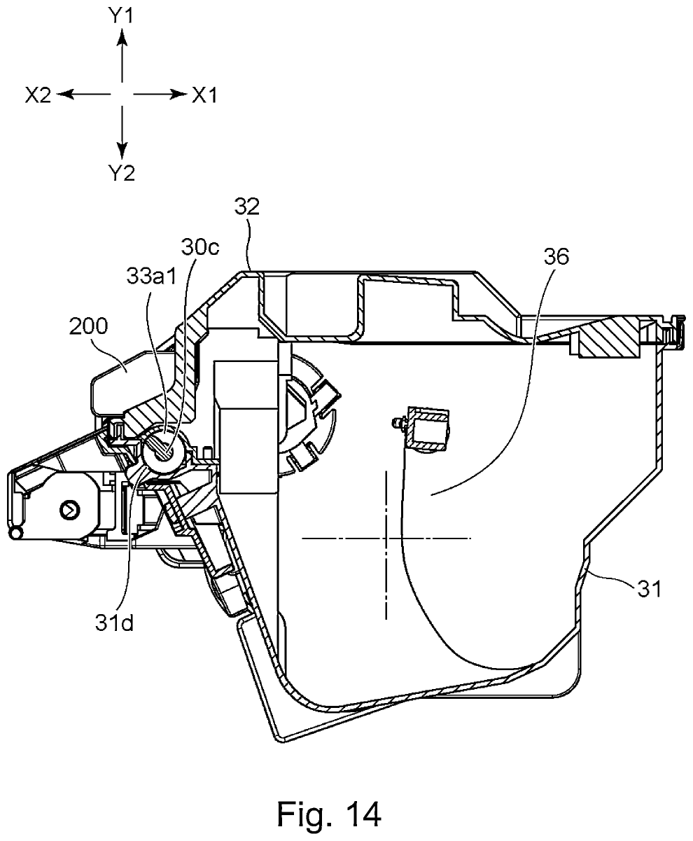

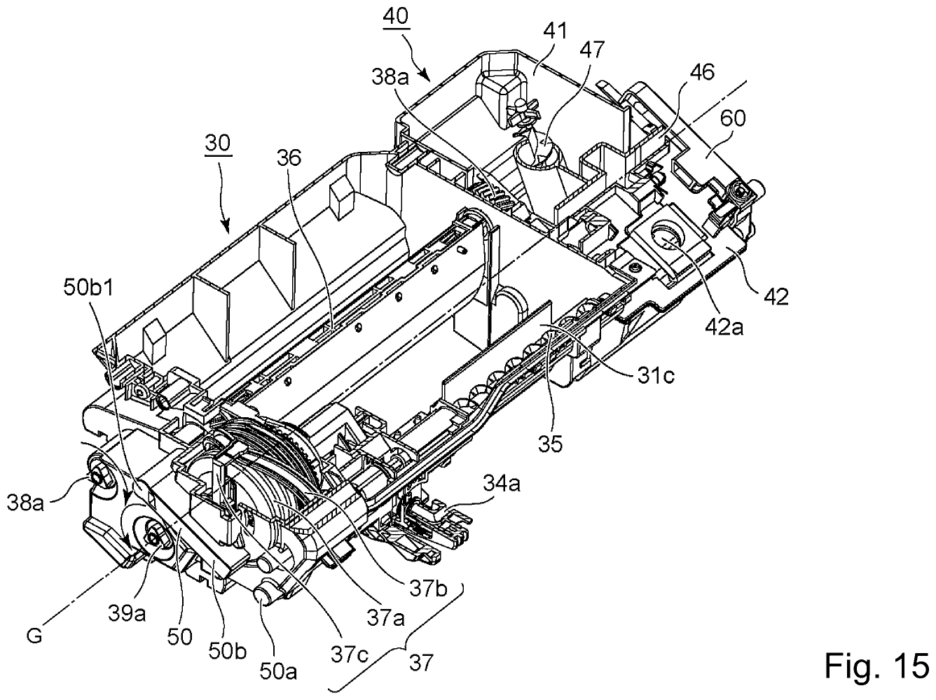

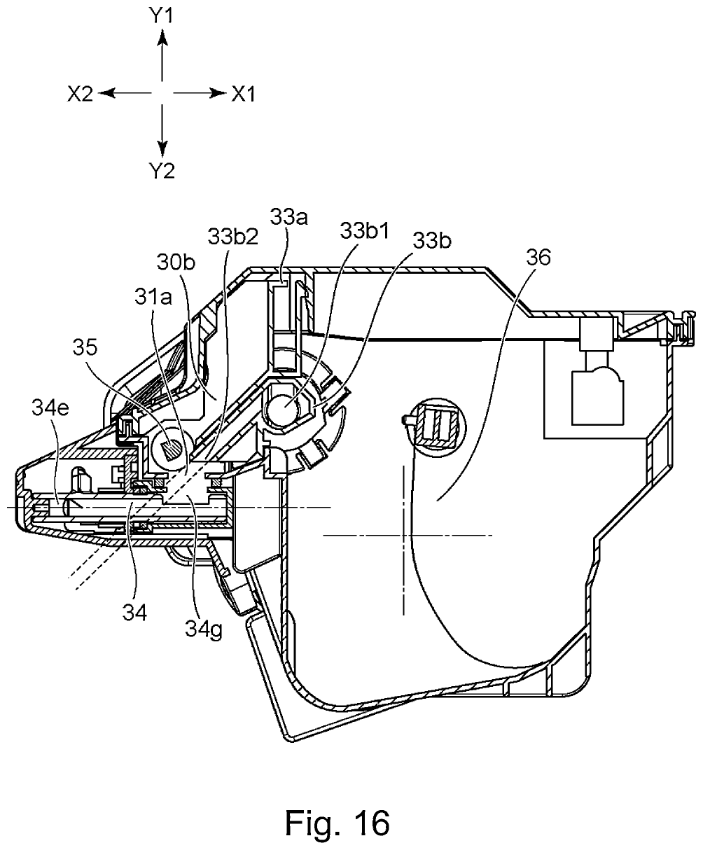

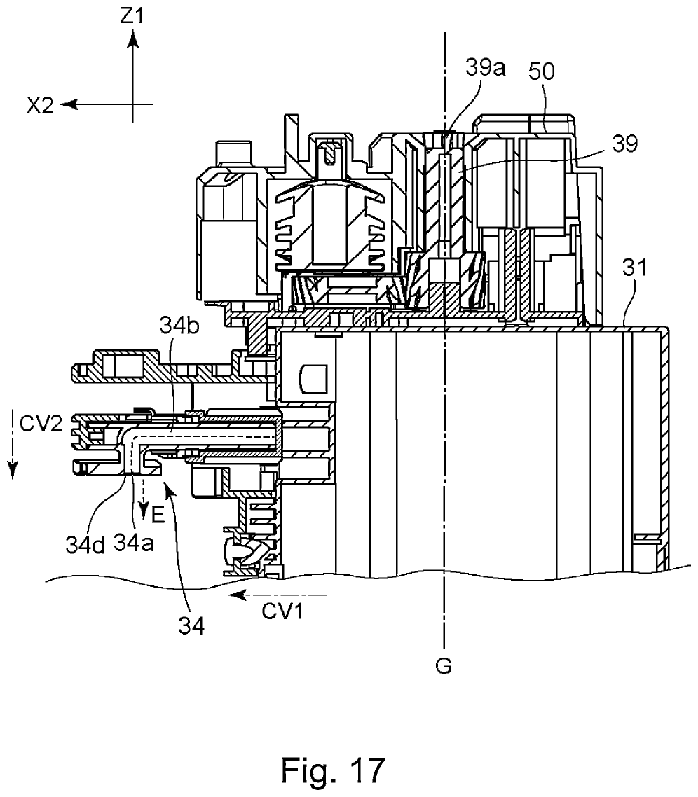

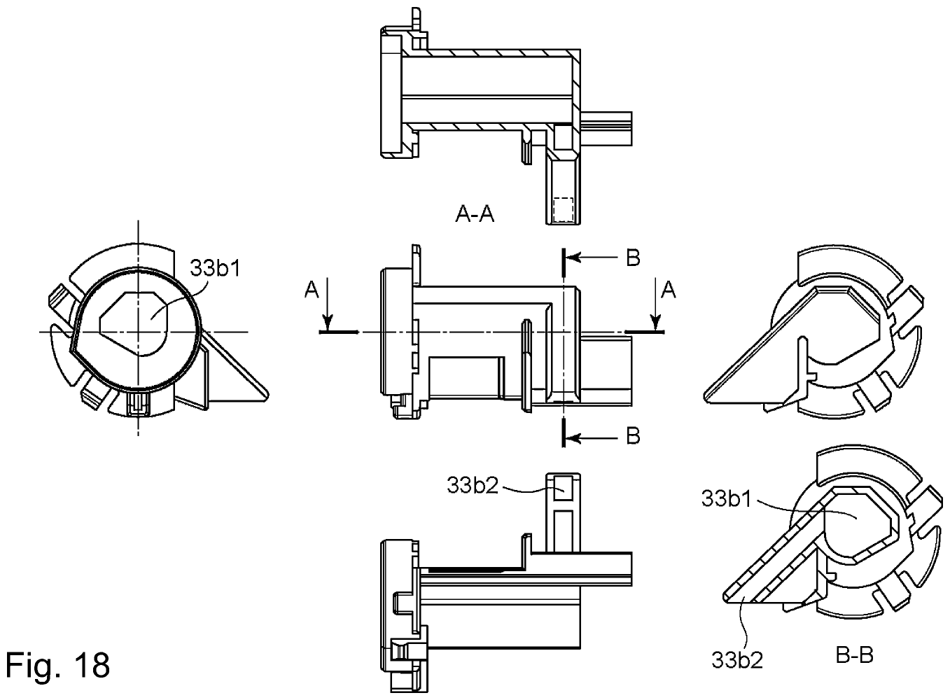

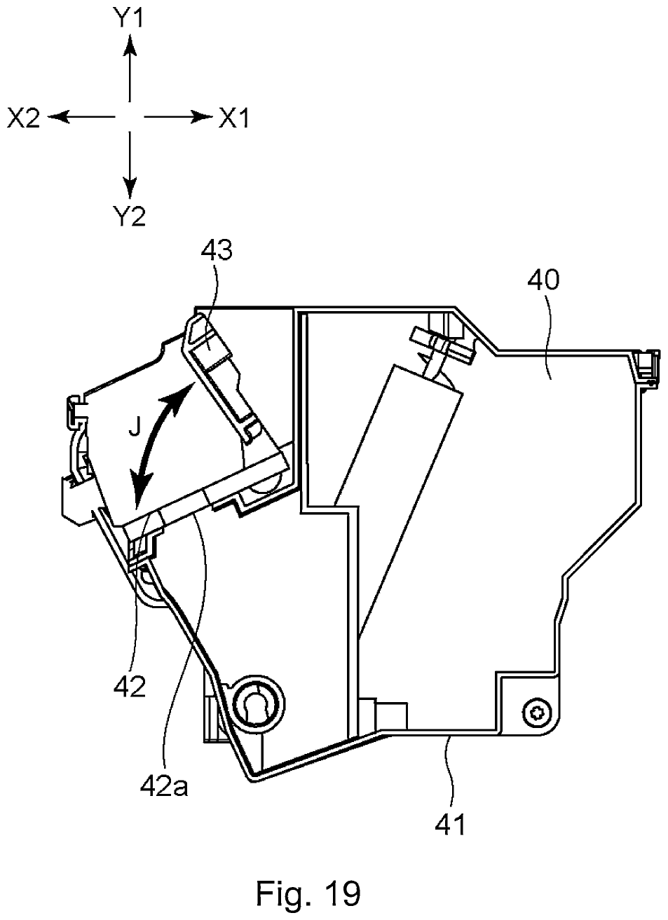

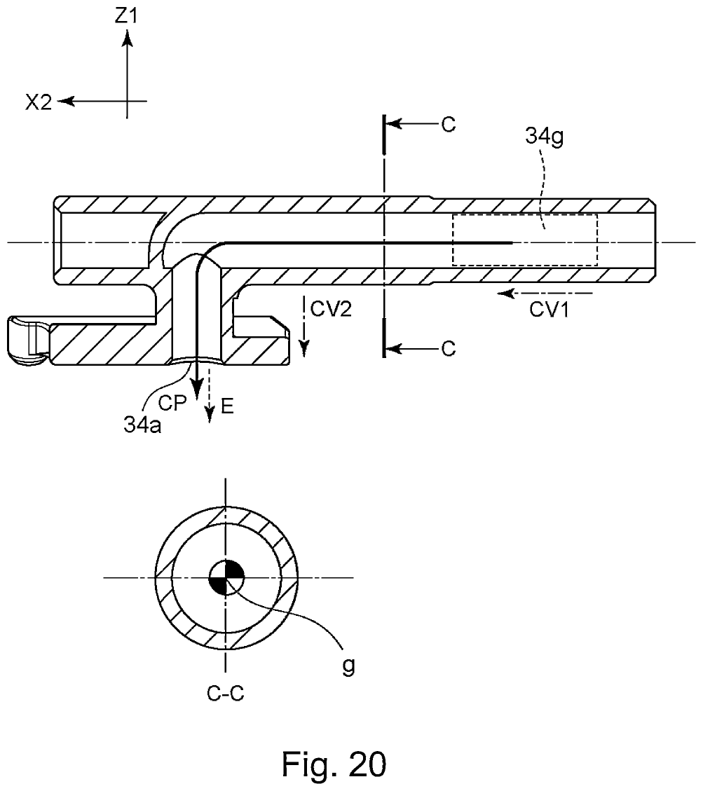

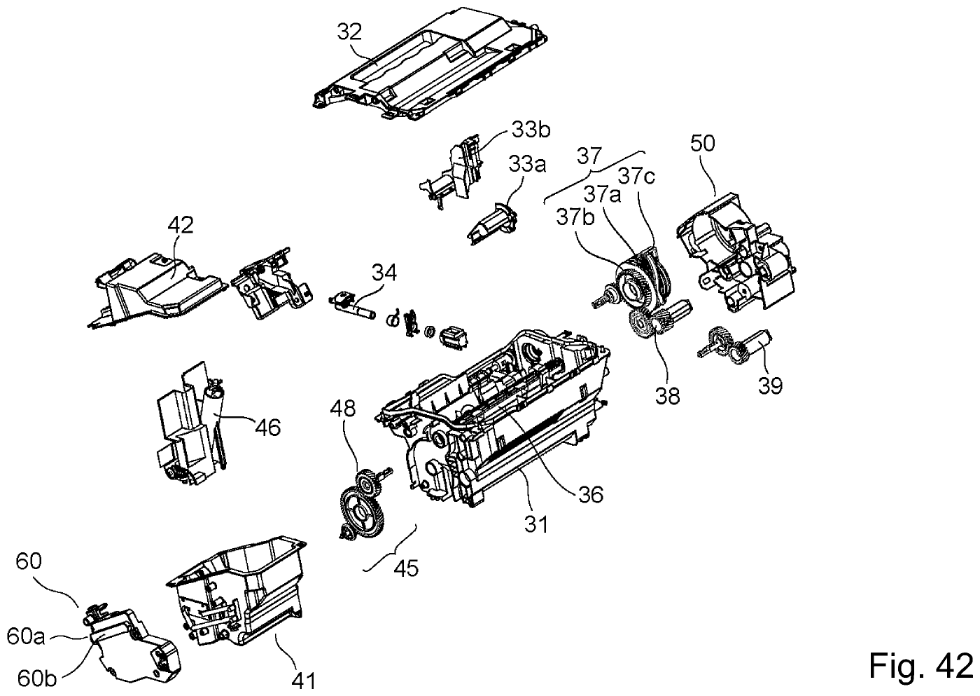

Next, referring to FIGS. 9-20, the toner cartridge C according to Embodiment 1 of the present invention will be described in detail. FIG. 9 is a front view of the toner cartridge C according to Embodiment 1 of the invention, showing the toner cartridge C mounted in the printer main assembly A. FIG. 10 is a main cross-sectional view (cross-section taken along line e-e in FIG. 9) showing the toner accommodating portion 30 of the toner cartridge C according to Embodiment 1 of the present invention. FIG. 11 is an exploded perspective view of the toner cartridge C according to Embodiment 1 of the present invention, as viewed from the drive side. FIG. 42 is an exploded perspective view of the toner cartridge C according to Embodiment 1 of the present invention, as viewed from the non-drive side. FIG. 12 is a side view of the toner cartridge C according to Embodiment 1 of the present invention as viewed from the drive side. FIG. 13 is a cross-sectional view (cross-section taken along line i-i in FIG. 12) based on the center of the rotation axis of the toner accommodating portion screw member 35 of the toner cartridge C according to Embodiment 1 of the present invention. FIG. 14 is a cross-sectional view (cross-section taken along line h-h in FIG. 9) for explaining an example of the level-off portion 33al of the toner cartridge C according to Embodiment 1 of the present invention. FIG. 15 is a cross-sectional perspective view taken along the longitudinal direction of the toner cartridge C according to Embodiment 1 of the present invention. FIG. 16 is a cross-sectional view (cross-section f-f shown in FIG. 9) based on the center of the rotation shaft of the shutter member 34 of the toner cartridge C according to Embodiment 1 of the present invention. FIG. 17 is a cross-sectional view (cross-section taken along a line j-j shown in FIG. 12) based on the center of the rotation shaft of the shutter member 34 of the toner cartridge C according to Embodiment 1 of the present invention. FIG. 18 is a front view, a left side view, a right side view, a bottom view, and various cross-sectional views of the nozzle member 33b in Embodiment 1 of the present invention. FIG. 19 is a cross-sectional view (cross-section taken along line g-g in FIG. 9) of an example of the waste toner storage portion 40 of the toner cartridge C according to Embodiment 1 of the present invention. FIG. 20 is a cross-sectional view of the shutter member 34 for illustrating an example of the feed passageway CP of the shutter member 34 according to Embodiment 1 of the present invention.

As shown in FIGS. 9, 10 and 19, the toner cartridge C of this embodiment has a toner accommodating portion 30 which stores the toner to be supplied to the process cartridge B, and a waste toner storage portion 40 which collects the waste toner from the process cartridge B. In addition, the toner cartridge C has a drive side toner cartridge side cover 50 provided on one side, sandwiching the toner accommodating portion 30 and the waste toner storage portion 40 therebetween, in a direction parallel to the rotational drive axis G of the pump-screw drive input portion 39 which will be described hereinafter. In addition, in the toner cartridge C, in the direction parallel to the rotation drive axis G, a non-drive side toner cartridge side cover 60 is provided on the other side, sandwiching the toner accommodating portion 30 and the waste toner storage portion 40 therebetween. That is, the frame which defines the outer shape of the toner cartridge C is formed by the toner accommodating portion 30, the waste toner storage portion 40, the drive side toner cartridge side cover 50, and the non-drive side toner cartridge side cover 60. In other words, the toner cartridge C is an assembly of separate frames including a plurality of accommodating portions and side covers, respectively.

In this embodiment, an axis parallel to the rotational drive axis G of the pump-screw drive input portion 39 is referred to as a Z axis. The X-axis, Y-axis, and Z-axis of the toner cartridge C per se is aligned with the X-axis (X1, X2 directions), Y-axis (Y1, Y2 directions), and Z-axis (Z1, Z2 directions) of the printer main assembly A and process cartridge B when the toner cartridge C is mounted to the printer main assembly A.

The toner accommodating portion 30 will now be described in detail. As shown in FIGS. 10, 11 and 42, the toner accommodating portion 30 is formed by an accommodating portion frame 31 and an accommodating portion lid 32. The toner accommodating chamber 30a includes the toner accommodating portion screw member 35 for feeding the toner toward the toner discharge opening 34a, and a toner accommodating portion stirring/feeding unit 36 for feeding the toner toward the toner accommodating portion screw member 35.

Here, as shown in FIG. 10, the horizontal direction of the completely mounted position of the toner cartridge C in the printer main assembly A is inclined by 4.6 degrees with respect to the straight line connecting the centers of rotation of the toner accommodating portion screw member 35 and the toner accommodating portion stirring/feeding unit 36.

As shown in FIG. 13, the accommodating portion frame 31 is provided with a supply opening 31a on a downstream side of the toner accommodating portion screw member 35 in the feeding direction. The portion of the accommodating portion frame 31 corresponding to the screw portion 35a of the toner accommodating portion screw member 35 has a curved portion 31d having substantially the same diameter as the screw.

As shown in FIG. 10, a partition wall 31c is provided on the upstream side of the toner accommodating portion screw member 35 in the feeding direction. The partition wall 31c is provided continuously opposing the curved portion 31d. The space between the partition wall 31c and the curved portion 31d is open upward in the direction of gravity. The curved portion 31d and the partition wall 31c of the accommodating portion frame 31 form a toner reservoir portion 31a1. The height of the partition wall 31c is higher than an apex of the toner accommodating portion screw member 35, and the toner reservoir 31al is shaped so that the upper side in the direction of gravity is open when the toner cartridge C is in the completely mounted position.

As shown in FIGS. 13 and 15, the partition wall 31c does no continuously extend to the upstream end portion of the toner accommodating portion screw member 35 in the feeding direction, so that the partition wall 31c does not exist in the neighborhood of the upstream end portion of the toner accommodating portion screw member 35, but because of the feed force of the toner accommodating portion screw member 35, the toner can be stored in the toner reservoir portion 31a1.

As shown in part (a) of FIG. 11, the toner accommodating portion stirring/feeding unit 36 is driven by a stirring drive input portion 38 which is rotatably supported at the longitudinal end side of the toner accommodating portion 30 (i.e. outside of the toner accommodating portion 30), so that the stirring part is rotatable. A method of inputting driving force from the printer main assembly A to the stirring drive input portion 38 will be described in detail hereinafter. The toner feed power of the toner accommodating portion stirring/feeding unit 36 varies depending on the amount of the toner present in the toner accommodating portion 30. In this embodiment, therefore, a toner reservoir 31al is provided in the neighborhood of the toner accommodating portion screw member 35 in the form of an area where the partition wall 31c is provided. With this structure, the toner accommodating portion screw member 35 can suppress variation in the pressure of the toner powder in the toner reservoir 31a1, regardless of the amount of the toner present inside the toner accommodating portion 30. That is, because the toner cartridge C according to this embodiment is provided with the toner reservoir 31a1, it is possible to suppress variation in the amount of the toner fed by the toner accommodating portion screw member 35.

In addition, as shown in FIG. 14, the toner accommodating portion 30 is provided with a level-off portion 33al for adjusting the amount of the toner feed to be constant. The level-off portion 33al is formed on the partition member 33a provided between the partition wall 31c and the supply opening 31a in the feeding direction of the toner accommodating portion screw member 35.

The shape of the level-off portion 33al is a curved shape having substantially the same diameter as the outer diameter of the toner accommodating portion screw member 35. As described above, the accommodation frame 31 also has the curved portion 31d. In the cartridge C of this embodiment, the toner accommodating portion screw member 35 is disposed in the space formed by combining the curved portion of the level-off portion 33al and the curved portion 31d of the accommodation frame 31 (i.e., the area surrounded by the two curved portions), in the feeding direction. Therefore, within the region defined by the two curved portions, the amount of the toner conveyed by the toner accommodating portion screw member 35 to the supply opening 31a can be kept constant. The space formed by combining the level-off portion 33al and the curved portion 31d of the accommodating portion frame 31 (the area surrounded by the two curved portions) is referred to as a feed passageway 30c.

In addition, the length of the level-off portion 33al measured along the feeding direction is preferably equal to or greater than two pitches (two consecutive threads) of the screw portion of the toner accommodating portion screw member 35. This is in order to prevent the toner from flowing back due to air supplied by a pump 37a (which will be described hereinafter) against feeding operation by the toner accommodating portion screw member 35.

As described above, the toner cartridge C of this embodiment can reduce variation in the amount of the toner fed to the supply opening 31a of the toner storage frame 3, 1 by providing the partition wall 31c and the level-off portion 33a1.

Next, a structure for inputting a driving force from an external source provided to the toner cartridge C will be described. As shown in FIG. 11, the toner cartridge C includes a pump unit 37, the stirring drive input portion 38, the pump-screw drive input portion 39, and a drive side toner cartridge side cover 50 covering the pump 37a of the pump unit 37. The above-described components are disposed on the side of the toner cartridge C where the stirring drive input portion 38 is provided (the drive side). In contrast, the above-mentioned waste toner storage portion 40 is disposed on a non-drive side which is the opposite side to the drive side of the toner cartridge C (in the longitudinal direction of the toner cartridge C). The parts of the waste toner storage portion 40 will be described in detail hereinafter.

As shown in FIGS. 11, 12 and 15, the pump unit 37 has a pump 37a, as a volume changing means of the image forming apparatus according to this embodiment, a cam gear 37b for expanding and contracting the pump 37a, and a link arm 37c. The stirring drive input portion 38 is a driving means for driving the toner accommodating portion stirring/feeding unit 36. The pump-screw drive input portion 39 is a drive means for driving the pump 37a and the toner accommodating portion screw member 35.

As shown in FIGS. 11, 12 and 15, the pump unit 37, the stirring drive input portion 38 and the pump-screw drive input portion 39 are all disposed outside the toner accommodating portion 30. Of these parts, the stirring drive input portion 38 and the pump-screw drive input portion 39 are rotatably supported outside the toner accommodating portion 30.

The pump-screw drive input portion 39 is a first driving force receiving member in this embodiment, and includes a pump-screw coupling portion 39a having a projection shape exposed through the drive side toner cartridge side cover 50. The pump-screw coupling portion 39a is a driving force receiving portion (first driving force receiving portion) in this embodiment.

The stirring drive input portion 38 is a second driving force receiving portion in this embodiment, and includes a driving/stirring coupling portion 38a having a projection shape exposed through the drive side toner cartridge side cover 50. The driving/stirring coupling portion 38a is a driving force receiving portion (second driving force receiving portion) in this embodiment. That is, the toner cartridge C according to this embodiment is provided with two coupling members at one end, in the longitudinal direction, of the toner cartridge C, as toner cartridge side coupling members.

The pump-screw coupling portion 39a can receive a driving force from the printer main assembly A side when it is engaged with the first main assembly side coupling 110 (first main assembly side coupling member) of the printer main assembly A. Furthermore, the driving/stirring coupling portion 38a can obtain a driving force from the printer main assembly A when engaged with a second main assembly side coupling (second main assembly side coupling member) of the printer main assembly A. As shown in FIG. 15, the rotational drive axis of the pump-screw drive input portion 39 is indicated by an axis G. The axis G is set to be substantially parallel to the rotation axis 11b of the photosensitive drum 11 and the rotation drive axis of the stirring drive input portion 38 of the process cartridge B.

As shown in FIG. 15, the pump unit 37 comprises the pump 37a as a volume changing means in the image forming apparatus in this embodiment, the cam gear 37b for expanding and contracting the pump 37a, and the link arm 37c. The cam gear 37b includes a gear portion 37b1 for receiving the rotational driving force outputted from the pump-screw coupling portion 39a. Therefore, the gear portion 37b1 (i.e., the cam gear 37b) is rotated by the driving force transmitted from the pump-screw coupling portion 39a. A link arm 37c linked with the cam gear 37b reciprocates in the direction of the axis G as the cam gear 37b rotates. The contact surface of the link arm 37c with the pump 37a is more outside the toner accommodating portion 30 than the pump 37a in the direction of the axis G, and therefore, the pump 37a expands and contracts along the axis G by the reciprocating motion of the link arm 37c described above. That is, the direction in which the pump 37a expands and contracts is substantially parallel to the axis G.

Although not shown in the Figure, the gear portion 37b1 of the cam gear 37b also meshes with a drive gear (not shown) provided at a Z1 direction end of the toner accommodating portion screw member 35, so that the driving force is transmitted to the toner accommodating portion screw member by way of the drive gear. The drive gear and the toner accommodating portion screw member 35 are rotatable coaxially, so that when the drive gear rotates, the toner accommodating portion screw member 35 also rotates in the same direction.

As shown in FIGS. 16 and 17, the toner accommodating portion 30 includes a nozzle member 33b connected to the pump 37a. Further, a toner discharge opening 34a of a shutter member 34 is disposed below the supply opening 31a. The shutter member 34 is a toner discharge member of the toner cartridge C in this embodiment, and is rotatably mounted to the toner cartridge C. The toner discharge opening 34a opens toward the outside of the toner cartridge C. That is, the shutter member 34 has a function as a feeding member for feeding the toner from the accommodation frame 31 toward the process cartridge B, and also a function as a discharge member for discharging the toner toward the process cartridge B.

As shown in FIGS. 16 and 18, the nozzle member 33b is provided with a pump side opening 33b1 and a toner side opening 33b2. The nozzle member 33b has a shape defining an internal space formed by connecting a space extending from the toner side opening 33b1 in the direction of the axis G to a space extending from the toner side opening 33b1 in a direction intersecting the axis G, i.e. direction intersecting the feeding direction of the toner accommodating portion screw member 35. As shown in FIG. 18, the cross-sectional area of the toner side opening 33b2 is smaller than the cross-sectional area of the pump side opening 33b1.

As shown in FIG. 16, the toner side opening 33b2 is disposed at a level higher than the supply opening 31a. The toner side opening 33b2 is disposed, in the height direction of the toner cartridge C, between the rotation center of the toner accommodating portion screw member 35 and the supply opening 31a. As shown in FIG. 16, as the toner cartridge C is viewed in the rotation axis direction of the shutter member 34, the nozzle member 33b is disposed so that a part of the supply opening 31a overlaps an extension line of the toner side opening 33b2.

The air flow produced by the contraction of the pump 37a flows from the pump side opening 33b1 to the toner side opening 33b2. At this time, since the cross-sectional area of the toner side opening 33b2 is smaller than that of the pump side opening 33b1, the speed (flow velocity) of the air flowing through the toner side opening 33b2 is higher. The air flowing through the toner side opening 33b2 is mixed with the toner fed into the supply opening 31a by the toner accommodating portion screw member 35. The toner mixed with the air is then fed from the supply opening 31a through the shutter inlet 34g to the toner discharge opening 34a and supplied into the process cartridge B.

As described above, in the toner cartridge C of the image forming apparatus according to this embodiment, the toner side opening 33b2 of the nozzle member 33b is positioned at a position away from the supply opening 31a and faces in a direction intersecting the feeding direction of the toner accommodating portion screw member 35. With this structure, the image forming apparatus according to this embodiment can prevent toner from entering the pump 37a even if the user orients the toner cartridge C such that the pump 37a of the toner cartridge C at a lower side. When toner enters the inside of the pump 37a, the force required for expanding and contracting the pump 37a increases. To solve this problem, the image forming apparatus of this embodiment employs the above-described structure, thereby reducing the amount of the toner entering the pump 37a, so that the increase in torque applied to the pump-screw coupling portion 39a can be suppressed.

In the toner cartridge C according to this embodiment, a supply chamber 30b is provided along the feeding direction of the toner accommodating portion screw member 35 in order to efficiently supply the air delivered by the contracting action of the pump 37a to the toner discharge opening 34a. Specifically, in a downstream side of the level-off portion 33al in the feeding direction of the toner accommodating portion screw member 35, the supply chamber 30b is provided which is separated from the toner accommodating portion 30a and divided by a partition member 33a, the nozzle member 33b, the accommodating portion lid 32, and the accommodating portion frame 31. The cross-sectional areas of the toner accommodating portion 30a, the supply portion 30b, and the feed passageway 30c are such that the toner accommodating portion 30a is the largest, the supply portion 30b is second largest, and the feed passageway 30c is the smallest.

The shutter member 34 is provided with a feed passageway CP and a discharge portion which are a toner feeding means which includes a toner feed nozzle (toner feeding member) of the toner cartridge C in this embodiment, and is used when supplying toner from the toner cartridge C to the process cartridge B. The shutter member 34 is rotatable in response to the mounting operation of the toner cartridge C into the printer main assembly A, and the rotation thereof can open and close a toner discharge opening 34a, which will be described hereinafter. Specifically, the shutter member 34 according to this embodiment can transition between a state in which the toner can be discharged (open state) and a state in which the toner is sealed in (closed state) by rotating the shutter member 34. The shutter member 34 can control whether or not toner is supplied to the process cartridge B by switching between an open state and a closed state. The closed state of the shutter member 34 means a state in which the passageway from the supply opening 31a of the accommodation frame 31 to the feed passageway 34b of the shutter member 34 is blocked.

As shown in FIGS. 16 and 17, the shutter member 34 includes a shutter inlet 34g for receiving the toner from the supply opening 31a, a toner discharge opening 34a, a feeding portion 34b for feeding the toner between the shutter inlet 34g and the toner discharge opening 34a, and an edge portion 34d. The shutter inlet 34g functions as a toner receiving opening for receiving the toner from the toner accommodating portion 30 side. The toner discharge opening 34a functions as a toner discharge portion of the toner cartridge according to this embodiment, and is an opening formed by an edge portion 34d. That is, the edge portion 34d forms the free end of the cylindrical portion formed by the feeding portion 34b and the opening of the toner discharge opening 34a.

The state shown in FIG. 17 is the open state of the shutter member 34. In this embodiment, the direction in which toner is discharged from the toner discharge opening 34a is referred to as a discharging direction E, which is indicated by a broken line arrow in the drawing. The direction in which the toner is fed by the feeding portion 34b is a feeding direction CV, and is indicated by a chain line arrow in the Figure. In this embodiment, as will be described hereinafter, the feeding portion 34b is bent midway, and therefore, the feeding direction CV is shown divided into a plurality of components (a first feeding direction CV1, a second feeding direction CV2).

As shown in FIG. 17, when the toner cartridge C is mounted to the printer main assembly A, a part of the feeding portion 34b intersects with the axis G which is the rotational drive axis of the pump-screw drive input portion 39, and extends in a direction away from the axis G. That is, the first feeding direction (first direction) CV1 of the toner by the feeding portion 34b intersects with the axis G of the pump-screw drive input portion 39 and includes a component in a direction away from the axis G.

Also, as shown in FIG. 17, the other part of the feeding portion 34b extends in a direction parallel to the axis G which is the rotational drive axis of the pump-screw drive input portion 39, and in a direction away from the pump-screw coupling portion 39a. That is, the second feeding direction CV2 of the toner by the feeding portion 34b is parallel to the axis G of the pump-screw drive input portion 39 and includes a component in a direction away from the pump-screw coupling portion 39a for receiving the driving force for feeding the toner.

As shown in FIG. 17, the toner discharged from the toner discharge opening 34a is discharged in a discharging direction E parallel to the axis G and away from the pump-screw coupling portion 39a. That is, a discharging direction (second direction) E of the toner discharged from the toner discharge opening 34a is a direction parallel to the axis G of the pump-screw drive input portion 39. The toner discharging direction E is parallel to the central axis of the circular toner discharge opening 34a and is a direction away from the toner discharge opening 34a. Alternatively, the normal direction (direction away from toner discharge opening 34a) to a two-dimensional projection plane (which is circular) of toner discharge opening 34a on a plane perpendicular to axis G is the toner discharging direction E. The toner discharging direction E includes a component in a direction away from the pump-screw coupling portion 39a for receiving the driving force for feeding the toner. At least a part of a component included in the toner discharging direction at the toner discharge portion 34a and a component included in the second feeding direction on the passageway from the feeding portion 34b to the toner discharge portion 34a coincide with each other.

Next, referring to FIG. 20, the toner feed passageway CP in the shutter member 34 will be described in detail. The toner feed passageway CP is a passageway along which the toner moves when it moves in the feeding portion 34b of the shutter member 34. As shown in FIG. 20, in a cross-section of the feeding portion 34b perpendicular to the feeding passageway CP indicated by the solid arrow, a center of gravity g of the cross-section is taken as an arbitrary position of the feeding passageway CP. However, in a part where the cross-section of the feeding portion 34b is partially missing, it is difficult to define the exact position of the center of gravity g. Therefore, in this embodiment, the most upstream point and the most downstream point of the feeding portion 34b that have no defects or the like in the cross-sections are defined as the start point and the end point of the feed passageway CP, respectively. The cross-sectional shape of the feeding portion 34b relating to the toner feed passageway CP is not limited to a circular shape. For example, the cross-sectional view of the feeding portion 34b may have any shape as long as it is not difficult to calculate or estimate the center of gravity g, as in a case that the outer edge of the cross-section of the feeding portion 34b is interrupted or the cross-sectional shape includes a sudden change.

In this embodiment, a line continuously connecting the centers of gravity of successive cross-sections of the toner feed passageway CP is defined as a toner feed line. The toner feed line is a line that indicates a main passageway of the toner feed passageway CP and generally passes through approximately the center of each cross-section, but this is not the case at the places where a sudden angle change in the shape of the feeding portion 34b exists. The direction of the toner feed line is the toner feeding direction at each point. The toner feeding direction CV2 at the end point of the toner feed passageway CP is the same as the toner discharging direction E.

As described above, the toner discharged from the toner discharge opening 34a is discharged in a discharging direction E which is parallel to the axis G and which has a component in a direction away from the pump-screw drive input portion 39 (see FIG. 17). With this structure, the image forming apparatus according to this embodiment can prevent the coupling portion of the printer main assembly A which engages with the pump-screw coupling portion 39a of the toner cartridge C from being dirtied with toner.

As shown in FIG. 11, the shutter member 34 is disposed on the side of the toner accommodating portion 30 where the pump-screw drive input portion 39 is placed in the longitudinal direction of the toner cartridge (the direction parallel to the Z axis described above). More specifically, the shutter member 34 in this embodiment is located on the side where the pump-screw drive input portion 39 is provided with respect to the center position of the toner accommodating portion 30 along at least the Z axis. Therefore, in the toner cartridge C according to this embodiment, it is possible to reduce the loss of discharging force when discharging toner due to volume fluctuations in the pump 37a, and to prevent upsizing of the discharging mechanism.

Furthermore, as shown in FIG. 11, a storing medium (electrical substrate) 203 including an electrical contact portion 203a as an electrode for electrical connection with the printer main assembly A is provided on the same side as the shutter member 34 in the longitudinal direction of the toner cartridge C. The storing medium 203 is a recording means in which the toner cartridge C stores various information relating to itself. The electrical contact portion 203a is connected to a main assembly side contact portion (not shown) provided in the printer main assembly A to establish communication between the printer main assembly A and the toner cartridge C, thus enabling the exchange of information between the them. When the toner cartridge C is mounted to the printer main assembly A, the electrical contact portion 203a is located above the toner discharge opening 34a of the shutter member 34 in the direction of gravity which is substantially perpendicular to the longitudinal direction of the toner cartridge C. Therefore, the toner cartridge C according to this embodiment is structured such that the electrical contact portion 203a is not easily affected by scattered toner. The electrical contact portion 203a is provided on a drive side toner cartridge side cover 50, which will be described hereinafter. As shown in FIGS. 11, 13 and 14, the accommodating portion lid 32 is provided with a shutter opening/closing rib 200 as a shutter opening/closing member. The shutter opening/closing rib 200 is a member for opening and closing the laser shutter RS which covers the laser scanner 101 provided inside the laser printer 1. Specifically, in interrelation with the insertion operation of the toner cartridge C, the shutter opening/closing rib 200 moves the mechanism for opening the laser shutter RS described above in the opening direction, thereby enabling the laser scanner 101 to expose the surface of the photosensitive drum 11. That is, in interrelation with the insertion of the toner cartridge C into the printer main assembly A, the laser shutter RS transitions from a closed state to an open state. At this time, the process cartridge B has been inserted into the printer main assembly A before the toner cartridge C, but the operation of the shutter opening/closing rib 200 to open and close the laser shutter RS is performed not by way of the process cartridge B.

Incidentally, in a state in which the toner cartridge C is not mounted to the printer main assembly A, the laser shutter RS is brought into the closed state. Therefore, even if a laser is erroneously irradiated from the laser scanner 101 in the state in which the toner cartridge C is mounted, the laser light can be prevented from being leaked to outside the printer main assembly A.

(Toner supply passageway from toner cartridge C to process cartridge B).

As shown in FIG. 13, as the toner cartridge C is viewed from the rear side, it is desirable that the shutter opening/closing rib 200 is disposed above the toner feed screw member 35 so as to overlap with the supply portion 30b and/or the feed passageway 30c. In other words, in the direction parallel to the Z axis, the shutter opening/closing rib 200 is disposed at the same position as the supply portion 30b and/or the feed passageway 30c. The side opposite to the direction of gravity when the toner cartridge C is mounted to the printer main assembly A placed on a horizontal surface is the upper side of the toner cartridge C.

In order to determine the cross-sectional areas of the toner accommodating portion 30 in the toner feed direction so as to satisfy toner accommodating portion 30 a >supply chamber 30b>feed passageway 30c as described above, the areas overlapping with the supply chamber 30b and the feed passageway 30c need to be made smaller than the toner reservoir portion 31al. Specifically, the dimensions of the toner accommodating portion 30 on the side opposite to the direction of gravity (i.e., the upper side) has to be restricted so that the supply chamber 30b and the feed passageway 30c are smaller than the toner reservoir portion 31a1. Therefore, in the image forming apparatus according to this embodiment, as described above, the shutter opening/closing rib 200 is disposed on an upstream side in the mounting direction of the toner cartridge C and at a position where the influence on the volume of the toner cartridge C is small. In addition, by placing the shutter opening/closing rib 200 on the upstream side in the mounting direction, a mechanism for opening and closing the laser shutter in interrelation with the mounting operation of the toner cartridge C into the printer main assembly A can be easily accomplished.

Further, with an image forming apparatus employing a mountable and dismountable type cartridge, a cartridge which is unclear in compatibility with the printer main assembly A may be erroneously mounted to the main assembly. Taking such a case into consideration, in this embodiment, a plurality of slits 32c are provided on the accommodating portion lid 32 for selective acceptance of insertion of the shutter opening/closing ribs 200 therein. With this structure, an incompatible cartridge will interfere with the shutter opening/closing rib 200, so it is possible to prevent an incompatible cartridge from being erroneously mounted in the printer main assembly A.

Next, the waste toner storage unit 40 will be described in detail. As shown in FIG. 19, the waste toner storage unit 40 includes a waste toner storage unit frame 41, a waste toner storage lid 42, and a waste toner shutter member 43. The outer shape of the waste toner main portion 40 is defined by a waste toner storage frame 41 and a waste toner storage lid 42. As shown in FIG. 15, a drive side toner cartridge side cover 50 is mounted to the drive side of the toner cartridge C (i.e., the lateral side of the toner accommodating portion 30). Further, a non-driven side toner cartridge side cover 60 is mounted to the waste toner storage portion (40) side of the toner cartridge C (i.e., the lateral side of the waste toner storage portion 40).

The waste toner storage lid 42 is provided with a waste toner receiving opening 42a. The waste toner shutter member 43 functions as a shutter means for opening and closing the waste toner receiving opening 42a. The waste toner shutter member 43 moves in a direction J shown in FIG. 19 in interrelation with the mounting and dismounting operation of the toner cartridge C into and from the printer main assembly A, thereby opening and closing the waste toner receiving opening 42a described above. FIG. 19 shows the state in which the waste toner shutter member 43 is in open state.

As shown in FIGS. 11 and 42, inside the waste toner storage portion 40, there are provided a first waste toner storage screw 44, a waste toner storage gear train 45, a partition member 46, and a second waste toner storage screw 47. The first waste toner storage screw 44 feeds the waste toner received (dropped) through the waste toner receiving opening 42a, in the direction of the rotation axis 11b of the photosensitive drum 11. The second waste toner storage screw 47 is driven by the first waste toner storage screw 44 to feed the waste toner fed by the first waste toner storage screw 44 to the upper side of the toner cartridge C. That is, the first waste toner storage screw 44 and the second waste toner storage screw 47 are waste toner feed members according to this embodiment.

As for the driving force for the waste toner storage portion 40, the driving force inputted from the above-described stirring drive input portion 38 is first transmitted by way of the toner storage portion stirring/feeding unit 36 to the toner storage portion non-driven side gear 48 disposed on the non-driven side of the toner accommodating portion 30. Then, the driving force is transmitted from the toner storage portion non-drive side gear 48 to the first waste toner storage screw 44 by way of the waste toner storage portion gear train 45.

With the above-described structure, the toner cartridge C of this embodiment can drive the stirring drive input portion 38 even when the pump/screw drive input portion 39 is not driven. In other words, in the toner cartridge C according to this embodiment, the pump/screw drive input portion 39 and the stirring drive input portion 38 can be driven independently from each other. Therefore, even when the toner cartridge C according to this embodiment is not supplying toner to the process cartridge B, the first waste toner storage screw 44 and the second waste toner storage screw 47 in the waste toner storage portion 40 can be driven. That is, the toner cartridge C can collect the waste toner (can maintain a collectable state) even when the toner cartridge C does not supply the toner.

In addition, the means for receiving the driving forces inputted from the printer main assembly A (driving force receiving parts) are concentratedly provided on one end portion side (in the longitudinal direction) of the toner cartridge C, and therefore, it is possible to constrain the gear train of the printer main assembly A from becoming complicated. In addition, by using the toner storage portion stirring/feeding unit 36 to transmit the driving force for driving each portion of the toner cartridge C from one end to the other end of the storage frame 31, the driving force can be transmitted to the waste toner storage portion 40 without increasing the number of parts for transmitting the driving force. By employing the structure described above, the image forming apparatus of this embodiment can efficiently accommodate the waste toner into the toner cartridge C while suppressing an increase in size in the longitudinal direction (the direction parallel to the drive axis of the toner cartridge C and the rotation axis 11b of the photosensitive drum 11).

### (Method of Mounting and Dismounting of Process Cartridge B and Toner Cartridge C)

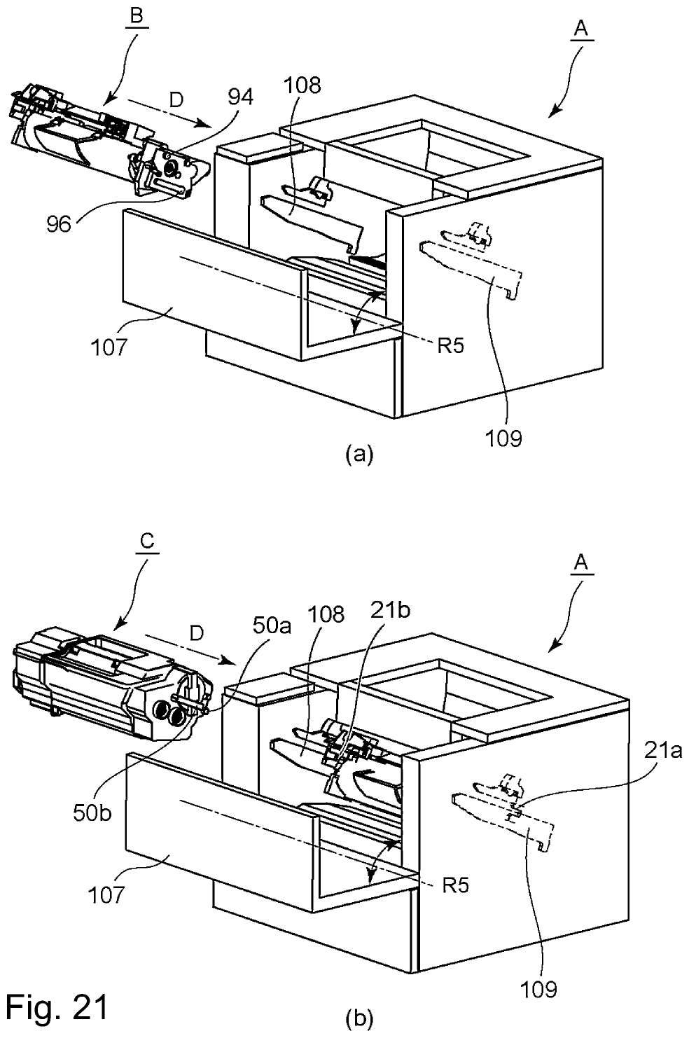

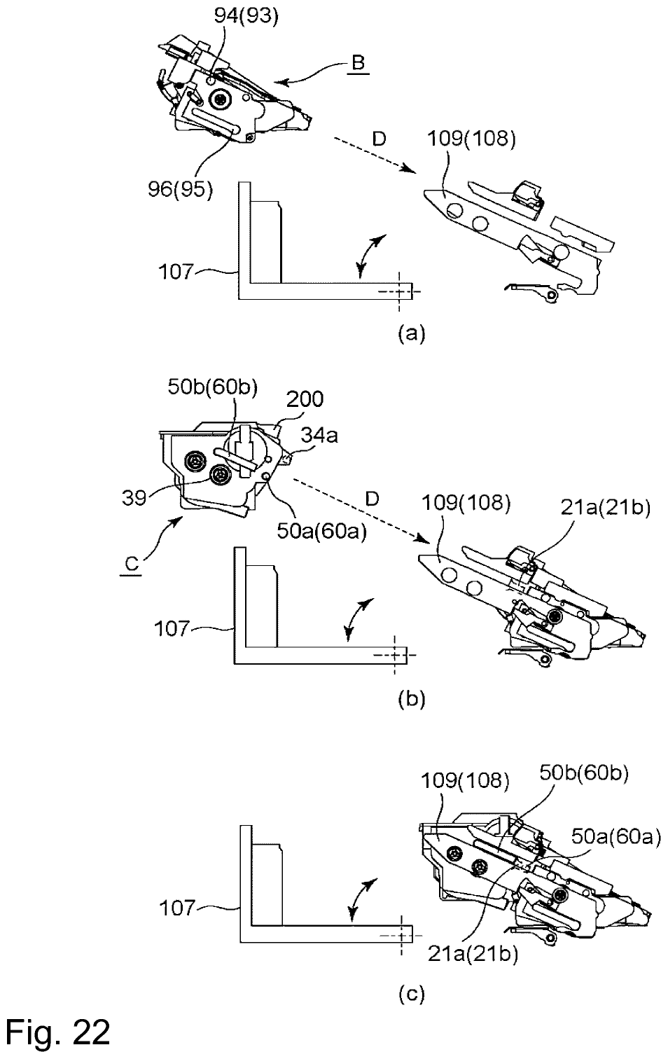

Next, referring to FIGS. 21 and 22, a method for mounting and dismounting the process cartridge B and the toner cartridge C to and from the printer main assembly A will be described in detail. FIG. 21 is a perspective view illustrating an example of a method of mounting the process cartridge B and the toner cartridge C to the printer main assembly A according to Embodiment 1 of the invention. Part (a) of FIG. 21 shows a method for mounting the process cartridge B, and part (b) of FIG. 21 shows a method for mounting the toner cartridge C. FIG. 22 is a side view illustrating an example of a method of mounting the process cartridge B and the toner cartridge C into the printer main assembly A according to Embodiment 1 of the invention. Part (a) of FIG. 22 shows how to mount the process cartridge B, part (b) of FIG. 22 shows how to mount toner cartridge C, and part (c) of FIG. 22 is an illustration of a state in which process cartridge B and toner cartridge C are mounted in the printer main assembly A.

As shown in part (a) of FIG. 21, an internal space of the printer main assembly A serves as mounting portions for the process cartridge B and the toner cartridge C. The door 107 is rotatable about a rotation axis R5 relative to the printer main assembly A, and in the state shown in part (a) of FIG. 21, the door 107 in the open state.

The printer main assembly A is provided with a first guide portion 108 and a second guide portion 109. In addition, as shown in FIG. 6, the process cartridge B is provided with an upper boss 93, an upper boss 94, a lower boss 95 and a lower boss 96 on the left and right sides in the longitudinal direction, respectively.

The process of mounting the process cartridge B and the toner cartridge C into the printer main assembly A will be described below. First, the process cartridge B is mounted into the printer main assembly A. As shown in part (a) of FIG. 21, the first guide portion 108 is sandwiched between the upper boss 93 and the lower boss 95, and the second guide portion 109 is sandwiched between the upper boss 94 and the lower boss 96, and the process cartridge B is inserted in the direction of arrow D while being guided by these guide portions. When the insertion of the process cartridge B is completed, the position of the process cartridge B relative to the printer main assembly A is determined.

Next, the toner cartridge C is mounted into the printer main assembly A. The user can insert or remove the toner cartridge C while gripping the entire toner cartridge C with his/her fingers put on a surface 32a of the container lid 32 and an opposing surface 31b. As shown in part (b) of FIG. 22, the toner cartridge C is provided with positioning bosses 50a and 60a at opposite ends in the longitudinal direction, on the leading side in the mounting direction. The guided portions 50b, 60b are disposed downstream of the positioning bosses 50a, 60a in the mounting direction. The positioning boss 60a is disposed on the non-drive side of the toner cartridge C, and when projected onto a plane perpendicular to the axis G, it is in the same position as (overlapping) the positioning boss 50a on the drive side. Further, the guided portion 60b is disposed on the non-driven side of the toner cartridge C, and when projected onto a plane perpendicular to the axis G, it is in the same position (overlapping position) as the guided portion 50b on the driven side.

As shown in FIG. 6, the process cartridge B is provided, on a stay 21, with a first positioning portion 21a and a second positioning portion 21b, each of which is recessed and used for positioning the toner cartridge C in place.

As shown in part (b) of FIGS. 21 and part (b) of FIG. 22, the toner cartridge C is inserted in the direction D with the guided portions 50b and 60b placed on the first guide portion 108 and the second guide portion 109, respectively. The state shown in part (c) of FIG. 22 is the state that the mounting of the process cartridge B and the toner cartridge C is completed. As shown in part (c) of FIG. 22, when the toner cartridge C is inserted to the completely mounted state, the positioning bosses 50a and 60a fit into the first positioning portion 21a and the second positioning portion 21b, respectively. At this time, the leading ends of guided portions 50b and 60b in the inserting direction move away from first guide portion 108 and second guide portion 109, and the trailing ends thereof come into contact with first guide portion 108 and second guide portion 109, respectively. In this state, the toner cartridge C is positioned in place relative to the process cartridge B. Further, the trailing end sides of the guided portions 50b and 60b contact the first guide portion 108 and the second guide portion 109, respectively, so that the position of the toner cartridge C inside the printer main assembly A is determined. In this state, the mounting of the process cartridge B and the toner cartridge C into the printer main assembly A is complete. Thereafter, the door 107 is closed, by which the laser printer 1 according to this embodiment is ready to form an image. When removing the toner cartridge C and the process cartridge B from the printer main assembly A, the various components operate in the order reverse to those in the mounting process described above.

(Toner Supply Passageway from Toner Cartridge C to Process Cartridge B).

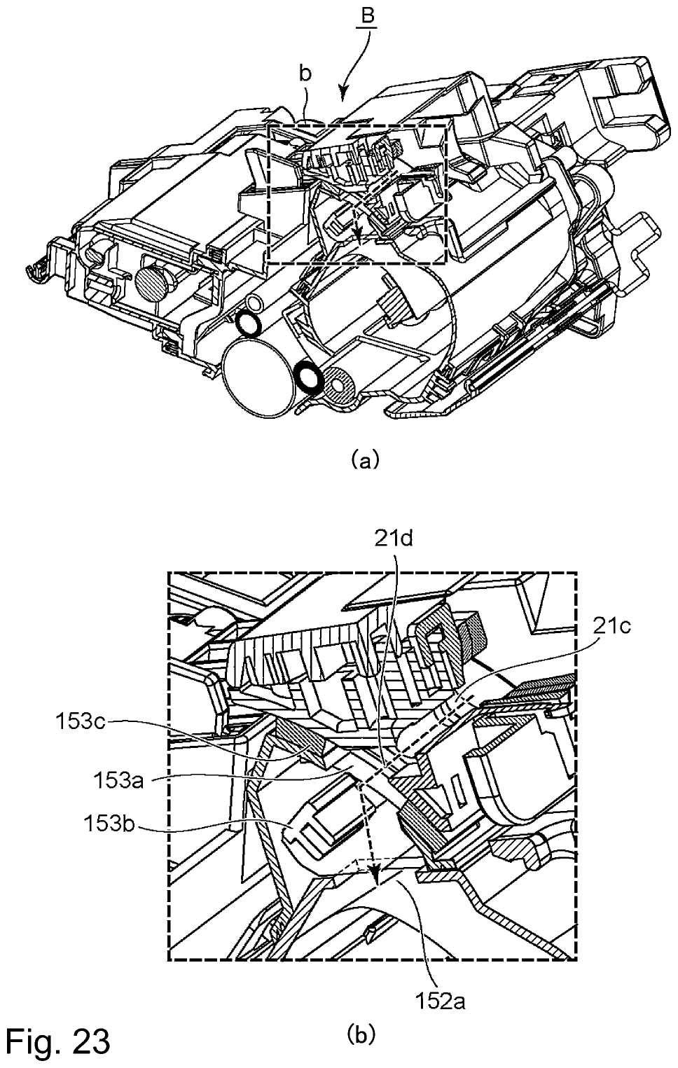

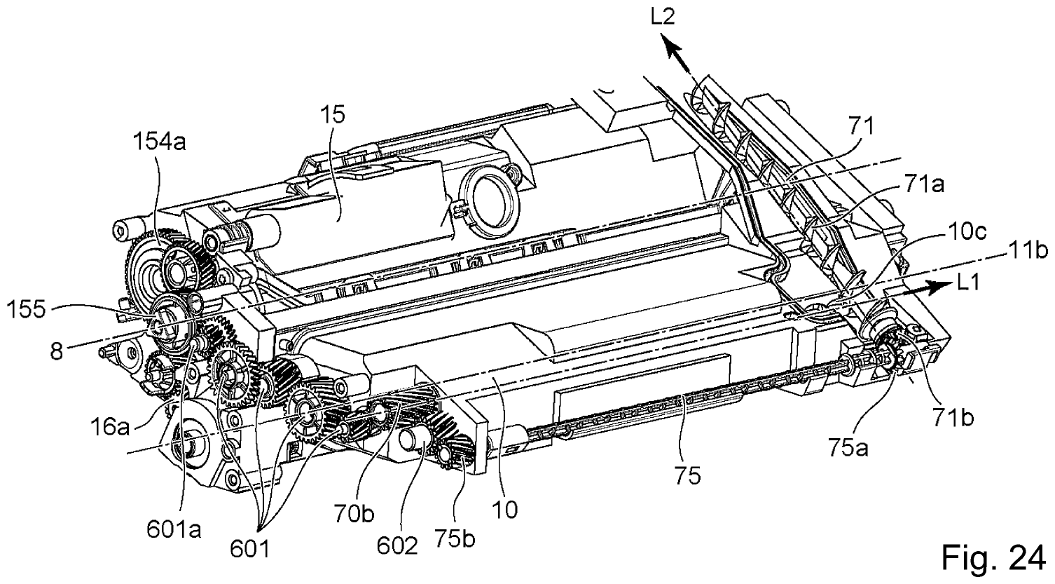

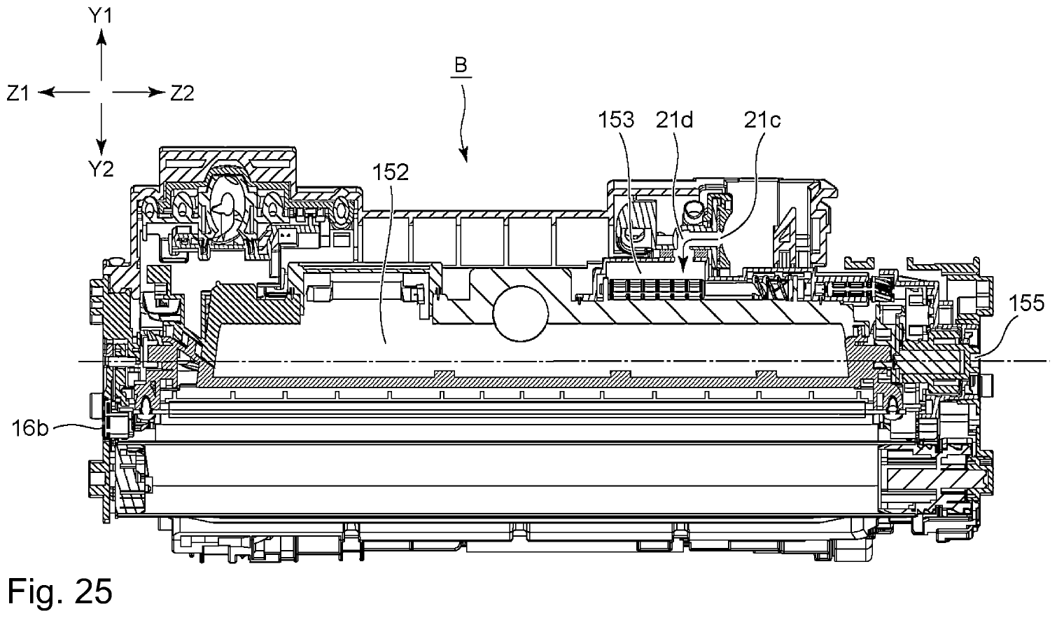

Next, referring to FIGS. 7, 23 and 24, the toner supply passageway from the toner cartridge C to the process cartridge B will be described in detail. FIG. 23 is a sectional perspective view illustrating an example of a supply opening of the process cartridge B according to Embodiment 1 of the present invention. FIG. 24 is an exploded perspective view for illustrating a driving means for the developing operation of the process cartridge B according to Embodiment 1 of the present invention. FIG. 25 is a schematic sectional view of the process cartridge B according to Embodiment 1 of the present invention, showing a section parallel to the Y-axis and Z-axis passing through the center of the supply opening 21c.

As described above, the process cartridge B is supplied (replenished) with the toner from the toner cartridge C. The detailed description will be made. As shown in FIG. 23, the stay 21 is provided with a supply opening 21c for receiving the toner supplied from the toner cartridge C. The toner received by the supply opening 21c is fed into the toner receiving chamber 153 of the developing unit 15 through the delivery opening 21d and the receiving opening 153a. The toner supplied into the toner receiving chamber 153 is supplied to the developer storing portion 152 through the developer storing chamber receiving opening 152a by a receiving chamber feeding member 153b. A receiving opening seal member 153c is mounted around the receiving opening 153a to seal the receiving opening 153a so that no gap is formed between the delivery opening 21d of the stay 21 and the receiving opening 153a, thereby preventing toner leakage.

As shown in FIGS. 7 and 24, the process cartridge B is provided with a development coupling 155 in the developing unit 15 as a drive input member for receiving drive from the printer main assembly A. The development coupling 155 in this embodiment can transmit rotational force to the developing roller gear 16a for transmitting rotational force to the developing roller 16 described above, and to the stirring gear 154a for transmitting rotational force to the stirring member 154, and so on.

A development contact 16b and a developing blade contact 18a are disposed at the end opposite, in the direction of the rotation axis 11b, to the end where the development coupling 155 is provided. The development contact 16b is a member (power supply member) to which a voltage to be applied to the developing roller 16 is supplied from the printer main assembly A. The developing blade contact 18a is a member (power supply member) to which a voltage to be applied to the developing blade 18 is supplied from the printer main assembly A.

As shown in FIG. 25, the supply opening 21c of the process cartridge B is disposed closer to the development coupling 155 in the longitudinal direction of the process cartridge B (the left-right direction in the Figure) than the development contact 16b. The toner supplied from the supply opening 21c is fed in a direction away from the development coupling 155 and then fed into the developing unit 15. With this structure, in the process cartridge B according to Embodiment 1 of the present invention, the toner is fed in a direction away from the development coupling 155, so that the development coupling 155 can be prevented from being dirtied with toner. In addition, in the process cartridge B, the toner supply opening 21c is disposed at a position away from the development contact 16b, so that the development contact 16b can be prevented from being dirtied with toner.

(Structure of the shutter member 34)

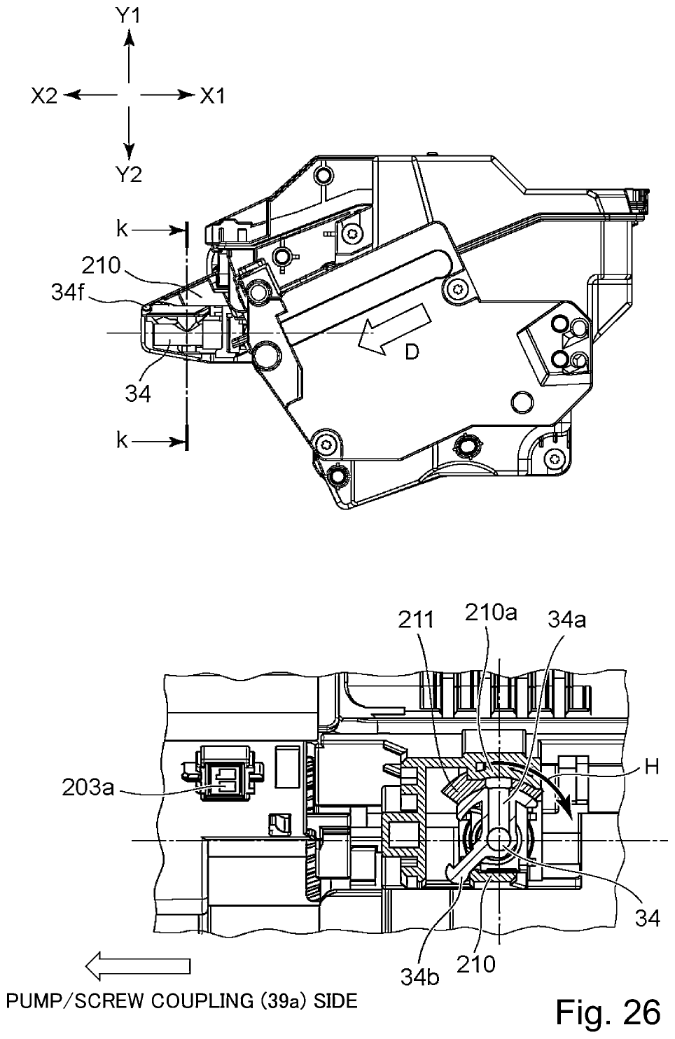

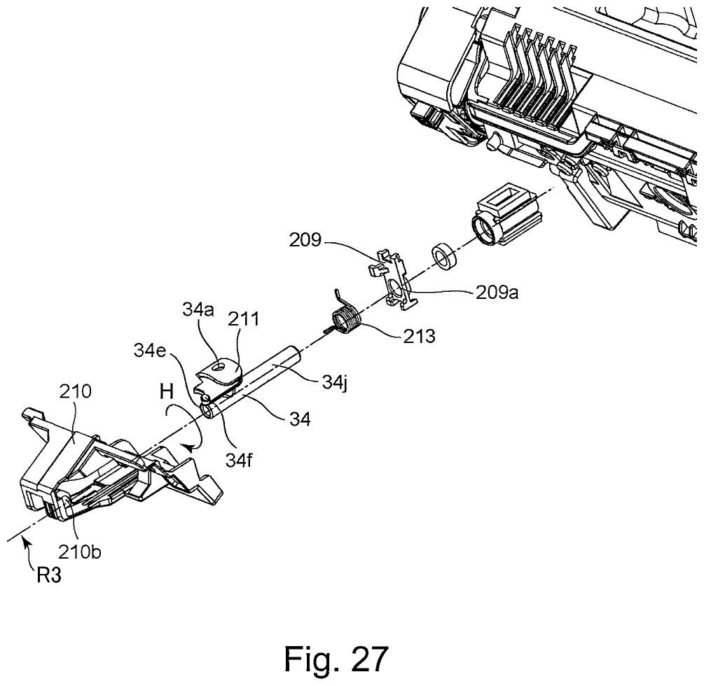

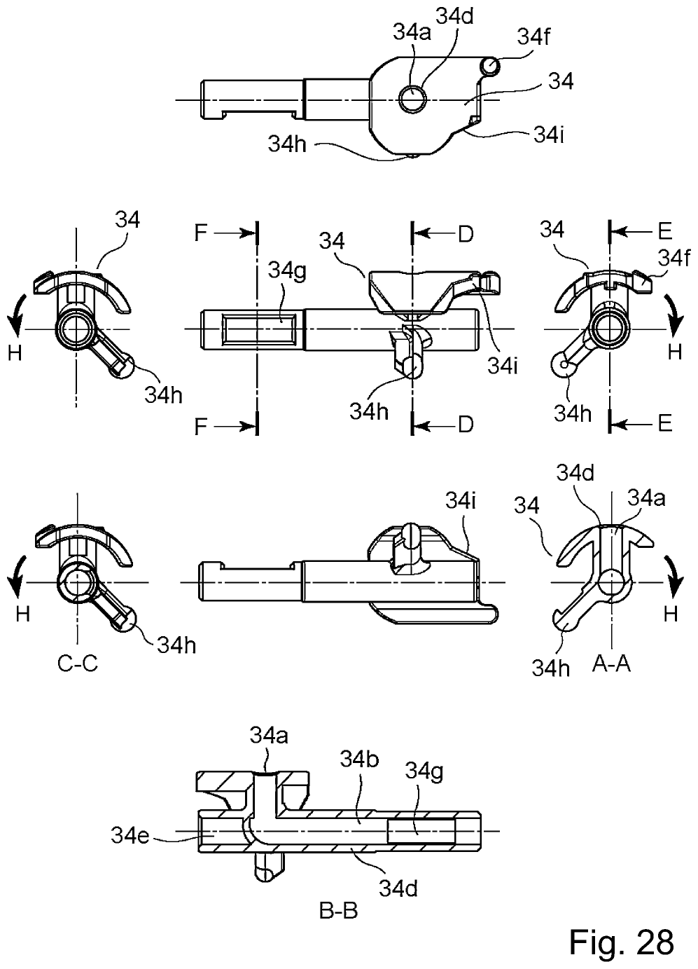

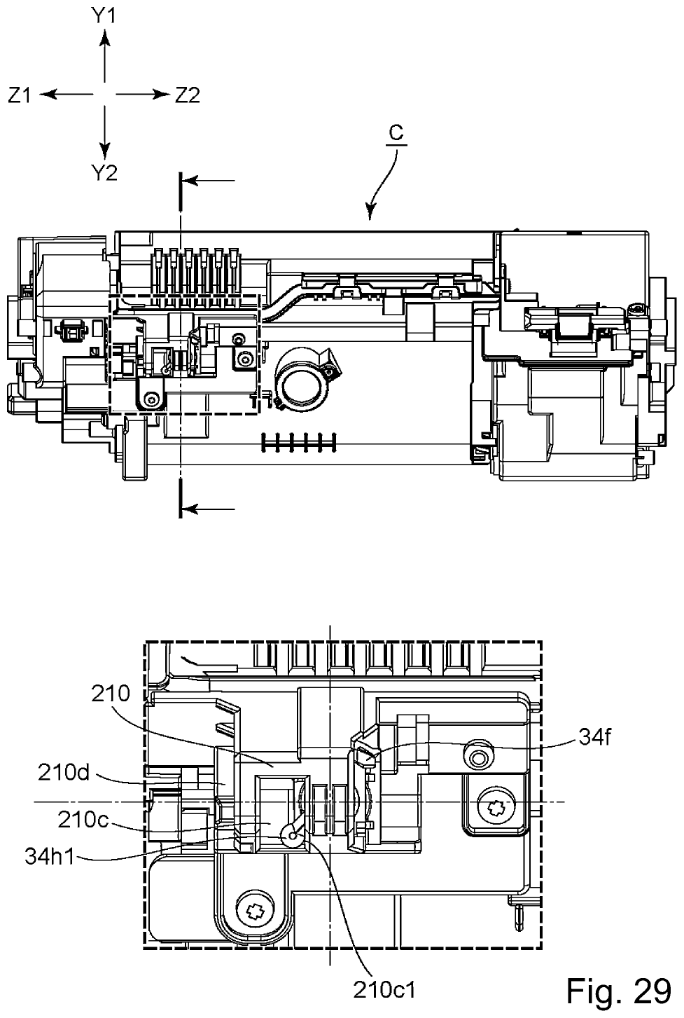

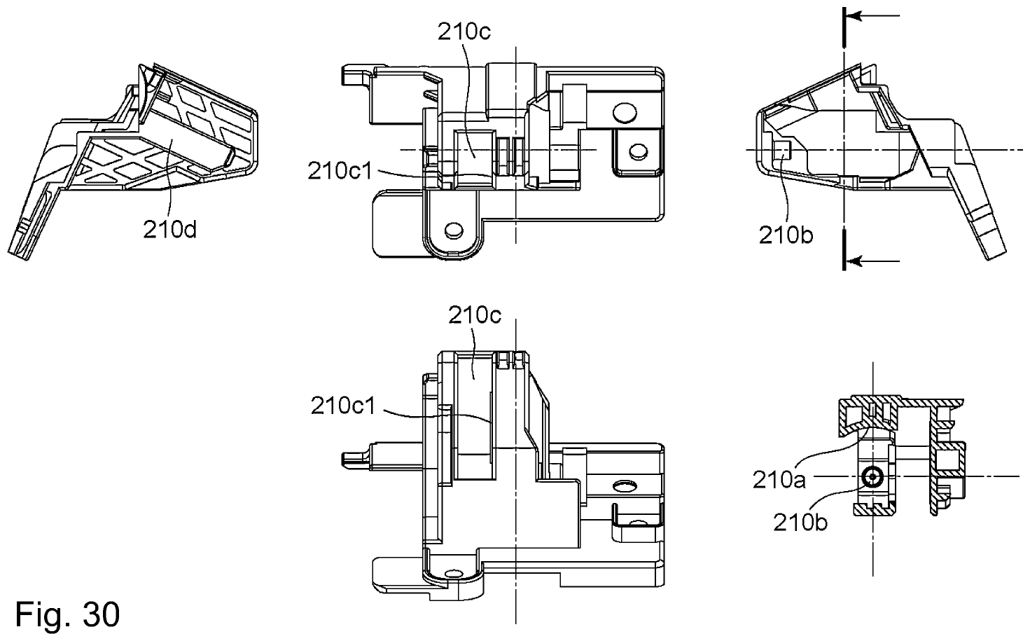

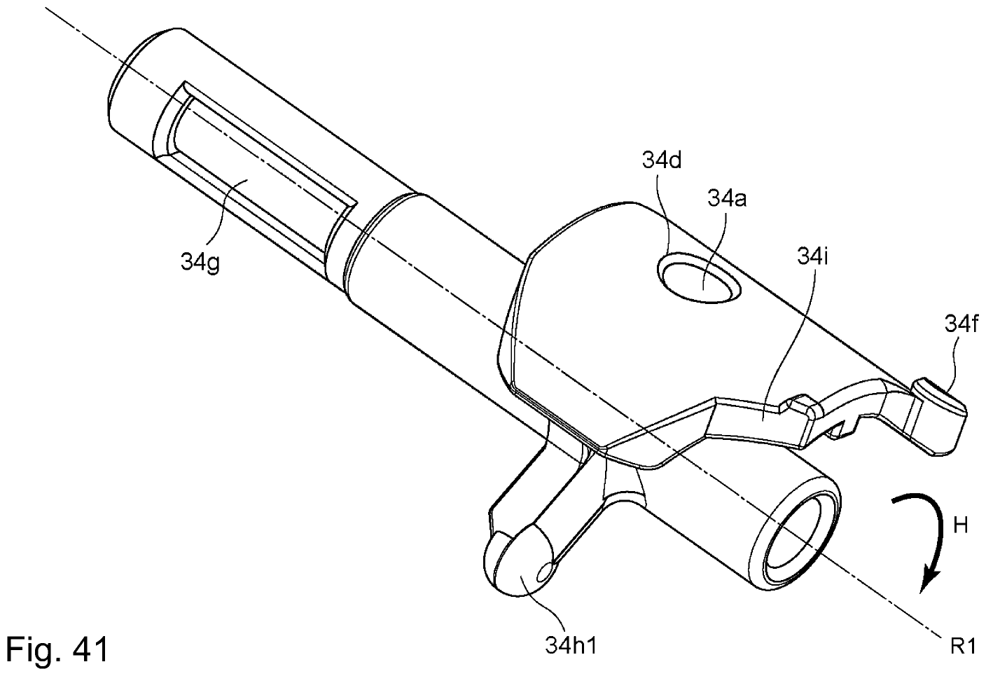

Next, referring to FIGS. 16, 26, 27, 28, 29, 30 and 41, the structure of the shutter member 34 provided in the toner cartridge C will be described in detail. FIG. 26 is a side view and a cross-sectional view (cross-section k-k in the Figure) for illustrating a state in which the shutter member 34 of the toner cartridge C according to Embodiment 1 of the present invention seals to block the toner. FIG. 27 is an exploded perspective view of the shutter member 34 and its peripheral portions of the toner cartridge C in Embodiment 1 of the present invention. FIG. 28 is a front view, a left side view, a right side view, a bottom view and cross-sectional views of the shutter member 34 in Embodiment 1 of the present invention. FIG. 29 is a front view of the toner cartridge C according to Embodiment 1 of the present invention, showing a state in which the shutter member 34 effects the sealing. FIG. 30 is a front view, a left side view, a right side view, a bottom view and sectional views of the shutter protection member 210 in Embodiment 1 of the present invention. FIG. 41 is an external perspective view of the shutter member 34 in Embodiment 1 of the present invention.

As shown in FIGS. 26 and 41, the shutter member 34 is supported rotatably with respect to the toner accommodating portion 30 about a rotation axis R1. As shown in FIG. 41, the toner discharge opening 34a of the shutter member 34 transitions to an open state (open direction) by rotating in the direction H about the rotation axis R1. Although the cross-sections are different, the state of the shutter member 34 shown in FIG. 26 is a closed state, and by rotating from this state in the direction H described above, the state of the shutter member 34 shown in FIG. 17 transitions to an open state.

When the toner cartridge C is mounted to the printer main assembly A, the toner discharge opening 34a of the shutter member 34 is kept urged by a coil spring (which will be described hereinafter) so as to face the upper side of the toner cartridge C at least until it comes into contact with the process cartridge B. In other words, the toner discharge opening 34a is urged by the coil spring 213 so that the opening is positioned on the side opposite to the direction of gravity (the state shown in FIG. 41). The upper side of the toner cartridge C is synonymous with the upper side of the printer main assembly A when the orientation of the toner cartridge C being mounted in the printer main assembly A is used as the reference.

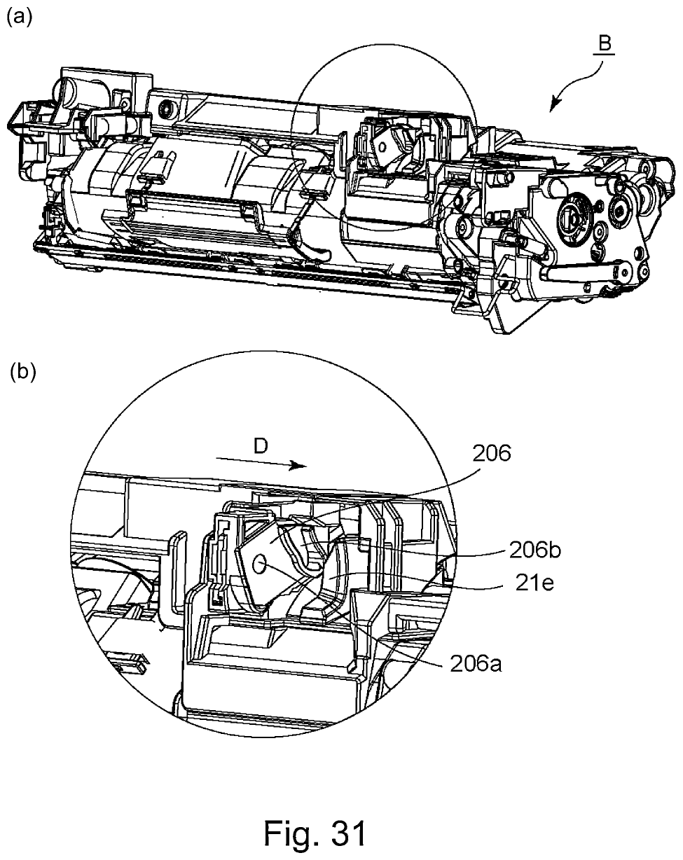

As shown in FIGS. 26 and 31, the shutter protection member 210 is a member (protective member) which is provided around the shutter member 34 and protects the shutter member 34, and includes an discharge opening seal contact surface 210a and a first shutter support portion 210b. By the discharge opening seal contact surface 210a contacting a shutter seal member 216 mounted around the toner discharge opening 34a, the toner discharge opening 34a is closed, thereby to prevent the toner from leaking through the toner discharge opening 34a.

Next, as shown in FIG. 27, the shutter member 34 includes a third shutter support portion 34e and a shutter support shaft 34j, which are supported by the first shutter support portion 210b and a second shutter support portion 209a of a shutter support member 209. With this structure, the shutter member 34 is mounted to the toner cartridge C so as to be rotatable relative to the toner accommodating portion 30.

As shown in FIG. 27, the coil spring 213 is an urging means which urges the shutter member 34 in the opposite direction of the arrow H around the rotation axis R3. As described above, the coil spring 213 can maintain the shutter member 34 in a state in which the toner discharge opening 34a faces upward in the apparatus.

As shown in FIG. 28, the shutter member 34 includes an arm portion 34 as an abutment member which is provided on the pump unit (37) side with respect to the center of rotation of the shutter member 34 as viewed along the direction of the rotation axis R1 of the shutter member 34. Further, the shutter member 34 includes an actuating projection (actuating member) 34f which is provided on the opposite side from the pump unit 37 (non-pump side) with respect to the center of rotation of the shutter member 34 as viewed along the direction of the rotation axis R1 of the shutter member 34. That is, the arm portion 34h and the actuating projection 34f are disposed at positions which are point symmetrical with respect to the rotation axis R1 of the shutter member 34.

With this structure, when the arm portion 34h and the actuating projection 34f, which are independent of each other, and the various portions on the process cartridge B side operate in interrelation with each other, they do not interfere with operations the other components. As the shutter member 34 is viewed from the side facing the toner discharge opening 34a, the toner discharge opening 34a and the arm portion 34h are at positions away from the rotation axis R1 of the shutter member 34. As viewed along a direction perpendicular to the rotation axis R1 of the shutter member 34, when the toner discharge opening 34a is located at the top, the feeding portion 34b from the toner discharge opening 34a to the shutter inlet 34g has an L-shape. The opening of the shutter inlet 34g faces the sheet of the drawing of FIG. 28. In other words, the angle between the toner feeding direction from the shutter inlet 34g to the feeding portion 34b and the toner discharging direction E of the toner discharge opening 34a is approximately 90 degrees.

As shown in FIG. 26, the electrical contact portion 203a of the storing medium 203 of the toner cartridge C is disposed on the downstream in the mounting direction of the toner cartridge C. As shown in FIGS. 17 and 26, in the direction along the rotation drive axis G, the electrical contact portion 203a is disposed closer to the pump-screw coupling portion 39a than the shutter member 34. That is, similar to the pump-screw coupling portion 39a described above, when the toner cartridge C is mounted to the printer main assembly A, the toner discharged from the toner discharge opening 34a is discharged in a direction away from the electrical contact portion 203a of the storing medium 203. This structure can prevent the electrical contact portion 203a of the storing medium 203 from being dirtied with toner.

The shutter protection member 210 is provided with an arm opening 210c. As shown in FIG. 29, the arm opening 210c is formed so as to expose an arm free end 34h1 of the arm portion 34h of the shutter member 34 as viewed along the rotation axis R1 of the shutter member 34. The arm opening 210c in this embodiment is an opening which opens in the direction of the rotation axis R1 of the shutter member 34 and below it. When the shutter member 34 is in the closed state, the arm portion 34h abuts against the opening end 210cl of the arm opening 210c, and the shutter member 34 is maintained in the closed state by the urging force of the coil spring 213. As described above, when the shutter member 34 is closed (closed state), the passageway from the supply opening 31a to the feed passageway 34b is blocked.

As will be described in detail later, as shown in FIG. 28, the shutter member 34 has a positioning surface 34i which determines the position of the toner cartridge C when it is completely mounted in the printer main assembly A. When the toner cartridge C is completely mounted in the printer main assembly A, the positioning surface 34i is in contact with a positioning surface 214e of the toner flow passageway member 214 of the process cartridge B, and regulates the position of the shutter member 34 in the rotational direction.

As shown in FIG. 30, in the shutter protection member 210, the shutter member 34 begins to rotate, in the process of the toner cartridge C being mounted in the printer main assembly A. Here, the rough guide rib 210 is provided for guiding (roughly guiding) the toner cartridge C so as to roughly determine its position relative to the process cartridge B in advance. Incidentally, the rough guide in this embodiment not only serves to position the toner cartridge C relative to the process cartridge B, but also serves to guide the insertion of the toner cartridge C into the printer main assembly A. The operation of inserting the rough guide rib 210d into the rough guide 21f will be described in detail hereinafter.

### (Shutter Structure of Process Cartridge B (Receiving Side)).

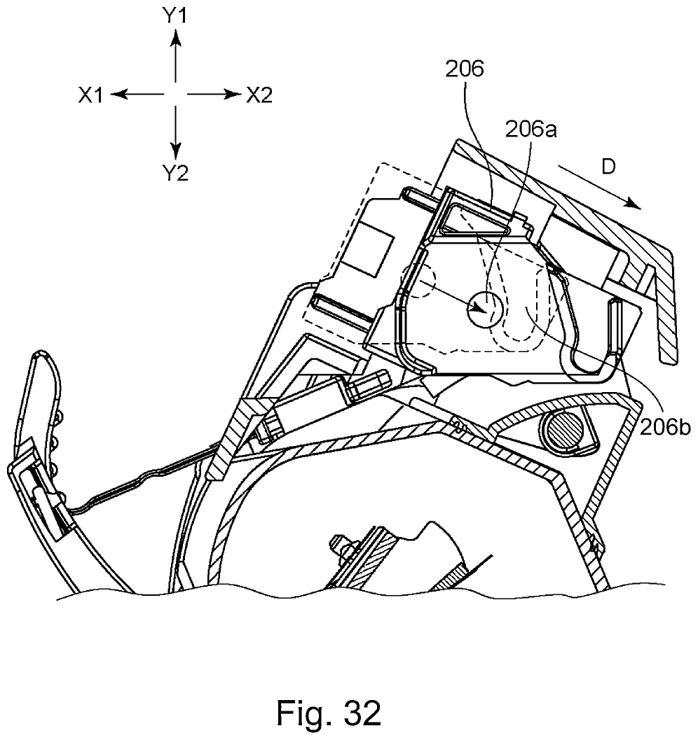

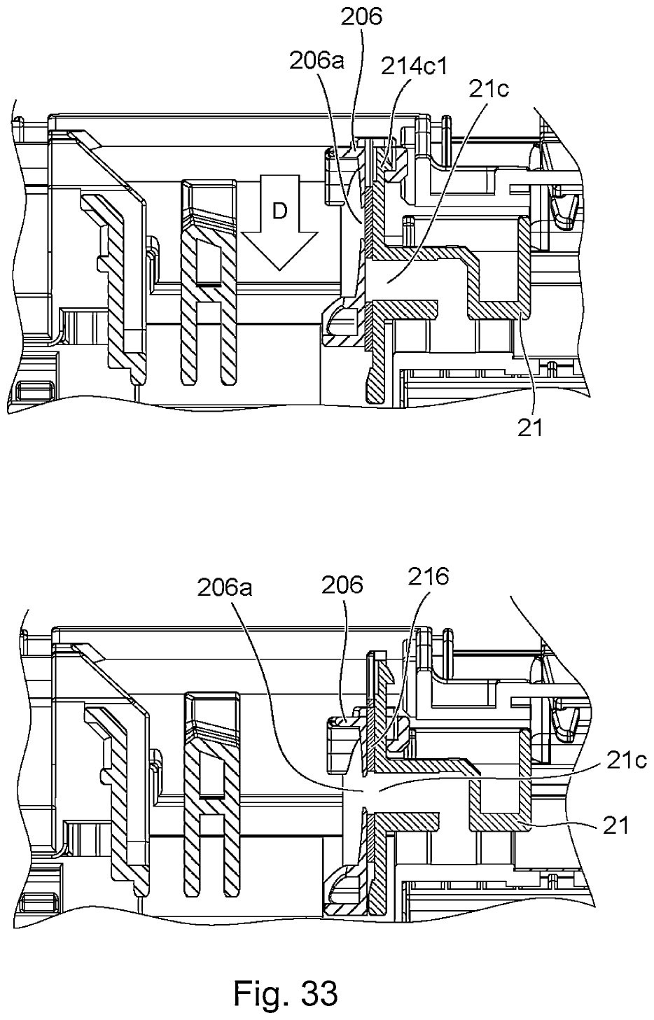

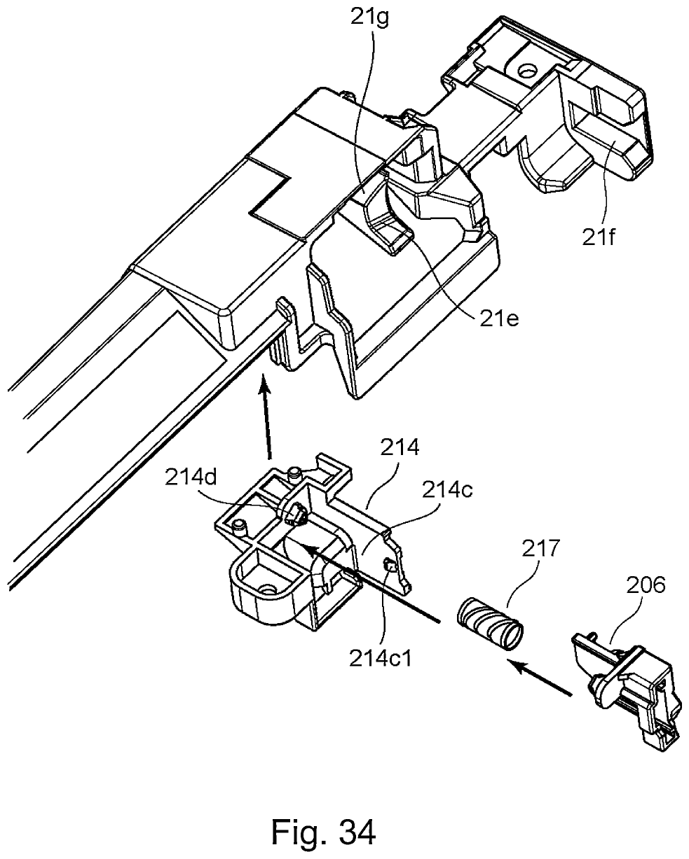

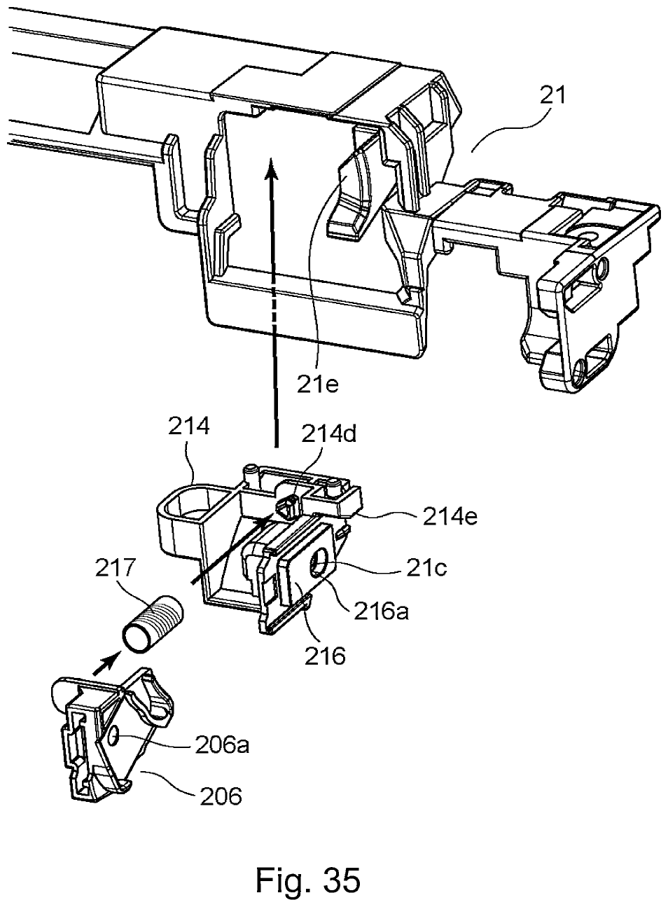

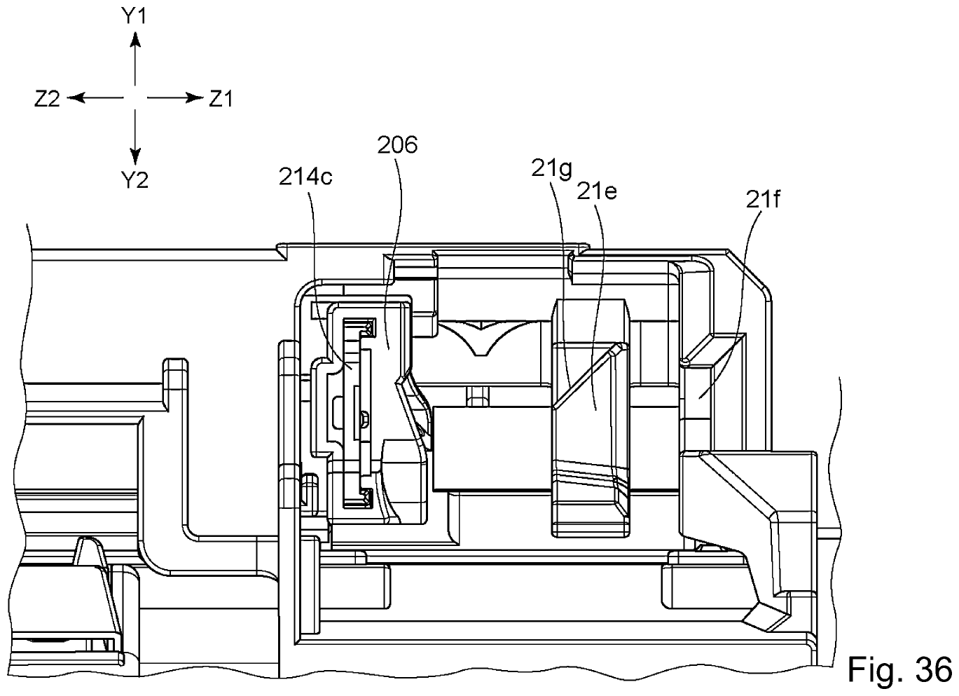

Next, referring to FIGS. 23, 31, 32, 33, 34, 35 and 36, the shutter structure in the process cartridge B will be described. FIG. 31 is an illustration of an example of the structure of the receiving side shutter member 206 of the process cartridge B according to Embodiment 1 of the present invention. Part (a) of FIG. 31 is an external perspective view of the process cartridge B including the receiving side shutter member 206, and part (b) of FIG. 31 is a partially enlarged view thereof. FIG. 32 is a view illustrating an example of the operation of the receiving side shutter member 206 of the process cartridge B according to Embodiment 1 of the present invention. FIG. 33 is a partial sectional view of the neighborhood of the receiving side shutter member 206 of the process cartridge B according to Embodiment 1 of the present invention. The sectional plane of the view shown in FIG. 33 is a plane that is parallel to the inserting direction (direction B) of the process cartridge B and the Z axis and passes through the center of the communication hole 206a. FIG. 34 is an exploded perspective view of the receiving side shutter member 206 and its peripheral components in Embodiment 1 of the present invention. FIG. 35 is an exploded perspective view of the receiving side shutter member 206 and peripheral components facing the communication opening 206a of the receiving side shutter member 206 in Embodiment 1 of the present invention. FIG. 36 is a partial enlarged view of the process cartridge B according to Embodiment 1 of the present invention, as viewed in the mounting direction of the toner cartridge C.

As shown in FIGS. 21, 32 and 33, the process cartridge B is provided with the receiving side shutter member 206. The receiving side shutter member 206 can cover the supply opening 21c provided in the stay 21, and is slidable in the mounting direction D of the toner cartridge C. The receiving side shutter member 206 also has a communication opening 206a for fluid communicating with the supply opening 21c to receive toner when the toner cartridge C and the process cartridge B are completely mounted in place in the printer main assembly A. The receiving shutter member 206 also includes an operating projection receiving portion 206b. Details of each part will be described hereinafter.

As shown in FIG. 34, a compression spring 217 for urging the receiving side shutter member 206 in the closing direction is provided between the shutter member 206 and the toner flow passageway member 214. The receiving side shutter member 206 is supported in a fitted relationship with the toner flow passageway member 214 in a direction perpendicular to the sliding direction (a direction parallel to Y1 and Y2 directions in FIG. 36). Therefore, when the receiving side shutter member 206 is opened, the communication opening 206a and the opening of the supply opening 21c communicate with each other in high precision.

As shown in part (b) of FIGS. 31 and 36, the stay 21 is provided with a guide surface 21e having an inclined surface shape which guides the arm free end 34h1 in the direction for opening the shutter member 34 when the toner cartridge C is mounted to the process cartridge B. The guide surface 21e and the guide lateral surface 21g which will be described hereinafter form a continuous surface with which the arm free end 34h1 contacts, and the abutment surface with which the arm free end 34h1 contacts is twisted between the guide surface 21e and the guide lateral surface 21g.

As shown in FIG. 35, the stay 21 includes a toner flow passageway member 214 having the supply opening 21c. The toner flow passageway member 214 is provided with the delivery opening 21d in addition to the supply opening 21c.

The toner flow passageway member 214 includes a rail portion 214c slidably supporting the receiving side shutter member 206, and a spring fixing portion 214d which fixes the compression spring 217. The rail portion 214c is provided with a restricting portion 214cl which abuts against the rail member 214c to restrict the position of the receiving side shutter member 206 when the receiving side shutter member 206 moves in the closing direction.

As shown in FIGS. 33 and 35, a shutter seal member 216 having an opening 216a is provided around the supply opening 21c. The shutter seal member 216 is a seal member which is disposed around the supply opening 21c and fills the gap between the receiving side shutter member 206 and the surface on which an auxiliary toner flow passageway member 21c is provided. The diameter of the opening 216a of the shutter seal member 216 is larger than the diameter of the supply opening 21c.

As shown in part (b) of FIG. 31, an actuation receiving portion 206b of the receiving side shutter member 206 is disposed downstream of the communication opening 206a in the mounting direction D of the toner cartridge C. The actuation receiving portion 206b is a groove-shaped portion into which the actuating projection 34f can be inserted and which extends in a direction intersecting the mounting direction (direction D) and having a component in the Y2 direction. Further, in the Y2 direction, the upstream end of the actuation receiving portion 206b is opened so that the actuating projection 34f can enter the groove-shaped portion. As shown in FIG. 36, the stay 21 has a rough guide 21f for receiving the rough guide rib 210d of the shutter protection member 210.

### (Interrelation of Shutter Member 34 and Receiving-side Shutter Member 206)

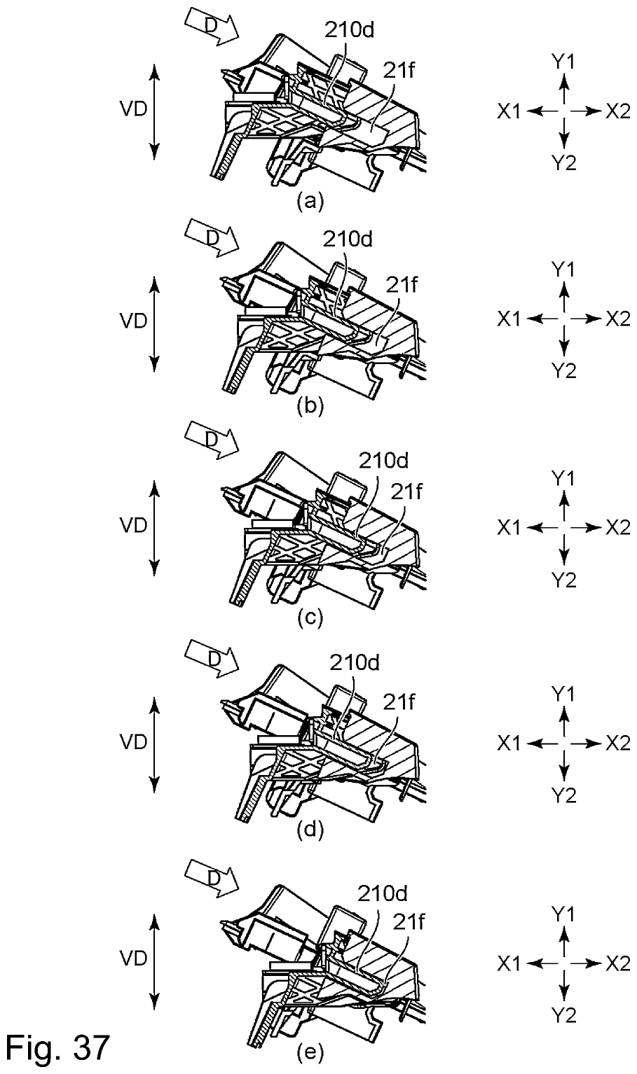

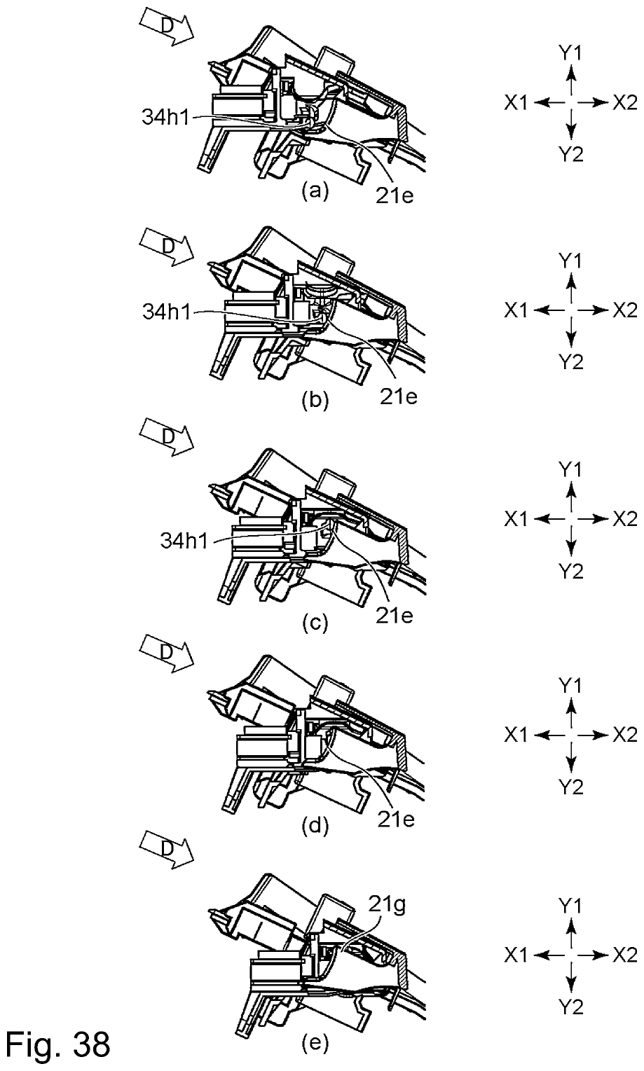

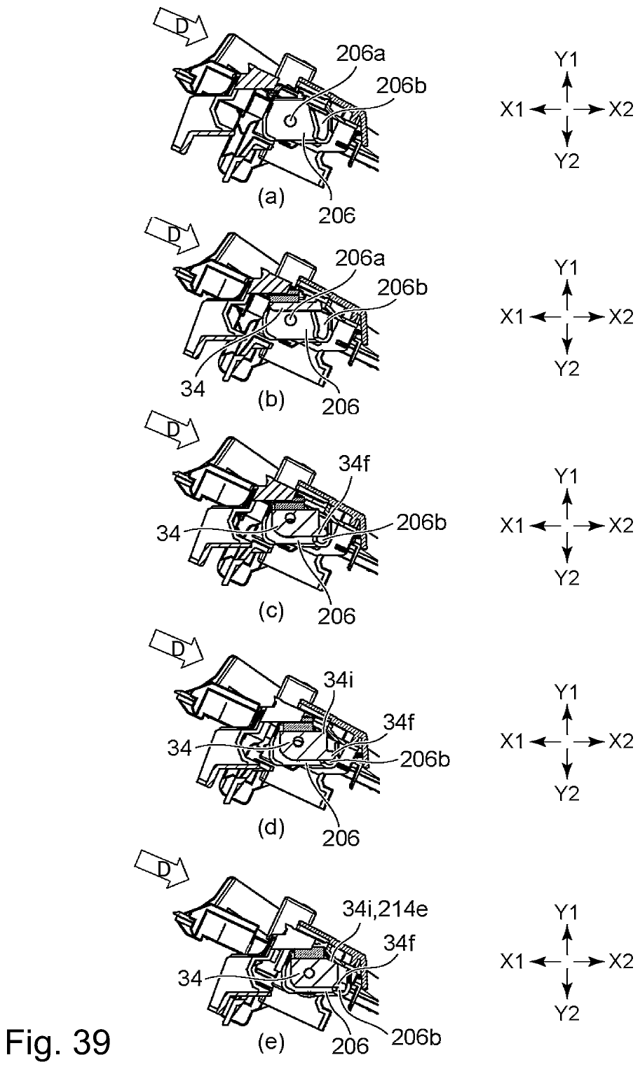

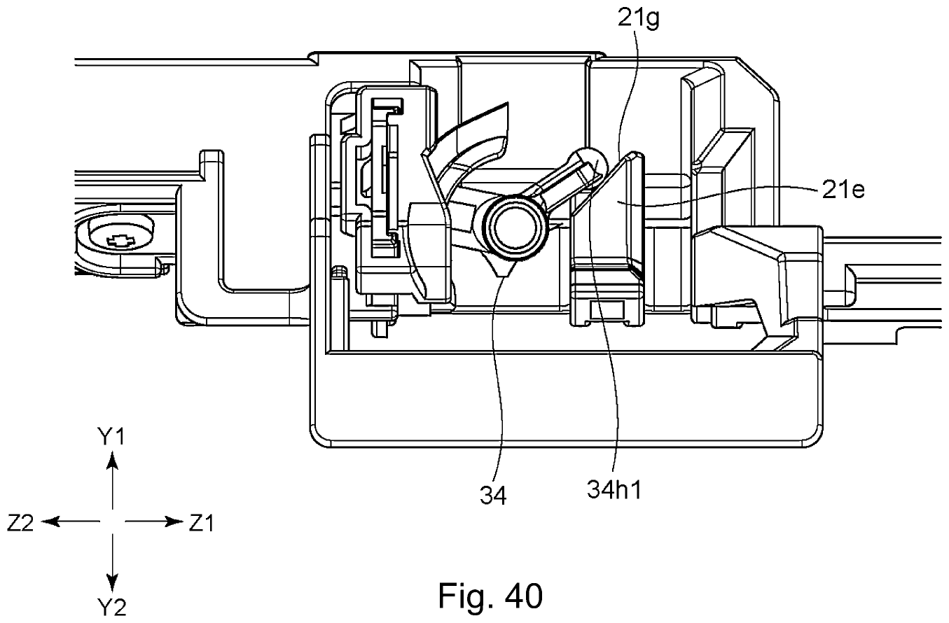

Referring to FIGS. 21, 37, 38, 39 and 40, the description will be made as to the linked opening and closing operations of the shutter member 34 of the toner cartridge C and the receiving side shutter member 206 of the process cartridge B. FIG. 37 is an illustration of an example of a mounting trace of the rough guide rib 210d to the rough guide 21f in this embodiment, and part (a) of FIG. 37 to part (e) of FIG. 37 show continuous change in the insertion of the rough guide rib 210d into the rough guide 21f. Part (a) of FIG. 37 to part (e) of FIG. 37 show sectional views taken along a plane passing through the center of the rough guide 21f and parallel to the X-axis and Y-axis. FIG. 38 is a view illustrating an example of the mounting trace of the arm free end 34h1 of the shutter member 34 in this embodiment. Part (a) of FIG. 38 to part (e) of FIG. 38 show continuous change in the relative position (or contact state) between the arm free end 34h1 and the guide surface 21e. Part (a) of FIG. 38 to part (e) of FIG. 38 show a sectional view taken along a plane passing substantially through the center of guide surface 21e and parallel to the X-axis and Y-axis. FIG. 39 is an illustration of an example of the mounting operation of the actuating projection 34f of the shutter member 34 and the actuating projection receiving portion 206b of the receiving side shutter member 206 in this embodiment. part (a) of FIG. 39 to part (e) of FIG. 39 respectively show successive changes in the relative positions (or connection states) between the shutter member 34 and the receiving shutter member 206. Part (a) of FIG. 39 to part (e) of FIG. 39 show sectional views taken along a plane passing substantially through the center of the actuating projection receiving portion 206b and parallel to the X-axis and Y-axis. FIG. 40 is an illustration of a state in which the toner cartridge C according to this embodiment is in the process of being mounted, as viewed in the mounting direction of the toner cartridge C.

As described above, in the laser printer 1 of this embodiment, when the process cartridge B is mounted in the printer main assembly A, and the toner cartridge C is additionally mounted, it becomes possible to supply the toner from the toner cartridge C to the process cartridge B. At this time, the receiving side shutter member 206 provided in the process cartridge B and the supply side shutter member 34 provided in the toner cartridge C are interrelated with the mounting operation of the toner cartridge C into the process cartridge B. In other words, in the laser printer 1 of this embodiment, by inserting (mounting) the toner cartridge C into the process cartridge B, the receiving side shutter member 206 and the shutter member 34 open in interrelation with each other to enable supply the toner and to in able an image forming operation.

First, the operation of opening the shutter member provided in each cartridge unit (opening operation) will be specifically described. As shown in part (a) of FIG. 37, during the mounting of the toner cartridge C into the process cartridge B, the rough guide rib 210d of the shutter protection member 210 on the toner cartridge C side enters the rough guide 21f of the stay 21 provided in the process cartridge B side. Part (a) of FIG. 37 is a view illustrating an example of a state in which the rough guide rib 210d starts to enter the rough guide 21f. In the state shown in part (a) of FIG. 37, the shutter protection member 210 and the shutter member 34 are roughly regulated (positioned) in the direction perpendicular to the mounting direction D relative to the stay 21. That is, the insertion range of the toner cartridge C is restricted first in the height direction (up-down direction) VD of the printer main assembly A in which the process cartridge B has been mounted.

Here, the reason for roughly positioning the shutter protection member 210 (and the shutter member 34) with respect to the stay 21 will be described. If the positioning precision between the positioning bosses 50a, 60a and the toner cartridge positioning portions 21a, 21b is high, the process cartridge B and the toner cartridge C cannot be correctly positioned if their insertion attitudes are even slightly misaligned. In such a case, if the cartridges is positioned only by the positioning bosses 50a, 60a and the positioning portions 21a, 21b, the positions of the shutter member 34 and the stay 21 would be misaligned, with the result that it is difficult to stably open the shutter member 34. Therefore, by roughly determining the relative positions between the cartridges using the rough guide ribs 210d and the rough guides 21f, the positioning accuracy of the process cartridge B and the toner cartridge C is enhanced, so that stable operation of the shutter member 34 can be accomplished. At this time, as shown in part (a) of FIG. 38, the arm free end 34h1 of the shutter member 34 does not contact the guide surface 21e of the stay 21. That is, the toner discharge opening 34a of the shutter member 34 faces upward (closed state). At this point, the receiving side shutter 206 is in a closed state, as shown in part (a) of FIG. 39.

Next, when the rough guide rib 210d is further inserted into the rough guide 21f as shown in part (b) of FIG. 37, the arm free end 34h1 begins to contact the guide surface 21e as shown in part (b) of FIG. 38, so that the shutter member 34 begins to rotate in the H direction. Furthermore, as viewed along the Z axis, the guide surface 21e is inclined with respect to the rotation axis R3 of the shutter member 34, and therefore, the shutter member 34 rotates in response to changes in the contact position between the guide surface 21e and the arm free end portion 34h1. As shown in part (b) of FIG. 39, when the arm free end 34h1 begins to contact the guide surface 21e, the receiving side shutter member 206 is closed.

Next, as shown in part (c) of FIG. 37, when the rough guide rib 210d is further inserted into the rough guide 21f, the contact position between the arm free end 34h1 and the guide surface 21e moves upwards in the apparatus, as shown in part (c) of FIG. 38. Then, the shutter member 34 further rotates in the H direction. At this time, as shown in part (c) of FIG. 39, the actuating projection 34f of the shutter member 34 enters the actuating projection receiving portion 206b of the receiving side shutter member 206. At this stage, the actuating projection 34f only enters the actuating projection receiving portion 206b, and the receiving side shutter member 206 does not move at all. That is, in the state shown in part (c) of FIG. 39, the receiving side shutter member 206 is still in the closed state. In addition, it is desirable that the upper side of the actuation projection receiving portion 206b has a tapered shape which opens toward the upper side of the apparatus in order to easily accept the insertion of the actuating projection 34f.

Next, as shown in part (d) of FIG. 37, when the rough guide rib 210d is further inserted into the rough guide 21f, the arm free end 34h1 moves to a position where it contacts the guide lateral surface 21g, which is the side surface of the guide surface 21e, as shown in part (d) of FIG. 38 and FIG. 40. In the stay 21, the guide surface 21e and the guide lateral surface 21g are formed continuously, and the guide lateral surface 21g is positioned at a position higher than the guide surface 21e in the apparatus. The guide lateral surface 21g is a surface parallel to the direction in which the toner cartridge C is mounted. Therefore, in the state where the arm free end 34h1 of the shutter member 34 is in contact with (rides on) the guide lateral surface 21g, the shutter member 34 stops rotating in the H direction, so that the rotation angle of the shutter member 34 becomes substantially constant.

At this time, the rotational position of the shutter member 34 about the rotational axis R3 is a position slightly moved in the opposite direction in the H direction from the position at the time of the completion of mounting. At this point, as shown in part (d) of FIG. 39, the actuating projection 34f and the actuation projection receiving portion 206b engage with each other, and the actuation projection receiving portion is pushed, causing the receiving side shutter member 206 to start moving in the opening direction (direction D). That is, when the toner cartridge C is inserted into the printer main assembly A, the engagement position between the actuating projection 34f and the actuation projection receiving portion 206b changes, the receiving side shutter member 206 opens, and the positions of the openings of the supply opening 21c and the communication opening 206a change into an open state in which they are approximately aligned with each other.

Next, as shown in part (e) of FIG. 37, the rough guide rib 210d is further inserted into the rough guide 21f, and when the insertion is completed, as shown in part (e) of FIG. 38, the arm free end 34h1 of the shutter member 34 is released from the guide lateral surface 21g. The positioning surface 34i of the shutter member 34 shown in FIGS. 28 and 41 are brough into contact with and are pressed by the positioning surface 214e of the toner flow passageway member 214, so that the shutter member 34 is rotated slightly in the H direction. In this state, the rotation of the shutter member 34 is completed, and the mounting of the toner cartridge C to the process cartridge B is completed.

At this point of time, as shown in part (e) of FIG. 39, the opening operation of the receiving side shutter member 206 is completed (the receiving side shutter member 206 opens). In this case, if the width of the actuation projection receiving portion 206 is approximately the same as the width of the actuating projection 34f, the positioning of the shutter member 34 and the receiving side shutter member 206 can be adjusted with high precision. The above is the description of the operation (opening operation) at the time of opening the shutter member provided in each cartridge unit. In addition, with regard to the closing operation (closing operation), the shutter members provided on the cartridge units may be operated in the reverse order to the opening operation described above.

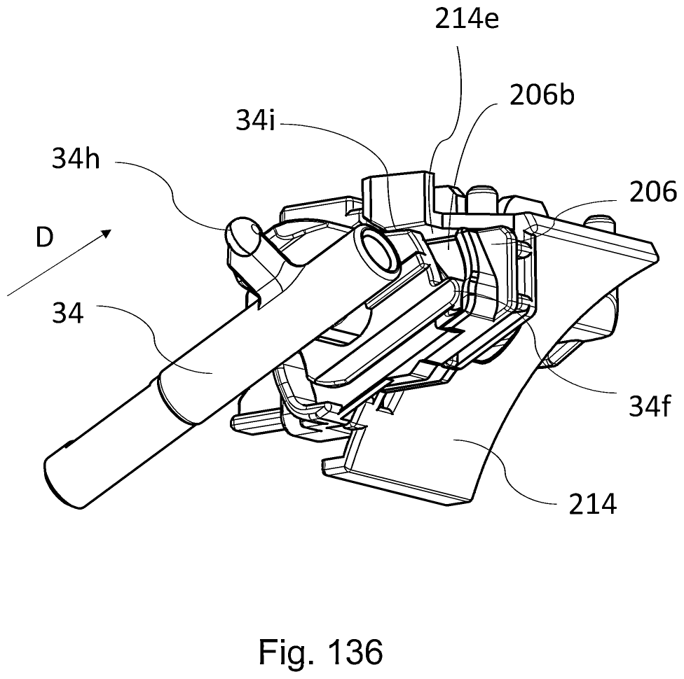

FIG. 136 is an external perspective view illustrating an example of a state in which the opening operation of the shutter member 34 and the receiving side shutter member 206 is completed, in Embodiment 1 of the present invention. For the simplicity of explanation, FIG. 136 shows only the shutter member 34, the receiving side shutter member 206, and the toner flow passageway member 214.

As shown in FIG. 136 the position of the receiving side shutter member 206 in the mounting direction D is determined by the actuating projection 34f of the shutter member 34 contacting the downstream, in the mounting direction D, surface of the actuating projection receiving portion 206b against the reaction force of the compression spring 217. With this structure, the communication opening 206a of the receiving side shutter member 206 is accurately positioned with respect to the toner discharge opening 34a of the shutter member 34 in the mounting direction D.

Furthermore, the shutter member 34 is positioned in the rotational direction by the positioning surface 34i contacting the positioning surface 214e of the toner flow passageway member 214 against the reaction force of the coil spring 213. With this structure, the communication opening 206a of the receiving side shutter member 206 is accurately positioned in the rotational direction by way of the toner discharge opening 34a of the shutter member 34 and the toner flow passageway member 214. With the above-described structure, when the toner cartridge C is mounted to the process cartridge B, the shutter member 34 provided on the toner cartridge C is accurately positioned on the process cartridge B side with reference to the X, Y, and Z axes and the rotation axis.

As described above, the process cartridge B and toner cartridge C of this embodiment are structured so that the shutter members provided respectively in them open and closes the toner supply openings, respectively, thereby preventing toner from leaking out unnecessarily. Furthermore, the shutter member 34 in this embodiment rotates in a direction such that the toner discharge opening 34a faces upward or laterally only with reference to the up, down, left and right directions of the printer main assembly A. Therefore, the toner cartridge C according to Embodiment 1 of the present invention can prevent the toner from unintentionally flowing out from the toner discharge opening 34a due to the opening and closing operation of the shutter member 34 or the effect of gravity.

In addition, as described above, in the toner cartridge C according to Embodiment 1 of the present invention, the toner is discharged through the toner discharge opening 34a in a direction parallel to the rotational drive axis G of the pump-screw drive input portion 39 and away from the pump-screw drive input portion 39. With this structure, the laser printer 1 according to Embodiment 1 of the present invention can prevent the pump-screw input/output parts of the printer main assembly A and the toner cartridge C from being dirtied with toner.

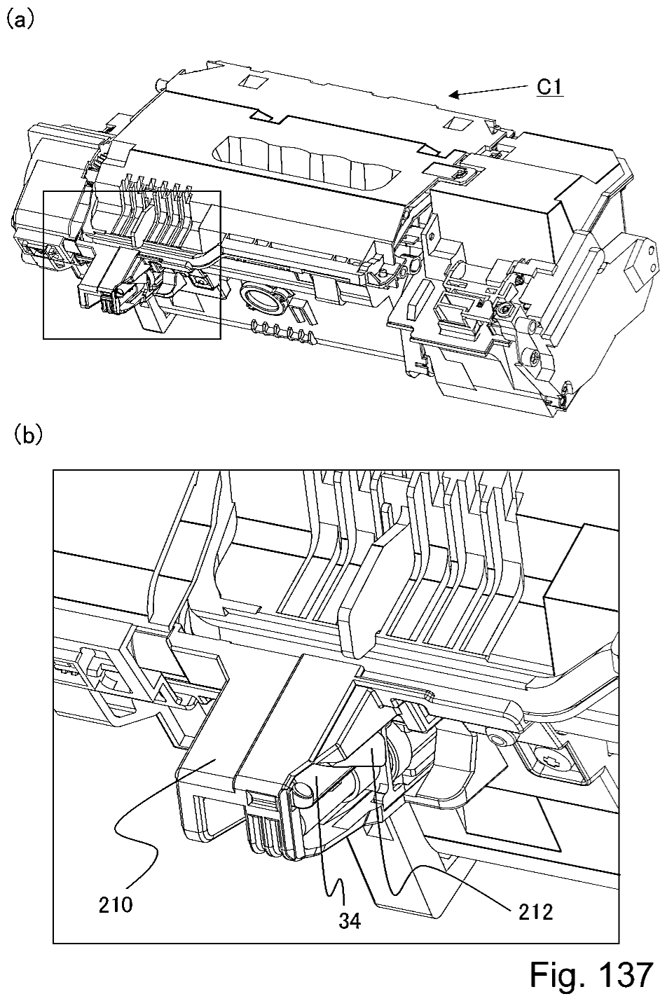

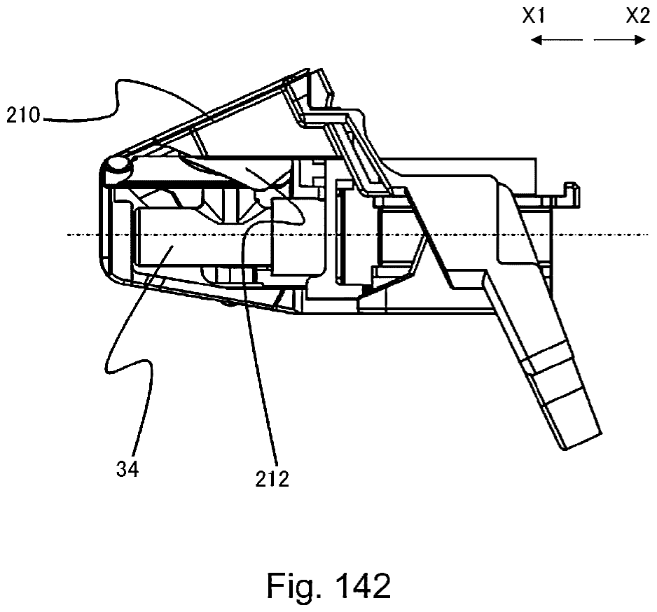

Although the preferred embodiment of the present invention has been described above, the present invention is not limited to this embodiment, and various modifications and changes are possible within the scope of the gist of the present invention. For example, in addition to the structure of the embodiment described above, it is also possible to employ a structure which suppresses scattering of toner when the toner is fed from the toner cartridge C side to the process cartridge B side. Referring to FIGS. 137 to 143, such a structure will be described in which the toner cartridge C1 is detachably mountable to the printer main assembly A described above. In addition, the same reference numerals (or symbols) are assigned for the members the same structure as in Embodiment 1 described in the foregoing.

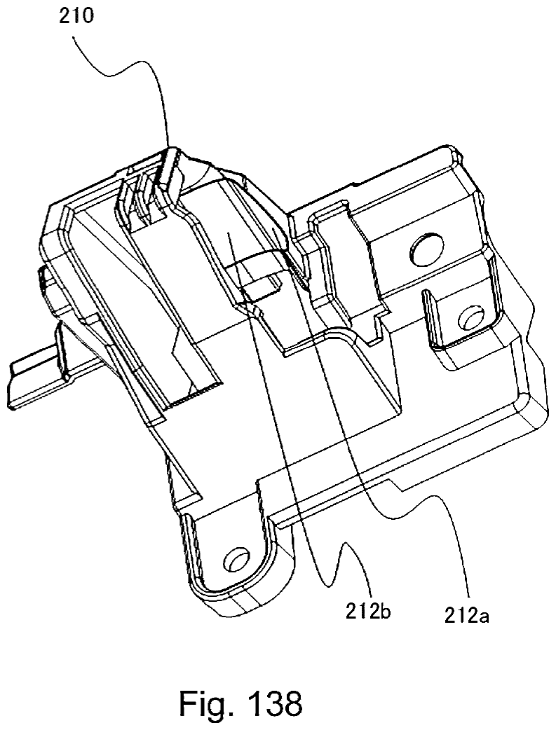

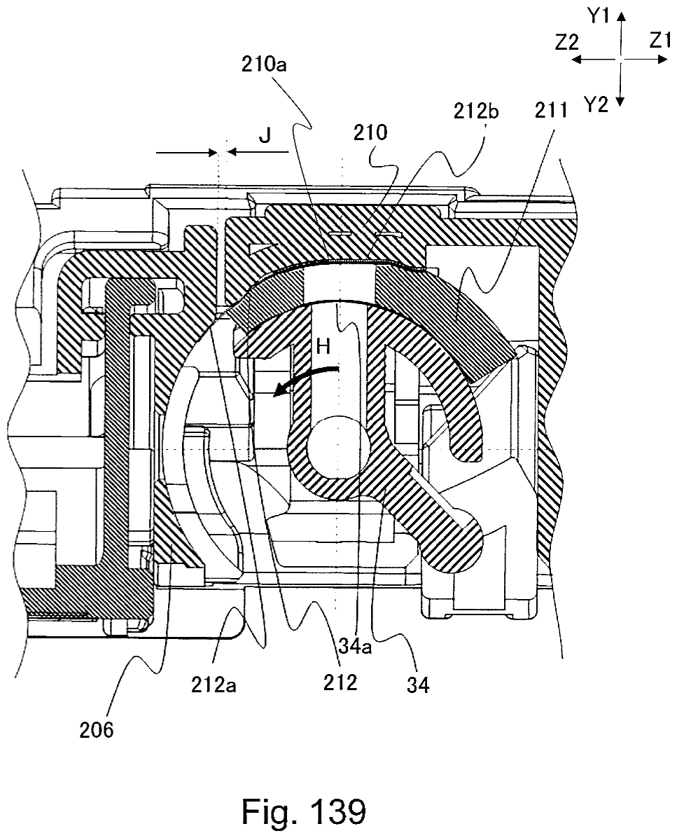

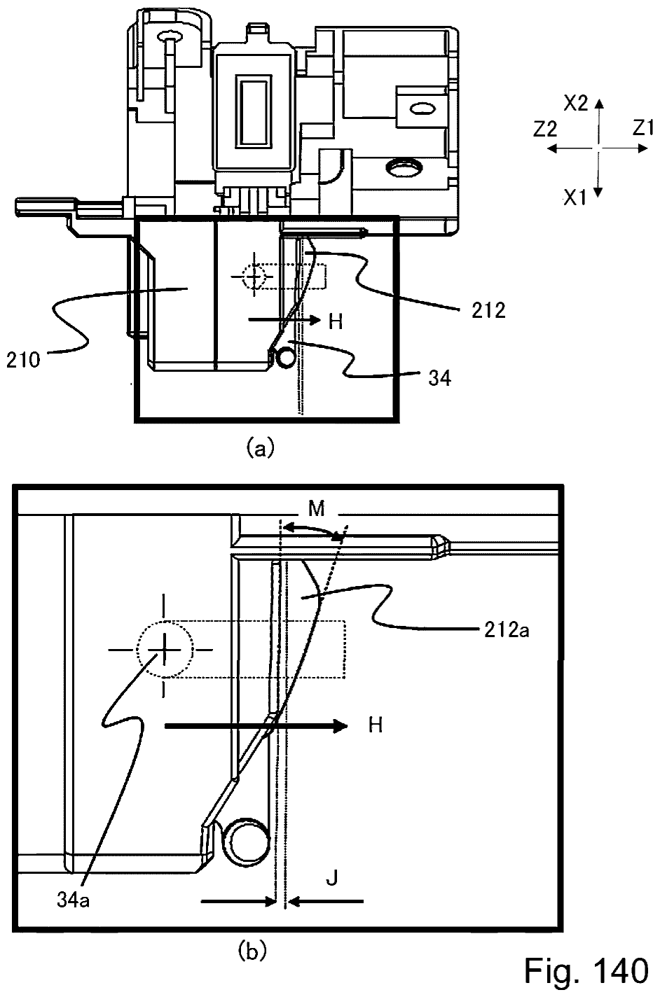

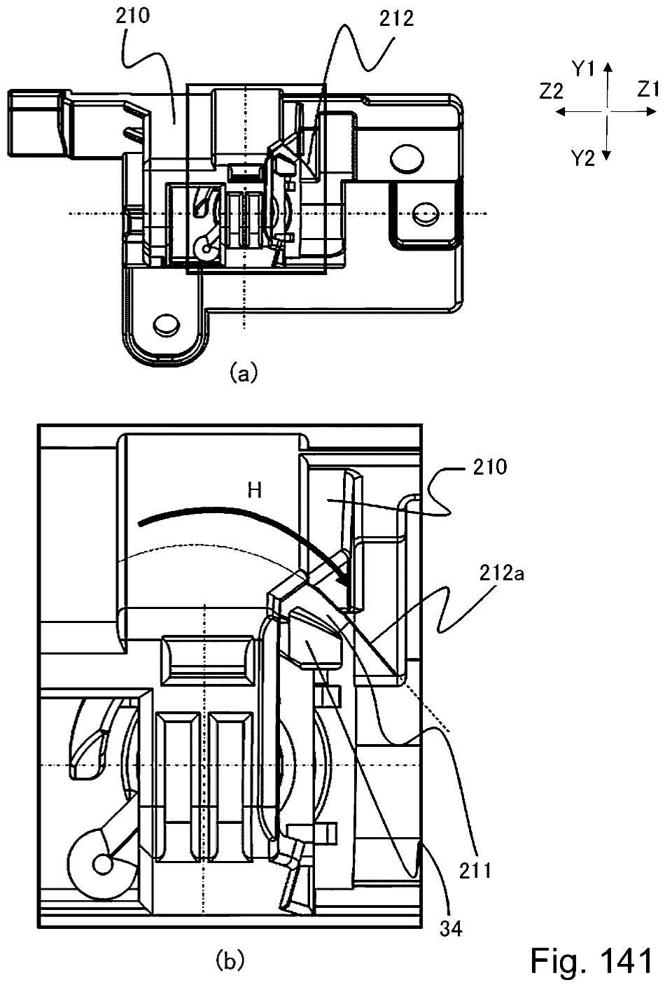

FIG. 137 is an illustration of an example of a toner cartridge C1 according to a modified example of Embodiment 1 of the present invention. Part (a) of FIG. 137 is an external perspective view of the toner cartridge C1, and part (b) of FIG. 137 is an enlarged perspective view of the area enclosed by the solid line in part (a) of FIG. 137. FIG. 138 is a perspective view illustrating the attachment position of a sheet member 212 mounted to a shutter protection member 210 according to a modified example of Embodiment 1 of the present invention. FIG. 139 is a cross-sectional view illustrating an example of the arrangement of a shutter protection member 210, a receiving side shutter member 206, a sheet member 212, and a shutter member 34 in the modified example of Embodiment 1 of the present invention. FIG. 139 shows the toner cartridge C1 according to this modified example in the process of being mounted on the process cartridge B. FIG. 140 is a view illustrating an example of the attachment position of the sheet member 212 to the shutter protection member 210 in the modified example of Embodiment 1 of the present invention. FIG. 140 is a top view of the shutter protection member 210 as seen from the top of the apparatus. FIG. 140 is a front view illustrating the attachment position of a sheet member 212 to a shutter protection member 210 according to the modified example of Embodiment 1 of the present invention. FIG. 141 is a side view illustrating the attachment position of a sheet member 212 to a shutter protection member 210 according to the modified example of Embodiment 1 of the present invention.

As shown in part (b) of FIG. 137, in this modified example, a sheet member 212 is disposed between the shutter member 34 and the shutter protection member 210 of the toner cartridge C1 to prevent toner from scattering from inside the toner cartridge C1. Specifically, as shown in FIGS. 138 and 139, a sheet member 212 is mounted at a position where it partially overlaps with a discharge opening seal contact surface 210a provided on the inner surface side of the shutter protection member 210. Another portion of the sheet member 212 (the area that does not overlap with the discharge opening seal contact surface 210a) projects from the shutter protection member 210 in accordance with the shape of the shutter member 34.

Here, as shown in FIG. 138, when the toner cartridge C1 is mounted to the process cartridge B, a gap J (approximately 0.2 mm to 0.8 mm) exists in the Z-axis direction to prevent the receiving side shutter member 206 and the shutter protection member 210 from interfering with each other. For example, when a user grips the toner accommodating portion 30 tightly, the volume of the toner accommodating portion 30 changes slightly. Therefore, for example, in the toner cartridge C of the above-described Embodiment 1 which does not have the sheet member 212, when the toner discharge opening 34a passes through the gap J, there is a possibility that the toner will scatter to the outside through the gap J due to the above-mentioned slight change in the volume of toner accommodating portion 30. In view of this, in this modified example, as shown in FIG. 139, a sheet member 212 is provided so as to cover the gap J, thereby preventing toner from unintentionally scattering through the toner discharge opening 34a. The specific structure of the sheet member 212 will be described.

As shown in FIGS. 137, 138 and 140, the sheet member 212 includes a protective portion 212a and an attachment portion 212b. The attachment portion 212b corresponds to a region of the sheet member 212 that corresponds to the discharge opening seal contact surface 210a of the shutter protection member 210. In other words, the attachment portion 212b is a part corresponding to the sheet member 212 affixed to the discharge opening seal contact surface 210a of the shutter protection member 210. Although not described in Embodiment 1, a flexible seal member 211 including a circular through hole is mounted by adhesive or the like to the toner discharge opening 34a side of the shutter member 34. The details of the seal member 211 will be described hereinafter. Therefore, in the toner cartridge C1 in this modified example, when the shutter member 34 is in a closed state, the attachment portion 212b of the sheet member 212 and the seal member 211 contact with each other to effect sealing against the toner leakage.

The protection portion 212a is a region that projects from the shutter protection member 210 in the direction in which the toner discharge opening 34a is exposed by the rotation of the shutter member 34 about the rotation axis R3. Here, the sheet member 212 in this modified example is a sheet material having a thickness of about 0.1 mm. The sheet member 212 is formed from a material such as polyphenylene sulfide (PPS) resin or polyethylene terephthalate (PET) resin, for example, and can be mounted to the shutter protection member 210 by a double-sided tape at the attachment portion 212b. Therefore, when the attachment portion 212b is mounted to the discharge opening seal contact surface 210a, the sheet member 212 deforms to conform to the shape of the discharge opening seal contact surface 210a. In this case, as shown in FIG. 141, the protective portion 212a projects outward beyond the outer shape of the shutter protection member 210 along an extension line of the shape of the discharge opening seal contact surface 210a. The size and material of the sheet member 212 are not limited to the above described example, and any flexible material may be used as long as it has a size that allows the shutter member 34 to move and can effectively prevent the toner scattering.

As shown in FIG. 140, the sheet member 212 of this modified example is formed so that the protective portion 212a forms an acute angle M with a line parallel to the mounting direction (X1 direction) in which the toner cartridge C1 is mounted to the process cartridge B. With this structure, when the toner cartridge C1 is mounted to the process cartridge B, the protective portion 212a can be prevented from coming into contact with the receiving side shutter member 206 and being broken (deformed).

As described above, it is necessary to cover the gap J with the sheet member 212 to prevent the toner scattering. Therefore, as shown in FIG. 140, the protective portion 212a of this modified example is disposed at a position corresponding to the gap J on the rotation trace of the toner discharge opening 34a of the shutter member 34 (a position covering the toner discharge opening 34a).

By employing the structure described above, in the toner cartridge C1 of this modified example, the sheet member 212 is provided so that unintended scattering of toner can be suppressed without the necessity of enhancing the rigidity of the toner accommodating portion 30.

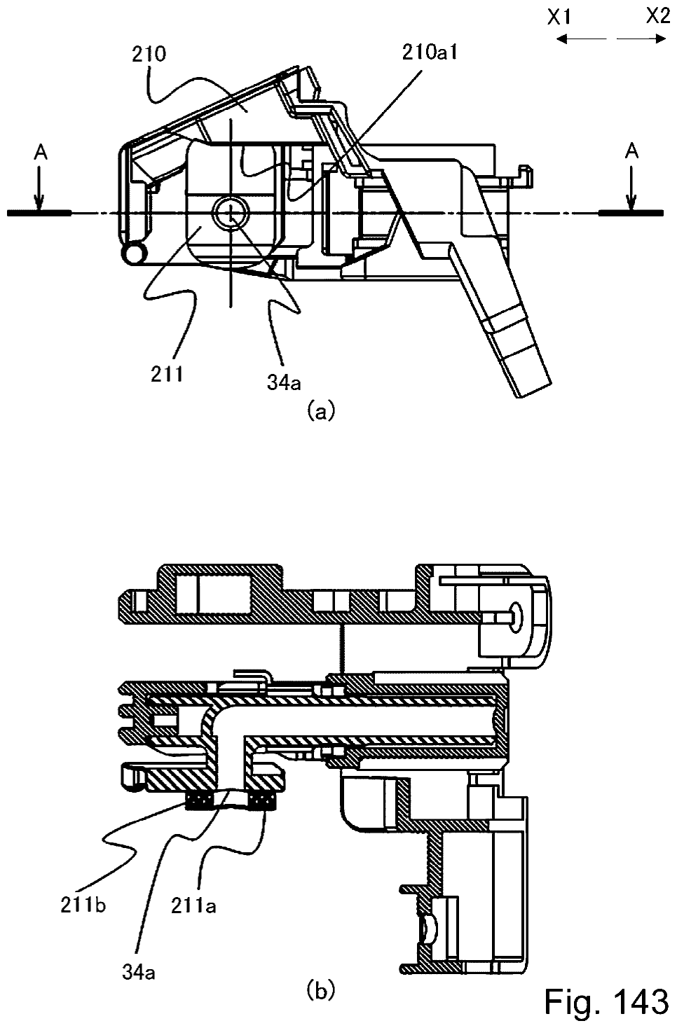

Here, referring to FIG. 143, the structure of the above-mentioned seal member 211 will be described. FIG. 143 is an illustration of an example of the structure of the seal member 211 in the modified example of Embodiment 1 of the present invention. Part (a) of FIG. 143 is a side view of various parts around the shutter member 34 as viewed along the Z axis, and part (b) of FIG. 143 is a sectional view taken along a line A-A shown in part (a) of FIG. 143. Part (b) of FIG. 143 is a section taken along a plane passing through the feeding portion 34b of the shutter member 34. As described above, it is a flexible seal member provided with a circular through hole 211a corresponding to the toner discharge opening 34a, and is provided around the toner discharge opening 34a (see FIGS. 27 and 143). The seal member 211 is disposed in a position where it is capable of sliding on the discharge opening seal contact surface 210a and the periphery of the communication opening 206a in response to the opening and closing of the shutter member 34 when the toner cartridge C1 is mounted to or dismounted from the process cartridge B (see FIG. 27). Therefore, if toner is present on the surface of the seal member 211, there is a liability that the toner on the surface of the seal member 211 falls off due to the opening direction side end 210al (see FIG. 143) located at the opening end of the discharge opening seal contact surface 210a in interrelation with the opening and closing operation of the shutter member 34.

It is also necessary to structure the seal member 211 so that it is compressed when the toner cartridge C1 is mounted to the process cartridge B, thereby to prevent the toner leakage even if there is air flow caused by the expansion and contraction of the pump unit 37.

Therefore, it is desirable that the seal member 211 of this embodiment has high repulsion and high surface sliding properties so that the rotational movement of the shutter member 34 can be carried out smoothly even if a repulsive force is applied. Therefore, as shown in part (b) of FIG. 143, the surface layer 211a of the seal member 211 is formed by weaving and knitting ultra-fine fibers of 0.1 dtex using composite yarn of polyester and nylon. By this, it possible to realize high slidability while reducing the amount of the toner present on the surface of the seal member 211. A cushion layer 211b is provided under the surface layer 211a, and urethane foam is used as the cushion layer 211b. The seal member 211 employing this cushion layer 211b allows the surface layer 211a to contact the periphery of the communication opening 206a of the receiving side shutter member 206 when the shutter member 34 is in an open state. Further, when the shutter member 34 is in a closed state, the surface layer 211a can contact the discharge opening seal contact surface 210a of the shutter protection member 210. With this structure, the toner cartridge C1 according to this embodiment can prevent toner from unintentionally leaking out regardless of whether the shutter member 34 is open or closed. Therefore, the amount of the toner accumulated on the surface of the seal member 211 can be reduced, and toner scattering resulting from the opening and closing operation of the shutter member 34 can be suppressed.

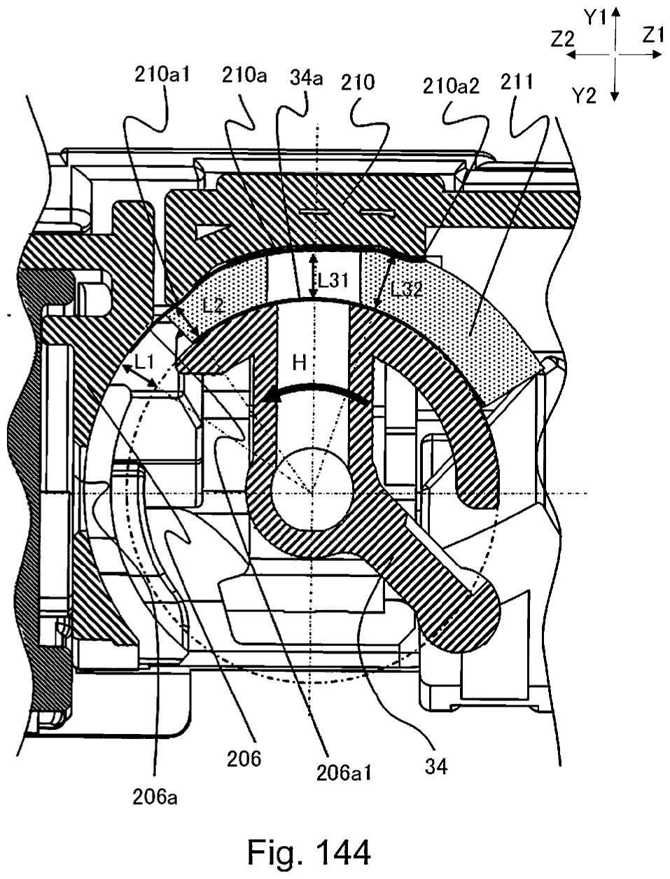

By adjusting the shape of the discharge opening seal contact surface 210a, it is also possible to prevent unintended toner leakage from the toner cartridge C1 regardless of whether the shutter member 34 is open or closed., referring to FIG. 144, such a modified example will be specifically described. As described above, the shutter member 34 is maintained in a closed state by the urging force of the coil spring 213. At this time, the toner discharge opening 34a is maintained facing the discharge opening seal contact surface 210a (that is, in the Y1 direction). The amount of twist of the coil spring 213 is larger when the toner discharge opening 34a faces the communication hole (206a) side than when the toner discharge opening 34a faces the discharge opening seal contact surface (210a) side. Therefore, the urging force of the coil spring 213 is greater when toner discharge opening 34a faces communication hole 206a than when toner discharge opening 34a faces discharge opening seal contact surface 210a.

On the other hand, when the toner discharge opening 34a faces the discharge opening seal contact surface 210a, there is no need to discharge the toner. Therefore, if the pump unit 37 is not driven in this state, the amount of compression when the seal member 211 is pressed against the shutter protection member 210 can be made smaller than when the toner discharge opening 34a is in fluid communication with the opening 216a and the communication opening 206a. Therefore, in this modified example, the shape of the discharge opening seal contact surface 210a is optimized to ensure the sealing performance of the shutter member 34 without increasing the load required when the toner cartridge C1 is mounted to the process cartridge B. Referring to FIG. 144, such a structure will be described in detail.

FIG. 144 is an illustration of an example of the shape of the discharge opening seal contact surface 210a in a modified example of Embodiment 1 of the present invention, and shows a cross-sectional view (XZ cross-section) of the toner cartridge C1 in this modified example in the process of being mounted to the process cartridge B. FIG. 143 shows a distance from the surface (including the imaginary surface) of the shutter member 34 on which the toner discharge opening 34a is formed to the inner surface of the shutter protection member 210 or the receiving side shutter member 206. Of these, the distance L1 is the distance to the opening direction side end 210al of the discharge opening seal contact surface 210a. Further, the distance L2 is the distance to the closing direction end of the periphery of the communication opening 206a of the receiving side shutter member 206 in the closing direction. Furthermore, by making the distance L1 and the distance L2 substantially the same (i.e., L1/L2 nearly equals 1), a sudden change in the compression state (compression rate) of the seal member 211 in response to the opening and closing operation of the shutter member 34 is prevented.

In addition, when distance L3 is defined as the distance from the opening direction side end 210al of discharge opening seal contact surface 210a to the discharge opening seal contact surface 210a on the closing direction side, the dimension of distance L3 varies depending on the location. Specifically, in this modified example, the distance L3 increases as it approaches the opposite side end (opposite end) 210a2 relative to the opening direction side end 210al of the discharge opening seal contact surface 210a. For example, when a distance L31 at a position corresponding to toner discharge opening 34a is compared with a distance L32 located closer to opposite end 210a2 than toner discharge opening 34a, L31<L32 is satisfied. However, even in the area corresponding to the distance L3, in order to realize stable toner discharge, it is desirable that the distance of the portion corresponding to the toner discharge opening 34a is constant.

By employing the structure described above, the coil spring 213 can effectively urge the shutter member 34 without increasing the compressed state of the shutter seal member 211, taking into account the open/closed state of the shutter member 34 (i.e., the urging force of the coil spring 213),. In other words, even if the urging force of the coil spring 213 is weak, the shutter member 34 can be opened and closed while preventing toner from scattering, so that the load on the toner cartridge C1 can be reduced. In the above-described example, a structure has been described in which the distance L3 increases as it approaches the opposite side end 210a2 from the opening direction side end 210al of the discharge opening seal contact surface 210, but the present invention is not limited to such an example. For example, a structure in which the distance from the opening direction side end 210al to the opposite side end 210a2 is gradually increased with respect to L2 may be used.

### Embodiment 2

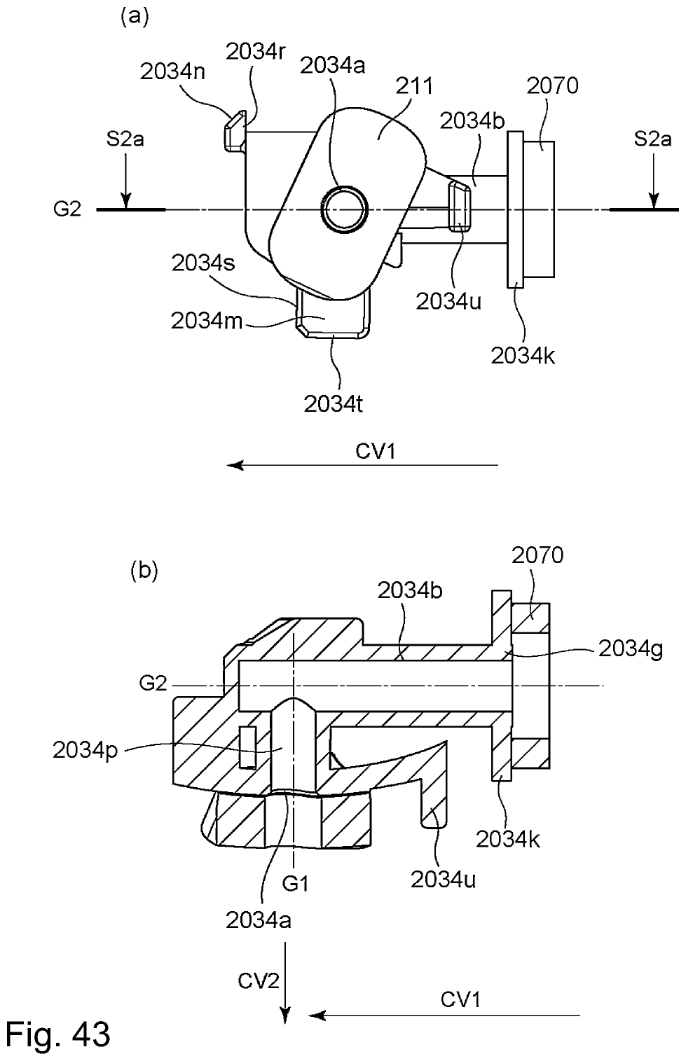

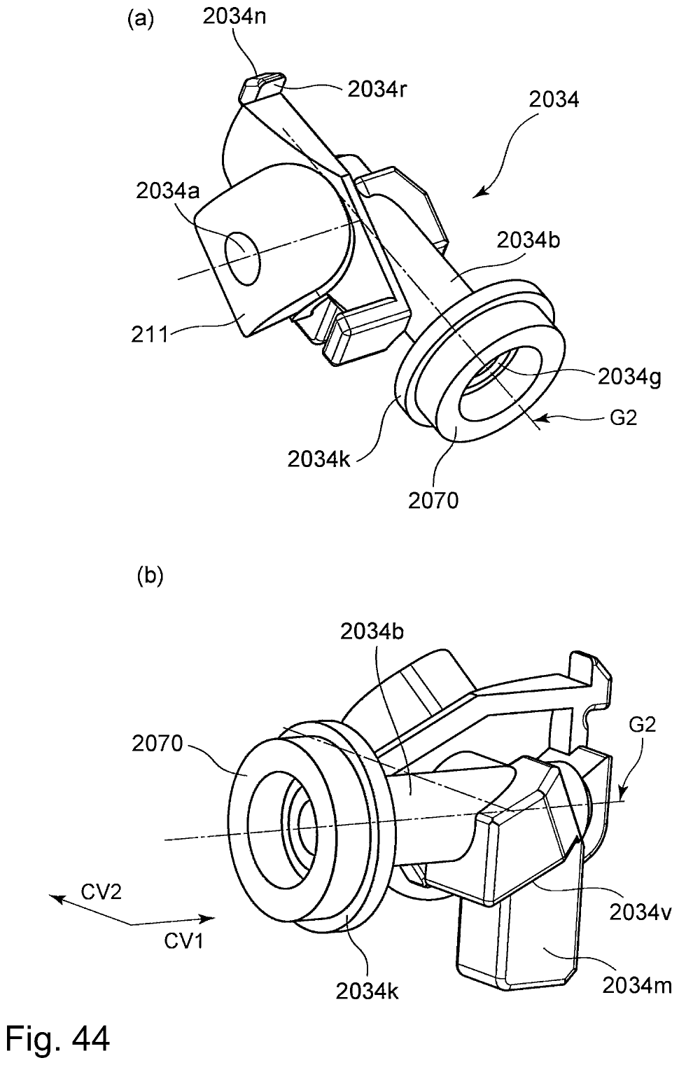

In Embodiment 1, the shutter member 34 is provided in the toner cartridge C. However, the shutter member 34 may be provided as a separate part from the toner cartridge C. Referring to FIGS. 44 and 43, the description will be made as to a shutter member (toner feeding member) 2034 including an attachment mechanism connectable to the process cartridge B and a toner cartridge C2 (which will be described hereinafter) in this embodiment. The same components as those in Embodiment 1 will be assigned the same reference numerals and symbols as those in Embodiment 1. In addition, regarding the toner cartridge side and the shutter member, the members having the same functions and roles as those in Embodiment 1 are given the same names and similar portion numbers and symbols. In the following explanation, an example will be taken in which the process cartridge B with the shutter member 2034 mounted is mounted in the printer main assembly A, and then the toner cartridge C2 is mounted, but the present invention is not limited to such an example. For example, after only the process cartridge B is mounted in the printer main assembly A, the shutter member 2034 may be mounted in the process cartridge B. Alternatively, the process cartridge B, the shutter member 2034, and the toner cartridge C2 may be mounted in the printer main assembly A in a combined state.

FIG. 43 is a view illustrating an example of a toner feeding direction by the shutter member 2034 according to Embodiment 2 of the present invention. Part (a) of FIG. 43 is a side view of the shutter member 2034, and part (b) of FIG. 43 is a cross-sectional view taken along a line S2a-S2a shown in part (a) of FIG. 43. FIG. 44 is an external perspective view of the shutter member 2034 of Embodiment 2 of the present invention, wherein part (a) of FIG. 44 is perspective view at an angle at which the discharge opening 2034a is seen, and part (b) of FIG. 44 is a perspective view at an angle at which the seal member 2070 is seen.

As shown in part (b) of FIG. 43, the shutter member 2034 is a cylindrical member having a substantially L-shaped through hole consisting of a first toner feed tube 2034b extending in a first feeding direction CV1 and a second toner feed tube 2034p extending in the second feeding direction CV2. The first feeding direction CV1 is substantially parallel to an axis G2 that passes through the center of the first toner feed tube 2034b. Here, the first feeding direction CV1 and the second feeding direction CV2 indicate the directions in which toner passes through the first toner feed tube 2034b and the second toner feed tube 2034p, and are not uniquely determined directions. Therefore, in this embodiment, the direction from the toner cartridge C2 side toward the process cartridge B side along each toner feed tube is defined as the toner feeding direction.

A toner inlet 2034g is provided at the end of the first toner feed tube 2034b opposite the first feeding direction CV1 in a direction parallel to the axis G2. In addition, in a direction perpendicular to the axis G2, a toner discharge opening 2034a is provided at an end of the second toner feed tube 2034p in the second feeding direction CV2.

A flange portion 2034k having a diameter larger than that of the toner feed tube 2034b is provided coaxially on the toner inlet 2034g side of the shutter member 2034. The cylindrical flexible seal member 2070 is mounted to the shutter member 2034 by adhesive or the like so as to surround the toner inlet 2034g, and is positioned on the opposite side of the flange portion 2034k in the first feeding direction CV1. Further, on the toner discharge opening 2034a side of the shutter member 2034, a flexible seal member 211 having a circular through hole is mounted by adhesive or the like.

As shown in part (a) of FIG. 43, the shutter member 2034 is provided with a claw portion 2034n at one end in the first feeding direction CV1, the end being an end in a direction perpendicular to the central axis G1 of the first toner feed tube 2034b and the central axis G2 of the second toner feed tube 2034p. The direction perpendicular to the axis G1 and the axis G2 is approximately parallel to the up-down direction of the shutter member 2034 in this embodiment. As the shutter member 2034 is viewed from a direction facing the toner discharge opening 2034a along the axis G1, the claw portion 2034n projects in a direction away from the axis G2 and has a first engagement surface 2034r which is approximately perpendicular to the axis G2.

As the shutter member 2034 is viewed in a direction facing the toner discharge opening 2034a along the axis G1, the shutter member 2034 is provided with an engagement portion 2034m projecting the side opposite from the claw portion 2034n with respect to the axis G2. The engagement portion 2034m is provided, at its end in the first feeding direction CV1, with a first adhesive surface 2034s which is a surface substantially perpendicular to the axis G2, and with a second adhesive surface 2034t which is a surface substantially parallel to the axis G2.

The shutter member 2034 is provided with a projection 2034u which projects in the second toner feeding direction CV2 from the surface on which the toner discharge opening 2034a is provided. The projection 2034u is provided between the toner discharge opening 2034a and the flange portion 2034k in a direction substantially parallel to the axis G2, and is provided on the opposite side of the toner discharge opening 2034a in the first feeding direction CV1.

Further, as shown in part (b) of FIG. 44, a first inclined surface 2034v is provided at the end of the toner discharge opening 2034a in a direction opposite to the second feeding direction CV2. The first inclined surface 2034v is a surface inclined with respect to the axis G2, and is inclined so as to approach the axis G2 along the first feeding direction CV1. The operation of each portion of the shutter member 2034 described above will be described in detail later.

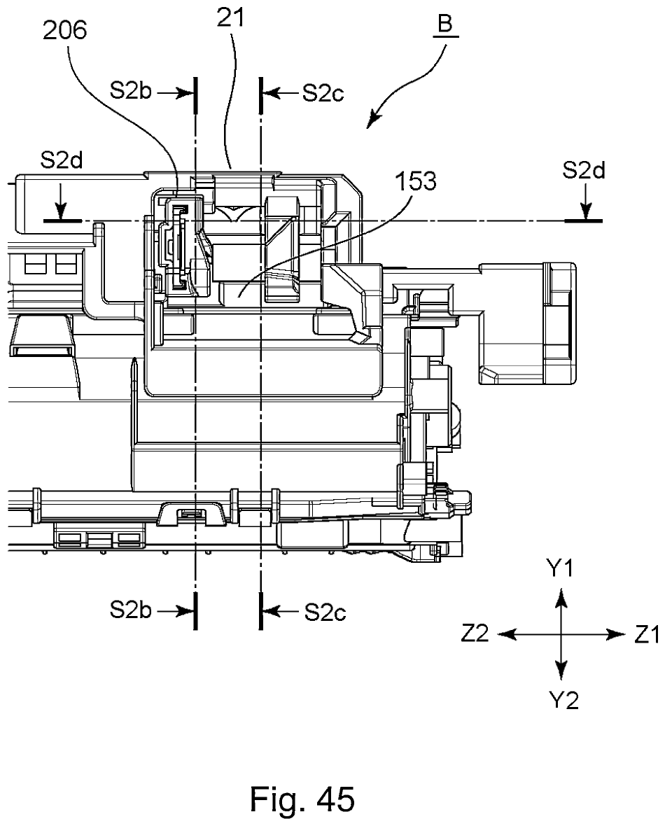

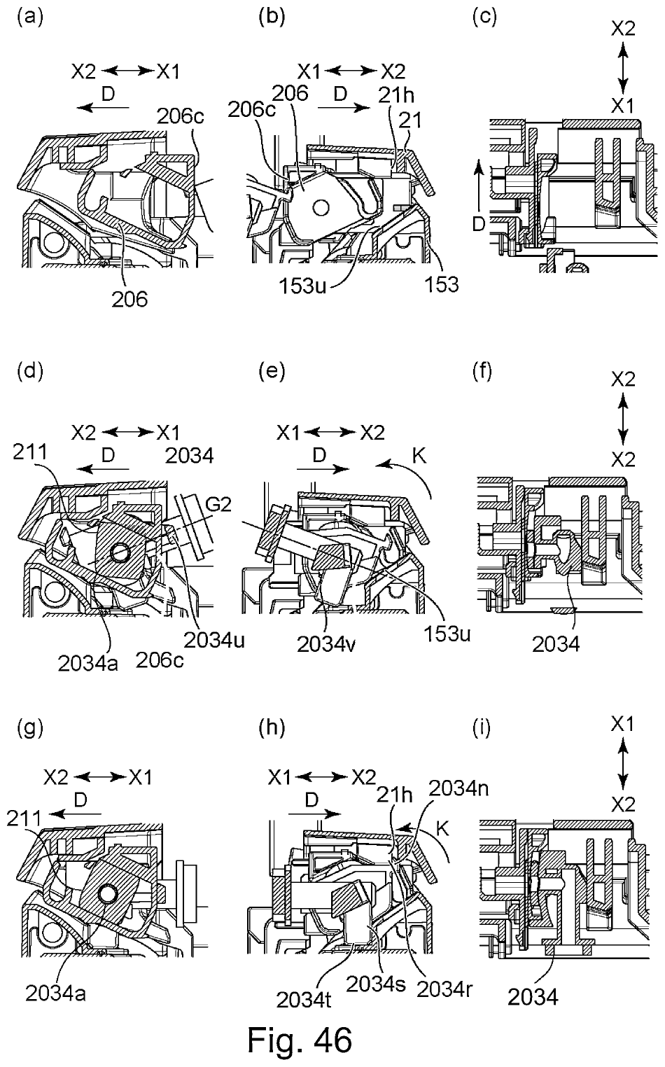

Next, referring to FIGS. 45 and 46, the process cartridge B will be described. FIG. 45 is a partial side view of the attachment portion of the shutter member 2034 with the process cartridge B according to Embodiment 2 of the present invention. FIG. 46 is a view illustrating an example of operation of the shutter member 2034 in Embodiment 2 of the present invention. Part (a) of FIG. 46 to part (i) of FIG. 46 show sectional views taken along lines S2c-S2c and S2d-S2d shown in FIG. 45 in time series in the order of part (a) of FIG. 46 to part (i) of FIG. 46. Here, part (a) of FIG. 46, part (d) of FIG. 46, and part (g) of FIG. 46 show S2b-S2b sectional views, part (b) of FIG. 46, part (e) of FIG. 46, and part (h) of FIG. 46 show S2c-S2c sectional views, and part (c) of FIG. 46, part (f) of FIG. 46, and part (i) of FIG. 46 show S2d-S2d sectional views. Part (a) of FIG. 46, part (b) of FIG. 46, and part (c) of FIG. 46 are sectional views of the process cartridge B before the shutter member 2034 is mounted. Part (d) of FIG. 46, part (e) of FIG. 46, and part (f) of FIG. 46 are sectional views of the process cartridge B when the shutter member 2034 is in the process of being mounted (before mounting is completed). Part (g) of FIG. 46, part (h) of FIG. 46, and part (i) of FIG. 46 are sectional views of the process cartridge B after the shutter member 2034 has been completely mounted.

As shown in part (b) of FIG. 46, the process cartridge B is provided with a receiving shutter member 206 and a stay 21, similarly to Embodiment 1. A second engagement surface 206c perpendicular to the mounting direction D is provided at the end of the receiving shutter member 206 in the direction opposite to the mounting direction D. As shown in part (b) of FIG. 46, a second inclined surface 153u inclined with respect to the mounting direction D is provided in the toner receiving chamber 153, in a direction facing the mounting direction D. The second inclined surface 153u is inclined upward along the mounting direction D of the shutter member 2034 to the process cartridge B.

Also, as shown in part (b) of FIG. 46, a third engagement surface 21h is provided at the upper rear side of the stay 21 in the mounting direction D, wherein the third engagement surface 21h extends downward (X2 direction), is perpendicular to the mounting direction D, and faces in the opposite direction to the mounting direction D.

As shown in part (d) of FIG. 46, part (e) of FIG. 46, and part (f) of FIG. 46, the shutter member 2034 moves in the mounting direction D and is mounted on the process cartridge B. Here, while the shutter member 2034 is in the middle of being mounted to the process cartridge B (before the mounting is completed), the axis G2 of the shutter member 2034 is inclined with respect to the mounting direction D.

As shown in part (d) of FIG. 46, when the shutter member 2034 moves (is inserted) relative to the process cartridge B in the mounting direction D, the projection 2034u comes into contact with the second engagement surface 206c of the receiving shutter member 206. With this action, the shutter member 2034 and the receiving shutter member 206 move together.

In addition, as shown in part (e) of FIG. 46, the first inclined surface 2034v of the shutter member 2034 abuts against the second inclined surface 153u of the process cartridge B, so that the shutter member 2034 rotates in a rotational direction K perpendicular to the longitudinal direction (the direction of the arrow Z1). Further, the longitudinal direction (Z1 direction) in part (e) of FIG. 46 is a direction perpendicular to the sheet of the drawing, and the shutter member 2034 can rotate in the direction of arrow K about a rotation axis parallel to the longitudinal direction.

When the shutter member 2034 is further pushed inward in the mounting direction D, the mounting of the shutter member 2034 to the process cartridge B is completed, as shown in part (g) of FIG. 46, part (h) of FIG. 46, and part (i) of FIG. 46. As shown in part (h) of FIG. 46, the first adhesive surface 2034s and the second adhesive surface 2034t of the shutter member 2034 are brought into contact with the toner receiving chamber 153 and are fixed thereto with adhesive tape or the like. The adhesive tape may be mounted to each of the adhesive surfaces on the shutter member 2034 side, or may be mounted to the toner receiving chamber 153 side. Alternatively, the shutter member 2034 and the toner receiving chamber 153 may be fixed together using an adhesive gel or the like as an intermediary material in place of the adhesive tape. Furthermore, magnets or the like may be provided in each contact surface and in the corresponding portion of the process cartridge B that comes into contact with the contact surface, and the shutter member 2034 and the process cartridge B may be fixed together by magnetic attraction force.

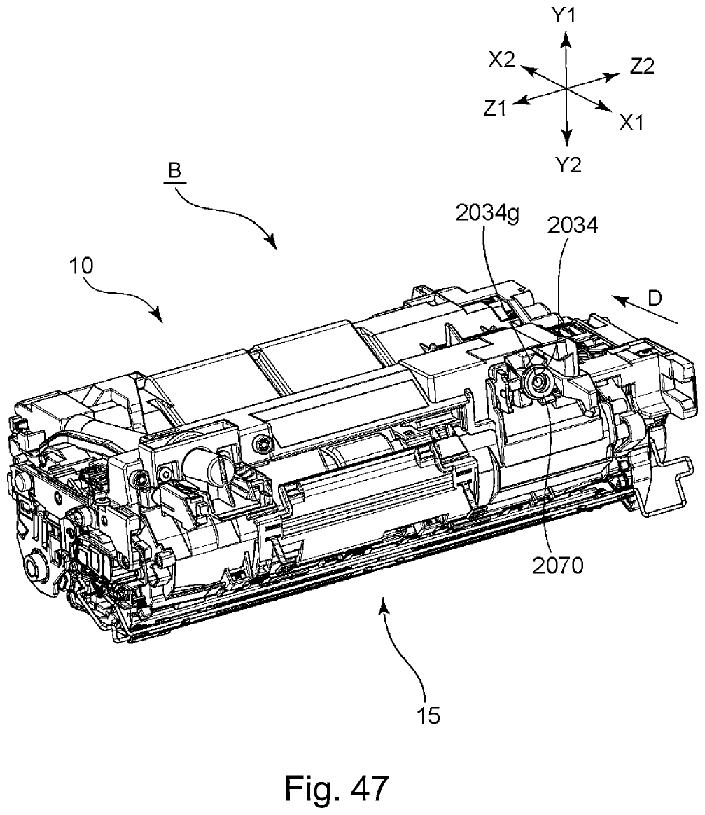

Furthermore, in the state shown in part (h) of FIG. 46, by the shutter member 2034 rotating in the rotational direction K, the first engagement surface 2034r of the claw portion 2034n is brought into contact with the third engagement surface 21h of the stay 21. In this state, as shown in FIG. 47, the mounting of the shutter member 2034 to the process cartridge B is completed. FIG. 47 is an illustration of an example of a state in which the shutter member 2034 is mounted to the process cartridge B according to Embodiment 2 of the present invention.

By employing the above-described structure, the shutter member 2034 of this embodiment can be maintained in a mounted state in the process cartridge B. More specifically, the shutter member 2034 receives an urging force in the direction opposite to the mounting direction D from the receiving shutter member 206 by the compression spring 217 (see FIG. 34) described in Embodiment 1. Against this urging force, the claw portion 2034n engages with the process cartridge B, and the process cartridge B is adhered to the first adhesive surface 2034s and the second adhesive surface 2034t, thereby maintaining the shutter member 2034 in a mounted state to the process cartridge B.

Next, the toner cartridge C2 to which the shutter member 2034 can be connected will be described. Here, as for the toner cartridge C2 in this embodiment, the description of the same structure as the toner cartridge C in the above-described Embodiment 1 will be omitted.

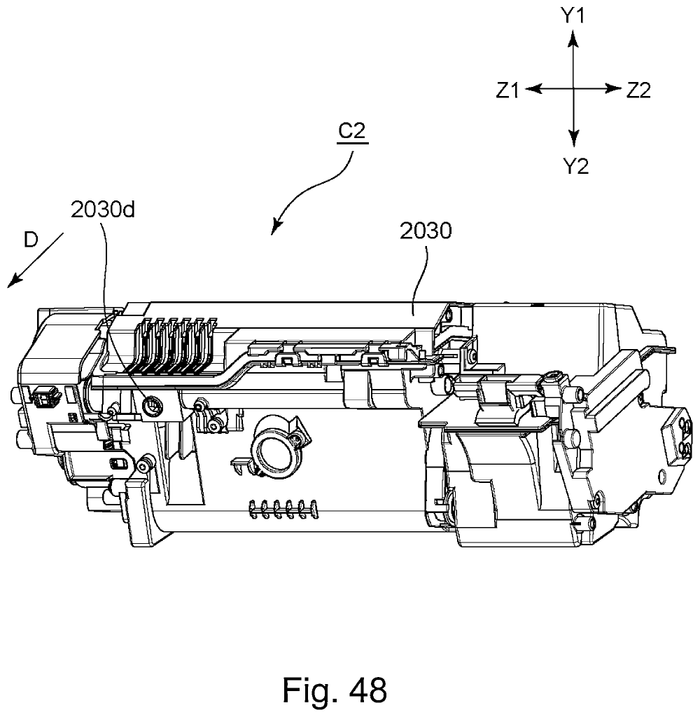

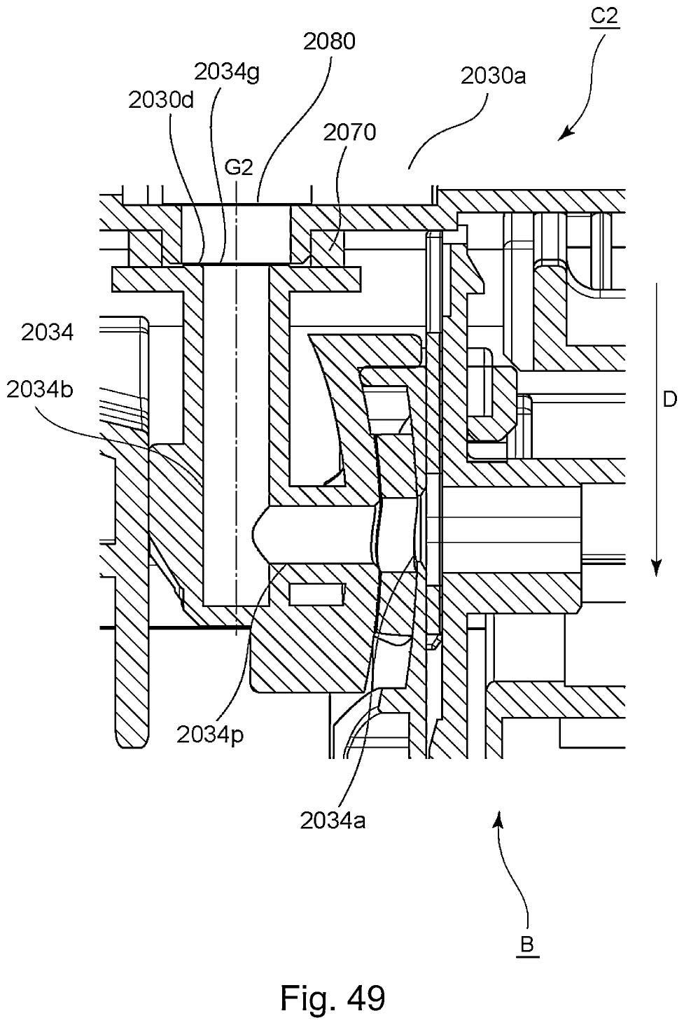

FIG. 48 is an external perspective view of the toner cartridge C2 according to Embodiment 2 of the present invention. FIG. 49 is a sectional view taken along the axis G2 in a state where the toner cartridge C2 and the process cartridge B according to Embodiment 2 of the present invention have been completely mounted.

As shown in FIGS. 48 and 49, a toner accommodating portion 2030 is provided with a cylindrical toner supply opening 2030d which projects along the mounting direction D (i.e., toward the process cartridge P side). A toner seal 2080 is provided between the toner supply opening 2030d and the toner accommodating chamber 2030a. The toner seal 2080 is provided so that it is pulled away, and the toner supply opening 2030d communicates with the toner accommodating chamber 2030a, when the toner cartridge C2 receives a driving force from the printer main assembly A.

As shown in FIG. 49, when the toner cartridge C2 is mounted to the process cartridge B, the seal member 2070 is compressed in the mounting direction D. Furthermore, in this state, the toner supply opening 2030d enters the inside of the cylindrical portion of the seal member 2070 and faces the toner inlet 2034g. When the toner is discharged from the toner supply opening 2030d, the toner is supplied into the process cartridge B through the shutter member 2034 while the gap between the toner cartridge C2 and the shutter member 2034 is sealed by the seal member 2070.

As described above, by employing the shutter member 2034, it is possible to supply toner from the toner cartridge C2 into the process cartridge B by way of a toner feeding member (the shutter member 2034) which is separate from the toner cartridge C2. With this structure, when the toner cartridge is replaced after toner is consumed up, there is no need to replace the shutter member 2034 for feeding and discharging toner to the process cartridge B side. In addition, with the above-described structure, it is possible to replace only the toner cartridge C2 with the process cartridge B including the shutter member 2034 having mounted thereto. Therefore, when replacing the toner cartridge C2, the durability of the process cartridge B is not deteriorated without the necessity of interrelated action with the toner cartridge C2.

In the above-described example, the shutter member 2034 is mounted while being rotated in the rotational direction K. Alternatively, similarly to Embodiment 1, when the shutter member is mounted in the mounting direction D relative to the process cartridge B, the shutter member may be structured to rotate about the axis G2. In the following, as an example different from the above-mentioned shutter member 2034, an example in which a toner feeding member is (indirectly) mounted to the process cartridge B by way of an attachment separate from the toner feeding member will be described. That is, a structure will be described in which the process cartridge B and the toner cartridge C2 are connected by way of a toner feeding member, an auxiliary mounting member, two separate attachments between the process cartridge B and the toner cartridge C2. Details will be explained below.

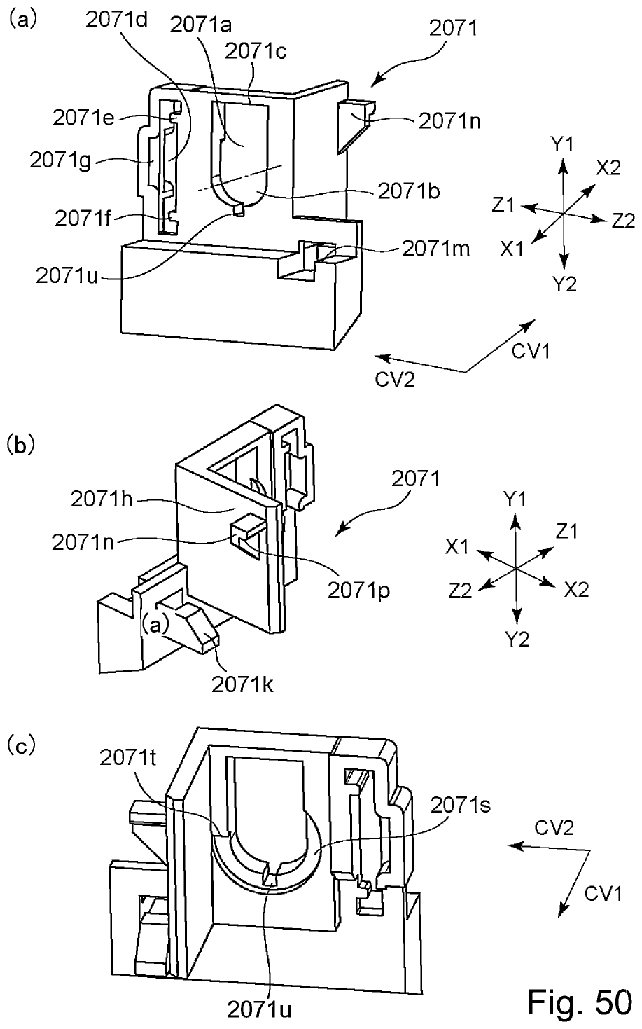

FIG. 50 is an illustration of an example of an attachment 2071 according to Embodiment 2 of the present invention. Part (a) of FIG. 50, part (b) of FIG. 50, and part (c) of FIG. 50 are external perspective views of the attachment 2071 as viewed in different directions.

As shown in part (a) of FIG. 50, the attachment 2071 is an auxiliary mounting member for assistance in mounting a shutter member 2072 (which will be described hereinafter) to the process cartridge B. The shutter member 2071 is mounted to the attachment 2071 in a state that the attachment 2071 is mounted to the process cartridge B, and therefore, the manipulation for aligning the shutter member 2071 with respect to the process cartridge B can be eliminated.

The attachment 2071 is partially plate-like, and has a first through hole 2071a provided in the center. One through hole 2071a is formed in combination of the semicircular portion 2071b and the rectangular hole portion 2071c. A cut-away portion 2071u is provided at the bottom (Y2 direction) of the through hole 2071a so as to be continuous with the semicircular portion 2071b.

As shown in part (c) of FIG. 50, the surface of the attachment 2071 facing the first feeding direction CV1 (i.e., the X2 direction) is provided with a recess portion 2071s, which is a semicircular recessed surface having a center thereof at the center of the semicircular portion 2071b. A flat surface portion 2071t is provided at one end of the semicircular edge portion which forms the semicircular recess portion 2071s.

A rectangular through hole (second through hole) 2071d which has a short side extending in the Z1 direction, is provided on the second feeding direction CV2 side (i.e., the Z1 direction) of the attachment 2071. The through hole 2071d is provided with a first rib-shaped portion 2071e and a second rib-shaped portion 2071f which are formed to extend toward the inside of the through hole 2071d in the Z1 direction. As shown in part (a) of FIG. 50, a fourth engagement surface 2071g having a thickness in the X1-X2 direction and a flat plate shape parallel to the YZ plane is provided inside the through hole 2071d.

As shown in part (b) of FIG. 50, in the attachment 2071, a plate-like portion 2071h extending in the X2 direction is provided on the opposite side of the through hole 2071a from the through hole 2071d. In addition, a projection 2071n projecting from the plate-like portion 2071h in the Z2 direction is provided. Further, a surface 2071p extending from the projection 2071n in the X2 direction is provided. Furthermore, similarly to the plate-like portion 2071h, the attachment 2071 is provided with a claw portion 2071k extending in the X2 direction.

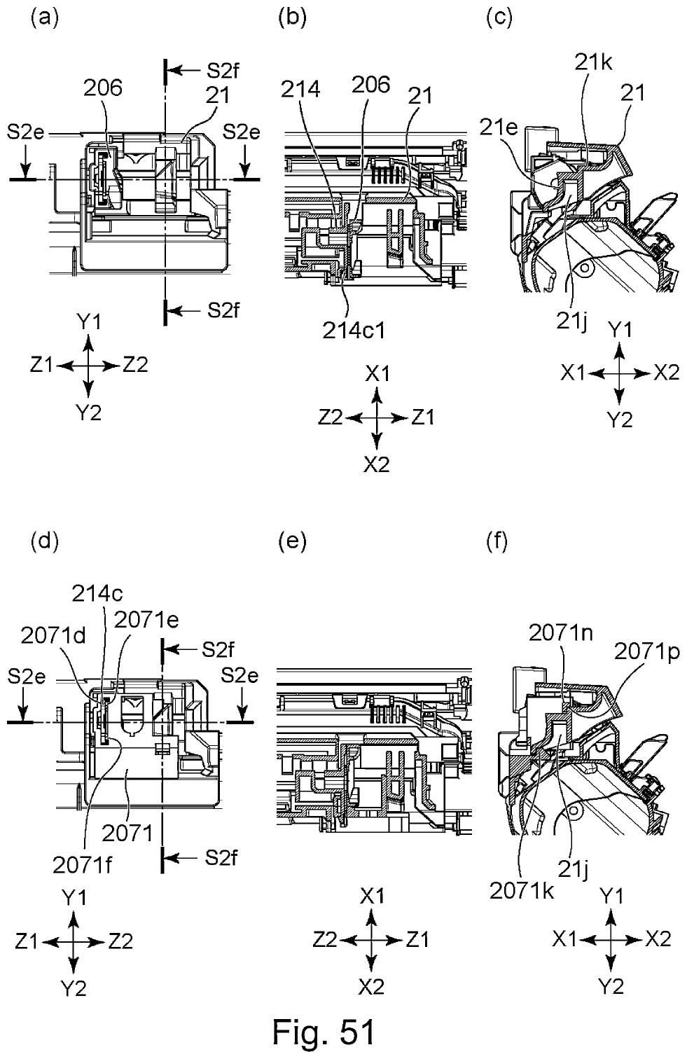

Next, referring to FIG. 51, a method of mounting the attachment 2071 to the process cartridge B will be described. FIG. 51 is an illustration of an example of an operation when the attachment 2071 according to Embodiment 2 of the present invention is mounted to the process cartridge B. Part (a) of FIG. 51 and part (d) of FIG. 51 are detailed side views of the process cartridge B before and after the attachment 2071 is mounted, respectively, and part (b) of FIG. 51 and part (e) of FIG. 51 are sectional views taken along a line S2e-S2e shown in part (a) of FIG. 51 and part (d) of FIG. 51. Part (c) of FIG. 51 and part (f) of FIG. 51 are cross-sectional views taken along a line S2f-S2f shown in part (a) of FIG. 51 and part (d) of FIG. 51.

As shown in part (b) of FIG. 51, the process cartridge B is provided with a stay 21, a toner flow passageway member 214, and a receiving shutter member 206, similarly to Embodiment 1.

As shown in part (b) of FIG. 51, the receiving shutter member 206 is pressed in the opposite direction to the mounting direction D by the urging force of the compression spring 217 (see FIG. 34) and is in contact with the restricting portion 214cl of the toner flow passageway member 214.

As shown in part (c) of FIG. 51, the stay 21 is provided with the guide surface 21e and a recess 21j recessed upward therein. In addition, a projection 21k is provided so as to project upward toward the mounting direction D side beyond the guide surface 21e of the stay 21.

As shown in part (d) of FIG. 51, when the attachment 2071 is mounted on the process cartridge B, the rail member 214c of the toner flow passageway member 214 fits into a space defined by the through hole 2071d of the attachment 2071 and the two rib-shaped portions 2071e and 2071f. At this time, the attachment 2071 comes into contact with the receiving shutter member 206 and moves integrally therewith in the mounting direction D. By further moving the attachment 2071 in the mounting direction D, the restricting portion 214cl of the toner flow passageway member 214 is deformed and moves over the fourth engagement surface 2071g. With this structure, the fourth engagement surface 2071g of the attachment 2071 abuts against the restricting portion 214cl of the toner flow passageway member 214 in the mounting direction D due to the urging force of the compression spring 217. At this time, the supply opening 21c on the process cartridge B side and the communication opening 206a of the receiving shutter member 206 are brought into fluid communication with each other. Furthermore, at this time, as shown in part (f) of FIG. 51, the claw portion 2071k provided on the attachment 2071 deforms in the Y2 direction and enters the recess 21j of the stay 21, thereby urging the attachment 2071 downward (Y2 direction). The projection 2071n of the attachment 2071 abuts against the projection 21k of the stay 21 in the X2 direction (i.e., the mounting direction D). Furthermore, the surface 2071p abuts against the projection 21k in the Y1 direction. That is, the attachment 2071 is mounted on the process cartridge B in such a manner that the stay 21 is sandwiched between the claw portions 2071k and the surface 2071p in both the Y1 direction and the Y2 direction (up and down direction).

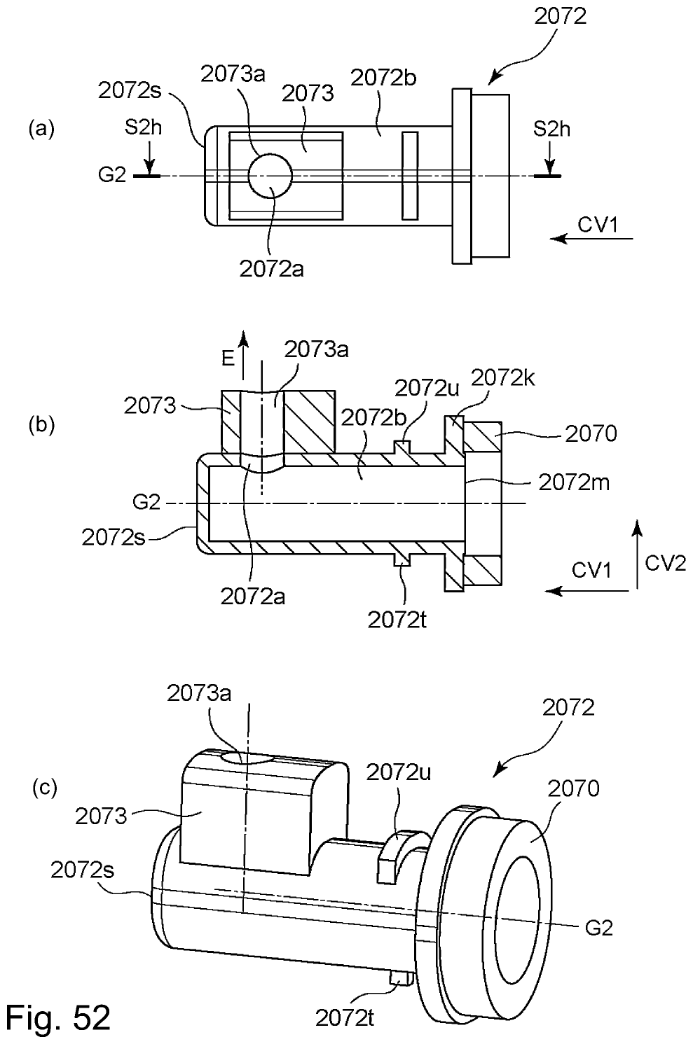

Next, the shutter member 2072 will be described. FIG. 52 is an illustration of an example of a structure of the shutter member 2072 according to Embodiment 2 of the present invention. Part (a) of FIG. 52 is a side view of the shutter member 2072, and part (b) of FIG. 52 is a sectional view taken along a line S2h-S2h shown in part (a) of FIG. 51. Part (c) of FIG. 52 is a perspective view of an outer appearance of the shutter member 2072.

As shown in FIG. 52, the shutter member 2072 includes a cylindrical portion and a toner feed tube 2072b extending along the first feeding direction CV1. Further, a free end portion 2072s is provided at the free end on the first feeding direction CV1 side. A toner discharge opening 2072a is provided on the free end 2072s side of the shutter member 2072 in a direction perpendicular to the axis G2. That is, the opening of the toner discharge opening 2072a faces a direction perpendicular to axis G2. Here, the direction in which the toner is discharged from the toner discharge opening 2072a is depicted as a discharging direction E in the drawing. Further, a toner receiving opening 2072m which is an opening centered on the axis G2 is provided at the end of the shutter member 2072 opposite to the bottom portion 2072s, along a direction parallel to the axis G2.

Furthermore, a flange portion 2072k having a diameter larger than that of the toner feed pipe 2072b is provided around the axis G2 so as to surround the toner receiving opening 2072m. A cylindrical seal member 2070 is mounted to the flange portion 2072k on the side upstream in the first feeding direction CV1. A contact portion 2073 contacting the attachment 2071 is mounted to the side of the shutter member 2072 where the toner discharge opening 2072a is provided. The contact portion 2073 is a rectangular toner discharge member having a through hole 2073a and surrounding the toner discharge opening 2072a. In this embodiment, a flexible member such as a sponge is used as an example.

A first projection 2072t and a second projection 2072u which extend in a direction perpendicular to the axis G2 are provided between the toner discharge opening 2072a and the flange portion 2072k in the direction of the axis G2 of the shutter member 2072. The first projection 2072t is provided extending from the toner feed tube 2072b to the side where the contact portion 2073 is provided, and the projection 2072u is provided extending in the opposite direction.

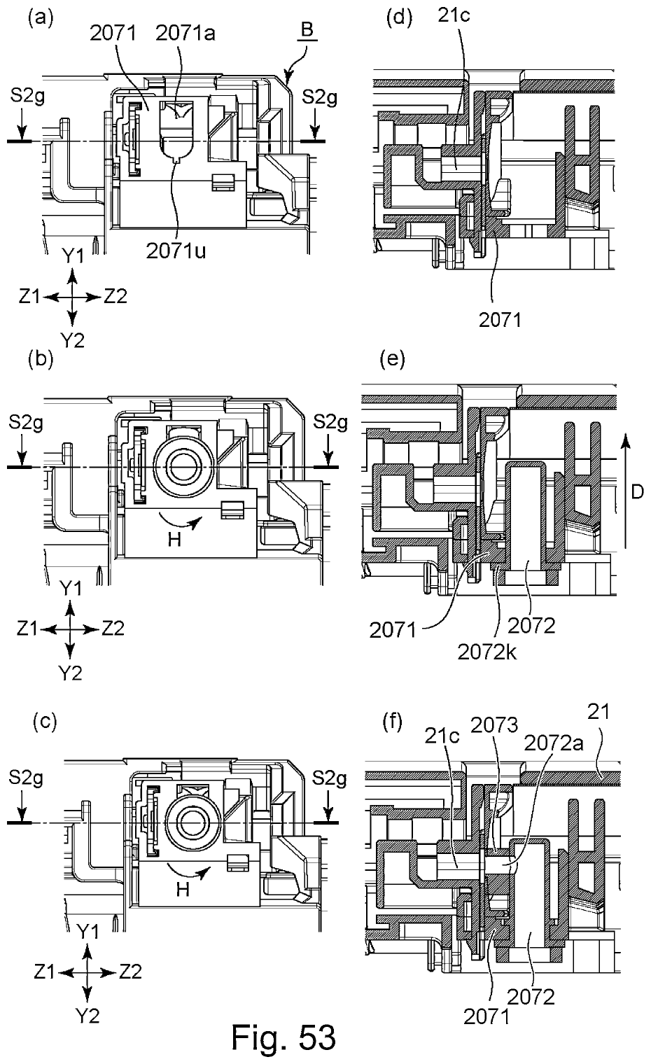

Here, referring to FIG. 53, a method of mounting the shutter member 2072 onto the process cartridge B to which the attachment 2071 has been mounted will be described. FIG. 53 is an illustration of an example of the mounting operation of the shutter member 2072 to the process cartridge B according to Embodiment 2 of the present invention. Part (a) of FIG. 53 shows the state before the shutter member 2072 is mounted to the process cartridge B. Part (b) of FIG. 53 shows a state in which the shutter member 2072 is in the process of being mounted to the process cartridge B. Part (c) of FIG. 53 shows the state after the shutter member 2072 has been completely mounted to the process cartridge B. 53 (d), (e), and (f) are sectional views taken along a line S2g-S2g shown in part (a) of FIG. 53, part (b) of FIG. 53, and part (c) of FIG. 53, respectively. Each of part (a) of FIG. 53, part (b) of FIG. 53, and part (c) of FIG. 53 shows the process cartridge B as viewed in the mounting direction D (i.e., X2 direction), wherein a direction toward the back side of the sheet of the drawing of this Figure is the X2 direction (i.e., the mounting direction D), and the opposite direction is the X1 direction.

With the toner discharge opening 2072a facing upward (Y1 direction), the shutter member 2072 is inserted into the through hole 2071a of the attachment 2071 in the mounting direction D (X2 direction). At this time, the second projection 2072u of the shutter member 2072 is inserted into the through hole 2071u of the attachment 2071. Then, as shown in part (e) of FIG. 53, the flange portion 2072k is brought into contact with the attachment 2071.

Thereafter, the shutter member 2072 is rotated in the direction of an arrow H while the contact portion 2073 is being deformed, and the mounting on the process cartridge B side is completed, as shown in part (f) of FIG. 53. At this time, the recess portion 2071s of the attachment 2071 is sandwiched between the first projection 2072t and the second projection 2072u of the shutter member 2072 and the flange portion 2072k into a lightly pressed-in state. Furthermore, by the rotation of the shutter member 2072 in the direction of the arrow H, the first projection 2072t is brought into contact with the flat surface portion 2071t of the attachment 2071, and the rotation stops in this state. At this time, as shown in part (f) of FIG. 53, the toner discharge opening 2072a of the shutter member 2072 is positioned so as to face the toner supply opening 21c. A shutter member 2072 is mounted to the process cartridge B by way of an attachment 2071.

The order in which the shutter member 2072 and the attachment 2071 are mounted is not limited to the above-mentioned order. For example, the shutter member 2072 may be mounted on the process cartridge B after the attachment 2071 is mounted to the shutter member 2072. The timing of mounting the process cartridge B into the printer main assembly A can be determined regardless of whether the attachment 2071 or the shutter member 2072 is mounted. The foregoing describes the mounting operation of the toner feeding member into the process cartridge B in this embodiment. A toner cartridge C is mounted to the process cartridge B to which the shutter member 2072 has been mounted, but the structure therefor is the same as when the shutter member 2034 described above is used, and therefore, the description thereof will be omitted.

In the above-described example, the attachment 2071 is used as an example of a structure in which the shutter member which is separate from the toner cartridge, is mounted to the process cartridge B while rotating about the axis G2. However, the shutter member according to this embodiment may be structured so that it is mounted to the process cartridge B while rotating the shutter member itself about the axis G2, without using the attachment 2071. In such a case, it will suffice if the shape of the end of the shutter member in the X2 direction (the mounting direction D side) is the same as that of the shutter member 34 in Embodiment 1, and it will suffice if the shape of the end in the X1 direction (the side of the connection with the toner cartridge) is the same as that of the shutter member 2034. In other words, it will suffice if the shape of the shutter member (toner feeding member) is the same as in Embodiment 1, and the shutter member which functions as an attachment separate from the toner cartridge can be mounted to the toner cartridge and/or process cartridge. In such a case, that the projection on the toner cartridge side is structured to be inserted into the inside of the seal member of the cylindrical portion (toner feed tube, and so on) which constitutes the shutter member.

In addition, in the above-described example, when connecting the shutter member and the toner cartridge, a structure has been described in which the toner cartridge side has a projection shape and the shutter member side receives the projection-shaped portion, but the present invention is not restricted to such an example. For example, a structure may be such that which a projecting portion on the shutter member side is inserted into a sealing member on a cylindrical portion (such as a toner feed tube) on the toner cartridge side. Although the sealing member has been described as being cylindrical in shape, it may be of any shape (for example, rectangular, and so on) to match the projecting portion. In the above-described example, the structure has been described in which the projecting portions of the shutter member and the toner cartridge enter the seal member, but the present invention is not limited to such an example. In any case, it is sufficient that the gap between the shutter member and the toner cartridge is sealed, and any structure can be employed as the seal member.

### Embodiment 3

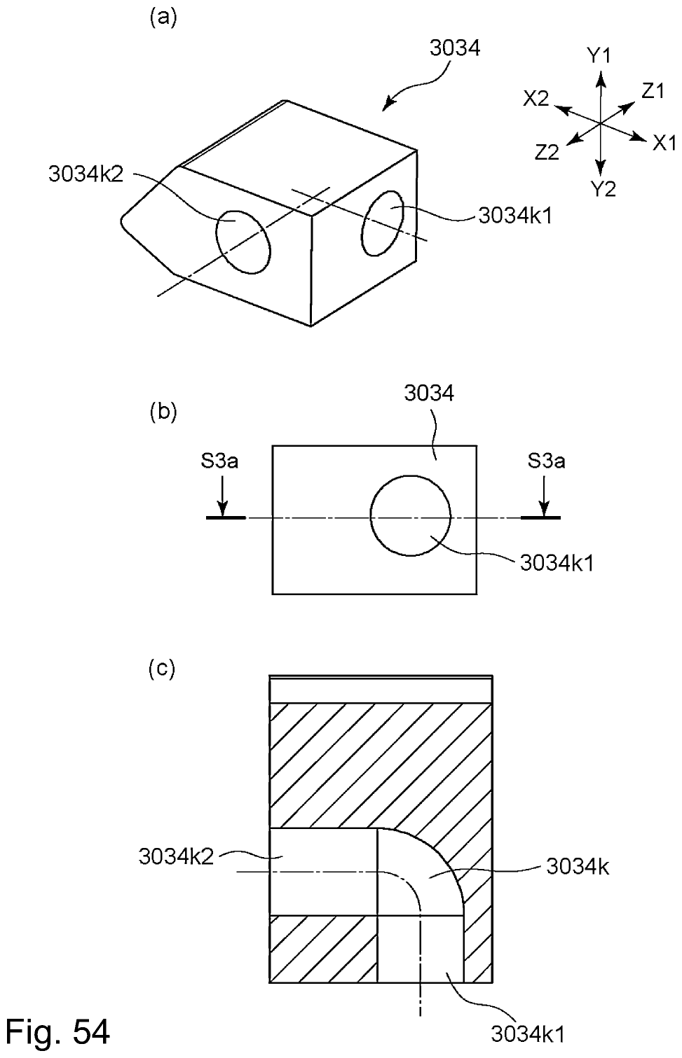

The shutter member (toner feeding member) described in Embodiment 2 is formed of a resin material such as ABS resin, for example, by resin molding, and is assumed to be a member having high rigidity. In contrast to this, this embodiment employs a toner feeding member made of a flexible material such as rubber, and will be described, referring to FIGS. 54-58. The same components as those in Embodiment 1 will be described with the same reference numerals and symbols as those in Embodiment 1. Regarding the toner cartridge side and the shutter member, the members including the same functions and roles as those in Embodiment 1 are assigned the same names and like part numerals and symbols.

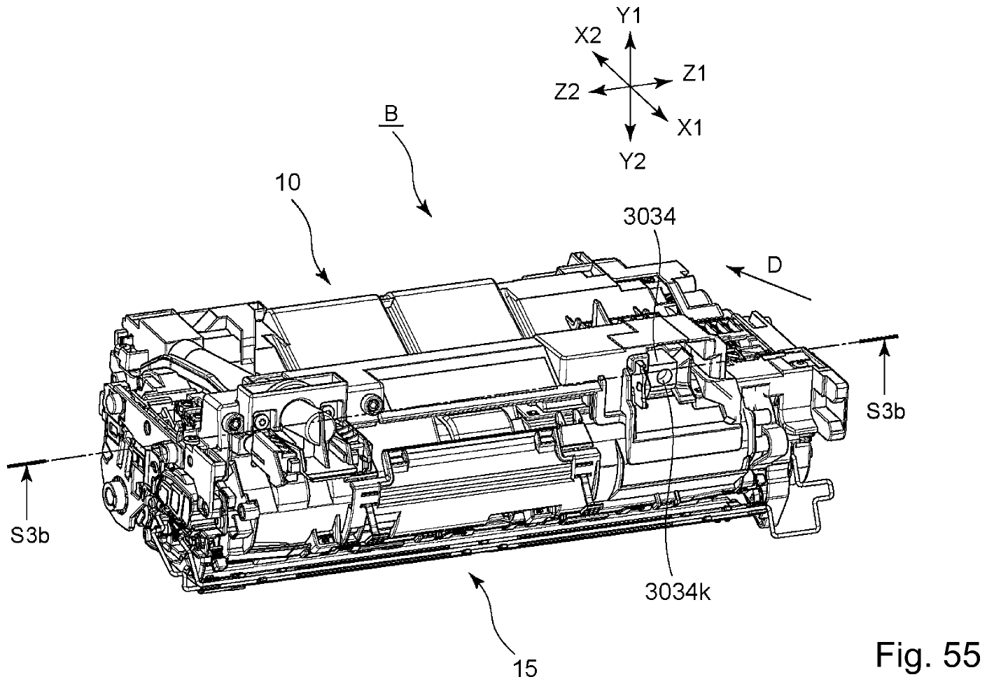

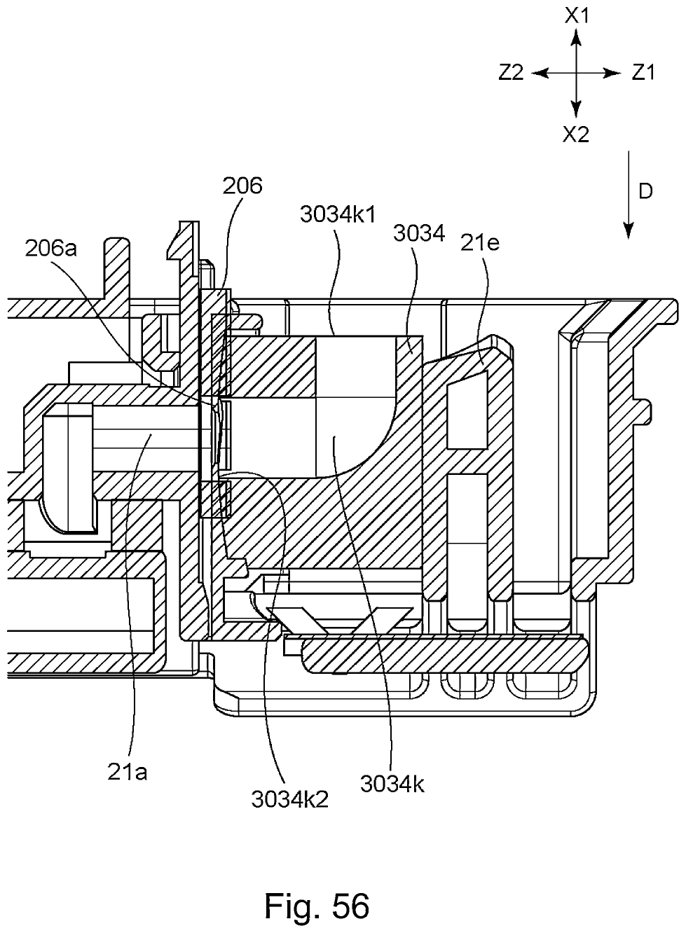

FIG. 54 is an illustration of an example of a toner feed attachment 3034 forming a part of a toner feeding member according to Embodiment 3 of the present invention. Part (a) of FIG. 54 is a perspective view of the toner feed attachment 3034, part (b) of FIG. 54 is a side view of the toner feed attachment 3034, and part (c) of FIG. 54 is a sectional view taken along a line S3a-S3a shown in part (b) of FIG. 54. FIG. 55 is an external perspective view of the process cartridge B according to Embodiment 3 of the present invention. FIG. 56 is a sectional view taken along an XZ plane passing through the center of the through hole 3034k when the toner feed attachment 3034 is mounted to the process cartridge B, and shows sectional view taken along a line S3b-S3b shown in FIG. 55.

As shown in part (a) of FIG. 54, the toner feed attachment 3034 is a toner feeding member having a substantially rectangular block shape, at least a part of which is formed from a flexible material. As shown in part (c) of FIG. 54, the toner feed attachment 3034 has a bent toner feed passageway therein, and in this embodiment, it is provided with L-shaped through holes 3034k which are substantially perpendicular to each other. One of the exposed portions (openings) of the through hole 3034k to the outside of the toner feed attachment 3034 is a toner receiving opening 3034k1, and the other is a toner discharge opening 3034k2. The shape of the toner feed passageway is not limited to an L-shape, and any shape may be employed for the internal bending direction as long as it does not impede the flow of the toner. Furthermore, the shapes of the toner receiving opening 3034k1 and the toner discharge opening 3034k2 may be other than circular (for example, polygonal).

The above-described toner feed attachment 3034 is mounted to the process cartridge B in an attitude in which the opening direction of the toner receiving opening 3034k1 faces in the X1 direction, and the opening direction of the toner discharge opening 3034k2 faces in the Z2 direction. In other words, in the case that the toner feed attachment 3034 is mounted to the process cartridge B, of the two toner feed passageways constituting the through hole 3034k, the toner feed passageway which passes through the toner receiving opening 3034k1 is substantially parallel to the X1 direction. Further, the toner feed passageway passing through the toner discharge opening 3034k2 is substantially parallel to the Z2 direction. As shown in FIG. 55, the toner feed attachment 3034 is structured to be mountable to the process cartridge B in a mounting direction D.

As shown in FIG. 56, the toner feed attachment 3034 is inserted into the gap formed between the guide surface 21e provided on the stay 21 of the process cartridge B and the receiving side shutter member 206 while at least a portion of it is elastically deformed. The toner feed attachment 3034 is mounted to the process cartridge B by a pressure force when it is inserted into the above-mentioned gap, or by separate adhesion.

When the toner feed attachment 3034 is inserted into the process cartridge B in the mounting direction D, a frictional force and a repulsive force produced by the elastic deformation of the toner feed attachment 3034 are applied to the receiving side shutter member 206 against the urging force of the compression spring 217. Then, in the X1 direction, the toner feed attachment 3034 is pushed into the process cartridge B until the end of the guide surface 21e and the toner receiving opening 3034k1 are substantially aligned, thus completing the mounting of the toner feed attachment 3034.

When the toner feed attachment 3034 is mounted on the process cartridge B, the toner discharge opening 3034k2 is brought into contact with the communication opening 206a of the receiving side shutter member 206 and the supply opening 21a of the stay 21. In this state, toner can be supplied from the toner cartridge C3 to the process cartridge B in this embodiment.

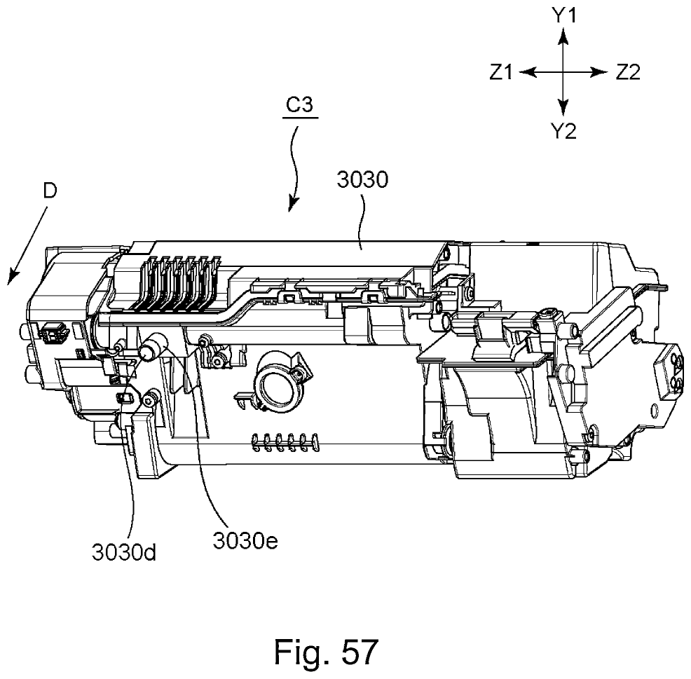

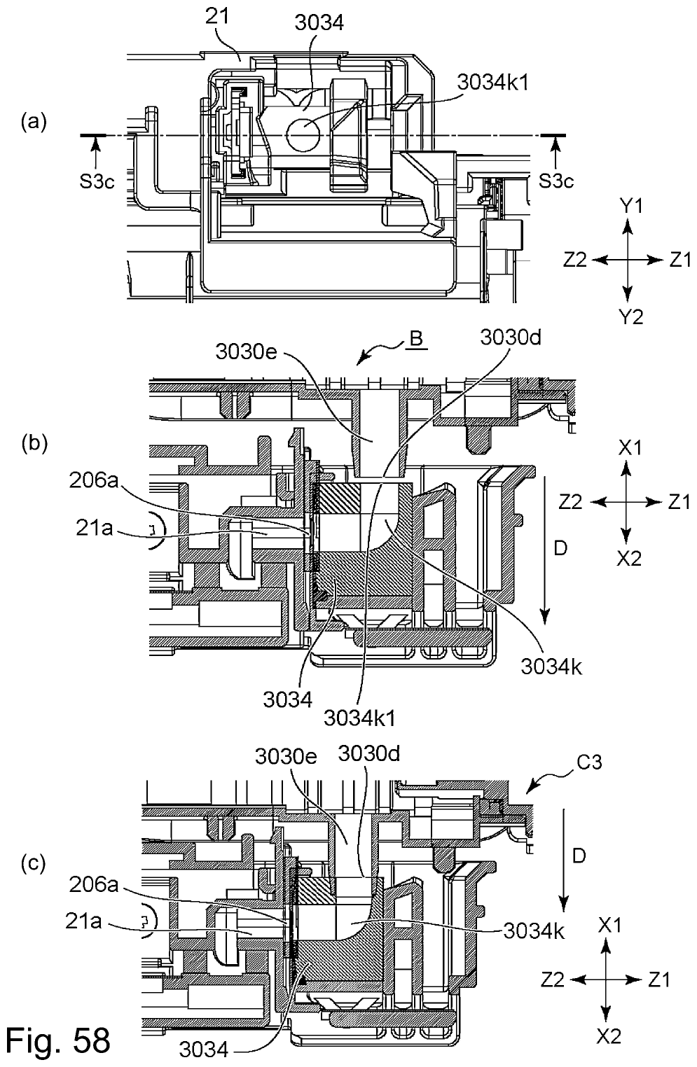

Next, the operation of mounting the toner cartridge C3 on the toner feed attachment 3034 will be described with reference to the drawings. FIG. 57 is an external perspective view of a toner cartridge C3 according to Embodiment 3 of the present invention. FIG. 58 is a view illustrating an example of a method of mounting the toner feed attachment 3034 to the toner cartridge C3 according to Embodiment 3 of the present invention. Part (a) of FIG. 58 is a partial side view, facing the toner receiving opening 3034k1, of the process cartridge B to which the toner feed attachment 3034 has been mounted. Part (b) of FIG. 58 is a sectional view taken along a line S3c-S3c, showing a state in which the toner cartridge C3 is in the process of being mounted on the process cartridge B shown in part (a) of FIG. 58. Part (c) of FIG. 58 is a sectional view taken along a line S3c-S3c, showing a state in which the mounting of the toner cartridge C3 into the process cartridge B shown in part (a) of FIG. 58 is completed.

As shown in FIG. 57, the toner accommodating portion 3030 is provided with a toner supplying portion 3030e for supplying toner to the process cartridge B by way of a toner feed attachment 3034. The toner supplying portion 3030e has a hollow cylindrical shape projecting in the mounting direction D (i.e., X2 direction) and communicates with the toner accommodating portion 3030 described above. A toner supply opening 3030d is provided at the free end of the toner supplying portion 3030e which projects in the mounting direction D. The toner supplying portion 3030e may have a shape other than a cylindrical shape as long as the inside is hollow and suitable for supplying toner and the shape can fit into the toner receiving opening 3034k1 of the toner feed attachment 3034. For example, the toner supplying portion 3030e may have a shape of a polygonal prism having a rectangular cross-section.

As in Embodiment 2, a toner seal (not shown) is provided between the toner supplying portion 3030e and the toner accommodating portion 3030. The toner seal is pulled off when the toner cartridge C3 receives a driving force from the printer main assembly A in which the process cartridge B is mounted, so that the toner supply opening 3030d and the toner accommodating portion 3030 are brought into contact with each other.

As shown in part (b) of FIG. 58, when the toner cartridge C3 is mounted to the process cartridge B side, the toner supplying portion 3030e is inserted into the toner receiving opening 3034k1 in the mounting direction D. At this time, the toner supplying portion 3030e is inserted while expanding the toner receiving opening 3034k1 and the through hole 3034k. Then, when the mounting of the toner cartridge C3 on the process cartridge B side is completed, the toner can be conveyed through the toner supply opening 3030d to the communication opening 206a (and supply opening 21a) by way of the toner feed attachment 3034 as shown in part (c) of FIG. 58. In this state, the outer wall portion of the toner supplying portion 3030e is in pressure contact with the inner wall portion of the through hole 3034k, so that leakage of the toner between the toner cartridge and the toner feed attachment 3034 can be prevented.

With the structure described above, the toner feed attachment 3034, which is a toner feeding member, is a separate member from the toner cartridge C3, and the structure of the toner cartridge, which is frequently replaced, can be simplified while making the toner cartridge smaller (compared to Embodiment 1).

In addition, the toner feed attachment 3034 of this embodiment is flexible, and therefore, it can be connected to the supply opening of the process cartridge B or the toner supply portion of the toner cartridge C3 while being elastically deformed. Therefore, even if the design tolerance of the toner feed attachment 3034 according to this embodiment is degraded, the affect of the degradation on the toner feeding is small, and the cost of manufacturing the toner feed attachment 3034 can be reduced.

The toner feed attachment 3034 according to this embodiment may be mounted to the process cartridge B either before or after the process cartridge B is mounted to the printer main assembly A. Further, the structure may be such that the toner cartridge C3 is mounted in the state in which the toner feed attachment 3034 is not completely mounted to the process cartridge B, so that the attachment of the toner feed attachment 3034 to the process cartridge B is completed.

In this embodiment, the toner feed attachment 3034 is structured to be flexible, but the present invention is not limited to such an example. For example, the portion of the process cartridge B or the toner cartridge C3 to which the toner feed attachment is connected may be flexible. For example, if the receiving side shutter member 206 on the process cartridge B side or the toner supplying portion 3030e of the toner cartridge C3 is structured to be flexible, the same effect as the above-mentioned structure can be achieved by the elastic deformation of these flexible members. For example, a structure may be considered in which a flexible cylindrical seal member is provided to surround the openings of the toner receiving opening 3034k1, the toner discharge opening 3034k2. Alternatively, it is also possible to make the toner supplying portion 3030e of the toner cartridge C3 from a flexible material and insert it into the toner receiving opening 3034k1. As described above, when a structure is employed in which a member other than the toner feed attachment 3034 has flexibility, it is preferable that the rigidity of the parts around the associated toner receiving opening 3034kl and/or toner discharge opening 3034k2 is high.

### Embodiment 4

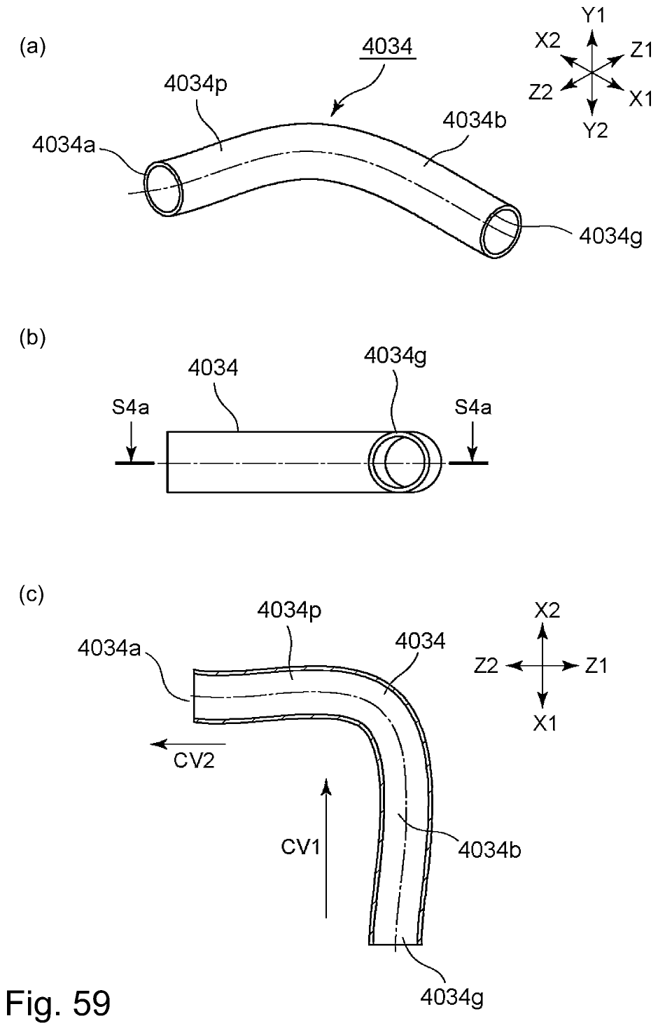

The shutter member (toner feeding member) described in Embodiment 2 may be structured such that a toner feed tube is inserted into the receiving side shutter member 206 on the process cartridge B side, for example. Referring to FIGS. 59-63, a structure of this embodiment in which an L-shaped toner feed pipe 4034 is used as a toner feeding member will be described. The same components as those in Embodiment 1 will be assigned the same reference numerals and symbols as those in Embodiment 1. In addition, regarding the toner cartridge side and the toner feeding members, the members having the same functions and roles as those in Embodiment 1 are given the same names and like reference numerals and symbols.

FIG. 59 is a view of an example of the structure of a toner feed pipe 4034 according to Embodiment 4 of the present invention. Part (a) of FIG. 59 is a perspective view illustrating an outer appearance of the toner feed pipe 4034. FIG. 59(b) shows a side view of the toner feed pipe 4034. Part (c) of FIG. 59 is a cross-sectional view of the toner feed pipe 4034 taken along a line S4a-S4a shown in Figure.

As shown in part (a) of FIG. 59 and part (c) of FIG. 59, the toner feed pipe 4034 includes a first toner feed pipe 4034b extending in substantially the same direction as the X1 direction, and a second toner feed tube 4034p extending substantially in the same direction as the Z2 direction. The first toner feed tube 4034b and the second toner feed tube 4034p are formed continuously, and a toner receiving opening 4034g is provided at the end of the first toner feed pipe 4034b, and a toner discharge opening 4034a is provided at the end of the second toner feed tube 4034p. In addition, the toner feed pipe 4034 in this embodiment is flexible, so that the relative position of the toner discharge opening 4034a with respect to the toner receiving opening 4034g can be changed. In other words, the toner feed pipe 4034 according to this embodiment can be bent in the middle. In this embodiment, the toner feed pipe 4034 will be described based on a state in which it is connected to the process cartridge B and the toner cartridge C4 according to this embodiment.

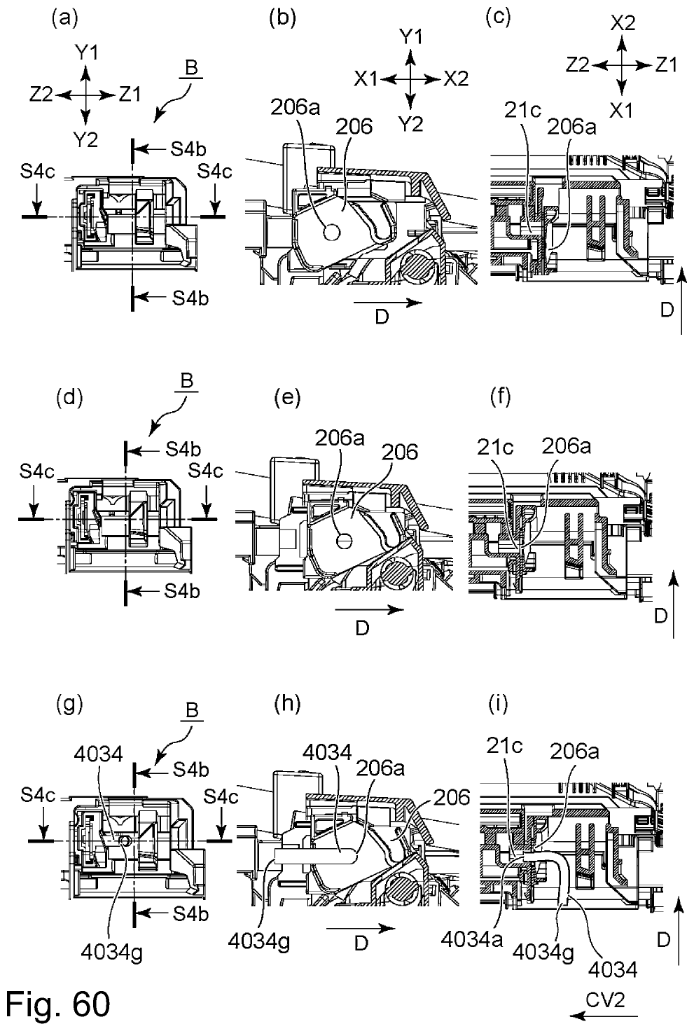

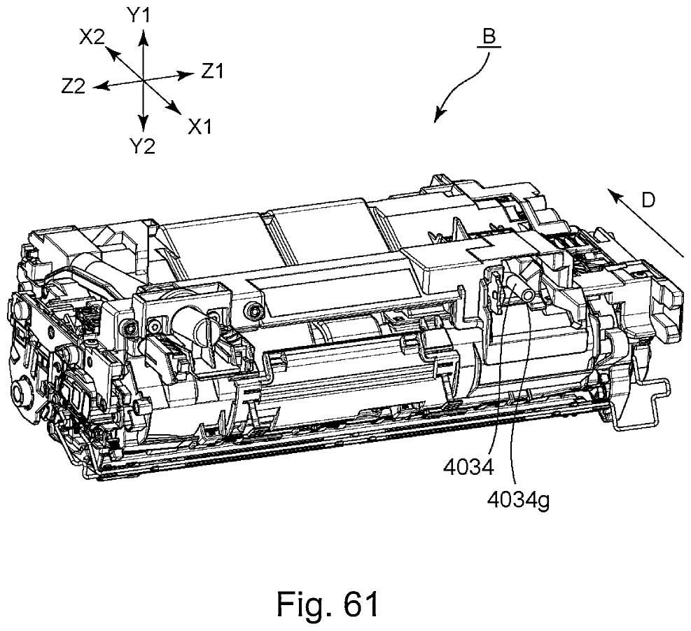

Next, referring to FIGS. 60 and 61, a method for mounting the toner feed pipe 4034 on the process cartridge B will be described. FIG. 60 is a view illustrating an example of operation of the toner feed pipe 4034 according to Embodiment 4 of the present invention. Part (a) of FIG. 60 is a side view of the process cartridge B as viewed in the X2 direction when the toner feed pipe 4034 is not mounted. Part (d) of FIG. 60 is a side view of the process cartridge B as viewed in the X2 direction, in the mounting preparation state of the toner feed pipe 4034. Part (g) of FIG. 60 is a side view of the process cartridge B as viewed in the X2 direction, with the toner feed pipe 4034 mounted. That is, part (a) of FIG. 60, part (d) of FIG. 60 and part (g) of FIG. 60 show the time sequence when the toner feed pipe 4034 is mounted to the process cartridge B. Part (b) of FIG. 60, part (e) of FIG. 60, and part (h) of FIG. 60 are cross-sectional views of the S4b-S4b cross-sections shown in part (a) of FIG. 60, part (d) of FIG. 60, and part (g) of FIG. 60, respectively. Part (c) of FIG. 60, part (f) of FIG. 60, and part (i) of FIG. 60 are sectional views taken along a line S4c-S4c shown in part (a) of FIG. 60, part (d) of FIG. 60, and part (g) of FIG. 60, respectively. FIG. 61 is a perspective view illustrating the external appearance of the process cartridge B according to Embodiment 4 of the present invention, with the toner feed pipe 4034 mounted thereto.

As shown in part (c) of FIG. 60, the communication opening 206a and the supply opening 21c of the process cartridge B are provided at different positions from each other in the YZ plane because the receiving side shutter member 206 is movable. With this structure, the supply opening 21c is closed by the receiving side shutter member 206, so that the toner present inside the process cartridge B is blocked so as not to leak out to the outside.

In this embodiment, the operator moves the receiving side shutter member 206 in the mounting direction D (X2 direction) against the urging force of a compression spring 217 (see FIG. 34) not shown, thereby moving the communication opening 206a to a position facing the supply opening 21c. This state is shown in part (d) of FIG. 60, part (e) of FIG. 60 and part (f) of FIG. 60, which shows the state in which the toner feed pipe 4034 is prepared for attachment to the process cartridge B. From this completed mounting preparation state, the operator further inserts the toner discharge opening 4034a of the toner feed pipe 4034 into the communication opening 206a and the supply opening 21c. This state is shown in part (g) of FIG. 60, part (h) of FIG. 60, and part (i) of FIG. 60, which indicates the state where the toner feed pipe 4034 is completely mounted to the process cartridge B.

As shown in part (g) of FIG. 60, when the toner feed pipe 4034 is inserted into the supply opening 21c which is a fixed portion, the toner feed pipe 4034 is also inserted into the communication opening 206c, so that the movement of the receiving side shutter member 206 is restricted. In this state, the toner feed pipe 4034 is clamped by the receiving side shutter member 206 while remaining inserted in the supply opening 21c, and the toner feed pipe 4034 is maintained in a mounted state to the process cartridge B. More specifically, in the state shown in part (g) of FIG. 60, an urging force acts on the side surface of the toner feed pipe 4034 from the receiving side shutter member 206 in the closing direction of the receiving side shutter member 206, in the XY plane.

As shown in FIG. 61, when the toner feed pipe 4034 is mounted to the process cartridge B, the toner receiving opening 4034g of the toner feed pipe 4034 faces the direction opposite to the mounting direction D (i.e., X1 direction).

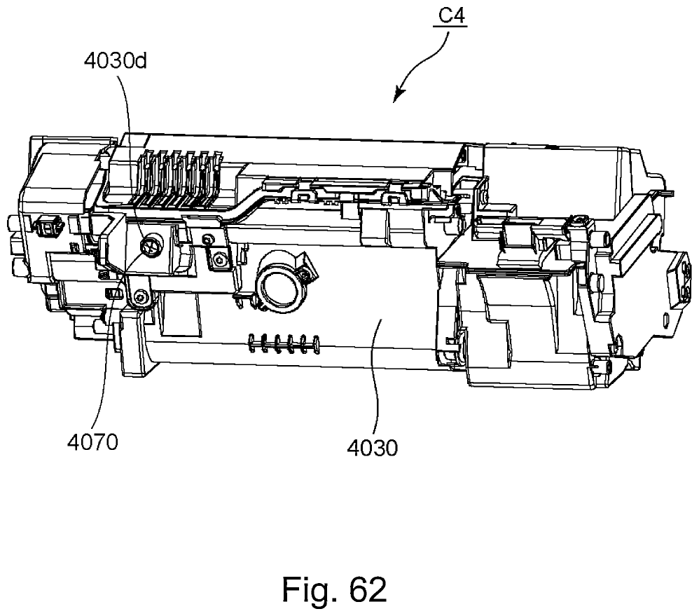

Next, a method of mounting the toner cartridge C4 according to this embodiment to the process cartridge B will be described. FIG. 62 is an external perspective view of a toner cartridge C4 according to Embodiment 4 of the present invention. As shown in FIG. 62, a toner accommodating portion 4030 is provided with a toner supply opening 4030d, and a circular seal member 4070 is mounted by adhesive or the like to the inside of the cylindrical shape of the toner supply opening 4030d. The shape of the toner supply opening 4030d may be other than cylindrical, and any shape may be employed as long as toner receiving opening 4034g of toner feed pipe 4034 can be connected thereto.

The seal member 4070 is a flexible valve having a cross slit in the center of the circular portion, and the seal member 4070 can prevent toner from leaking through the toner supply opening 4030d. The material of the seal member 4070 is preferably urethane rubber, and the thickness is preferably 1 to 3 mm. As for the structure of the seal member 4070, a flexible movable valve may be usable in place of the cross slit as long as the sealing performance can be ensured, for example.

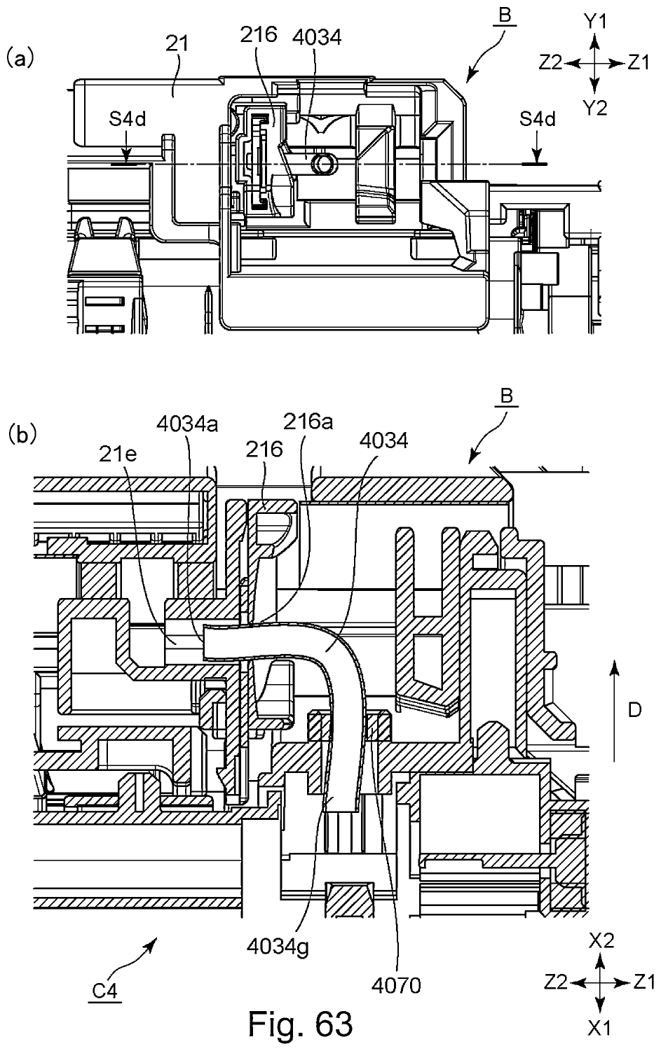

FIG. 63 is an illustration of an example in which the toner cartridge C4 according to Embodiment 4 of the present invention is mounted to the process cartridge B by way of a toner feed pipe 4034. Part (a) of FIG. 63 is a partial side view of the process cartridge B with the toner cartridge C4 not yet mounted and the toner feed pipe 4034, as viewed in the X2 direction. Part (b) of FIG. 63 is a sectional view, taken along a line S4d-S4d of part (a) of FIG. 63, of the process cartridge B in a state in which the toner cartridge C4 is mounted.

As shown in part (b) of FIG. 63, one end (toner receiving opening 4034g side) of the toner feed pipe 4034 mounted to the process cartridge B is inserted into the cylindrical shape of the seal member 4070 of the toner cartridge C4. At this time, the toner feed pipe 4034 is inserted by pushing open the cross slit of the seal member 4070, so that the gap between the outer periphery of the toner feed pipe 4034 and the seal member 4070 is sealed, thereby preventing toner leakage. The toner receiving opening 4034g of the toner feed pipe 4034 enters the inside of the toner cartridge C4 and abuts against a contact surface (not shown). In the state shown in part (b) of FIG. 63, the toner can be fed from the toner cartridge C4 to the process cartridge B side through the toner feed pipe 4034.

With the above-described structure, the toner feed pipe 4034, which is a toner feeding member, is a separate member from the toner cartridge C4, and the structure of the toner cartridge, which is frequently replaced, can be simplified while making the toner cartridge smaller (compared to Embodiment 1). In addition, by employing a flexible toner feed pipe 4034, the process cartridge B and the toner cartridge C4 can be easily connected by the toner feed pipe 4034. Therefore, the latitude in designing the members relating to toner feed in the process cartridge B and the toner cartridge C4 according to this embodiment is improved.

Although the above description is made as to a case where the toner cartridge C4 is connected to the process cartridge B with the toner feed pipe 4034 mounted having been mounted to the process cartridge B, the present invention is not limited to such an example. For example, the toner receiving opening 4034g of the toner feed pipe 4034 may be connected to the seal member 4070 of the toner cartridge C4, and then the toner discharge opening 4034a may be connected to the process cartridge B side.

Moreover, although the toner feed pipe 4034 has been described as being flexible, the shape of the toner feed pipe 4034 may be fixed as shown in part (a) of FIG. 59. In this case, the movement of the receiving side shutter member 206 on the process cartridge B side may be structured to be carried out manually by an operator, as described above, or may be structured to be carried out semi-automatically by the toner discharge opening 4034a acting on the receiving side shutter member 206.

### Embodiment 5

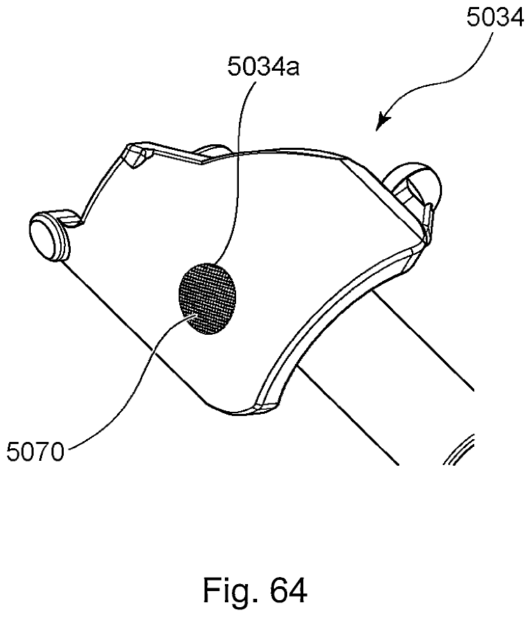

Referring to FIG. 64, in addition to the structure of Embodiment 1 described above, a structure of this embodiment for effectively preventing toner leakage will be described. In addition, the same components as those in Embodiment 1 will be described with the same reference numerals and symbols as those in Embodiment 1. In addition, as for the shutter member (toner feeding member), members having the same functions and roles as those in Embodiment 1 are given the same names and like reference numerals and symbols.

FIG. 64 is a view illustrating an example of the structure of a shutter member 5034 according to Embodiment 5 of the present invention. As shown in FIG. 64, the shutter member 5034 according to this embodiment is provided with a filter 5070 at the opening of the toner discharge opening 5034a. The filter 5070 has gaps large enough to allow the toner to pass through. For example, the filter 5070 is made of a material such as polyurethane foam having open cells therein.

Therefore, when the pump unit 37 provided in the toner cartridge C is driven, the shutter member 5034 in this embodiment can feed an appropriate amount of the toner to the process cartridge B side by the air flow caused by the change in air pressure. On the other hand, when the pump unit 37 is not driven, the amount of the toner leaking from the toner discharge opening 5034a can be reduced. In other words, when the pump unit 37 is driven, the amount of the toner that passes through the filter 5070 and is discharged is greater than when the pump unit 37 is not driven.

With the structure described above, the shutter member 5034 in this embodiment can reduce the amount of the toner leakage, when, for example, the printer main assembly A is in a non-operating state or when the toner cartridge is subjected to external impact.

The filter 5070 may be mounted to the end of the shutter member 5034 where the toner discharge opening 5034a is formed, or may be sealed inside the toner discharge opening 5034a.

### Embodiment 6

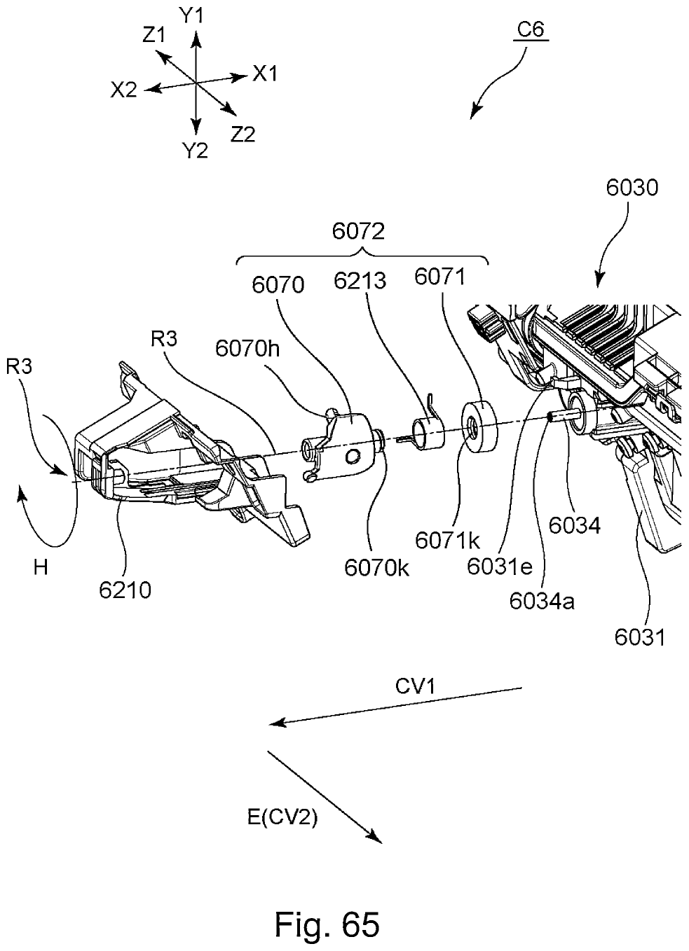

In the above-described Embodiment 1, it has been described that the shutter member 34 is L-shaped, and the feeding portion 34b is capable of feeding the toner along a first toner feeding direction CV1 and a second toner feeding direction CV2 that are perpendicular to the toner discharging direction E. In contrast, in this embodiment which will be described referring to FIGS. 65 to 67, a toner feeding member for feeding the toner from the toner cartridge C6 to the process cartridge B is formed by a plurality of members having different toner feeding directions. The same components as those in Embodiment 1 will be described with the same reference numerals and symbols as those in Embodiment 1. In addition, regarding the toner cartridge side and the toner feeding members, the members having the same functions and roles as those in Embodiment 1 are given the same names and like reference numerals and symbols.

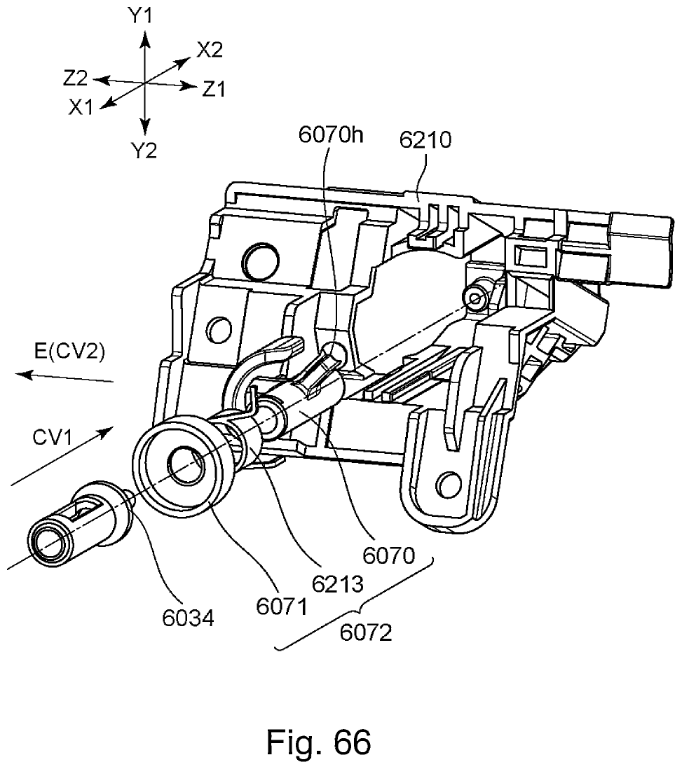

FIG. 65 is a partially exploded perspective view of a toner cartridge C6, a first toner feeding portion 6034, and a second toner feeding portion 6072 according to Embodiment 6 of the present invention. FIG. 66 is an exploded perspective view illustrating an example of the structure of a first toner feeding portion 6034 and a second toner feeding portion 6072 according to Embodiment 6 of the present invention.

As shown in FIGS. 65 and 66, a first toner feeding portion 6034 having a hollow cylindrical shape is connected to a toner accommodating portion 6030 provided in the toner cartridge C6 along the first toner feeding direction CV1. The first toner feeding portion 6034 is provided with a first toner discharge opening 6034a at the end opposite to the connection point with the toner accommodating portion 6030. Therefore, the toner contained in the toner accommodating portion 6030 is fed in the first toner feeding direction CV1 by way of the first toner feeding portion 6034, and discharged through the first toner discharge opening 6034a. In other words, the toner discharging direction from the first toner discharge opening 6034a is substantially parallel to the first toner feeding direction CV1. The structure of the connecting portion between the first toner feeding portion 6034 and the toner accommodating portion 6030accommodating frame is substantially the same as that of the toner cartridge C of Embodiment 1.

As shown in FIGS. 65 and 66, the second toner feeding portion 6072 is mounted to the toner accommodating portion 6030 coaxially with the first toner feeding portion 6034. The second toner feeding portion 6072 is a unit constituted by a shutter member 6070, a torsion coil spring 6213, and a shutter support member 6071.

The shutter member 6070 is provided with a screw portion 6070k at the end in the X1 direction on the side where the shutter member 6070 is mounted to the toner accommodating portion 6030. The shutter member 6070 has an end portion in the X2 direction, which is the side interlocking with the receiving side shutter member 206 provided in the process cartridge B, and the end has substantially the same shape as the shutter member 34 of Embodiment 1 described in the foregoing.

The screw portion (6070k) side (X1 direction) of the shutter member 6070 is inserted into the inside of a torsion coil spring 6213 wound in a cylindrical shape. In this state, the screw portion 6070k of the shutter member 6070 is screwed into a threaded groove portion 6071k provided in the cylindrical shutter support member 6071.

In this embodiment, the screw portion 6070k and the screw groove portion 6071k are simply screwed together, but the screw portion 6070k and the screw groove portion 6071k may be bonded together using an adhesive or the like after the screwing of the screw portion 6070k to the screw groove portion 6071k is completed. In this embodiment, the screw portion 6070k has a male screw shape, and the screw groove portion 6071k has a female screw shape formed on the inside of the cylindrical portion, but the screw shapes may be reversed.

The central axes of the members constituting the second toner feeding portion 6072 are substantially aligned with each other, when the shutter member 6070 and the shutter support member 6071 are completely screwed together by way of the torsion coil spring 6213. When the second toner feeding portion 6072 is completely mounted to the toner accommodating portion 6030, the central axis of the second toner feeding portion 6072 becomes substantially parallel to the X1 and X2 directions and coincides with the rotation axis R3 of the shutter member 6071. In this state, for the second toner feeding portion 6072, the shutter member 6070 and the torsion coil spring 6213 are rotatable about the rotation axis R3.

In this state, one end of the torsion coil spring 6123 is engaged with the arm portion 6070h of the shutter member 6070, and the other end is engaged with a projection 6031e provided on the accommodation frame 6031 of the toner accommodating portion 6030.

An urging force in the direction opposite to the rotational direction indicated by the arrow H is produced in the shutter member 6070 by the spring force of the torsion coil spring 6213. Similarly to Embodiment 1 described in the foregoing, when the toner cartridge C6 is mounted in the printer main assembly A, the second toner feeding portion 6072 rotates in the direction of the arrow H in interrelation with the receiving shutter member 206 of the process cartridge B.

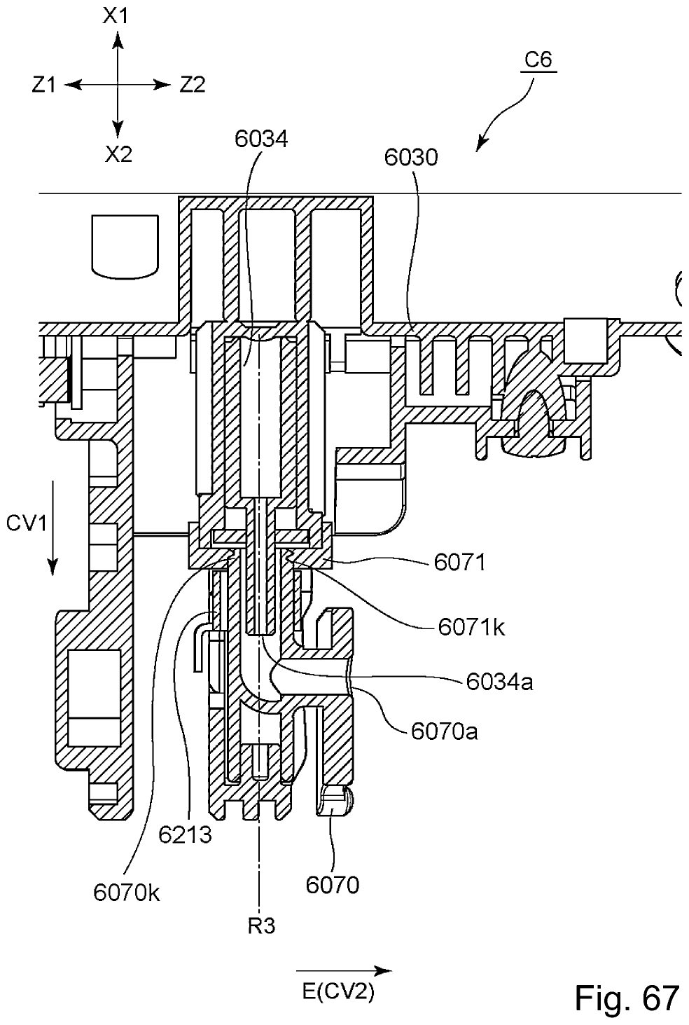

Next, referring to FIG. 67, a toner feed passageway formed when the toner cartridge C6 is mounted in the process cartridge B will be described. FIG. 67 is an illustration of an example of the toner feed passageway from the toner cartridge C6 to the process cartridge B by way of the first toner feeding portion 6034 and the second toner feeding portion 6072 according to Embodiment 6 of the present invention. FIG. 67 is a sectional view of the toner accommodating portion 6030, the first toner feeding portion 6034, and the second toner feeding portion 6072 taken along the XZ plane passing through the rotation axis R3.

As shown in FIG. 67, the toner contained in the toner cartridge C6 passes through the first toner feeding portion 6034 and is fed from the first toner discharge opening 6034a in the first toner feeding direction CV1. The toner discharged from the first toner discharge opening 6034a passes through the inside of the second toner feeding portion 6072 and is discharged through the second toner discharge opening 6070a in a discharging direction E (and a second toner feeding direction CV2) perpendicular to the first toner feeding direction CV1. The inside of the shutter member 6070 is bent in an L shape. In the state where the toner cartridge C6 is mounted to the process cartridge B, the second toner discharge opening 6070a is in fluid communication with the supply opening 21c by way of the communication opening 206a of the receiving side shutter member 206. Therefore, in this state, the toner discharged from the second toner discharge opening 6070a is replenished to the developing unit (15) side, similarly to Embodiment 1.

Here, the first toner feeding portion 6034 is mounted in a manner such that it is inserted into the second toner feeding portion 6072 (more specifically, the shutter member 6070) along the rotation axis R3. The cross-sectional area of the first toner discharge opening 6034a is smaller than the cross-sectional area of the toner feed passageway inside the cylindrical portion of the shutter member 6070 and the cross-sectional area of the second toner discharge opening 6070a. In other words, in the toner feed passageway (discharge flow passageway) from the toner cartridge C6 to the second toner feeding portion 6072, the cross-sectional area of the first toner discharge opening 6034a is the smallest. That is, in the toner cartridge C6 of this embodiment, the toner feed passageway is structured so that, the amount of the toner that can be fed (discharged) when passing through the first toner discharge opening 6034a is less than when passing through other portions.

In particular, it is preferable that a toner discharging force resulting from air flow generated when the pump unit 37 is driven is required to discharge the toner through the first toner discharge opening 6034a. By employing such a structure, it is possible to prevent toner leakage attributable to vibrations which may occur when the toner cartridge C6 is transported, for example.

In addition, by reducing the cross-sectional area of the first toner feeding portion 6034 upstream of the second toner feeding portion in the toner feed passageway, the amount of the toner feed can be stabilized.

The optimal cross-sectional area of the toner feed passageway for conveying the toner varies depending on the physical properties and size of the toner, and the material of the toner cartridge, and so on. Therefore, the structure may be such that the cross-sectional area of the first toner feeding portion 6034 (particularly, the first toner discharge opening 6034a) may be appropriately adjusted as necessary.

With the structure described above, the toner cartridge C6 (more specifically, the toner feeding member) of this embodiment is capable of more effectively feeding of toner to the process cartridge B side than the toner cartridge C described in Embodiment 1. In this embodiment, a part of the toner feed passageway from the toner cartridge C6 to the shutter member that operates in interrelation with the receiving side shutter member 206 on the process cartridge B side is made of a member separate from the shutter member. With this structure, the toner cartridge C6 according to this embodiment can be made easier to maintain and repair than the toner cartridge C according to Embodiment 1 described in the foregoing.

### Embodiment 7

In the above-described Embodiment 1, the shutter member 34 is bent in an L-shape, and the first toner feeding direction CV1 and the second toner feeding direction CV2 are substantially perpendicular to each other. In addition, the structure in which the first toner feeding direction CV1 is substantially perpendicular to the axis G of the pump-screw drive input portion 39 has been described. In contrast, in this embodiment which will be described below, the bent shape of the shutter member (toner feed means) is different from that in Embodiment 1. The same components as those in Embodiment 1 will be described with the same reference numerals and symbols as those in Embodiment 1. In addition, as for the toner cartridge side and the toner feeding members, the members having the same functions and roles as those in Embodiment 1 are assigned the same names and like reference numerals and symbols.

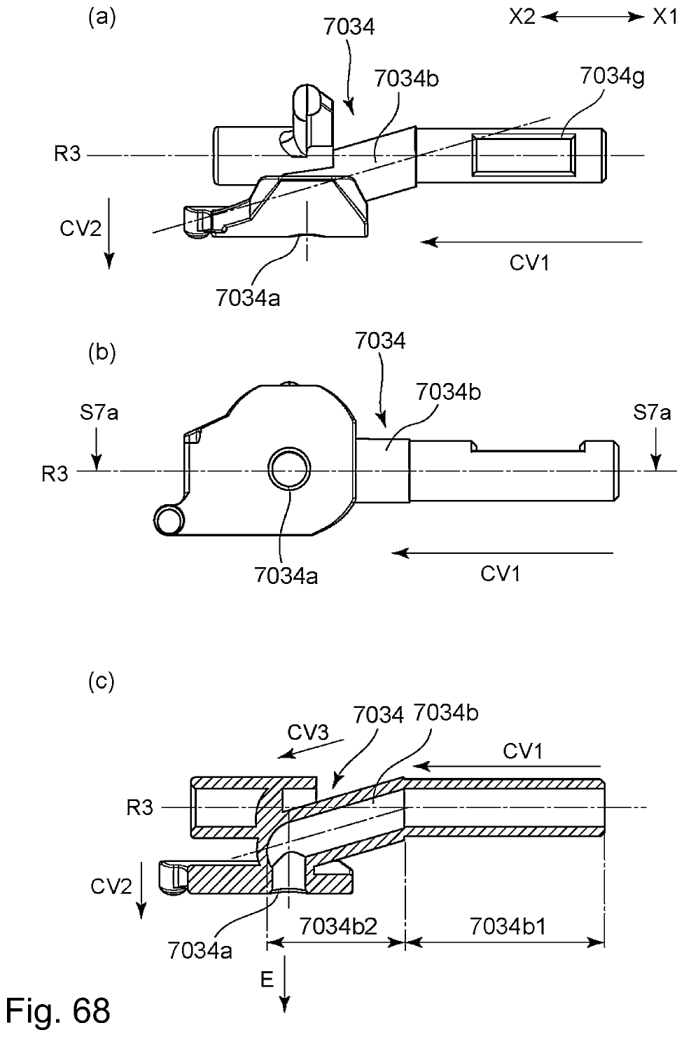

FIG. 68 is an illustration of an example of the first shutter member (first toner feeding member) 7034 according to Embodiment 7 of the present invention. Part (a) of FIG. 68 and part (b) of FIG. 68 are side views of the first shutter member 7034 viewed from different angles, wherein part (a) of FIG. 68 shows the state facing the toner receiving opening 7034g, and part (b) of FIG. 68 shows the state facing the toner discharge opening 7034a. Part (c) of FIG. 68 is a sectional view taken along a line S7a-S7a in part (b) of FIG. 68, passing through the center of the toner feeding portion 7034b.

As shown in part (c) of FIG. 68, a first shutter member 7034 according to this embodiment differs from the shutter member 34 of Embodiment 1 in that a part of the toner feeding portion 7034b is inclined with respect to the rotation axis R3. As described in Embodiment 1, the rotation axis R3 of the first shutter member 7034 is approximately perpendicular to the axis G (see FIG. 17) of the pump-screw drive input portion 39, and therefore, a part of the toner feeding portion 7034b is inclined with respect to the axis G. In the toner feeding portion 7034b, a region including one end in the X1 direction is a parallel region 7034b1, and a region including the other end is an inclined region 7034b2.

As shown in part (c) of FIG. 68, the parallel region 7034b1 of the toner feeding portion 7034b can feed toner along the first feeding direction CV1. In contrast, the inclined region 7034b2 can feed toner along a third feeding direction CV3 which includes a component of the second feeding direction CV2. The toner conveyed along the third feeding direction CV3 is then discharged in the feeding direction E through the toner discharge opening 7034a. The third feeding direction CV3 is inclined at an arbitrary predetermined angle with respect to both the rotation axis R3 and the axis G.

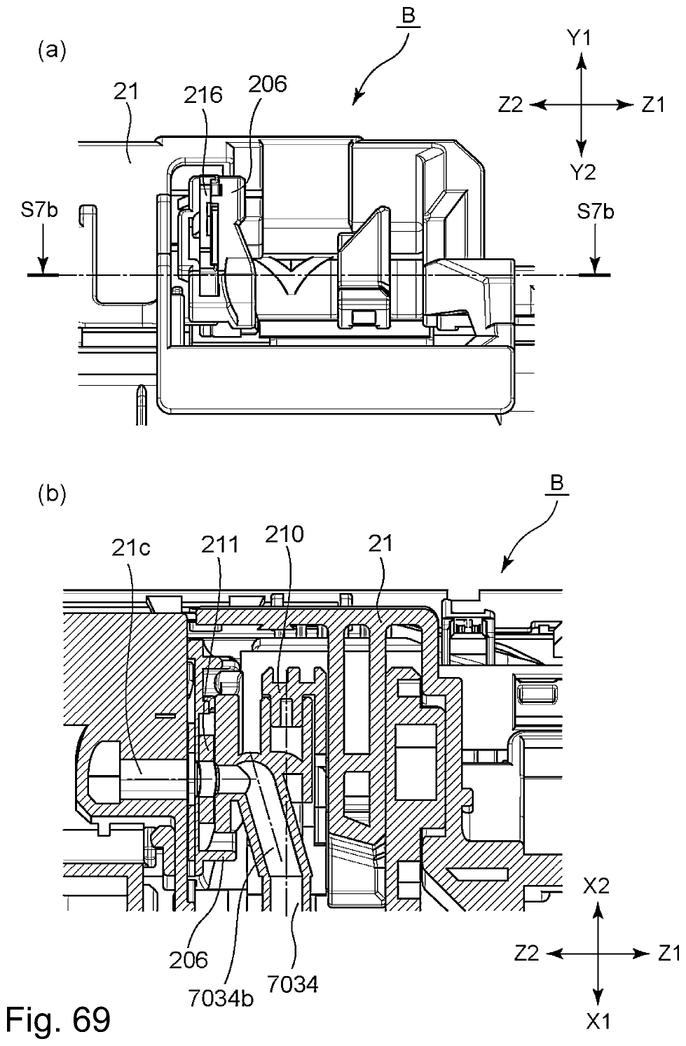

Next, referring to FIG. 69, the state in which the first shutter member 7034 is mounted on the process cartridge B will be described. FIG. 69 is an illustration for illustrating an example of a state in which a first shutter member 7034 according to Embodiment 7 of the present invention is mounted on a process cartridge B. Part (a) of FIG. 69 is a partial side view of the process cartridge B before the first shutter member 7034 is mounted, as viewed in the X2 direction. Part (b) of FIG. 69 is a sectional view taken along a line S7b-S7b in part (a) of FIG. 69 of the process cartridge B with the first shutter member 7034 mounted thereon.

The method of connecting the first shutter member 7034 to the process cartridge B is the same as the method of connecting the shutter member 34 to the process cartridge B in the above-described Embodiment 1, and therefore, the description thereof will be omitted. In the state shown in part (b) of FIG. 69, the toner discharged from the toner cartridge C7 of this embodiment passes through the toner feeding portion 7034b of the first shutter member 7034 and is supplied to the supply opening 21c of the process cartridge B. That is, even with the first shutter member 7034 according to this embodiment, it is possible to feed toner from the toner cartridge C7 to the process cartridge B side, similarly to Embodiment 1 described in the foregoing.

Further, the first shutter member 7034 according to this embodiment feeds the toner along a third feeding direction CV3 that is at an obtuse angle with respect to the second feeding direction CV2 in the inclined region 7034b2 of the toner feeding portion 7034b. Therefore, as compared to the case where toner is fed through the L-shaped bent shutter member 34 in Embodiment 1, pressure loss and local pressure drops of air passing through the feed passageway can be reduced, making it possible to discharge toner stably.

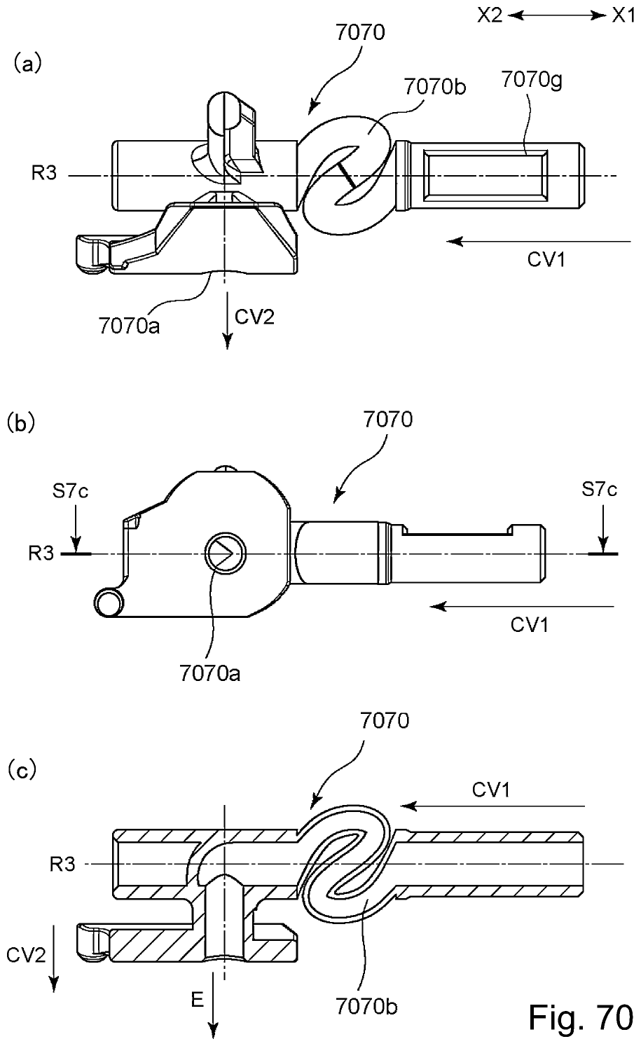

Next, referring to FIG. 70, the description will be made as to a case where toner is fed using a second shutter member 7070 having a shape different from the first shutter member 7034 described above. FIG. 70 is an illustration for exemplifying the second shutter member (second toner feeding member) 7070 according to Embodiment 7 of the present invention. Part (a) of FIG. 70 and part (b) of FIG. 70 are side views of the second shutter member 7034 as viewed in different angles, wherein part (a) of FIG. 70 shows the state facing the toner receiving opening 7070g, and part (b) of FIG. 70 shows the state facing the toner discharge opening 7070a. Part (c) of FIG. 70 is a sectional view taken along a line S7c-S7c indicated in part (b) of FIG. 70, passing through the center of the toner feeding portion 7070b.

As shown in part (c) of FIG. 70, the second shutter member 7070 according to this embodiment differs from the shutter member 34 of Embodiment 1 in that a part of the toner feeding portion 7070b is bent in an S-shape. Furthermore, the second shutter member 7070 is different from the shutter member 34 of Embodiment 1 and the first shutter member 7034 in the number of bending points in the middle of the toner feeding portion 7070b. In addition, in some areas, the second shutter member 7070 can feed toner in the opposite direction to the discharging direction E and the second feeding direction CV2, or in the opposite direction to the first feeding direction CV1.

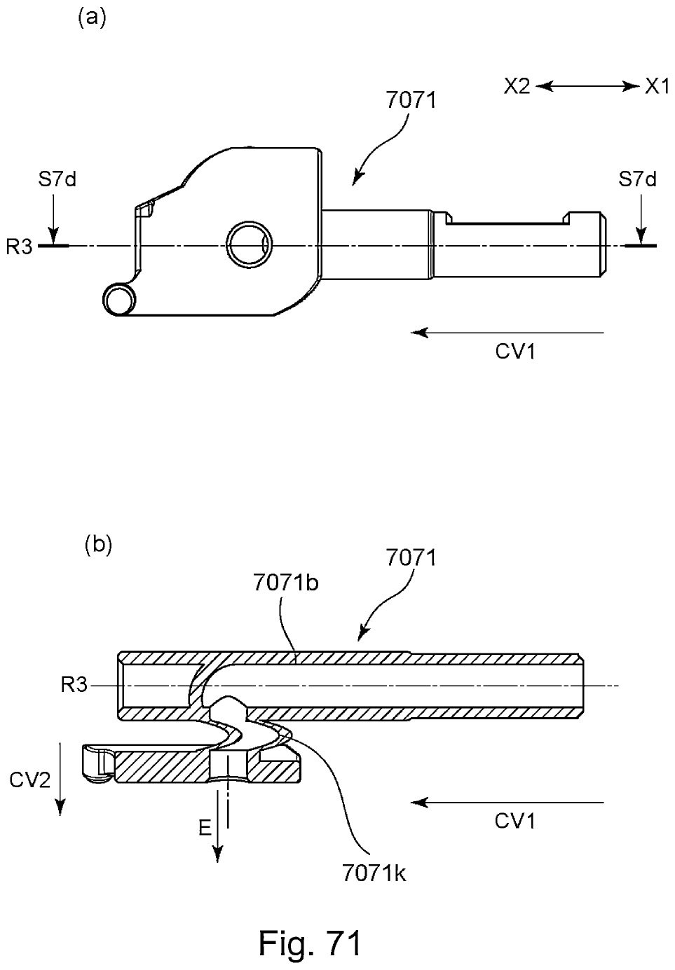

When the second shutter member 7070 is employed, the same effect as when the toner is fed by the shutter member 34 in Embodiment 1 can be obtained. Further, as described above, in the toner feeding portion 7070 of this embodiment, a part of the area of the toner feeding portion 7070b has a directional component facing in the opposite direction to the first feeding direction CV1 and the second feeding direction CV2. Therefore, the toner cartridge C7 according to this embodiment can suppress the amount of the toner leakage from the shutter member 7070 attributable to vibrations or the like which may occur when the toner cartridge C7 is transported. Although the second shutter member 7070 has been described as including the toner feeding portion 7070b which is substantially S-shaped with two bent points (nodes), the present invention is not limited to such an example. For example, the toner feeding portion may have three or more bent points at positions different from the above-described will be described. FIG. 71 is an illustration of an example of a third shutter member (third toner feeding portion) 7071 according to Embodiment 7 of the present invention. Part (a) of FIG. 71 is a side view of the third shutter member 7071. Part (b) of FIG. 71 is a sectional view taken along a line S7d-Sd in part (a) of FIG. 71, passing through the center of the toner feeding portion 7071b.

Referring to FIG. 71, a case where the position of the bent point is different from that of the second shutter member 7070 described above will be described. FIG. 71 is a illustration of an example of a third shutter member (third toner feed portion) 7071 according to Embodiment 7 of the present invention. Part (a) of FIG. 71 is a side view of the third shutter member 7071. Part (c) of FIG. 71 is a sectional view taken along line S7d-Sd in FIG. 71A passing through the center of the toner feed portion 7071b.

As shown in part (b) of FIG. 71, the third shutter member 7071 has a bent portion 7071k located in a feed passageway of the toner feeding portion 7071b which includes a directional component of the second feeding direction CV2. Although the bent position (curved portion) in the toner feeding portion is different from that of the second shutter member 7070 described above, the same effect can be provided when the third shutter member 7071 according to this embodiment is employed.

With the structure described above, the shape of the shutter member (toner feeding member) is different from that of the above-described Embodiment 1, but the toner can be fed from the toner cartridge side to the process cartridge B side, as in Embodiment 1. In addition, the second shutter member 7070 and the third shutter member 7071 of this embodiment include passageways in which the toner is conveyed in opposite directions in the toner feed section, and therefore, toner leakage can be reduced as compared to the shutter member 34 of Embodiment 1.

### Embodiment 8

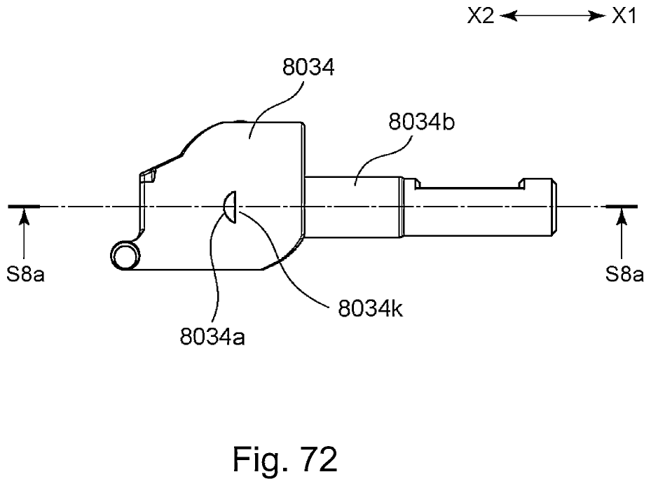

The shutter member (toner feeding member) 34 in Embodiment 1 has been described above in which the opening area of the toner discharge opening 34a and the cross-sectional area of the feeding portion 34b are substantially the same. In contrast to this, in this embodiment which is described below referring to FIG. 72-74, the cross-sectional area of the toner feeding portion and the area of the toner discharge opening are different. In addition, the same components as those in Embodiment 1 will be described with the same reference numerals and symbols as those in Embodiment 1. In addition, as for the toner cartridge side and the toner feeding members, the members having the same functions and roles as those in Embodiment 1 are assigned the same names and like reference numerals and symbols.

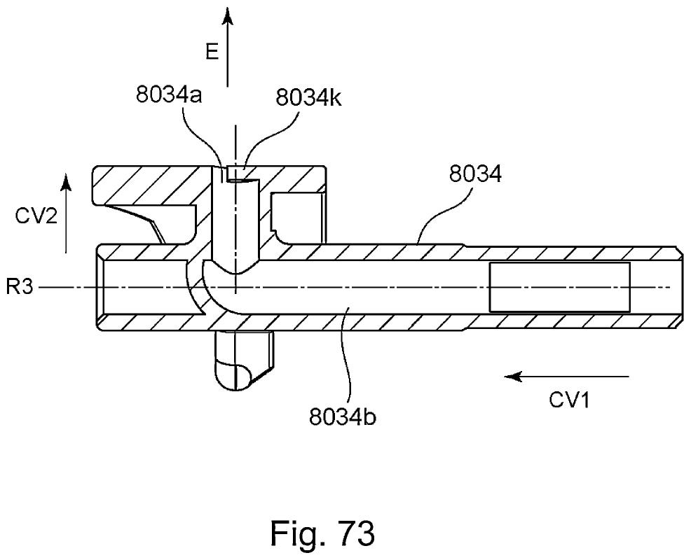

FIG. 72 is a side view of a first shutter member (first toner feeding member) 8034 according to Embodiment 8 of the present invention, as viewed from the side facing a toner discharge opening 8034a. FIG. 73 is a sectional view of the first shutter member 8034 according to Embodiment 7 of the present invention, taken along a line S8a-S8a shown in FIG. 72. As shown in FIGS. 72 and 73, a wall portion 8034k is provided in a part of the toner discharge opening 8034a of the first shutter member 8034. Therefore, the flow of toner (air containing toner powder) from the toner feeding portion 8034b to the toner discharge opening 8034a is blocked by the wall portion 8034k, by which a part of the toner flows back against the toner discharging direction E extending from the toner discharge opening 6034a. It is preferable that the size of the wall portion 8034k (in other words, the area of the toner discharge opening 8034a) be adjusted in accordance with the amount of the toner to be supplied to the process cartridge B side.

With the above-described structure, the first shutter member 8034 according to this embodiment can supply a necessary amount of the toner to the process cartridge B side, while reducing the amount of the toner consumption and the amount of the toner leakage.

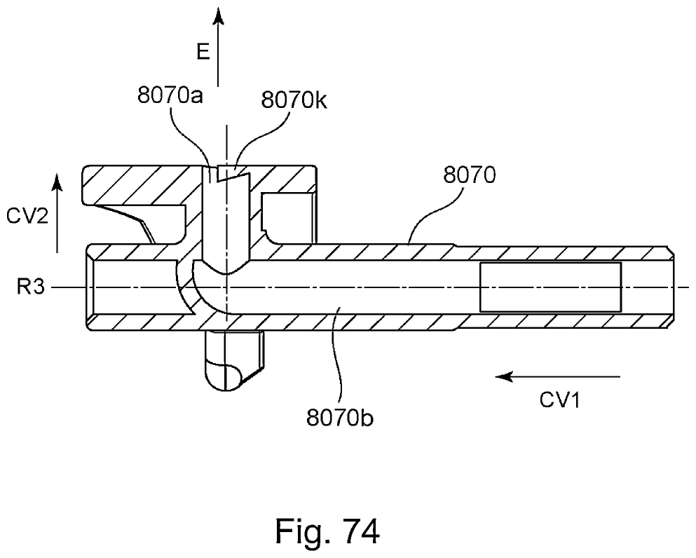

With a shutter member employs a wall portion having a shape different from that of the wall portion 8034k provided in the first shutter member 8034 described above, the same effect as that of the first shutter member 8034 described above can be provided. Referring to FIG. 74, this point will be explained. FIG. 74 is a sectional view passing through the centers of a toner feeding portion 8070b and a toner discharge opening 8070a of a second shutter member (second toner feeding member) 8070 according to Embodiment 8 of the present invention.

In the above-described first shutter member 8034, the wall portion 8034k is provided substantially parallel to the first feeding direction CV1 of the toner feeding portion 8034b and the rotation axis R3 of the shutter member 8034. In contrast, as shown in FIG. 74, the second shutter member 8070 is provided with a wall portion 8070k which is inclined at a predetermined angle with respect to the first feeding direction CV1 of the toner feeding portion 8070b and with respect to the rotation axis R3 of the shutter member 8070. Also, with the structure of the second shutter member 8070 described above, it is possible to provide the same effects as the first shutter member 8034 described above.

In this embodiment, the shutter member and the wall portion are integrally formed, but the present invention is not limited to such an example. For example, a wall portion separate from the shutter member may be mounted to the shutter member.

In this embodiment, the toner discharge opening and the wall portion are formed on the same plane on the exterior of the shutter member, but the present invention is not limited to such an example. For example, a wall portion may be provided inside the shutter member (i.e., midway in the toner feeding portion) with respect to the toner discharge opening.

In addition, in this embodiment, the toner discharge opening has a semicircular shape provided by the wall portion, but the shape of the toner discharge opening is not limited to this and may be any shape.

In addition, in this embodiment, a structure is employed in which a wall portion is provided to limit the amount of the toner discharged near the toner discharge opening, but a structure in which the cross-sectional area of the passageway from the toner feeding portion to the toner discharge opening changes in stages may also be employed. For example, the shutter member may be structured so that the wall portion is removed from the shutter member, and the shape of the feed passageway of the toner feeding portion formed continuously with the toner discharge opening may be tapered so that the cross-sectional area reduces as goes toward the toner discharge opening. With this structure, too, the amount of the toner discharged from the toner discharge opening can be limited.

### Embodiment 9

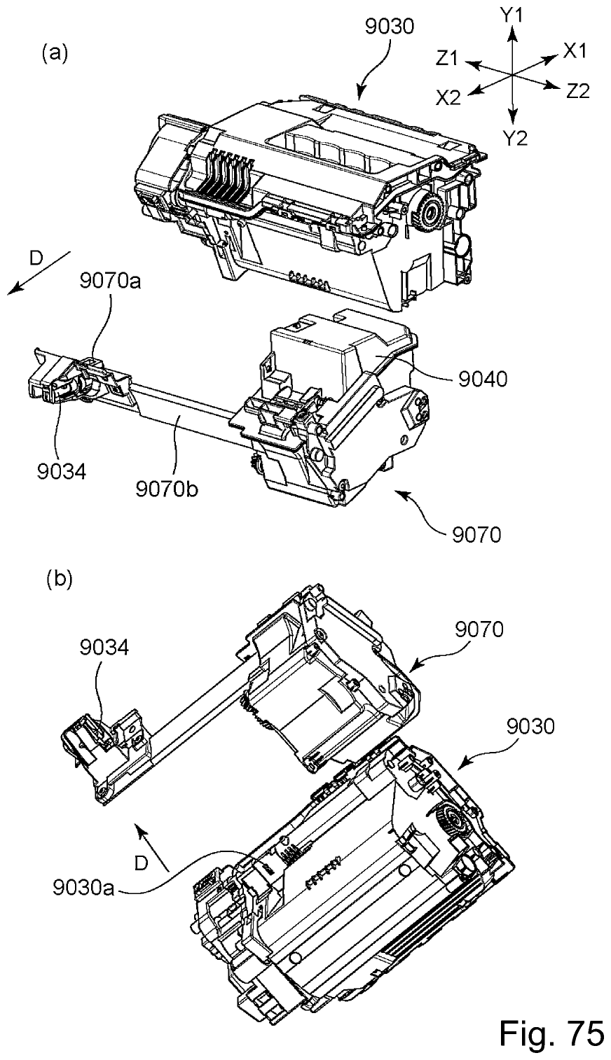

In the above-described Embodiment 1, the shutter member 34 is provided in the toner accommodating portion 30. In contrast, in this embodiment which will be described referring to FIGS. 75-85, a shutter member (toner feeding member) is provided (or supported) in a casing (unit) separate from the toner accommodating portion will be described. The same components as those in Embodiment 1 will be described with the same reference numerals and symbols as those in Embodiment 1. In addition, as for the toner cartridge side and the toner feeding members, the members having the same functions and roles as those in Embodiment 1 are assigned the same names and like reference numerals and symbols. The structure of a shutter member 9034 itself, which will be described hereinafter, is the same as that of the shutter member 34 described above, but for the sake of explanation, different reference numerals are used.

FIG. 75 is a perspective view of the external appearance of a first toner accommodating unit 9030 and a first waste toner storage unit 9070 according to Embodiment 9 of the present invention. Part (a) of FIG. 75 and part (b) of FIG. 75 are perspective views, as viewed in different directions, of the first toner accommodating unit 9030 and the first waste toner storage unit 9070 before they are coupled together.

As shown in part (a) of FIG. 75, the shutter member 9034 of this embodiment is supported by a first waste toner storage unit 9070. Specifically, the shutter member 9034, the first waste toner storage unit 9070 are provided with a waste toner storage portion 9040 in the Z2 direction. A shutter member 9034 is disposed near the end of an extension portion 9070b that is formed to extend from the waste toner storage portion 9040 in the Z1 direction.

In addition, in the XY plane, when the first toner accommodating unit 9030 and the first waste toner storage unit 9070 are connected, the shutter member 9034 is positioned offset toward the mounting direction D (X2 direction) relative to the first toner accommodating unit 9030. In contrast to this, the waste toner storage portion 9040 of the first waste toner storage unit 9070 and so on are disposed in the positions overlapping with the first toner accommodating unit 9030.

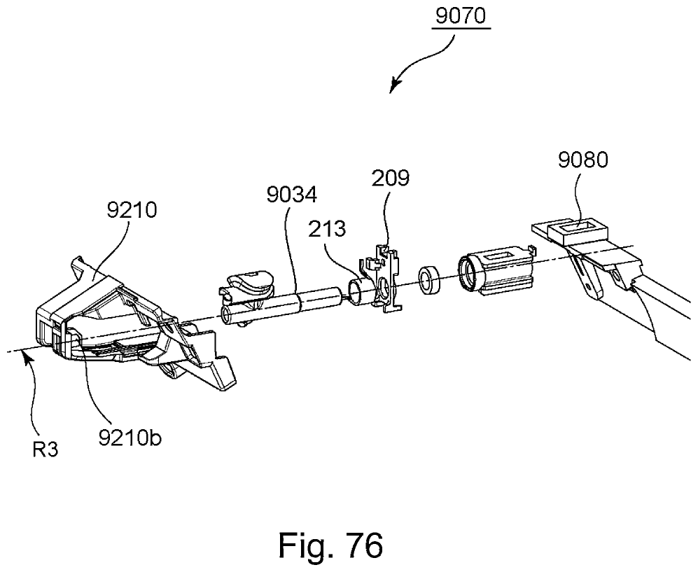

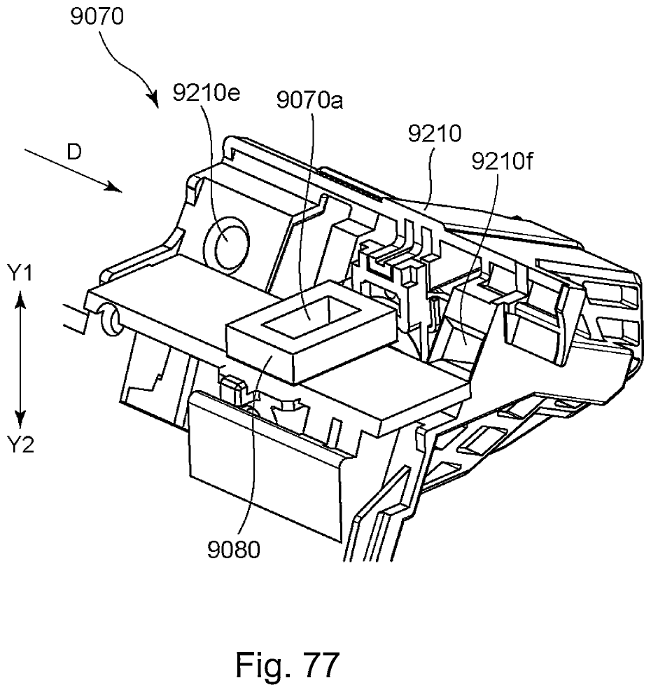

FIG. 76 is an exploded perspective view including each member in the neighborhood of a shutter member 9034 according to Embodiment 9 of the present invention. FIG. 77 is an enlarged perspective view of the first waste toner storage unit 9070 according to Embodiment 9 of the present invention, as viewed from the first toner storage unit (9030) side. As shown in FIG. 76, in the first waste toner storage unit 9070, similarly to the toner cartridge C of Embodiment 1 described above, there are provided a shutter member 9034, a coil spring 213, and a shutter support member 209, coaxially with respect to the rotation axis R3. In addition, the shutter member 9034 is rotatably supported by the shutter support member 209 and a first shutter support portion 9210b of the shutter protection member 9210.

As shown in FIG. 77, the first waste toner storage unit 9070 is provided with a toner receiving opening 9070a which is an opening facing in the Y2 direction. A seal member 9080 is disposed to project (with a certain thickness) in the Y2 direction so as to surround the toner receiving opening 9070a. The sealing member 9080 is made of a flexible foam material or the like.

Further, the shutter protection member 9210 is provided with a through hole 9210e and a rectangular hole 9210f in the mounting direction D (i.e., X2 direction). In addition, a through hole 9210e and a rectangular hole 9210f are provided with a toner receiving opening 9070a therebetween, in the Z1 direction and the Z2 direction.

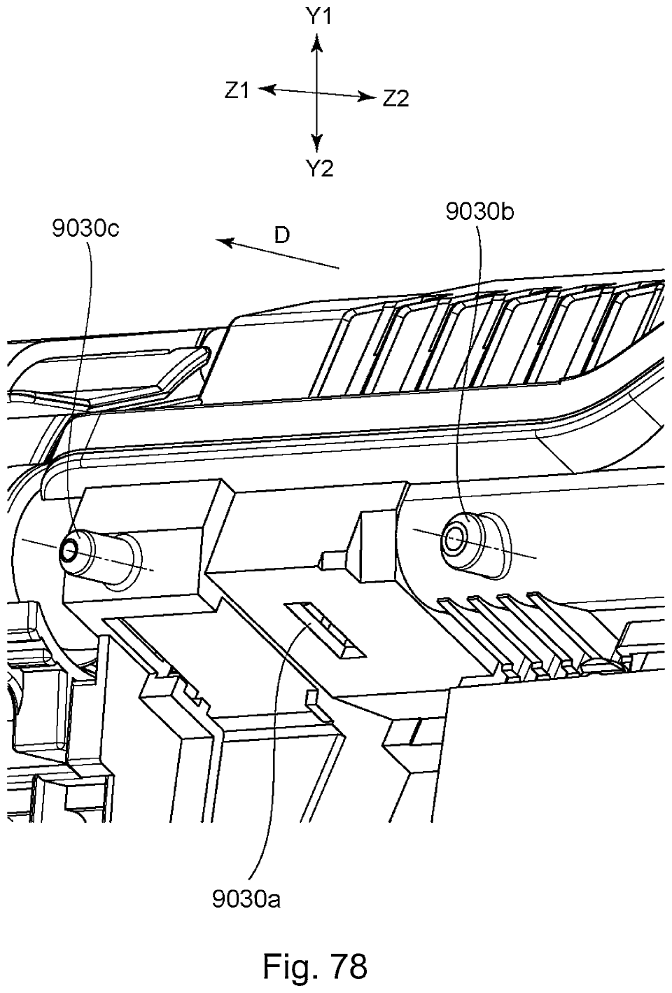

Next, the structure of the first toner accommodating unit 9030 according to this embodiment will be described. FIG. 78 is an enlarged perspective view of the neighborhood of a toner supply opening 9030a of the first toner accommodating unit 9030 according to Embodiment 9 of the present invention. As shown in FIG. 78, the first toner accommodating unit 9030 is provided with a toner supply opening 9030a which is an opening facing the Y1 direction. In addition, a first cylindrical portion 9030b is disposed in a downstream side of the Z2 direction, and a second cylindrical portion 9030c is disposed in in a downstream side of the Z1 direction, relative to the toner supply opening 9030a. That is, in a direction parallel to the Z1 direction and the Z2 direction (longitudinal direction of the first toner accommodating unit 9030), the cylindrical portions are provided on the opposite sides of the toner supply opening 9030a. The first cylindrical portion 9030b and the second cylindrical portion 9030c both project in the mounting direction D (i.e. X2 direction).

A toner seal (not shown) is provided on an inside of the container at the toner supply opening 9030a. When the first toner accommodating unit 9030 receives a driving force from the printer main assembly A, the toner seal is torn off, so that the toner stored in the first toner accommodating unit 9030 becomes capable of discharging through the toner supply opening 9030a.

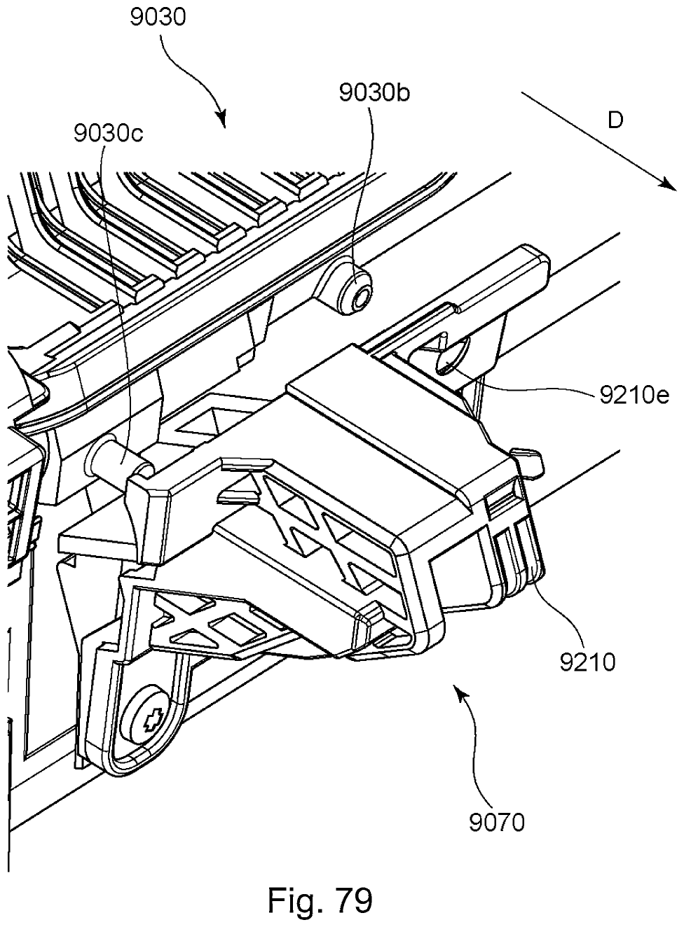

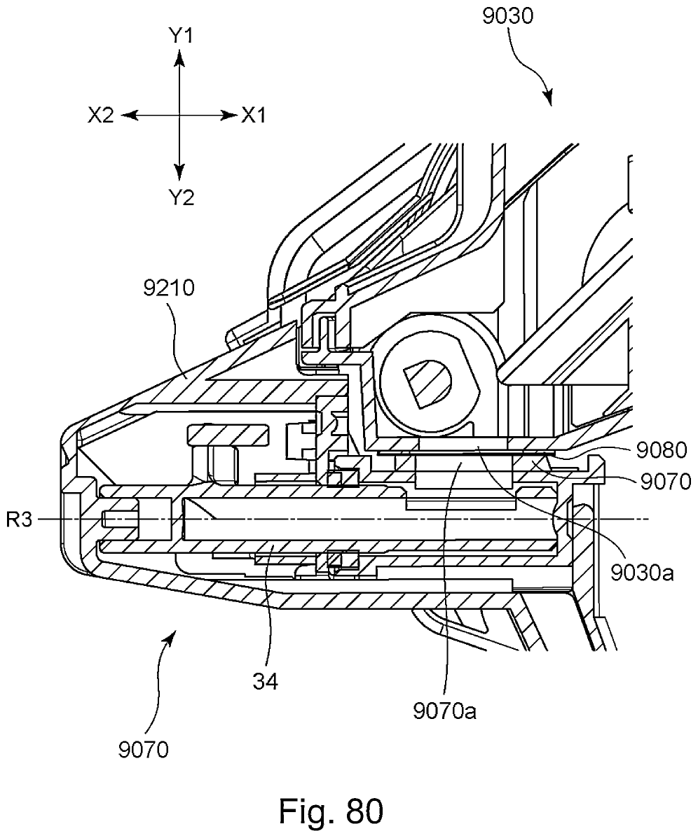

Next, a method of connecting the first toner accommodating unit 9030 and the first waste toner storage unit 9070 with each other will be described. FIG. 79 is an enlarged perspective view of the first toner accommodating unit 9030 according to Embodiment 9 of the present invention before the first waste toner storage unit 9070 is connected to the first toner accommodating unit 9030. FIG. 80 is a cross-sectional view in an XY plane passing through the rotation axis R3 of the shutter member 9034 in a state in which the first waste toner storage unit 9070 is connected to the first toner accommodating unit 9030 in Embodiment 9 of the present invention.

As shown in FIG. 79, in this embodiment, the first waste toner storage unit 9070 is first mounted to the printer main assembly A. Thereafter, the first toner accommodating unit 9030 is mounted in the mounting direction D (X2 direction) to the printer main assembly A in which the first waste toner storage unit 9070 has been mounted. At this time, the first cylindrical portion 9030b and the second cylindrical portion 9030c of the first toner accommodating unit 9030 are inserted into a through hole 9210e and a rectangular hole 9210f provided in the shutter protection member 9210, by which the first toner accommodating unit 9030 is positioned in place.

At the time of this positioning, the toner supply opening 9030a of the first toner accommodating unit 9030 and the toner receiving opening 9070a of the first waste toner storage unit 9070 face each other (see FIG. 80). Then, the seal member 9080 surrounding the toner receiving opening 9070a is compressed in directions parallel to the Y1 and Y2 directions, sealing the gap between the toner supply opening 9030a and the toner receiving opening 9070a, thereby preventing the toner from leaking out to the outside.

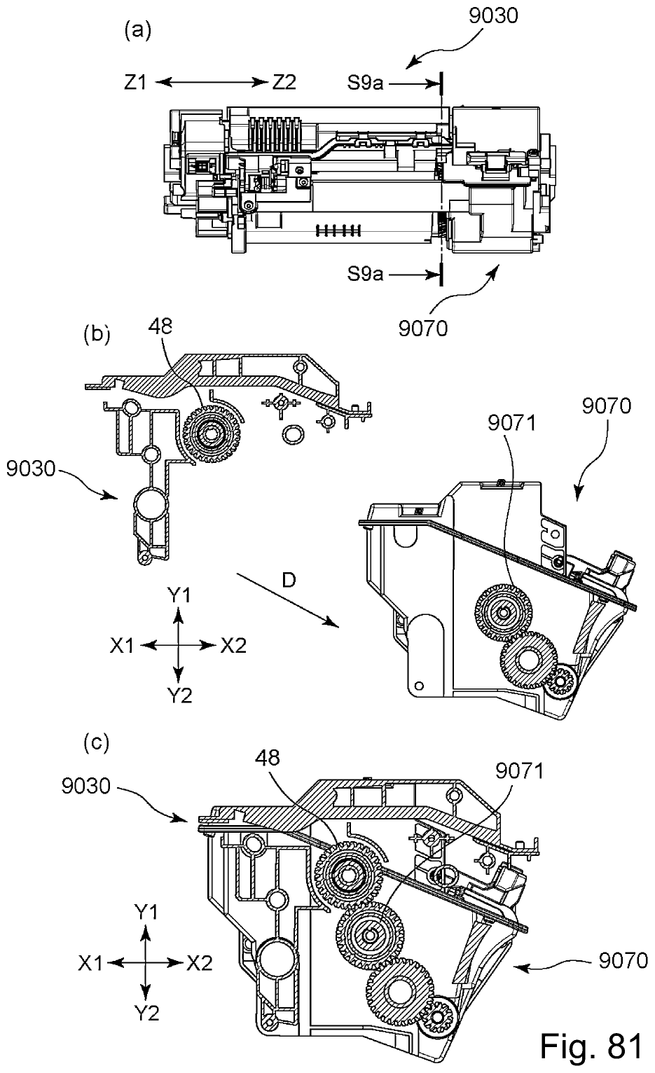

Here, a method of transmitting driving force in the first toner accommodating unit 9030 and the first waste toner storage unit 9070 will be described. FIG. 81 is an illustration of an example of a method for transmitting a driving force from a first toner accommodating unit 9030 to a first waste toner storage unit 9070 according to Embodiment 9 of the present invention. Part (a) of FIG. 81 is an illustration of the first waste toner storage unit 9070 connected to the first toner accommodating unit 9030 as viewed in the X2 direction. Part (b) of FIG. 81 is a cross-sectional view taken along a line S9a-S9a in part (a) of FIG. 81 during the process of connecting the first waste toner storage unit 9070 to the first toner accommodating unit 9030. FIG. 81C is a cross-sectional view taken along a line S9a-S9a in part (a) of FIG. 81, showing a state in which the first waste toner storage unit 9070 is connected to the first toner accommodating unit 9030.

The driving force for supplying toner in the first toner accommodating unit 9030 is transmitted from the printer main assembly A in the same manner as in Embodiment 1. In addition, in the first waste toner storage unit 9070, the driving force for feeding the toner to the process cartridge B side is transmitted to the first waste toner storage unit 9070 by way of the first toner accommodating unit 9030, similarly to Embodiment 1.

As shown in part (b) of FIG. 81, a gear-shaped drive input member 9071 is supported at an end of the first waste toner storage unit 9070 in the Z1 direction (front side of the paper) so as to be rotatable about an axis in the Z direction. At the end of the first toner accommodating unit 9030 in the Z2 direction (the back side of the sheet of drawing), a gear-shaped toner accommodating unit non-drive side gear 48 is supported rotatably about an axis in the Z axis direction. As in Embodiment 1, the driving force of the printer main assembly A is transmitted to the toner accommodating portion non-driving side gear 48 by way of the toner accommodating portion stirring/feeding unit 36.

As shown in part (c) of FIG. 81, when the first waste toner storage unit 9070 is connected to the first toner accommodating unit 9030, the toner accommodating portion non-driving side gear 48 and the drive input member 9071 are engaged with each other. In this state, the driving force received by the first toner accommodating unit 9030 from the printer main assembly A side can be transmitted to the first waste toner storage unit 9070. The first waste toner storage unit 9070 transmits the driving force received from the first toner accommodating unit 9030 to a toner feed mechanism within the first waste toner storage unit 9070. In other words, the driving force required for the first waste toner storage unit 9070 to feed toner is transmitted from the printer main assembly A by way of the first toner accommodating unit 9030.

With the above-described structure, the first toner accommodating unit 9030 of this embodiment is structured similarly to the members of the toner cartridge C of the above-described Embodiment 1 but without the waste toner storing portion 40, the shutter member 34, and the like. Therefore, as compared to the toner cartridge C of Embodiment 1 described above, the first toner accommodating unit 9030 of this embodiment can reduce the manufacturing cost of the toner accommodating unit which is a member replaced frequently, and can also reduce the size of the toner accommodating unit.

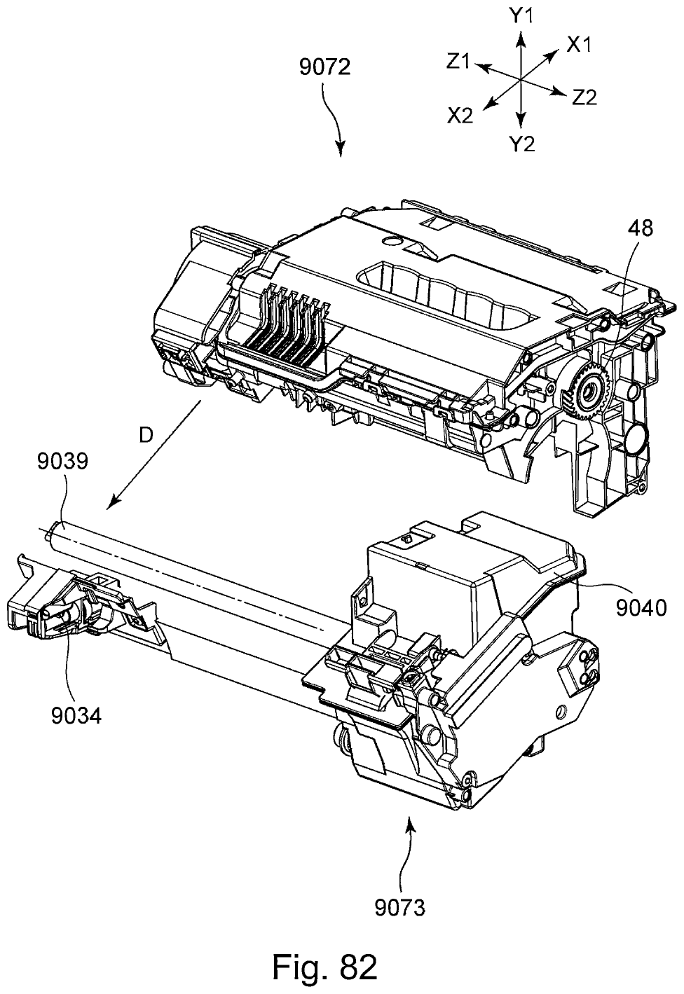

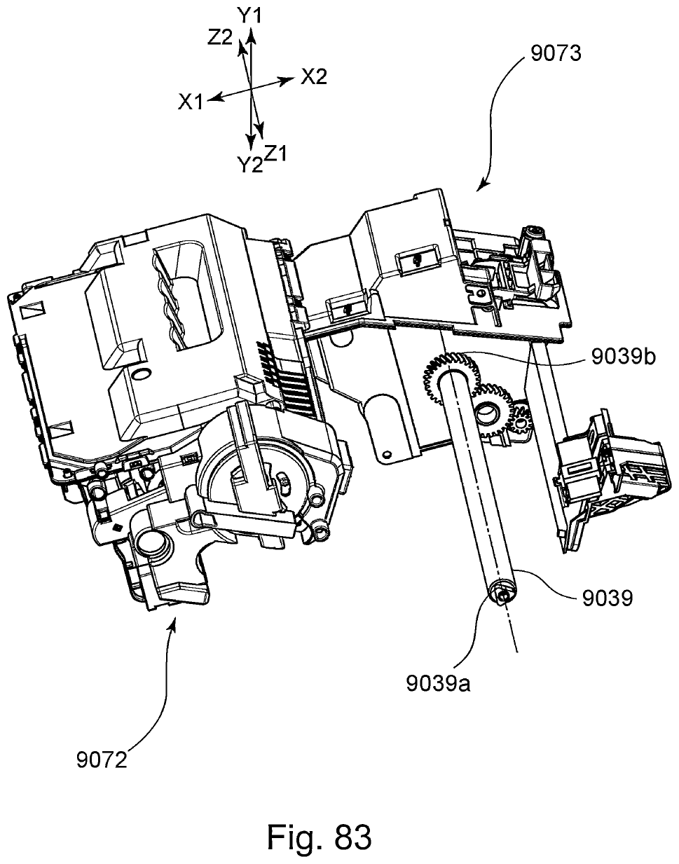

Here, it is also possible to employ a structure in which the waste toner storage unit receives driving force from the printer main assembly A and transmits it to the toner storage unit side. Referring to FIG. 82 and FIG. 82, such a structure will be described. FIG. 82 and FIG. 82 are perspective views of the external appearances of the second toner accommodating unit 9072 and the second waste toner storage unit 9073 according to Embodiment 9 of the present invention, as viewed from the front side thereof. FIG. 83 is an external perspective view of the second toner accommodating unit 9072 and the second waste toner storage unit 9073 according to Embodiment 9 of the present invention, as viewed in the Z1 direction. For the second toner accommodating unit 9072 and the second waste toner storage unit 9073, the description will be omitted for the structure which are substantially the same as those of the first toner accommodating unit 9030 and the first waste toner storage unit 9070 described above, respectively. Hereinafter, the drive input member 9039 provided in the second waste toner storage unit 9073 will be mainly described.

As shown in FIGS. 82 and 83, the second waste toner storage unit 9073 is provided with a drive input member 9039. The drive input member 9039 has a cylindrical shape extending in the Z1 direction from the waste toner storage portion (9040) side, and is coaxially provided, at the Z1 direction end, with a drive input portion 9039a for receiving a driving force from the printer main assembly A, and is coaxially provided, at the Z2 direction end, with a gear-shaped drive transmission portion 9039b. The drive input member 9039 is supported by the second waste toner storage unit 9073 so as to be rotatable about the central axis of rotation. By the drive input member 9039 receiving a driving force from the printer main assembly A, the driving force can be transmitted to a waste toner feed mechanism in the second waste toner storage unit 9073. As shown in FIG. 82, the second toner accommodating unit 9072 can be connected to the second waste toner storage unit 9073 in the mounting direction D (X2 direction). The driving force input portion 9039 is disposed at a position where it does not interfere with the second toner accommodating unit 9072 when the second toner accommodating unit 9072 is connected. The other structure is the same as that of the first waste toner storage unit 9070 described above, and therefore, the description will be omitted.

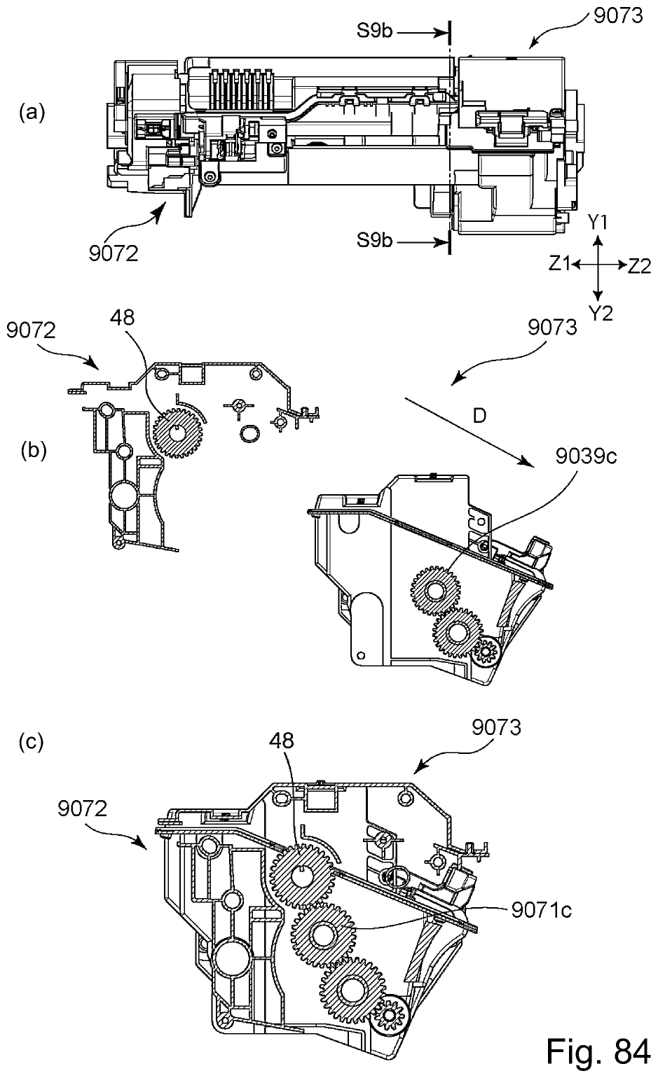

Here, a method for transmitting the driving force in the second toner accommodating unit 9072 and the second waste toner storage unit 9073 will be described. FIG. 84 is an illustration of a method of transmitting a driving force from the second toner accommodating unit 9072 to the second waste toner storage unit 9073 according to Embodiment 9 of the present invention. Part (a) of FIG. 84 is an illustration of a state in which the second waste toner storage unit 9073 is connected to the second toner accommodating unit 9072, as viewed in the X2 direction. Part (b) of FIG. 84 is a cross-sectional view taken along a line S9b-S9b in part (a) of FIG. 84 during the process of connecting the second waste toner storage unit 9073 to the second toner accommodating unit 9072. FIG. 84C is a cross-sectional view, taken along a line S9b-S9b indicated in part (a) of FIG. 84, of a state in which the second waste toner storage unit 9073 is connected to the second toner accommodating unit 9072.

As shown in part (c) of FIG. 84, when the second waste toner storage unit 9073 is connected to the second toner accommodating unit 9072, the toner accommodating portion non-drive side gear 48 of the second toner accommodating unit 9072 and the drive input member 9039 of the second waste toner storage unit 9073 engage with each other. In this state, the driving force received by the second waste toner storage unit 9073 from the printer main assembly A can be transmitted to the second toner accommodating unit 9072 by way of the toner accommodating portion stirring/feeding unit 36 and a drive transmission portion (not shown). That is, the second toner accommodating unit 9072 receives the driving force required to supply toner, from the printer main assembly A by way of the second waste toner storage unit 9073. With the above-described structure, it is possible to provide the same effects as in the case where the first toner accommodating unit 9030 and the first waste toner storage unit 9070 described above are employed.

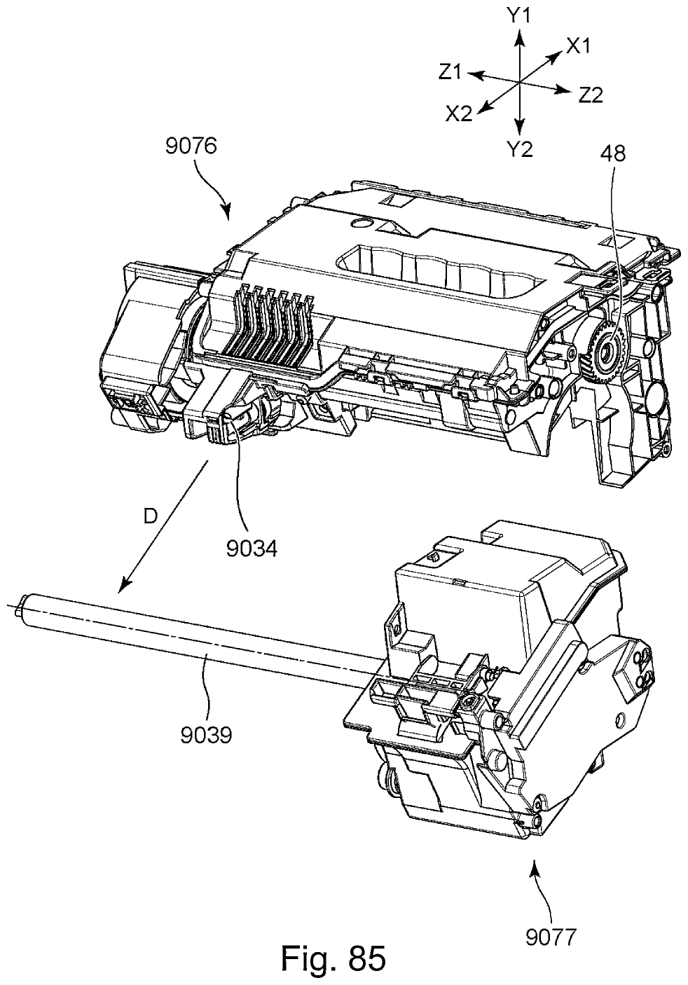

It is also possible to employ a structure in which the toner accommodating unit has a shutter member, as in Embodiment 1, and the driving force from the printer main assembly A is received by the waste toner accommodating unit and transmitted to the toner accommodating unit. Referring to FIG. 85, this structure will be described. FIG. 85 is a perspective view illustrating the external appearance of a third toner accommodating unit 9076 and a third waste toner unit 9077 according to Embodiment 9 of the present invention.

As shown in FIG. 85, the third toner accommodating unit 9076 is provided with the shutter member 9034, and the third waste toner storage unit 9077 is provided with a drive input member 9039, as with the second waste toner storage unit 9073 described above. Except that the shutter member 9034 is provided in the toner accommodating unit 9076, the toner accommodating unit 9076 has the same structure and operates in the same manner as the second toner accommodating unit 9072 and the second waste toner storage unit 9073 described above, and therefore, the description thereof will be omitted. With the above-described structure, the manufacturing cost of the toner accommodating unit can be reduced and the toner accommodating unit can be made smaller than the toner cartridge C of Embodiment 1.

In addition to the three examples of this embodiment described above, a structure in which the waste toner storage portion 40 is separated from the toner accommodating portion 30 of Embodiment 1 may be employed, and since the structure and operation of each portion are substantially the same as in the above-mentioned examples, the detailed explanations thereof will be omitted.

In addition, in the above-described examples of this embodiment, a structure has been described in which either the toner storage unit or the waste toner storage unit is first mounted to the printer main assembly A, and then the other is connected, but this is not inevitable. For example, the toner storage unit and the waste toner storage unit, in a connected state, may be mounted to the printer main assembly A.

In the above-described examples according to this embodiment, a connection direction between the toner accommodating unit and the waste toner storage unit is parallel to the X-axis, but the present invention is not limited to such an example. For example, by changing the support structure of the toner accommodating unit and the waste toner storage unit, the two units may be connected in a direction parallel to an axis different from the X axis (Z axis, for example).

### Embodiment 10

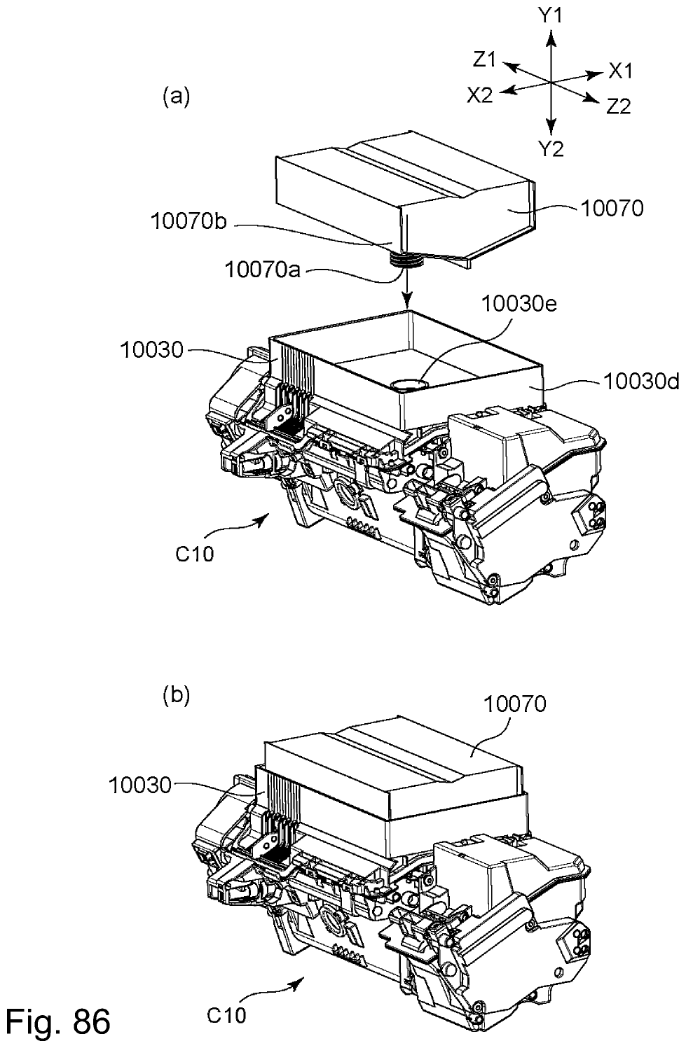

In the above-described Embodiment 1, the toner cartridge C including the toner accommodating portion 30 includes the shutter member 34 that is a toner feeding member. In contrast, in this embodiment which will be described below referring to FIG. 86, the toner accommodating portion is separated from the unit including the toner feeding member and the toner accommodating portion is replaceable as a separate member such as a pouch. The same components as those in Embodiment 1 will be described with the same reference numerals and symbols as those in Embodiment 1. In addition, as for to the toner cartridge, the members having the same functions and roles as those in Embodiment 1 are assigned the same names and like reference numerals and symbols.

FIG. 86 is an external perspective view of a toner cartridge C10 according to Embodiment 10 of the present invention. Part (a) of FIG. 86 is an external perspective view of the toner cartridge C10 before the toner container unit 10070 is mounted to the toner cartridge C10. Part (b) of FIG. 86 is an external perspective view of the toner cartridge C10 after toner container unit 10070 is mounted to the toner cartridge C10.

The toner cartridge C10 of this embodiment is the same as the toner cartridge C of the previously described Embodiment 1 except for the mounting portion 10030 provided on the top of the cartridge and the structure for receiving toner from the mounting portion 10030, and therefore, the description thereof will be omitted. As shown in part (a) of FIG. 86, the toner cartridge C10 is provided with the mounting portion 10030 on the top of the cartridge (Y2 direction). The mounting portion 10030 is provided with a mounting frame 10030d to which the toner container unit 10070 can be mounted.

In this embodiment, the shape of the mounting frame 10030d is rectangular in the XZ plane to match the shape of the pouch-type toner container unit 10070 having a rectangular shape in the XZ plane, but the shape of the mounting frame 10030d is not limited to such an example. The shape of the mounting frame 10030d can be appropriately changed to match the shape of the toner container unit 10070. In addition, the mounting frame 10030d itself may not be provided. In such a case, it is preferable to fix the toner container unit 10070 using mounting members or seals to prevent the toner container unit 10070 from moving or falling after the toner container unit 10070 has been completely mounted in the toner cartridge C10.

A toner receiving opening 10030e, which is an opening connected to the inside of the toner cartridge C10, is provided at approximately the center of the mounting frame 10030d. The toner received through the toner receiving opening 10030e can move toward the shutter member (toner feeding member) 34 through a supply chamber (not shown) provided inside the toner cartridge C10, as in Embodiment 1 described in the foregoing.

The toner container unit 10070 accommodates toner therein, and as shown in part (b) of FIG. 86, when it is mounted to the toner cartridge C10, a part of the upper surface side (Y2 direction) is exposed above the mounting frame 10030d. When replacing the toner container unit 10070, an operator can grip this exposed portion to perform the operation of mounting it to or dismounting it from the toner cartridge C10.

A cylindrical toner supply portion 10070d is provided at a lower portion (Y1 direction) of the toner accommodating unit 10070, in alignment with the position of the toner receiving opening 10030e provided in the mounting portion 10030, so as to project in the Y1 direction. At the free end of the toner supply portion 10070d, a toner supply opening 10070a is provided, which is an opening for supplying toner to the toner cartridge (C10) side. After the toner container unit 10070 is mounted to the toner cartridge C10, the cylindrical toner supply portion 10070b is inserted into the toner receiving opening 10030e. In this state, the oner can be supplied from the toner container unit 10070 into the toner cartridge C10.

With the above-described structure, the toner container unit 10070 is mountable to and detachable from the toner cartridge C10 according to this embodiment, and there is no need to replace the toner cartridge itself as the toner is consumed, and therefore, the toner cartridge can be made smaller. In particular, there is no need to replace the toner cartridge C10, which is provided with the shutter member 34 which operates in interrelation with the process cartridge B, when the toner is consumed. Therefore, fatigue of the shutter member 34 and the receiving side shutter member 206 of the process cartridge B resulting from the mounting and dismounting of the toner cartridge C10 can be reduced.

The toner accommodating unit usable with this embodiment is a pouch type, and is made of polypropylene, and is structured into a flexible box shape by bonding together sheet-like members each including a thickness of about 0.18 mm. The toner supply unit 10070b is made of a known plastic material having rigidity (such as ABS resin). The toner container unit 10070 may be structured to be formed from a frame made of plastic material or the like.

In addition, when using the toner cartridge C10 according to this embodiment, the user may mount it to the printer main assembly A with the toner container unit 10070 mounted thereto. In addition, a structure may be such that, after the toner inside the toner container unit 10070 is supplied to the toner cartridge C10, the toner container unit 10070 is removed and the toner cartridge C10 is then mounted to the printer main assembly A.

### Embodiment 11

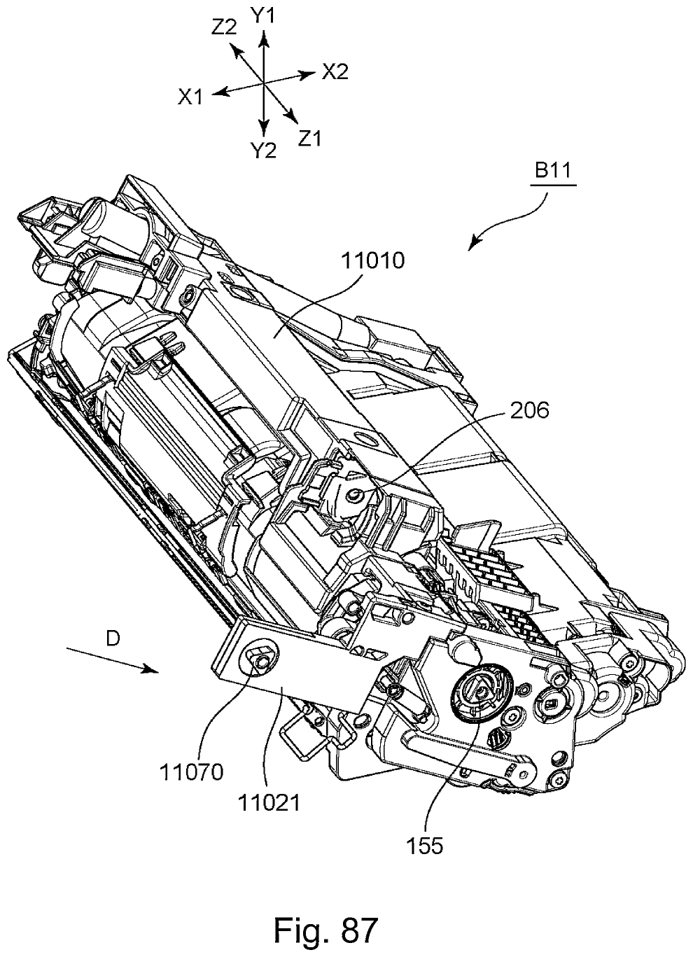

In the above-described Embodiment 1, the toner is fed based on the driving force received from the printer main assembly A using the pump-screw drive input portion 39 provided in the toner cartridge C. In contrast, in this embodiment which will be described, referring to FIGS. 87 to 91, a member other than the toner cartridge C is provided with a member for receiving a driving force, from the printer main assembly A, wherein the driving force for feeding the toner to the toner cartridge side is transmitted by way of that member. The same components as those in Embodiment 1 will be described with the same reference numerals and symbols as those in Embodiment 1. In addition, as for the toner cartridge, process cartridge, and printer main assembly, the components having the same functions and roles as those in Embodiment 1 are assigned the same names and like reference numerals and symbols.

FIG. 87 is a perspective view illustrating an external appearance of the process cartridge B11 according to Embodiment 11 of the present invention. As shown in FIG. 87, the process cartridge B11 is provided with a cleaning unit 11010. The process cartridge B11 is provided with an extension portion 11021 extending from the cleaning unit 1101 in the X1 direction on the side (called the drive side) where the development coupling 155 is provided in the direction parallel to the Z axis. A driving force receiving member 11070 is provided at a free end (X1 direction) of the extending portion 11021. The method of engagement between the driving force receiving member 11070 and the first main assembly side coupling 110 provided in the printer main assembly A will be described in detail hereinafter.

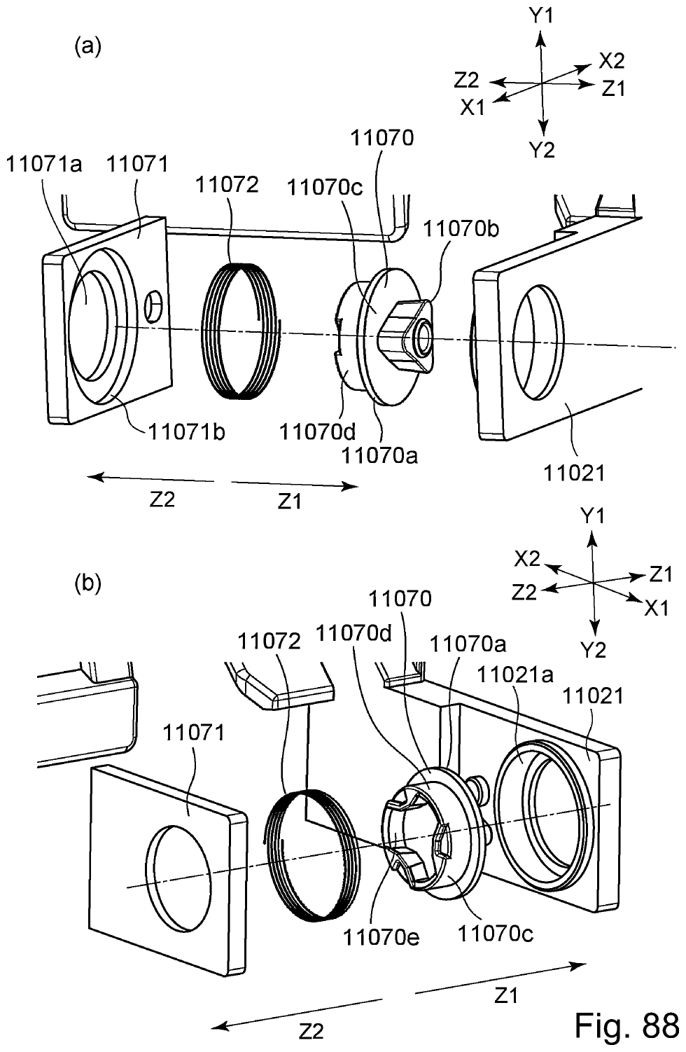

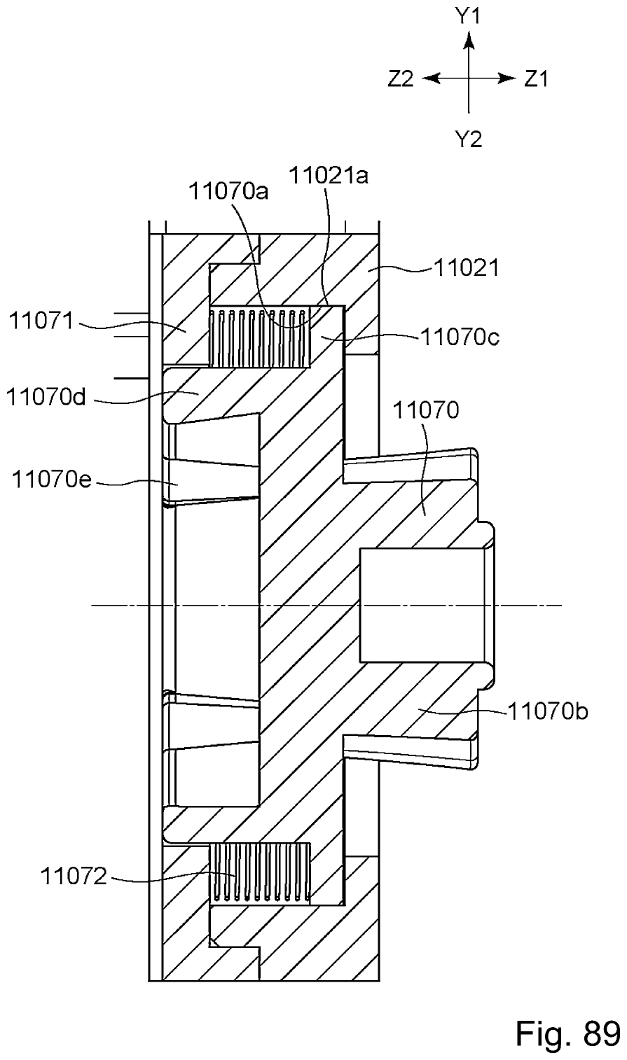

Next, referring to FIGS. 88 and 89, the support mechanism of the driving force receiving member 11070 will be described. FIG. 88 is an exploded perspective view of a driving force receiving member 11070 according to Embodiment 11 of the present invention. Part (a) of FIG. 88 is an exploded perspective view illustrating the driving force receiving member 11070 in detail as viewed generally in the Z1 direction, and part (b) of FIG. 88 is an exploded perspective view illustrating the driving force receiving member 11070 in detail as viewed generally in the Z2 direction. FIG. 89 is a sectional view taken along a YZ plane passing through a center of a rotation axis of a driving force receiving member 11070 according to Embodiment 11 of the present invention.

As shown in FIGS. 88 and 89, the extension portion 11021 of the process cartridge B11 is provided with a first circular recess 11021a recessed in the Z1 direction. The driving force receiving member 11070 has a hollow cylindrical shape, and is provided with a driving force receiving portion 11070b which projects toward the printer main assembly A side (Z1 direction). A flange portion 11070c is provided at the base portion of the drive receiving portion 11070b. The thickness portion of the flange portion 11070c in the Z-axis direction is formed with an outer circumferential surface 11070a. A cylindrical portion 11070d having a smaller diameter than the flange portion 11070c is provided on the Z2 direction side of the flange portion 11070c, coaxially with the flange portion 11070c and projecting from the flange portion 11070c in the Z2 direction. A drive transmission portion 11070e having a plurality of recesses formed toward the inner circumferential surface side of the cylindrical portion is provided at the end in the Z2 direction of the cylindrical portion 11070d.

The cover portion 11071 has a flat plate shape and is provided with a through hole 11071a which penetrates in a direction parallel to the Z axis. The cover portion 11071 is provided with a second circular recess 11071b which is recessed in the Z2 direction and is coaxial with the through hole 11071a.

Next, a method of assembling the driving force receiving member 11070 will be described. The driving force receiving member 11070 is mounted to the extension portion 11021 in the Z2 direction, and the outer circumferential surface 11070a of the flange portion 11070c is supported by a first circular recess 11021a provided in the extension portion 11021. The cover portion 11071 is fixed to the extension portion 11021 by adhesive or the like so as to sandwich the flange portion 11070c of the driving force receiving portion 11070 between the opposite sides in the direction of the rotation axis (Z axis direction).

In addition, a compression spring 11072 is provided between the flange portion 11070c of the driving force receiving member 11070 and the cover portion 11071. The compression spring 11072 urges the driving force receiving member 11070 towards the printer main assembly A (Z1 direction). As shown in FIG. 89, the drive transmission portion 11070e of the driving force receiving member 11070 is structured so as not to project from the stay cover member 11071 in the Z2 direction, at this time.

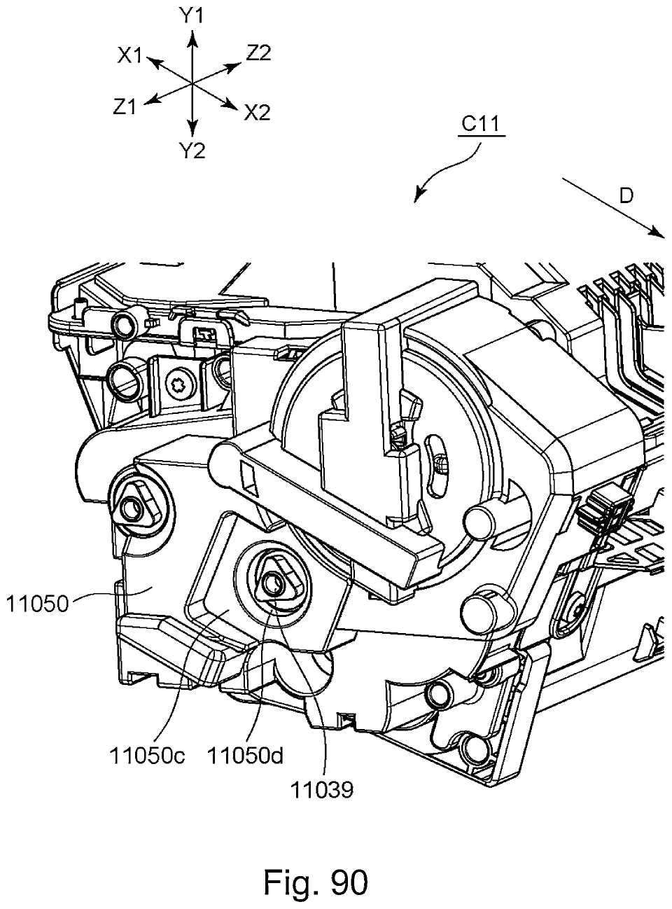

Next referring to FIG. 90, the toner cartridge C11 according to this embodiment will be described. FIG. 90 is an external perspective view of the toner cartridge C11 according to Embodiment 11 of the present invention. As shown in FIG. 90, a drive side toner cartridge side cover 11050 is provided at the Z1 direction end of the toner cartridge C11. The drive side toner cartridge side cover 11050 is provided with a recess 11050c recessed in the Z2 direction. The recess 11050c is provided with a through hole 11050d. A drive input portion 11039 is mounted to the through hole 11050d so as to be rotatable coaxially with the central axis of the through hole 1150c. The structure of the drive side toner cartridge side cover 11050 is the same as that of the drive side toner cartridge side cover 50 of Embodiment 1 except for the above-mentioned structure, and therefore, the description thereof will be omitted.

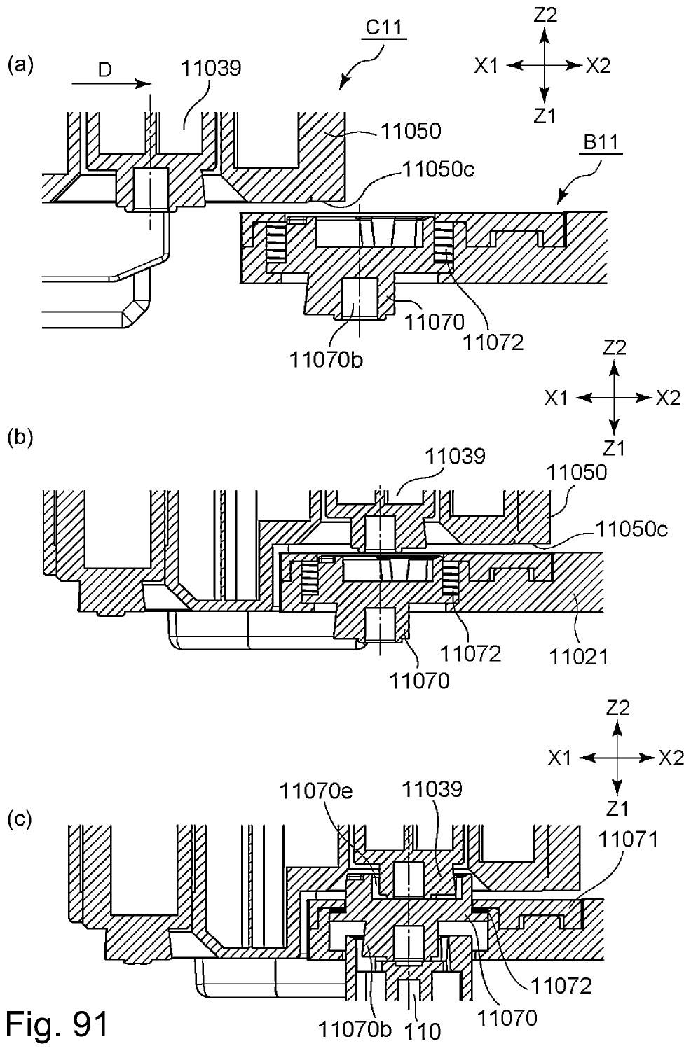

Next, referring to FIG. 91, the operation of the driving force receiving member 11070 when the toner cartridge C11 is mounted to the process cartridge B11 will be described. FIG. 91 is an illustration of an example of a connection method between the drive input portion 11039 and the driving force receiving member 11070 in Embodiment 11 of the present invention, and shows a sectional view taken along an XZ plane passing through the rotation axis of the drive input portion 11039 and the driving force receiving member 11070. Part (a) of FIG. 91 is a sectional view illustrating a state in which the toner cartridge C11 is in the process of being mounted to the process cartridge B11. Part (b) of FIG. 91 is a sectional view illustrating a state in which the toner cartridge C11 has been completely mounted to the process cartridge B11. FIG. 91 (C) is a sectional view illustrating the state when both the process cartridge B11 and the toner cartridge C11 have been completely mounted in the printer main assembly A. For simplification of explanation, part (c) of FIG. 91 shows only the first main assembly side coupling 110 as a component on the printer main assembly A side.

As shown in part (a) of FIG. 91 and part (b) of FIG. 91, the toner cartridge C11 can move in the mounting direction D (X2 direction) relative to the process cartridge B11. In the state that the toner cartridge C11 is completely mounted to the process cartridge B11, the drive input portion 11039 and the driving force receiving member 11070 face each other, with their axes substantially coaxial in the X-axis direction. At this time, as shown in part (b) of FIG. 91, the extension portion 11021 of the process cartridge B11 overlaps with the recess 11050c of the drive side toner cartridge side cover 11050 in the Z axis direction.

As shown in part (c) of FIG. 91, when the process cartridge B11 and toner cartridge C11 are mounted to the printer main assembly A, the rotation axis of the driving force receiving portion 11070 is positioned coaxially with the rotation axis of the main assembly side coupling 110 of the printer main assembly A. When the driving force is transmitted from the printer main assembly A to the toner cartridge C11 side, the main assembly side coupling 110 moves in the Z2 direction to press the driving force receiving member 11070 in the Z2 direction against the urging force of the compression spring 11072. Therefore, the drive transmission portion of the main assembly side coupling 110 and the drive force receiving portion 11070b of the drive force receiving member 11070 are engageable with each other in the rotational direction. The drive transmission portion 11070e projects in the Z2 direction beyond the cover portion 11071 and engages with the drive input portion 11039 of the toner cartridge C11. The first main assembly side coupling 110 may be structured to move in the Z2 direction in response to the opening and closing opening/closing door 107 of the printer main assembly A being closed.

With the structure described above, also in the case that the driving force related to the feed of toner in toner cartridge C11 is received by way of a member provided in process cartridge B11, the same effects as those described in embodiment 1 can be provided. In general, toner cartridges are exchanged more frequently than process cartridges (developing cartridges). Therefore, by providing a member for receiving the driving force from the printer main assembly A on the process cartridge side, which is replaced less frequently, it is possible to reduce fatigue and damage to the members involved in transmission of the driving force from the printer main assembly A to other portions when the toner cartridge is exchanged.

### Embodiment 12

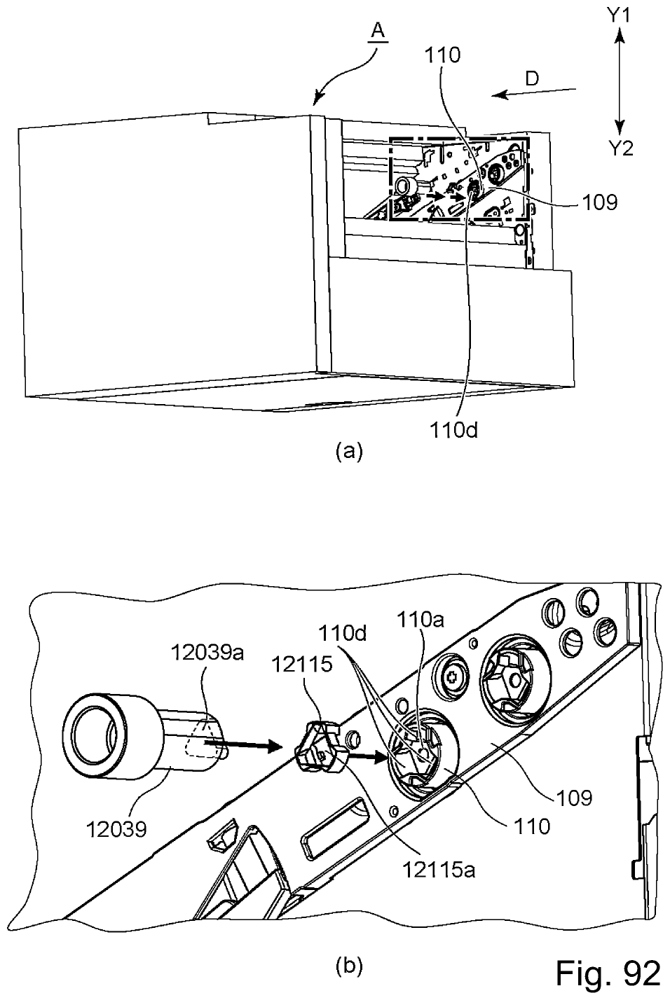

In the above-described Embodiment 1, the structure has been described in which the rotational drive of the printer main assembly A is transmitted to the toner cartridge C through the engagement between the first main assembly side pump coupling 110 and the pump-screw coupling portion 39a. In contrast, in this embodiment which will be described, referring to FIGS. 92 to 95, the driving force is transmitted by way of a drive transmission attachment 12115 provided between the first main assembly side pump coupling 110 and the pump-screw coupling portion 12039a. The same components as those in Embodiment 1 will be described with the same reference numerals and symbols as those in Embodiment 1. In addition, as for the toner cartridge, process cartridge, and printer main assembly, the components having the same functions and roles as those in Embodiment 1 are assigned the same names and like reference numerals and symbols.

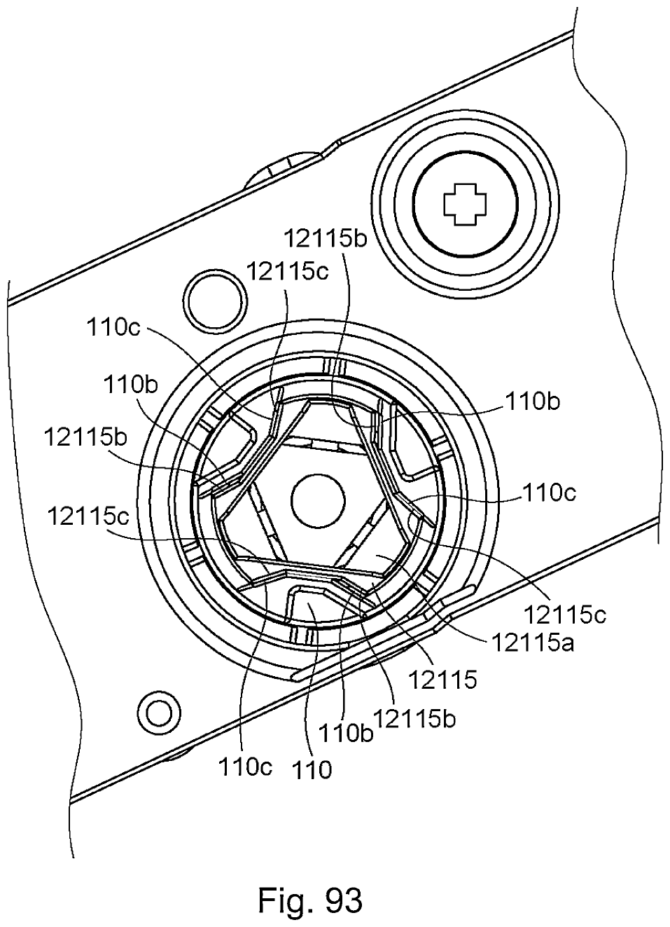

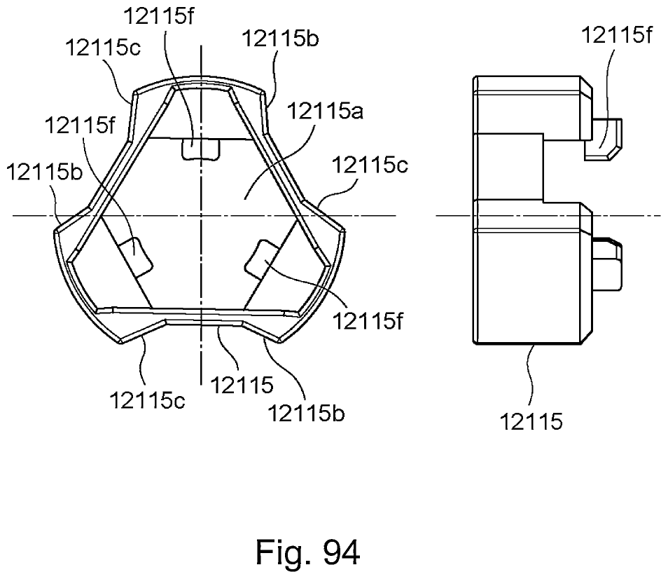

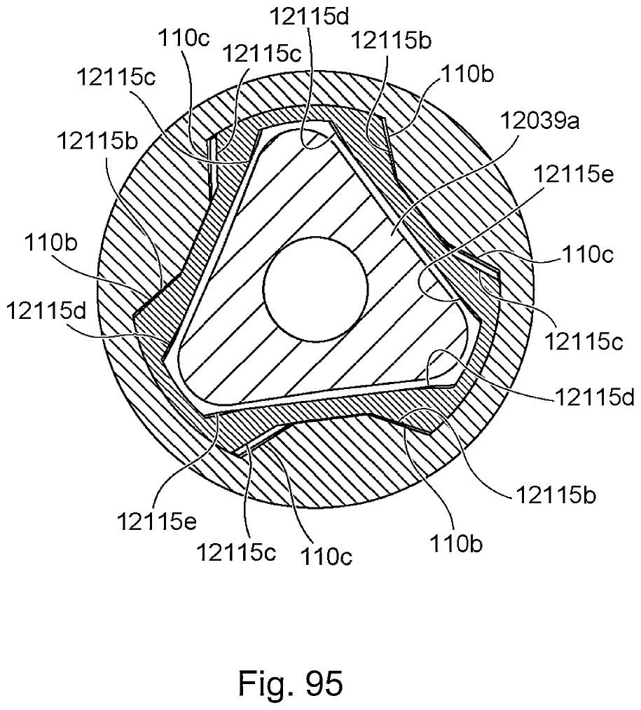

FIG. 92 is an illustration for exemplarily explaining a method for mounting each drive transmission mechanism according to Embodiment 12 of the present invention. Part (a) of FIG. 92 is an exploded perspective view illustrating major parts of the printer main assembly A to which the drive transmission attachment 12115 is mounted. Part (b) of FIG. 92 is an enlarged view of a part of part (a) of FIG. 92 and illustrates, by way of example, the position on the printer main assembly A to which the drive transmission attachment 12115 is mounted. For simplification of explanation, some portions of the printer main assembly A, such as the opening and closing opening/closing door 107, are omitted from part (a) of FIG. 92. FIG. 93 is an illustration of an example of a state in which the drive transmission attachment 12115 is mounted to the first main assembly side coupling 110 according to Embodiment 12 of the present invention. FIG. 94 is a detailed view of the drive transmission attachment 12115 according to Embodiment 12 of the present invention. FIG. 95 is an illustration of an example of a drive transmission mechanism for transmission from the printer main assembly A to the toner cartridge C12 according to Embodiment 12 of the invention. FIG. 95 is a cross-sectional view (taken along an XY plane) of the first main assembly side coupling 110, the drive transmission attachment 12115, and the pump-screw coupling portion 12039a, taken along a line in a direction perpendicular to the axis G.

First, the first main assembly side coupling 110 is arranged to be able to advance and retract in the second guide portion 109, and in this embodiment, advances and retracts in accordance with the opening and closing of the opening and closing opening/closing door 107 (it moves inward of the apparatus when the opening and closing opening/closing door 107 is closed). Further, the toner cartridge C12 according to this embodiment employs substantially the same structure as the toner cartridge C according to the above-described Embodiment 1, except for the pump-screw coupling 12039.

As shown in part (a) of FIG. 92, part (b) of FIG. 92, and FIG. 93, the drive transmission attachment 12115 is a driving force transmission member according to this embodiment which is used when transmitting drive force from the printer main assembly A to the toner cartridge C12. The drive transmission attachment 12115 can be mounted to the main assembly side coupling recess 110a of the first main assembly side coupling 110 in a direction parallel to the Z axis.

Next, as shown in FIG. 94, the drive transmission attachment 12115 has a retaining shape 12115f. The retaining shape 12115f of the drive transmission attachment 12115 can engage with a hole portion 110d provided in the first main assembly side coupling 110. When the drive transmission attachment 12115 is mounted to the first main assembly side coupling recess 110a, the retaining shape 12115f is elastically deformed and snap-fitted into the hole portion 110d. However, the method of fixing the drive transmission attachment 12115 to the first main assembly side coupling 110 is not limited to this example, and it may be fixed by, adhesion or press fitting, for example.

Next, as shown in FIGS. 93 and 94, the drive transmission attachment 12115 has a first drive receiving surface 12115b for receiving a drive force by abutting against the first drive transmitting surface 110b of the first main assembly side coupling. The drive transmission attachment 12115 also has a second drive receiving surface 121115c for receiving the drive force by abutting against the second drive transmitting surface 110c of the first main assembly side coupling 110. In FIG. 93, when the main assembly side coupling 110 rotates clockwise, the first drive receiving surface 12115b abuts against the first drive transmitting surface 110b. In addition, when the main assembly side coupling 110 rotates in the counterclockwise direction, the second drive receiving surface 12115c abuts against the second drive transmitting surface 110c. Here, in this embodiment, in the XY plane when the first main assembly side coupling 110 is viewed from the side on which the drive transmission attachment 12115 is mounted, the clockwise rotation is defined as forward rotation and counterclockwise rotation is defined as backward rotation.

Next, as shown in FIG. 95, the drive transmission attachment 12115 has a third drive transmission surface 12115d for transmitting a driving force to the pump-screw coupling portion 12039a during forward rotation, and a fourth drive transmission surface 121115e for transmitting a driving force during backward rotation.

When the toner cartridge C12 is mounted in the printer main assembly A and the opening and closing opening/closing door 107 is closed, the first main assembly side coupling 110 and the drive transmission attachment 12115 engage with each other and integrally project to the inside of the apparatus. At this time, the pump-screw coupling portion 12039a of the toner cartridge C12 enters the drive transmission attachment recess 12115a of the drive transmission attachment 12115.

The drive transmission attachment 12115 mounted to the first main assembly side coupling 110 is rotated by the first drive receiving surface 12115b or the second drive receiving surface 12115c receiving the driving force from the first main assembly side coupling 110. Further, the driving force is transmitted from the third driving force transmission surface 12115d or the fourth driving force transmission surface 121115e to the pump-screw coupling portion 12039a. With the above structure, the driving force for feeding toner can be transmitted from the printer main assembly A to the toner cartridge C12 by way of the drive transmission attachment 12115. That is, the drive transmission attachment 12115 of this embodiment functions as a coupling (attachment side coupling portion) engageable with the first main assembly side coupling 110, and has the function of transmitting the drive force to the toner cartridge C12.

With the above-described structure, similarly to Embodiment 1, it is possible to transmit the driving force from the printer main assembly A to the toner cartridge C12. By employing this structure, according to this embodiment, the engagement of each portion of the driving force transmission mechanism with the toner cartridge C12 is performed by way of the attachment. Therefore, the printer main assembly according to this embodiment reduces the number of points of direct contact with the toner cartridge which is replaced frequently, and can prevent fatigue and damage of the driving force transmission mechanisms such as couplings resulting from replacing the toner cartridge.

### Embodiment 13

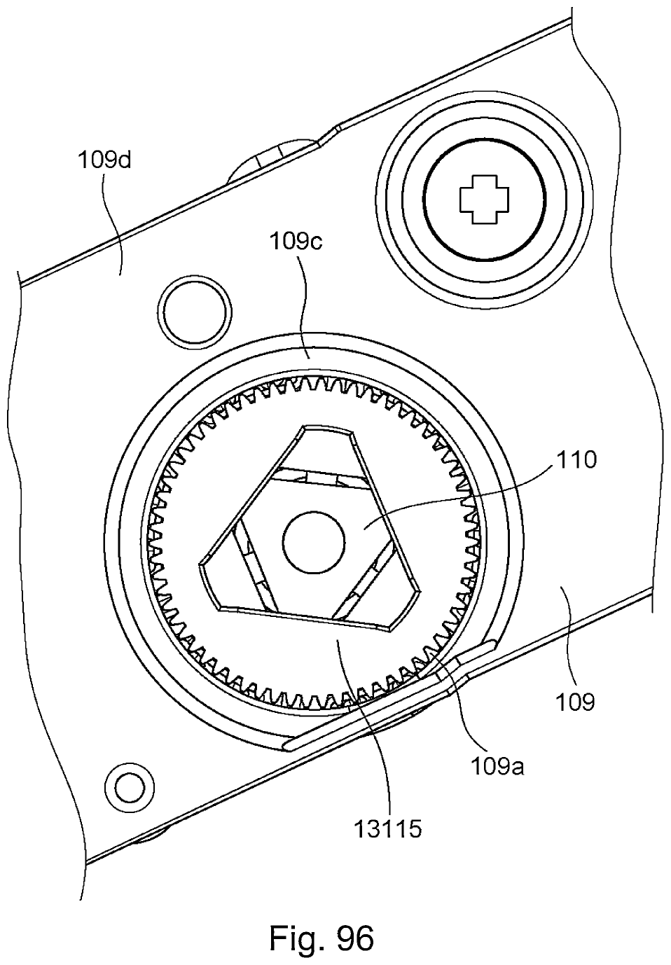

In the above-described Embodiment 1, the rotational drive of the printer main assembly A is transmitted to the toner cartridge C by the engagement between the first main assembly side pump coupling 110 and the pump-screw coupling portion 39a. In contrast, in this embodiment which will be described, referring to FIGS. 96 to 102, an attachment gear 13115 is mounted to the first main assembly side coupling 110, and the gear is used to transmit driving force to the pump-screw input gear portion 13039a. The same components as those in Embodiment 1 will be described with the same reference numerals and symbols as those in Embodiment 1. Furthermore, as for the toner cartridge, process cartridge, and printer main assembly, the components having the same functions and roles as those in Embodiment 1 are assigned the same names and like reference numerals and symbols.

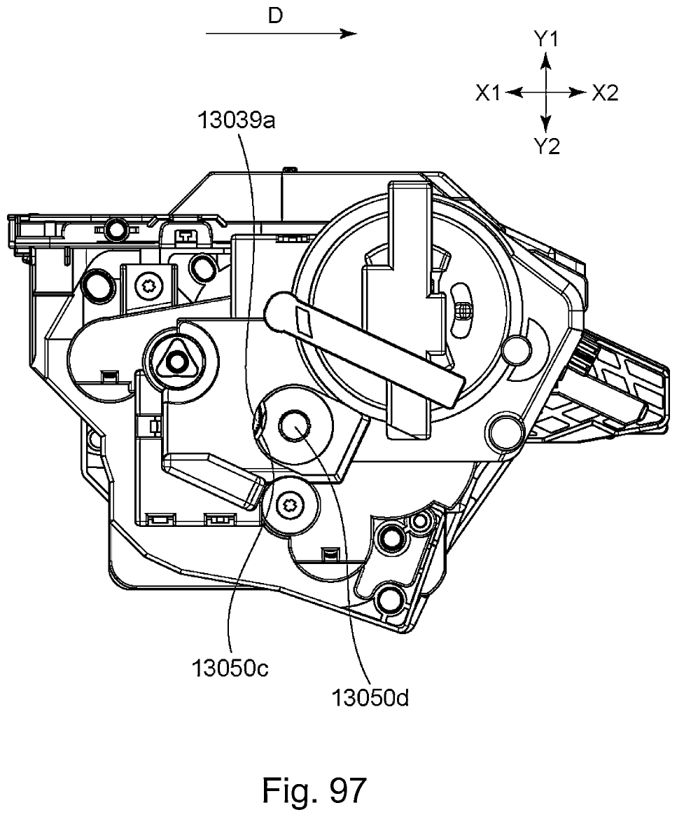

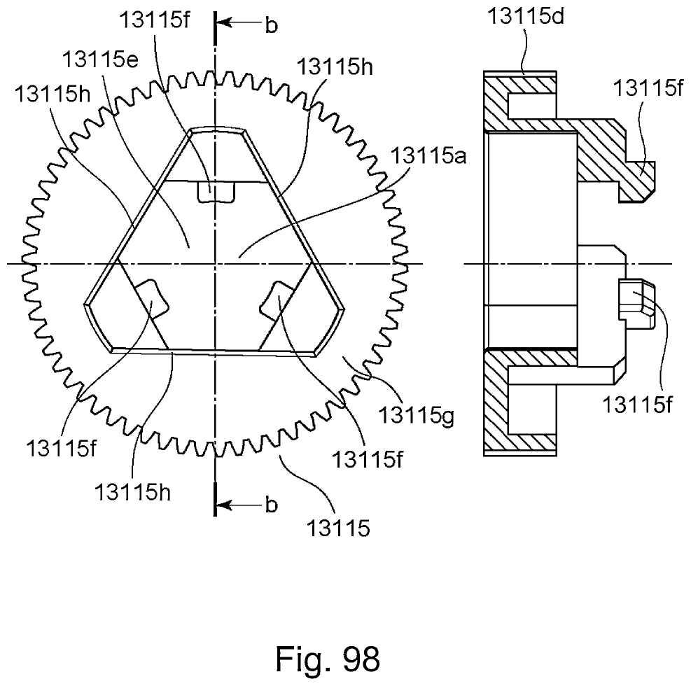

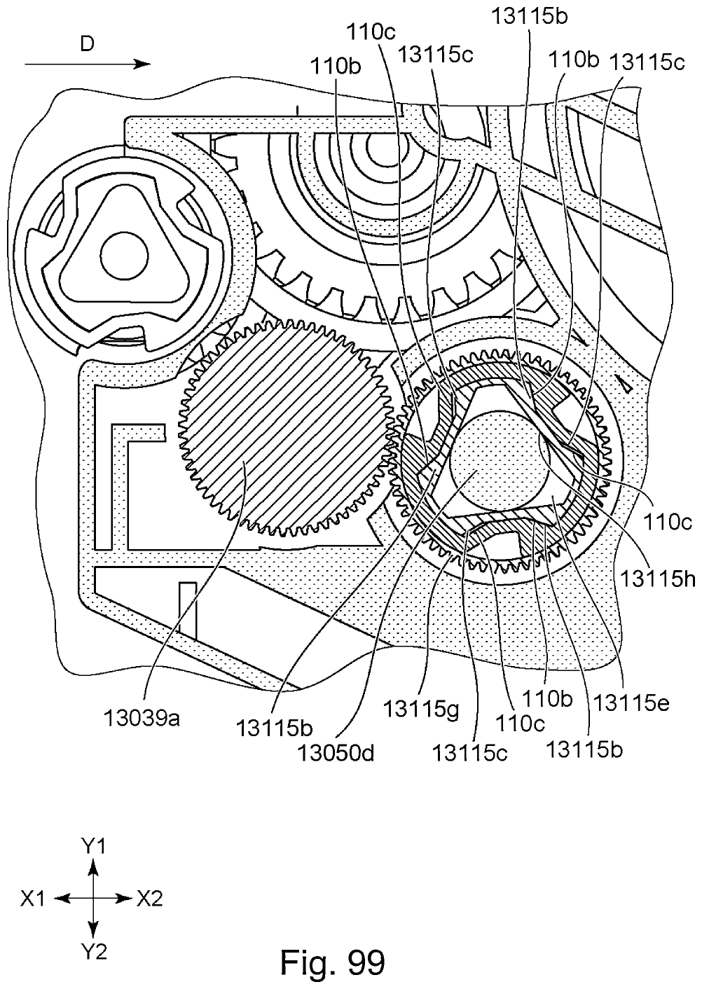

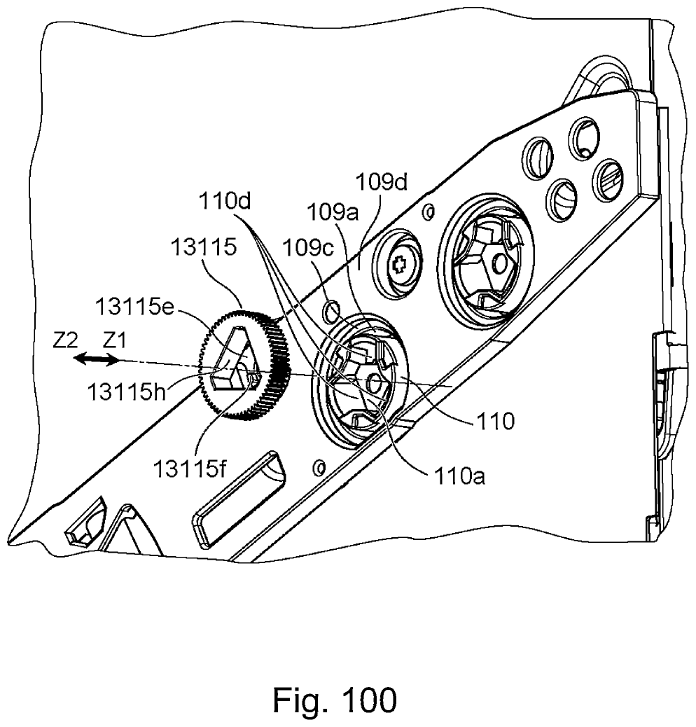

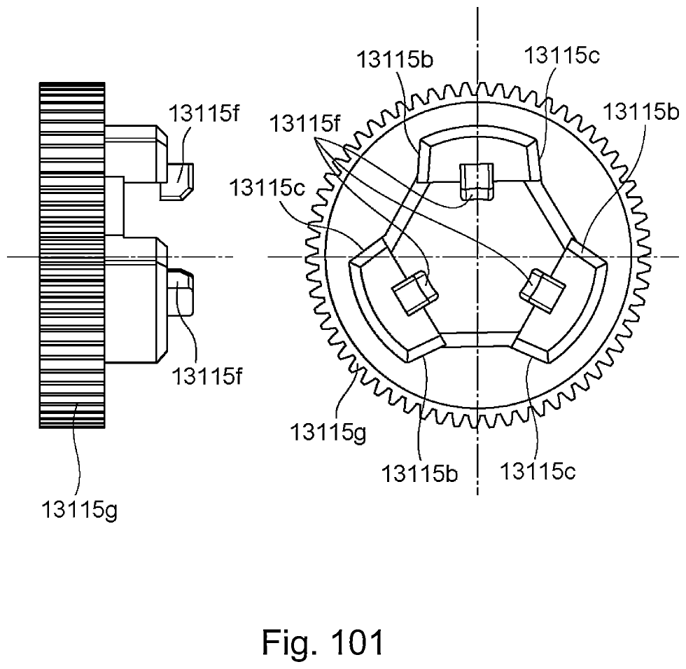

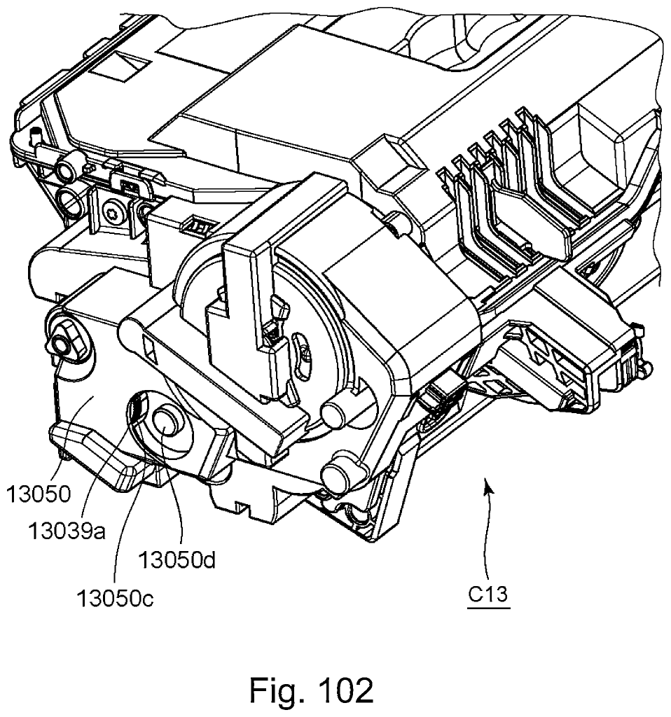

FIG. 96 is a detailed view illustrating the attachment gear 13115 according to Embodiment 13 of the present invention, the gear being mounted to the first main assembly side coupling 110. FIG. 97 is a side view of the toner cartridge C13 according to Embodiment 13 of the present invention, as viewed in a direction parallel to the Z axis. FIG. 98 is a detailed view of the attachment gear 13115 according to Embodiment 13 of the present invention. FIG. 99 is an illustration of an example of a drive transmission mechanism for transmission from the printer main assembly A to the toner cartridge C12 according to Embodiment 13 of the invention. FIG. 99 is a cross-sectional view (XY plane) of the first main assembly side coupling 110, the attachment gear 13115, and the pump-screw coupling portion 13039a taken along a direction perpendicular to the axis G. FIG. 100 is a view illustrating an example of a mounting method of each drive transmission mechanism according to Embodiment 13 of the present invention. FIG. 101 is a detailed view of the attachment gear 13115 according to Embodiment 13 of the present invention. FIG. 102 is an external perspective view of a toner cartridge C13 according to Embodiment 13 of the present invention.

As shown in FIG. 100, the attachment gear 13115 is a driving force transmission member according to this embodiment which is used when transmitting driving force from the printer main assembly A to the toner cartridge (C13) side. The attachment gear 13115 can be mounted to the first main assembly side coupling recess 110a of the first main assembly side coupling 110 in a direction parallel to the Z axis.

As shown in FIGS. 99 and 101, the attachment gear 13115 has a first drive receiving surface 13115b which abuts against the first drive transmitting surface 110b of the first main assembly side coupling 110 to receive the driving force. The attachment gear 13115 also has a second drive receiving surface 131115c which receives the drive force by abutting against the second drive transmitting surface 110c of the first main assembly side coupling 110. In FIG. 99, when the main assembly side coupling 110 rotates clockwise, the first drive receiving surface 13115b abuts against the first drive transmitting surface 110b. Furthermore, when the main assembly side coupling 110 rotates in the counterclockwise direction, the second drive receiving surface 13115c abuts against the second drive transmitting surface 110c. In this embodiment, in the XY plane when the first main assembly side coupling 110 is viewed from the side on which the drive transmission attachment 13115 is mounted, the clockwise rotation is defined as forward rotation and counterclockwise rotation is defined as backward rotation.

As shown in FIGS. 98 and 101, the attachment gear 13115 has a retaining shape 13115f. The retaining shape 13115f of the attachment gear 13115 can engage with a hole portion 110d provided in the first main assembly side coupling 110. When the attachment gear 13115 is mounted to the first main assembly side coupling recess 110a, the retaining shape 13115f is elastically deformed and is snap-fitted and fixed into the hole portion 110d. However, the method of fixing the attachment gear 13115 to the first main assembly side coupling 110 is not limited to this example, and it may be fixed by bonding or press fitting, for example.

Next, a method of transmitting the driving force from the first main assembly side coupling 110 to the toner cartridge C13 will be described. As shown in FIGS. 97 and 99, the toner cartridge C13 is provided with a pump-screw input gear 13039a, which is a driving force input member in the toner cartridge C13 of this embodiment. As shown in FIG. 102, the pump-screw input gear 13039a is provided with a drive side toner cartridge side cover 13050 on the outer side in the Z axis direction. A hole 13050c is provided in a part of the drive side toner cartridge side cover 13050 to uncover a part in the circumferential direction of the pump-screw input gear 13039a.

When the toner cartridge C13 is mounted in the printer main assembly A and the opening and closing opening/closing door 107 is closed, the first main assembly side coupling 110 and the attachment gear 13115 engage with each other and integrally project to the inside of the apparatus. At this time, the gear portion 13115g of the attachment gear 13115 meshes with the pump-screw input gear 13039a of the toner cartridge C13.

The attachment gear 13115 mounted to the first main assembly side coupling 110 rotates when the first drive receiving surface 13115b or the second drive receiving surface 131115c receives a driving force from the first main assembly side coupling 110. In addition, a gear portion 13115g of the attachment gear 13115 meshes with a pump-screw input gear portion 13039a of the toner cartridge C13, so that the driving force is transmitted from the printer main assembly A to the toner cartridge C13.

As shown in FIGS. 97 and 99, the drive side toner cartridge side cover 13050 is provided with a positioning boss 13050d for positioning the attachment gear. The distance between the center of the positioning boss 13050d and the center of the pump-screw input gear portion 13039a is set to be equal to the distance between the center of the attachment gear 13115 and the center of the pump-screw input gear portion 13039a after the engagement. As shown in FIGS. 98 to 100, the attachment gear 13115 is provided with a central contact surface 13115h and a central hole portion 13115e. More specifically, in this embodiment, as viewed along the rotation axis of the attachment gear 11039, a triangular prism-shaped central hole portion 13115e is formed as an area surrounded by a plurality of central abutment surfaces 13115b. The center of the central hole portion 13115e is aligned with the central axis of rotation of the attachment gear portion 13115g.

When the attachment gear 13115 meshes with the pump-screw input gear 13039a, the central hole 13115e abuts against the positioning boss 13050d. Therefore, the center of rotation of the attachment gear 13115 and the positioning boss 13050d are positioned coaxially. With this structure, the axial distance between the attachment gear 13115 and the pump-screw input gear 13039a can be maintained with high precision, and the meshing precision of the gears is stabilized, thereby improving the precision of drive transmission.

Next, as shown in FIGS. 96 and 100, the outer periphery of the hole portion 109a of the second guide portion 109 has a recess 109c which is one step lower in height in the direction parallel to the Z axis than a reference surface 109d of the second guide portion 109 in the direction of the rotational axis of the first main assembly side coupling 110.

As shown in FIG. 100, when the opening/closing opening/closing door 107 is open and the first main assembly side coupling 110 is retracted in the Z1 direction, the first main assembly side coupling 110 projects beyond the recess 109c and retracts in the Z1 direction beyond the reference surface 109d of the second guide portion 109.

Here, it is desirable that the outer periphery of the gear portion 13115g of the attachment gear 13115 is smaller than the inner periphery of the recess 109c as viewed in the Z-axis direction, and that a part of the attachment gear 13115 is accommodated inside the recess 109c as viewed in a direction perpendicular to the Z-axis. The details thereof will be described hereinafter.

As shown in FIGS. 97 and 99, the pump-screw input gear 13039a is disposed upstream of the attachment gear 13115 in the mounting direction D of the toner cartridge C13. With this structure, even if the attachment gear 13115 projects beyond the second guide portion 109 toward the outside of the apparatus when the opening/closing door 107 is opened, the attachment gear 13115 does not interfere with the toner cartridge C13, and the toner cartridge C13 can be mounted and dismounted.

Also, as described above, since the outer diameter of the gear portion 13115g is smaller than the inner diameter of the recess 109c, a part of the retracted attachment gear 13115 can be accommodated inside the recess 109c, when the opening and closing opening/closing door 107 is opened. With this structure, the amount of projection of the attachment gear 13115 through the second guide 109 toward the toner cartridge C13 (that is, toward the inside of the printer main assembly A) can be reduced. Therefore, in this embodiment, the interference between the process cartridge B and the attachment gear 13115 is prevented, and the process cartridge B can be mounted and dismounted without removing the attachment gear 13115 from the first main assembly side coupling 110.

The timing of mounting the attachment gear 13115 to the printer main assembly A is not limited to such an example. For example, the attachment gear 13115 may be mounted after the process cartridge B is mounted in the printer main assembly A, and then the toner cartridge C13 may be mounted. In this case, there arises no such interference with the attachment gear 13115 when the process cartridge B is mounted to or dismounted from the printer main assembly A, as described above, it is possible to make the attachment gear 131115 larger. In other words, the printer main assembly A and the attachment gear 13115 according to this embodiment do not need to employ a structure in which a part of the attachment gear 13115 is accommodated inside the recess 109c. For example, the attachment gear 13115b and the first main assembly side coupling 110 may be structured to engage with each other at a position more inside of the apparatus than the reference surface 109d of the second guide portion 109.

With the above-described structure, similar to Embodiment 1, it is possible to transmit driving force from the printer main assembly A to the toner cartridge C13. Also, similarly to Embodiment 12 described above, according to this embodiment, the engagement of portions of the driving force transmission mechanism with the toner cartridge C13 is performed by way of an attachment. Therefore, the printer main assembly according to this embodiment reduces the number of points of direct contact with the toner cartridge which is replaced frequently, and can prevent fatigue and damage of driving force transmission mechanisms such as couplings resulting from replacing the toner cartridge.

### Embodiment 14

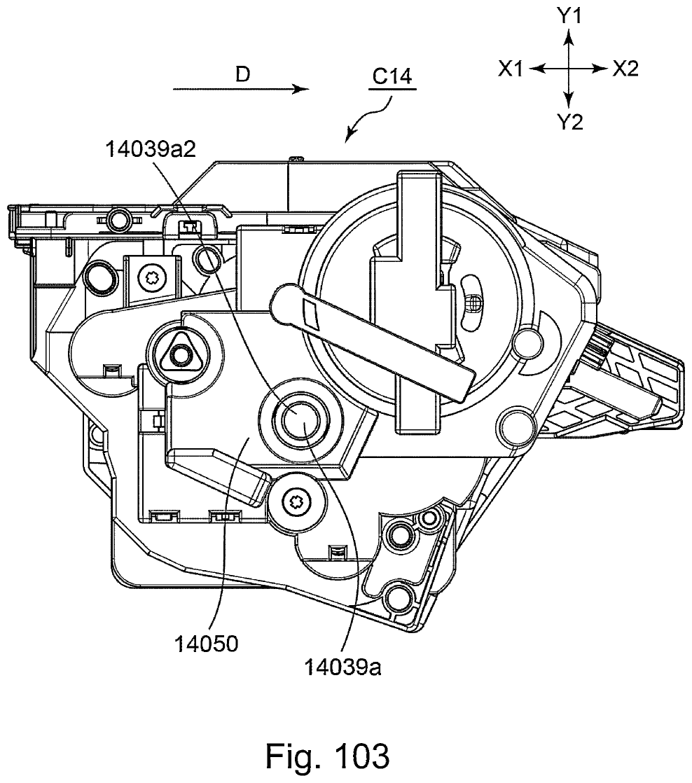

In the above-described Embodiment 1, the structure has been described in which the drive force is transmitted by the engagement between the engagement surfaces of the pump-screw coupling portion 39a and the first main assembly side coupling 110. In contrast, in this embodiment, a pump-screw coupling portion 14039a formed from a material including rubber elasticity as a drive input member comes into contact with the first main assembly side coupling 110 on the printer main assembly A side to receive the drive force. Referring to FIGS. 103 to 106, specific description will be made. The same components as those in Embodiment 1 will be described with the same reference numerals and symbols as those in Embodiment 1. Furthermore, as for the toner cartridge, the process cartridge, and the printer main assembly, the components having the same functions and roles as those in Embodiment 1 are given the same names and like reference numerals and symbols.

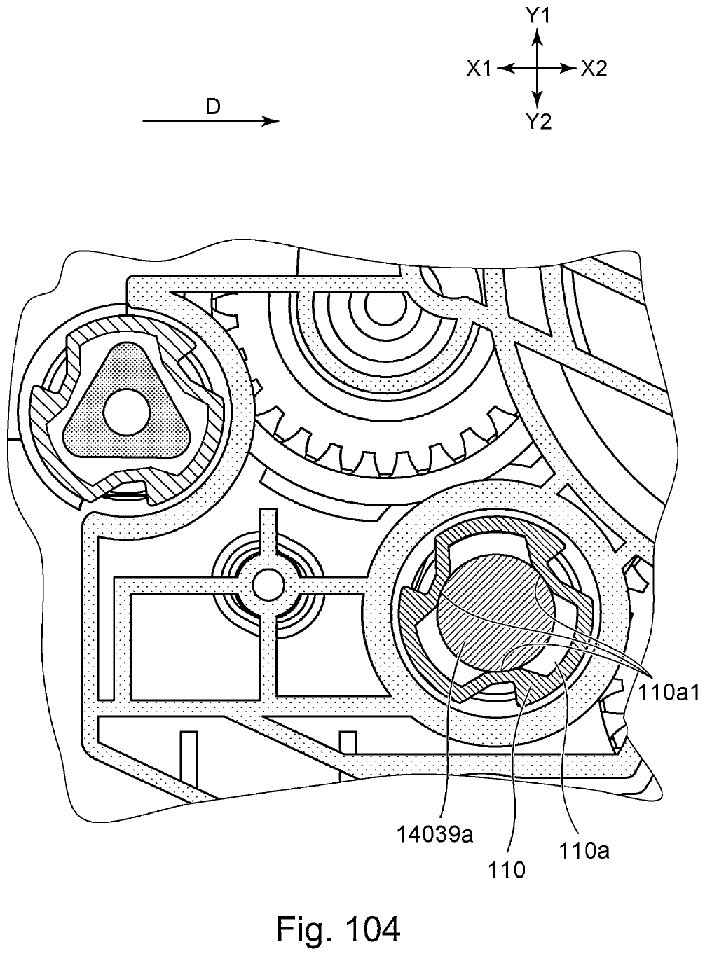

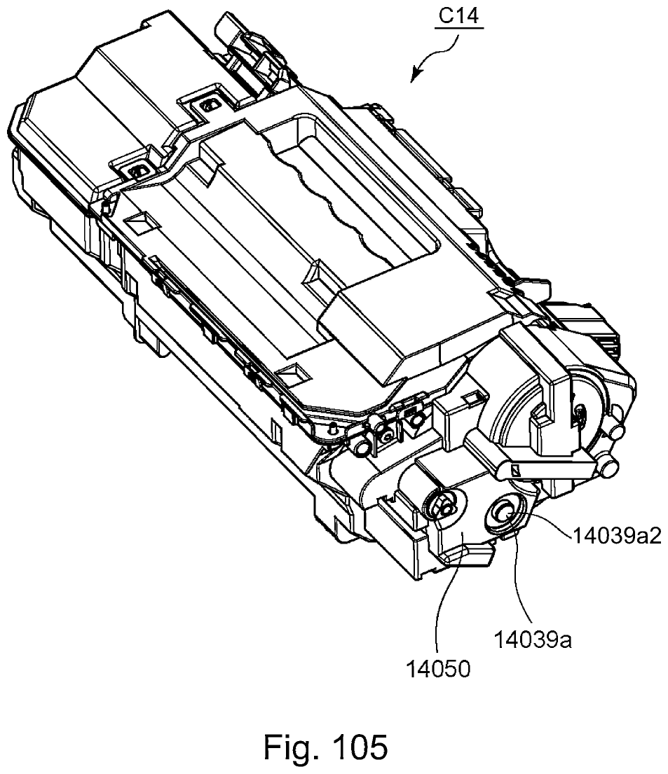

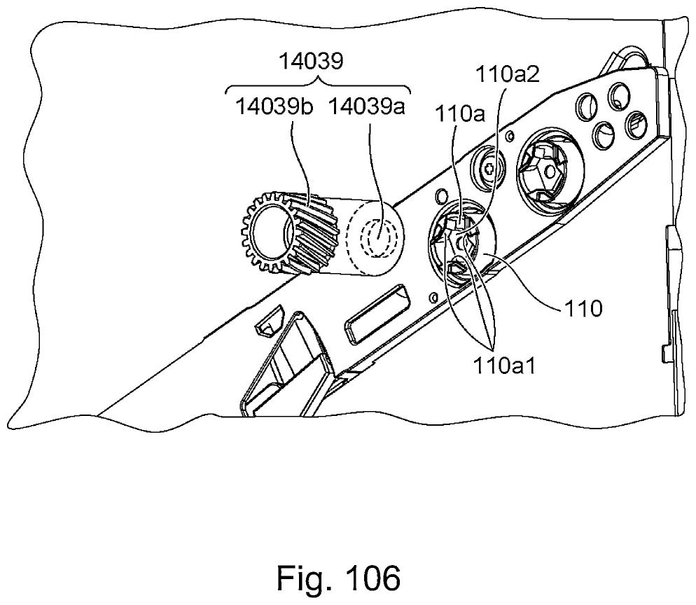

FIG. 103 is a side view of the toner cartridge C14 according to Embodiment 14 of the present invention, showing the toner cartridge C14 as viewed from the side facing the pump-screw coupling portion 14039a along the Z axis. FIG. 104 is an illustration of an example of the drive transmission mechanism from the printer main assembly A to the toner cartridge C14 side in Embodiment 14 of the present invention, and is a cross-sectional view taken along the XY plane perpendicular to the rotation axis G of the pump-screw coupling portion 14039a. FIG. 105 is an external perspective view of a toner cartridge C14 according to Embodiment 14 of the present invention. FIG. 106 is an illustration of an example of a method of engagement between the first main assembly side pump coupling 110 and the pump-screw drive input portion 14039 according to Embodiment 14 of the present invention.

As shown in FIGS. 103, 105 and 106, the pump-screw drive input portion 14039 includes the pump-screw coupling portion 14039a and a drive transmission portion 14039b. The pump-screw coupling portion 14039a according to this embodiment is formed of an elastic material such as rubber or elastomer having so-called rubber elasticity. Due to the rubber elasticity, the pump-screw coupling portion 14039a deforms when it comes into contact with the first main assembly side coupling 110, and the contact state between the two is maintained by the frictional force of the contact surfaces.

As shown in FIG. 105, a drive side cover 1450 is provided on the side surface (Z1 direction) of the toner cartridge C14. The pump-screw drive input portion 14039a has a cylindrical shape projecting from this drive side cover 1450. The shape of the pump-screw drive input portion 14039a is not limited to a cylindrical shape, but may be a member having a polygonal cross-section, for example, and the free end may be pointed rather than flat.

The drive transmission portion 14039b is made of a material such as a resin material or a metal material, and transmits the drive force received by the pump-screw coupling portion 14039a to the pump unit 37 and the toner accommodating portion screw member 35.

The pump-screw coupling portion 14039a and the drive transmission portion 14039b may be fixed to each other by two-color molding, clamping, press fitting, or the like, as long as they are structured to be rotatable integrally to transmit a rotational drive force.

Next, referring to FIGS. 104 and 106, a method of transmitting driving force using the pump-screw drive input portion 14039 and the first main assembly side coupling 110 will be described. As shown in FIG. 104, in the state where the pump-screw coupling portion 14039a is inserted into the main assembly side coupling recess 110a, the pump-screw coupling portion 14039a contacts the side wall 110al of the main assembly side coupling recess 110a. Alternatively, a structure in which the free end portion 14039a2 of the pump-screw coupling portion 14039a and the bottom portion 110a2 of the first main assembly side coupling 110 contact each other may be used as shown in FIGS. 105 and 106.

Here, the pump-screw coupling portion 14039a has an outer diameter dimension selected so as to satisfy a slight press-fit relationship with the side wall 110a1. In this embodiment, the pump-screw coupling portion 14039a is made of urethane rubber having a diameter of 8.6 mm, the main assembly pump coupling 110 is made of polyacetal resin, and the main assembly side coupling recess 110a has an inscribed circle having a diameter of 8.38 mm. The material and dimensions of the pump-screw coupling 14039a and the main assembly pump coupling 110 are not limited to such examples, as long as they can transmit the rotational drive of the printer main assembly A to the toner cartridge C.

According to the structure described above, similarly to Embodiment 1 described in the foregoing, it is possible to transmit driving force from the printer main assembly A to the toner cartridge C14. In addition, in this embodiment, since the pump-screw coupling 14039a has rubber elasticity, it is possible to prevent damage to the pump-screw coupling 14039a at the time when the toner cartridge C14 is mounted or dismounted, for example.

### Embodiment 15

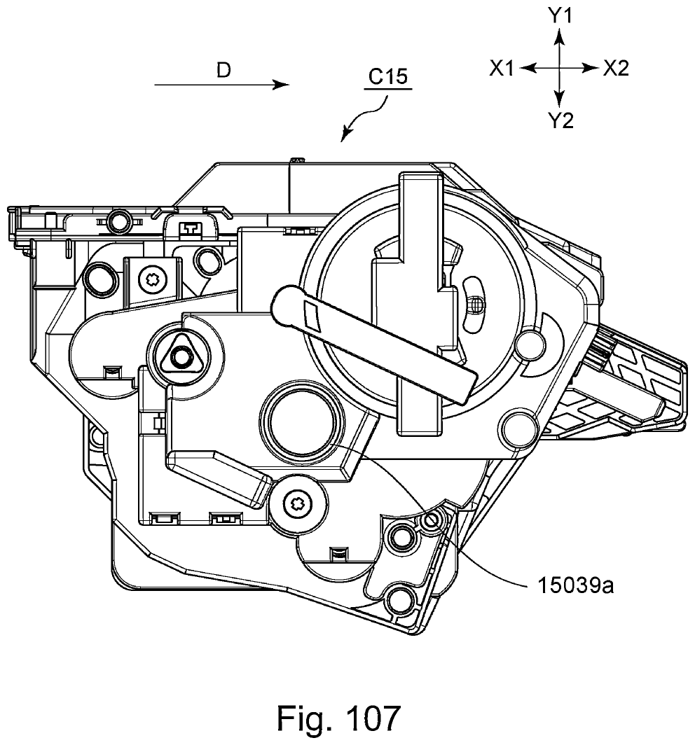

In the above-described Embodiment 14, the case has been described in which the pump-screw coupling portion 14039a having the rubber elasticity is inserted into the main assembly side coupling recess 110a provided in the printer main assembly A. In contrast, this embodiment will be described, referring to FIGS. 107 to 110, in which the toner cartridge C15 is provided with a pump-screw drive input portion 15039 having an inner surface larger than the outer circumferential part of the first main assembly side coupling 110. The same components as those in Embodiment 14 described in the foregoing will be described with the same reference numerals and symbols as those in Embodiment 1. In addition, as for the toner cartridge, the process cartridge, and the printer main assembly, the components having the same functions and roles as those in Embodiment 1 are given the same names and like reference numerals and symbols.

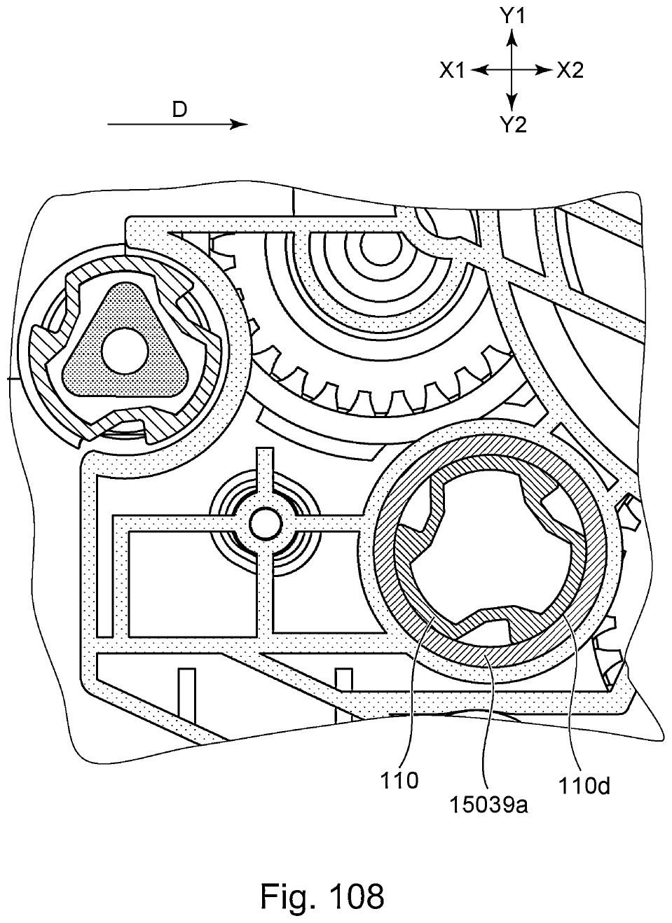

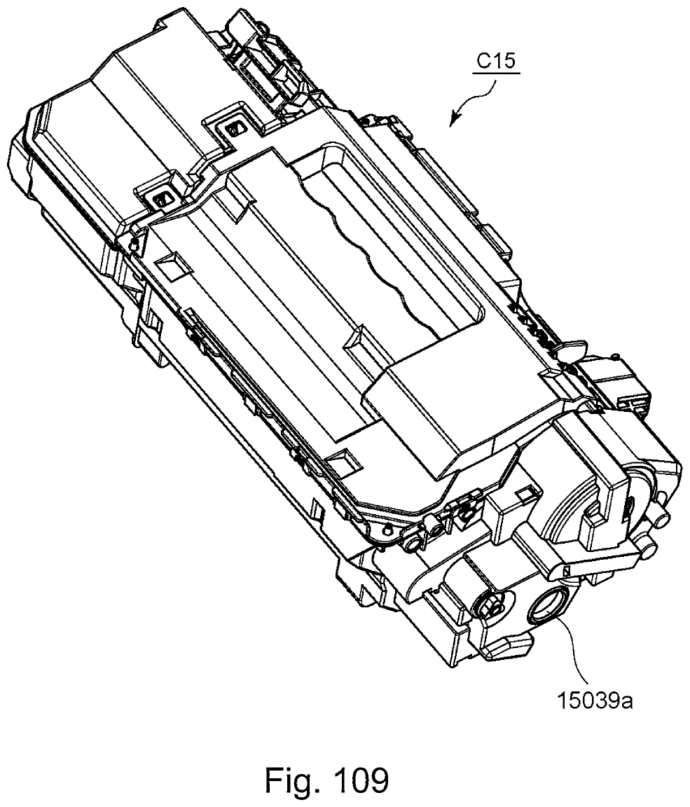

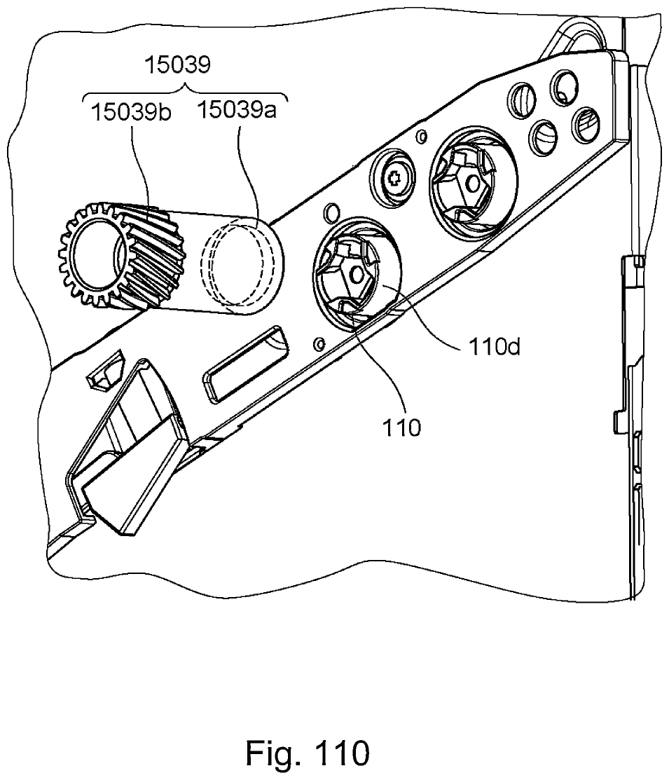

FIG. 107 is a side view of the toner cartridge C15 according to Embodiment 15 of the present invention, showing the toner cartridge C15 as viewed from the side facing the pump-screw coupling portion 15039a along the Z axis. FIG. 108 is an illustration of an example of the drive transmission mechanism for transmission from the printer main assembly A to the toner cartridge C15 side in Embodiment 15 of the present invention, and is a cross-sectional view taken along the XY plane perpendicular to the rotation axis G of the pump-screw coupling portion 15039a. FIG. 109 is an external perspective view of a toner cartridge C15 according to Embodiment 15 of the present invention. FIG. 110 is an illustration for exemplarily explaining a method of engagement between the first main assembly side pump coupling 110 and the pump-screw drive input portion 15039 according to Embodiment 15 of the present invention.

As shown in FIGS. 107, 109 and 110, the pump-screw drive input portion 15039 includes the pump-screw coupling portion 15039a and a drive transmission portion 15039b. The pump-screw coupling portion 15039a according to this embodiment is formed of an elastic material such as rubber or elastomer having so-called rubber elasticity. Because of the provision of rubber elasticity, the first main assembly side coupling 110 can be inserted into the pump-screw coupling portion 15039a while deforming. In the inserted state, the contact state between the inner circumferential portion 15039a1 of the pump-screw coupling 15039a and the outer circumferential portion 110e of the first main assembly side coupling 110 is maintained by the frictional force between the contact surfaces thereof.

As shown in FIG. 109, a drive side cover 1550 is provided on the side (Z1 direction) of the toner cartridge C15. The pump-screw drive input portion 15039a is formed as a circular portion uncovered by this drive side cover 1550. The shape of the pump-screw drive input portion 15039a is not limited to a circular shape, and may be a member having a polygonal cross-section, for example. In addition, the cross-section of the pump-screw drive input portion 15039a may be such that the free end projecting inward only at the contact point with the first main assembly side coupling 110 is sharp rather than flat. In addition, the pump-screw drive input portion 15039a may be cylindrical and project from the drive side cover 1550.

The drive transmission portion 15039b is made of a material such as a resin material or a metal material, and transmits the drive force received by the pump-screw coupling portion 15039a to the pump unit 37 and the toner accommodating portion screw member 35.

The pump-screw coupling portion 15039a and the drive transmission portion 15039b may be fixed to each other by two-color molding, clamping, press fitting, or the like, as long as they are structured to be rotatable integrally and transmit a rotational drive force.

Next, referring to FIGS. 108 and 110, a method for transmitting driving force using the pump-screw drive input portion 15039 and the first main assembly side coupling 110 will be described. As shown in FIG. 108, when transmitting driving force from the printer main assembly A to the toner cartridge C15, the outer circumferential portion 110e of the first main assembly side coupling 110 is inserted into the inner circumferential portion 15039a1 of the pump-screw coupling portion 15039a. In this state, as described above, the contact state between the first main assembly side coupling 110 and the pump-screw drive input portion 15039 is maintained. To achieve this structure, the inner circumferential portion 15039a1 of the pump-screw coupling portion 15039a in this embodiment has an inner diameter dimension which provides a light press-fit relationship with the outer circumferential portion 110e of the first main assembly side coupling 110.

In this embodiment, the pump-screw coupling portion 15039a is made of urethane rubber with an inner circumferential portion 15039a1 having a diameter of 15.3 mm, and the first main assembly side coupling 110 is made of polyacetal resin with an outer circumferential portion 110e having a diameter of 15.6 mm. The material and dimensions of the pump-screw coupling 15039a and the main assembly pump coupling 110 are not limited as long as they can transmit the rotational drive of the printer main assembly A to the toner cartridge C.

With the structure described above, similarly to Embodiment 1, it is possible to transmit driving force from the printer main assembly A to the toner cartridge C15. In addition, in this embodiment, since the pump-screw coupling 15039a has rubber elasticity, it is possible to prevent damage to the pump-screw coupling 15039a when the toner cartridge C15 is mounted or dismounted, for example.

### Embodiment 16

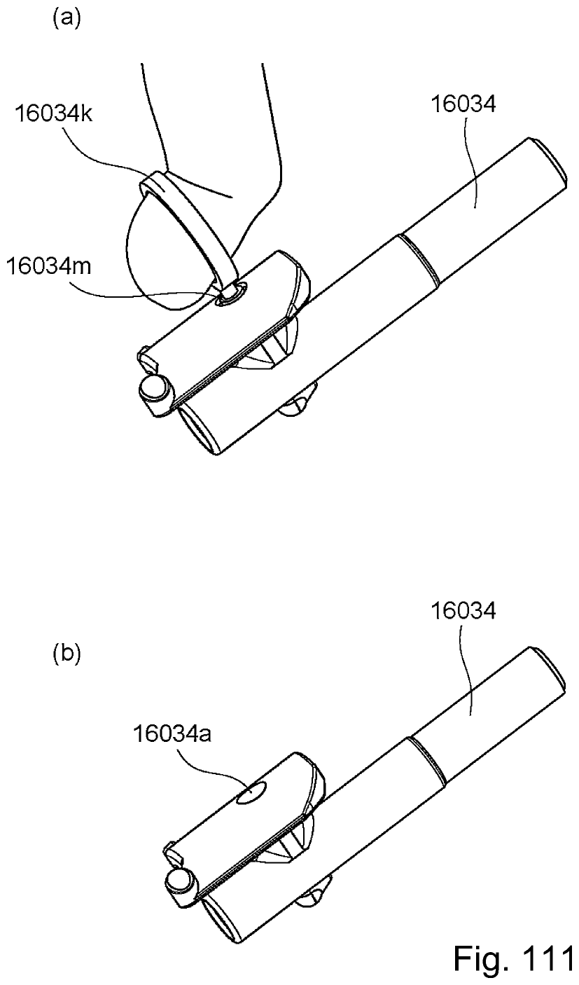

In Embodiment 1, the shutter member (toner feeding member) 34 is provided with the toner discharge opening 34a for discharging the toner. In contrast, in this embodiment, the toner discharge opening is formed in a toner feeding member by a user operation, for example, and the description will be made, referring to FIG. 111,., the same components as those in Embodiment 1 will be described with the same reference numerals and symbols as those in Embodiment 1. In addition, as for the shutter member 16034 according to this embodiment, members including the same functions and roles as those in Embodiment 1 are given the same names and like reference numerals and symbols.

FIG. 111 is an illustration for illustratively explaining a shutter member 16034 which is a toner feeding member according to Embodiment 16 of the present invention. Part (a) of FIG. 111 is an external perspective view of the shutter member 16034 before the toner discharge opening 16034a is formed (i.e., before the pull tab portion 16034k is removed). Part (b) of FIG. 111 is a perspective view of the exterior of the shutter member 16034 after the toner discharge opening 16034a has been formed (i.e., after the pull tab portion 16034k is removed).

As shown in part (a) of FIG. 111, the shutter member 16034 according to this embodiment is provided with a pull tab portion (removal member) 16034k which can be removed from the shutter member 16034 by manual operation by the user. A groove portion 16034m is provided at the base portion of the shutter member 16034 where the pull tab portion 16034k is provided so as to surround the pull tab portion 16034k.

As shown in part (a) of FIG. 111, the user can hook a finger or the like on the pull tab portion 16034k of the shutter member 16034. Then, from this state, by pulling the pull tab portion 16034k in the direction away from the shutter member 16034, the pull tab portion 16034k can be broken off and removed from the shutter member 16034 at the groove portion 16034m.

Then, as shown in part (b) of FIG. 111, the pull tab portion 16034k is removed from the shutter member 16034, so that a toner discharge opening 16034a is provided in the shutter member 16034 as a broken surface.

With the above-described structure, the shutter member 16034 according to this embodiment forms a toner discharge opening when the toner is to be discharged, and is capable of discharging the toner in the same manner as the shutter member 34 according to Embodiment 1. Before the cartridge is used, the toner discharge opening is closed by the pull tab portion 16034k, thereby keeping the toner cartridge sealed.

### Embodiment 17

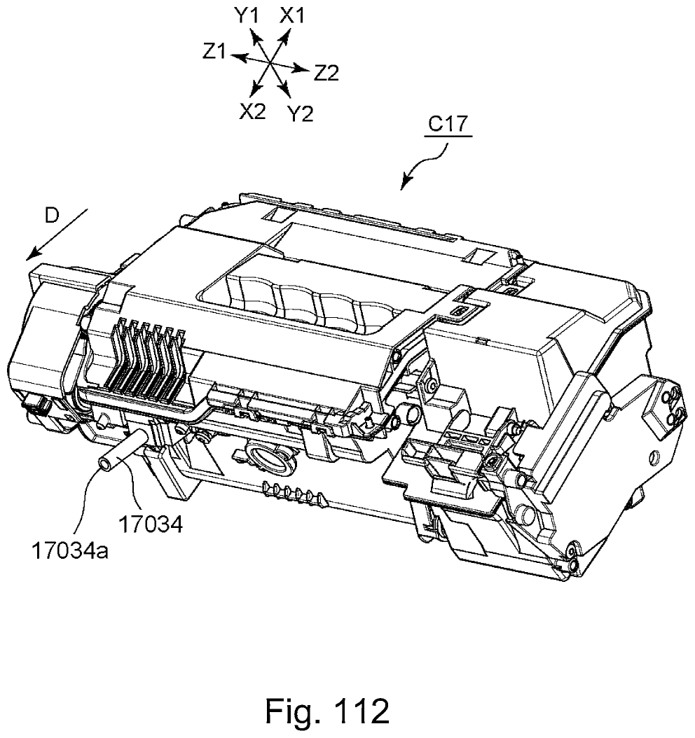

In the above-described Embodiment 1, the case has been described in which toner is fed from the toner cartridge side to the process cartridge side by using the shutter member (toner feeding member) 34 which operates in interrelation with the receiving side shutter member provided on the process cartridge side. In contrast, in this embodiment, a flexible toner feeding member 17034 provided on toner cartridge C17 is capable of conveying toner by deforming in interrelation with an attachment member 17070 which can be mounted to process cartridge B17. Referring to FIGS. 112 to 116, a specific explanation will be made below. The same components as those in Embodiment 1 will be described with the same reference numerals and symbols as those in Embodiment 1. In addition, as for the toner cartridge, process cartridge, and printer main assembly, the components having the same functions and roles as those in Embodiment 1 are assigned the same names and like reference numerals and symbols.

FIG. 112 is an external perspective view of a toner cartridge C17 according to Embodiment 17 of the present invention. As shown in FIG. 112, the toner cartridge C17 is provided with a toner feeding member 17034. The toner feeding member 17034 is a flexible cylindrical member which projects from the toner cartridge C17 in the mounting direction D (that is, the X2 direction) with the opening of the cylindrical shape facing toward the outside. The toner feeding member 17034 is made of a flexible silicone rubber. The toner feeding member 17034 may be made of any material that is elastically deformable, but a material that is not easily deformed due to temperature is preferable.

A toner discharge opening 17034a is provided at an end of the toner feeding member 17034 in the mounting direction D (i.e., X2 direction). In addition, a toner seal (not shown) is mounted on the inside of the container of the toner feeding member 17034, and when it is pulled off by the driving force from the printer main assembly A, the toner accommodated inside the toner cartridge C17 can be discharged through the toner discharge opening 17034a.

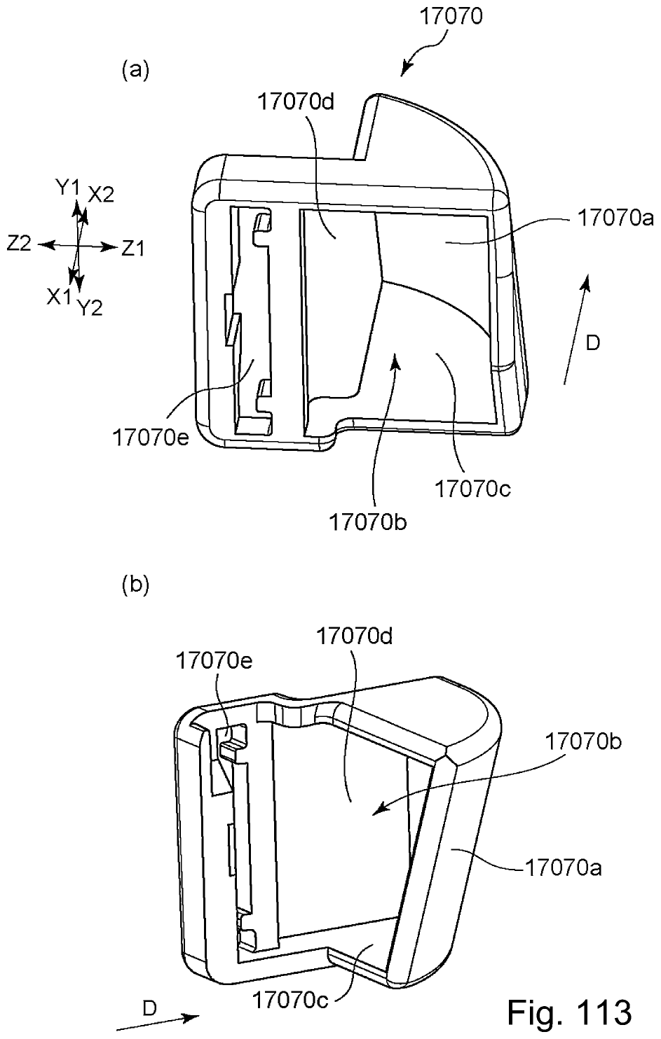

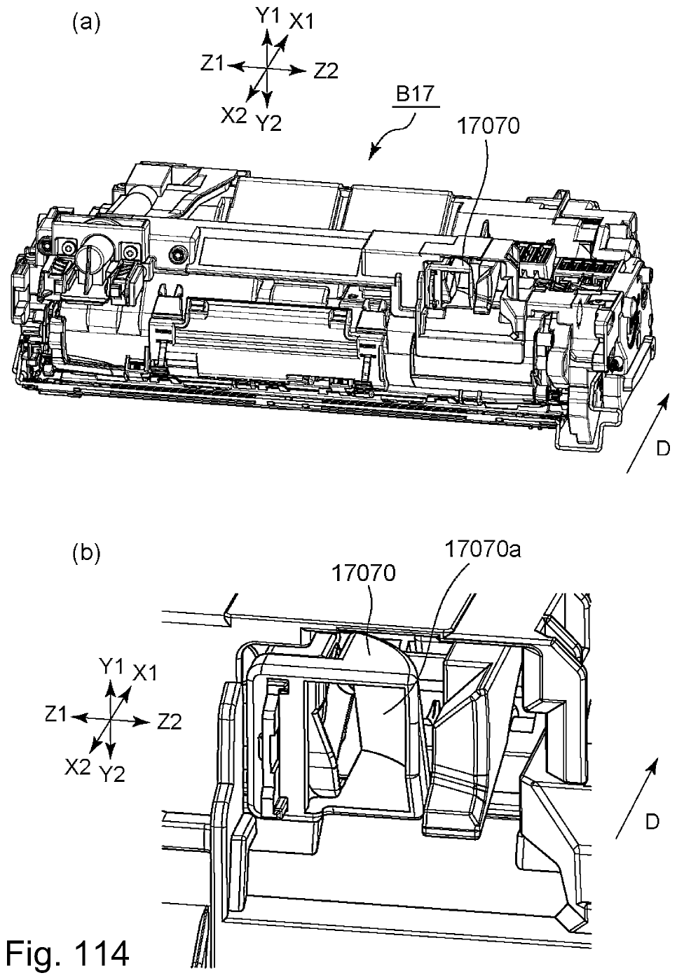

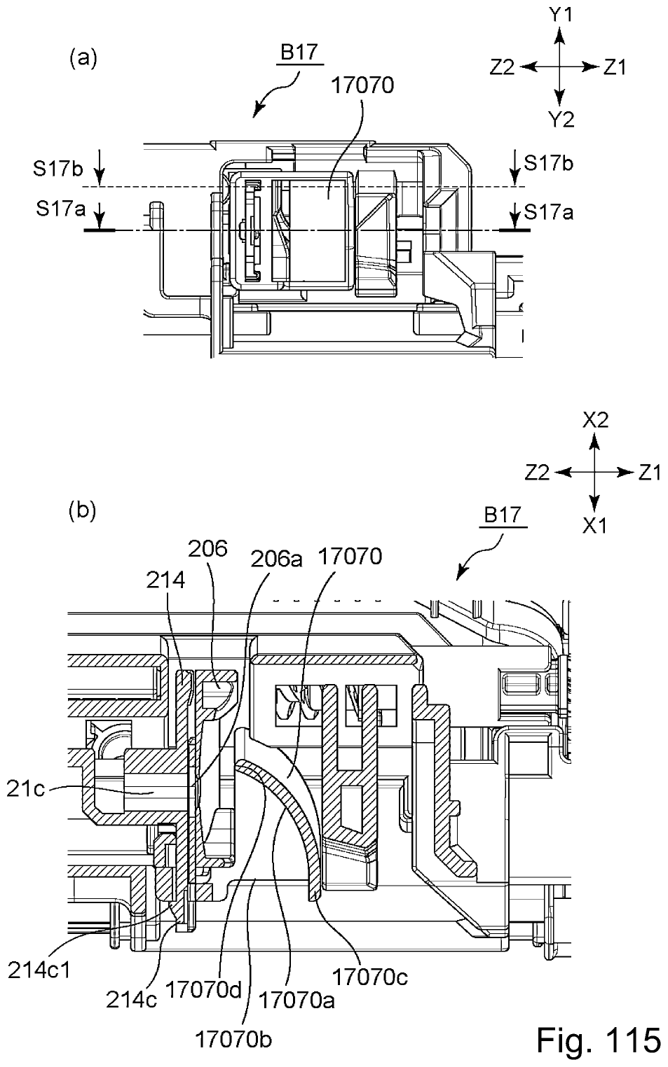

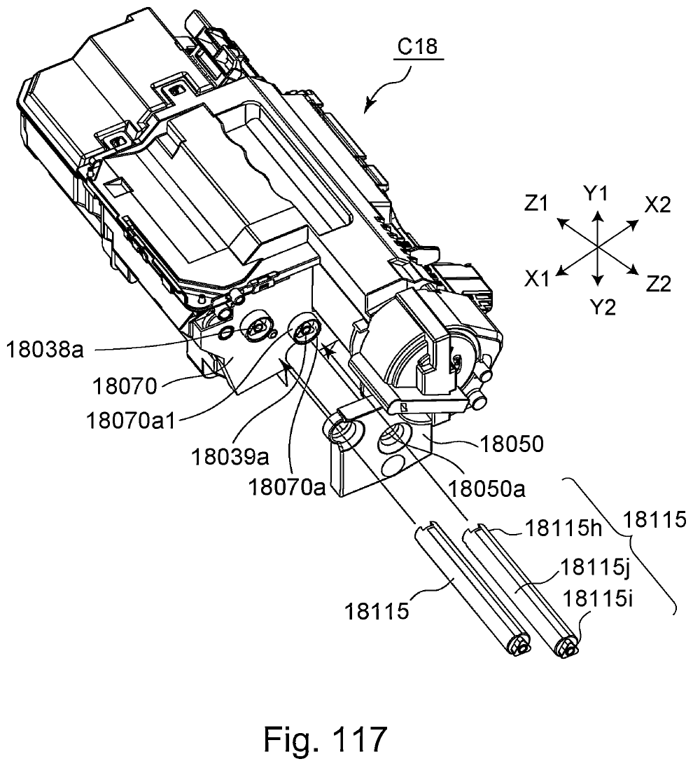

Next, the structure of the process cartridge B17 according to this embodiment will be described. FIG. 113 is an external perspective view of an attachment member 17070 according to Embodiment 17 of the present invention. Part (a) of FIG. 113 is an external perspective view of the attachment member 17070 as viewed in the X2 direction from a side facing the first opening 17070c. Part (b) of FIG. 113 is an external perspective view of the attachment member 17070 as viewed in the Z2 direction from a side facing the second opening 17070d. FIG. 114 is a view for exemplarily explaining the process cartridge B17 according to Embodiment 17 of the present invention. Part (a) of FIG. 114 is an external perspective view of the process cartridge B17 after the attachment member 17070 is mounted. Also, part (b) of FIG. 114 is an enlarged view of the attachment member 17070 mounted to the process cartridge B17. FIG. 115 is an illustration of details of an attachment member 17070 according to Embodiment 17 of the present invention. Part (a) of FIG. 115 is a side view of the neighborhood of the attachment member 17070 of the process cartridge B17 after the attachment member 17070 is mounted. Part (b) of FIG. 115 is a sectional view of the S17a-S17a section shown in part (a) of FIG. 117.

As shown in part (a) of FIG. 113 and part (b) of FIG. 113, the attachment member 17070 is provided with a first through hole 17070b extending from the X1 direction side to the X2 direction side. The first through hole 17070b has a first opening 17070c opening in the X1 direction and a second opening 17070d opening in the Z2 direction. In addition, the first through hole 17070b is provided with a generally arc-shaped inclined portion 17070a at the X2 direction end of the opening 17070c. More specifically, the inclined portion 17070a is formed in an arc shape which connects the first opening 17070c and the second opening 17070d with each other. Further, a second through hole 11070e which opens in the mounting direction D is provided on the attachment member 17070 on the Z2 side of the first opening 17070c.

As shown in FIG. 114, the attachment member 17070 can be mounted to the process cartridge B17 in the mounting direction D (i.e., the X2 direction). When removing the attachment member 17070 from the process cartridge B17, the attachment member 17070 can be removed from the process cartridge B17 in the X1 direction.

As shown in part (b) of FIG. 115, the rail portion 214c of the toner flow passageway member 214 provided in the process cartridge B17 is inserted into the second through hole 17070e of the attachment member 17070. At this time, the attachment member 17070 is moved integrally with the receiving side shutter member 206 which is fitted into the rail portion 214c, by pushing it in the mounting direction D against the urging force of the coil spring 213 described in the foregoing in Embodiment 1. When the attachment member 17070 is further pushed in, the attachment member 17070 is urged in the X1 direction by the urging force of the coil spring 213 until it abuts against the restricting portion 214cl, completing the attachment to the process cartridge B17.

In this state, the receiving side shutter member 206 abuts against the attachment member 17070 in the X1 direction by the urging force of the coil spring 213, and the communication opening 206a is positioned facing the supply opening 21c of the stay 21. That is, in this state, the communication opening 206a of the receiving side shutter member 206 is in fluid communication with the supply opening 21c of the stay 21. In addition, in this state, the second opening 17070d of the attachment member 17070 is disposed facing the supply opening 21c.

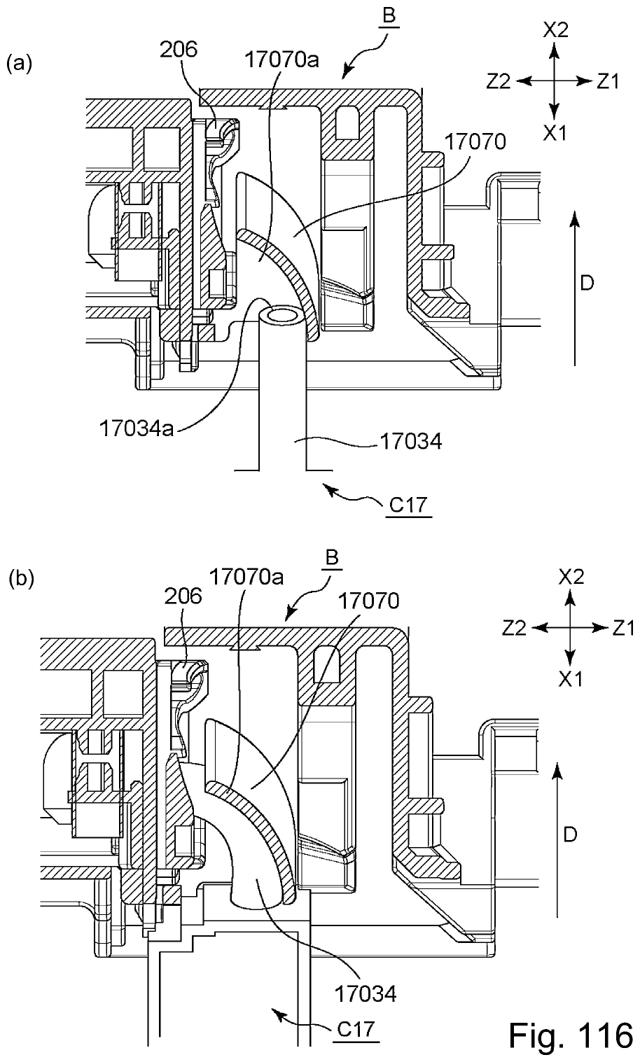

Next, the operation of mounting the toner cartridge C17 according to this embodiment into the process cartridge B17 will be described. FIG. 116 is an illustration for exemplarily explaining the operation when the toner cartridge C17 according to Embodiment 17 of the present invention is mounted on the process cartridge B17. Part (a) of FIG. 116 is a sectional view taken along the XZ plane in the process of mounting the toner cartridge C17 to the process cartridge B17, and is a sectional view taken along a line S17b-S17b shown in part (a) of FIG. 115. Part (b) of FIG. 116 is a sectional view taken along the XZ plane showing the state in which the mounting of the toner cartridge C17 to process cartridge B17 is completed, and is a sectional view taken along a line S17b-S17b shown in part (a) of FIG. 115.

As shown in part (a) of FIG. 116, when the toner cartridge C17 is moved and mounted in the mounting direction D relative to the process cartridge B17, the toner feeding member 17034 deforms while contacting an arcuate portion 17070a of the attachment member 17070. Then, when the mounting of the toner cartridge C17 into the process cartridge B17 is completed, as shown in part (b) of FIG. 116, the toner feeding member 17034 deforms and the toner discharge opening 17034a faces in the Z2 direction. In other words, the direction in which the toner discharge opening 17034a faces when the toner cartridge C17 begins to be mounted to the process cartridge B17 (the central axis of the opening) and the direction in which the toner discharge opening 17034a faces when the mounting is completed are perpendicular to each other. Thereafter, the toner discharge opening 17034a enters the communication opening 206a of the receiving side toner feeding member 206 of the process cartridge B17.

With the structure described above, the toner cartridge C17 of this embodiment is capable of feeding the toner to the process cartridge side, even if it has a toner discharge opening which faces in a direction different from that toward the toner supply opening formed on the process cartridge B17 side before mounting is completed. Specifically, the toner cartridge C17 according to this embodiment is mounted to the process cartridge B17 while the flexible toner feeding member 17034 is deformed along the shape provided on the process cartridge side. With this structure, the toner cartridge can be downsized without need for the shape of the toner feeding member to become complicated.

The timing of mounting the attachment member 17070 to the process cartridge B17 is not limited to the above-described example. For example, the process cartridge B17 to which the attachment member 17070 has been mounted may be mounted to the printer main assembly A, or the attachment member 17070 may be mounted to the process cartridge B17 which has been mounted to the printer main assembly A.

### Embodiment 18

In the above-described Embodiment 1, the two couplings provided on the toner cartridge C directly engage with couplings provided on the printer main assembly A to transmit the driving forces from the printer main assembly A to the toner cartridge C. In contrast, in this embodiment which will be described, referring to FIGS. 117 to 120, the drive force is transmitted through a drive transmission attachment 18115 provided between the printer main assembly A and the toner cartridge C18.

Figure MU1801 is a perspective view illustrating a method of mounting the drive transmission attachment 18115 to the toner cartridge C. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

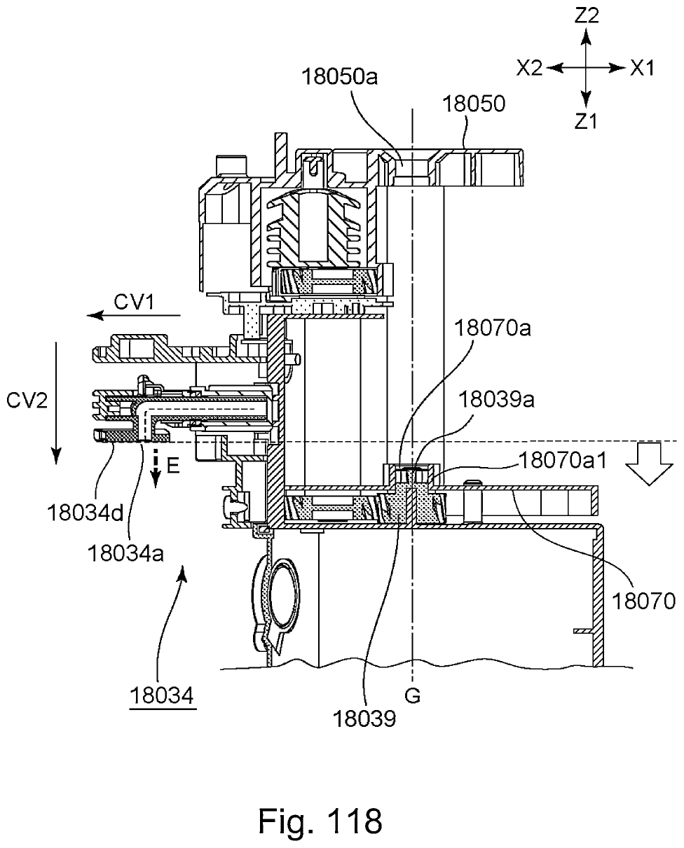

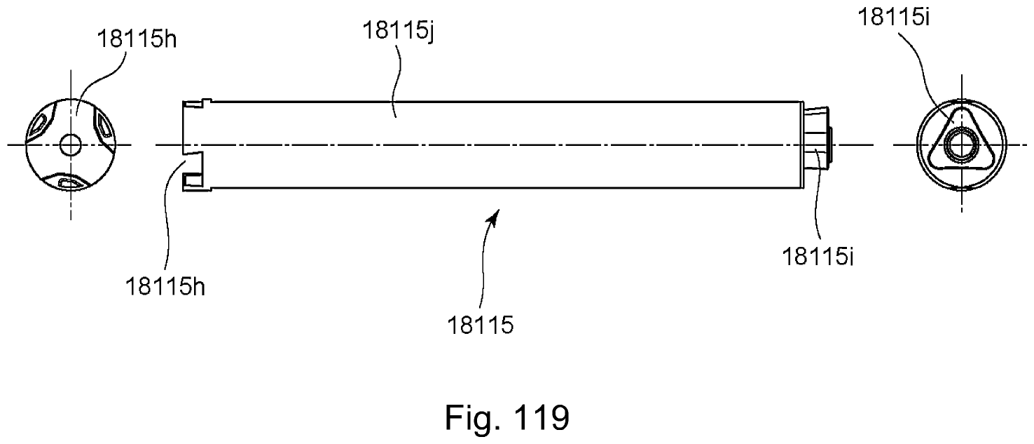

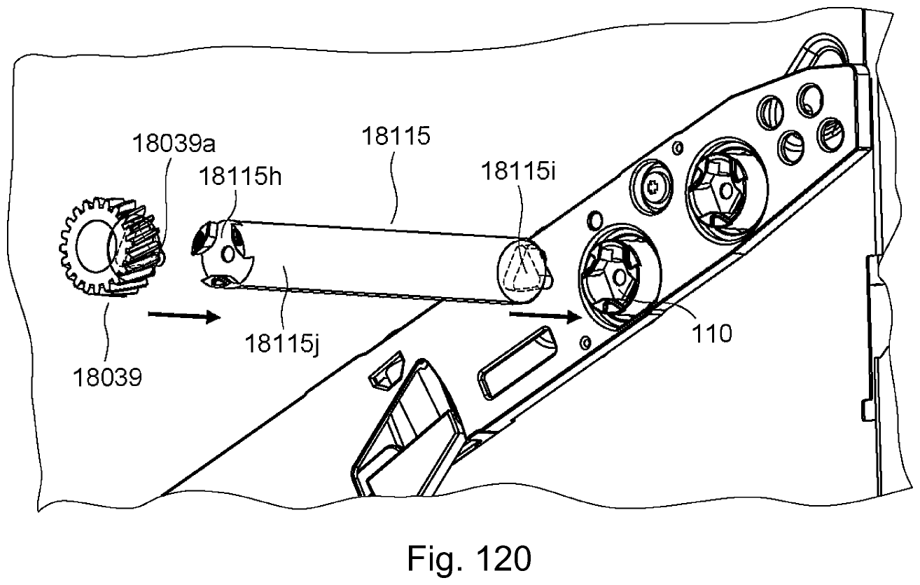

FIG. 117 is an external perspective view of a toner cartridge C18 according to an Embodiment 18 of the present invention, and shows, for the purpose of explanation, a state in which the two drive transmission attachments 18115 have been removed from the toner cartridge C18. FIG. 118 is a sectional view of a main portion of the toner cartridge C18 according to an Embodiment 18 of the present invention, taken along the XZ plane passing through the rotation center of the shutter member 18034. FIG. 119 is a detailed view of the drive transmission attachment 18115 according to Embodiment 18 of the present invention. FIG. 120 is an illustration of an example of a drive transmission mechanism from the printer main assembly A to the toner cartridge C18 according to Embodiment 18 of the invention. In addition, in FIG. 120, an engagement method between the first main assembly side pump coupling 110, the pump-screw coupling portion 18039a, and the drive transmission attachment 18115 will be exemplarily described.

As shown in FIG. 118, in the toner discharging direction E through the toner discharge opening 18034a in the XZ plane, the pump-screw coupling portion 18039a is located downstream of the shutter member 18034 having the toner discharge opening 18034a. The shutter member 18034 of this embodiment has the same structure as the shutter member 34 of Embodiment 1 described in the foregoing, and is capable of feeding the toner in the first feeding direction CV1 and the second feeding direction CV2 as the toner feeding direction. The toner discharging direction E and the direction of the second feed passageway CV2 are substantially the same. Therefore, it can be said that the pump-screw coupling portion 18039a is located downstream of the shutter member 18034 in the second feeding direction CV2, instead of the toner discharging direction E. In other words, it can be said that the pump-screw coupling portion 18034a is placed closer to the inside of the toner cartridge C21 than the shutter member 18034 in the direction parallel to the rotation axis of the pump-screw coupling portion 18039a.

As shown in FIG. 118, a coupling holding member 18070 is provided inside the side cover 18050 in a direction parallel to the axis G of the pump-screw coupling portion 18039a. In this embodiment, the pump-screw coupling portion 18039a is exposed in the Z2 direction through a hole portion 18070a provided in the coupling holding member 18070.

As shown in FIG. 119, the drive transmission attachment 18115 of this embodiment is a driving force transmission member for transmitting, from the printer main assembly A side to the toner cartridge C18 side, the drive force transmitted from the drive source of the printer main assembly A. The driving force transmission attachment 18115 has a drive inputting portion 18115i engageable with the first main assembly side coupling 110, and a drive outputting portion 18115h engageable with the pump-screw coupling portion 39a.

As shown in FIG. 119, the drive transmission attachment 18115 has a cylindrical shape provided with the drive input portion 18115i at one end, the drive outputting portion 18115h at the other end, and a drive transmission portion 18115j between these ends. The shape of the drive transmission attachment may be other than cylindrical as long as it does not affect the drive of the toner cartridge C18.

As shown in FIG. 117, the toner cartridge C18 is provided with a hole 18050a in the side cover 18050, the hole 18050a opening in the Z2 direction. In addition, a cylindrical portion 18070a1 is provided on the outer periphery the above-mentioned hole portion 18070a of the coupling holding member 18070.

As shown in FIG. 117, the drive transmission attachment 18115 can be inserted in the Z1 direction through a hole 18050a provided in the side cover 18050 and a hole portion 18070a provided in the coupling holding member 18070.

In the above-described manner, the drive transmission attachment 18115 inserted into the toner cartridge C18 has the drive transmission portion 18115j rotatably supported by the hole portion 18050a and the cylindrical portion 18070a1. When the drive transmission attachment 18115 is fully inserted into the toner cartridge C18 in the Z1 direction, the pump-screw coupling portion 18039a and the drive outputting portion 18115h engage with each other as shown in FIG. 120.

In this state, when the mounting of the toner cartridge C18 into the printer main assembly A is completed and the opening and closing opening/closing door 107 is closed, the first main assembly side coupling 110 projects toward the inside of the apparatus (in the Z1 direction). By this action, the drive input portion 18115i and the first main assembly side pump coupling 110 are brought into engagement with each other. Through the above-described operations, it becomes possible to transmit the driving force from the first main assembly side coupling 110 through the drive transmission attachment 18115 to the toner cartridge C18 side.

As for the drive/stirring coupling portion 18038a, as well, similarly to the pump-screw drive input portion 18039, the driving force can be transmitted from the printer main assembly A to the toner cartridge C18 through the drive transmission attachment 18115, although details are omitted.

With the above-described structure, as well, as with the structure described in Embodiment 1, the driving force can be accurately transmitted from the printer main assembly A to the toner cartridge C18.

### Embodiment 19

In the above-described Embodiment 13, the attachment gear 13115 is mounted to the first main assembly side coupling 110, and the driving force is transmitted from the attachment gear 13115 to the pump-screw input gear 13039a. In contrast, in this embodiment, the driving force is transmitted from the printer main assembly A to the toner cartridge C19 by way of an attachment unit 19115 including an attachment gear 19115a and a worm gear 19115b. Referring to FIGS. 115-125, this will be described below. The same components as those in Embodiment 1 will be described with the same reference numerals and symbols as those in Embodiment 1. In addition, as for the toner cartridge, the process cartridge, and the printer main assembly, the components having the same functions and roles as those in Embodiments 1 and 13 are assigned the same names and like reference numerals and symbols.

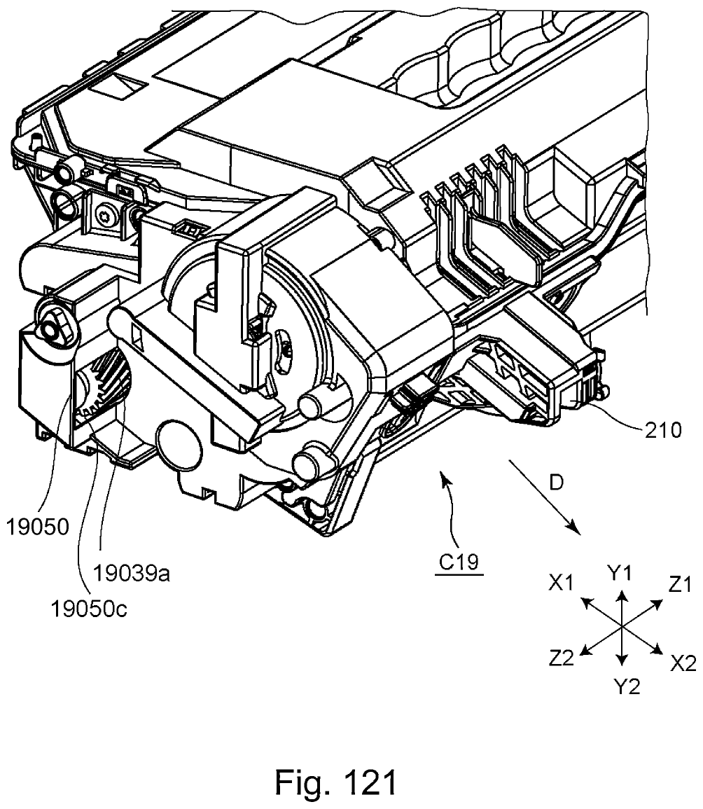

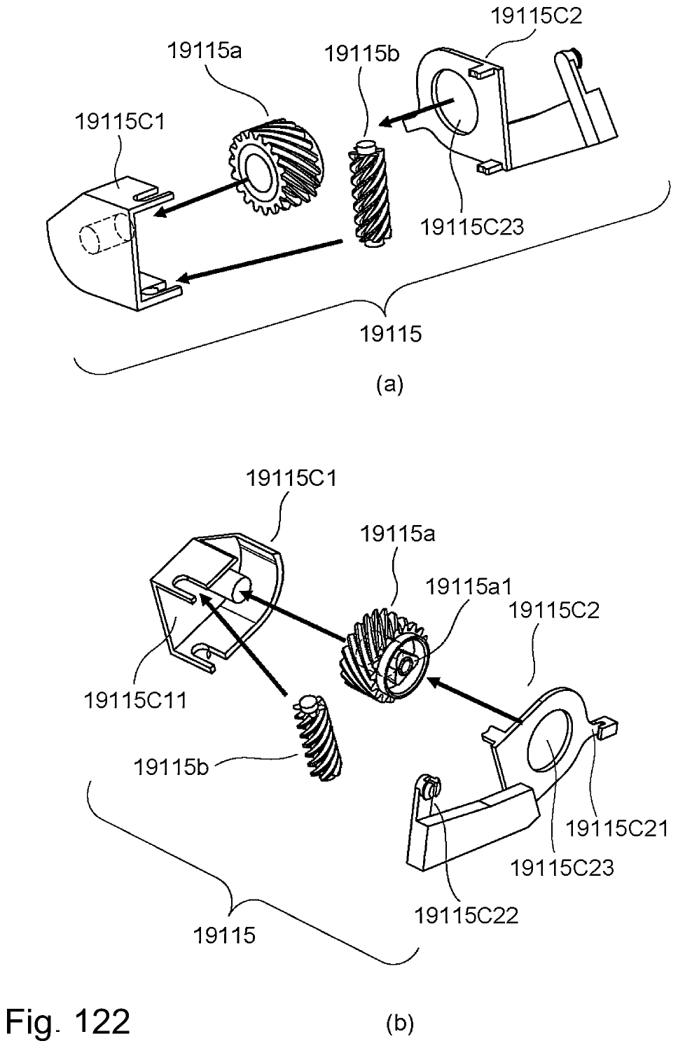

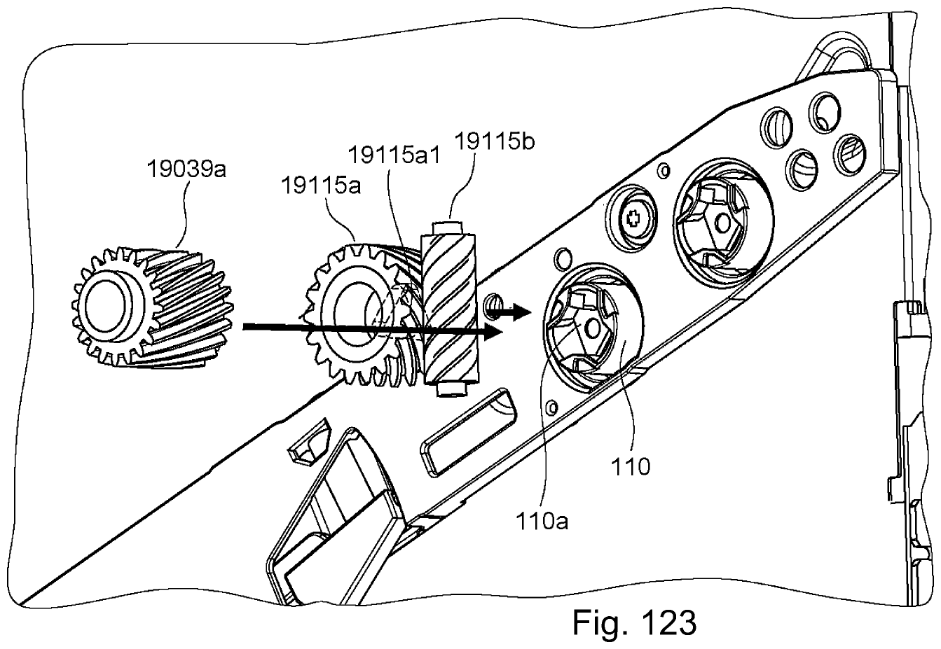

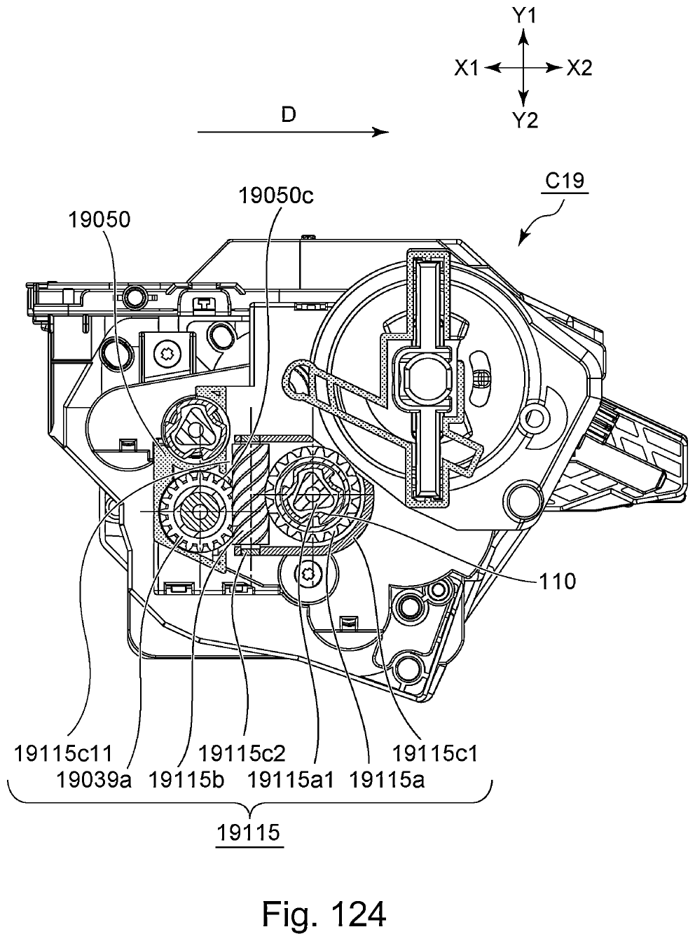

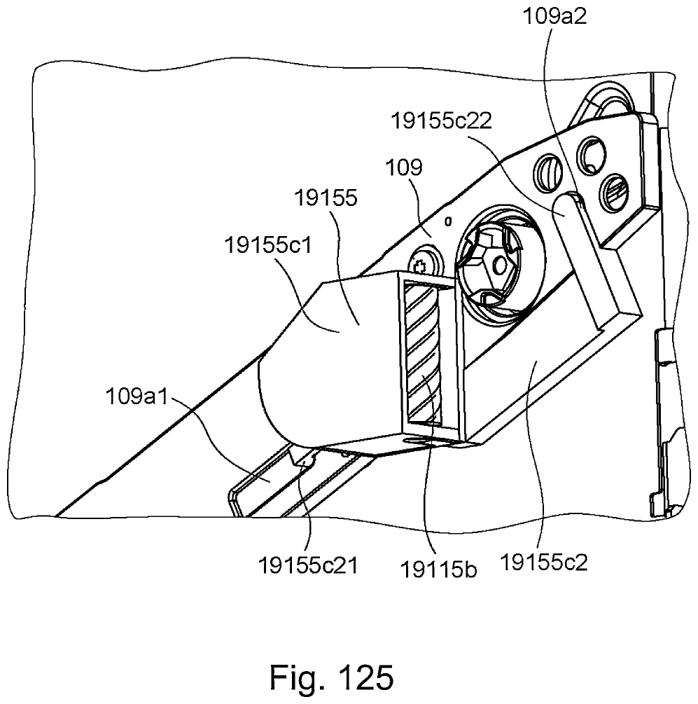

FIG. 121 is a partial external perspective view of a toner cartridge C19 according to Embodiment 19 of the present invention. FIG. 122 is an exploded perspective view of an attachment unit 19115 according to Embodiment 19 of the present invention. Part (a) of FIG. 122 is a perspective view of the attachment unit 19115, as viewed from the side connectable to the toner cartridge C19. Part (b) of FIG. 122 is a perspective view of the attachment unit 19115 as viewed from the side connectable to the printer main assembly A. FIG. 123 is an illustration of an example of a drive transmission mechanism for transmission from the printer main assembly A to the toner cartridge C19 according to Embodiment 19 of the invention. FIG. 123 shows the relative positional relationship between a pump-screw coupling gear 19039a, the attachment unit 19115, and the first main assembly side coupling 110, which will be described hereinafter. FIG. 124 is a cross-sectional view taken along the XY plane of a major part of the driving force transmission mechanism according to Embodiment 19 of the present invention. FIG. 124 is a cross-section view taken along a plane perpendicular to the rotation axes of the pump-screw input gear 19039a and the attachment gear 19115a. FIG. 125 is a perspective view of the major parts of an attachment unit 19115 mounted to the printer main assembly A according to Embodiment 19 of the invention.

As shown in part (a) of FIG. 122 and part (b) of FIG. 122, the attachment unit 19115 is a drive transmission member of this embodiment, including the attachment gear 19115a and the worm gear 19115b. The attachment unit 19115 includes an outer attachment cover 19115cl supporting the two gears, and an inner attachment cover 19115c2. In addition, the attachment unit 19115 has an opening 19115c11 through which a part of the worm gear 19115b is exposed, and a hole 19115c23 through which the engagement portion 19115a1 passes and which allows the engagement portion 19115a1 to project toward the printer main assembly A.

As shown in part (b) of FIG. 122, the inner attachment cover 19115c2 has a first retaining shape portion 19115c21 and a second retaining shape portion 19115c22. As shown in FIG. 125, the second guide portion 109 of the printer main assembly A is provided with a first hole portion 109a1 and a second hole portion 109a2. The attachment unit 19115 is mounted to the printer main assembly A by mounting the first retaining portions 19115c21 and 19115c22 to the first hole portion 109al and the second hole portion 109a2, respectively. The method of mounting the attachment unit 19115 to the printer main assembly A is not limited to this example, and any method such as fixing with screws or press fitting may be used.

Next, as shown in FIG. 121, the toner cartridge C19 is provided with a pump-screw input gear 19039a which constitutes a pump-screw drive input portion 19039. In addition, the side cover 19050 of the toner cartridge C19 is provided with an opening 19050c for uncovering a part, in the circumferential direction, of the pump-screw input gear 19039a. Therefore, as the toner cartridge C19 is viewed from the outside, the pump-screw drive input gear 19039a is only partially exposed through the opening 19050c. Then, by this exposed pump-screw drive input gear 19039a meshing with the worm gear 19050c, the drive force is supplied from the printer main assembly A side to the toner cartridge C19 side. The driving force inputted to the pump-screw driving input gear 19039a is then transmitted to the pump unit 37 and the toner accommodating portion screw member 35 inside the toner cartridge C19. The internal structure of the toner cartridge C19 after receiving the driving force is the same as that of Embodiment 1 described in the foregoing, and therefore a description thereof is omitted.

A method of connecting the first main assembly side coupling 110 and the attachment unit 19115 will be specifically described below. When the toner cartridge C19 is mounted in the printer main assembly A with the attachment unit 19115 mounted in the manner described above, the worm gear 19115b and the pump-screw input gear 19039a mesh with each other.

Next, when the opening and closing opening/closing door 107 provided on the printer main assembly A is closed, the first main assembly side coupling 110 moves (projects) toward the inside of the device. Then, as shown in FIGS. 123 and 124, the engagement portion 19115a1 of the attachment gear 19115a enters the main assembly side coupling recess 110a of the first main assembly side coupling 110. By this operation, the engagement portion 19115a1 is brought into engagement with the first main assembly side coupling 110, and the driving force is transmitted from the printer main assembly A (see FIGS. 123 and 124). Since the attachment gear 19115a is partially engaged with the worm gear 19115b, the driving force is transmitted from the attachment gear 19115a to the worm gear 19115b. At this time, the rotation axis of the worm gear 19115b is substantially perpendicular to the rotation axis of the first main assembly side coupling 110. With the above-described structure, the toner cartridge C19 can receive a (rotational) driving force from the first main assembly side coupling 110 by way of the attachment unit 19115.

When transmitting driving force from the printer main assembly A to the toner cartridge C19, the rotation axis of the pump-screw drive input gear 19039a and the rotation axis of the worm gear 19115b are also substantially perpendicular to each other. In other words, the rotation axis of the first main assembly side coupling 110 and the rotation axis of the pump-screw input gear 19039a are approximately parallel to each other (see FIG. 124).

The attachment unit 19115 of this embodiment is mounted to the printer main assembly A after the process cartridge B is mounted to the printer main assembly A and before the toner cartridge C19 is mounted. Thereafter, the toner cartridge C19 is mounted to the printer main assembly A. The method for removing the toner cartridge C19 and the process cartridge B from the printer main assembly A is the opposite to that described above. In other words, the toner cartridge C19 may be removed from the printer main assembly A, and then the attachment unit 19115 may be removed, and thereafter the process cartridge B may be removed.

With the structure described above, as in the above-mentioned Embodiments 1 and 13, even if the rotation axis of the rotational driving force is changed midway, the driving force can be transmitted from the driving source provided in the printer main assembly A to the toner cartridge C19. In this embodiment, the direction of the rotation axis is changed by using the attachment gear 19115a and the worm gear 19115b, but a combination of bevel gears may be instead.

### Embodiment 20

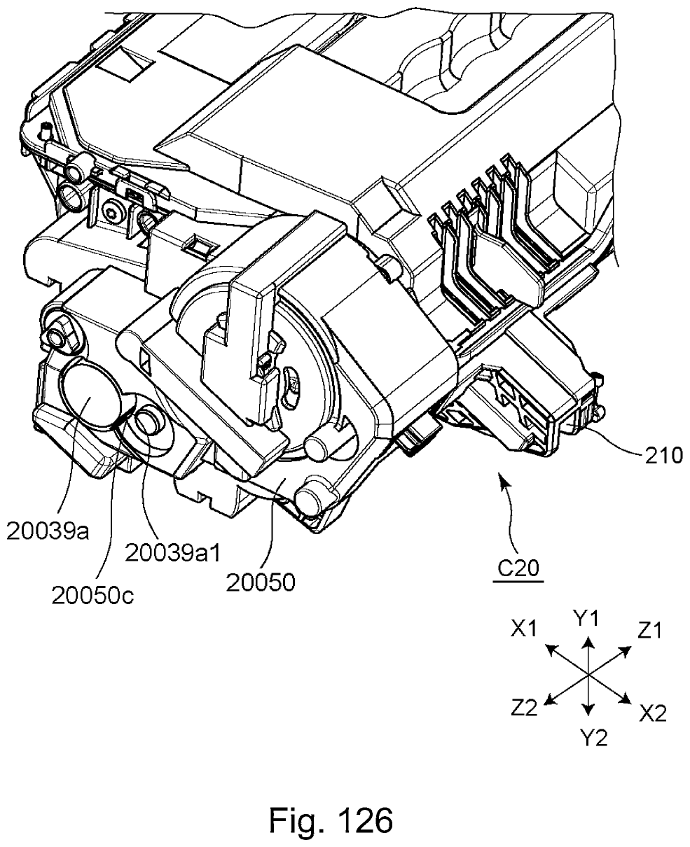

In the above-mentioned Embodiment 15, the outer circumferential portion of the first main assembly side coupling 110 is fitted with the pump-screw coupling portion 15039a having a larger inner diameter and rubber elasticity, thereby transmitting the driving force. In contrast, in this embodiment which will be described, referring to FIGS. 126 to 128, the driving force is transmitted by contacting a pump-screw coupling portion 20039a having rubber elasticity in a direction perpendicular to the rotation axis of the first main assembly side coupling 110. The same components as those in Embodiment 1 will be described with the same reference numerals and symbols as those in Embodiment 1. In addition, as for the toner cartridge, the process cartridge, and the printer main assembly, the components having the same functions and roles as those in Embodiments 1 and 15 are given the same names and like reference numerals and symbols.

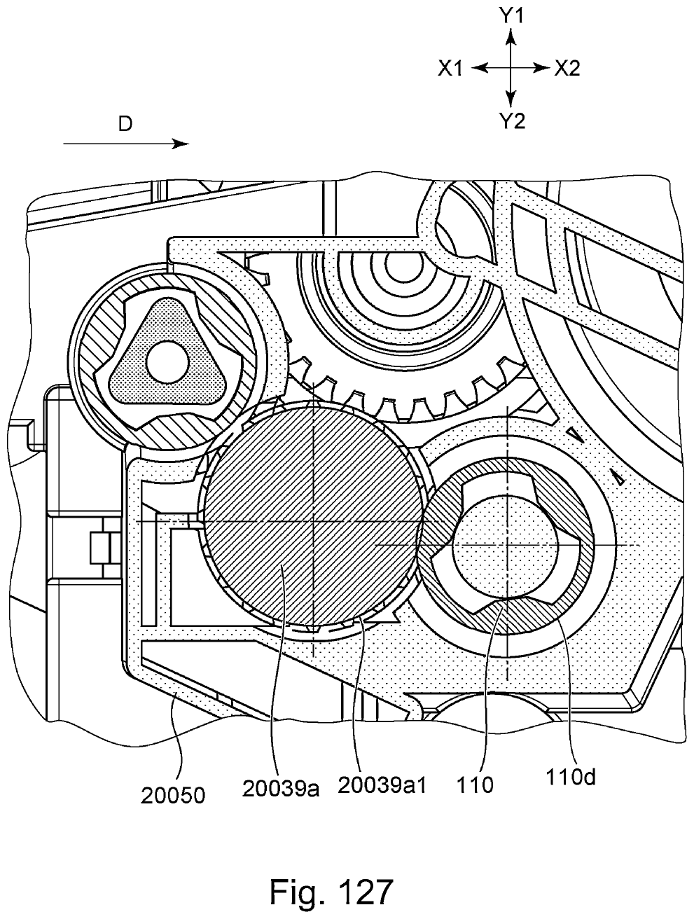

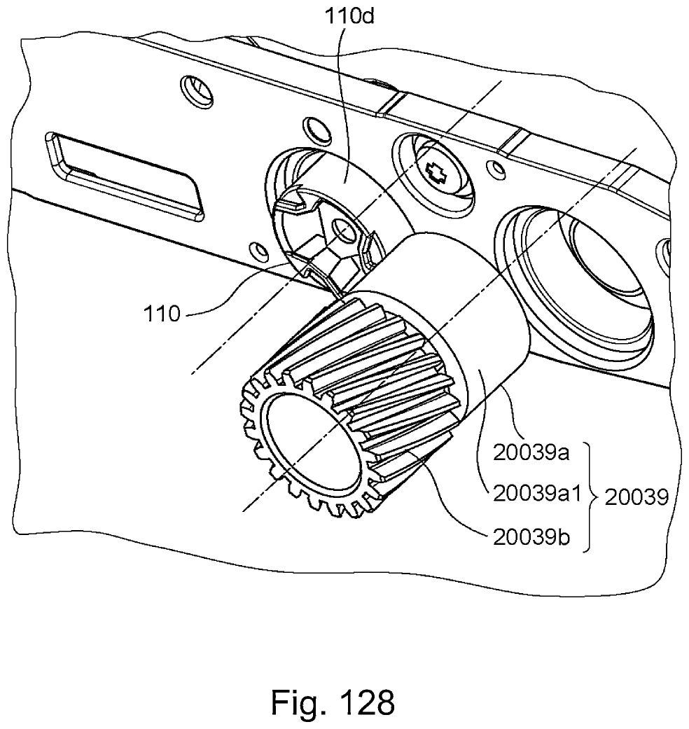

FIG. 126 is an external perspective view of a toner cartridge C20 according to Embodiment 20 of the present invention. FIG. 127 is a cross-sectional view of the toner cartridge C20 and the first main assembly side coupling 110 according to Embodiment 20 of the present invention, taken along a plane (XY plane) perpendicular to the rotation axis of the pump-screw coupling portion 20039a. FIG. 128 is an illustration of an example of a driving force transmission mechanism according to Embodiment 20 of the present invention, and shows a relative positional relationship between the pump-screw coupling gear 20039a and the first main assembly side coupling 110.

As shown in FIGS. 126 and 128, the pump-screw drive input portion 20039 is a driving force transmission member according to this embodiment, and includes a pump-screw coupling portion 20039a and a drive transmission portion 20039b. The pump-screw coupling portion 20039a has a side portion 20039a1, the details of which will be described hereinafter.

The pump-screw coupling portion 20039a is formed of an elastic material such as rubber or elastomer having so-called rubber elasticity. Because of the rubber elasticity, the pump-screw coupling portion 20039a deforms when it comes into contact with the first main assembly side coupling 110, and the contact state between them is maintained by the frictional force of the contact surfaces. The pump-screw coupling portion 20039a according to this embodiment is cylindrical in shape with at least a portion of the side surface portion 20039a1 exposed through the hole 20050a of the side cover 20050 of the toner cartridge C20. The drive transmission portion 20039b is made of a material such as a resin material or a metal material, and transmits the drive force received from the pump-screw coupling portion 20039a, to the inside of the toner cartridge C20.

When the toner cartridge C20 is mounted in the printer main assembly A and the opening and closing opening/closing door 107 is closed, the first main assembly side coupling 110 moves (projects) toward the inside of the device. At this time, as shown in FIGS. 127 and 128, the side surface portion 20039a1 of the pump-screw coupling portion 20039a abuts against the outer circumferential portion 110d of the first main assembly side coupling 110. In this embodiment, the side surface 20039a1 is positioned so as to intrude into the outer circumferential portion 110d by approximately 0.15 mm, and the pump-screw coupling portion 20039a is made of urethane rubber. The first main assembly side coupling 110w as made of polyacetal resin as in Embodiment 14. The material of and intrusion amount between the pump-screw coupling portion 20039a and the first main assembly side coupling 110 are not limited to these examples, as long as they can transmit the rotational driving force of the printer main assembly A to the toner cartridge C20, and various materials and intrusion amount can be selected.

As described above, in the toner cartridge C20 according to this embodiment, the side surface portion 20039a1 of the pump-screw coupling portion 20039a and the outer circumferential portion 110d of the first main assembly side coupling 110 can maintain a contact state by the frictional force when they are in contact with each other. Therefore, in this state, by rotating the first main assembly side coupling portion 110, the rotational driving force of the first main assembly side coupling 110 can be transmitted to the toner cartridge C20 side, similarly to Embodiment 15.

In the above-described example, the pump-screw coupling portion 20039a has a cylindrical shape, but the shape is not limited to such an example. For example, any structure may be employed for the pump-screw coupling portion 20039a as long as it is made of the material and has the shape that can maintain the contact with the outer circumferential portion 110d of the first main assembly side coupling portion 110. For example, the cross-section perpendicular to the rotation axis of the pump-screw coupling portion 20039a may be polygonal rather than circular. In this case, the more vertices that form the polygon, the easier it is to maintain the contact state between the first main assembly side coupling 110 and the pump-screw coupling portion 20039a.

### Embodiment 21

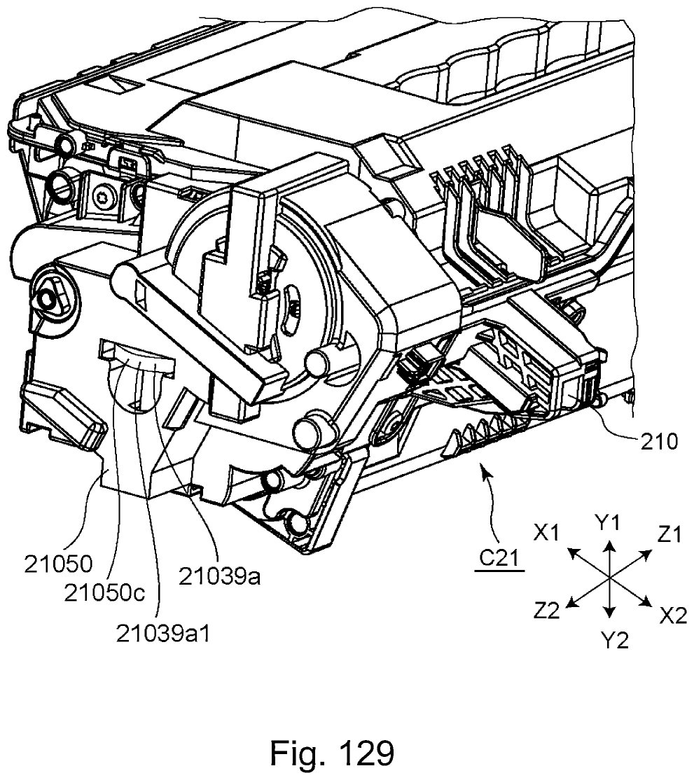

In the above-described Embodiment 14, the toner cartridge receives a driving force using a pump-screw coupling portion 14039a having rubber elasticity which rotates substantially coaxially with the rotation axis of the first main assembly side coupling 110 provided in the printer main assembly A. In contrast, in this embodiment the toner cartridge C21 receives a driving force using a pump-screw coupling portion 21039a which has rubber elasticity and which is rotatable about a rotation axis crossing with the rotation axis of the first main assembly side coupling 110. Referring to FIGS. 129-132, this embodiment will be explained below. Here, the same components as those in Embodiment 1 will be described with the same reference numerals and symbols as those in Embodiment 1., as for the toner cartridge, the process cartridge, and the printer main assembly, the components having the same functions and roles as those in Embodiments 1 and 14 are assigned the same names and like reference numerals and symbols.

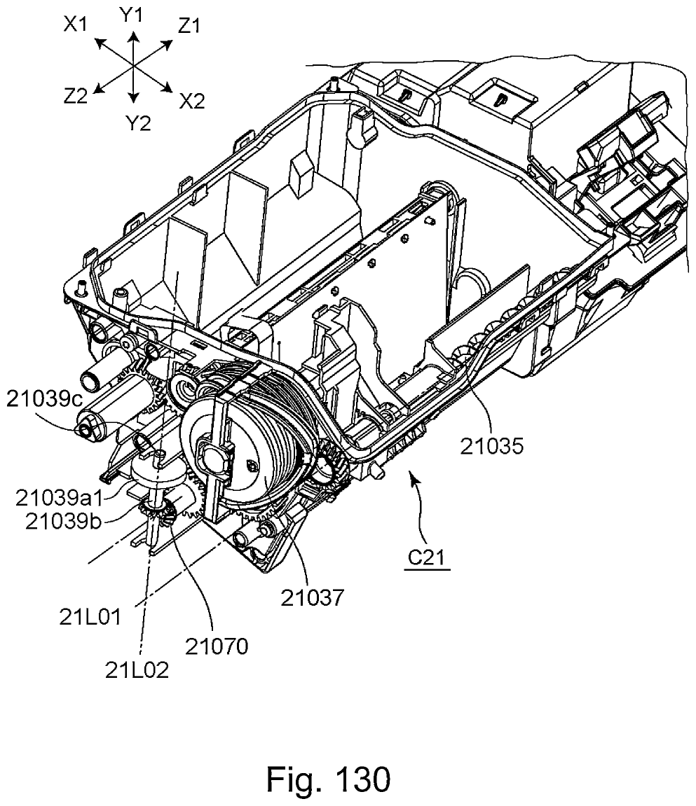

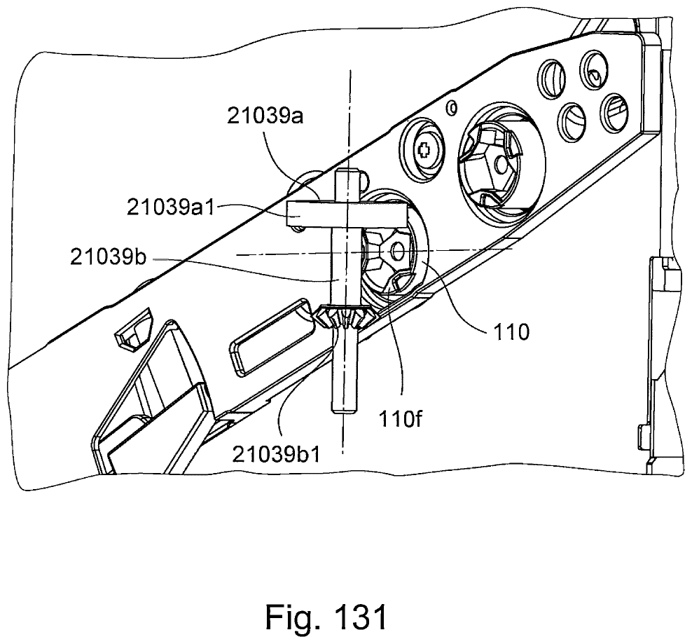

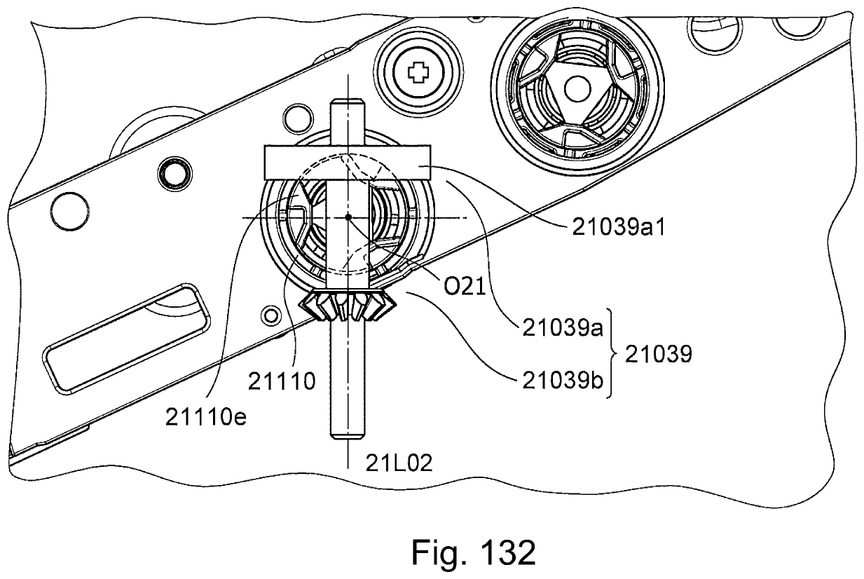

FIG. 129 is a partial external perspective view of the toner cartridge C21 according to Embodiment 21 of the present invention. FIG. 130 is an exploded perspective view including a drive transmission mechanism of a toner cartridge C21 according to Embodiment 21 of the present invention. FIG. 131 is an illustration of an example of a driving force transmission mechanism according to Embodiment 21 of the present invention, and shows a relative positional relationship between the pump-screw coupling portion 21039a and the first main assembly side coupling 110. FIG. 132 is a partial side view illustrating a part including the pump-screw drive transmission portion 21039 as viewed in a direction facing the first main assembly side coupling 110. For the sake of explanation, FIG. 132 shows only the pump-screw drive transmission portion 21039 as a member on the toner cartridge C21 side.

As shown in FIG. 130, a pump-screw drive transmission portion 21039, which is the driving force input means in this embodiment, has the pump-screw coupling portion 21039a and a drive transmission portion 21039b. The pump-screw coupling portion 21039a has a cylindrical outer periphery 21039a1, and is made of an elastic material such as rubber or elastomer having so-called rubber elasticity. Because of the rubber elasticity, the pump-screw coupling portion 21039a deforms when it comes into contact with the first main assembly side coupling 110, and the contact state between them is maintained by the frictional force of the contact surfaces. The driving force received by the pump-screw drive transmission portion 21039 is transmitted to the toner accommodating portion screw member 21035 and the pump unit 21037 provided inside the toner cartridge C21.

As shown in FIG. 130, the pump-screw coupling portion 21039a rotates about a rotation axis 21L02 perpendicular to the rotation axis 21L01 of the toner accommodating portion screw member 21035. Here, the rotation axis 21L02 of the toner accommodating portion screw member 21035 is parallel to the Z-axis direction. That is, the pump-screw coupling portion 21039a in this embodiment is rotatable about a rotation axis extending in a direction (thickness direction of the toner cartridge C21) perpendicular to the longitudinal direction of the toner cartridge C21 (direction parallel to the Z axis).

In addition, a shaft portion 21039c projecting from the end of the pump-screw coupling portion (21039a) side of the pump-screw drive transmission portion 21039 and having a center aligned with the rotation axis 21L02 engages with a recess-shaped bearing portion (not shown) provided inside the toner cartridge C21. In this state, the pump-screw drive transmission portion 21039 is rotatable about the rotation axis 21L02.

As shown in FIG. 129, the side cover 21050 of the toner cartridge C21 is provided with a hole 21050c for exposing a portion of the cylindrical outer periphery 21039a1 of the pump-screw coupling portion 21039a.

When the toner cartridge C21 is mounted in the printer main assembly A and the opening and closing opening/closing door 107 is closed, the first main assembly side coupling 110 projects to the inside of the device (Z1 direction) as shown in FIG. 131. At this time, a free end portion 110f provided at the free end of the first main assembly side coupling 110 comes into contact with a cylindrical outer periphery 21039a1 of the pump-screw coupling portion 21039a of the toner cartridge C21. In this state, the cylindrical outer periphery 21039a1 is lightly pressed against the free end portion 110f and is deformed.

In this embodiment, the pump-screw coupling portion 21039a is made of urethane rubber, and is positioned so that the cylindrical outer periphery 21039a1 intrudes (deforms) into the free end portion 110f by approximately 0.15 mm. As in Embodiment 14, the first main assembly side coupling 110w as made of polyacetal resin. The material and the amount of penetration (deformation) of the pump-screw coupling portion 21039a and the first main assembly side coupling 110 are not limited to these, and may be any structure that can transmit the rotational driving force of the printer main assembly A to the toner cartridge C21.

When the first main assembly side coupling 110 is rotationally driven, the free end portion 110f of the first main assembly side coupling 110 and the cylindrical outer periphery 21039a1 of the pump-screw coupling portion 21039a are maintained in contact with each other by the frictional force between them. In this state, the pump-screw coupling portion 21039a also rotates in response to the rotation of the first main assembly side coupling 110, and the driving force is transmitted from the printer main assembly A side to the toner cartridge C21 side.

The drive transmission portion 21039b converts the drive force received by the pump-screw coupling portion 21039a into a direction parallel to the rotation axis 21L01 of the toner accommodating portion screw member 21035 by a bevel-toothed drive transmission gear 21039b1, and inputs it. More specifically, the driving force is converted into a direction parallel to the rotation axis 21L01 of the toner accommodating portion screw member 21035 (that is, a direction parallel to the Z axis) by the driving force input gear 21070 meshing with the drive transmission gear 21039b1. Then, the driving force is inputted into the toner cartridge C21 by the driving force input gear 21070. The drive transmission gear 21039b1 may be structured to use other conversion means such as a gear other than a bevel gear (such as a worm gear).

As shown in FIGS. 129 and 132, as viewed in the rotational axis direction of the first main assembly side coupling 110 (direction parallel to the Z axis), the rotation axis 21L02 of the pump-screw coupling portion 21039a passes through the rotational center O21 of the first main assembly side coupling 110.

According to the structure described above, similarly to Embodiment 1, it is possible to transmit driving force from the printer main assembly A to the toner cartridge C21. In addition, since the pump-screw coupling portion 21039a according to this embodiment has rubber elasticity, it is possible to achieve the same effects as those of Embodiment 14 described in the foregoing. Further, the pump-screw drive transmission portion 21039 according to this embodiment is rotatable about the rotation axis extending in the direction perpendicular to the longitudinal direction of the toner cartridge C21 (direction parallel to the Z axis). Therefore, the toner cartridge C21 including the pump-screw coupling portion 221039a can be made smaller in longitudinal dimension (size) than the toner cartridge C14 according to Embodiment 14 described in the foregoing. This effect can be provided as long as the direction of the rotation axis of the pump-screw coupling portion 21039a at least intersects the longitudinal direction of the toner cartridge C21 (the direction parallel to the Z axis), but the above-described structure is preferable.

In the above-described example, the drive transmission gear 21039b1 is provided on the drive transmission portion 21039b, but this embodiment is not limited to such an example. For example, the driving force (rotation axis) may be changed before the driving force is transmitted to the pump unit 21037 or the toner accommodating portion screw member 21035. In this case, the drive transmission portion 21039b may not include the drive transmission gear 21039b1.

### Embodiment 22

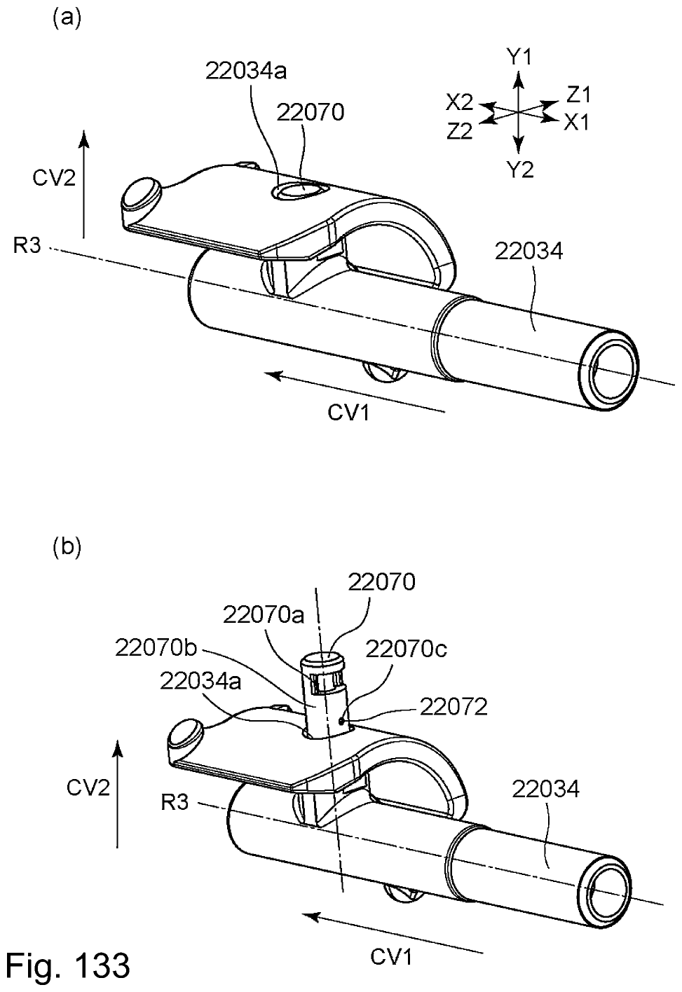

In above-described Embodiment 1, the L-shaped shutter member 34 is used to feed the toner in two different directions, and then the toner is supplied to the process cartridge B side. In contrast, in this embodiment which will be described, referring to FIGS. 133 to 135, the shape of the shutter member (toner feeding member) itself is not greatly changed from that of Embodiment 1, and the toner is discharged in a direction different from that of Embodiment 1 described in the foregoing. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

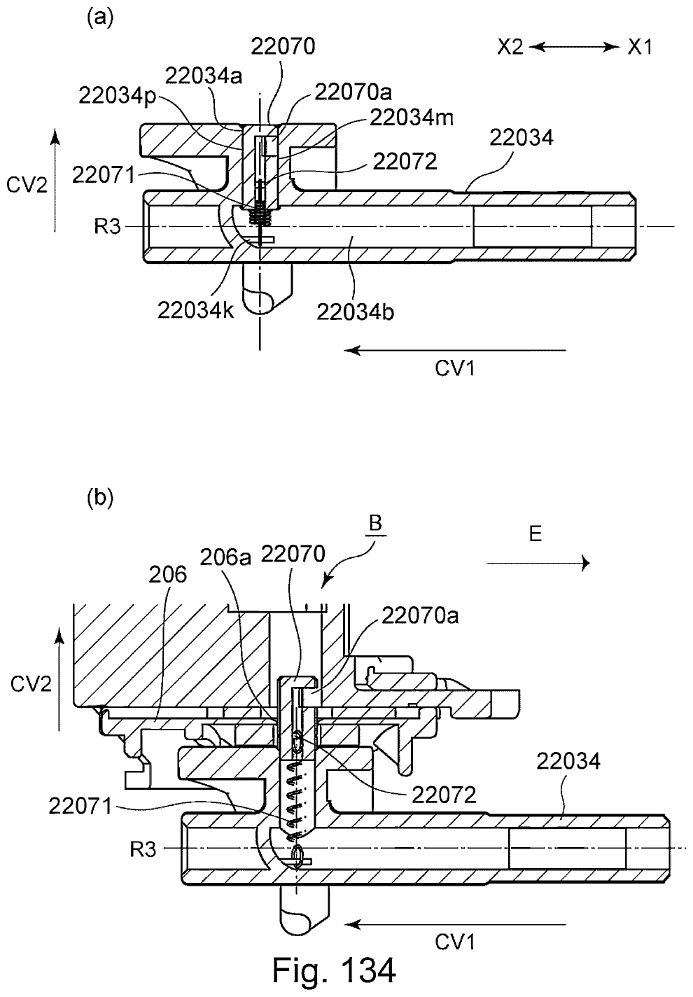

FIG. 133 is an external perspective view of a shutter member 22034 according to Embodiment 22 of the present invention. Part (a) of FIG. 133 is an external perspective view illustrating a state in which the toner discharge portion 22070 is retracted, and part (b) of FIG. 133 is an external perspective view illustrating a state in which the toner discharge portion 22070 is protruded. FIG. 134 is a sectional view taken along a plane parallel to the X-axis and passing through the rotation axis R3 of the shutter member 22034, according to Embodiment 22 of the present invention. Part (a) of FIG. 134 is a sectional view illustrating the state in which the toner cartridge C22 is not mounted in the process cartridge B, and part (b) of FIG. 134 is a sectional view illustrating the state in which the toner cartridge C22 is mounted in the process cartridge B. The shutter member 22034 according to this embodiment can supply toner to the process cartridge B side in a state in which the toner discharge portion 22070 protrudes from the hole portion 220234a as shown in part (b) of FIG. 133.

As shown in FIG. 133, the shutter member 220324 according to this embodiment is provided on the toner cartridge C22, and is a toner feeding member for feeding (supplying) the toner to the process cartridge B side. The toner discharge portion (projection) 22070 which can protrude and retract is mounted to the inner periphery of the hole 22034a of the shutter member 22034.

As shown in part (a) of FIG. 134, when the toner discharge portion 22070 is housed (retracted position), the toner discharge portion 22070 is retracted so as to follow the inner circumferential surface of the hollow portion as the second toner feed passageway 22034m in the shutter member 22034. In contrast, as shown in part (b) of FIG. 134, when the toner discharge portion 22070 is in a protruding state, the toner discharge portion 22070 is in a protruding state (operating position) through the hole 22034a in the shutter member 22034.

As shown in FIG. 133 and part (a) of FIG. 134, the shutter member 22034 has approximately the same shape as the shutter member 34 of the above-mentioned Embodiment 1. The shutter member 22034 has a first toner feed passageway 22034b extending in the first toner feeding direction CV1, a second toner feed passageway 22034m extending in the second toner feeding direction CV2, and a hole 22034a at the free end of the second toner feed passageway 22034m. In addition, the first toner feed passageway 22034b has a spring hook portion 22034k at the end thereof in the X2 direction (that is, the portion intersecting with the second toner feed passageway 22034m) which extends in the opposite direction to the first toner feeding direction CV1.

As shown in part (a) of FIG. 133 and part (b) of FIG. 133, the toner discharge portion 22070 has a cylindrical shape and is provided with an outer circumferential surface 22070b, and is provided with the second toner discharge port, and a hole portion 22070c. In addition, the outer circumferential surface 22070b may have a shape other than a cylindrical shape as long as it has such a shape that can be inserted into the communication opening 206 (supply opening 21c) of the process cartridge B. Further, the opening directions of the toner discharge opening 22070a and the hole portion 22070c both face in the Z1 direction.

The outer circumferential surface 22070b of the toner discharge portion 22070 is supported on the inner circumferential surface of a hollow portion of the shutter member 22034 which corresponds to the second toner feed passageway 22034m so as to be movable in the second toner feeding direction CV2. A parallel pin 22072 is fixed to the hole portion 22070c of the toner discharge portion 22070. In addition, a tension spring 22071 is provided inside the shutter member 22034 and has one end which is connected to the parallel pin 22072 and the other end which is connected to the spring hook portion 22034k. When the toner discharge portion 22070 is in an operating state (projecting state), the tension spring 22071 produces an urging force such that the toner discharge portion 22070 moves to the retracted position (storage state).

As shown in part (b) of FIG. 133 and part (b) of FIG. 134, in the toner discharge portion 22070, the pump unit 37 of the toner cartridge C22 can expand and contract by the driving force received from the printer main assembly A, similarly to Embodiment 1. An air pressure difference resulting from the expansion and contraction of the pump unit 37 produces an air flow in the toner discharging direction, and toner discharge portion 22070 moves to the operating position against the urging force of the tension spring 22071. When the toner discharge portion 22070 moves to the operating position, the toner discharge opening 22070a is exposed out of the shutter member 22034. The toner supplied together with the air from the toner cartridge C22 passes through the shutter member 22034 and the inside of the toner discharge portion 22070 to be discharged through the toner discharge opening 22070a. Specifically, when the toner discharge portion 22070 is in the operating position, the toner is discharged in a direction having directional components of the first toner feeding direction CV1 and the second toner feeding direction CV2 (i.e., direction parallel to the rotation axis R3) and is supplied into the process cartridge B side.

When the toner cartridge C22 is removed from the printer main assembly A and the supply of driving force disappears, the expansion and contraction of the pump unit 37 (air flow) stops, so that the urging force of the tension spring 22071 moves the toner discharge portion 22070 to the retracted position. That is, when the toner cartridge C22 is removed from the printer main assembly A, the toner discharge portion 22070 transitions from the projecting state to the retracted state (into the shutter member 22034).

As described above, the shutter member 22034 according to this embodiment, similarly to the shutter member 34 of Embodiment 1, can feed the toner in the first toner feeding direction CV1 and the second toner feeding direction CV2 which intersect with each other. In addition, the toner discharge portion 22070 in this embodiment differs from the shutter member 34 of Embodiment 1 in that the toner discharging direction E is substantially parallel to the rotation axis R3 of the shutter member 22034. Further, in the toner discharge portion 22070 in this embodiment, the toner supplied in the second toner feeding direction CV2 is not discharged as it is, but the feed passageway is changed to a direction intersecting the second toner feeding direction CV2, and then the toner is discharged. With the above-described structure, the leakage of toner in the toner feeding passageway extending from the toner cartridge C22 to the process cartridge B can be reduced.

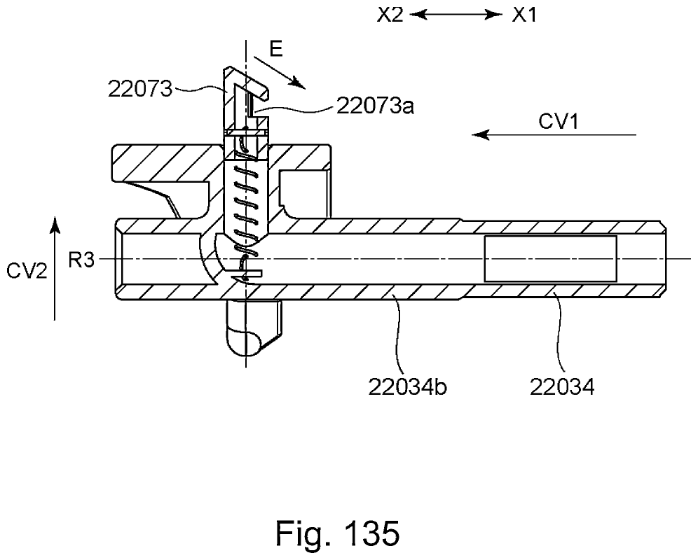

In the above-described example, the toner discharge opening 22070a is provided so that the opening thereof faces in a direction perpendicular to the rotation axis R3 of the shutter member 22034, but the orientation of the opening of the toner discharge opening 22070a is not limited to such an example. It will suffice if the toner can be discharged at least in a direction intersecting the second toner feeding direction CV2. For example, FIG. 135 illustrates an example of a different toner discharging direction by the toner discharge portion of this embodiment, in which a second toner discharge portion 22073 is provided on a shutter member 22034 of embodiment 22 of the present invention.

FIG. 135 is a sectional view of the shutter member 22034 and the second toner discharge portion 22073, taken along a plane parallel to the X-axis passing through the rotation axis R3, according to Embodiment 22 of the present invention. The structure of the second toner discharge portion 22073 is the same as that of the above-described (first) toner discharge portion 22070, except for the end portion on the side of the second toner feeding direction CV2, and therefore, a description will be omitted except for the differences from the first toner discharge portion 22070.

As shown in FIG. 135, inside the second toner discharge portion 22073, the toner having passed through the inside of the shutter member 22034 moves in the direction of the second toner discharge portion CV2 (upward in the Figure). Here, the free end portion of the second toner discharge portion 22073 in the neighborhood of the toner discharge opening 22073a is inclined in a tapered shape. Therefore, the moving direction of the toner is restricted by the tapered inclined portion, and the toner is discharged in a toner discharging direction E inclined with respect to the rotation axis R3 of the shutter member 22034. The toner discharging direction E of the toner discharge opening 22073a of the second toner discharge portion 22073 includes a component in a direction parallel to the rotation axis R3 (i.e., the X1 direction) and is a direction toward the rotation axis R3.

With the above-described structure, both the first toner discharge portion 22070 and the second toner discharge portion 22073 in this embodiment are capable of stably discharging (supplying) toner into the process cartridge B side.

Furthermore, the first toner discharge portion 22070 and the second toner discharge portion 22073 in this embodiment are capable of popping out into the interior of the process cartridge B to supply toner when the toner cartridge C22 is mounted to the process cartridge B. Therefore, as compared to the toner cartridge C according to Embodiment 1, the amount of the toner leakage can be reduced.

The shapes of the toner discharge portion and the toner discharge opening are not limited to the above-mentioned examples, and various modifications are usable. For example, the opening of the toner discharge opening may be inclined in the form of taper. In addition, the toner discharge opening may have a shape other than a circle (such as a rectangle). Further, the toner discharge portion may be structured to be capable of being protruded and retracted by a method other than the urging force of the tension spring 22071. For example, a guide portion may be provided on the process cartridge side, and the toner discharge portion may be moved to the operating position in interrelation with the guide portion by rotation of the shutter member.

### Embodiment 23

In the above-described Embodiment 1, a structure for suppressing unnecessary scattering of toner has been described in which the shutter member 34 per se rotates to open and close the toner discharge opening 34a and the shutter inlet 34g provided in the shutter member 34. In this embodiment, an internal shutter mechanism is provided inside the accommodation frame of the toner cartridge. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

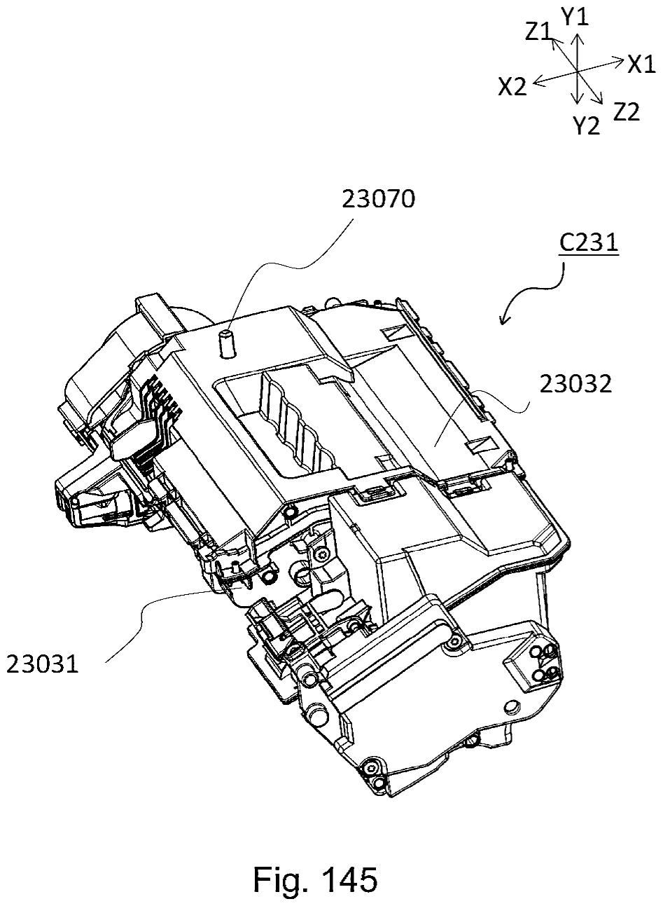

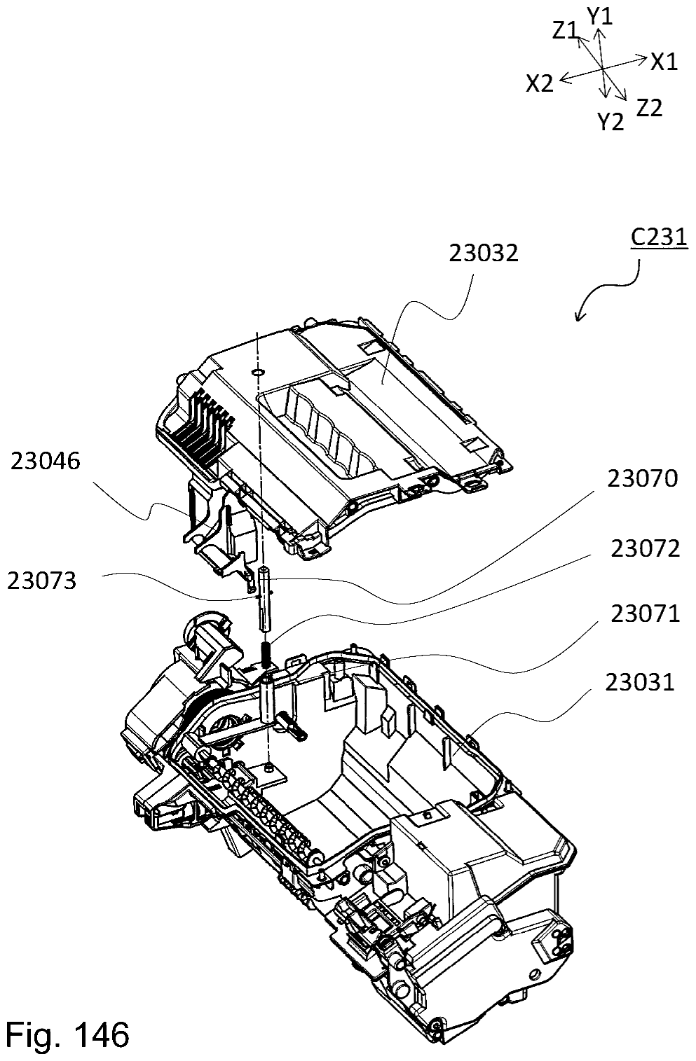

The specific structure of the toner cartridge C231 according to this embodiment will be described. First, referring to FIGS. 145 and 146, the structure of a first internal shutter member 23071 in this embodiment will be described. FIG. 145 is an external perspective view of the toner cartridge C231 according to Embodiment 23 of the present invention. FIG. 146 is a partially exploded perspective view of the toner cartridge C231 according to Embodiment 23 of the present invention, and is an illustration for explaining a method of assembling each part, focusing on the first internal shutter member 23071.

As shown in FIG. 145, in the toner cartridge C231 of this embodiment, an accommodation frame 23031 and an accommodating portion lid 23032 form a frame of the toner cartridge. In addition, in the toner cartridge C231, the free end of the switch member 23070 protrude (is exposed) beyond the upper surface of the accommodating portion lid 23032 in the Y1 direction. As shown in FIG. 146, the switch member 23070, a switch spring 23072, a first internal shutter member 23071, and a partition member 241046 are provided inside the accommodation frame 23031 of the toner cartridge C231. Of these, the switch member 23070, the switch spring 23072, and the first internal shutter member 23071 are arranged coaxially.

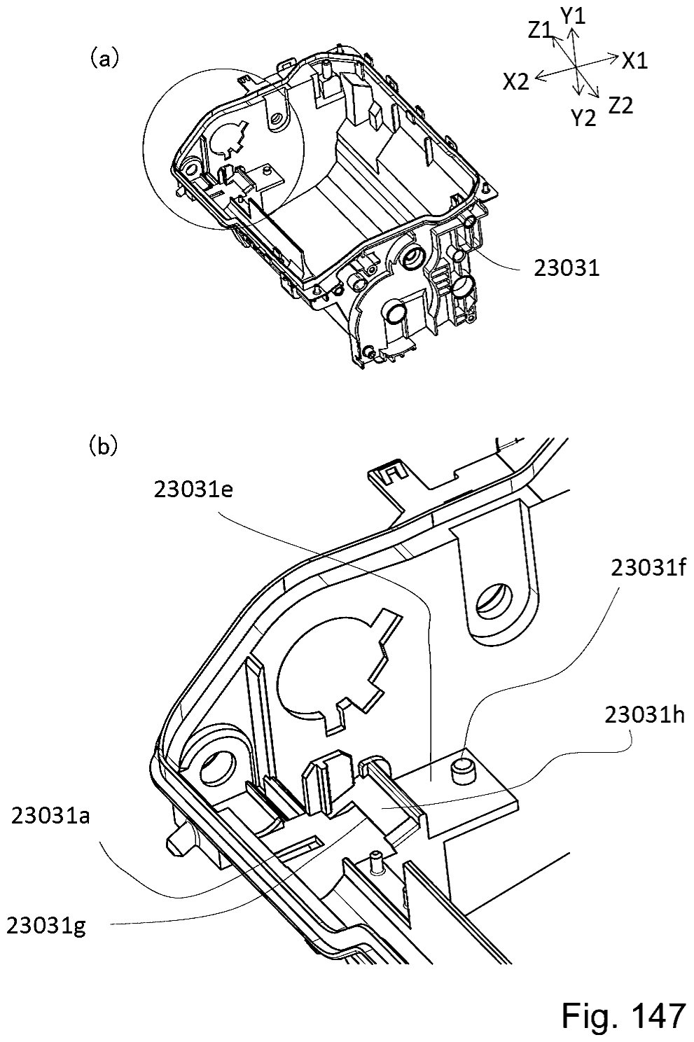

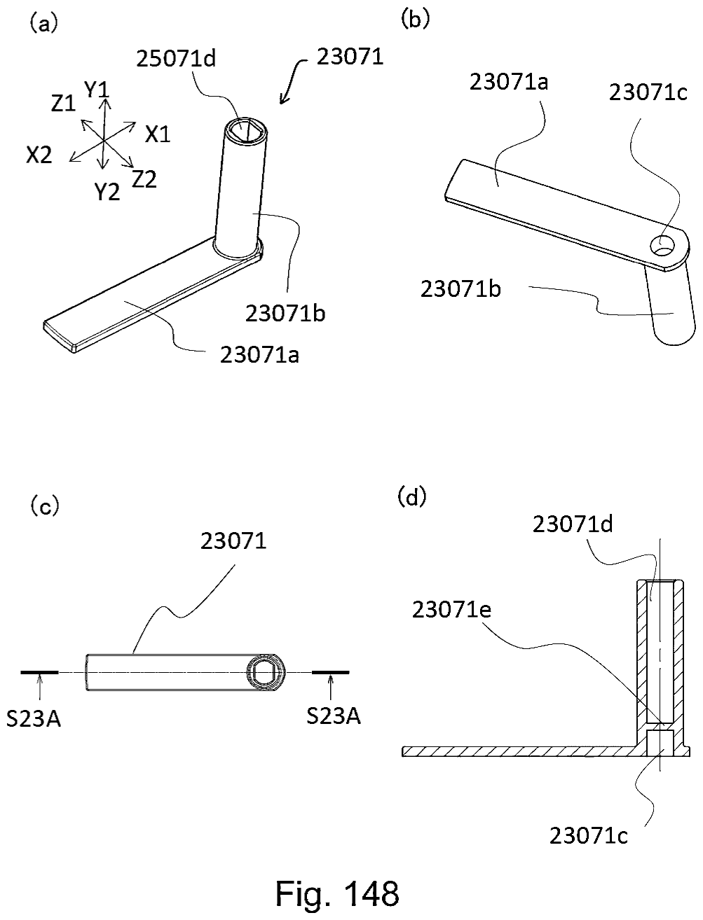

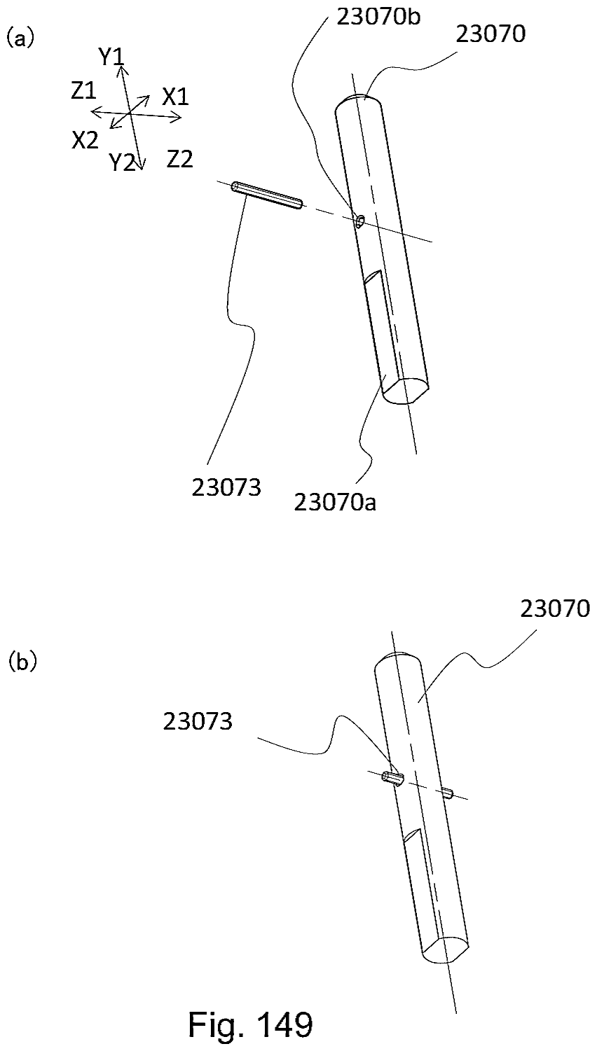

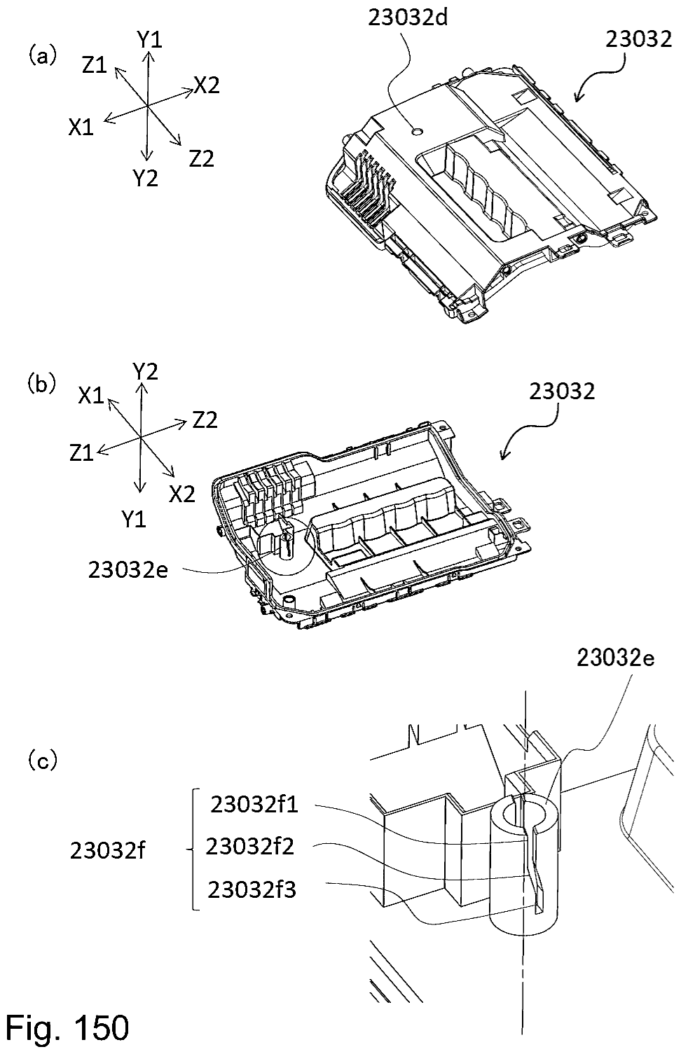

Next, referring to FIGS. 147 to 150, the shapes of the components constituting the toner cartridge C231 will be described. FIG. 147 is an illustration for exemplarily explaining an accommodation frame 23031 according to Embodiment 23 of the present invention. Of these, part (a) of FIG. 147 shows an external perspective view of the accommodation frame 23031, and part (b) of FIG. 147 is an enlarged view the part of the accommodation frame 23031 that is indicated by a solid-line circle shown in part (a) of FIG. 147. In addition, FIG. 148 is an illustration of an example of a first internal shutter member 23071 according to Embodiment 23 of the present invention. Of these, part (a) of FIG. 148 and part (b) of FIG. 148 are external perspective views of the first internal shutter member 23071 as viewed from different directions. In addition, part (c) of FIG. 148 is a side view of the first internal shutter member 23071 as viewed in the Y2 direction (along the Y axis), and part (d) of FIG. 148 is a view taken along a line S23A-S23A shown in part (c) of FIG. 148. FIG. 149 is an illustration of an example of a switch member 23070 in Embodiment 23 of the present invention. Part (a) of FIG. 149 is a perspective view of the switch member 23070 before a parallel pin 23073 is mounted, and part (b) of FIG. 149 is a perspective view of the switch member 23073 with the parallel pin 23073 mounted. FIG. 150 is a view of an example of an accommodating portion lid 23032 in Embodiment 23 of the present invention. Of these, part (a) of FIG. 150 and part (b) of FIG. 150 are external perspective views of the accommodating portion lid 23032 as viewed in different directions, and part (c) of FIG. 150 is an enlarged view of the encircled part in part (b) of FIG. 150.

As shown in part (a) of FIG. 147, the accommodation frame 23031 has substantially the same structure as the accommodation frame 31 of the above-described Embodiment 1, and therefore, in this embodiment, the structure that differs from Embodiment 1 will be specifically described. As shown in part (b) of FIG. 147, the containing frame 23031 has an mounting surface 23031e extending in the X1 direction from the toner supply opening 23031a, and a cylindrical portion 23031f is provided in the neighborhood of the end of the mounting surface 23031e in the X1 direction. The cylindrical portion 23031f is formed so as to project in the Y1 direction. In a direction parallel to the X-axis, between the toner supply opening 23031a and the cylindrical portion 23031f, a wall portion 23031h is provided which is inclined relative to the Y1 direction and the X1 direction. The wall portion 23031h is provided with a hole 23031g in fluid communication in a direction parallel to the X-axis.

Next, as shown in part (a) of FIG. 148, the first internal shutter member 23071 has a flat-plate like shutter portion 241071a. At an end of the shutter portion 23071a, there is provided a first cylindrical portion 23071b projecting in the Y1 direction from the shutter portion 23071a. Inside the first cylindrical portion 23071b, there is provided a cylindrical hole 23071d formed by two parallel planes extending in the Y1 direction. As shown in part (b) of FIG. 148 and part (d) of FIG. 148, one end of the first cylindrical portion 23071b of the shutter portion 23071a is provided with a circular recess 23071c which is coaxial with the first cylindrical portion 23071b. As shown in part (d) of FIG. 148, the first cylindrical portion 23071b and the circular recess 23071c are separated by a wall portion 23071e.

Next, as shown in part (a) of FIG. 149, in the toner cartridge C231, the switch member 23070 has a cylindrical shape extending in the Y direction, and one end thereof in the axial direction is provided with a chamfered portion 23070a which is chamfered by two approximately parallel flat surfaces. In addition, a through hole 23070b is provided which is perpendicular to the axis of the cylindrical shape of the switch member 23070 and intersects with the axis. As shown in part (b) of FIG. 149, the parallel pin 23073 can be pressed into and pass through the through hole 23070b, and is mounted with opposite ends of the parallel pin 23073 projecting beyond the switch member 23070. The switch member 23070 is an actuating portion for actuating the first internal shutter member, and the details of the operation of the first internal shutter member 23070 in interrelation with the operation of the switch member 23070 will be described hereinafter.

Next, the accommodating portion lid 23032 shown in part (a) of FIG. 150 and part (b) of FIG. 150 has approximately the same structure as the accommodating portion lid 32 of the above-described embodiment 1, the structure different will be specifically explained in the following. As shown in part (a) of FIG. 150 and part (b) of FIG. 150, the accommodating portion lid 23032 is provided with a circular hole portion 23032d which penetrates in the Y direction. As shown in part (b) of FIG. 150 and part (c) of FIG. 150, a second cylindrical portion 23032e is provided on the Y2 direction side of the hole portion 23032d so as to extend in the Y2 direction. As shown in part (c) of FIG. 150, the second cylindrical portion 23032e is provided with two guide grooves 23032f extending from the free end in the Y2 direction in the Y1 direction at positions symmetrical with respect to the axis of the second cylindrical portion 23032e. The guide groove 23032f is formed by a first guide groove 23032f1, a second guide groove 23032f2, and a third guide groove 23032f3. The first guide groove 23032f1 and the third guide groove 23032f3 are grooves extending in a direction substantially parallel to the Y axis. In addition, the second guide groove 23032f2 is formed between the first guide groove 23032f1 and the third guide groove 23032f3, and is a groove inclined with respect to the first guide groove 23032f1 and the third guide groove 23032f3. In other words, the second guide groove 23032f2 is a groove inclined at a predetermined angle with respect to the Y axis, and has an inclination of approximately 15° with respect to the Y axis. Specifically, the second guide groove 23032f2 is connected to the third guide groove 23032f3 in a state of being inclined at approximately 15° in the counterclockwise direction with respect to the first guide groove 23032f1. That is, the first guide groove 23032f1, the second guide groove 23032f2, and the third guide groove 23032f3 are groove portions formed continuously.

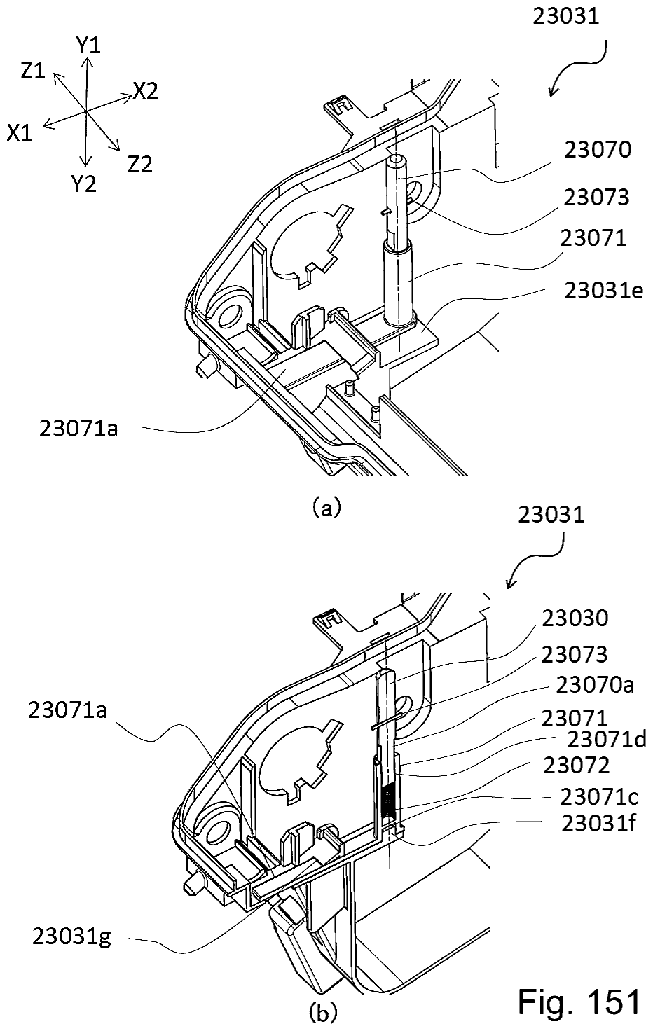

Next, referring to FIG. 151, a method of assembling the first internal shutter member 23071 and the switch member 23070 to the accommodation frame 23031 will be described. FIG. 151 is an illustration of an example of the mounting state of a first internal shutter member 23071 and a switch member 23070 according to Embodiment 23 of the present invention. Of these, part (a) of FIG. 151 is a partial perspective view of the accommodation frame 23031 in a state in which the first internal shutter member 23071 and the switch member 23070 are mounted to the accommodation frame 23031. Also, part (b) of FIG. 151 is a sectional view of the first internal shutter member 23071 shown in part (a) of FIG. 151 taken along the XY plane passing through the center of its axis.

As shown in part (b) of FIG. 151, the shutter portion 23071a of the first internal shutter member 23071 is disposed so as to penetrate the hole portion 23031h provided in the wall portion 23031g of the above-described accommodation frame 23031. That is, in the toner cartridge C231, the shutter portion 23071a and the rotation shaft of the first internal shutter member 23071 are provided on opposite sides of the wall portion 23031g, respectively. This structure makes it possible to prevent toner fed to the toner supply opening 23031a from scattering over the wall portion 23031g toward the rotation shaft side of the first internal shutter member 23071 by the operation of the shutter portion 23071a. In addition, a flexible seal (not shown) is mounted to the Y2 direction surface of the shutter portion 23071a of the first internal shutter member 23071, so that the accommodation frame 23031 and the first internal shutter member 23071 are closely mounted by way of the seal.

Next, the circular recess 23071c of the first internal shutter member 23071 is fitted around the cylindrical portion 23031f of the accommodation frame 23031 in the Y2 direction, and the first internal shutter member 23071 is rotatably supported in the accommodation frame 23031.

In addition, the switch spring 23072 is fitted into the cylindrical hole portion 23071d of the first internal shutter member 23071. Further, the chamfered portion 23070a of the switch member 23070 is inserted into the cylindrical hole portion 23071d of the first internal shutter member 23071. Therefore, the inner periphery of the cylindrical hole portion 23071d and the chamfered portion 23070a come into contact with each other, and the rotational directions of the first internal shutter member 23071 and the switch member 23070 are restricted.

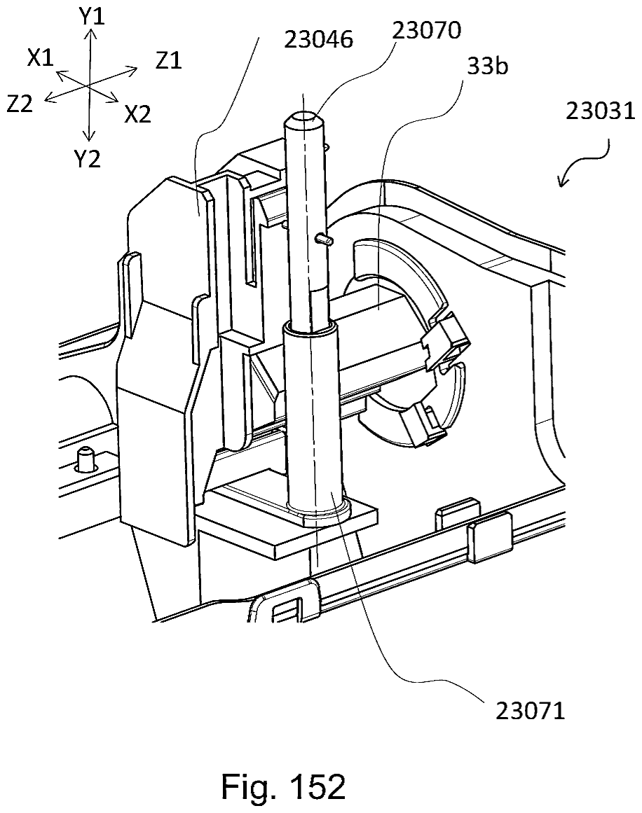

Next, referring to FIG. 152, a method of mounting the partition member 23046 and the nozzle member 33b to the containing frame 23031 will be described. FIG. 152 is a view of an example of mounting positions of the partition member 23046 and the nozzle member 33b to the accommodation frame 23031 in Embodiment 23 of the present invention.

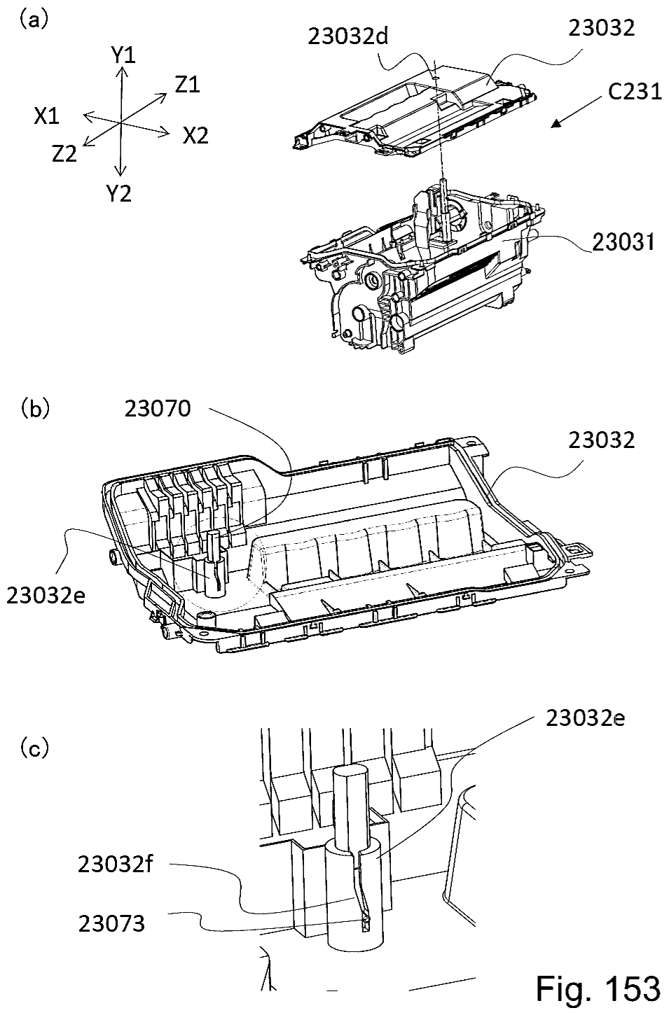

As shown in FIG. 152, a nozzle member 33b having the same structure as that of the previously described Embodiment 1 is mounted to the accommodation frame 23031 facing in the Z1 direction, and the partition member 23046 is mounted on the opposite side to the attachment direction facing in the Y2 direction. The partition member 23046 has substantially the same structure as the partition member 46 of Embodiment 1 described in the foregoing, but has a shape in which a part is cut out to avoid contact (interference) with the first internal shutter member 23071 and with the accommodation frame 23031. Next, referring to FIG. 153, an example of a method for mounting the accommodating portion lid 23032 to the accommodation frame 23031 will be described. FIG. 153 is a view illustrating an example of the mounting position of an accommodating portion lid 23032 with respect to an accommodation frame 23031 in Embodiment 23 of the present invention. Of these, part (a) of FIG. 153 is an exploded perspective view with the accommodating portion lid 23032 removed. Further, part (b) of FIG. 153 is a perspective view of the accommodating portion lid 23032 with the switch member 23070 mounted, as viewed from the bottom side (Y2 direction). Furthermore, part (c) of FIG. 153 is an enlarged view of the encircled part in part (b) of FIG. 153.

As shown in part (a) of FIG. 153, the accommodating portion lid 23032 is mounted to the accommodation frame 23031 so as to face in the Y2 direction. As shown in part (b) of FIG. 153, the switch member 23070 is mounted by penetrating the second cylindrical portion 23032e and the hole portion 23032d of the accommodating portion lid 23032. A seal member (not shown) is mounted between the switch member 23070 and the second cylindrical portion 23032e, so that the switch member 23070 is in close contact with the second cylindrical portion 23032e and can rotate relative to the second cylindrical portion 23032e. In addition, opposite end portions of a parallel pin 23073 mounted to the switch member 23070 are inserted into two guide grooves 23032f provided in the accommodating portion lid 23032, respectively.

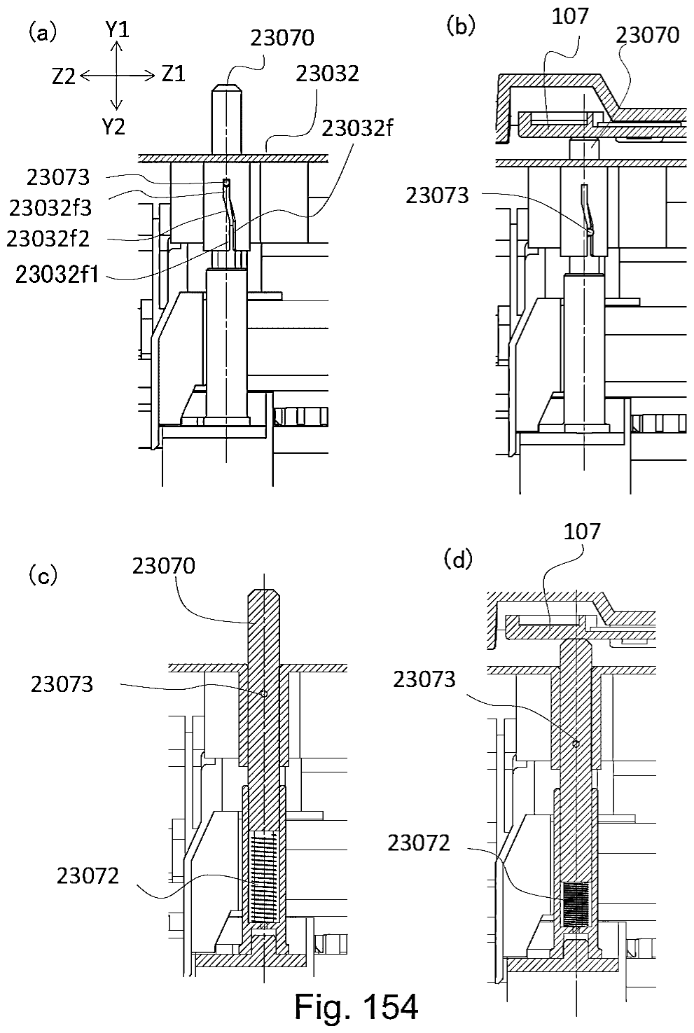

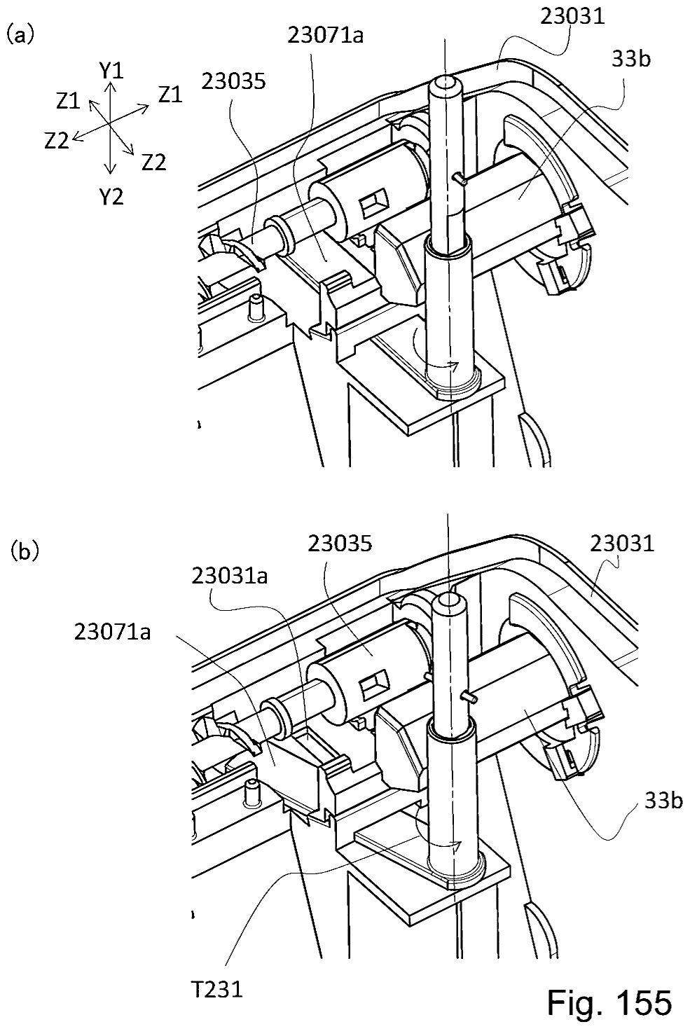

Next, referring to FIGS. 154 and 155, the method of operation of the switch member 23070 and the first internal shutter member 23071 will be described. FIG. 154 is an illustration of an example of a structure in which the switch member 23070 is operated by an opening/closing opening/closing door 107 provided in the printer main assembly A, in Embodiment 23 of the invention. Part (a) of FIG. 154 shows a state in which the opening and closing opening/closing door 107 is open, and part (c) of FIG. 154 shows a sectional view taken along a YZ plane passing through the central axis (rotation axis) of the switch member 23070 in the state of part (a) of FIG. 154. In addition, part (b) of FIG. 154 shows a state in which the opening and closing opening/closing door 107 is closed, and part (d) of FIG. 154 shows a sectional view taken along the YZ plane passing through the central axis (rotation axis) of the switch member 23070 in the state of part (b) of FIG. 154. FIG. 155 is a view illustrating an example of the open/closed state of the first internal shutter member 23071 of the present invention, and is a perspective view with the opening/closing opening/closing door 107 removed for the purpose of explanation, in Embodiment 23. Part (a) of FIG. 155 shows the first internal shutter member 23071 in a closed state (the toner supply opening 23031a is closed), and part (b) of FIG. 155 shows the first internal shutter member 23071 in an open state (the toner supply opening 23031a is open).

As shown in part (a) of FIG. 154 and part (c) of FIG. 154, when the opening and closing opening/closing door 107 is in an open state, the switch member 23070 receives an urging force in the Y1 direction from the switch spring 23072. In this state, the parallel pin 23073 projected from the switch member 23070 by the urging force abuts against the Y1 direction end inside the guide groove 23032f of the accommodating portion lid 23032 and stops. At this time, the switch member 23070 penetrates the accommodating portion lid 23032 (the hole 23032d thereof) and projects in the Y1 direction.

Also, as shown in part (b) of FIG. 154 and part (d) of FIG. 154, in the state that the opening and closing opening/closing door 107 is closed, the switch member 23070 is abutted to by the inner surface of the opening and closing opening/closing door 107 (the surface facing in the Y2 direction (abutment surface)) so that it is pushed in the Y2 direction. When the switch member 23070 is pushed in the Y2 direction, the parallel pin 23073 press-fitted into the switch member 23070 is moved while being guided by the guide groove 23032f of the accommodating portion lid 23032. Specifically, when the opening and closing opening/closing door 107 transitions from an open state to a closed state, the parallel pin 23073 moves sequentially along the third groove portion 23032f3, the second groove portion 23032f2, and the first groove portion 23032f1. At this time, as shown in part (a) of FIG. 155 and part (b) of FIG. 155, when the parallel pin 23073 moves in the second groove portion 23032f2, the switch member 23070 rotates in a T231 direction about own rotation axis thereof.

As shown in part (a) of FIG. 155 and part (b) of FIG. 155, by the switch member 23070 rotating in the T231 direction, the first internal shutter member 23071 which is restricted in the rotational direction as described above also rotates in the same direction as that of the switch member 23070. Then, by this rotation of the first internal shutter member 23071, the shutter portion 23071a is moved to a position where it opens the toner supply opening 23031a of the accommodation frame 23031. The state of the first internal shutter member 23071 shown in part (a) of FIG. 155 is referred to as the closed state, and the state of the first internal shutter member 23071 shown in part (b) of FIG. 155 is referred to as the open state.

As shown in part (a) of FIG. 155, the shutter portion 23071a of the first internal shutter member 23071 is provided on the Y2 direction side with respect to the rotation axis of the toner accommodating portion screw member 23035. The toner accommodating portion screw member 23035 has substantially the same shape as the screw member 35 of Embodiment 1 described in the foregoing, but has a shape in which a part of it is cut away to avoid contact (interference) with the first internal shutter member 23071.

In the toner cartridge C231 according to this embodiment, similarly to Embodiment 1 described in the foregoing, when the pump 37a is operated, the air passes through the nozzle member 33b and is discharged together with the toner from the toner supply opening 23031a.

With the above-described structure, the toner cartridge C231 according to this embodiment is capable of discharging the toner from inside the accommodation frame 23031 when the opening/closing opening/closing door 107 of the printer main assembly A is closed. In other words, even in the case that the toner cartridge C231 in this embodiment is mounted to the printer main assembly A, when the opening/closing opening/closing door 107 is in the open state, the toner supply opening 23031a provided in the accommodation frame 23031 remains closed (sealed). Therefore, the toner cartridge C231 according to this embodiment can prevent unintended leakage and scattering of toner even more effectively than the toner cartridge C according to Embodiment 1 described in the foregoing. For example, even if an impact resulting from a collision between parts is propagated to the toner cartridge C231 when the toner cartridge C231 is mounted to or dismounted from the printer main assembly A, the amount of the toner leakage can be effectively reduced.

In the structure of the toner cartridge C231 described above, it is assumed that the first internal shutter member 23071 is additionally provided in the structure of the shutter member 34 of Embodiment 1 described in the foregoing. However, the first internal shutter member 23071 of the toner cartridge C231 according to this embodiment is also applicable to the case where the toner cartridge C231 is provided with a toner feeding portion different from the shutter member 34 of Embodiment 1 described in the foregoing. For example, even in the case that the shutter inlet (toner receiving entrance) 34g provided in the shutter member 34 is always in an open state, it is possible to suppress leakage of toner by employing the structure of the first internal shutter member 23071.

### Embodiment 24

In the above-described Embodiment 1, a structure for suppressing unnecessary scattering of toner has been described in which the shutter member 34 per se rotates to open and close the toner discharge opening 34a and the shutter inlet 34g provided in the shutter member 34. In this embodiment, another shutter mechanism is provided for the accommodation frame of the toner cartridge. The same components as those in Embodiment 1 will be described with the same reference numerals and symbols as those in Embodiment 1. Furthermore, as for the toner cartridge, the process cartridge, and the printer main assembly, the components having the same functions and roles as those in Embodiment 1 are assigned the same names and like reference numerals and symbols.

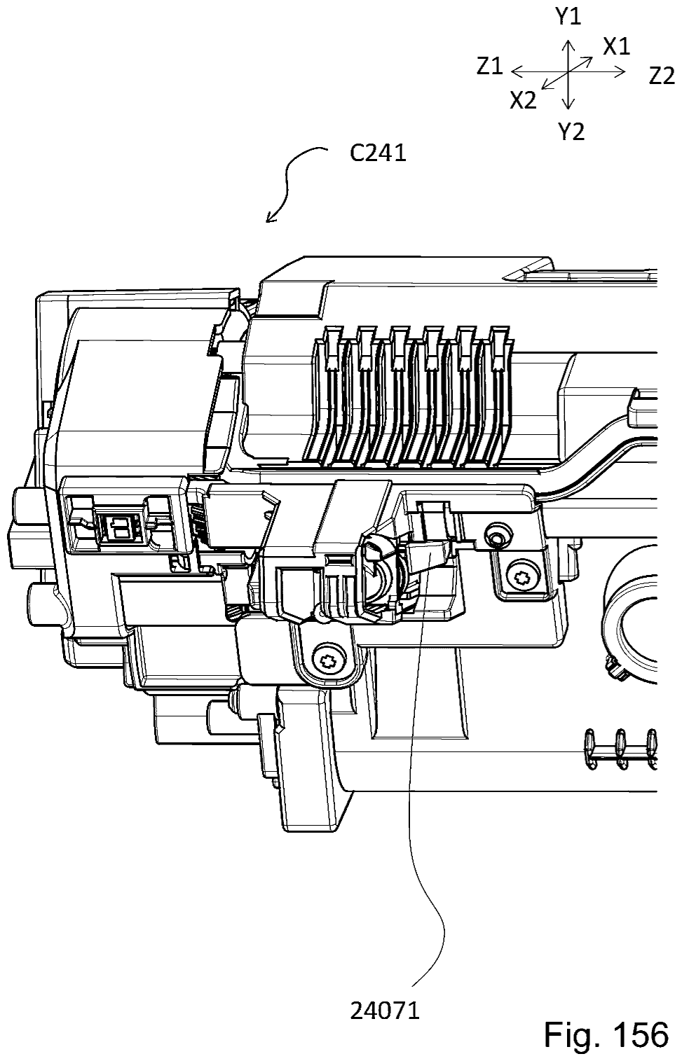

A specific structure of the toner cartridge C241 according to Embodiment 24 of the present invention will be described. FIG. 156 is an external perspective view of a toner cartridge C241 according to Embodiment 4 of the present invention, and for the simplification of explanation, only one end side in the longitudinal direction of the toner cartridge C241 is shown. As shown in FIG. 156, the toner cartridge C241 is provided with a second internal shutter member 24071, a part of which is exposed to the outside on the front side (X2 direction) of the toner cartridge C241.

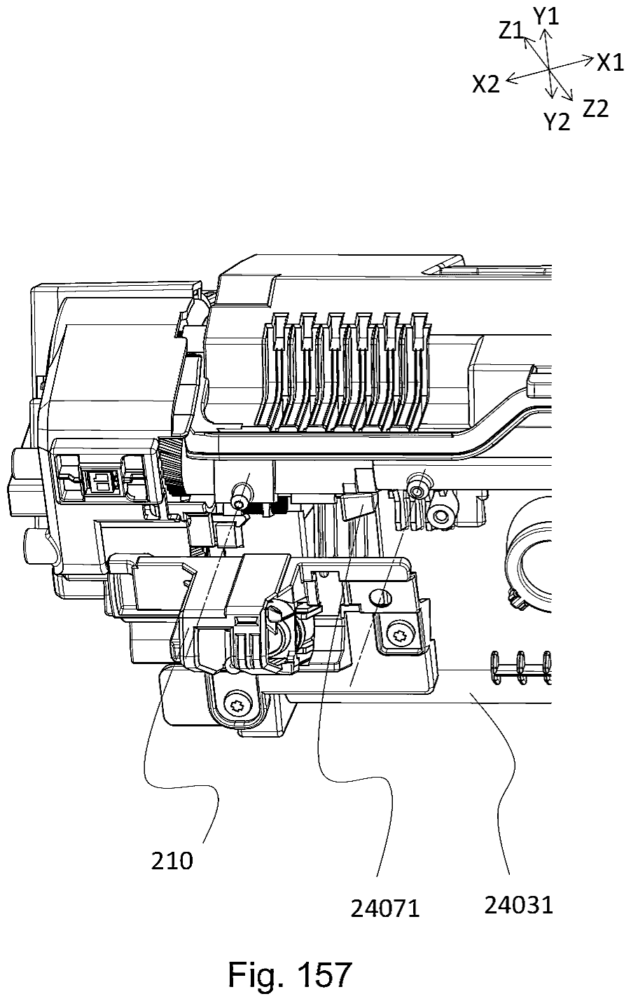

FIG. 157 is an exploded perspective view of the toner cartridge C241 according to Embodiment 24 of the present invention, showing a state in which the shutter protection member 210 has been removed from the accommodation frame 24031. As shown in FIG. 157, the second internal shutter member 24071 is disposed on the front surface side (X2 direction side) of the accommodation frame 24031. The accommodation frame 24031 has substantially the same structure as the accommodation frame 31 of the above-described Embodiment 1, and therefore, in this embodiment, the structures that differ from Embodiment 1 will be specifically described.

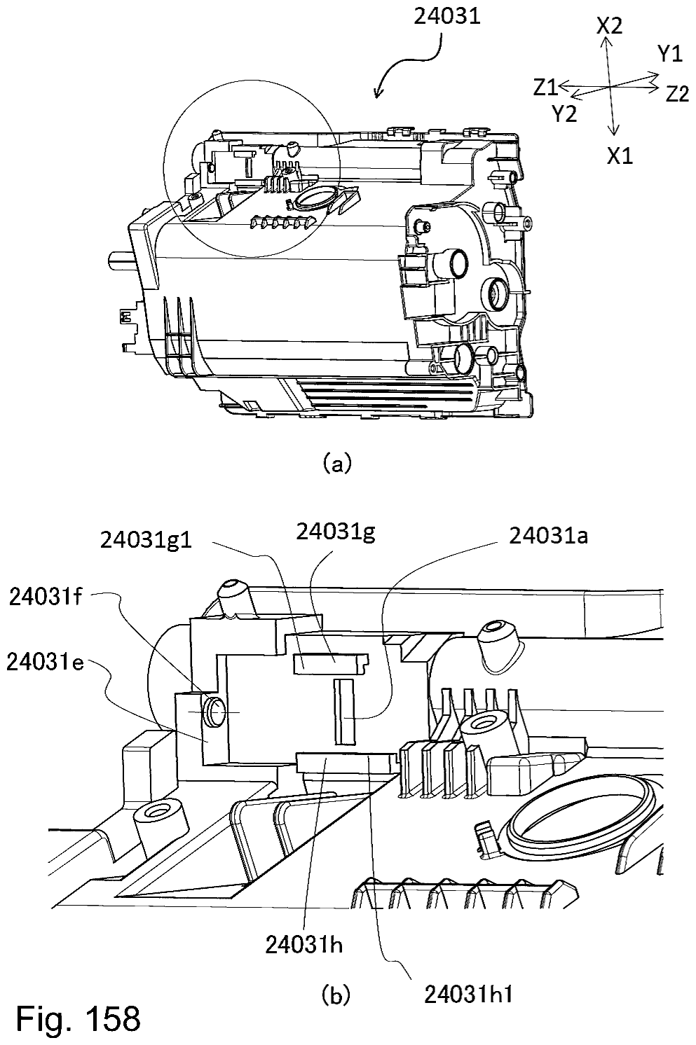

FIG. 158 is an illustration for exemplarily explaining an accommodation frame 24031 according to Embodiment 24 of the present invention. Part (a) of FIG. 158 shows an external perspective view of the accommodation frame 24031, and part (b) of FIG. 158 is an enlarged view of an encircled part of the accommodation frame 24031 shown in part (a) of FIG. 158. As shown in part (b) of FIG. 158, a wall portion 24031e is provided on the toner accommodation frame 24031 in the Z1 direction beyond the toner discharge opening 24031a, and projects in the Y2 direction. In addition, a first cylindrical portion 24031f projecting in the Z2 direction from the wall portion 24031e is formed on the Z2 direction side surface of the wall portion 24031e. Further, a first support portion 24031g is provided on the X2 side relative to the toner discharge opening 24031a, and a second support portion 24031h is provided on the X1 side relative to the toner discharge opening 24031a. In other words, in a direction parallel to the X-axis, a first support portion 24031g and a second support portion 24031h are provided on opposite sides of the toner discharge opening 24031a, respectively, and both support portions project in the Y2 direction. A first support wall 24031g1 is provided at the free end of the first support portion 24031g in the Y2 direction, and projects toward the toner discharge opening 24031a in the X1 direction. Further, a second support wall 24031h1 is provided at the free end of the second support portion 24031h in the Y2 direction, projects towards the toner discharge opening 24031a in the X2 direction.

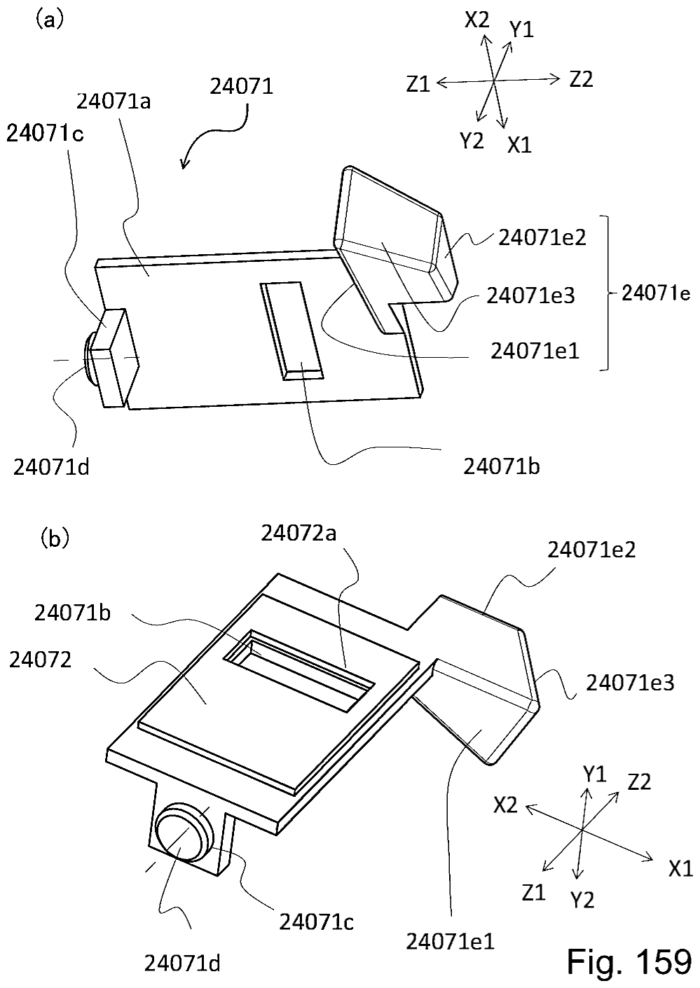

Next, the specific structure of the second internal shutter member 24071 will be described. FIG. 159 is an illustration of an example of a second internal shutter member 24071 used in Embodiment 24 of the present invention, wherein part (a) of FIG. 159 and part (b) of FIG. 159 are external perspective views of the second internal shutter member 24071 as viewed from different directions. As shown in part (a) of FIG. 159 and part (b) of FIG. 159, the second internal shutter member 24071 has a generally flat plate shape having a part which projects in the Y2 direction (when the second internal shutter member 24071 is mounted to the accommodation frame 24031). The second internal shutter member 24071 includes a flat plate portion 24071a having a flat plate shape substantially parallel to the XZ plane. Further, the second internal shutter member 24071 is provided with a rectangular through hole 24071b provided in a region above the flat plate portion 24071a.

Furthermore, a wall portion 24071c projecting in the Y2 direction is provided at the end portion, in the Z1 direction, of the flat plate portion 24071a. In addition, a second cylindrical portion 24071d is provided so as to project in the Z1 direction from the Z1 direction side surface of the wall portion 24071c. Further, a projection 24071e projecting in both the X2 and Y2 directions is provided at the Z2 side end of the second internal shutter member 24071. This projection portion 24071e has a first surface 24071e1 facing in the Z1 direction and perpendicular to the flat plate portion 24071a, and a second surface 24071e2 facing in the Z2 direction and perpendicular to the flat plate portion 24071a. In addition, the first surface 24071e1 and the second surface 24071e2 are connected by a third surface 24071e3, which is an inclined surface facing in the X2 direction. The third surface 24071e3 is an inclined surface that slopes in the X1 direction as goes in the Z2 direction.

A flat seal member 24072 is mounted by adhesive or the like to the Y1 direction side of the flat-plate like portion 24071a. The seal member 24072 has an opening 24072a at the same position as the through hole 24071b of the second internal shutter member 24071.

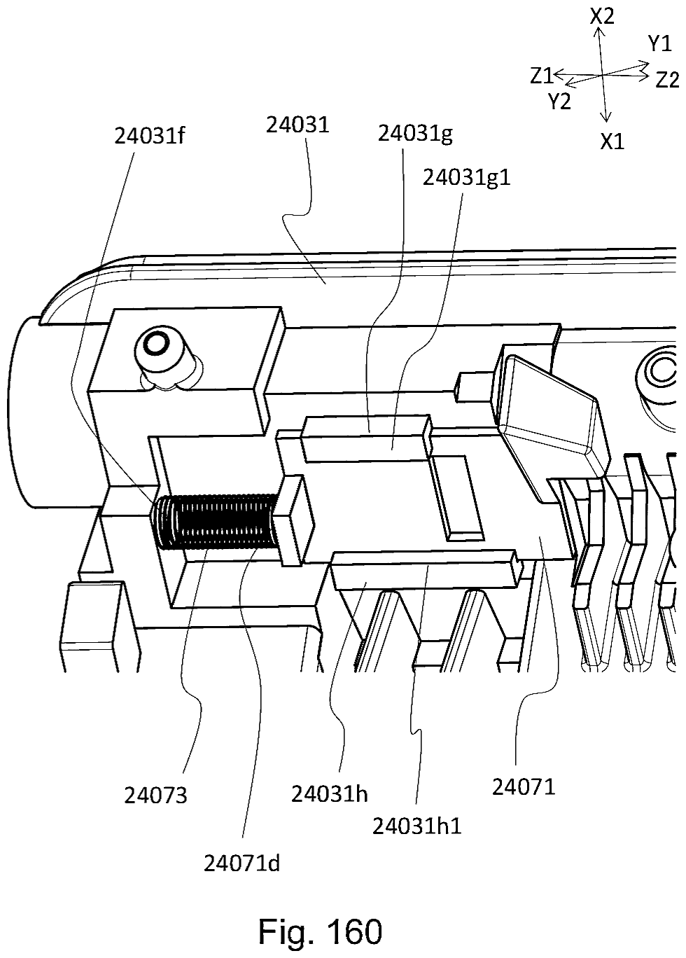

Next, referring to FIG. 160, a method of mounting the second internal shutter member 24071 to the accommodation frame 24031 will be described. FIG. 160 is an enlarged perspective view of the accommodation frame 24031 to which the second internal shutter member 24071 is mounted in Embodiment 24 of the present invention. As shown in FIG. 160, in the accommodation frame 24031, the second internal shutter member 24071 is disposed between the first support portion 24031g and the second support portion 24031h. More specifically, the flat plate portion 24071a of the second internal shutter member 24071 is movably supported so as to be embraced by first support wall 24031g1 of the first support portion 24031g and second support wall 24031h1 of the second support portion 24031h. Therefore, the movement of the second internal shutter member 24071 in directions parallel to the X-axis and Y-axis is restricted by the first support wall 24031g1 and the second support wall 24031h1, so that the second internal shutter member 24071 can only move in a direction parallel to the Z-axis.

As shown in FIG. 160, a compression spring 24073 is press-fitted and supported in a second cylindrical portion 24071d placed at the Z1 direction end of the second internal shutter member 24071. The other end of the compression spring 24073 is fitted into and supported by the first cylindrical portion 24031f of the accommodation frame 24031, so that the second internal shutter member 24071 is pressed (urged) in the Z2 direction.

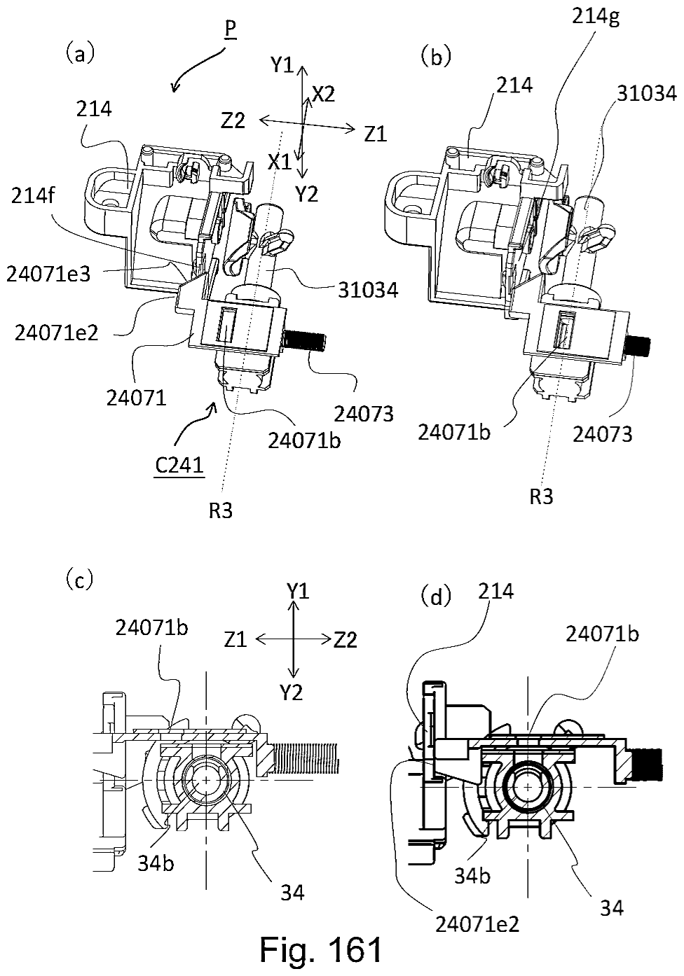

Next, referring to FIG. 161, the opening and closing operation of the second internal shutter member 24071 will be described. FIG. 161 is an illustration of an example of the opening and closing operation of the second internal shutter member 24071 in Embodiment 24 of the present invention. For the sake of explanation, only the members which operate in interrelation with the second internal shutter member 24071 at the time when the toner cartridge C241 is mounted on the process cartridge B are shown. Part (a) of FIG. 161 and part (b) of FIG. 161 are partial perspective views based on the second internal shutter member 24071 in the order of time series when the toner cartridge C241 is mounted to the process cartridge B. Further, part (c) of FIG. 161 and part (d) of FIG. 161 respectively show cross-sectional views taken along the YZ plane passing through the through hole 24071b in part (a) of FIG. 161 and part (b) of FIG. 161.

As shown in part (a) of FIG. 161 and part (c) of FIG. 161, by movement of the toner cartridge C241 in the mounting direction (X2 direction), the third surface 24071e3 of the second internal shutter member 24071 is brought into contact with the first abutment portion 214f of the toner flow passageway member 214 of the process cartridge B. Then, as shown in part (b) of FIG. 161 and part (d) of FIG. 161, as the toner cartridge C241 continues to move in the mounting direction, the second internal shutter member 24071 moves in the Z1 direction along the inclination of the third surface 24071e3. That is, the movement of the toner cartridge C241 in the X-axis direction is converted into movement in the Z-axis direction by the third surface 24071e3 of the second internal shutter member 24071.

At this time, the second internal shutter member 24071 moves in the Z1 direction against the spring pressure of the compression spring 24073. Then, when the second surface 24071e2 of the second internal shutter member 24071 moves until it abuts against the second abutment portion 214g of the toner flow passageway member 214, the movement of the second internal shutter member 24071 in the Z1 direction is completed. At this time, as shown in part (b) of FIG. 161 and part (d) of FIG. 161, the through hole 24071b of the second internal shutter member 24071 moves onto the axis of the shutter member 34 in a direction parallel to the Z axis. More specifically, in the state of the toner cartridge C241 shown in part (b) of FIG. 161 and part (d) of FIG. 161, in the direction parallel to the Z axis, the center of the through hole 24071b of the second internal shutter member 24071 is approximately aligned with the rotation axis R3 of the shutter member 34 and the central axis of the feeding portion 34b. Although a preferred example of the second internal shutter member 24071 has been described, the present invention is not limited to such an example. For example, if the through hole 24071b and the toner discharge opening 34a are structured to be partially communicable in the direction parallel to the Z axis with the toner cartridge C241 mounted in the process cartridge B, then at least the toner transfer is possible.

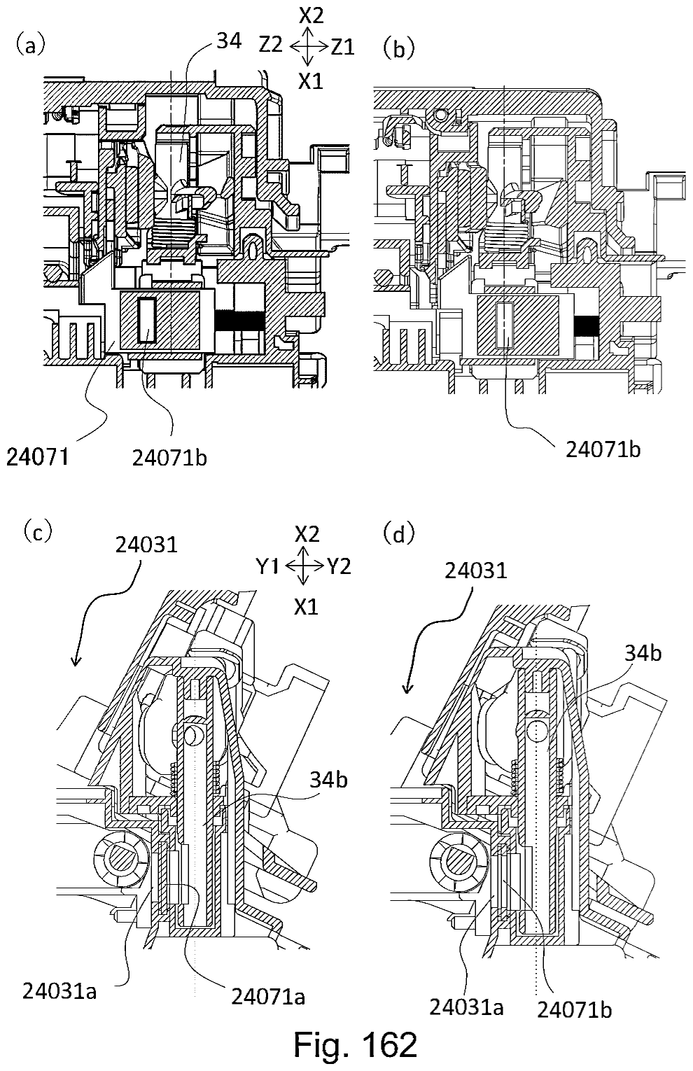

FIG. 162 is an illustration of an example of a toner discharge passageway in the second internal shutter member 24071 in Embodiment 24 of the present invention. Part (a) of FIG. 162 and part (b) of FIG. 162 are sectional views of the toner cartridge C241 taken along an XZ plane facing the through hole 24071b, and the status changes in the order of part (a) and part (b) of the time sequence when the toner cartridge C241 is mounted to the process cartridge B. In addition, part (c) of FIG. 162 and part (d) of FIG. 162 are cross-sectional views taken along the XY plane passing through the central axis of the feeding portion 34b of the shutter member 34, and the status changes in the order of part (c) and part (d) of the time sequence when the toner cartridge C241 is mounted to the process cartridge B.

Part (a) of FIG. 162 and part (b) of FIG. 162, when the second internal shutter member 24071 moves in the Z1 direction in accordance with the mounting operation of the toner cartridge C241 into the process cartridge B, the through hole 24071b moves onto a central axis of the feeding portion 34b of the shutter member 34. At this time, as shown in part (c) of FIG. 162 and part (d) of FIG. 162, the through hole 24071b changes from a state in which it blocks the toner discharge opening 24031a of the accommodation frame 24031 to a state in which it is in fluid communication with the toner discharge opening 24031a. Specifically, when the toner cartridge C241 is not yet mounted to the process cartridge B, the second internal shutter member 24071 closes (blocks) the toner discharge opening 24031a with the flat plate portion 24071a. In interrelation with the operation of mounting the toner cartridge C241 to the process cartridge B, the second internal shutter member 24071 transitions from this state to the state in which the through hole 24071b in fluid communication with the toner discharge opening 24031a. In this state, the toner cartridge C241 is enabled to feed (discharge) the toner from within the accommodation frame 24031 to the shutter member 34 side.

As described above, by providing the second internal shutter member 24071 in addition to the shutter member 34, it is possible to enhance robustness against leakage of toner which may result from impact or the like.

As described above, the toner cartridge C241 according to this embodiment is provided with the internal shutter member capable of opening and closing the discharge opening provided in the accommodation frame 24031 in interrelation with the mounting operation into the process cartridge B. When the toner cartridge C241 is not yet mounted to the process cartridge B, the toner discharge opening 24031a is closed by the internal shutter member (second internal shutter member 24071). With this structure, the toner cartridge C241 according to this embodiment can effectively prevent toner leakage resulting from an external impact onto the toner cartridge C241, for example. In other words, by providing the toner cartridge C241 according to this embodiment with the second internal shutter member 24071, the robustness against toner leakage can be enhanced. Therefore, even if an impact due to an external collision or the like is transmitted to the toner cartridge C241 when the toner cartridge C241 is mounted to or dismounted from the process cartridge B, for example, the amount of the toner leakage caused by the impact can be reduced.

In the structure of the toner cartridge C241 described above, it is assumed that a second internal shutter member 24071 is additionally provided in the structure of the shutter member 34 of Embodiment 1 described in the foregoing. However, the second internal shutter member 24071 of the toner cartridge C241 according to this embodiment is also applicable to a case where the toner cartridge C241 is provided with a toner feeding portion different from the shutter member 34 of Embodiment 1 described in the foregoing. For example, even if the shutter inlet (toner receiving entrance) 34g provided in the shutter member 34 is always in an open state, it is possible to suppress leakage of toner by employing the structure of the second internal shutter member 24071.

### Embodiment 25

In the above-described Embodiment 1, a structure has been described in which the shutter member 34 per se rotates in interrelation with the mounting and dismounting of the toner cartridge C with respect to the process cartridge B, thereby opening and closing the toner discharge opening 34a and the shutter inlet 34g provided in the shutter member 34. In this embodiment, a structure will be described in which the toner discharge opening opens and closes in interrelation with the toner cartridge receiving a driving force from the printer main assembly. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

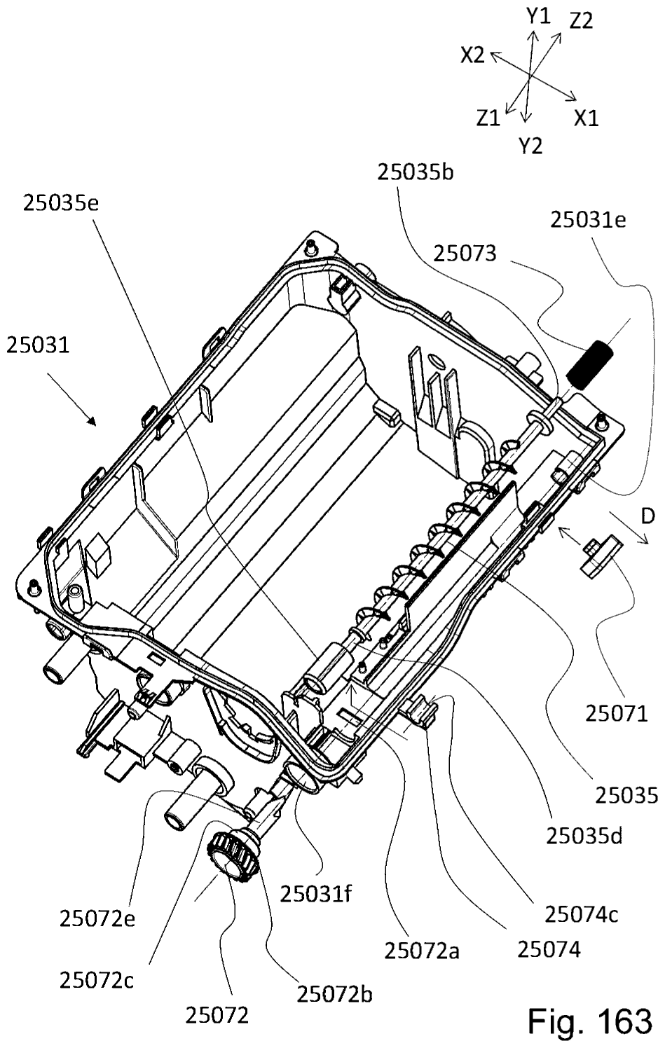

A specific structure of the toner cartridge C251 according to Embodiment 25 of the present invention will be described below. FIG. 163 is an exploded perspective view for illustrating each portion connected to the accommodation frame 25031 of the toner cartridge C251 according to Embodiment 25 of the present invention. For the purpose of explanation, some of the components constituting the toner cartridge C251 are omitted in the Figure. As shown in FIG. 163, a brake member 25071, a toner accommodating portion screw member 25035, a screw gear 25072, a screw spring 25073, and a second shutter member 25074 are mounted to the accommodation frame 25031 of the toner cartridge C251. The components connected to the accommodation frame 25031 will be described in detail hereinafter.

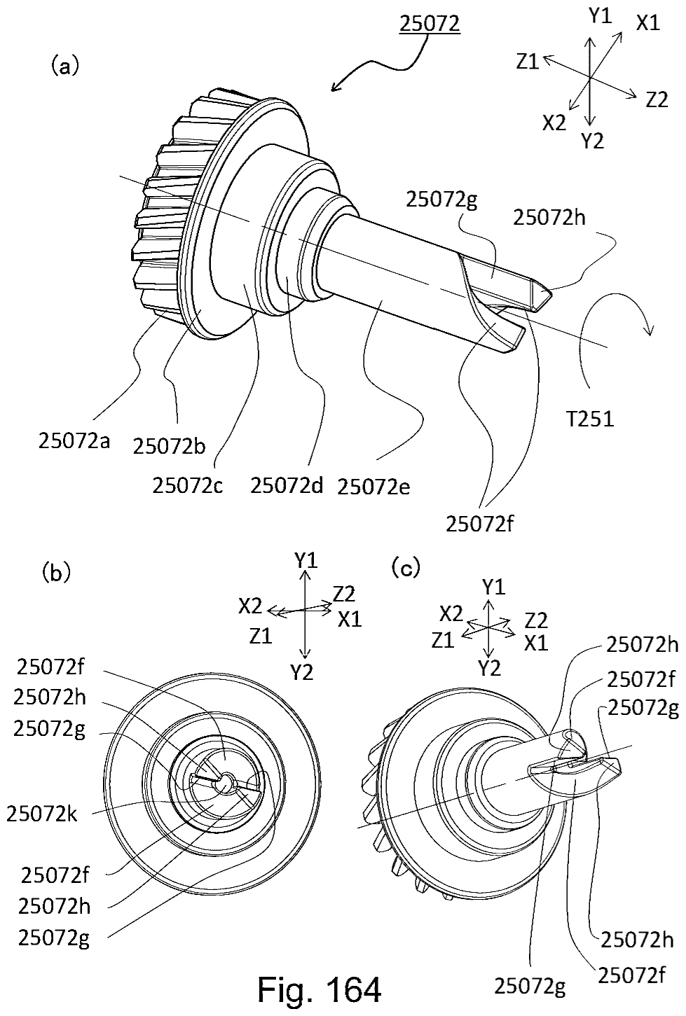

FIG. 164 is a view illustrating the details of a screw gear 25072 according to Embodiment 25 of the present invention, wherein part (a) of FIG. 164, part (b) of FIG. 164, and part (c) of FIG. 164 are external perspective views of the screw gear 25072 as viewed in different directions. As shown in each drawing of FIG. 164, the screw gear 25072 has a generally cylindrical shape and includes a cylindrical portion having diameters (measured in the direction perpendicular to the Z axis) different along the Z axis direction. Specifically, the screw gear 25072 is provided with a helical gear portion 25072a at the end side in the Z1 direction. In addition, a flange portion 25072b is provided continuously extended from the helical gear portion 25072a in the Z2 direction, and has a disk shape having a larger diameter than the helical gear portion 25072a. Further, a first cylindrical portion 25072c and a second cylindrical portion 25072d are provided continuously from the flange portion 25072b in the Z2 direction. The first cylindrical portion 25072c and the second cylindrical portion 25072d both have a smaller diameter than the flange portion 25072b, and the first cylindrical portion 25072c has a larger diameter than the second cylindrical portion 25072d. Furthermore, a first cylindrical portion 25072e which is provided continuously from the second cylindrical portion 25072d in the Z2 direction has a smaller diameter than the second cylindrical portion 25072d. All of the portions constituting the screw gear 25072 described above rotate about the same axis.

As shown in part (b) of FIG. 164, a circular recess 25072k is provided at the end of the first cylindrical portion 25072e in the Z2 direction and is centered on the rotation axis of the screw gear 25072 and recessed in the Z1 direction. In addition, there are provided a first inclined surface portion 25072f which is twisted in the rotational direction so as to surround the circular recess 25072k, and a first surface 25072g which is parallel to the Z-axis direction and faces the rotational direction T251. A second surface 25072h connecting the first inclined surface portion 25072f and the first surface 25072g with each other is provided at two locations symmetrical with respect to the rotation axis of the screw gear 25072.

The toner accommodating portion screw member 25035 in this embodiment, like the toner accommodating portion screw member 35 in Embodiment 1 described in the foregoing, can be rotated (driven) by the driving force received by the pump-screw coupling portion 39a from the printer main assembly A. That is, the driving force received by the pump-screw coupling portion 39a is transmitted to the screw gear 25072 by way of the gear portion of the pump unit 37, so that the toner accommodating portion screw member 2035 can rotate. In order to enable movement of the toner accommodating portion screw member 2035 (which will be described hereinafter) in a direction parallel to the Z axis, the gear portion of the screw gear 25072 employs a helical gear such as the helical gear portion 25072a described above. Therefore, the gear portion of the pump unit 37 in this embodiment has a gear shape which matches the shape of the screw gear 25072.

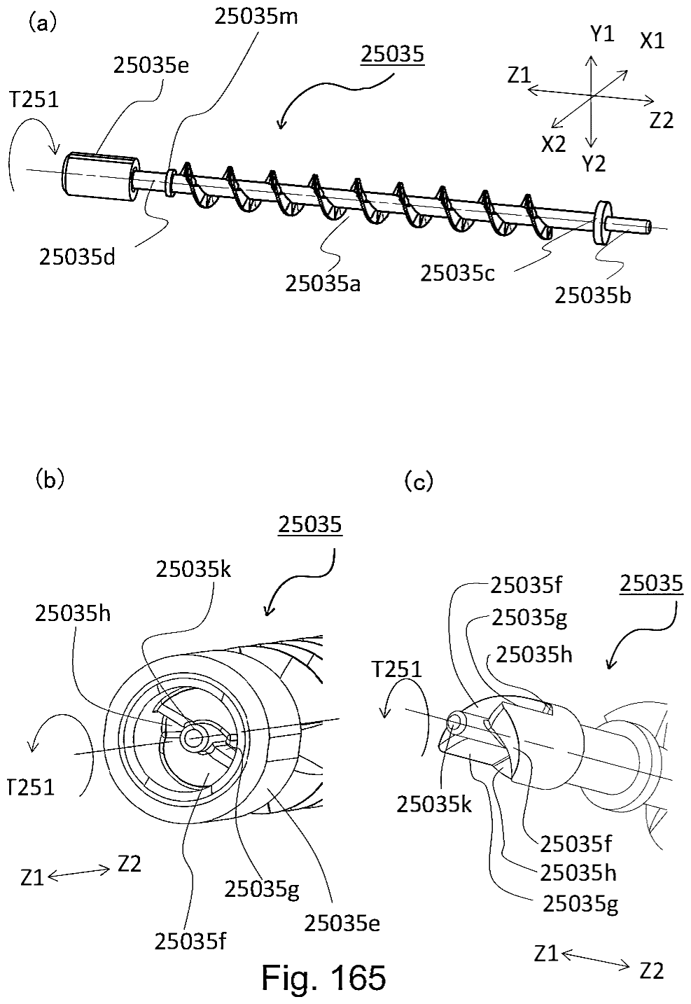

FIG. 165 is an illustration for illustrating an example of the structure of a toner accommodating portion screw member 25035 in Embodiment 25 of the present invention. Part (a) of FIG. 165 is an external perspective view of the toner accommodating portion screw member 25035. Part (b) of FIG. 165 is an enlarged perspective view of the toner accommodating portion screw member 25035 as viewed in the Z1 direction. Also, part (c) of FIG. 165 is a perspective view for illustrating the internal structure of the cylindrical end portion 25035e of the toner accommodating portion screw member 25035, and shows a state in which the cylindrical end portion 25035e has been removed for the purpose of better illustration. In addition, the toner accommodating portion screw member 25035 according to this embodiment has substantially the same shape as the toner accommodating portion screw member 35 of the above-described Embodiment 1, and therefore, only the structure different from Embodiment 1 will be described in this embodiment.

As shown in part (a) of FIG. 165, the toner accommodating portion screw member 25035 has a cylindrical shape extending in a direction parallel to the Z axis. The toner accommodating portion screw member 23035 includes, in the order from the Z2 direction end in the Z direction, a third cylindrical portion 25035b, a first disk portion 25035c, a screw portion 25035a, a second disk portion 25035m, a fourth cylindrical portion 25035d, and a cylindrical end portion 25035e. The components constituting the toner accommodating portion screw member 25035 are formed so as to be rotatable coaxially. The diameter (in a direction perpendicular to the Z axis) of the first disk portion 25035c is larger than that of the third cylinder portion 25035b, and the diameters of the second disk portion 25035m and the cylindrical end portion 25035e are larger than those of the second cylindrical portion 25035d. Also, as shown in part (b) of FIG. 165 and part (c) of FIG. 165, the cylindrical end portion 25035e has an end on the Z1 side which is recessed in the Z2 direction, and inside the recessed portion, there is provided is a cylindrical projection 25035k which is rotatable coaxially with the screw portion 25035a and projects in the Z1 direction. In addition, there are provided a second inclined surface portion 25035f which is twisted in the rotational direction so as to surround the cylindrical projection 25035k, and a third surface 25035g which is parallel to the Z-axis direction and faces the rotational direction T251. A fourth surface 25035h connecting the second inclined surface portion 25035f and the third surface 25035g is provided at two locations symmetrical with respect to the rotation axis of the toner accommodating portion screw member 25035.

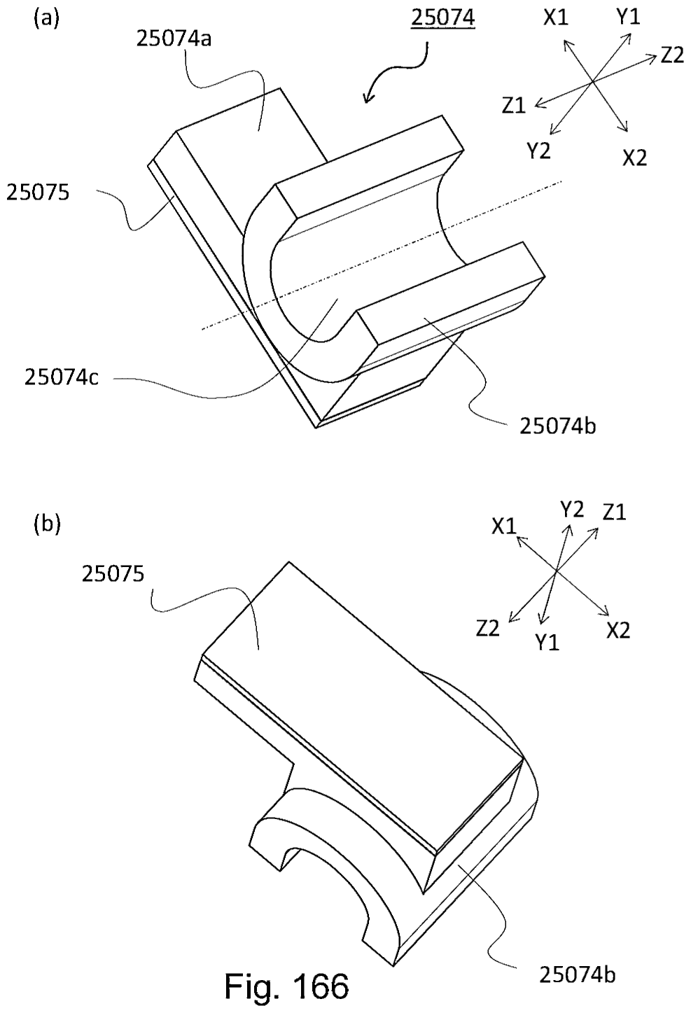

Next, referring to FIGS. 166 and 67, the second shutter member 25074 according to this embodiment will be described in detail. FIG. 166 is a perspective view of the second shutter member 25074 according to Embodiment 25 of the present invention, and part (a) of FIG. 166 and part (b) of FIG. 166 show the second shutter member 25074 as viewed in different directions. As shown in part (a) of FIG. 166 and part (b) of FIG. 166, the second shutter member 25074 has a first flat plate portion 25074a which is parallel to the XZ plane and faces in the Y1 direction. The X2-direction end of this first flat plate portion 25074a is provided with a U-shaped projecting portion 25074b which projects in the Y1 direction and has a U-shape having a width measured in the direction parallel to the Z axis is greater than that of the first flat plate portion 25074a. This U-shaped portion is provided with a U-shaped groove portion 25074c which is recessed in the Y2 direction and is placed on a downstream side, in the X1 direction, of the U-shaped projection portion 25074b. The bottom of the U-shaped groove 25074c is semicircular, and the central axis of the semicircle is parallel to the Z-axis. As shown in part (b) of FIG. 166, a flexible seal member 243075 formed to match the shape of the first flat plate portion 25074a is mounted to the Y2 direction side of the first flat plate portion 25074a.

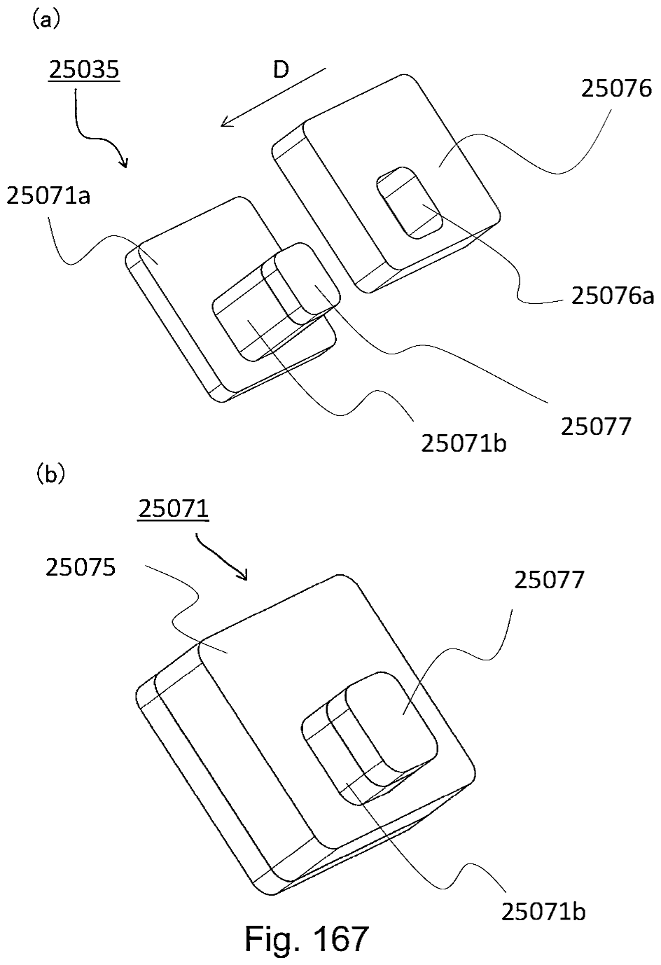

FIG. 167 is a perspective view of the brake member 25071 in Embodiment 25 of the present invention, wherein part (a) of FIG. 167 and part (b) of FIG. 167 show the brake member 25071 as viewed in different directions. part (a) of FIG. 167 shows the state before the flexible sheet member 25076 is mounted to the brake member 25071, and part (b) of FIG. 167 shows the state after the flexible sheet member 25076 is mounted to the brake member 25071.

As shown in part (a) of FIG. 167, the brake member 25071 has a second flat plate portion 25071a. A rectangular projecting portion 25071b (shaped like a square boss) is provided in a direction perpendicular to the second flat plate portion 25071a. An contact portion 25077 is provided at the free end of the rectangular projecting portion 25071b. A flexible sheet member 25076 is mounted on the surface of the second flat plate portion 25071a on which the rectangular projecting portion 25071b is provided. The flexible sheet member 25076 has a flat plate shape and is provided with a rectangular (square hole in this embodiment) through hole 25076a. The flexible sheet member 25076 is mounted so that the rectangular projecting portion 25071b passes through the through hole 25076a in a direction perpendicular to the second flat plate portion 25071a (the direction of arrow D in the Figure), and is fixed to the second flat plate portion 25071a (by bonding with any adhesive, and so on).

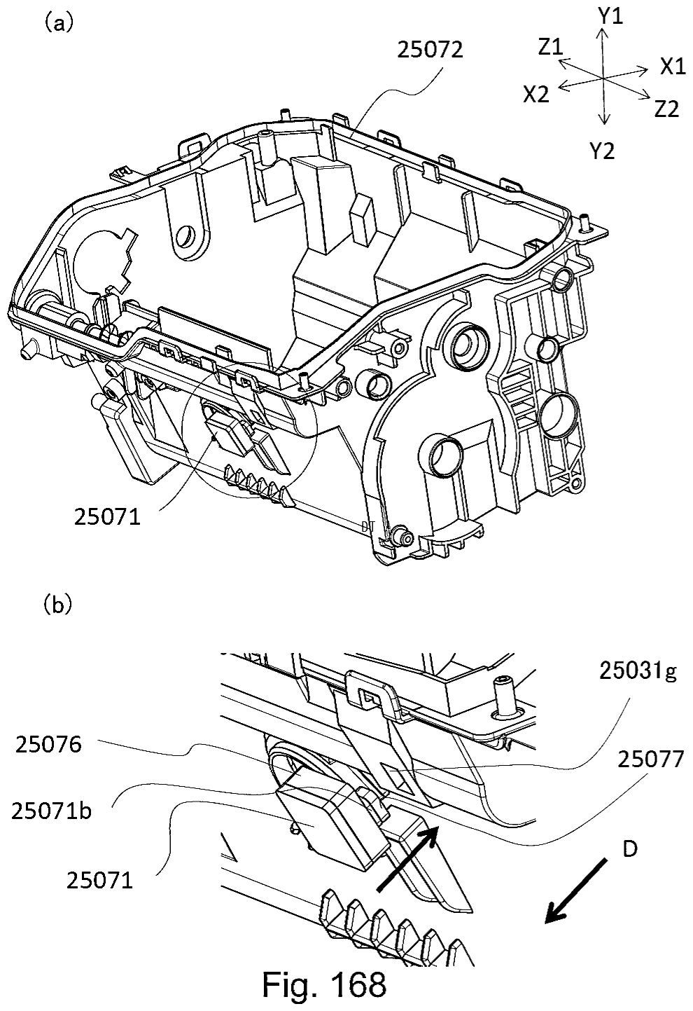

Next, referring to FIG. 163, the assembling of the various portions constituting the toner cartridge C251 in this embodiment will be described. As shown in FIG. 163 and part (a) of FIG. 168, the accommodation frame 25031 has a hollow tub shape, and is provided with a second cylindrical portion 25031e extending in the Z1 direction on its Z2 end surface. At the Z1 direction end, a second cylindrical portion 25031e having a hollow interior is provided. In addition, a through hole 25031f coaxial with the second cylindrical portion 25031e is provided at the Z1 side end of the accommodation frame 25031.

As shown in FIG. 163, a screw spring 25073, which is a compression spring capable of expanding and contracting in a direction parallel to the Z axis, is fitted around the outer circumferential portion of the second cylindrical portion 25031e. In addition, the first cylindrical portion 25035b of the toner accommodating portion screw member 25035 is fitted into the second cylindrical portion 25031e at the inside the accommodation frame 25031, from the Z1 direction side. Further, a U-shaped groove portion 25074c of the shutter member 25074 is disposed at the lower portion (Y2 direction side) of the second cylindrical portion 25035d of the toner accommodating portion screw member 25035. The U-shaped groove portion 25034c is fitted so as to face the Y1 direction with respect to the rotation axis of the toner accommodating portion screw member 25035, and is rotatable coaxially with the rotation axis of the toner accommodating portion screw member 25035. The width of the second cylindrical portion 25035d of the toner accommodating portion screw member 25035 measured in a direction parallel to the Z axis is approximately the same as the width of the U-shaped groove portion 25074c of the shutter member 25074 measured in a direction parallel to the Z axis. With the above-described structure, the shutter member 25074 moves integrally with the toner accommodating portion screw member 25035 in the direction parallel to the Z axis.

Next, as shown in FIG. 163, the screw gear 25072 is mounted to the through hole 25031f from the outside of the accommodation frame 25031 toward the Z2 direction. At this time, a first cylindrical portion 25072e, which is a free end portion of the screw gear 25072 projecting in the Z2 direction, is inserted into the cylindrical end portion 25035e of the toner accommodating portion screw member 25035. The engagement relationship between the screw gear 25072 and the toner accommodating portion screw member 25035 will be described in detail hereinafter.

Furthermore, as shown in FIG. 163, the first cylindrical portion 25072c of the screw gear 25072 is inserted into the through hole 25031f, and the screw gear 25072 moves in the Z2 direction in a direction parallel to the Z axis until it abuts against the flange portion 25072b. In this state, the first cylindrical portion 25072c is rotatably supported in the through hole 25031f. As shown in FIG. 163, the toner accommodating portion screw member 25035 and the screw gear 25072 are urged in the Z1 direction by the urging force produced by the screw spring 25073. Although not shown, when the toner cartridge C251 is assembled, the screw gear 25072 abuts against the cam gear 37b (see FIG. 42, and so on) of the pump unit 37, thereby being restricted its position in the Z1 direction. As shown in FIG. 163, a brake member 25071 is mounted to the front side (the surface on the X1 direction side) of the accommodation frame 25031, facing in the X2 direction.

Referring to FIG. 168, a method for mounting the brake member 25071 to the accommodation frame 25031 will be described. FIG. 168 is a view illustrating an example of a method of mounting a brake member 25071 to an accommodation frame 25031 in Embodiment 25 of the present invention. Part (a) of FIG. 168 is an external perspective view illustrating a state in which a brake member 25071 is mounted to an accommodation frame 25031, and for the purpose of better illustration, shows a state in which members other than the accommodation frame 25031 and the brake member 25071 have been removed. Part (b) of FIG. 168 is an enlarged view of the part encircled in part (a) of FIG. 168. As shown in part (b) of FIG. 168, rectangular through hole 25031g is provided on the side of the accommodation frame 25031 in the direction of arrow D (direction X2). The rectangular projecting portion 25071b of the brake member 25071 is inserted into this rectangular through hole 25031g in the X2 direction. The state in which the flexible sheet member 25076 is in pressure contact with the accommodation frame 25031 around the rectangular through hole 25031g is the state in which the insertion of the rectangular projecting portion 25071b is completed. In this state, the flexible sheet member 25076 is fixed to the accommodation frame 25031 by adhesive or the like, thereby completing the attachment of the brake member 25071 to the accommodation frame 25031.

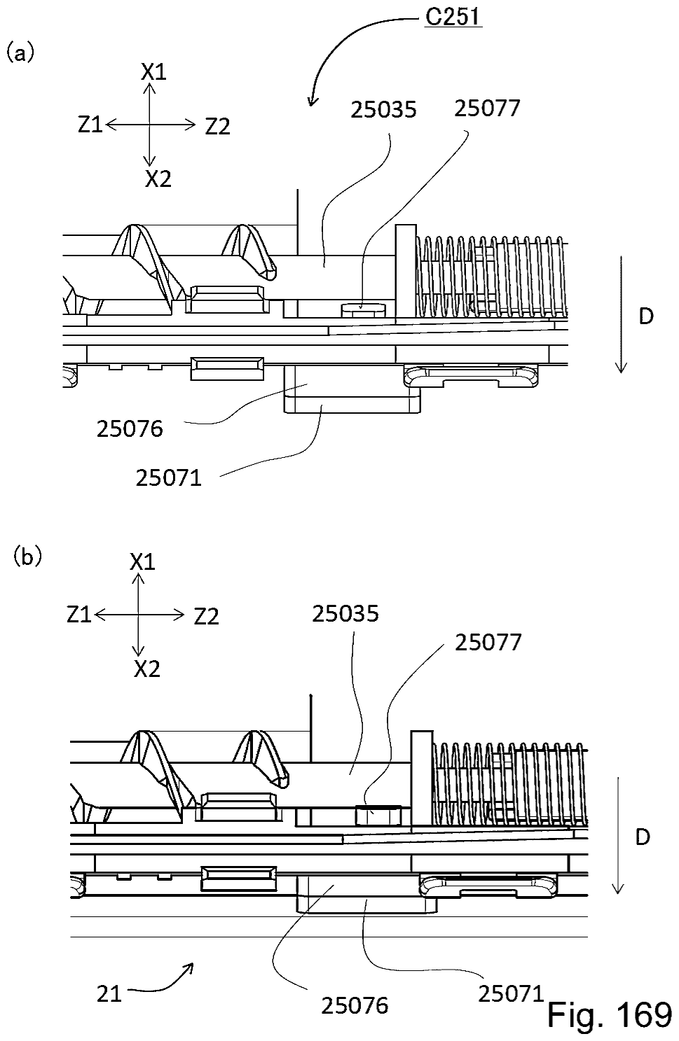

Next, referring to FIG. 169, the operation of the brake member 25071 will be described. FIG. 169 is an illustration of an example of the operation of the brake member 25071 in Embodiment 25 of the present invention. Each of part (a) of FIG. 169 and part (b) of FIG. 169 is a side view of the major portions of toner cartridge C251 as toner cartridge C251 is viewed along the Y axis with the brake member 25071 at the center. Part (a) of FIG. 169 shows the state before the toner cartridge C251 is mounted in the printer main assembly A, and part (b) of FIG. 169 shows the state after the toner cartridge C251 is mounted in the printer main assembly A. As shown in part (b) of FIG. 169, when the toner cartridge C251 is mounted in the printer main assembly A (with the process cartridge B mounted), the brake member 25071 comes into contact with the stay 21 of the process cartridge B. When the brake member 25071 is pressed against the accommodation frame 25031 in the direction opposite to the arrow D in the Figure (X1 direction) by this contact, the flexible sheet member 25076 is compressed and moves until the contact portion 25077 is brought into contact with the toner accommodating portion screw member 25035.

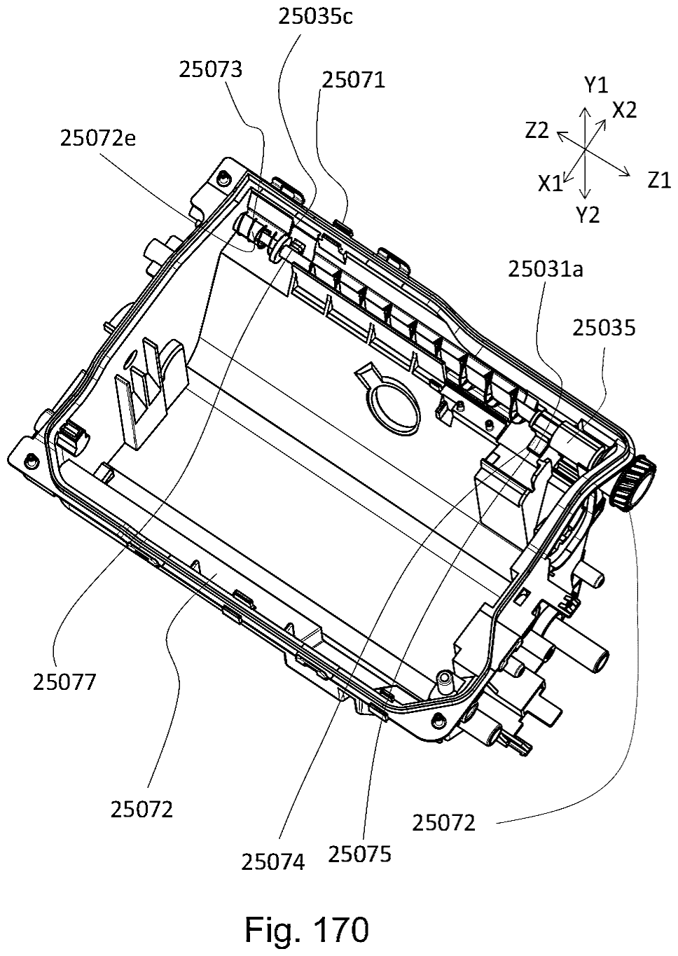

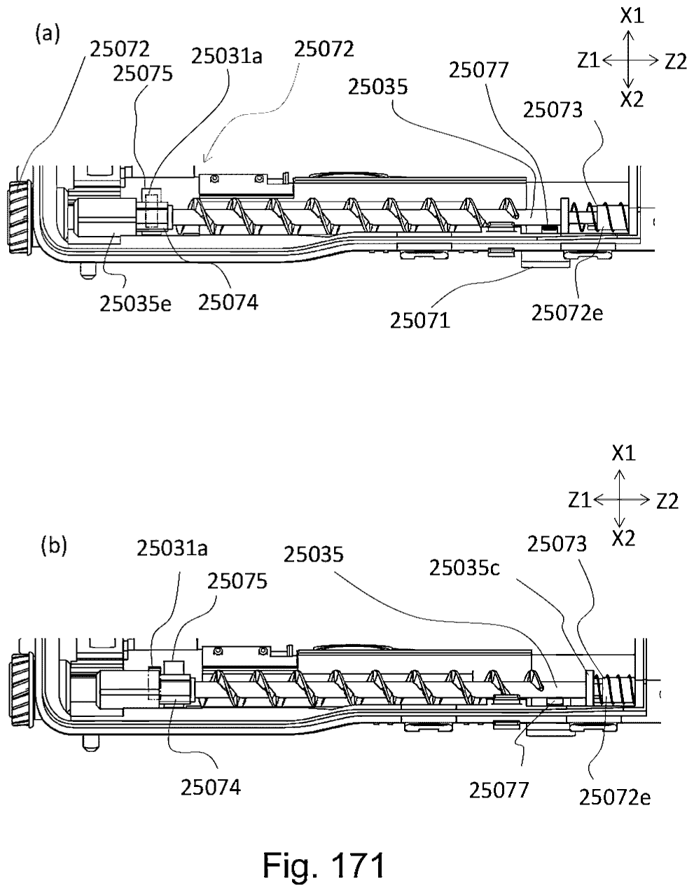

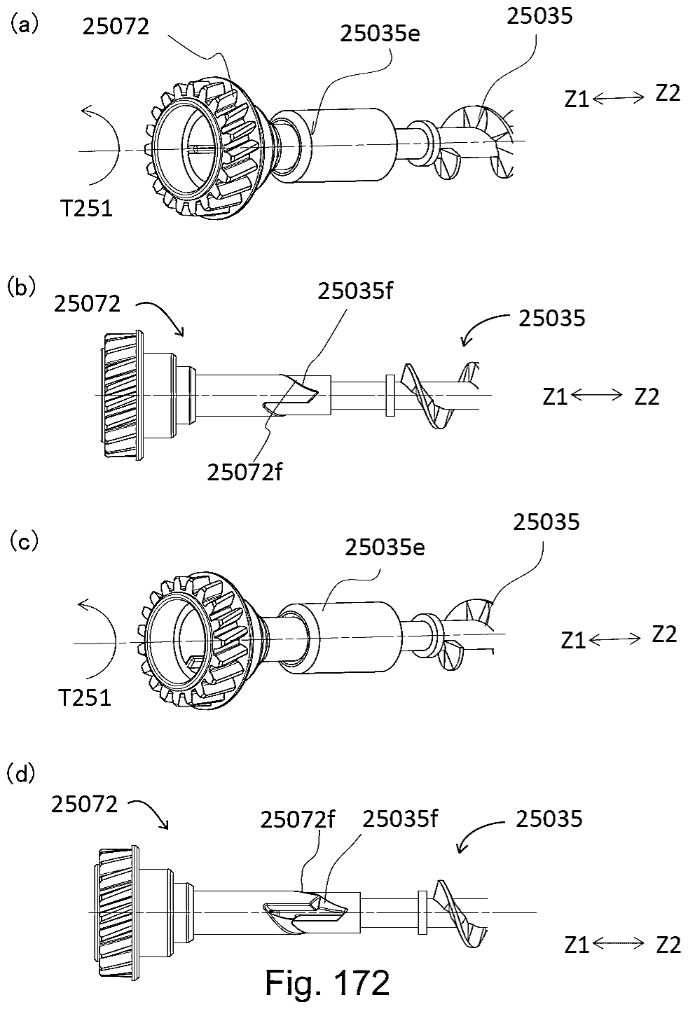

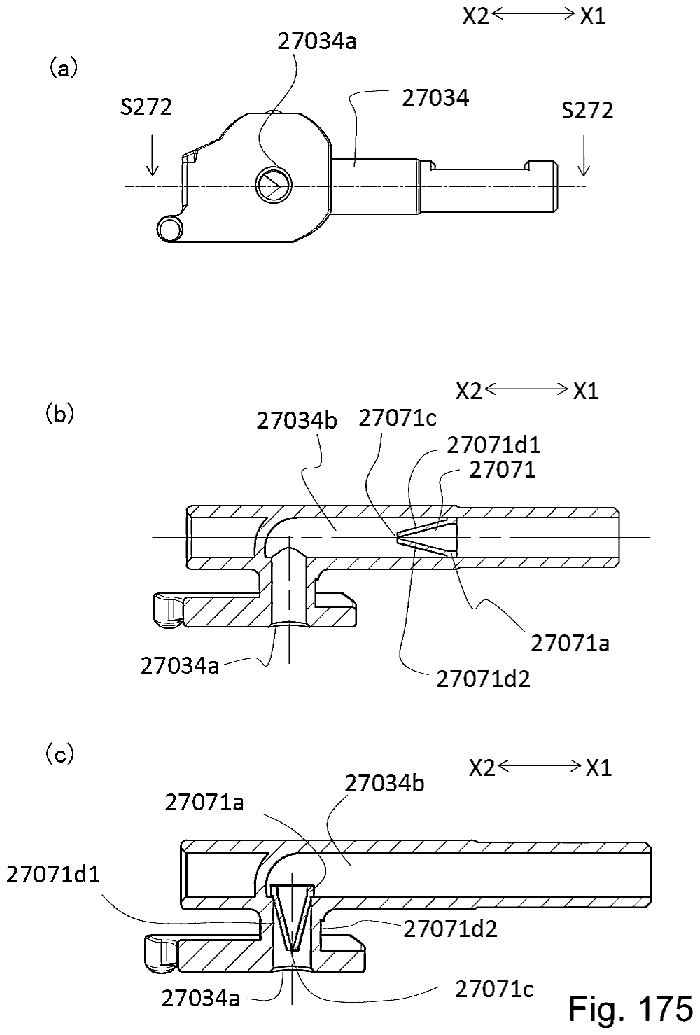

Next, referring to FIGS. 170 to 172, the operation of the toner cartridge C251 when it receives a driving force from the printer main assembly A while the toner cartridge C251 is mounted in the printer main assembly A will be described. FIG. 170 is an external perspective view of the toner cartridge C251 according to Embodiment 25 of the present invention, as viewed from above, with the accommodating portion lid 32 removed for the sake of better illustration. Incidentally, FIG. 170 shows the same state as that shown in FIG. 163 in which the various portions of the toner cartridge C251 are assembled. FIG. 171 is an illustration for exemplarily explaining the operation of a driving portion in Embodiment 25 of the present invention. Part (a) of FIG. 171 is an enlarged view of the major parts of the toner cartridge C251 before it receives driving force from the printer main assembly A, and part (b) of FIG. 171 is an enlarged view of the major parts of the toner cartridge C251 when it is receiving driving force from the printer main assembly A. FIG. 172 is an illustration of an example of a structure in which screw gear 25072 and toner accommodating portion screw member 25035 are interrelated with each other in Embodiment 25 of the present invention. Part (a) of FIG. 172 is an perspective view of the major parts, mainly on the screw gear 25072 before the driving force is transmitted from the printer main assembly A, and part (b) of FIG. 172 is a side view of the state shown in part (a) of FIG. 172. Part (c) of FIG. 172 is a perspective view of the major part, focusing on the screw gear 25072 for receiving the driving force from the printer main assembly A side, and part (d) of FIG. 172 is a side view of the state shown in part (c) of FIG. 172. In addition, for the purpose of better illustration, part (b) of FIG. 172 and part (d) of FIG. 175 show a state in which the outer circumferential portion of the cylindrical end portion 25035e is not visible.

As shown in FIG. 170 and part (a) of FIG. 171, in the state that the toner cartridge C251 is mounted in the printer main assembly A, a supply opening 25031a (dotted line portion) of the accommodation frame 25031 is closed by the seal member 243075 mounted on a shutter member 25074. In this state, the toner inside the accommodation frame 25031 is confined. In this state, the contact portion 25077 of the brake member 25071 contacts the toner accommodating portion screw member 25035 as described above.

In the state shown in part (a) of FIG. 171 and part (b) of FIG. 172, the screw gear 25072 and the toner accommodating portion screw member 25035 are engaged in the rotational direction at the first inclined surface portion 25072f and the second inclined surface portion 25035f. Further, when the screw gear 25072 receives a driving force from the printer main assembly A in this state, as shown in part (a) of FIG. 171, the toner accommodating portion screw member 25035 receives a frictional force from the contact portion 25077, so that action in the rotational direction is hindered.

When the screw gear 25072 receives a driving force from the printer main assembly A, as shown in part (b) of FIG. 171 and part (d) of FIG. 172, the frictional force received from the contact portion 25077 acts on the second inclined surface portion 25035f from the first inclined surface portion 25072f in a direction parallel to the rotation axis (Z axis). This force causes the toner accommodating portion screw member 25035 to move in the Z2 direction against the urging force of the screw spring 25073. Then, as shown in part (b) of FIG. 171, the first disk portion 25035c of the toner accommodating portion screw member 25035 comes into contact with the second cylindrical portion 25031e of the accommodation frame 25031, whereby the movement in the Z2 direction is stopped. Even in this state, as shown in part (d) of FIG. 172, the engagement state between the first inclined surface portion 25072f and the second inclined surface portion 25035f in the rotational direction is maintained, so that the toner accommodating portion screw member 25035 rotates together with the screw gear 25072.

Also, as shown in part (b) of FIG. 171, by the toner accommodating portion screw member 25035 moving in the Z2 direction, the shutter member 25074 is moved in the Z2 direction, thus opening the supply opening 25031a of the accommodation frame 25031 and allowing the toner to be discharged. In this state, as in Embodiment 1 described above, the pump unit 37 is operated by the driving force received from the printer main assembly A, whereby toner is discharged together with air through the supply opening 25031a.

When the transmission of the driving force from the printer main assembly A is stopped, the frictional force from the brake member 25071 causes the toner accommodating portion screw member 25035 to maintain a state in which the first disk portion 25035c is in contact with the cylindrical end portion 25031e of the accommodation frame 25031. When the toner cartridge C251 is removed from the printer main assembly A, the contact between the contact portion 25077 and the toner accommodating portion screw member 25035 as shown in part (b) of FIG. 171 is broken. The toner accommodating portion screw member 25035 is urged in the Z1 direction by the screw spring 25073, and therefore moves in the Z1 direction while rotating in the T251 direction along the shape of the second inclined surface portion 25035f. At this time, the shutter member 25074 moves in the Z1 direction in interrelation with the movement of the toner accommodating portion screw member 25035, and the supply opening 25031a of the accommodation frame 25031 is reclosed by the seal member 243075 mounted to the shutter member 25074. That is, when the transmission of the driving force from the printer main assembly A is stopped, the shutter member 25074 moves again to a position where it closes the supply opening 25031a in accordance with the toner accommodating portion screw member 25035.

With the structure described above, when the toner cartridge C251 of this embodiment is mounted to or dismounted from the printer main assembly A, the toner supply opening 25031a can be maintained in the closed state, whereas in response to receiving a driving force from the printer main assembly A, the supply opening can be opened. In other words, in the state that the toner cartridge C251 according to this embodiment receives a driving force from the printer main assembly A side and is enabled to actually supply (feed) the toner, and the supply opening 25031a is released from closure. With this structure, the toner cartridge C251 according to this embodiment can effectively prevent toner leakage resulting from an external impact on the toner cartridge C251, for example. For example, even if the toner cartridge C251 is subjected to an external impact or other shock during the toner cartridge C251 being mounted to or dismounted from the printer main assembly A, the amount of the toner leakage resulting from the impact can be reduced.

In this embodiment, the toner accommodating portion screw member 25035 has the screw portion 25035a, but even if the toner accommodating portion screw member 25035 does not have the screw portion 25035a, the effect of preventing toner leakage can be provided.

In the structure of the toner cartridge C251 described above, it is assumed that a second shutter member 25074 is additionally provided in the structure of the shutter member 34 of Embodiment 1 described in the foregoing. However, the toner cartridge may have the structure of the toner cartridge C251 according to this embodiment (second shutter member 25074, and so on, for example), and the shutter member 34 itself may not have a shutter mechanism related to the toner discharging. For example, the structure may be that the shutter member 34 itself does not rotate, and the shutter inlet 34g always faces the supply opening 25031a. In this case, the shutter member 34 may have any shape as long as it is capable of operating the receiving side shutter member 206 on the process cartridge B side.

### Embodiment 26

In the above-described Embodiment 24, the second internal shutter member 24071 operates in interrelation with the mounting and dismounting of the toner cartridge C241 to and from the process cartridge B. In Embodiment 25 described above, the toner accommodating portion screw member 25035 and the second shutter member 25074 are operated in response to the driving force received from the printer main assembly A. In this embodiment, a structure is such that a shutter member driven by external electric power is used to suppress leakage of toner. The components having the same functions and roles as those in the above-mentioned Embodiment 24 are assigned the same names and like reference numerals and symbols.

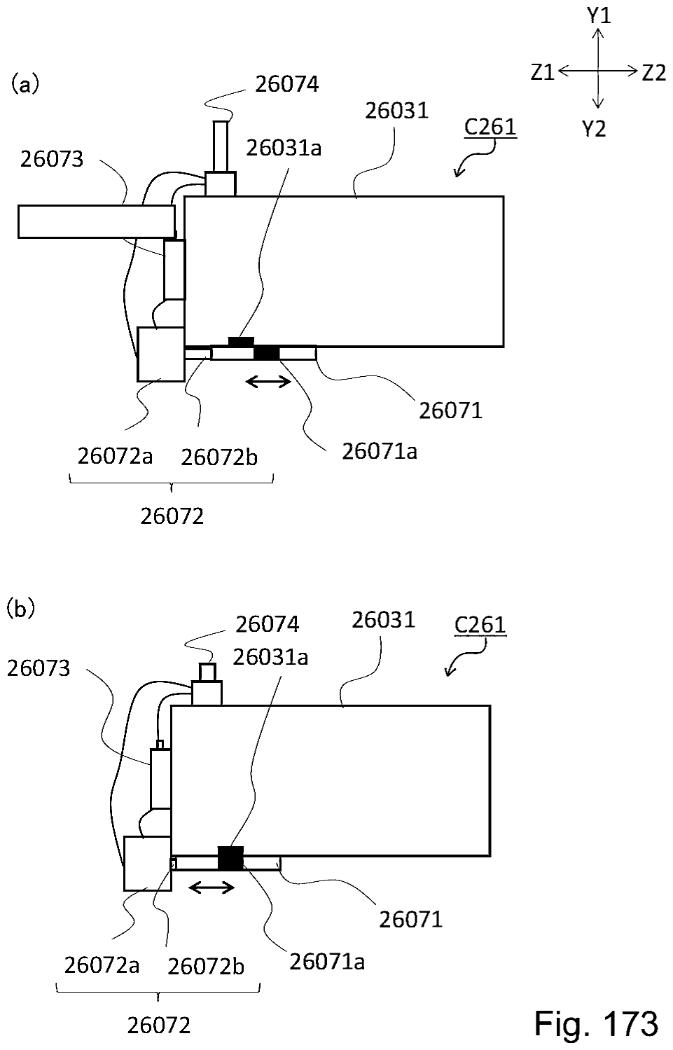

FIG. 173 is an illustration for exemplarily explaining a toner cartridge C261 according to Embodiment 26 of the present invention, and part (a) of FIG. 173 and part (b) of FIG. 173 respectively show the states before and after a third internal shutter member 26071 is opened and closed. FIG. 173 schematically shows each portion to explain the characteristic structure of the toner cartridge C261.

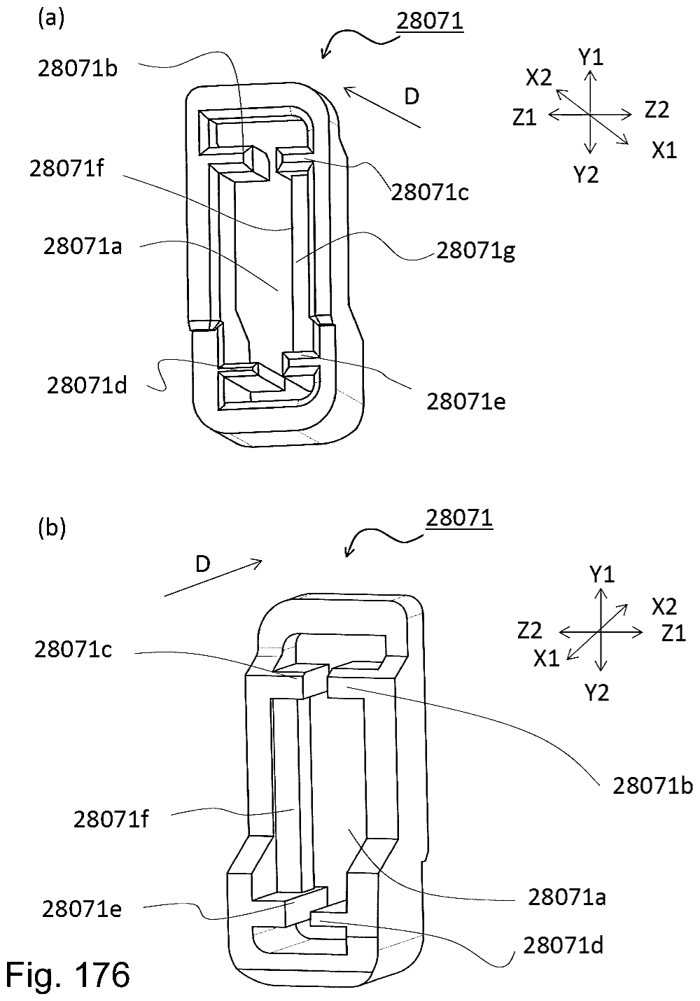

As shown in part (a) of FIG. 173 and part (b) of FIG. 176, the accommodation frame 26031 is provided with a supply opening 26031a for supplying toner to the shutter member 34 side. A third shutter member 26071 is provided on the Y2 direction side of the supply opening 26031a. The third inner shutter member 26071 includes a flat plate shape and has a through hole 26071a.

The third inner shutter member 26071 is mounted to the accommodation frame 26031 so as to be movable in a direction parallel to the Z axis. In addition, a sealing member (not shown) is mounted to the surface of the third internal shutter member 26071 contacting the supply opening 26031a, and the sealing member can confine the toner by closely contacting the supply opening 26031a in a direction parallel to the Y-axis.

Further, on the Z1 direction side of the third internal shutter member 26071, a reciprocating member 26072 provided with a drive portion 26072b operable in a direction parallel to the Z-axis is mounted. The reciprocating member 26072 includes a body portion 26072a and the drive portion 26072b described above which are mounted on the accommodation frame 26031. Of these portions, the drive portion 26072b is movable in a direction parallel to the Z-axis relative to the main assembly portion 26072a, and the above-mentioned third internal shutter member 26071 is fixed to the drive portion 26072b. The main assembly also has a motor (not shown) which is driven by a battery 26073, which will be described hereinafter.

As shown in part (a) of FIG. 173, the battery 26073 is mounted to the accommodation frame 26031, and the drive portion 26072b can be driven by supplying power from the battery 26073 to the motor. In this embodiment, a method of driving the drive portion 26072b using a motor is employed, but the present invention is not limited to this example, and the drive portion 26072b may be driven by magnetic force or the like.

Also, as shown in part (a) of FIG. 173 and part (b) of FIG. 173, on the top surface side (Y1 side) of the toner cartridge C261, a switch portion 26074 is provided projecting in the Y1 direction from the top surface side of the accommodation frame 26031 so as to be capable of being pressed in the Y2 direction.

The above-described reciprocating member 26072, battery 26073, and switch portion 26074 are electrically connected to each other. When the switch portion 26074 is pressed in the Y2 direction or moves in the Y1 direction (returning to its original position), electric power is supplied to the reciprocating member 26072, thereby actuating the drive portion 26072b. In this embodiment, when the switch portion 26074 is pressed, the drive portion 26072b operates so that the through hole 26071a of the third internal shutter member 26071 is brought into communication with the supply opening 26031a in a direction parallel to the Y axis. Further, when the switch portion 26074 has completed moving in the Y1 direction, the drive portion 26072b operates so that the flat portion of the third internal shutter member 26071 closes the supply opening 26031a in a state in parallel to the Y axis. The third internal shutter 26071 of this embodiment can be stopped in the two states described above, and can supply the toner to the outside of the accommodation frame 26031 in the state shown in part (b) of FIG. 173.

In this embodiment, the switch portion 26074 is operatively connected to an urging member such as a return spring member not shown in the Figure, and therefore, is moved in the Y1 direction by the urging force of the return spring when no external force (such as by manual operation by a person) is applied to the switch portion 26074. By employing this structure, for example, the toner cartridge C261 of this embodiment is structured so that the state of the switch portion 26074 changes in response to the opening and closing of the opening and closing opening/closing door 107 provided in the printer main assembly A. Specifically, when the opening and closing opening/closing door 107 is opened, the switch portion 26074 moves in the Y1 direction as shown in part (a) of FIG. 173. Further, when the opening/closing opening/closing door 107 is closed, the switch portion 26074 is pushed by the inner wall of the opening/closing opening/closing door 107 and moves in the Y2 direction, as shown in part (b) of FIG. 173.

With the structure described above, the toner cartridge C261 of this embodiment, similarly to the accommodation frame 23031, can switch between toner supplying state and non-toner-supplying state to the outside of the accommodation frame 26031 in interrelation with the opening and closing of the opening and closing opening/closing door 107. In this embodiment, the structure has been described in which the pressed state of the switch portion 26074 changes in interrelation with the opening and closing operation of the opening and closing opening/closing door 107, but the present invention is not limited to such an example. For example, the switch portion 26074 may not be structured to be in interrelation with the opening and closing opening/closing door 107, but may be structured so that the user can manually change the pressed state. When such a structure is employed, it is possible to the switching between the toner-supplying state to the outside of the accommodation frame 26031 and non-toner-supplying state at any time, regardless of the mounting state of the toner cartridge C261 in the printer main assembly A or the operating state of the printer main assembly A. In addition, when the structure is employed in which the user manually operates the switch portion 26074, it is desirable to add a structure which can lock the operation of the switch portion 26074.

In this embodiment, the battery 26073 is used as the power source for the reciprocating member 26072, but the present invention is not limited such an example. For example, a power source other than a battery (i.e., a power source other than electricity), such as a spring, may be used.

### Embodiment 27

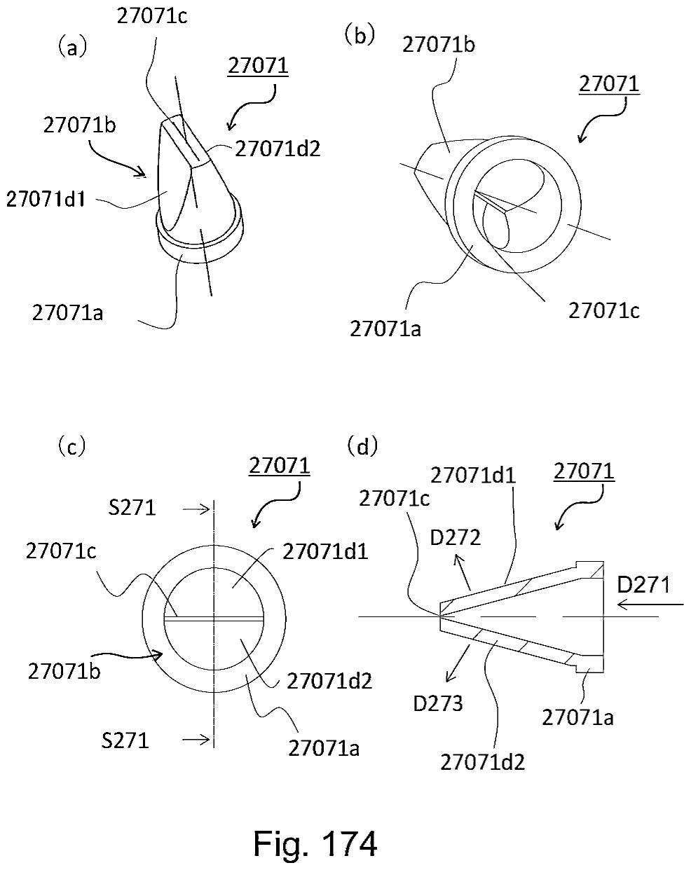

Referring to FIGS. 174 and 175, in this embodiment, a discharge valve 27071 which is an internal shutter member is provided within the feeding portion of a shutter member 27034 which is a first shutter member having substantially the same structure as the shutter member 34 of Embodiment 1 described in the foregoing. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols. FIG. 174 is an illustration of an example of an discharge valve 27071 according to Embodiment 27 of the present invention, wherein part (a) of FIG. 174, part (b) of FIG. 174, and part (c) of FIG. 174 are a perspective view and a side view of the discharge valve 27071, as viewed in different angles. Part (d) of FIG. 174 is a sectional view taken along a line S271-S271 shown in part (c) of FIG. 174. As shown in part (a) of FIG. 174 and part (b) of FIG. 174, the discharge valve 27071 has a cylindrical portion 27071a and an elastic shutter valve portion 27071b extending axially from the cylindrical portion 27071a, and it functions as a second shutter member of the present invention.

The elastic shutter valve portion 27071b is symmetrical with respect to a central axis of the cylindrical portion 27071a, and has a tapered free end as shown in part (d) of FIG. 174. More specifically, the elastic shutter valve portion 27071b has two flat plate portions 27071d1 and 27071d2, and the two flat plate portions is closer to each other as go away from the cylindrical portion 27071a on the central axis of the cylindrical portion 27071a. A slit-shaped discharge portion 27071c is formed at the free end of the elastic shutter valve portion 27071b by flat plate portions 27071d1 and 27071d2. In addition, the states shown in each drawing of FIG. 174 show the state in which the discharge portion 27071c is closed by the flat plate portions 27071d1 and 27071d2 contacting each other.

In the discharge valve 27071 of this embodiment, air pressure is applied to the inner walls of the flat plate portions 27071d1 and 27071d2 when a flow of air of a predetermined amount or more is produced inside from the cylindrical portion 27071a toward the free end side (in the direction of the arrow D271). Then, due to the air pressure, the flat plate portion 27071dl deforms in the direction of the arrow D272, and the flat plate portion 27071d2 deforms in the direction of the arrow D273. Then, the flat plate portions 27071d1 and 27071d2 are deformed, so that the discharge portion 27071c is formed from the state where they contact each other. With this discharge portion 27071c formed, it is possible to discharge toner through the discharge portion 27071c. Then, when the air pressure acting on the flat plate portions decreases and falls below a predetermined value, the flat plate portions 27071d1 and 27071d2 return to their original shapes, and the flat plate portions 27071d1 and 27071d2 come into contact with each other again.

Next, FIG. 175 is an illustration of an example of the structure of a shutter member 27034 according to Embodiment 27 of the present invention. Part (a) of FIG. 175 is a top view of the shutter member 27034 as viewed from the upper side. Also, part (b) of FIG. 175 and part (c) of FIG. 175 are sectional views of an example of the shutter member 27034 taken along a line S272-S272 passing through the center of the feeding portion 27034b, and show cases in which the position at which the discharge valve 27071 is disposed is different. The shutter member 27034 has substantially the same structure as the shutter member 34 of Embodiment 1 described in the foregoing, but an discharge valve 27071 can be disposed inside the feeding portion 27034b.

As shown in part (b) of FIG. 175, in the shutter member 27034, the outer periphery of the cylindrical portion 27071a of the discharge valve 27071 is inserted into the inside of the feeding portion 27034b by press-fitting, adhesive, or the like. In this case, the discharge valve 27071 is disposed so that the discharge portion (27071c) side of the discharge valve 27071 is closer to the toner discharge opening 27034a than the cylindrical portion 27071a.

As in Embodiment 1, when the pump 37a receives a driving force from the printer main assembly A and operates, a mixture of air and the toner is fed from the pump 37a to the feeding portion 27034b. At this time, by driving the pump 37a, a pressure difference is generated between the inside and outside of the toner cartridge C271. Then, the air pressure acting on the flat plate portions 27071dl and 27071d2 changes due to the air pressure difference, the discharge portion 27071c is established (or increasing the gap), and the toner and air are discharged through the discharge portion 27071c. In this state, the shutter member 27034 can discharge the toner through the toner discharge opening 27034a.

On the other hand, when the pump 37a is not operating, or when the driving force of the pump 37a is small, or when the driving force is not transmitted, the discharge portion 27071c is in a substantially closed state, and the toner is hermetically blocked and held inside the toner cartridge C271.

The discharge valve 27071 is made of a material such as rubber or resin (known as a duckbill valve), but the discharge valve 27071 may be made of any material.

As described above, the shutter member 27034 according to this embodiment has the discharge valve 27071 functioning as a second shutter member disposed in the internal feeding portion 27034b. With this structure, it is possible to reduce unintended leakage of the toner when the pump 37a is driven to actually discharge toner to the outside of the toner cartridge C271, for example. In particular, the discharge valve 27071 in this embodiment can be provided outside the shutter member 2034, and therefore, it is possible to effectively suppress toner leakage without changing the dimensions, and so on, of the toner cartridge shown in Embodiment 1.

The discharge valve 27071 may be disposed at a position other than that shown in part (b) of FIG. 175 as long as it is inside the feeding portion 27034b. For example, as shown in part (c) of FIG. 175, it may be arranged in the neighborhood of the toner discharge opening 27034a. In other words, the orientation of the discharge valve 27071 may be any as long as the free end of the discharge valve 27071 faces the toner discharge opening 27034a inside the discharge portion 27034b.

In addition, even if the discharge valve 27071 is arranged on a member other than the shutter member 27034, it may be possible to achieve the same effect. For example, the discharge valve 27071 may be disposed in the neighborhood of the discharge opening 31a also provided in the accommodation frame 31.

### Embodiment 28

In the above-described Embodiment 1, the structure in which the receiving side shutter member 206 provided on the process cartridge B side is moved with the mounting operation of the shutter member 34 provided on the toner cartridge C to the process cartridge B. In this embodiment described in the following, the toner cartridge C281 is mounted to the process cartridge B by moving the receiving side shutter member 206 on the process cartridge B side, using a structure other than the shutter member of the toner cartridge C281. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

In the following description, X-axis, Y-axis, and Z-axis are the same as the X-axis, the Y-axis, and the Z-axis of the process cartridge B or the toner cartridge C281. Therefore, as regards the attachment member 28071 which will be described hereinafter, the X-axis, the Y-axis, and the Z-axis are defined based on the orientations of the attachment member 28071 at the time when it is mounted on the process cartridge B or toner cartridge C281.

FIG. 176 is an external perspective view of an attachment member 28071 according to Embodiment 28 of the present invention, wherein part (a) of FIG. 176 and part (b) of FIG. 176 show the attachment member 28071 as viewed in different directions. The attachment member 28071 is an actuating member for actuating the receiving side shutter member 206 of the process cartridge B. As shown in part (a) of FIG. 176 and part (b) of FIG. 176, the attachment member 28071 is provided with a hollow portion 28071a penetrating in the direction of arrow D (X2 direction), which is the mounting direction of the attachment member 28071 to the process cartridge B.

On the Y1 side inside hollow portion 28071a, two opposing projections are provided which project toward the inside of hollow portion 28071a from the opposite ends in a direction parallel to the Z axis. Of these, the projection projecting in the Z2 direction is referred to as a first projection 28071b, and the projection projecting in the Z1 direction is referred to as a second projection 28071c.

Furthermore, on the Y2 side of the inside hollow portion 28071a, two opposing projections are provided projecting toward the inside of hollow portion 27071a from the opposite ends in a direction parallel to the Z axis. Of these, the projection projecting in the Z2 direction is referred to as a third projection 28071d, and the projection projecting in the Z1 direction is referred to as a fourth projection 28071e. In addition, a wall portion 28071f which connects the second projection 28071c and the fourth projection 28071e is provided between the second projection 28071c and the fourth projection 28071e in the direction parallel to the Y axis. Further, a mounting surface 28071g having a flat portion perpendicular to the D direction (X axis) is provided on the D direction (X2 direction) side of the wall portion 28071f.

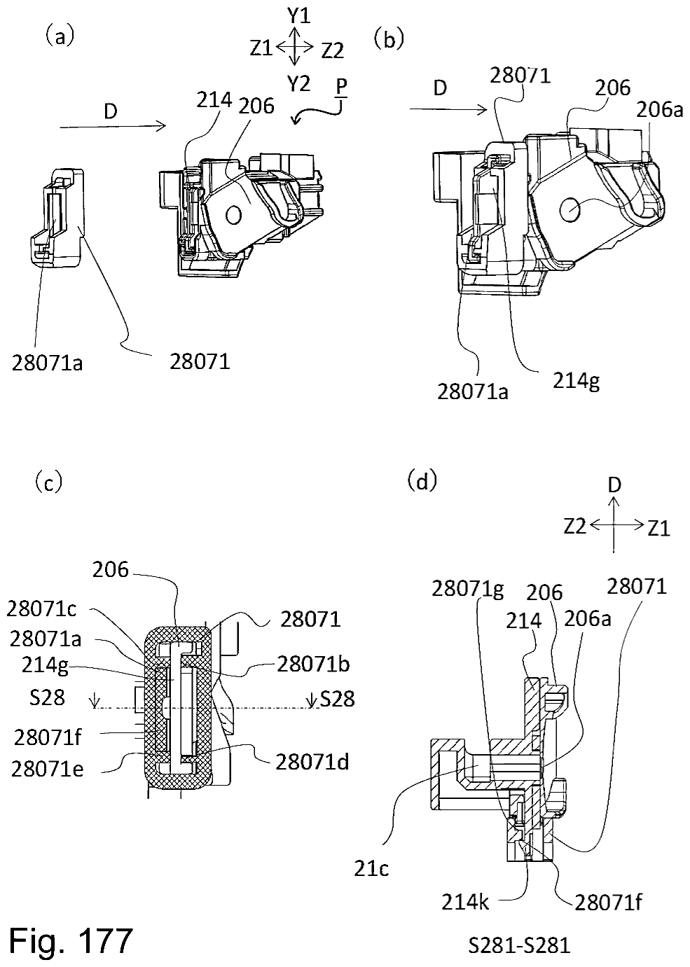

Next, referring to FIG. 177, a method of mounting the attachment member 28071 to the process cartridge B will be described. FIG. 177 is a view for illustrating a method of mounting the attachment member 28071 according to Embodiment 28 of the present invention to the process cartridge B. Of these, part (a) of FIG. 177 and part (b) of FIG. 177 are partial perspective views based on the receiving side shutter member 206 of the process cartridge B. Part (a) of FIG. 177 shows a state in which the attachment member 28071 is not mounted, and part (b) of FIG. 177 shows a state in which the attachment member 28071 is mounted. Also, part (c) of FIG. 177 is a side view of the process cartridge B with the attachment member 28071 mounted, as viewed in the mounting direction, that is, direction D (X2), and for the purpose of better illustration, the area corresponding to the attachment member 28071 is hatched. Part (d) of FIG. 177 is a sectional view taken along a line S28-S28 shown in part (c) of FIG. 177. In addition, for the sake of better illustration, some portions are omitted in each of part (a) of FIG. 177 to part (d) of FIG. 177.

As shown in part (a) of FIG. 177, the attachment member 28071 is mounted to the toner flow passageway member 214 of the process cartridge B in the direction D (from the direction X1 to the direction X2).

When the attachment member 28071 is mounted on the process cartridge B, as shown in part (b) of FIG. 177, the toner flow passageway member 214 of the process cartridge B is inserted through the inside of the hollow portion 28071a. At this time, the attachment member 28071 is mounted on the process cartridge B while moving the receiving side shutter member 206 mounted to the toner flow passageway member 214 in the D direction against the urging force of the compression spring 217. In this state, as shown in part (c) of FIG. 177, the attachment member 28071 sandwiches the flat plate portion 214g of the toner flow passageway member 214 between the first projection 28071b and the second projection 28071c, and between the third projection 28071d and the fourth projection 28071e. With this structure, the attachment member 28071 is positioned relative to the toner flow passageway member 214 in a direction parallel to the Z axis. The attachment member 28071 is positioned in the vertical direction (direction parallel to the Y axis) by sandwiching the toner flow passageway member 214 in the hollow portion 28071a.

Next, as shown in part (d) of FIG. 177, a snap fit portion 214k of the toner flow passageway member 214 extends in the direction opposite to the mounting direction D (that is, the X1 direction). As described above, the attachment member 28071 is mounted to the process cartridge B in the direction D, and the toner flow passageway member 214 is inserted into the hollow portion 28071a. Therefore, when the attachment member 28071 is mounted in the D direction, the snap fit portion 214k of the toner flow passageway member 214 is pressed by the wall portion 28071f of the attachment member 28071, and is deformed in the Z1 direction. When the attachment member 28071 is further pushed in the D direction, the snap fit portion 214k rides over the wall portion 28071f, and the deformed state is restored.

The attachment member 28071, together with the receiving side shutter member 206, receives an urging force from the compression spring 217 in the direction opposite to the D direction (i.e., X1 direction). Therefore, the mounting surface 28071g of the attachment member 28071 abuts against the snap fit portion 214k of the toner flow passageway member 214, and the attachment member 28071 is positioned in the D direction (direction parallel to the X axis). At this time, the receiving side shutter member 206 is pushed in the direction D by the attachment member 28071, and moves to a position where the communication opening 206a and the supply opening 21c of the toner flow passageway member 214 is in fluid communication with each other in a direction parallel to the Z axis (see part (b) of FIG. 177).

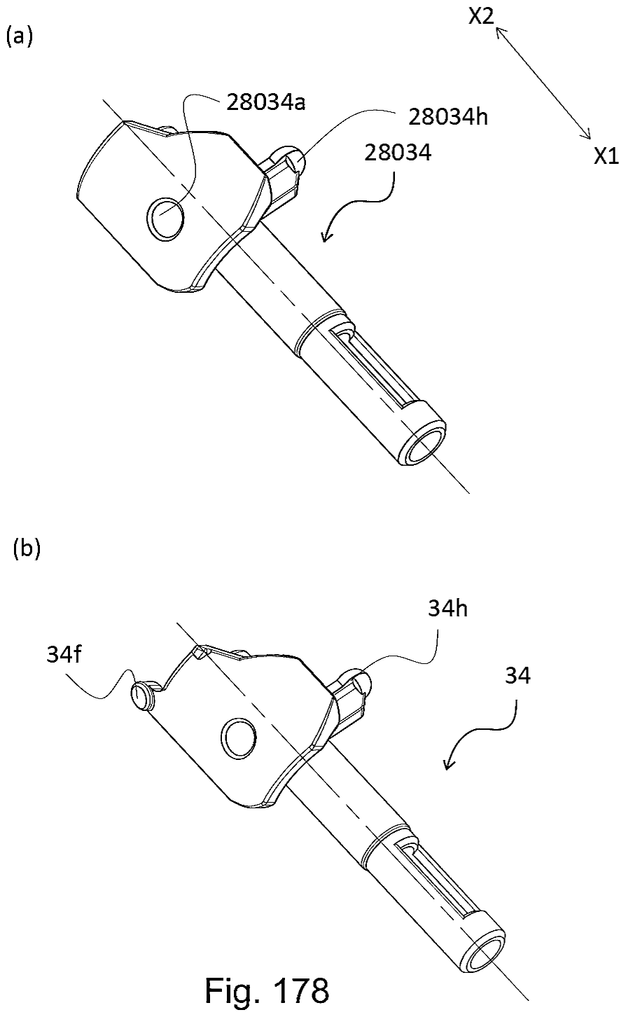

Next, referring to FIG. 178, the operation of the shutter member 28034 will be described. FIG. 178 is an external perspective view of a shutter member 28034 according to Embodiment 28 of the present invention. In the Figure, part (a) of FIG. 178 shows a shutter member 28034 according to this embodiment, and part (b) of FIG. 178 shows the shutter member 34 of the above-mentioned embodiment 1 for comparison.

As shown in part (a) of FIG. 178 and part (b) of FIG. 178, a shutter member 28034 according to this embodiment differs from the shutter member 34 of the previously described Embodiment 1 in that it does not include an actuating projection 34f. In addition, other than the presence or absence of the actuating projection 34f, the shutter member 28034 according to this embodiment and the shutter member 34 according to the embodiment have substantially the same shape.

The reason why the shutter member 28034 in this embodiment is not provided with an actuating projection is that the receiving side shutter member 206 on the process cartridge B side is actuated by the above-mentioned attachment member 28071. As described above, at least when the attachment member 28071 is completely mounted to the process cartridge B, the receiving side shutter member 206 transitions to a state in which it is capable of receiving toner discharged from the toner cartridge C281. Therefore, there is no need to provide an operating projection on the shutter member 28071 in this embodiment.

Therefore, when the shutter member 28034 is mounted to the process cartridge B to which the attachment member 28071 has been mounted, an arm portion 28034h provided on the shutter member 28034 comes into contact with the guide surface 21e on the process cartridge B side. With this structure, the shutter member 28034 is guided in the mounting direction towards the process cartridge B while rotating. Then, the mounting operation is completed in a state where the toner discharge opening 28034a of the rotated shutter member 28034 is in fluid communication with the communication opening 206a of the receiving side shutter member 206, in a direction parallel to the Z axis.

As described above, even when the toner cartridge C281 is mounted on the process cartridge B with the attachment member 28071 mounted, the toner cartridge can be mounted on the process cartridge with high accuracy. In particular, when the structure described in this embodiment is employed, no force is produced by the shutter member on the toner cartridge C281 side to press the receiving side shutter member 206 on the process cartridge B side. The toner cartridge C281 (attachment member 28071) employing this structure can reduce the operating force required for mounting the toner cartridge C281 compared to the toner cartridge C of Embodiment 1 described in the foregoing.

### Embodiment 29

In the above-described Embodiment 28, the toner cartridge C281 is mounted to the process cartridge B in the state that the attachment member 28071 mounted to the process cartridge B. In contrast, in this embodiment which is described in the following, a part having substantially the same shape as the attachment member 28071 described above is provided on the toner cartridge C291. The same structures as those in the above-mentioned Embodiment 28 will be described using the same reference characters and numerals as those in Embodiment 28. In addition, as for the toner cartridge, the process cartridge, and the printer main assembly, the components having the same functions and roles as those in Embodiment 28 are assigned the same names and like reference numerals and symbols.

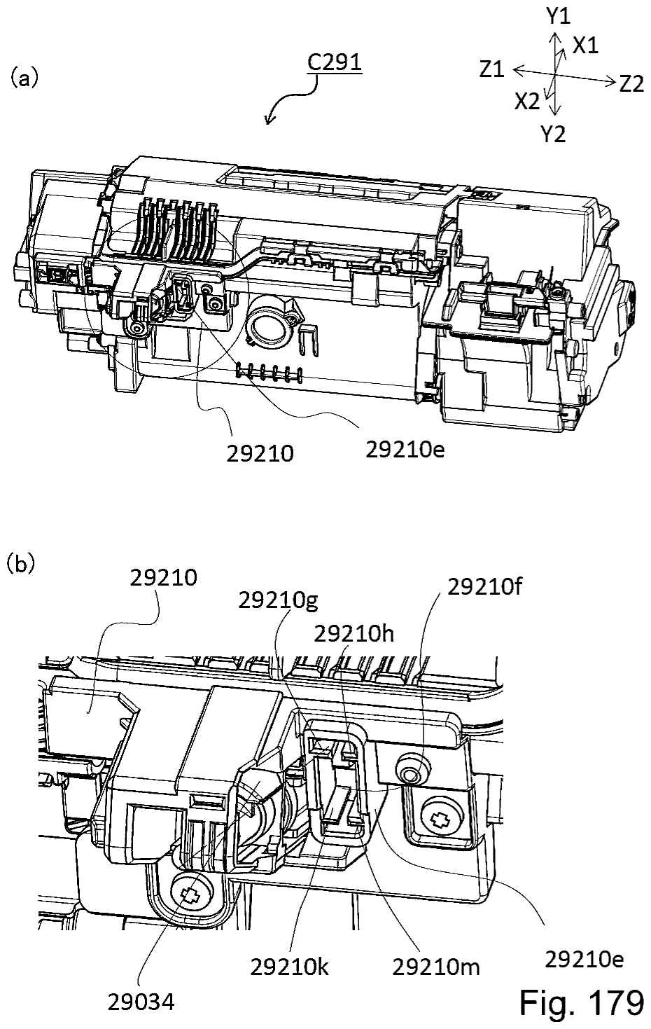

First, referring to FIG. 179, the toner cartridge C291 according to this embodiment will be described. FIG. 179 is an external perspective view of a toner cartridge C291 according to Embodiment 29 of the present invention, wherein part (a) of FIG. 179 is a perspective view illustrating the entire toner cartridge C291, and part (b) of FIG. 179 is an enlarged view corresponding to an encircled part shown in part (a) of FIG. 179.

As shown in part (a) of FIG. 179, a shutter protection member 29210 is mounted to the front side (X2 direction) of the toner cartridge C29. The shutter protection member 29210 has substantially the same shape as the shutter protection member 210 of Embodiment 1 described in the foregoing, and in this embodiment, the differences from Embodiment 1 will be described. As shown in part (b) of FIG. 179, a connecting portion 29210e including a part having approximately the same shape as the attachment member 28071 described in the above-mentioned Embodiment 28 is formed on the Z2 direction side of the shutter protection member 29210.

The connecting portion 29210e has a recess portion 29210f which corresponds to the hollow portion 28071a of the attachment member described in Embodiment 28. It also has a first projection 29210g, a second projection 29210h, a third projection 29210k, and a fourth projection 29210m, which correspond to projections (28071b to 28071e) provided on the attachment member 28071, respectively. The shutter member 29034 has substantially the same structure as the shutter member 28034 of Embodiment 28 described above.

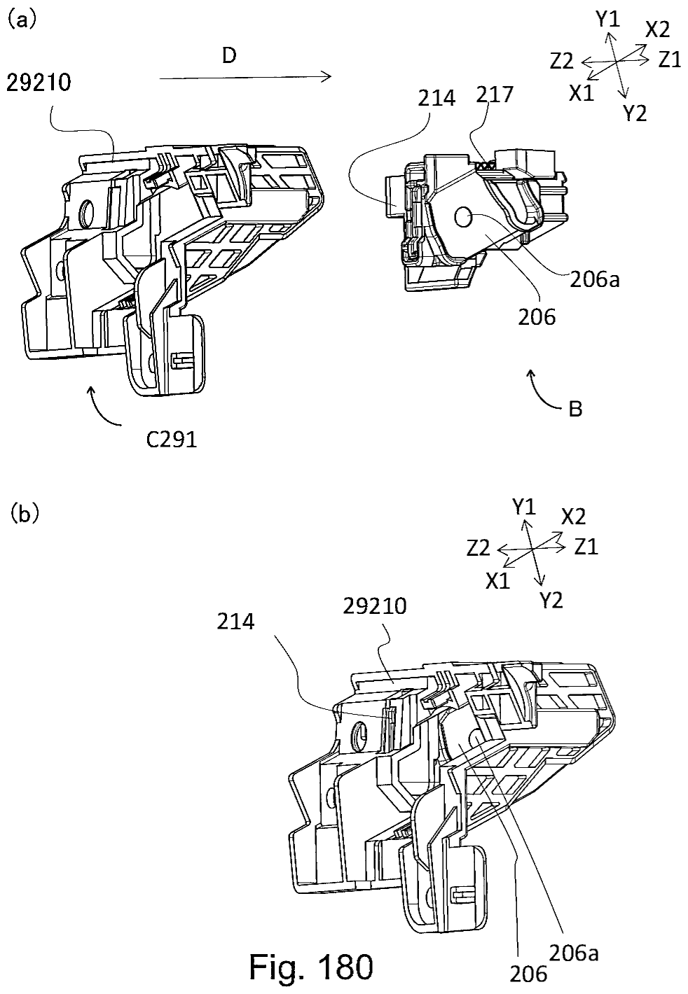

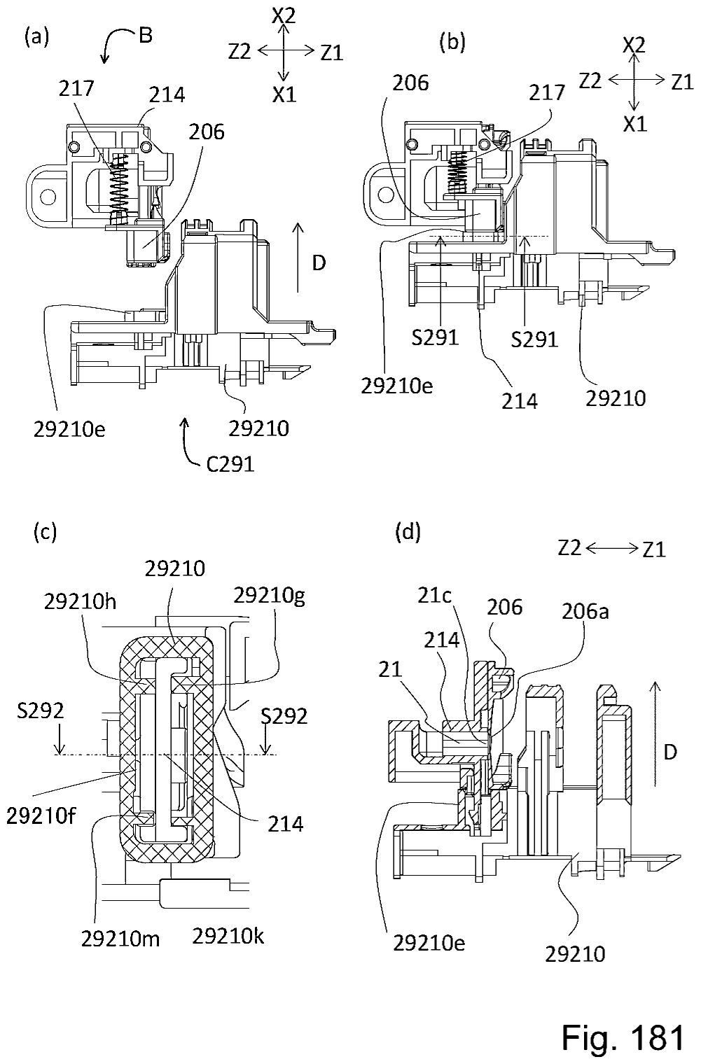

Next, referring to FIGS. 180 and 181, a method of mounting the toner cartridge C29 into the process cartridge B will be described. FIG. 180 is an illustration of an example of a method of mounting a toner cartridge C291 according to Embodiment 29 of the present invention to a process cartridge B. Part (a) of FIG. 180 shows a state in which the toner cartridge C291 has not been completely mounted on the process cartridge B side, and part (b) of FIG. 180 shows a state in which the toner cartridge C291 has been mounted on the process cartridge B side., in part (a) of FIG. 180 and part (b) of FIG. 180, for the purpose of better illustration, only the major portions are shown, and both Figures show the shutter protection member 2910 and the receiving side shutter member 206 as viewed from the rear side of the apparatus (X1 direction). As shown in part (a) of FIG. 180 and part (b) of FIG. 180, the toner cartridge C291 provided with the shutter protection member 29210 can be mounted on the process cartridge B in the D direction (X2 direction). In the mounting operation, the receiving side shutter member 206 is inserted into the above-described recess portion 29210f (see part (c) of FIG. 181 which will be described hereinafter) of the shutter protection member 29210.

Next, referring to FIG. 181, changes in the relative positional relationship between the shutter protection member 29201, the toner flow passageway member 214, and the receiving side shutter member 206 when the toner cartridge C291 is mounted in the process cartridge B will be described. FIG. 181 is an illustration of the portions when the toner cartridge C291 according to Embodiment 29 of the present invention is mounted in the process cartridge B. Part (a) of FIG. 181 is a side view of the major parts in the state before the toner cartridge C291 is mounted in process cartridge B, and part (b) of FIG. 181 is a side view of the major parts in the state after toner cartridge C291 has been mounted in process cartridge B. Part (c) of FIG. 181 is a sectional view taken along a line S291-S291 shown in part (b) of FIG. 181, and part (d) of FIG. 181 is a sectional view taken along a line S292-S292 shown part (c) of FIG. 181. In each illustration of FIG. 181, unnecessary parts are omitted for the sake of better illustration.

As shown in part (a) of FIG. 181 and part (b) of FIG. 181, when the toner cartridge C291 is mounted to the process cartridge B, the toner flow passageway member 214 is inserted into the inside of the connecting portion 29210e (recess portion 29210f). At this time, the connecting portion 29210e is mounted by moving (pushing) the receiving side shutter member 206 in the D direction against the urging force of the compression spring 217 in the direction opposite to the D direction (X1 direction).

As in the previously described Embodiment 28, the receiving side shutter member 206 is inserted into the paired projections on the shutter protection member 210 and the vertical (parallel to the Y axis) end portion of the recess portion 29210f, thereby determining its position in the Z and Y axes. As shown in part (d) of FIG. 181, the position of the receiving side shutter member 206 is determined by the position at which the toner cartridge C291 is completely mounted in the process cartridge B. At this time, the receiving side shutter member 206 in the direction parallel to the X-axis abuts against the outside of the connecting portion 29071 to be positioned in place.

In the above-described state, similarly to Embodiment 1, the toner cartridge C291 continues to receive the urging force from the compression spring 217 in the direction opposite to the D direction (X1 direction). At this time, the receiving side shutter member 206 is moved (pushed in) by the connecting portion 29210e against the urging force, and the communication opening 206a and the supply opening 21c of the toner flow passageway member 214 are brought into contact with each other in a direction parallel to the Z axis. In this state, the mounting of the toner cartridge C291 into the process cartridge B is completed.

As described above, the toner cartridge C291 of this embodiment can move the receiving side shutter member 206 using a member other than the shutter member 34, without using external members such as the attachment member 28071 described in the above-mentioned embodiment 28. That is, in the toner cartridge C291 according to this embodiment, the member for moving the receiving side shutter member 206 and the member for conveying and discharging the toner can be separated from each other. With this structure, the position at which the urging force from the compression spring 217 is received by way of the receiving side shutter member 206 is stabilized, so that the force required when mounting the toner cartridge C291 can be reduced.

Furthermore, if the structure of the shutter member on the toner cartridge C291 side is the same as that of the previously described embodiment 28, the toner cartridge C291 can be mounted to the process cartridge B without unintended interference with the receiving side shutter member 206.

### Embodiment 30

In the above-described Embodiment 1, the toner cartridge C is structured to feed and discharge toner, and is capable of driving the pump 37a based on the driving force supplied from the printer main assembly A side. In contrast, in this embodiment, a case will be described in which the toner cartridge C300 per se includes a drive source related to toner feed. More specifically, in this embodiment, a structure in which an air cylinder 30071 is provided in the toner cartridge C300 will be described. The same components as those in Embodiment 1 will be described with the same reference numerals and symbols as those in Embodiment 1. Furthermore, as for the toner cartridge, the process cartridge, and the printer main assembly, the components having the same functions and roles as those in Embodiment 1 are assigned the same names and like reference numerals and symbols.

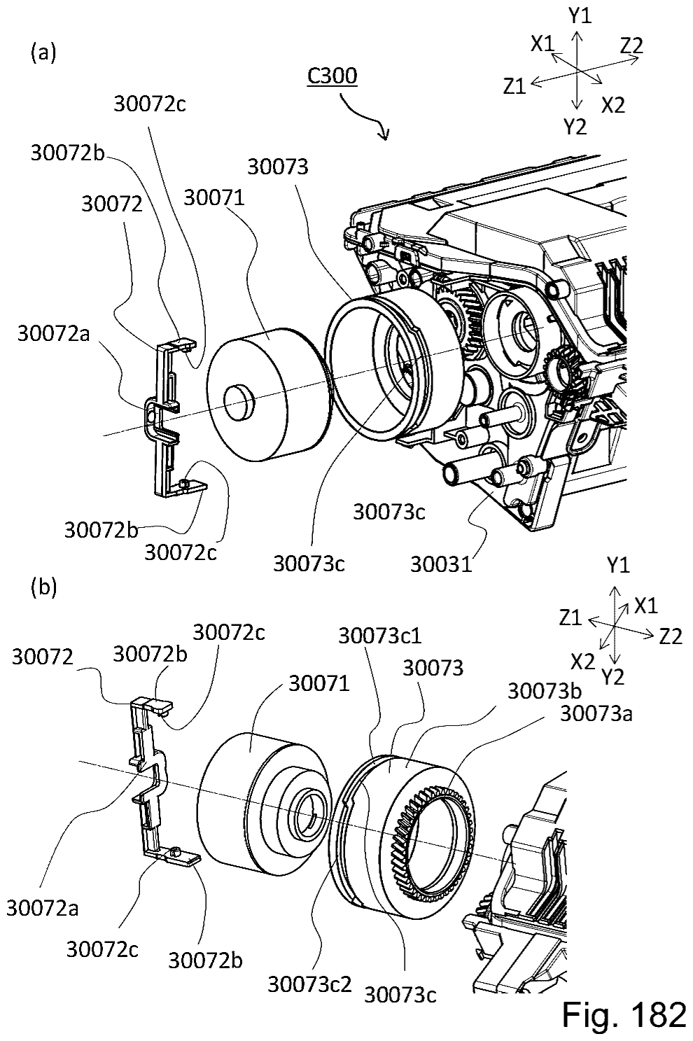

First, referring to part (a) of FIG. 182 and part (b) of FIG. 182, the structure of the toner cartridge C300 according to this embodiment will be described. FIG. 182 is an external perspective view of the drive side end of the toner cartridge C300 according to Embodiment 30 of the present invention, wherein part (a) of FIG. 182 and part (b) of FIG. 182 show the toner cartridge C300 as viewed in different directions. As shown in part (a) of FIG. 182 and part (b) of FIG. 182, a link arm 30072, an air cylinder 30071, and a cam gear 30073 are mounted to an accommodation frame 30031 at the end in the Z1 direction of the toner cartridge C300. The cam gear 30073 has a cylindrical shape having an axis parallel to the Z direction, and is provided with a gear portion 30073a formed at the end in the Z2 direction. The gear portion 30073a has substantially the same shape as the cam gear 37 of Embodiment 1 described in the foregoing.

The cam gear 30073 is mounted to the accommodation frame 30031 so as to be rotatable about a predetermined rotation axis, similarly to Embodiment 1 described in the foregoing. The gear portion 30073a is a driving force receiving portion, and is capable of receiving driving force from a drive input means, such as a coupling, provided in the printer main assembly A. In other words, the cam gear 30073 is disposed in a position where the gear portion 30073a can receive the driving force outputted from the printer main assembly A side.

A cylindrical portion 30073b having a larger diameter than the gear portion 30073a is provided coaxially with the gear portion 30073a on the Z1 direction side of the gear portion 30073a. A groove portion 30073c is provided on the outer periphery of the cam cylindrical portion 30073b so as to be recessed in the radial direction relative to the rotation axis and extend around the outer periphery of the cam cylindrical portion 30073b. The groove portion 30073c is formed at each of different positions (on the Z axis) on the outer periphery of cam cylindrical portion 30073b, and therefore, when the Z axis is used as a reference, the groove portion 30073c passes two different positions. That is, the groove portion 30073c includes a first groove portion 30073c1 and a second groove portion 30073c2 located on the Z2 direction side of the first groove portion 30073c1. The first groove portion 30073cl and the second groove portion 30073c2 are provided continuously (connected) to form a single groove portion 30073c. In addition, the groove portion 30073c has a rotationally symmetric shape with respect to the central axis (rotation axis) of the cam cylindrical portion 30073b.

The cam gear 30073 has an opening provided in a Z2 direction side and an opening provided in a Z1 direction side, the openings having different sizes, and the diameter of the opening open in the Z1 direction side is large enough to allow an air cylinder 30071 to be inserted. In contrast, the opening of the cam gear 30073 in the Z2 direction side is smaller than the outer diameter of the air cylinder 30071. Therefore, the air cylinder 30071 inserted from the Z1 direction opening abuts against the inner surface of the cam gear 30073 that forms a Z2 direction side opening, and the air cylinder 30071 cannot be inserted through the Z2 direction side opening.

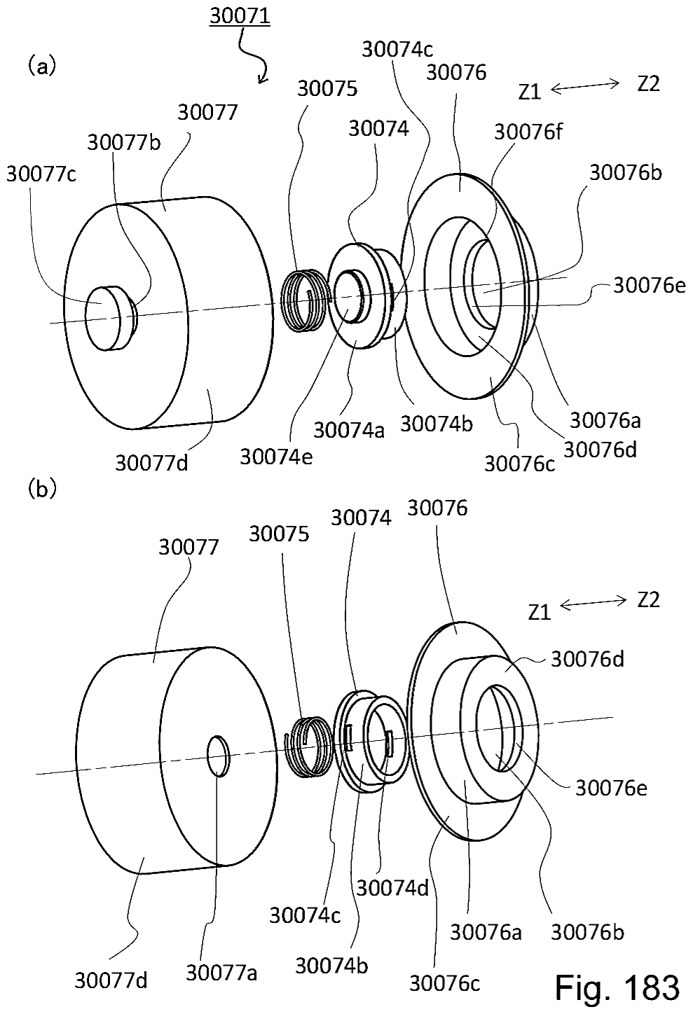

Next, referring to part (a) of FIG. 183 and part (b) of FIG. 183, the structure of an air cylinder 30071 according to this embodiment will be described. FIG. 183 is an exploded perspective view of an air cylinder 30071 according to Embodiment 30 of the present invention, and part (a) of FIG. 183 and part (b) of FIG. 183 shows the air cylinder 30071 as viewed in different directions. As shown in part (a) of FIG. 183 and part (b) of FIG. 183, the air cylinder 30071 includes, a shutter support member 30076, a shutter member 30074, a compression spring 30075, and an air storage member 30077 arranged in this order in the Z1 direction.

The shutter support member 30076 is provided with a first cylindrical portion 30076a, and an end surface 30076d is provided at the end of the first cylindrical portion 30076a in the Z2 direction. A first hollow portion 30076b penetrating the end surface 30076d in the Z1 direction is provided coaxially with the first cylindrical portion 30076a. In addition, since the first hollow portion 30076b is formed in the end surface 30076d, a circumferential surface 30076e is formed with a central portion penetrating therethrough. A circular flange portion 30076c having a larger diameter than the first cylindrical portion 30076a is provided at the end of the first cylindrical portion 30076a in the Z1 direction, coaxially with the other members constituting the air cylinder 30071. Additionally, an opening 30076f is formed in the shutter support member 30076 in the Z1 direction, and by this opening 30076f, the first hollow portion 30076b described above is formed. The shutter member 30074 can be mounted to the shutter support member 30076 by inserting the shutter member 30074 into this opening 30076f in the Z1 direction.

Next, the shutter member 30074 includes a disk portion 30074a, a second cylindrical portion 30074b, a second hollow portion 30074c, and a first cylindrical portion 30074e. Of these components, the second cylindrical portion 30074b is provided with two through holes extending from the outer circumferential surface of the cylindrical portion toward the inner surface (i.e., in the radial direction). The first through hole 30074c and the second through hole 30074d are arranged symmetrically on the opposite sides with respect to the rotation axis. The second cylindrical portion 30074b extends from the disk portion 30074a in the Z2 direction, and has a smaller diameter than the disk portion 30074a. Further, a first cylindrical portion 30074e having a smaller diameter than the disk portion 30074a is projected coaxially with the disk portion 30074a from the disk portion 30074a in the direction (Z1 direction) opposite from the direction in which the second cylindrical portion 30074b projects.

The shutter member 30074 described above can be inserted into the interior of the shutter support member 30076 through the opening 30076f provided in the shutter support member 30076.

The air storage member 30077 is mounted on the Z2 direction side of the shutter support member 30076. The air storage member 30077 includes an air storage portion 30077d, a second cylindrical portion 30077b, and a third cylindrical portion 30077c.

The air storage portion 30077d has a closed cylindrical shape and has a circular hole 30077a formed in the Z2 end surface, the hole 30077a being centered on the axis of rotation. The air storage portion 30077d, the second cylindrical portion 30077b, and the third cylindrical portion 30077c are provided concentrically and continuously. The second cylindrical portion 30077b is provided between the air storage portion 30077d and the third cylindrical portion 30077c, and the third cylindrical portion 30077c, the second cylindrical portion 30077b, and the air storage portion 30077d are arranged in this order from the Z1 direction side to the Z2 direction side in the Z-axis direction. In terms of the diameter of each member, the air storage portion 30077d is the largest, and the second cylindrical portion 30077b is the smallest.

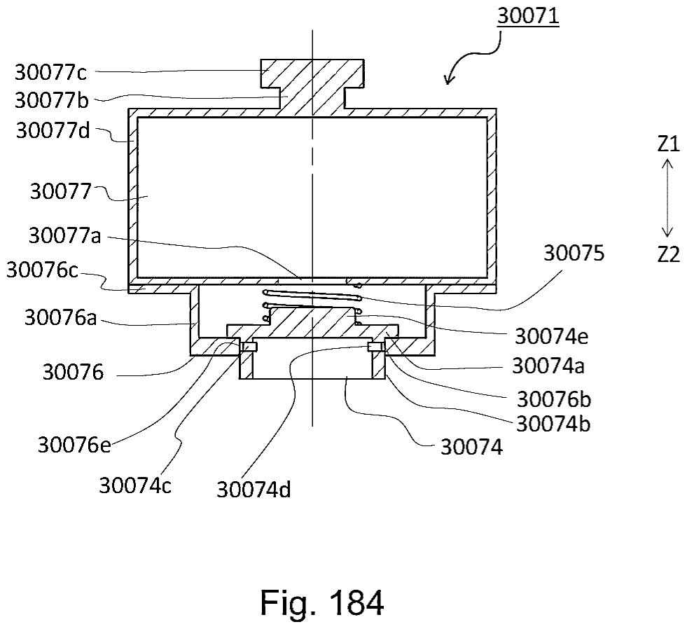

Next, referring to FIG. 184, a method of assembling the air cylinder 30071 will be described in detail. FIG. 184 is a view of the XZ plane passing through the central axis of rotation of an air cylinder 30071 according to Embodiment 30 of the present invention. As shown in FIG. 184, the method of assembling the components of the air cylinder 30071 is to insert the second cylindrical portion 30074b of the shutter member 30074 into the first hollow portion 30076b of the shutter support member 30076. In this state, the disk portion 30074a abuts against the inner surface of the shutter support member 30076. At this time, the first through hole portion 30074c and the second through portion 30074d of the shutter member 30074 are closed by the circumferential surface 30076e of the shutter support member 30076, thereby being hermetically sealed.

In addition, a compression spring 30075 acts on the first cylindrical portion 30074e of the shutter member 30074. In this embodiment, the compression spring 30075 is fitted into the first cylindrical portion 30074e using a spring having a diameter matching the diameter of the first cylindrical portion 30074e. The air storage member is placed so as to be coaxial with the shutter member 30074, the compression spring 30075, and the shutter support member 30076. More specifically, with the compression spring 30075 pressed and enclosed against the Z2 side end surface of the air storage portion 30077d of the air storage member 30077, the flange portion 30076c of the shutter support member 30076 is fixed by adhesive or the like.

In the air cylinder 30071 according to this embodiment described above, the Z2 direction end of the shutter member 30074 is fixed to the accommodation frame 30031 by adhesive or the like. As shown in FIG. 184, the hole 30077a of the air storage member 30077 in in fluid communication with the first hollow portion 30076b of the shutter support member 30076, but is sealed by the shutter member 30074. With this structure, compressed air can be filled into the shutter support member 30076 without any leakage.

As shown in part (a) of FIG. 182, the link arm 30072 has two arm portions 30072b extending in the Z2 direction provided at opposite ends in a direction parallel to the Y axis, symmetrically with respect to the axis of rotation. The two arm portions 30072b are each provided at a free end in the Z2 direction with a projection 30072c projecting in a direction parallel to the Y axis and facing each other.

As shown in part (a) of FIG. 182 and part (b) of FIG. 182, the link arm 30072 is provided with a U-shaped bent portion 30072a in the diametrical center portion relative to the two arm portions 30072b. The link arm 30072 is formed by extending the arm portions 30072b described above from the ends of two rod-shaped members which extend radially outward from the bent portion 30072a.

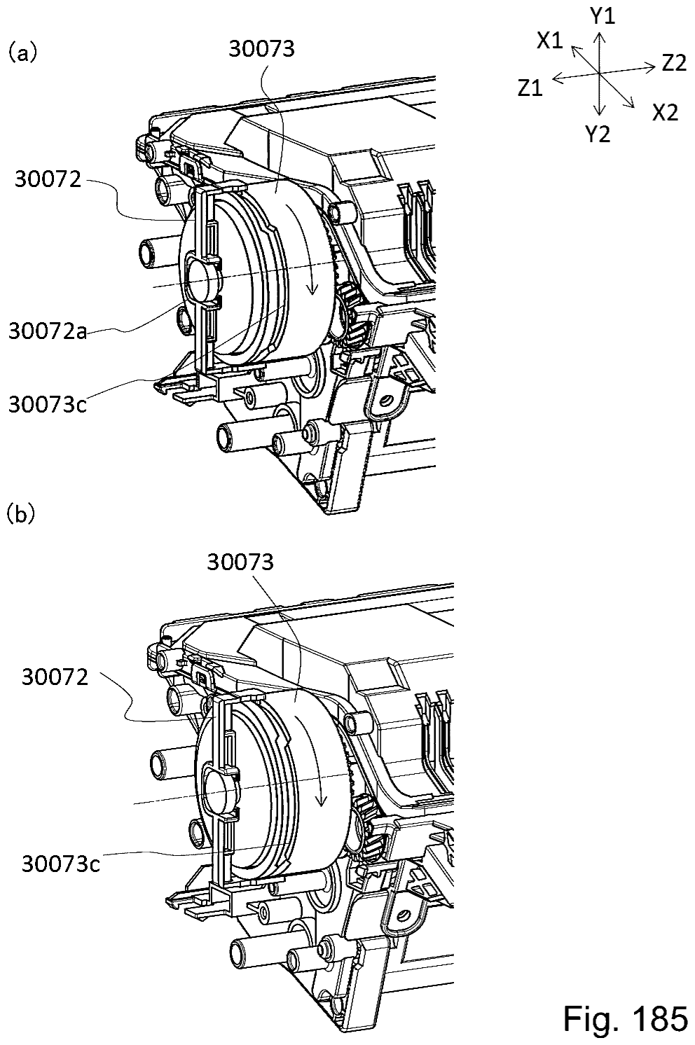

FIG. 185 is a perspective view illustrating the exterior of the major parts of the drive side end portion of the toner cartridge C300 before and after actuating the air cylinder 30071 according to Embodiment 30 of the present invention. 185 (a) and 185 (b) respectively show the state when air is not discharged using and the state when air is discharged, from the air cylinder 30071. As shown in FIG. 185, a recess portion of the bent portion 30072a of the link arm 30072 fits into the second cylindrical portion 30077b of the air cylinder 30071. With this structure, the link arm 30072 and the air cylinder 30071 can move integrally in a direction parallel to the Z axis. In addition, the two projections 30072c are fitted into the groove portion 30073c of the cam gear 30073.

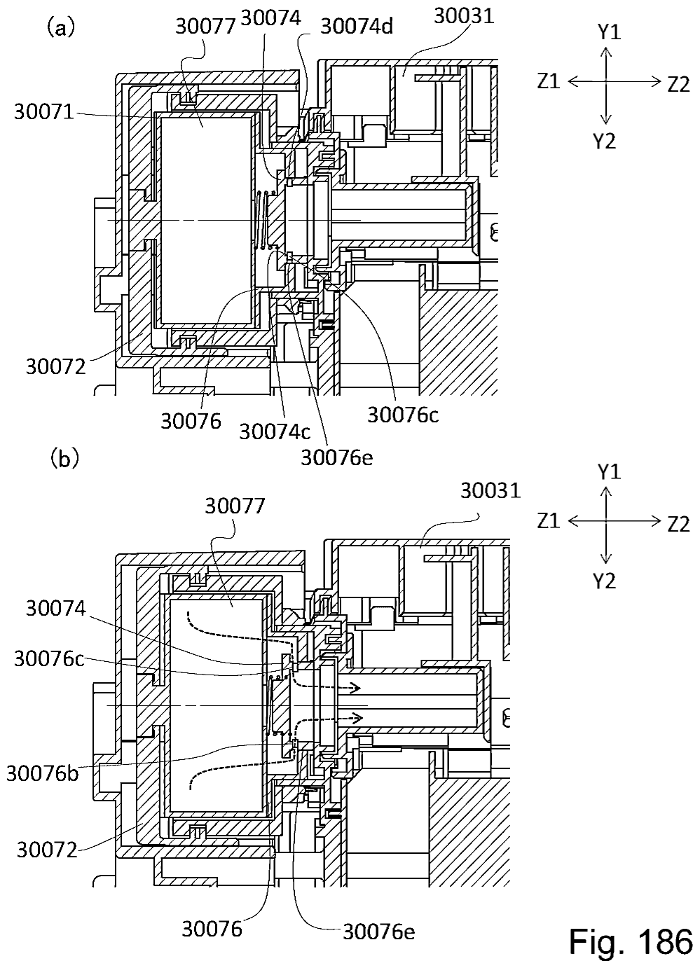

Next, referring to part (a) of FIG. 185, part (b) of FIG. 185, part (a) of FIG. 186, and part (b) of FIG. 186, a method of discharging the toner and air using the air cylinder 30071 will be specifically described. FIG. 186 is a cross-sectional view of major parts, mainly on an air cylinder 30071 according to Embodiment 30 of the present invention. Part (a) of FIG. 186 shows a state in which air is not discharged, and part (b) of FIG. 186 shows a state in which air is discharged. Each illustration in FIG. 186 is a sectional view taken along a YZ plane including the rotation axis.

As shown in part (a) of FIG. 185 and part (b) of FIG. 185, the link arm 30072 (its projection 30072c) fits into the groove portion 30073c of the cam gear 30073, so that as the cam gear 30073 rotates, the link arm 30072 moves in a direction parallel to the Z axis. As shown in part (a) of FIG. 186 and part (b) of FIG. 186, as the link arm 30072 moves, the shutter support member 30076 moves in a direction parallel to the Z axis relative to the fixed shutter member 30074, changing whether to discharge the air. Specifically, in the state shown in part (a) of FIG. 186, the first through hole 30074c and the second through hole 30074d are closed by the circumferential surface 30076e. On the other hand, the shutter support member 30076 is moved in the Z1 direction by the link arm 30072, as shown in part (b) of FIG. 186. Then, the first through hole portion 30074c and the second through portion 30074d, which have been closed (sealed) by the circumferential surface 30076e of the shutter support member 30076, are brought into fluid communication with the internal space formed by the shutter support member 30076. By this, the compressed air in the air storage member 30077 is discharged through the first through hole 30074c and the second through hole 30074d as indicated by the dashed arrows in part (b) of FIG. 186.

The air discharged by the structure described above functions in the same manner as the air discharged from the pump 37a described in Embodiment 1, and is discharged from toner cartridge C300 to the outside together with the toner accommodated in the toner cartridge C300. In addition, it is desirable that the volume of air discharged from the air cylinder 30071 be greater than or equal to the air discharge amount required to discharge the total amount of the toner contained in the toner cartridge C using the pump 37a of the above-mentioned Embodiment 1. For example, the air cylinder 30071 of this embodiment contain approximately 180000 cc or more of air. The air cylinder 30071 may be structured so that the volume of the air filled therein can be appropriately selected according to the amount of the toner contained in the toner cartridge C300.

As described above, the toner cartridge C300 according to this embodiment does not have a pump, and can discharge toner using a power source other than that from the printer main assembly A such as the air cylinder 30071. Therefore, as compared with Embodiment 1 described above, the amount of electric power consumption, for example, required for compression by the pump 37a can be reduced, and toner can be effectively discharged together with air. That is, the toner cartridge C300 according to this embodiment is capable of discharging toner with less driving force than the toner cartridge C according to Embodiment 1 described above.

### Embodiment 31

In the above-described Embodiment 1, the toner cartridge C is structured to feed and discharge toner, and is capable of driving the pump 37a using the driving force obtained from the printer main assembly A side. In contrast, in this embodiment which will be described in the following, the toner cartridge C310 itself includes a drive source for driving the pump. More specifically, in this embodiment, the pump unit 37 is operated by driving a motor 31075 using power obtained from a battery 31031. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

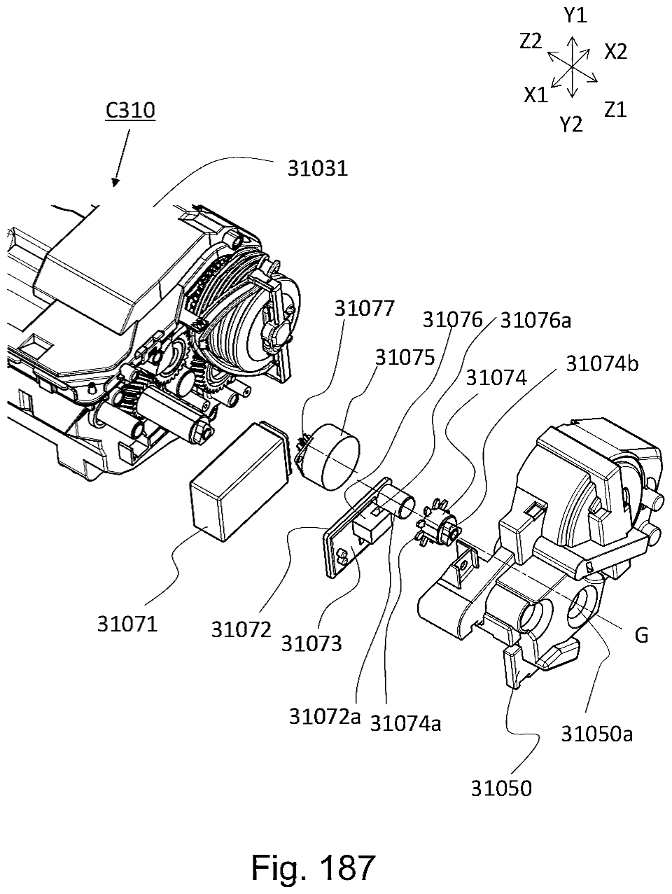

FIG. 187 is an exploded perspective view of the major parts of the toner cartridge C310 according to Embodiment 31 of the present invention, and illustrates an example of the mounting positions of relevant parts relative to the accommodation frame 31031. As shown in FIG. 187, a battery 31071, a fixing metal plate 31072, a control board 31073, a detection coupling 31074, the motor 31075, and a side cover 31050 are mounted to the end of the accommodation frame 31031 in the Z1 direction.

The fixing metal plate 31072 has a flat plate shape having a plate surface which is approximately parallel to the side surface of the accommodation frame 31031, and is provided with a shaft portion 31072a projecting in the Z1 direction. The control board 31073 is a control member disposed on the surface of the fixing metal plate 31072 facing in the Z1 direction. The detection portion 31076 is a detection means provided on the control board 31073, and in this embodiment, it is a photo-interrupter. As shown in FIG. 187, this detection portion 31076 can detect whether or not an object has passed through a slit portion 31076a that is partially recessed in the X1 direction. The detection coupling 31074 has a cylindrical shape with an axis parallel to the Z axis, and has a plurality of detection blades 31074a extending away from the axis (radially) at the end in the Z2 direction, and a coupling portion 31074b at the end in the Z1 direction. The multiple detection blades 31074a are arranged at equal intervals in the circumferential direction about the axis, and a total of nine blades are provided in this embodiment. The structure of the coupling portion 31074b is substantially the same as that of the screw coupling portion 39a of Embodiment 1 described in the foregoing.

The motor 31075 is provided with a pinion gear 31077 provided at its free end in the Z2 direction, and is supported by the accommodation frame 31031 so as to be rotatable about the axis G shown in FIG. 187. The side cover 31050 is a cover member provided at the end of the toner cartridge C310 in the Z1 direction. The structure of the side cover 31050 is substantially the same as the drive side cover 50 of Embodiment 1 described in the foregoing. As shown in FIG. 187, the side cover 31050 is provided with a hole portion 31050a which penetrates in a direction parallel to the Z axis.

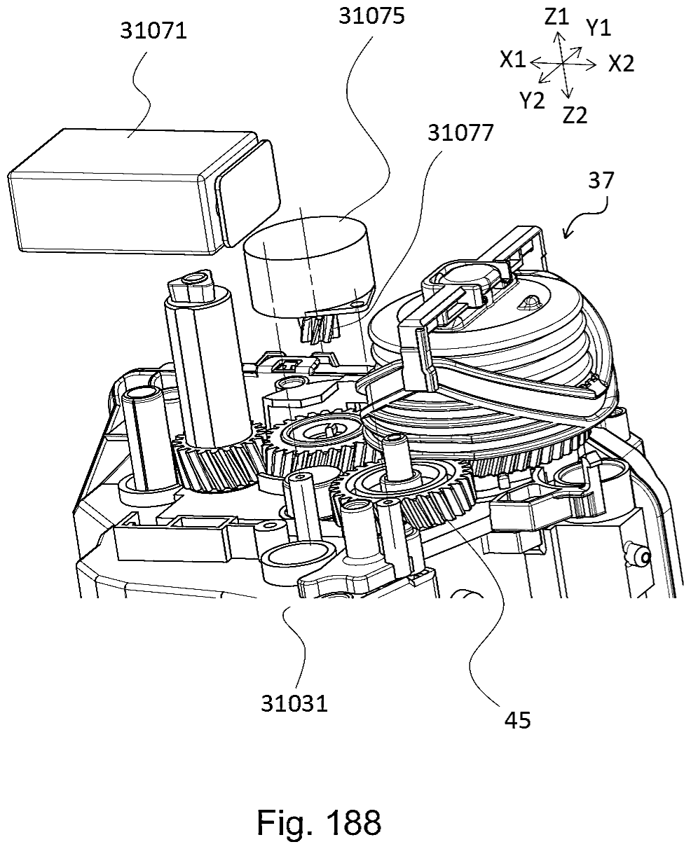

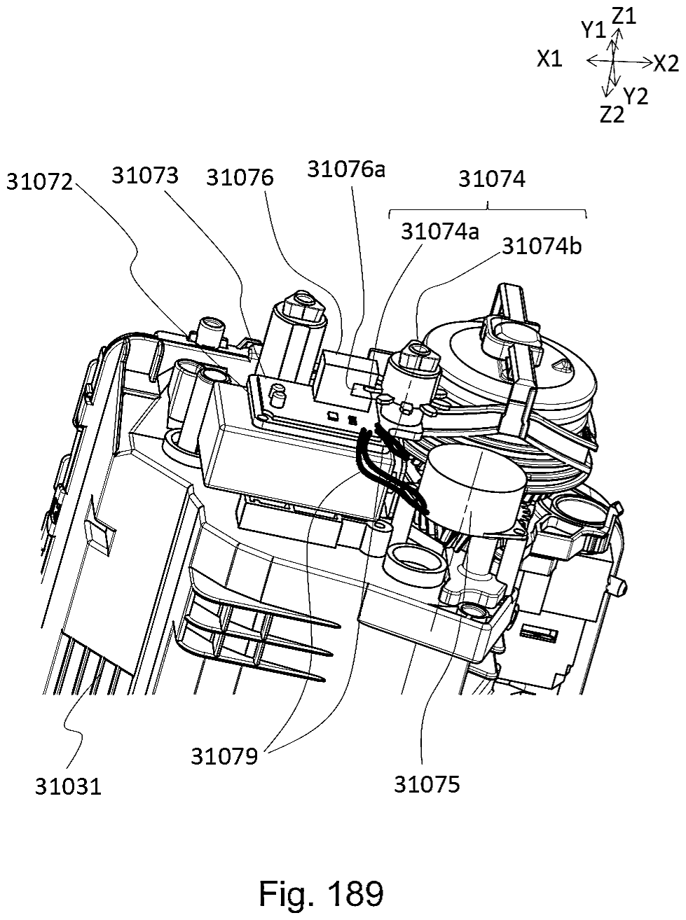

Next, referring to FIGS. 188 and 189, a method of assembling the various members at the drive side end of the toner cartridge C310 will be described. FIG. 188 is an exploded perspective view illustrating the drive side of the toner cartridge C310 according to Embodiment 31 of the present invention, with some parts not shown for the sake of better illustration. The drive side of the toner cartridge C310 according to this embodiment is the side on which the pump unit 37 is provided. FIG. 189 is a perspective view of the drive side end of the toner cartridge C310 according to Embodiment 31 of the present invention, with some parts not shown for better illustration. As shown in FIGS. 188 and 189, the battery 31071 is mounted (by adhesive or the like) on the end surface, in the Z1 direction, of the accommodation frame 31031. In addition, the motor 31075 is mounted on the accommodation frame 31031 by means of screws or the like so that a driving shaft (not shown) faces in the Z2 direction. Further, the pinion gear 31077, which is a motor side gear provided on the driving shaft of the motor 31075, is disposed in a position where it can transmit drive to the pump unit 37 through engaging with a gear train 45 provided at the drive side end of the accommodation frame 31031.

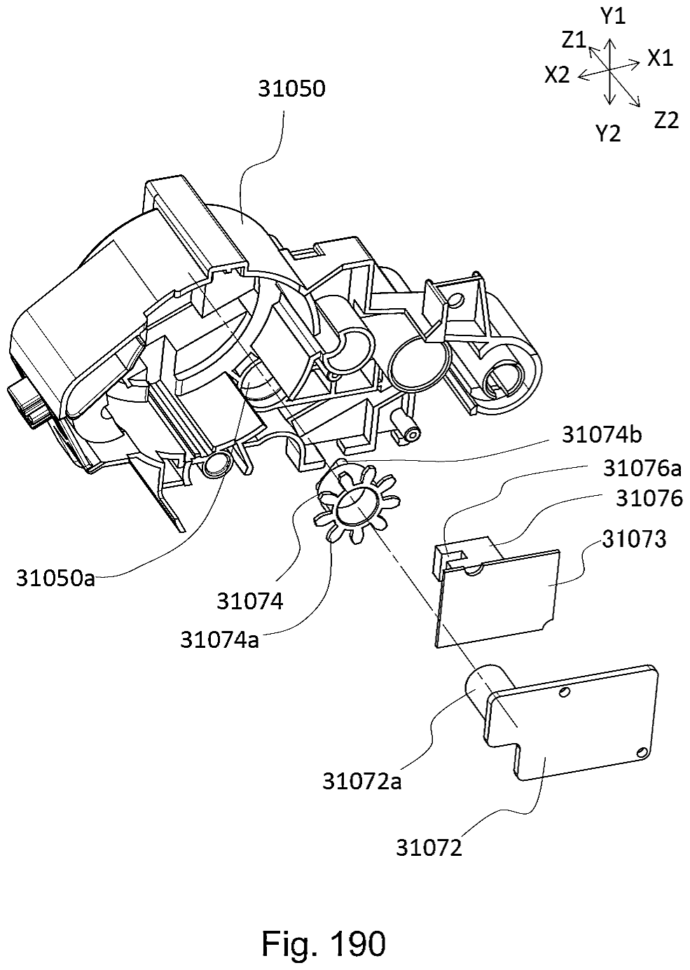

Next, referring to FIGS. 189 and 190, a method of mounting each part to the side cover 31050 will be described. FIG. 190 is an exploded perspective view of the side cover 31050 according to Embodiment 31 of the present invention, as viewed in the Z2 direction, with some portions not shown for better illustration. As shown in FIG. 190, a detection coupling 31074 is fitted around a shaft 31072a provided on the fixing metal plate 31072 from the Z1 direction side toward the Z2 direction side, whereby the detection coupling 31074 is rotatably supported by the fixing metal plate 31072. Also, as shown in FIG. 189, the detection blade 31074a of the detection coupling 31074 is placed inside the slit portion 31076a of the detection portion 31076 in the direction parallel to the Z axis. In other words, each of the blades constituting the detection blade 31074a of the detection coupling 31074 can move inside the slit portion 31076a on a plane perpendicular to the Z axis by the rotation of the detection coupling 31074.

As shown in FIG. 190, the fixing metal plate 31072 is fixed to the side cover 31050 in the Z1 direction side from the Z2 direction side with screws or the like (not shown). The coupling portion 31074b of the detection coupling 31074 mounted to the fixing metal plate 31072 is inserted into the hole portion 31050a, and the free end portion is exposed to the outside of the side cover 31050.

When mounting the side cover 31050 to the accommodation frame 31031, the control board 31073, the battery 31071, and the motor 31075 are electrically connected with conductor lines 31079 before mounting the side cover 31050 (see FIG. 189). Thereafter, the side cover 31050 is mounted to the accommodation frame 31031 in the Z2 direction using screws (not shown).

Next, as regards the toner cartridge C310 according to this embodiment, the operation of each part when the pump unit 37 is driven will be described. First, as shown in FIG. 189, the coupling portion 31074b of the detection coupling 31074 receives the driving force outputted from the printer main assembly A. The shape of the coupling portion 31074a is substantially the same as that of the screw coupling portion 39a of Embodiment 1 described in the foregoing, and the coupling portion 31074a of this embodiment is also disposed in the same position as the screw coupling portion 39a of Embodiment 1.

When the detection coupling 31074 is rotated by the driving force received from the printer main assembly A, the detection blade 31074a rotates in interrelation with the detection coupling 31074. Then, the detection blade 31074a rotates and passes through the slit 31076a of the detection portion 31076, and the rotation is detected by the detection portion 31076. Then, in response to detecting this rotation, the control board 31073 starts supplying the power from the battery 31071 to the motor 31075, and controls the motor 31075 to rotate using the supplied power. This control causes the pinion gear 31077 provided on the driving shaft of the motor 31075 to rotate, thereby transmitting driving force to the gear train 45 that engages with the pinion gear 31077, so as to drive the pump unit 37 in the same manner as in Embodiment 1 described in the foregoing. The control may be performed by a CPU (not shown) provided in the toner cartridge C310, as long as the CPU and other components constituting the toner cartridge C310 are controlled as a whole.

In this embodiment, the battery 31071 is a box-shaped alkaline battery with an output rated voltage of 9V, but the present invention is not limited to such an example, and the battery which can be usable with this embodiment may have other specifications, such as a lithium-ion battery.

As described above, the toner cartridge C310 according to this embodiment can drive the pump unit 37 in the same manner as in Embodiment 1, without receiving a driving force from the printer main assembly A side. With this structure, the toner cartridge C310 according to this embodiment does not require the printer main assembly A to consume electric power when driving the pump unit 37, and the amount of the electric power used by the printer main assembly A can be reduced.

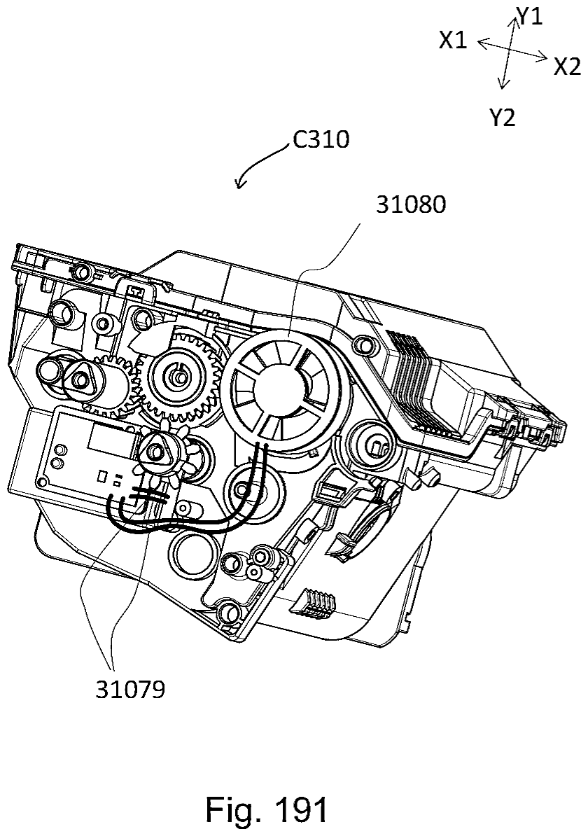

In this embodiment, the air and toner are fed (discharged) by the air pressure difference produced when the pump 37a is compressed and restored, but the present invention is not limited to such an example. For example, as shown in FIG. 191, a structure may be employed in which an electrically powered fan 31080 is employed in place of the pump 37a, and the air is caused to flow inside the accommodation frame 31031 by the operation of the fan 31080. In this case, it is only necessary that the battery 31071 described above is electrically connected to the control board 31073 and then to the fan 31080 by way of the lead wire 31079. FIG. 191 is an illustration of an example of a toner cartridge C310 provided with a fan 31080 as a modified example of Embodiment 31 of the present invention.

In this embodiment, the detection portion 31076, which is a detecting member, detects whether the printer main assembly A is being driven, and the pump unit 37 is controlled to be driven according to the detection result, but the present invention is not limited to such an example. For example, a structure may be employed in which a switch which can be manually operated by the user is provided, and the power is supplied from the battery 31072 to each part of the toner cartridge C310 in response to the user operating the switch. With such a structure, the user can supply toner at any time.

In addition, in this embodiment, a battery 31071 is used as the driving source for driving the pump unit 37, but a driving source other than a battery (such as a spring), for example, may be used.

Further, in this embodiment, only the operation related to driving the pump unit 37 is described, but the structure of this embodiment described above may be used for a structure other than the pump unit 37 (for example, a toner stirring operation, and so on).

### Embodiment 32

In the above-described Embodiment 1, the driving/stirring coupling portion 38a, through which the toner cartridge C receives the driving force outputted from the printer main assembly A, and the screw coupling portion 39a rotates about the axis G parallel to the Z axis. In contrast, in this embodiment, a toner cartridge C320 has a rotation axis of a driving force receiving portion which receives driving force from the printer main assembly A is inclined (intersecting) with respect to the Z axis. The same components as those in Embodiment 1 will be described with the same reference numerals and symbols as those in Embodiment 1. Furthermore, as for the toner cartridge, the process cartridge, and the printer main assembly, the components having the same functions and roles as those in Embodiment 1 are given the same names and like reference numerals and symbols.

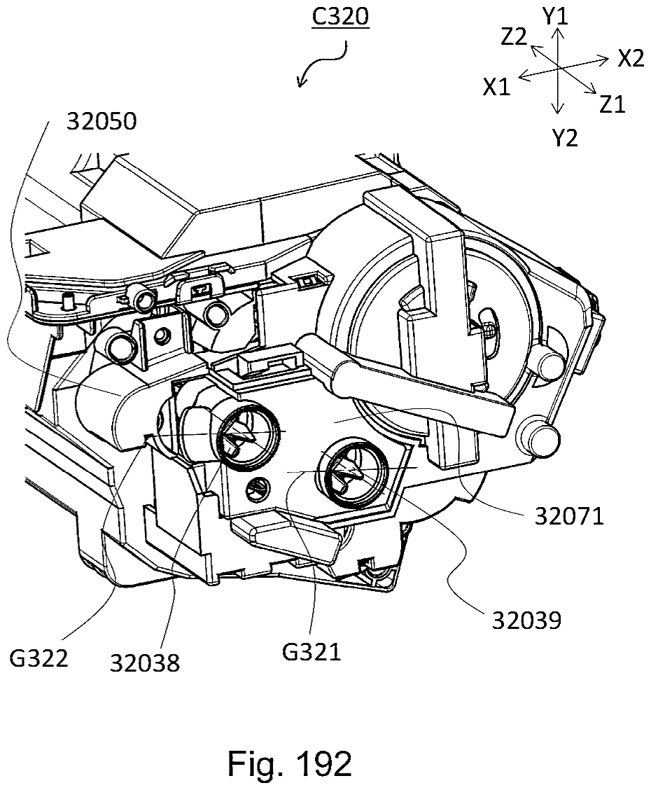

FIG. 192 is an external perspective view of the toner cartridge C320 according to Embodiment 32, mainly on the driving force receiving portion. As shown in FIG. 192, the stirring drive receiving portion 32038 of this embodiment is a first drive force receiving portion which is rotatable about an axis G322. The pump-screw drive receiving portion 32039 is a second drive force receiving portion which is rotatable about the axis G321. The axis G321 is inclined by about 45° with respect to the Z axis. The stirring drive receiving portion 32038 and the pump-screw drive receiving portion 32039 are supported by a movable cover 32071 mounted to a drive side cover 32050.

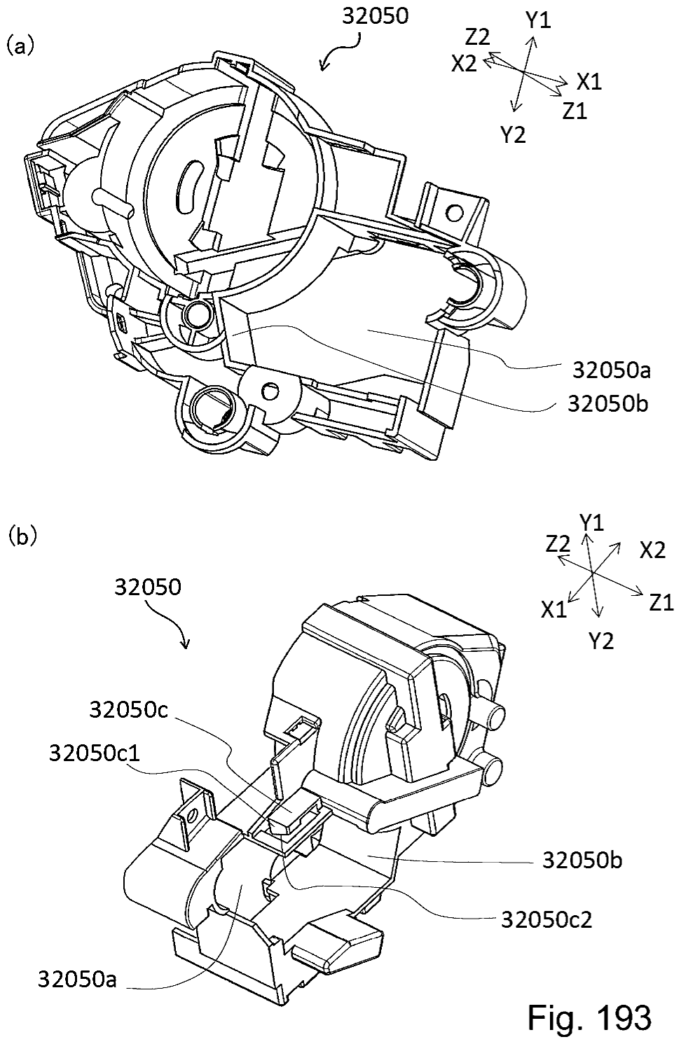

Next, referring to FIG. 193, the structure of the drive side cover 32050 according to this embodiment will be described. FIG. 193 is an external perspective view of a drive side cover 32050 according to Embodiment 32 of the present invention, wherein part (a) of FIG. 193 and part (b) of FIG. 193 show the drive side cover 32050 as viewed in different directions. The drive side cover 32050 has a shape similar to the drive side toner cartridge side cover 50 of Embodiment 1 described in the foregoing, and the differences of this embodiment from the structure described in Embodiment 1 will be mainly described.

As shown in part (a) of FIG. 193, the drive side cover 32050 is provided with a first hole portion 32050a having an opening facing in a direction parallel to the Z axis. Furthermore, a first wall portion 32050b is provided extending in a direction parallel to the Z-axis so as to surround the first hole portion 32050a. As shown in part (b) of FIG. 193, a claw portion 32050c is provided on the end surface, in the Y1 direction, of the first wall portion 32050b. The claw portion 32050c is an extending member extending from the drive side cover 32050 in the X1 direction from the X2 direction, and is provided at its end in the X1 direction side with an inclined projection 32050cl extending in the Y2 direction. This inclined projection 32050cl is provided with an inclined surface 32050c2 on the end in the Y2 direction side, which is sloped from the Z2 direction side toward the Z1 direction side.

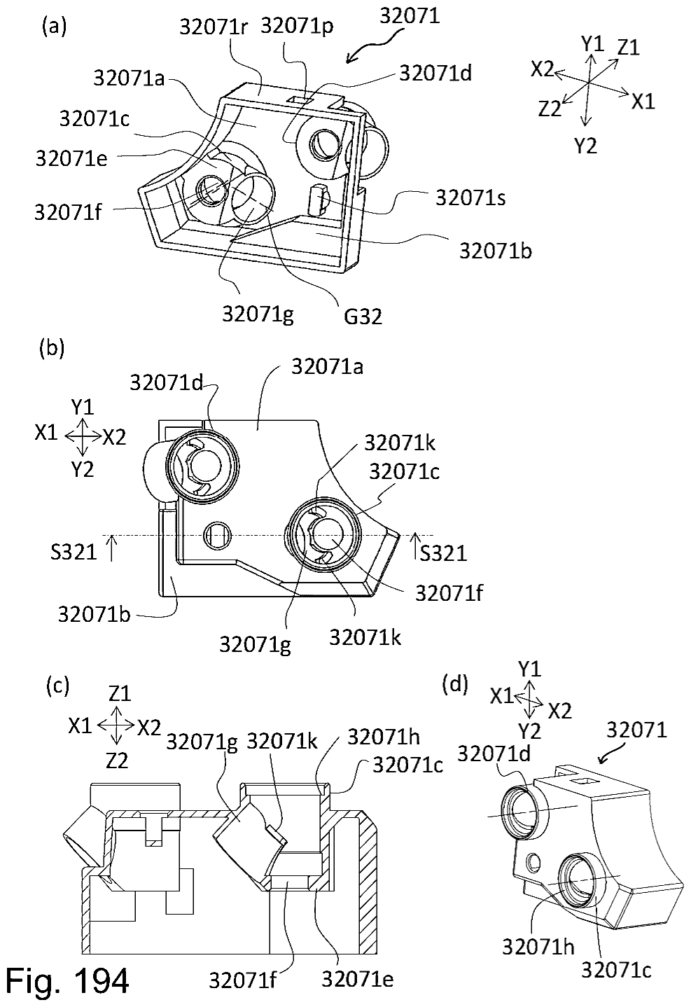

Next, referring to part (a) of FIG. 194 to part (d) of FIG. 194, the structure of the movable cover 32071 according to this embodiment will be described. FIG. 194 is an illustration of an example of the structure of the movable cover 32071 according to Embodiment 32 of the present invention. Part (a) of FIG. 194 and part (d) of FIG. 194 are external perspective views of the movable cover 32071 as viewed in different directions, part (b) of FIG. 194 is a side view of the movable cover 32071, and part (c) of FIG. 194 is a sectional view taken along a line S321-S321 shown in part (b) of FIG. 194.

As shown in part (a) of FIG. 194, the movable cover 32071 has a shape recessed in the Z1 direction from the edge which forms the exterior, and has a first wall surface portion 32071a at the end in the Z1 direction which is approximately parallel to the XY plane. In addition, a second wall portion 32071r extends in the Z2 direction from the first wall surface portion 32071a. Further, a second hole portion 32071p is provided in the second wall portion 32071r at a position corresponding to the end surface, in the Y1 direction, of the movable cover. Furthermore, a first spring hook portion 32071s is provided extending from the first wall surface portion 32071a in the Z2 direction. The first wall surface portion 32071a is provided with a step portion 32071b, which is a surface approximately parallel to the first wall surface portion 32071a, at a position corresponding to the end surface, in the Z2 direction, of the movable cover 32071.

As shown in part (a) of FIG. 194, part (b) of FIG. 194, and part (d) of FIG. 194, the first wall surface portion 32071a is provided with a first cylindrical portion 32071c and a second cylindrical portion 32071d, which are two cylindrical portions extending in a direction parallel to the Z axis (Z2 direction). The second cylindrical portion 32071d has the same shape as the first cylindrical portion 32071c, and therefore, the following description will refer to the first cylindrical portion 32071c.

As shown in part (a) of FIG. 194, part (c) of FIG. 184, and part (d) of FIG. 194, a contact surface 32071e facing in the Z2 direction is provided at the end, in the Z2 direction, of the first cylindrical portion 32071c. The contact surface 32071e is provided with a third hole portion 32071f penetrating in a direction parallel to the Z axis. In addition, the first cylindrical portion 32071c is provided with a third cylindrical portion 32071g having a central axis aligned with an axis G32 intersecting with the central axis of the first cylindrical portion 32071c.

A first rib 32071k is provided on the end surface on the Z1 direction side of the third cylindrical portion 32071g (i.e., exterior side of the movable cover 32071), which is perpendicular to the central axis of the third cylindrical portion 32071g and extends toward the central axis. The first ribs 32071k are provided at each of two positions symmetrically about the central axis of the third cylindrical portion 32071g so as to cover a part of the inner surface of the third cylindrical portion 32071g. As shown in part (c) of FIG. 194 and part (d) of FIG. 194, inside the first cylindrical portion 32071c, an inner cylindrical (circumferential) drive abutment surface 32071h is provided on the end side in the Z1 direction (outer side of the movable cover 32071) which is coaxial with the central axis of the first cylindrical portion 32071c.

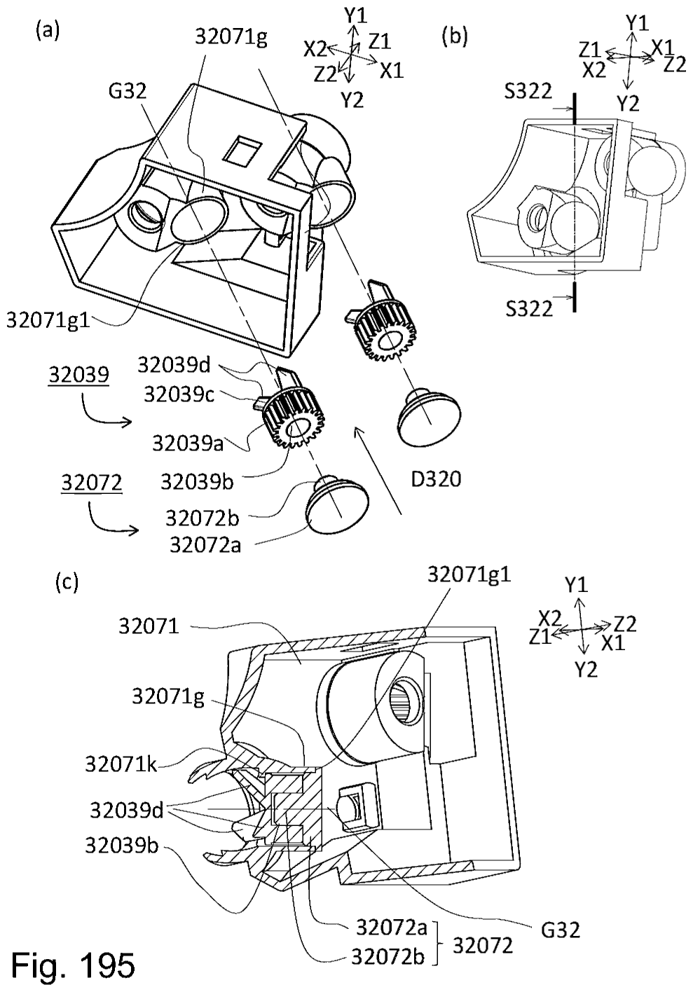

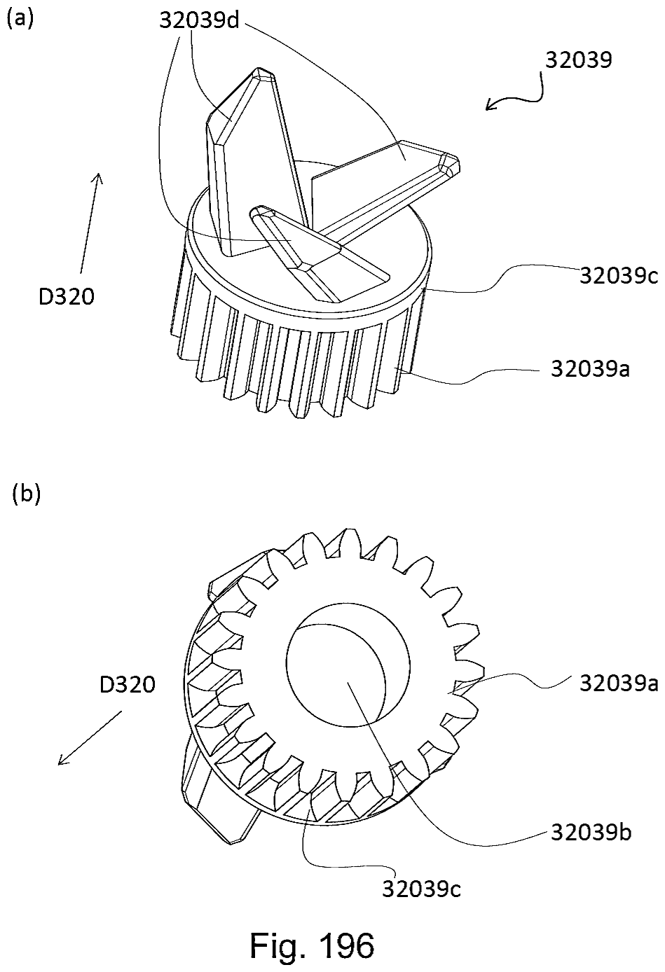

Next, referring to FIGS. 195 and 196, a method of mounting the stirring drive receiving portion 32038 and the pump-screw drive receiving portion 32039 to the movable cover 32071 will be described. FIG. 195 is an illustration of an example of the arrangement of a stirring drive receiving portion 32038 and a pump-screw drive receiving portion 32039 in a movable cover 32071 according to Embodiment 32 of the present invention. Part (a) of FIG. 195 is a partial exploded perspective view of the movable cover 32071 and two different couplings. Part (b) of FIG. 195 is a perspective view of the movable cover 32071 in an assembled state from the state shown in the exploded perspective view of part (a) of FIG. 195, as viewed in the direction of the arrow D320. Furthermore, part (c) of FIG. 195 is a sectional view taken along a line S322-S322 shown in part (b) of FIG. 195. FIG. 196 is a perspective view of a pump-screw drive receiving portion 32039 according to Embodiment 32 of the present invention. Part (a) of FIG. 196 shows the side where the driving force (rotational force) is received from the printer main assembly A, and part (b) of FIG. 196 shows the side where the driving force is outputted to the inside of the toner cartridge C320. In this embodiment, the pump-screw drive receiving portion 32039 and the stirring drive receiving portion 32038 are mounted using members of the same shape and in substantially the same manner, and therefore, the detailed explanation of the stirring drive receiving portion 32038 will be omitted.

As shown in part (a) of FIG. 195, part (a) of FIG. 196 and part (b) of FIG. 196, the pump-screw drive receiving portion 32039 has a gear portion 32039a having a rotation center axis which is coaxial with the axis G32. In addition, the pump-screw drive receiving portion 32029 is provided with a circular recess portion 32039b on the inside of the gear portion 32039a. It is provided coaxially with the gear portion 32039a. As shown in part (a) of FIG. 196 and part (b) of FIG. 196, a disk-shaped flange portion 32039c is provided on one end side of the gear portion 32039a (the side on which an engaging projection 32039d, which will be described hereinafter, is provided) on a downstream side in the direction D320. Engagement projections 32039d of the same shape are formed projecting (extending) in the direction D320 from the flange portion 32039c at intervals of 120° with respect to the axis G32. In this embodiment, three engaging projections 32039d are provided, but the number of engagement projections is not limited to this, and, the number may be increased or decreased depending on the shape of the coupling provided on the printer main assembly A, for example. In addition, the pump-screw drive receiving portion 32029 in this embodiment has been described as a single member in which the gear portion 32039a, the first flange portion 32039c, and the engaging projection 32039d are integrally formed, but the present invention is not limited to such an example. For example, the pump-screw drive receiving portion 32029 may be formed by combining the gear portion 32039a, the first flange portion 32039c, and the engaging projection 32039d, which are separate members.

As shown in part (a) of FIG. 195, a coupling receiving member 32072 is a supporting member that is mounted to the back side of the pump-screw drive receiving portion 32029 (the side where the gear portion 32039a is provided relative to the engaging projection 32039d). The coupling receiving member 32072 is provided with, a disk-shaped second flange portion 32072a and a projection 32072b having a smaller diameter than the second flange portion 32072a, in the order in the direction of the arrow D320 in the Figure. As shown in part (a) of FIG. 195, the projection 32072b of the coupling receiving member 32072 fits into the circular recess portion 32039b of the pump-screw drive receiving portion 32039 in the D320 direction. With this structure, the pump-screw drive receiving portion 32039 is rotatably supported by the projection 32072b of the coupling receiving member 32072.

Then, the second flange portion 32072a is mounted to the end surface 32071g1 of a third cylindrical portion 32071g of the movable cover 32071 by adhesive or the like, thereby completing the attachment of the pump-screw drive receiving portion 32039 to the movable cover 32071. As shown in part (c) of FIG. 195, a first rib 32071k is provided in the D320 direction side of the pump-screw drive receiving portion 32039, so that the movement of the pump-screw drive receiving portion 32039 in the D320 direction is restricted.

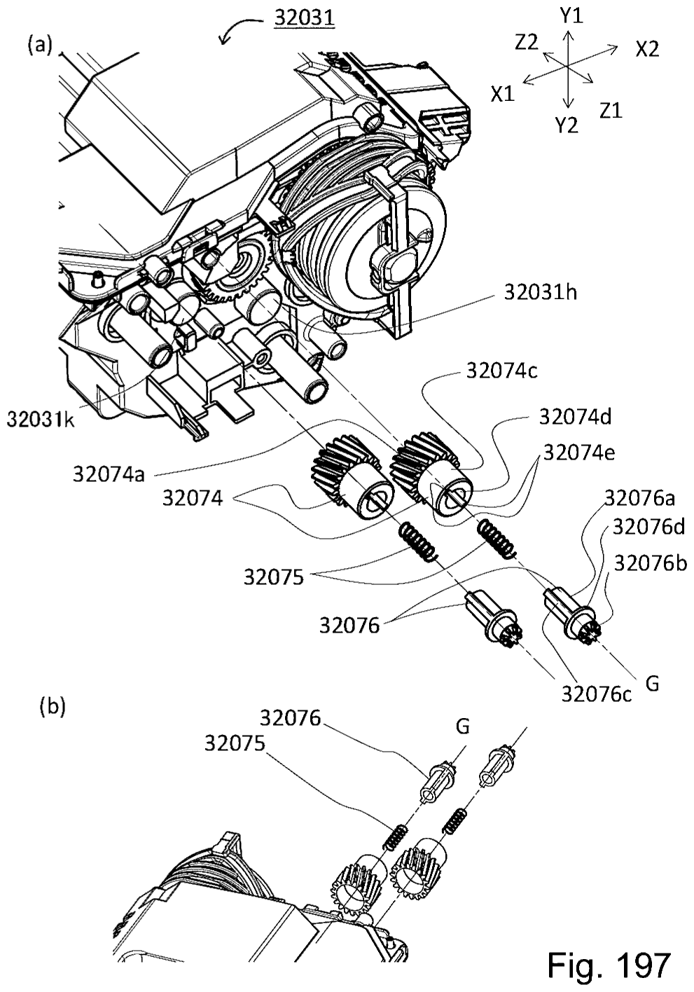

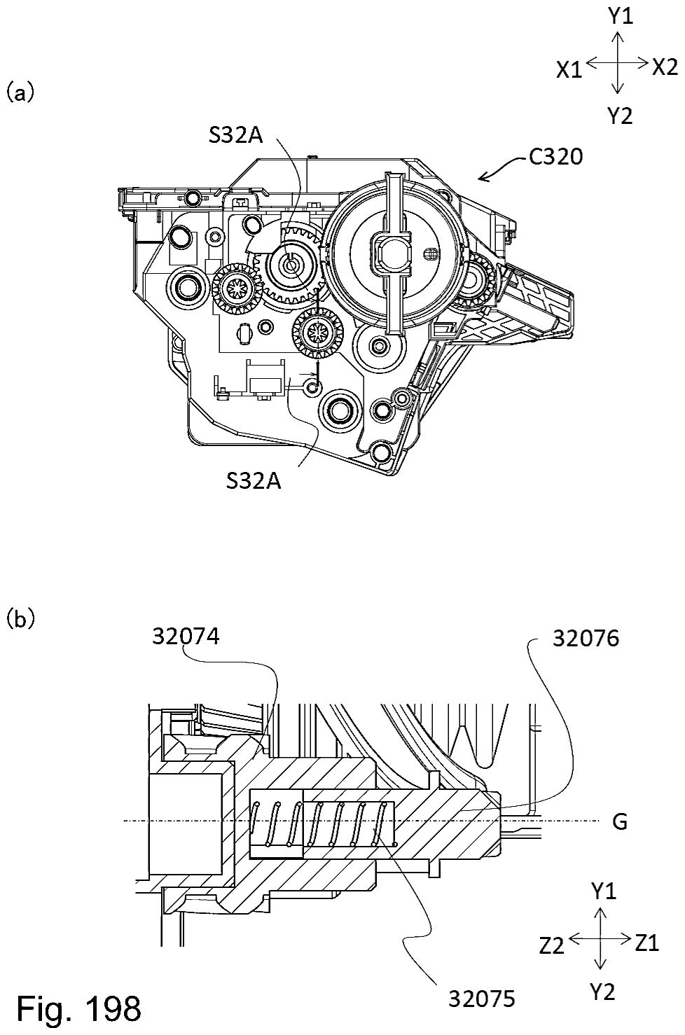

Next, referring to FIGS. 197 and 198, a method of assembling each member to the accommodation frame 32031 will be described. FIG. 197 is a partial exploded perspective view of the drive side of the toner cartridge C320 according to Embodiment 32 of the present invention. Part (a) of FIG. 197 shows the drive side of the accommodating frame 32031 as viewed in the Z1 direction, and part (b) of FIG. 197 shows the drive side of the accommodating frame 32031 as viewed in the Z2 direction. FIG. 198 is an illustration of an example of the drive transmission member of the toner cartridge C320 according to Embodiment 32 of the present invention. Part (a) of FIG. 198 is a side view of the drive end of the toner cartridge C320 (or the accommodating frame 32031), and for the sake of better illustration, some members are not shown. Part (b) of FIG. 198 is a sectional view taken along a line S32A-S32A shown in part (a) of FIG. 198. In addition, the accommodating frame 32031 according to this embodiment has substantially the same shape as the accommodation frame 31 according to Embodiment 1 described in the foregoing, and therefore, only the parts of this embodiment which are different from Embodiment 1 will be described.

As shown in part (a) of FIG. 197 and part (b) of FIG. 197, the accommodating frame 32031 is provided with a first cylindrical portion 32031h and a second cylindrical portion 32031k which project in the Z1 direction. In addition, in the accommodating frame 32031, the drive transmission gear member 32074, a compression spring 32075, and a drive receiving coupling 32076 are mounted to each of the first cylindrical portion 32031h and the second cylindrical portion 32031k. In addition, the method of mounting each member to the two cylindrical portions is the same, the following description will be made for the first cylindrical portion 32031h side, and the description of the second cylindrical portion 32031k side will be omitted.

The drive transmission gear member 32074 is a driving force transmission member which transmits the drive force received by the pump-screw drive receiving portion 39 from the printer main assembly A side to the inside of the toner cartridge C320. The drive transmission gear 32074 includes a first gear 32074a having substantially the same shape as the gear located at the end of the screw drive input portion 39 in the Z2 direction, in Embodiment 1 described in the foregoing. The drive transmission gear member 32074 is mounted to the accommodating frame 32031 in the manner similar to the pump-screw drive input portion. A fourth cylindrical portion 32074c is formed on the drive transmission gear member 32074 in the Z1 direction side relative to the first gear portion 32074a. In addition, a fourth circular hole 32074d is provided in the center of the fourth cylindrical portion 32074c coaxially with the central axis (Z-axis direction) of the fourth cylindrical portion 32074c. The fourth hole portion 32074d is provided with two rectangular holes 32074e which expand outward in the radial direction relative to the central axis, and are disposed at two positions symmetrical with respect to the rotation axis G of the drive transmission gear member 32074.

The drive receiving coupling 32076 has a fifth cylindrical portion 32076a coaxial with the axis G, and the compression spring 32075 is fitted into the fifth cylindrical portion. Further, the drive receiving coupling 32076 is provided with a disk portion 32076d on the Z1 direction side with respect to the fifth cylindrical portion 32076a. On the outer periphery of the fifth cylindrical portion 32076a, second ribs 32076c extending radially outward (with respect to the rotation axis) are provided at two locations symmetrical with respect to the rotation axis (synonymous with axis G), respectively. A coupling portion 32076b is provided on the drive receiving coupling 32076 at the end opposite to the side where the drive transmission gear member 32074 is mounted in the rotational axis direction (i.e., the end in the Z1 direction).

Next, a method of assembling the drive transmission gear member 32074 and the drive receiving coupling 32076 to the above-described accommodating frame 32031 will be described. The compression spring 32075 and the drive receiving coupling 32076 are mounted coaxially with the axis G to the drive transmission gear member 32074 in the Z2 direction. More specifically, the fifth cylindrical portion 32076a of the drive receiving coupling 32076 is inserted into the fourth hole portion 32074d of the drive transmission gear member 32074, and at the same time, the second rib 32076c is fitted into the rectangular hole portion 32074e. Therefore, in this state, the rotational directions of both the drive transmission gear member 32074 and the drive receiving coupling 32076 are restricted. With this structure, as shown in part (b) of FIG. 198, the drive receiving coupling 32076 is supported movably by the drive transmission gear member 32074 while receiving the urging force of the compression spring 32075 in a direction parallel to the Z axis.

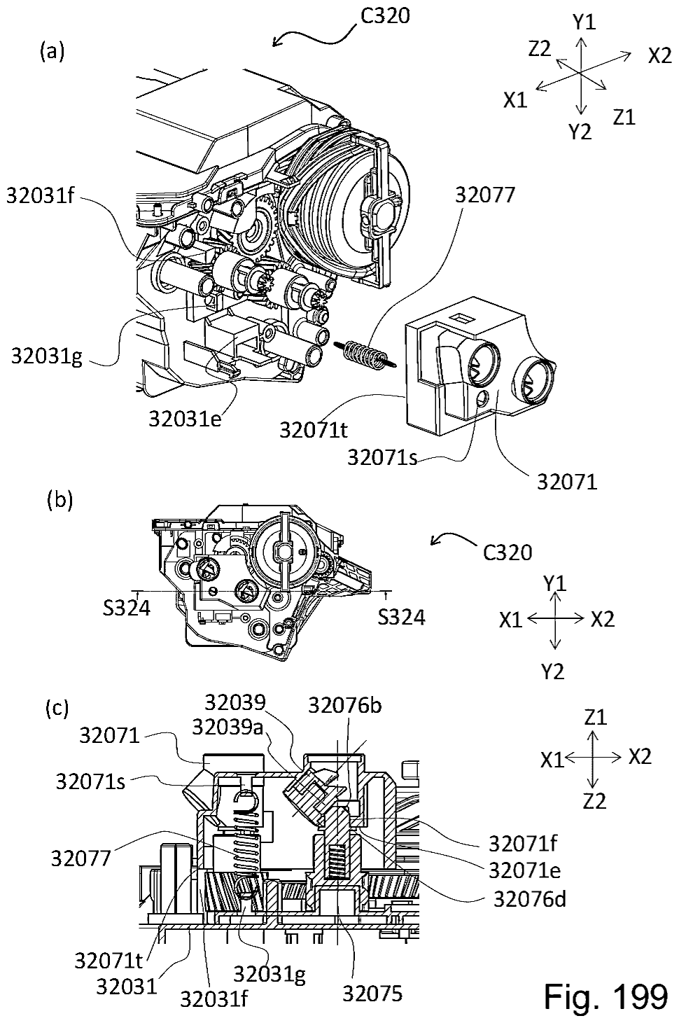

Next, referring to FIG. 199, a method of mounting the movable cover 32071 to the accommodating frame 32031 will be described. FIG. 199 is an illustration of an example of a method of mounting a movable cover 32071 to the accommodation frame 32031 according to Embodiment 32 of the present invention. Part (a) of FIG. 199 is an exploded perspective view illustrating a state in which the movable cover 32071 is removed from the accommodating frame 32031. Part (b) of FIG. 199 is a side view of the toner cartridge C320 as viewed from the drive side. In addition, part (c) of FIG. 199 is a sectional view taken along a line S324-S324 shown in part (b) of FIG. 199.

As shown in part (a) of FIG. 199, the accommodating frame 32031 is provided with two projections, i.e., a first projection 32031e and a second projection 32031f which project in the Z1 direction, and a second spring hook portion 32031g. As shown in part (c) of FIG. 199, one end of a tension spring 32077 is mounted to the spring hook portion 32031g, and the other end of this tension spring 32077 is mounted to a first spring hook portion 32071s of the movable cover 32071.

The movable cover 32071 is urged in the Z2 direction by the urging force produced by a tension spring 32077. Then, due to this urging force, the end surface 32071t on the Z2 direction side of the movable cover 32071 comes into contact with the first projection 32031e and the second projection 32031f of the accommodating frame 32031, so that the movement of the movable cover 32071 stops. This is the state where the mounting of the movable cover 32071 to the accommodating frame 32031 is completed (see part (c) of FIG. 199).

As shown in part (c) of FIG. 199, the drive receiving coupling portion 32076b of the drive receiving coupling 32076 mounted to the accommodating frame 32031 is inserted into the third hole portion 32071f of the movable cover 32071. Then, the urging force of the compression spring 32075 disposed inside the fifth cylindrical portion 32076a brings the disk portion 32076d into contact with the contact surface 32071e. At this time, the urging force of the compression spring 32075 is sufficiently smaller than the urging force of the tension spring 32077, so that the contact state between the movable cover 32071 and the accommodating frame 32031 is maintained. In this state, the coupling portion 32076b of the drive receiving coupling 32076 engages (meshes) with the gear portion 32039a of the pump-screw drive receiving portion 32039 supported by the movable cover 32071.

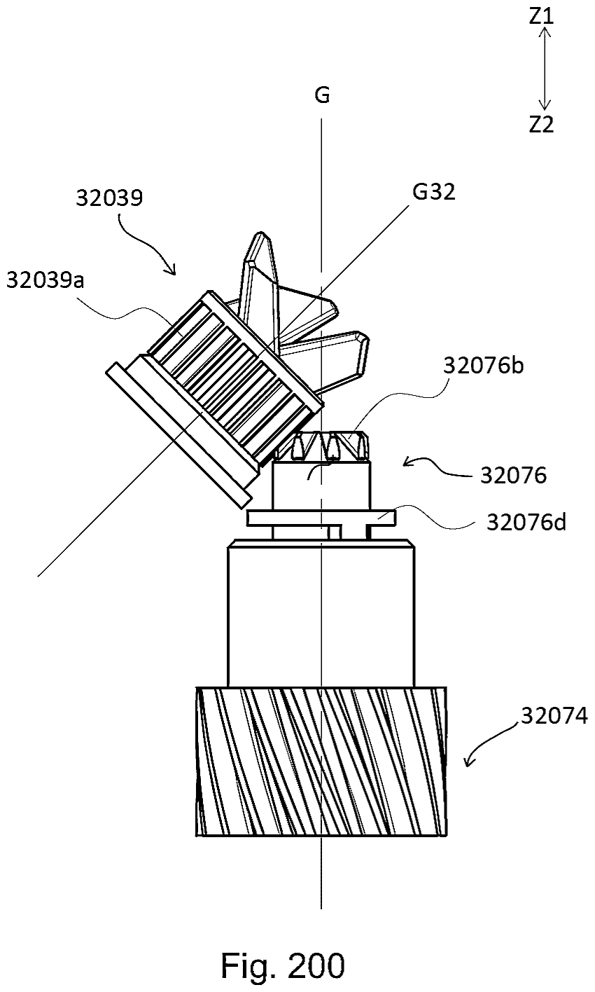

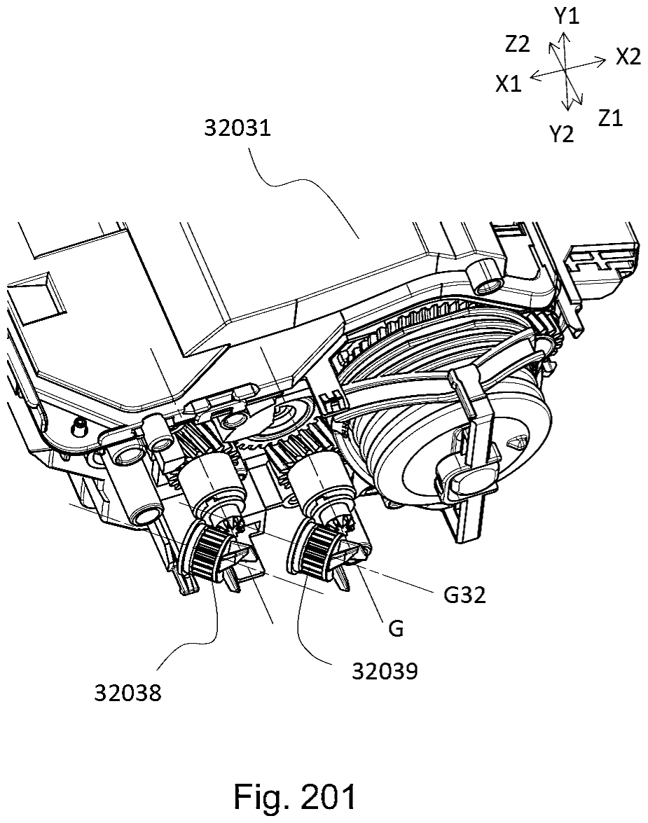

Next, referring to FIGS. 200 and 201, the manner in which the drive receiving coupling 32076 and the pump-screw drive receiving portion 32039 are engaged will be described. FIG. 200 is a partial side view illustrating an example of the engagement state between the pump-screw drive receiving portion 32039, the drive receiving coupling 32076, and the drive transmission gear member 32074 according to Embodiment 32 of the present invention. FIG. 201 is an external perspective view of the toner cartridge C320 according to Embodiment 32 of the present invention with the movable cover 32071 mounted to the end on the drive side (Z1 direction). In FIG. 201, the movable cover 32071 is not shown, for the purpose of better illustration, and the mounting state of the stirring drive receiving portion 32038 and the pump-screw drive receiving portion 32039 which are rotatably supported on the movable cover 32071 is illustrated. As shown in FIGS. 200 and 201, the rotation axis G of the drive receiving coupling 32076 is approximately parallel to the longitudinal direction of the toner cartridge C320 when the drive receiving coupling 32076 is mounted to the toner cartridge C320.

As shown in FIG. 200, in the state that they are engaged with each other, the drive receiving coupling 32076 can rotate (pivot) about the axis G, and the pump-screw drive receiving portion 32039 can rotate (pivot) about the axis G32, wherein the rotation axes of the two portions intersect. Then, the gear portion 32039a of the pump-screw drive receiving portion 32039 and the coupling portion 32076b of the drive receiving coupling 32076 engage (mesh) with each other. In this state, the rotational force (driving force) about the axis G32 of the pump-screw drive receiving portion 32039 is transmitted to the drive receiving coupling 32076.

As described above, the drive receiving coupling 32076 and the pump-screw drive receiving portion 32039 are rotatably supported by the movable cover 32071, while their axial movement is restricted, so that the positioning with high precision is accomplished. Therefore, the coupling portion 32076b of the drive receiving coupling 32076 and the gear portion 32039a of the pump-screw drive receiving portion 32039 can be engaged (meshed) with each other with high precision.

As shown in FIG. 201, with the movable cover 32071 mounted to the accommodating frame 32031, the rotation axis G32 of the stirring drive receiving portion 32038 and the pump-screw drive receiving portion 32039 supported by the movable cover 32071 is inclined with respect to the rotation axis G. As mentioned above, in FIG. 201, the movable cover 32071 is omitted for the sake of better illustration.

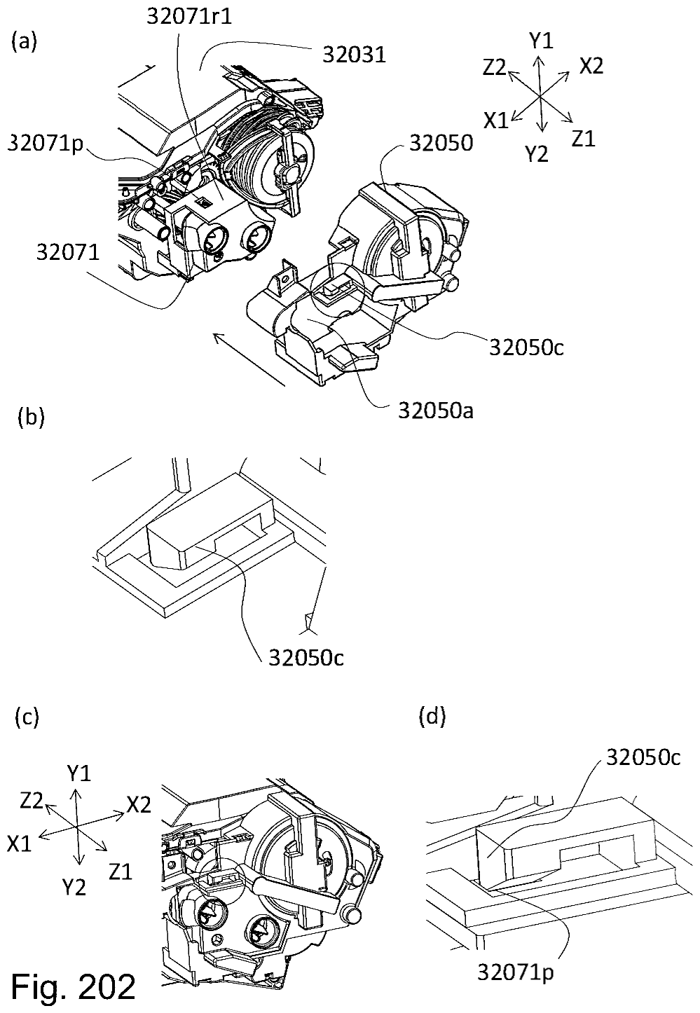

Next, referring to FIG. 202, a method of mounting the drive side cover 32050 to the accommodating frame 32031 will be described. FIG. 202 is an illustration of an example of a method of mounting a drive side rear cover 32050 to an accommodating frame 32031 according to Embodiment 32 of the present invention. Part (a) of FIG. 202 is a partially exploded perspective view of the toner cartridge C320 with the drive side cover 32050 removed (before mounting). Part (b) of FIG. 202 is an enlarged view of the part encircled by a solid line in part (a) of FIG. 202. Part (c) of FIG. 202 is a partial external perspective view of the state in which the drive side cover 32050 is assembled to the accommodating frame 32031. Part (d) of FIG. 202 is an enlarged view of the part encircled by a solid line in part (c) of FIG. 202.

As shown in part (a) of FIG. 202, a drive side cover 32050 is mounted to the accommodating frame 32031 from the Z2 direction side, and fixed there with screws or the like (not shown). When the drive side cover 32050 is mounted to the accommodation frame 32031, the claw portion 32050c shown in part (b) of FIG. 202 rides over the surface 32071rl of the second wall portion 32071r, which is the end surface in the Y1 direction of the movable cover 32071, while deforming in the Y1 direction. Thereafter, the free end of the claw portion 32050c is inserted into a second hole portion 32071p provided in the surface 32071r1. In addition, the movable cover 32071 fits into a first hole portion 32050a provided in the drive side cover 32050, and movement in directions parallel to the X-axis and Y-axis is restricted. In this state, the assembly of the toner cartridge C320 is completed by fixing them with screws (not shown) as described above.

Next, a method for mounting the toner cartridge C320 into the printer main assembly A will be described. First, the toner cartridge C320 of this embodiment is mounted in the printer main assembly A in the same manner as the toner cartridge C of Embodiment 1 described in the foregoing. That is, as shown in FIG. 22, the toner cartridge C320 is guided by a first guide portion 108 and a second guide portion 109 and moved in the direction of the arrow D while being mounted to the printer main assembly A. As shown in FIG. 92, a first main assembly side coupling 110 is provided extended from the second guide portion 109 of the printer main assembly A in the Z2 direction. By the opening/closing door 107 being closed, the first main assembly side coupling 110 is moved in the Z2 direction toward a position where it can engage with the pump-screw drive receiving portion 32029 provided on the toner cartridge C320.

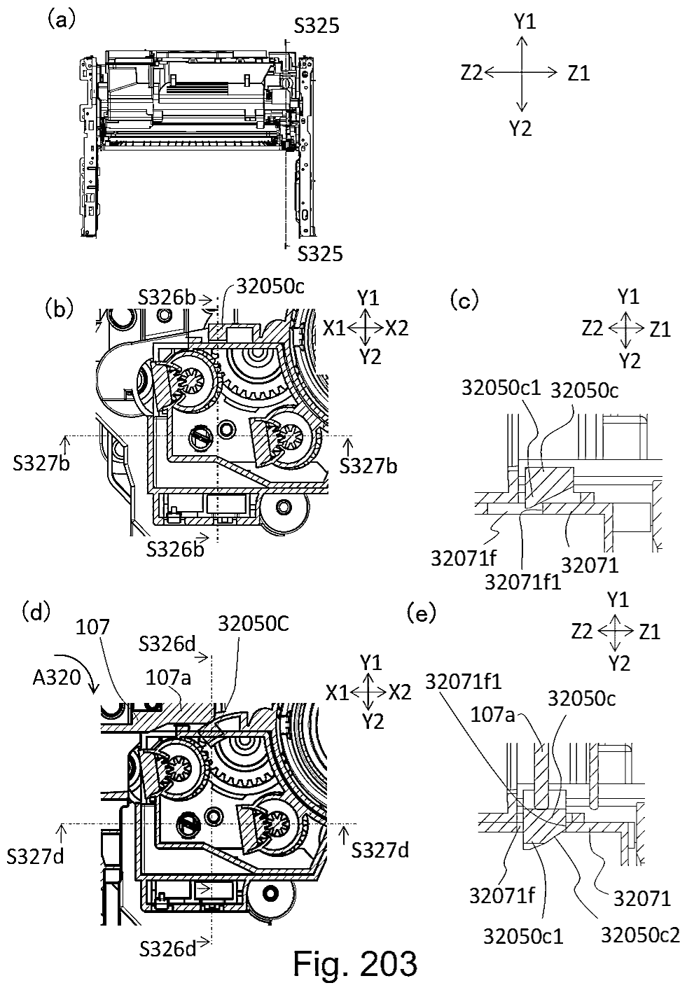

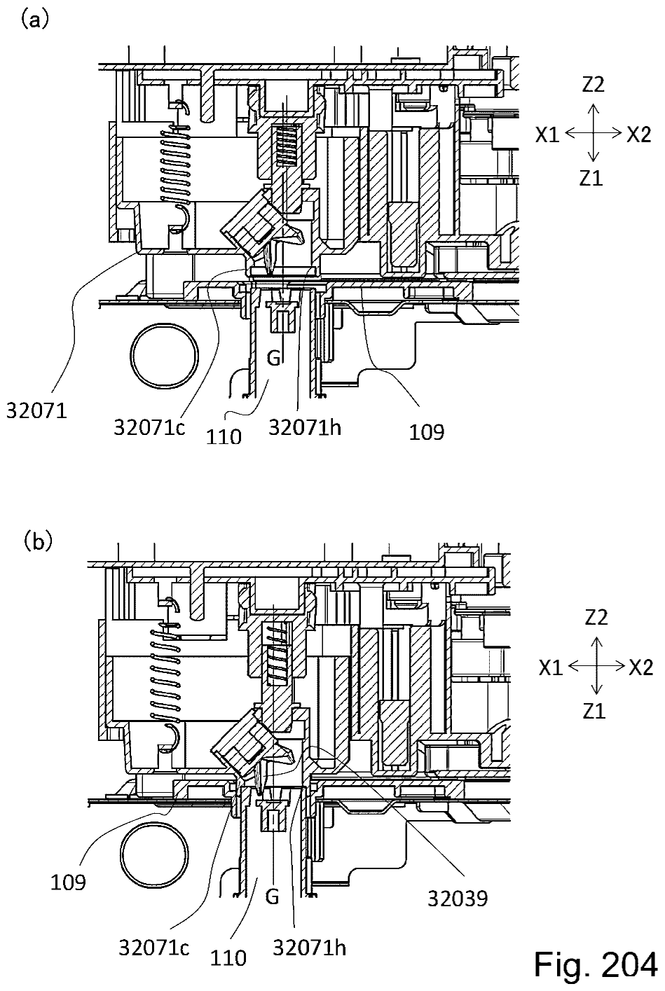

Next, referring to FIGS. 203 and 204, a method of engaging the pump-screw drive receiving portion 32039 with the first main assembly side coupling 110 will be described. FIG. 203 is an illustration of an example of a method of engaging the pump-screw drive receiving portion 32039 and the first main assembly side coupling 110 according to Embodiment 32 of the present invention. Part (a) of FIG. 203 is a side view of the toner cartridge C320 after mounting in the printer main assembly A has been completed, with the opening/closing opening/closing door 107 open, as viewed from the X1 direction. For better illustration, the opening and closing opening/closing door 107 is not shown in the drawing. Part (b) of FIG. 203 is a cross-sectional view taken along a line S325-S325 shown in part (a) of FIG. 203. Part (c) of FIG. 203 is a cross-sectional view taken along a line S326b-S326b shown in part (b) of FIG. 203. Part (d) of FIG. 203 is a cross-sectional view taken along a line S325-S325 shown part (a) of FIG. 203, with the opening/closing opening/closing door 107 closed. Part (e) of FIG. 203 is a sectional view taken along a line S326d-S326d indicated in part (d) of FIG. 203, showing a state in which the opening and closing opening/closing door 107 is closed compared to part (c) of FIG. 203. FIG. 204 is an illustration of an example of the change in position of the first main assembly side coupling 110 and the pump-screw drive receiving portion 32039 depending on the open/close state of the opening/closing opening/closing door 107 in accordance with Embodiment 32 of the present invention. Of these, part (a) of FIG. 204 is a sectional view taken along a line S327b-S327b shown in part (b) of FIG. 203. In addition, part (b) of FIG. 204 is a sectional view taken along a line S327d-S327 shown in part (d) of FIG. 203.

As shown in part (b) of FIG. 203 and part (d) of FIG. 203, when the opening/closing opening/closing door 107 is closed, the projection 107a of the opening/closing opening/closing door 107 moves in the direction of arrow A320 in the Figure, so that the claw portion 32050c of the drive side cover 32050 is pushed in the Y2 direction. Then, as shown in part (e) of FIG. 203, while the claw portion 32050c is deformed in the Y2 direction, the inclined projection 32050cl provided on the Y2 direction side is inserted into the third hole portion 32071f of the movable cover 32071. At this time, a surface 32071f1 placed on the Z1 direction side among the surfaces forming the third hole portion 32071f is pressed in the Z1 direction by the inclined surface 32050c2 of the drive side cover 32050. Then, the movable cover 32071 moves in the Z1 direction against the urging force of the tension spring 32077.

As shown in part (a) of FIG. 204 and part (b) of FIG. 204, when the movable cover 32071 moves in the Z1 direction, the first main assembly side coupling 110 is inserted into the first cylindrical portion 32071c of the movable cover 32071. In this state, the rotational center axis of the first main assembly side coupling 110 and the center axis of the first cylindrical portion 32071c are positioned coaxially (axis G). At this time, the end surface. In the Z2 direction. Of the first main assembly side coupling 110 comes into contact with the drive abutment face 32071h of the movable cover 32071. As described above, for the movable cover 32071 to move in the Z1 direction, the Z2 end surface of the first main assembly side coupling 110 is pushed in the Z1 direction, restricting the movement of the first main assembly side coupling 110 in the Z2 direction. In this state, the first main assembly side coupling 110 inserted in the inner surface side of the movable cover 32071 engages with the pump-screw drive receiving portion 32039.

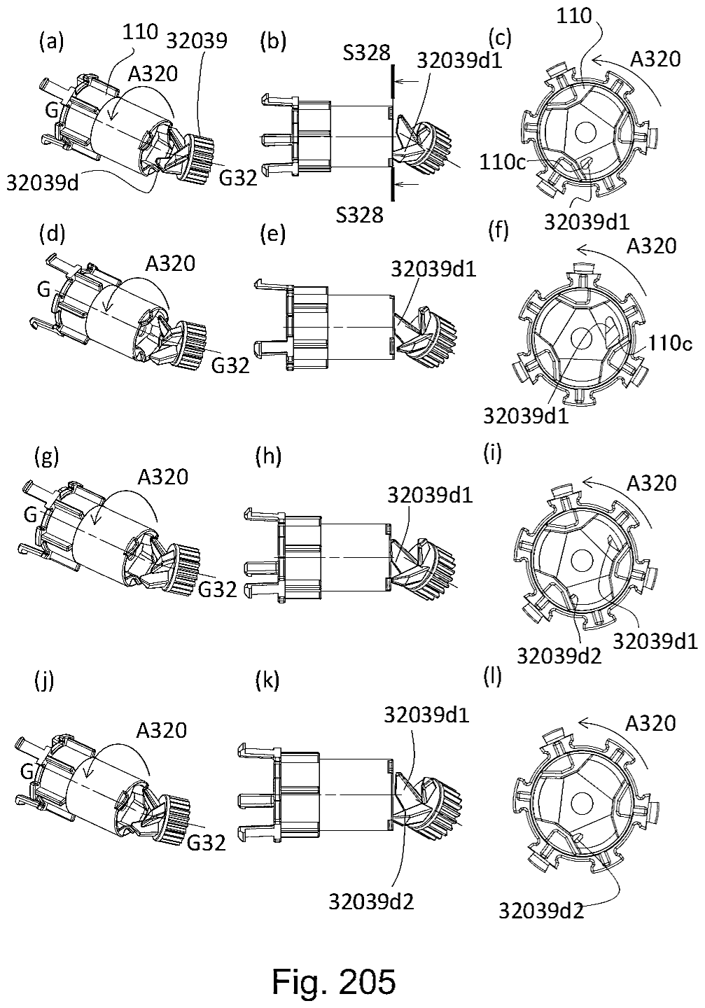

Next, referring to FIG. 205, a method of transmitting a driving force (rotational force) when the first main assembly side coupling 110 and the pump-screw drive receiving portion 32039 are engaged with each other will be described. FIG. 205 is an illustration of an example of the change in the engagement state between the first main assembly side coupling 110 and the pump-screw drive receiving portion 32039 according to Embodiment 32 of the present invention. Part (a) of FIG. 205, part (d) of FIG. 205, part (g) of FIG. 250, and part (j) of FIG. 250 are external perspective views of the first main assembly side coupling 110 and the pump-screw drive receiving portion 32039 in an engaged state, with some components not shown for the sake of better illustration. Part (b) of FIG. 205, part (e) of FIG. 205, part (h) of FIG. 205, and part (k) of FIG. 205 are side views showing the first main assembly side coupling 110 and the pump-screw drive receiving portion 32039 in an engaged state, with some components not shown for the sake of better illustration. Part (c) of FIG. 205, part (f) of FIG. 205, part (i) of FIG. 205, and part (l) of FIG. 205 are sectional views of the states of part (b) of FIG. 205, part (e) of FIG. 205, part (h) of FIG. 205, and part (k) of FIG. 205 taken along a line S328-S328 shown in part (b) of FIG. 205. Part (a) of FIG. 205 to part (c) of FIG. 205 show the state before the first main assembly side coupling 110 and the pump-screw drive receiving portion 32039 are engaged with each other. Parts (d) to (f) of FIG. 205 show a state in which the first main assembly side coupling 110 and one of the engaging projections 32039d of the pump-screw drive receiving portion 32039 are engaged with each other. Parts (g) to (i) of FIG. 205 show a state in which the first main assembly side coupling 110 and the second of the engaging projections 32039d of the pump-screw drive receiving portion 32039 have begun to engage with each other. In addition, parts (j) to (l) of FIG. 205 show a state in which the first main assembly side coupling 110 and the first of the engaging projections 32039d of the pump-screw drive receiving portion 32039 (engaging projection 32039d engaged in part (d) of FIG. 205 to part (f) of FIG. 205) are disengaged. That is, parts (a) to (1) of FIG. 205 show, on time-series basis, the changes in the engagement state between the first main assembly side coupling 110 and the pump-screw drive receiving portion from the open state to the time when the opening and closing opening/closing door 107 of the printer main assembly A in which the toner cartridge C320 is mounted is closed.

As shown in part (a) of FIG. 205 to part (c) of FIG. 205, the pump-screw drive receiving portion 32039 in this embodiment has a total of three engaging projections 32039d. The first engaging projection (first engaging projection) 32039d1 of them enters the cylindrical interior formed on the first main assembly side coupling 110.

Next, as shown in part (d) of FIG. 205 to part (f) of FIG. 205, when the first main assembly side coupling 110 rotates in the direction of arrow A320 in the Figure, the first engagement projection 32039d1 is pressed against the second drive transmitting surface 110c and starts to rotate about the axis G32.

Next, as shown in part (g) of FIG. 205 to part (i) of FIG. 250, as the pump-screw drive receiving portion 32039 rotates, the first engagement projection 32039d1 moves from the inside to the outside of the cylindrical shape of the first main assembly side coupling 110. At this time, the second engagement projection 32039d2 of the engaging projections 32039d enters the cylindrical shape formed on the first main assembly side coupling 110. Therefore, the rotational force is continuously transmitted from the first main assembly side coupling 110 to the pump-screw drive receiving portion 32029 side. Then, as shown in part (j) of FIG. 205 to part (l) of FIG. 250, the engagement between the first engagement projection 32039d1 and the drive transmission surface of the first main assembly side coupling 110 is broken, and the driving force is transmitted by the second engagement projection 32039d2 and the drive transmission surface of the first main assembly side coupling 110. That is, as the pump-screw drive receiving portion 32039 rotates, the drive transmission is performed, while the projection which engages with the main assembly side coupling 110 changes. With the above-described structure, the driving force (rotational force) is transmitted from the first main assembly side coupling 110 to the pump-screw drive receiving portion 32039 side.

Next, the operation of each part when removing the toner cartridge C320 from the printer main assembly A will be described. When the opening/closing opening/closing door 107 of the printer main assembly A with the toner cartridge C320 mounted is opened from a closed state, the shape of the claw portion 32050c of the drive side cover 32050 is restored in the Y1 direction, as shown in part (d) of FIG. 203 to part (b) of FIG. 203. This operation releases the contact between the claw portion 32050c and the surface 32071f1 of the movable cover 32071.

Thereafter, the movable cover 32071 and the pump-screw drive receiving portion 32039 is moved in the Z2 direction by the urging force of the tension spring 32077, so that the engagement between the pump-screw drive receiving portion 32039 and the first main assembly side coupling 110 is broken. In other words, in this state, the one of the engaging projections 32039d of the pump-screw drive receiving portion 32039 and the engaging surfaces of the first main assembly side coupling 110 are separated from each other. In other words, the connection related to drive transmission between the printer main assembly A and the toner cartridge C320 is disestablished.

In the toner cartridge C320 of this embodiment, the structure of the toner accommodating portion screw member 35 is the same as that of the above-described Embodiment 1, and the rotation axis of the screw portion 35a of the toner accommodating portion screw member 35 is substantially parallel to the longitudinal direction of the toner cartridge. In contrast, the rotation axis of the pump-screw drive receiving portion 2039, which is the driving force receiving member for driving the screw portion 35a, intersects with the rotation axis of the screw portion 35a, unlike Embodiment 1 described in the foregoing. Also, with this structure, the toner cartridge C320 of this embodiment, like the toner cartridge C of Embodiment 1 described in the foregoing, is capable of effectively transmitting driving force (rotational force) from the printer main assembly A to the toner cartridge C320.

Although the description is omitted, the stirring drive receiving portion 32038 also has substantially the same structure as the pump-screw drive receiving portion 32039 described above. Therefore, also when the stirring drive receiving portion 32038 is structured to rotate on an axis of rotation which crosses with the axis of rotation of the screw portion 35a (or the longitudinal direction of the toner cartridge C320), it can effectively receive the drive force (rotational force) from the printer main assembly A.

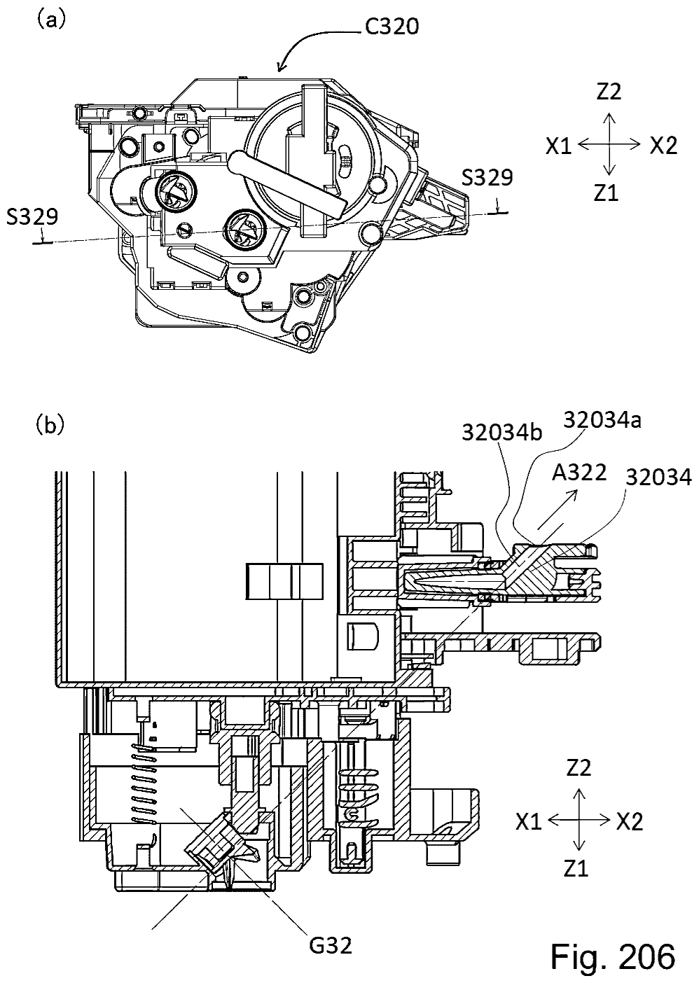

By employing the above-described structure, it is also possible to structure the shutter member so that the toner discharging direction is perpendicular to the rotation axis of the pump-screw drive receiving portion 32039. Referring to FIG. 206, this structure will be specifically described. FIG. 206 is a view illustrating an example of a relationship between the toner discharging direction and the rotation axis of the pump-screw drive receiving portion 32039 in Embodiment 32 of the present invention. Part (a) of FIG. 206 is a side view of the toner cartridge C320 when it is mounted to the process cartridge B. Part (b) of FIG. 206 is a sectional view taken along a line S329-S329 shown in part (a) of FIG. 206.

As shown in part (a) of FIG. 206 and part (b) of FIG. 206, a toner feed passageway 32034b of a shutter member 32034 which is a toner discharge member in this embodiment has a part of the toner feeding direction and discharging direction parallel to the direction of arrow A322 in the Figure. The A322 direction intersects with the Z axis and is perpendicular to the rotation axis G32 of the pump-screw drive receiving member 32039. That is, the toner feeding direction and the toner discharging direction of the toner discharge member and the toner feeding member according to this embodiment are structured to be perpendicular to the rotation axis of the driving force receiving portion of the toner cartridge C320. The structure of the shutter member in this embodiment is not limited to this example, and the shutter member 34 of Embodiment 1 may be applied to the toner cartridge C320 according to this embodiment. In other words, the rotation axis of the pump-screw drive receiving portion 32039 may not be perpendicular to the toner discharging direction and the toner feeding direction, but may be approximately parallel to the Z2 direction, as in Embodiment 1.

In the above-described structure of this embodiment, the movable cover 32071 is moved in interrelation with the opening and closing operation of the opening and closing opening/closing door 107, but the present invention is not limited to such an example. For example, the movable cover 32071 may be structured not to be linked to the opening and closing operation of the opening and closing opening/closing door 107. In this case, the movable cover 32071 may be structured to be manually movable by the user.

In this embodiment, the rotation axis G322 of the stirring drive receiving portion 32038 and the rotation axis G320 of the pump-screw drive receiving portion 32039 are inclined at approximately 45° with respect to the Z axis. However, the structure of the toner cartridge C320 in this embodiment is not limited to this example, and the angles of the rotation axis of the stirring drive receiving portion 32038 and the pump-screw drive receiving portion 32039 relative to the Z axis may be any angle. For example, the angles of the rotation axis of the stirring drive receiving portion 32038 and the pump-screw drive receiving portion 32039 with respect to the Z axis are desirably within 85° in order to receive the drive force from the first main assembly side coupling 110.

### Embodiment 33

In the above-mentioned Embodiment 1, the first driving force receiving portion and the second driving force receiving portion in the toner cartridge C, i.e., the driving/stirring coupling portion 38a and the screw coupling portion 39a, rotate about an axis (axis G) parallel to the Z axis (see FIG. 11). In this embodiment, a toner cartridge C330 has a structure which the first driving force receiving portion and the second driving force receiving portion are movable back and forth in a direction parallel to the Z axis and are capable of receiving driving force from the printer main assembly A. The same structures as those in Embodiments 1 and 32 will be described with the same reference characters and numbers as those in Embodiments 1 and 32. In addition, as for the toner cartridge, the process cartridge, and the printer main assembly, the components having the same functions and roles as those in Embodiments 1 and 32 are given the same names and like reference numerals and symbols.

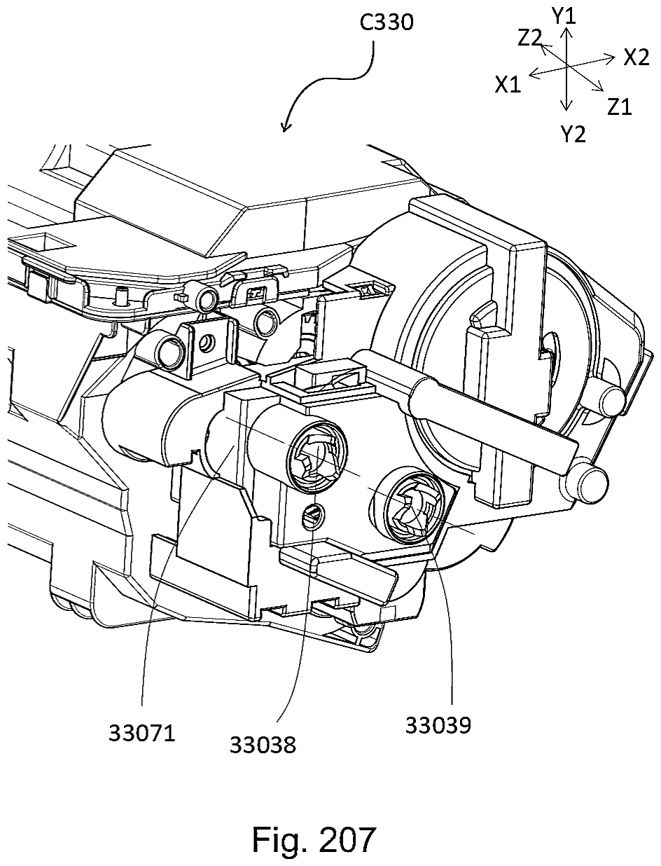

FIG. 207 is a partial external perspective view of a toner cartridge C330 including the drive side, according to Embodiment 3 of the present invention. As shown in FIG. 207, the toner cartridge C330 of this embodiment includes a movable cover 33071, similarly to the toner cartridge C320 of Embodiment 3. In addition, a stirring drive input portion 33038 and a pump-screw drive input portion 33039 are rotatably supported on the movable cover 33071.

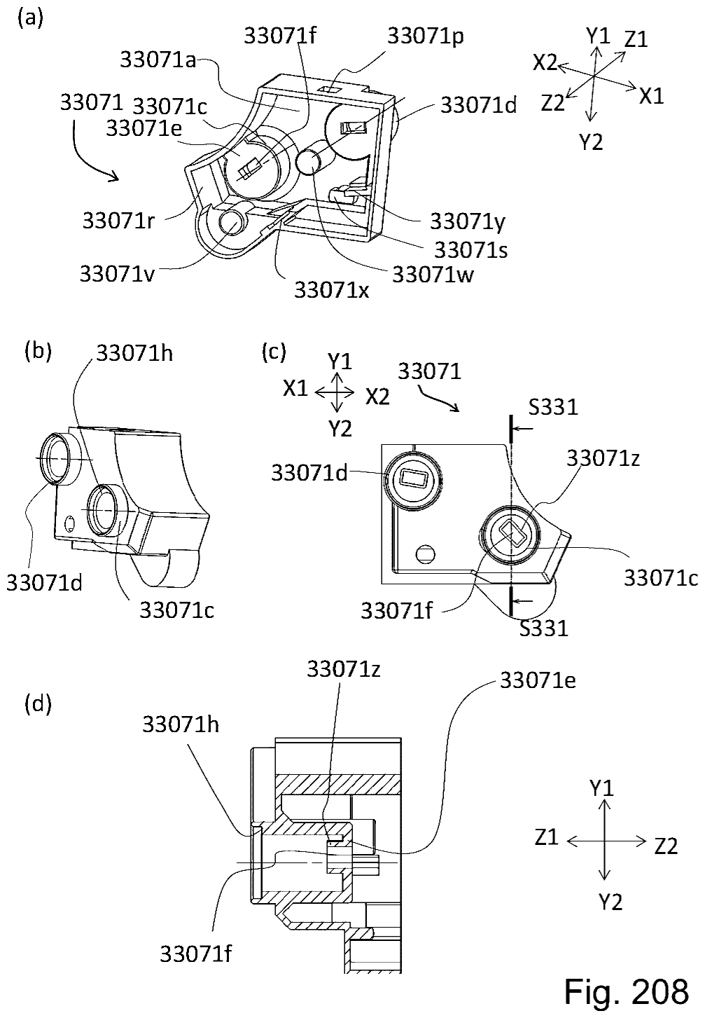

Next, referring to FIG. 208, the shape of the movable cover 33071 in this embodiment will be described. FIG. 208 is an illustration of an example of the movable cover 33071 according to Embodiment 33 of the present invention. Part (a) of FIG. 208 and part (b) of FIG. 208 are external perspective views of the movable cover 33071 as viewed in different directions. In addition, part (c) of FIG. 208 is a side view of the movable cover 33071 as viewed in a direction from the Z1 direction side toward the Z2 direction side. Part (d) of FIG. 208 is a sectional view taken along a line S331-S331 shown in part (c) of FIG. 208. As shown in part (a) of FIG. 208, the movable cover 33071 has substantially the same structure as the movable cover 32071 of the previously described embodiment 32. The movable cover 33071 has multiple surfaces which form the exterior of the device, and each of which has a recessed shape in the Z1 direction, and has a first wall 33071a at its end in the Z1 direction (the recessed end) which is parallel to the XY plane. A second wall portion 33071r is provided extending in the Z2 direction from the outer edge portion of the first wall portion 33071a. A first hole 33071p is provided in the surface of the second wall portion 33071 facing in the Y1 direction. The side wall 33071r is provided with a first mounting surface 33071x and a second mounting surface 33071y as two flat mounting surfaces extending in a direction parallel to the Z-axis.

A spring hook portion 33071s extending in the Z2 direction is provided from a first wall portion 33071a of the movable cover 33071, and similarly, a first cylindrical portion 33071v and a second cylindrical portion 33071w projecting in the Z2 direction are provided. The movable cover 33071 is formed with a first cylindrical portion 33071c and a second cylindrical portion 33071d which extend parallel to the Z-axis direction and penetrate the first wall portion 33071a. The first cylindrical portion 33071c and the second cylindrical portion 33071d have the same shape, the description of the second cylindrical portion 33071d will be omitted. As shown in part (d) of FIG. 208, a support surface 33071e facing in the Z2 direction is formed on the end portion in the Z2 direction of the first cylindrical portion 33071c. As shown in part (c) of FIG. 208 and part (d) of FIG. 208, a second hole portion 33071f having a rectangular hole shape penetrating in the Z-axis direction is provided in the support surface 33071e. A restriction rib 33071z is formed to surround the second hole portion 33071f and is projected in the Z1 direction.

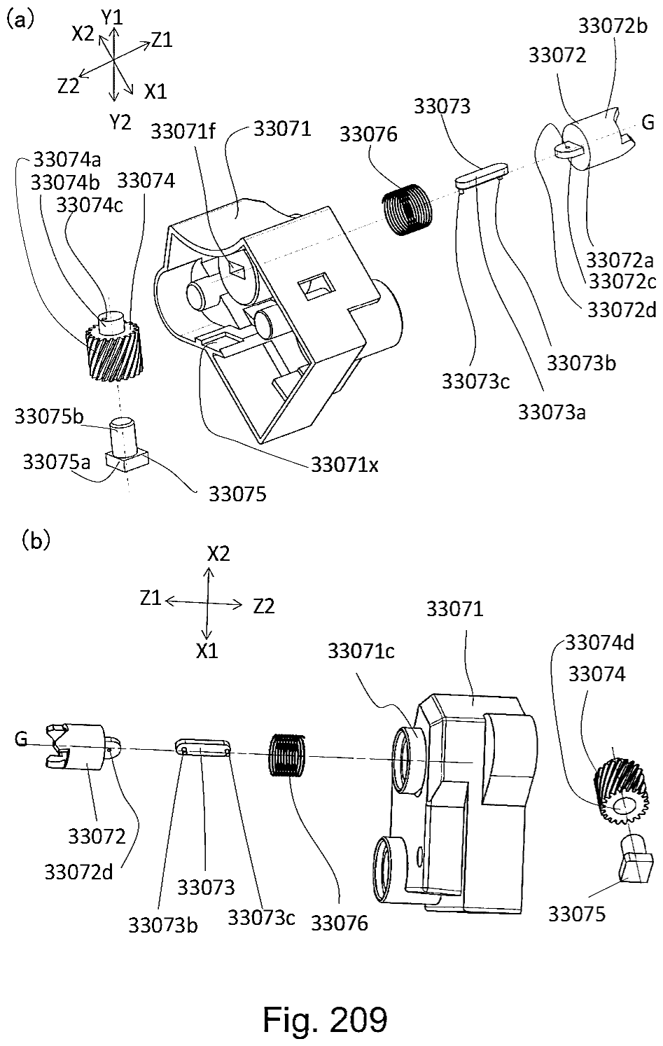

Next, referring to FIG. 209, a method of assembling the related portions to the movable cover 33071 will be described. FIG. 209 is an illustration of a method of mounting each component to the movable cover 33071 in Embodiment 33 of the present invention, wherein part (a) of FIG. 209 and part (b) of FIG. 209 are exploded perspective views of each part based on the movable cover 33071 as viewed in different directions. The stirring drive input portion 33038 and the pump-screw drive input portion 33039 have the same shape and are mounted in the same manner, and therefore, the explanation thereof is omitted. In this embodiment, the advance/retract coupling portion 33072, a link member 33073, and the conversion gear 33074, which will be described hereinafter, are collectively referred to as the pump-screw drive input portion 33039. And, in the detailed description below, each part constituting the pump-screw drive input portion 33039 will be described.

As shown in part (a) of FIG. 209 and part (b) of FIG. 209 to the movable cover 33071, the advance/retract coupling portion 33072, the link member 33073, the compression spring 33076, the conversion gear 33074, and a gear mounting member 33075 are mounted. Coaxially (the axis G) with respect to the movable cover 33071, an advance/retract coupling portion 33072, a link member 33073, and a compression spring 33076 are disposed, in that order from the Z1 direction, outside the movable cover 33071 for the toner cartridge C330. In addition, the conversion gear 33074 and the gear mounting member 33075 are disposed inside the movable cover 33071 for the toner cartridge C330. The method of mounting each part will be described in detail hereinafter.

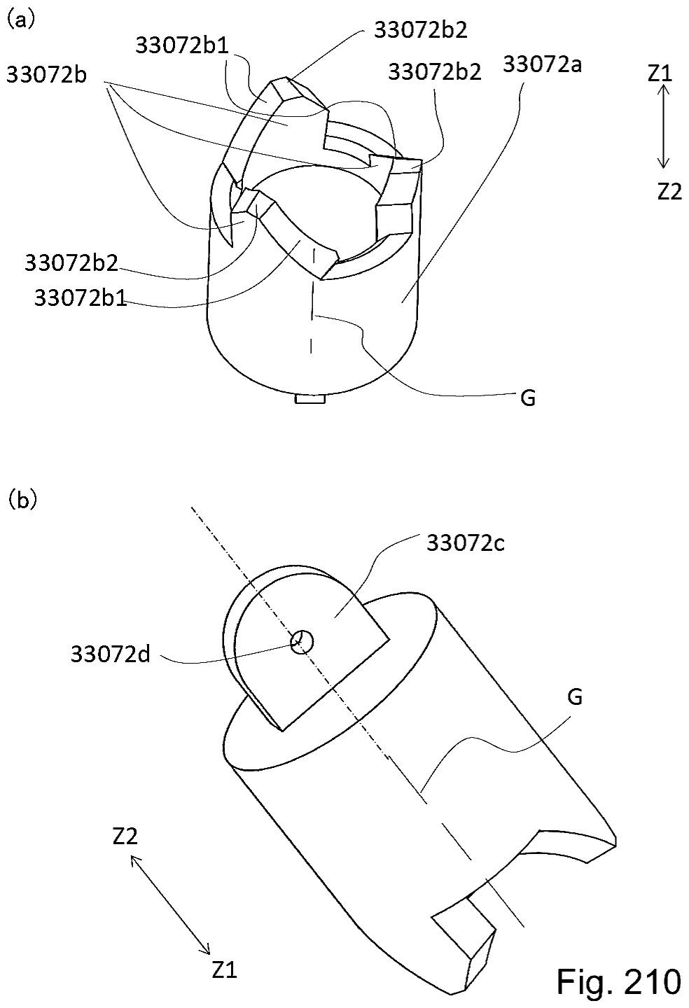

First, referring to FIG. 210, the advance/retract coupling 33072 will be described. FIG. 210 is an external perspective view of the advance/retract coupling portion 33072 according to Embodiment 33 of the present invention, wherein part (a) of FIG. 210 and part (b) of FIG. 210 are perspective views of the advance/retract coupling portion 33072 as viewed in different directions. As shown in part (a) of FIGS. 210 and 210 (b), the advance/retract coupling 33072 has a cylindrical shape with the central axis thereof parallel to the Z axis (when mounted to the toner cartridge C330). The advance/retract coupling portion 33072 includes a third cylindrical portion 33072a and a total of three engagement projections 33072b of the same shape provided at the Z1 direction end of the third cylindrical portion 33072a at 120° intervals with respect to the central axis. In this embodiment, the advance/retract coupling 33072 includes the three engagement projections 33072b, but the number of the engaging projections 33072b may be freely selected, as long as it is possible to engage with the first main assembly side coupling 110 of the printer main assembly A and to transmit the driving force.

The engagement projection 33072b is provided with an inclined surface portion 33072b1. The inclined surface portion 33072b1 is inclined such that the amount of projection in the Z1 direction increases as the advance/retract coupling portion 33072 goes clockwise in the circumferential direction of the advance/retract coupling portion 33072. In addition, an end surface 33072b2 is provided at the end of the engagement projection 33072b in the Z1 direction. Further, a flat-plate like coupling rib 33072c is provided extending in the Z2 direction from the end (end surface) of the third cylindrical portion 33072a in the Z2 direction. A third hole portion 33072d is provided in the center of the coupling rib 33072c, and the third hole portion 33072d is perpendicular to (intersects with) the axis G which is aligned with the central axis of the third cylindrical portion 33072a.

As shown in part (a) of FIG. 209 and part (b) of FIG. 209, the link member 33073 has a flat plate shape extending in a direction parallel to the Z axis. The link member 33073 includes a flat plate portion 33073a, a third cylindrical portion 33073b provided near the end of the flat plate portion 33073a in the Z1 direction, and a fourth cylindrical portion 33073c provided near the end of the flat plate portion 33073a in the Z2 direction. And, the flat plate portion 33073a, the third cylindrical portion 33073b and the fourth cylindrical portion 33073c each project in the same direction on the same surface of the flat plate portion 33073a.

As shown in part (a) of FIG. 209 and part (b) of FIG. 209, the conversion gear 33074 includes a gear portion 33074a, a fifth cylindrical portion 33074b which is coaxial with the gear portion 33074a and projects in the axial direction, and a hole portion 33074c provided in the fifth cylindrical portion. Furthermore, the gear portion 33074a is provided with a support hole portion 33074d at the end opposite to the fifth cylindrical portion 33074b, and the center axis thereof is coaxial with the gear portion 33074a. The gear mounting member 33075 is provided with a base portion 33075a and a sixth cylindrical portion 33075b extending in a direction perpendicular to the base portion 33075a.

The method of mounting each part to the movable cover 33071 will be described in detail below. As shown in part (b) of FIG. 209, a compression spring 33076 is inserted into the first cylindrical portion 33071c of the movable cover 33071 in the Z2 direction. The third cylindrical portion 33073b of the link member 33073 is inserted into the third hole portion 33072d of the advance/retract coupling portion 33072, and the advance/retract coupling portion 33072 is rotatably supported by the link member 33073. In this state, the link member 33073 and the advance/retract coupling 33072 are placed inside the first cylindrical portion 33071c of the movable cover 33071.

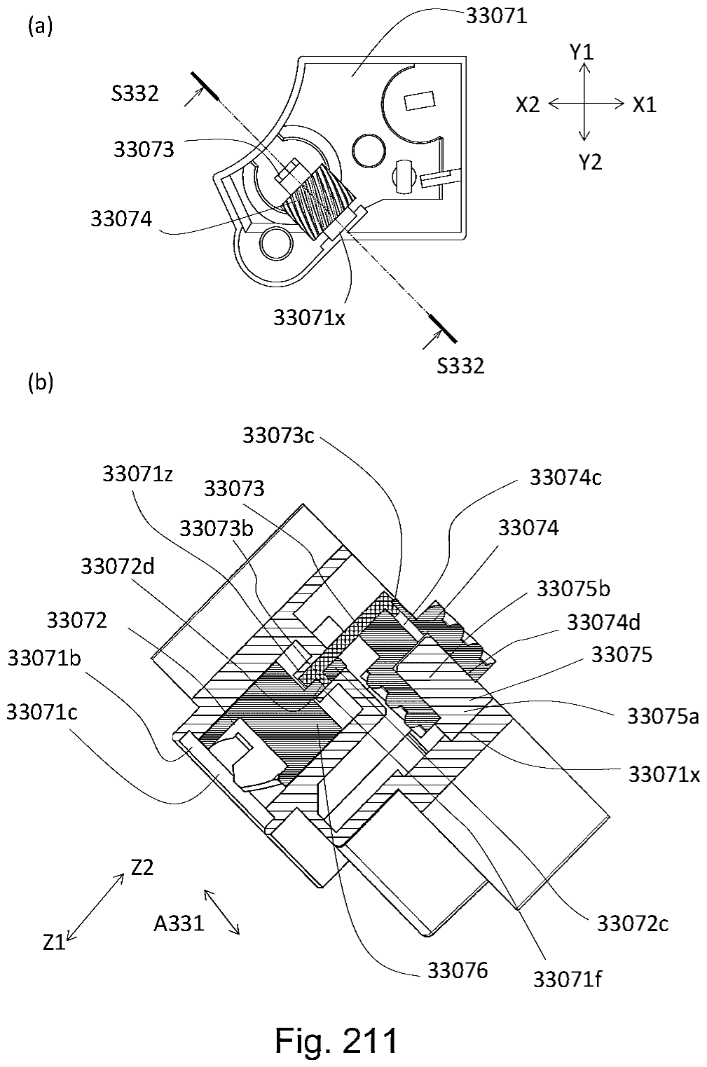

FIG. 211 is an illustration for illustrating an example of the state in which each portion related to the movable cover 33071 according to Embodiment 32 of the present invention is mounted. Of these, part (a) of FIG. 211 is a side view of the movable cover 33071, and part (b) of FIG. 211 is a sectional view taken along a line S322-S322 shown in part (a) of FIG. 211. As shown in part (a) of FIG. 211 and part (b) of FIG. 211, the link member 33073 and the advance/retract coupling 33072 are arranged so as to pass through the second hole portion 33071f provided at the Z2 direction end of the first cylindrical portion 33071c of the movable cover 33071 while being in engagement in the above-mentioned state. In this state, the link member 33073 and the coupling rib 33072c of the advance/retract coupling 33072 are sandwiched between the second hole portion 33071f and the restrictor rib 33071z, so that the movement in the direction of the arrow A301 in the Figure is restricted.

As shown in part (b) of FIG. 211, the fourth cylindrical portion 33073c of the link member 33073 passing through the second hole portion 33071f is rotatably fitted into the fourth hole portion 33074c of the conversion gear 33074. Furthermore, the sixth cylindrical portion 33075b of the gear mounting member 33075 is inserted into the support hole portion 33074d of the conversion gear 33074, whereby the conversion gear 33074 is rotatably supported by the gear mounting member 33075. In this state, the base portion 33075a of the gear mounting member 33075 is fixed to the first mounting surface 33071x of the movable cover 33071 by adhesive or the like, thus completing the mounting of each part to the movable cover 33071.

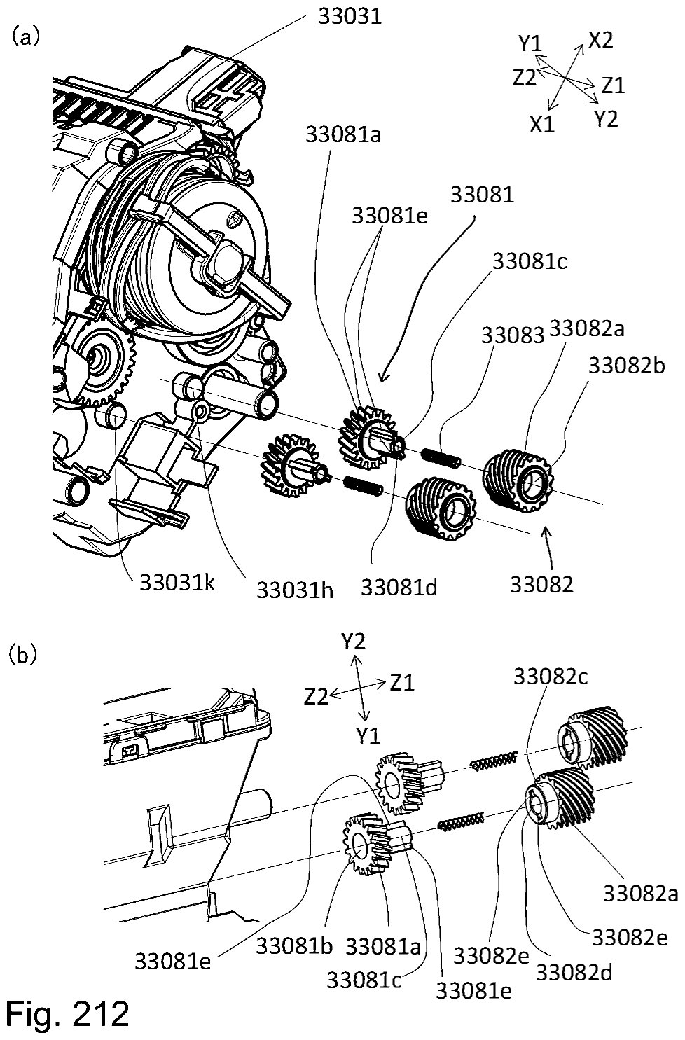

Next, referring to FIG. 212, the attachment of related portions to the accommodation frame 33031 will be described. FIG. 212 is a view illustrating an example of a method of mounting each part for transmitting drive force to the accommodation frame 33031 according to Embodiment 33 of the present invention. Part (a) of FIG. 212 is an exploded perspective view of the toner cartridge C330 as viewed from the drive side (Z1 direction side), and part (b) of FIG. 212 is an exploded perspective view of the drive side of the toner cartridge C330 as viewed from the accommodation frame (33031) side. As shown in part (a) of FIG. 212 and part (b) of FIG. 212, a first idler gear 33081, a spring portion 33083 which is a compression spring, and the second idler gear 33082 are mounted to the accommodation frame 33031, facing in the Z2 direction. Here, the first idler gear 33081, the spring portion 33083, and the second idler gear 33082 are arranged in this order with respect to the accommodation frame 33031.

As shown in part (a) of FIG. 212 and part (b) of FIG. 212, the first idler gear 33081 has a cylindrical shape with its central axis parallel to the Z axis, and has a gear portion 33081a. A circular first support hole portion 33081b is provided at the end portion, in the Z2 direction, of the first idler gear 33081 coaxially with the gear portion 33081a. In addition, on the Z1 direction side of the gear portion 33081a, a fourth cylindrical portion 33081c including a smaller diameter than the gear portion 33081a is provided coaxially with the gear portion 33081a. Further, a circular fifth hole portion 33081d is provided at the end, in the Z1 direction, of the fourth cylindrical portion 33081c. Furthermore, ribs 33081e projecting radially outward from the outer circumferential surface of the fourth cylindrical portion 33081c are provided at each of two locations in total, symmetrically with respect to the axis of the fourth cylindrical portion 33081c.

Next, as shown in part (a) of FIG. 212 and part (b) of FIG. 212, the second idler gear 33082 has a cylindrical shape with its central axis parallel to the Z axis, and has a gear portion 33082a. A second circular support hole portion 33082b is provided at the end portion, in the Z1 direction, of the second idler gear 33082 coaxially with the gear portion 33082a. In addition, a fifth cylindrical portion 33082c having a smaller diameter than the gear portion 33082a is provided coaxially with the gear portion 33082a on the Z2 direction side of the gear portion 33082a. Further, a sixth circular hole portion 33082d is provided at the end, in the Z2 direction, of the fifth cylindrical portion 33082c. Furthermore, grooves 33082e recessed radially outward from the inner surface side of the sixth hole portion 33082d are provided at two positions symmetrically with respect to the axis of the fifth cylindrical portion 33082c.

Next, referring to part (a) of FIG. 212 and part (b) of FIG. 212, a method of assembling each part to the accommodation frame 33031 will be described. In addition, the accommodation frame 33031 according to this embodiment has substantially the same shape as the accommodation frame 31 according to Embodiment 1 described in the foregoing, and therefore, in this embodiment, only the structures which are different from the accommodation frame 31 will be described. As shown in part (a) of FIG. 212, the accommodation frame 33031 is formed with a seventh cylindrical portion 33031h and an eighth cylindrical portion 33031k projecting in the Z1 direction, at two locations. In addition, the seventh cylindrical portion 33031h and the eighth cylindrical portion 33031k have the same shape, and the attachment members and attachment methods to the respective cylindrical portions are the same, and therefore, the description of the eighth cylindrical portion 33031k will be omitted.

As shown in part (a) of FIG. 212 and part (b) of FIG. 212, the first support hole portion 33081b of the first idler gear 33081 is fitted around the seventh cylindrical portion 33031h in the Z2 direction, and the first idler gear 33081 is rotatably supported by the seventh cylindrical portion 33031h. The spring portion 30083 is fitted into the fourth hole portion 33081d of the first idler gear 33081 from the Z2 direction side. In addition, the sixth hole portion 30082d of the second idler gear 30082 is fitted around the fourth cylindrical portion 30081c of the first idler gear 30081 in the Z2 direction. At this time, the rib 30081e and the groove portion 30082e are fitted together, so that the movements of the first idler gear 33081 and the second idler gear 33082 in the rotational direction are restricted relative to each other.

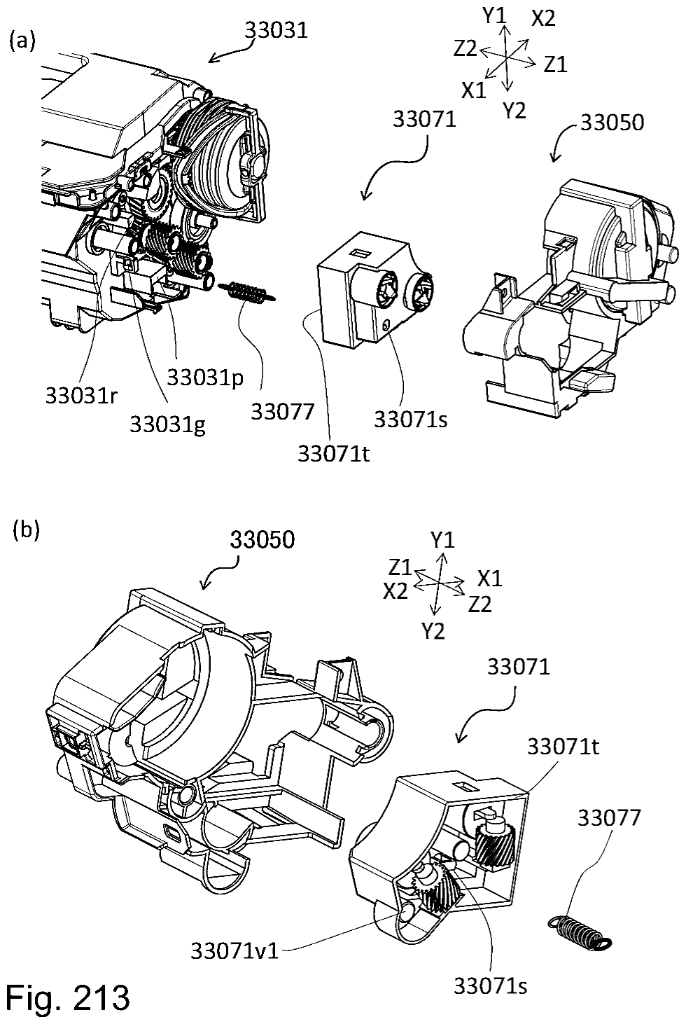

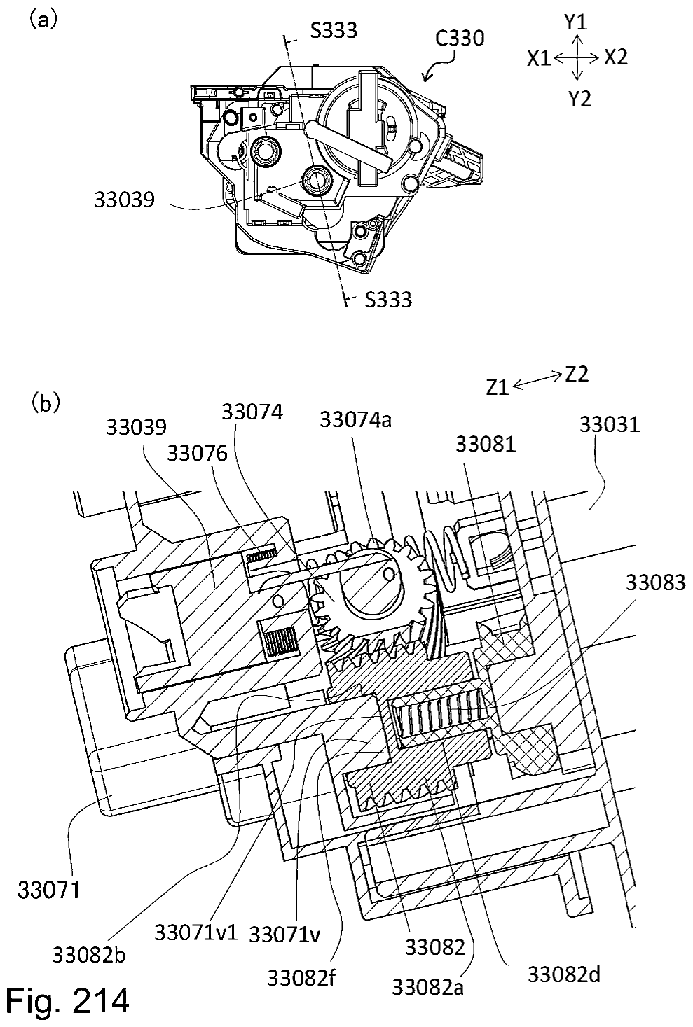

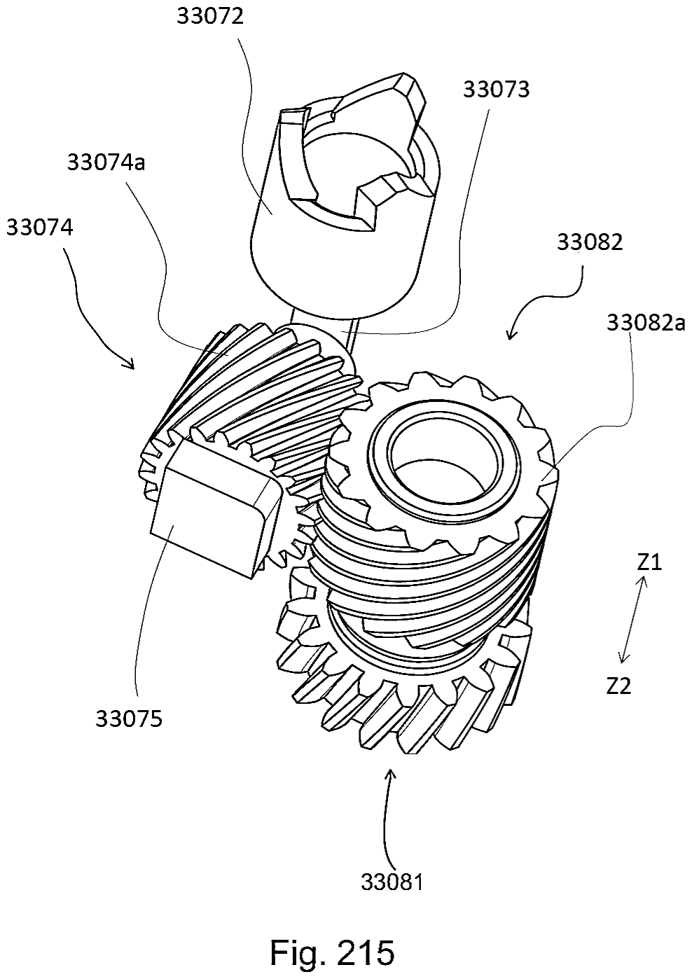

Next, referring to FIGS. 213, 214 and 215, a method for mounting the movable cover 33071 to the accommodation frame 33031 will be described. FIG. 213 is an exploded perspective view of the drive side of the toner cartridge C330 according to Embodiment 33 of the present invention. Part (a) of FIG. 213 shows a state in which the movable cover 33071 and the drive side cover 33050 have been removed from the accommodation frame 33031. Also, part (b) of FIG. 213 is an exploded perspective view of the movable cover 33071 and the drive side cover 33050 as viewed from the toner cartridge C330 side. FIG. 214 is an illustration of an example of a state in which the drive side cover 33050 is mounted to the accommodation frame 33031 according to Embodiment 33 of the present invention. Part (a) of FIG. 214 is a side view illustrating the state in which the drive side cover 33050 is mounted to the accommodation frame 33031, wherein part (b) of FIG. 214 is a cross-sectional view taken along a line S333-S333 shown in part (a) of FIG. 214. FIG. 215 is a perspective view illustrating an engagement state between the conversion gear 33074 and the second idler gear 33082 in Embodiment 33 of the present invention, with some components not shown for the sake of better illustration.

As shown in part (a) of FIG. 213, a movable cover 33071 is disposed on the Z2 direction side of the accommodation frame 33031. As in the above-described embodiment 32, opposite ends of the tension spring 33077 are mounted to a second spring hook portion 33031g of the accommodation frame 33031 and the first spring hook portion 33071s of the movable cover 33071, respectively. An end surface 33071t which is the end surface, in the Z2 direction, of the movable cover 33071 abuts against a first abutment face 33031p which is the abutment face of the accommodation frame 33031 and against a second abutment face 33031r in a direction parallel to the Z axis. In addition, similarly to Embodiment 3, the drive side cover 30050 is fixed to the accommodation frame 33031 with screws or the like. The drive side cover 33050 has substantially the same shape as the drive side cover 32050 of Embodiment 32.

As shown in part (b) of FIG. 214, the first cylindrical portion 33071v of the movable cover 33071 is inserted into a second support hole 33082b of the second idler gear 33082 mounted to the accommodation frame 33031. With this structure, the second idler gear 33082 is rotatably supported by the movable cover 33071. In addition, a surface 33082f, which is the Z2 direction end surface of the hole portion 33082d of the second idler gear 33082, is abutted against a surface 33071v1, which is the Z1 direction end surface of the first cylindrical portion 33071v of the movable cover 33071, in the Z-axis direction, by the urging force of the spring portion 30083. At this time, as shown in FIG. 215, the gear portion 30082a of the second idler gear 33082 engages with the gear portion 33074a of the conversion gear 33074, thereby enabling the transmission of driving force (rotational force). Here, the movable cover 33071 in this embodiment moves in the Z1 direction in response to closing the opening/closing opening/closing door 107 of the printer main assembly A, as in embodiment 32 described above, and the advance/retract coupling portion 33072 transitions to a state (position) in which it can engage with the first main assembly side coupling 110.

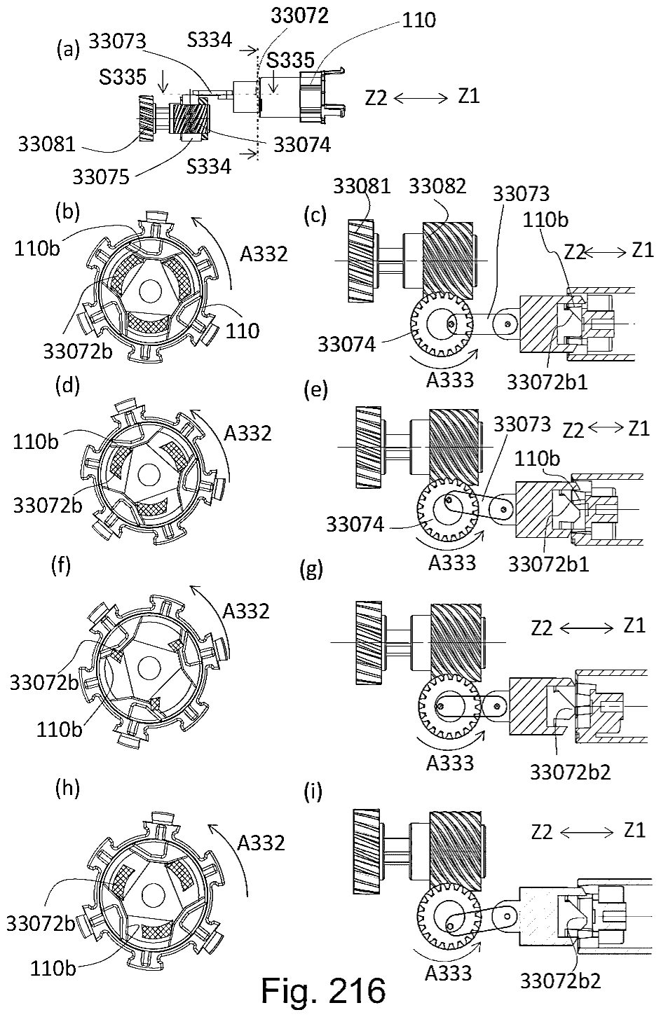

Next, referring to FIG. 216, the description will be made as to a method of engagement between the advance/retract coupling portion 33072 and the first main assembly side coupling 110 and a method of transmitting the drive. FIG. 216 is an illustration of an example of a drive transmission method between the advance/retract coupling portion 33072 and the first main assembly side coupling 110 in Embodiment 33 of the present invention. Part (a) of FIG. 216 is a side view including the advance/retract coupling 33072 and the first main assembly side coupling 110, for illustrating a drive transmission path on the toner cartridge C330 side and a drive transmission path on the printer main assembly A side. Part (b) of FIG. 216, part (d) of FIG. 216, part (f) of FIG. 216, and part (h) of FIG. 216 are cross-sectional views sequentially showing changes over time, taken along a line S334-S334 shown in part (a) of FIG. 216. Part (c) of FIG. 216, part (e) of FIG. 216, part (g) of FIG. 216, and part (i) of FIG. 216 are sectional views sequentially showing changes over time, taken along a line S335-S335 shown in part (a) of FIG. 216. Part (c) of FIG. 216, part (e) of FIG. 216, part (g) of FIG. 216, and part (i) of FIG. 216 are sectional views of only a part, taken along a line S335-S335, of the entire drive transmission path shown in part (a) of FIG. 216, and therefore, the areas other than the S335-S335 section are shown as side views.

As shown in part (b) of FIG. 216 and part (c) of FIG. 216, the engagement projection 33072b of the advance/retract coupling 33072 receives an urging force from the compression spring 33075 and enters an engaging recess recessed in the Z1 direction of the first main assembly side coupling 110. When the first main assembly side coupling 110 rotates from this state in the direction of arrow A332 in the Figure, the engagement projection 33072b abuts against the first drive transmitting surface 110b of the first main assembly side coupling 110, as shown in part (d) of FIG. 216 and part (e) of FIG. 216.

When the first main assembly side coupling 110 rotates further from this state the inclined portion 33072b1 is brought into abutment to the first drive transmitting surface 110b, and the advance/retract coupling portion 33072 moves in the Z2 direction against the urging force of the compression spring 33075. As shown in part (e) of FIG. 216, the advance/retract coupling 33072 and the conversion gear 33074 are connected by a link member 33073, so that the conversion gear 33074 rotates in the direction of arrow A333 shown in the Figure in response to the movement of the advance/retract coupling 33072 in the Z2 direction.

When the first main assembly side coupling 110 is further rotated in the direction of the arrow A332 from this state, the advance/retract coupling 33072 further moves in the Z2 direction against the urging force of the compression spring 33075, as shown in part (f) of FIG. 216 and part (g) of FIG. 216. In this state, the end surface 33072b2 of the advance/retract coupling portion 33072 moves to a position where it abuts against the first main assembly side coupling 110. At this time, in accordance with the movement of the advance/retract coupling 33072, the conversion gear 33074 further rotates in the direction of the arrow A332.

From this state, the first main assembly side coupling 110 further rotates in the direction of the arrow A332. In this case, as shown in part (h) of FIG. 216 and part (i) of FIG. 216, the advance/retract coupling 33072 receives the urging force of the compression spring 33075 to move in the Z1 direction into the above-described engaging recess of the first main assembly side coupling 110. At this time, in accordance with the movement of the advance/retract coupling 33072, the conversion gear 33074 further rotates in the direction of the arrow A303.

From this state, the first main assembly side coupling 110 further rotates in the direction of the arrow A332. In this case, as shown in part (b) of FIG. 216 and part (c) of FIG. 216, the advance/retract coupling 33072 enters again into the above-described engaging recess of the first main assembly side coupling 110 due to the urging force of the compression spring 33075. At this time, in accordance with the movement of the advance/retract coupling 33072, the conversion gear 33074 further rotates in the direction of the arrow A333, thus completing one cycle of the drive transmission operation of the advance/retract coupling portion 33072 and the conversion gear 33074. By repeating the rotation of the advance/retract coupling 33072 and the reciprocating movement in a direction parallel to the Z axis as described above, the conversion gear 33074 can continue to rotate in the direction of the arrow A333 in the Figure.

As described above, the gear portion 33074a of the conversion gear 33074 is engaged with the gear portion 33081a of the first idler gear 33081. Therefore, the driving force (rotational force) received from the printer main assembly A is transmitted to the inside of the toner cartridge C330 by way of the first idler gear 33081 and the second idler gear 33082. This driving force can drive the pump unit 37 and other components provided inside the toner cartridge C330.

When the toner cartridge C330 is removed from the printer main assembly A, the movable cover 33071 moves in the Z2 direction as the opening and closing opening/closing door 107 opens, and the engagement between the first main assembly side coupling 110 and the advancing and retracting coupling portion 33072 is broken. In addition, the movable cover 33071 may not be moved in interrelation with the opening and closing operation of the opening and closing opening/closing door 107. For example, the movable cover 33071 may be structured not to be linked to the opening and closing operation of the opening and closing opening/closing door 107, in which case the movable cover 33071 may be structured to be manually movable by the user.

In the toner cartridge C330 according to this embodiment employing the above-described structure, the advance/retract coupling portion 33072 constituting the pump-screw drive input portion 33039 can be advanced and retracted in a direction parallel to the Z axis. Also with this structure, as with the toner cartridge C described in Embodiment 1 in the foregoing, it is possible to receive the driving force from the printer main assembly A by way of engaging with the first main assembly side coupling 110 on the printer main assembly A as necessary.

In the above-described embodiment, the link member 33073 has a flat plate shape, but the present invention is not limited to such an example. For example, instead of the link member 33073, a multi-stage (multi-joint) link mechanism can be employed, in which case the driving force can be transmitted more smoothly. In addition to the structure of the conversion gear 33074 in this embodiment, it may be structured to have a weight portion which exerts a moment of inertia in the rotational direction, which also enables smoother transmission of driving force.

### Embodiment 34

In the above-described Embodiment 1, the toner cartridge C is mounted to the process cartridge B having been mounted in the printer main assembly A. In contrast, in this embodiment, a structure in which a cartridge unit in which the process cartridge B100 and the toner cartridge C340 are first connected together is mounted in the printer main assembly A will be described. The same components as those in Embodiment 1 will be described with the same reference numerals and symbols as those in Embodiment 1. In addition, as for the toner cartridge, the process cartridge, and the printer main assembly, the components having the same functions and roles as those in Embodiment 1 are assigned the same names and like reference numerals and symbols.

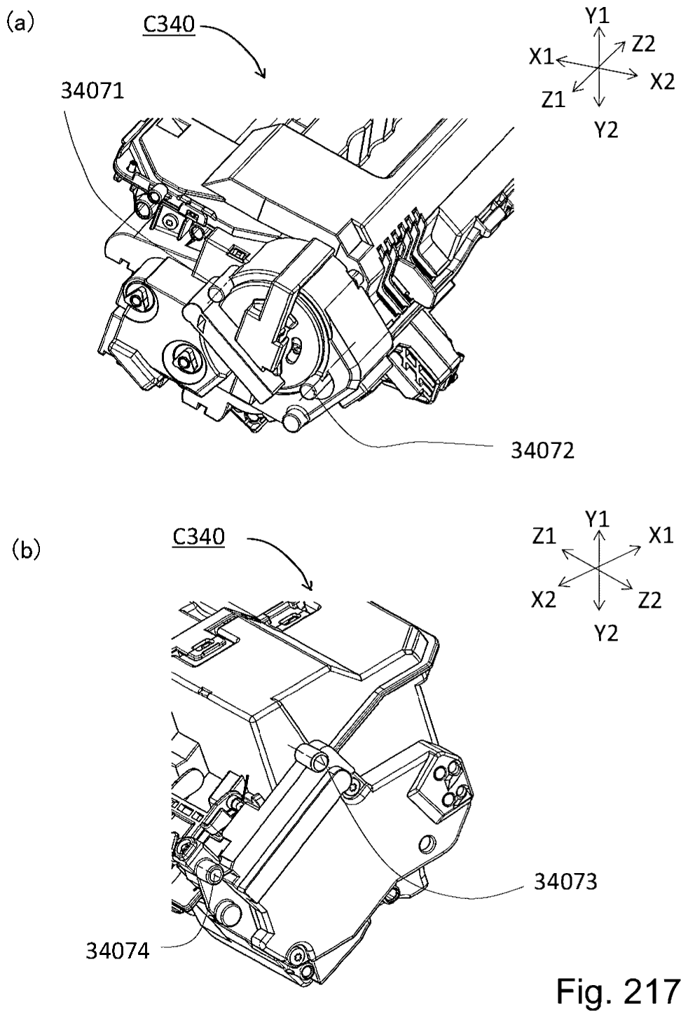

FIG. 217 is a partial external perspective view of a toner cartridge C340 according to Embodiment 34 of the present invention. Part (a) of FIG. 217 is a perspective view including the drive side end of the toner cartridge C340, and part (b) of FIG. 217 is a perspective view including the non-drive side end of the toner cartridge C340. As shown in part (a) of FIG. 217 and part (b) of FIG. 217, the toner cartridge C340 of this embodiment has substantially the same shape as the toner cartridge C of the above-mentioned embodiment 1, and therefore, only the parts different from the toner cartridge C will be described.

As shown in part (a) of FIG. 217, a first cylindrical portion 34071 and a second cylindrical portion 34072 are formed on the Z1 end surface of the toner cartridge C340, projecting in the Z1 direction. As shown in part (b) of FIG. 217, a third cylindrical portion 34073 and a first cylindrical portion 34074 are formed to extend from the Z2 end side surface of the toner cartridge C340 and project in the Z2 direction.

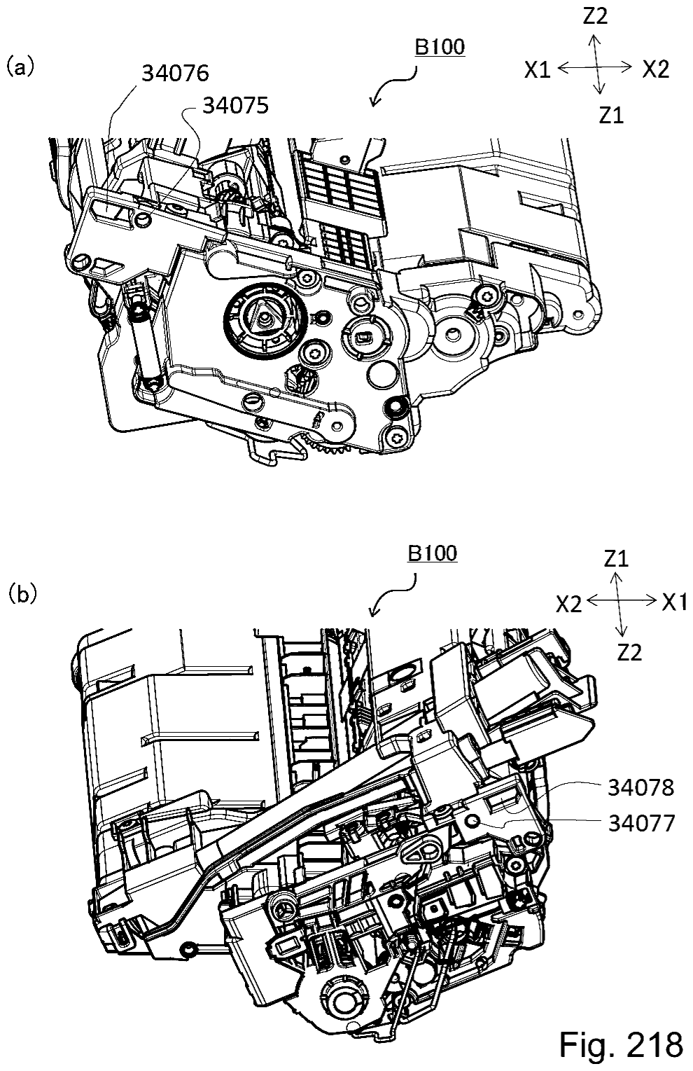

Next, referring to FIG. 218, the process cartridge B100 according to this embodiment will be described. FIG. 218 is a partial external perspective view of the process cartridge B100 according to Embodiment 34 of the present invention. Part (a) of FIG. 218 is a perspective view including the drive side end portion of the process cartridge B100, and part (b) of FIG. 218 is a perspective view including the non-drive side end portion of the process cartridge B100. As shown in part (a) of FIG. 218 and part (b) of FIG. 218, the process cartridge B100 of this embodiment has substantially the same shape as the process cartridge B of the previously described Embodiment 1, and therefore, only the parts different from the process cartridge B will be described.

As shown in part (a) of FIG. 218, a first circular recess 34075 and a first rectangular recess 34076 which are recessed in the Z2 direction are provided on the end surface, in the Z1 direction, of the process cartridge B100. As shown in part (b) of FIG. 218, the end surface, in the Z2 direction, of the process cartridge B100 is provided with a second circular recess 34077 and a second rectangular recess 34078 which are recessed in the Z1 direction.

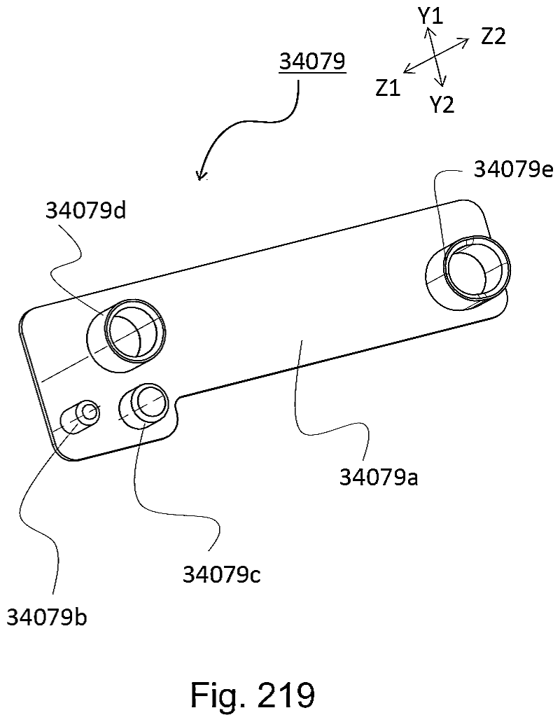

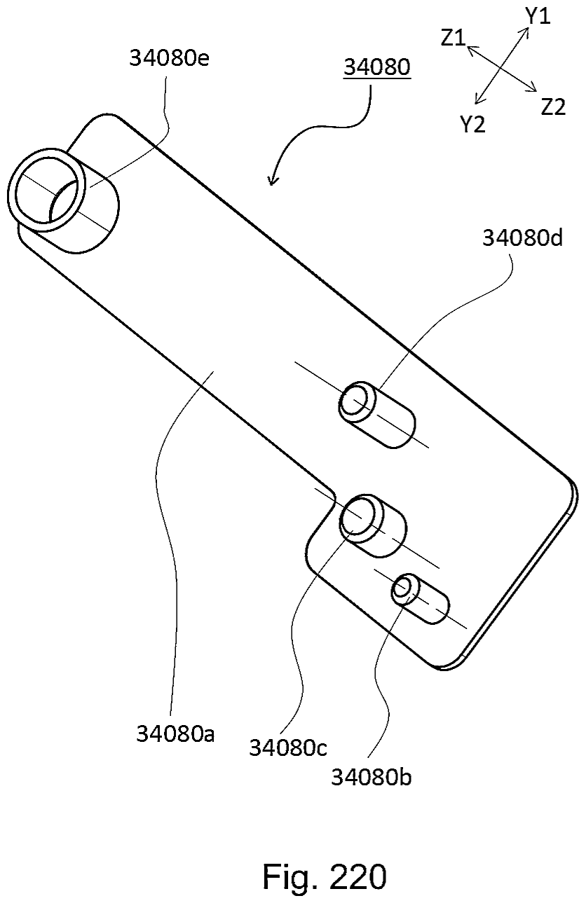

Next, referring to FIGS. 219 and 220, a connecting member for connecting the toner cartridge C340 and the process cartridge B100 together will be described. FIG. 219 is an external perspective view of a first connecting member 34079 in to Embodiment 34 of the present invention. In addition, FIG. 220 is an external perspective view of a second connecting member 34080 in Embodiment 34 of the present invention. As shown in FIG. 219, the first connecting member 34079 has a first plate-like portion 34079a as a flat-plate like base portion. A fourth cylindrical portion 34079b, a fifth cylindrical portion 34079c, a second cylindrical portion 34079d, and a third cylindrical portion 34079e are formed extended from the first plate-like portion 34079a in the Z2 direction. Of these portions, the second cylindrical portion 34079d and the third cylindrical portion 34079e have a hollow shape which penetrates in a direction parallel to the Z axis when mounted on the toner cartridge C340 and/or the process cartridge B100. Here, the structure may be such that each portion extending from first plate-like portion 34079a is formed as a separate member from first plate-like portion 34079a, and the respective portions are connected to each other.

As shown in FIG. 220, the second connecting member 34080 includes a second plate-like portion 34080a as a flat-plate like base portion. A sixth cylindrical portion 34080b, a seventh cylindrical portion 34080c, an eighth cylindrical portion 34080d, and a fourth cylindrical portion 34080e are formed extended in the Z1 direction from the second plate-like portion 34080a. Of these portions, the fourth cylindrical portion 34080e has a hollow shape which penetrates in a direction parallel to the Z axis when the fourth cylindrical portion 34080e is mounted to the toner cartridge C340 and/or the process cartridge B100. Here, the structure may be such that each portion extending from the second plate-like portion 34080a is formed as a separate member from second plate-like portion 34080a, and the respective portions are connected to each other.

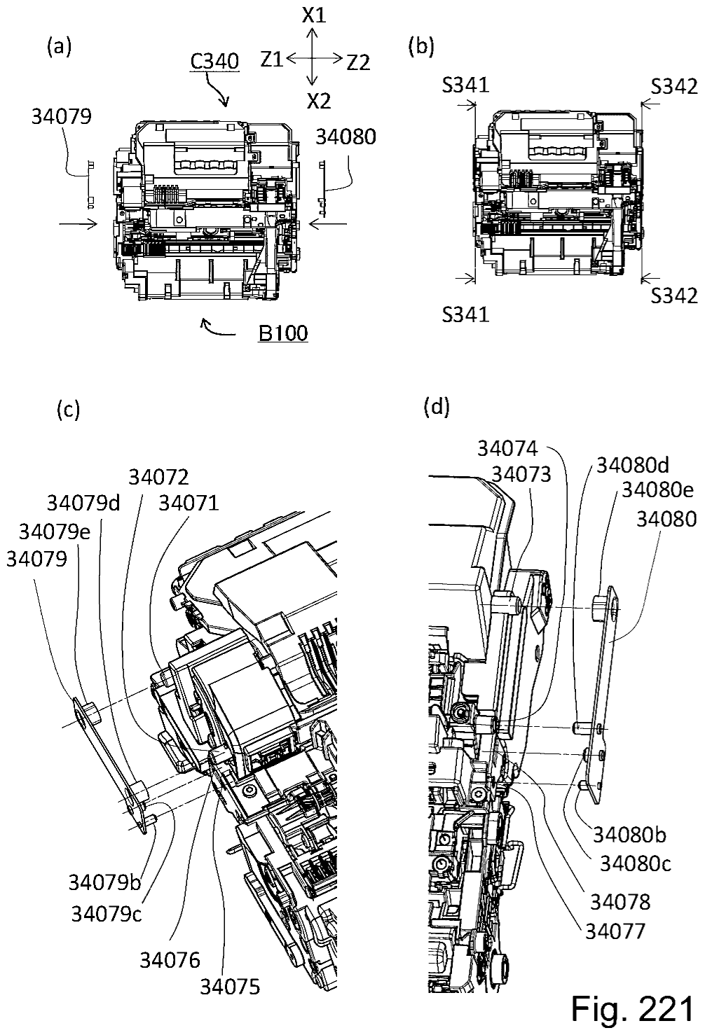

Next, referring to FIG. 221, a method of coupling (connecting) the toner cartridge C340 and the process cartridge B100 with each other will be described. FIG. 221 is an illustration of an example of the state in which the toner cartridge C340 is mounted (connected) to the process cartridge B100 according to Embodiment 34 of the present invention. Part (a) of FIG. 221 is a side view of a unit in which a toner cartridge C340 is mounted on a process cartridge B100, as viewed in the Y1 direction, and for the sake of better illustration, some members are omitted. Part (b) of FIG. 221 is a side view illustrating a state in which the first connecting member 34079 and the second connecting member 34080 are mounted on the process cartridge B100 and the toner cartridge C340 shown in part (a) of FIG. 221. Part (c) of FIG. 221 and part (d) of FIG. 221 are enlarged perspective views of the drive side and non-drive side, respectively, when the toner cartridge C340 is mounted to the process cartridge B100.

As shown in part (a) of FIG. 221, the toner cartridge C340 can be mounted to the process cartridge B100 in the X2 direction. This structure is the same as with Embodiment 1, and the X2 direction is the mounting direction D in Embodiment 1 described in the foregoing. As shown in part (a) of FIG. 221 and part (b) of FIG. 221, in the unit (combined unit) in which the toner cartridge C340 is mounted to the process cartridge B100, the first connecting member 34079 is on the Z1 direction side, and the second connecting member 34080 is on the Z2 direction side. The first connecting member 34079 is mounted to the combined unit described above with its projecting portion facing in the Z2 direction, and the second connecting member 34080 is mounted to the combined unit described above with its projecting portion facing in the Z1 direction.

Also, as shown in part (c) of FIG. 221, the fourth cylindrical portion 34079b and the fifth cylindrical portion 34079c of the first connecting member 34079 are press-fitted into the first circular recess 34075 and the first rectangular recess 34076 formed in the process cartridge B100. Furthermore, the second cylindrical portion 34079d and the third cylindrical portion 34079e of the first connecting member 34079 are press-fitted around the second cylindrical portion 34072 and the first cylindrical portion 34071 formed on the toner cartridge C340, respectively. That is, the circular recesses and the cylindrical portions formed on the process cartridge B100 and the toner cartridge C340 function as connecting portions for connecting the connecting members.

Also, as shown in part (d) of FIG. 221, the sixth cylindrical portion 34080b and the seventh cylindrical portion 34080c of the second connecting member 34080 are press-fitted into the second circular recess 34077 and the second rectangular recess 34078 formed in the process cartridge B100, respectively. Furthermore, the eighth cylindrical portion 34080d and the fourth cylindrical portion 34080e of the second connecting member 34080 are press-fitted around the first cylindrical portion 34074 and the third cylindrical portion 34073 formed on the toner cartridge C340. With the above-described structure, when the toner cartridge C340 and the process cartridge B100 are in a connected (mounted) state, the connected state between the two is maintained (fixed) by using the first connecting member 34079 and the second connecting member 34080.

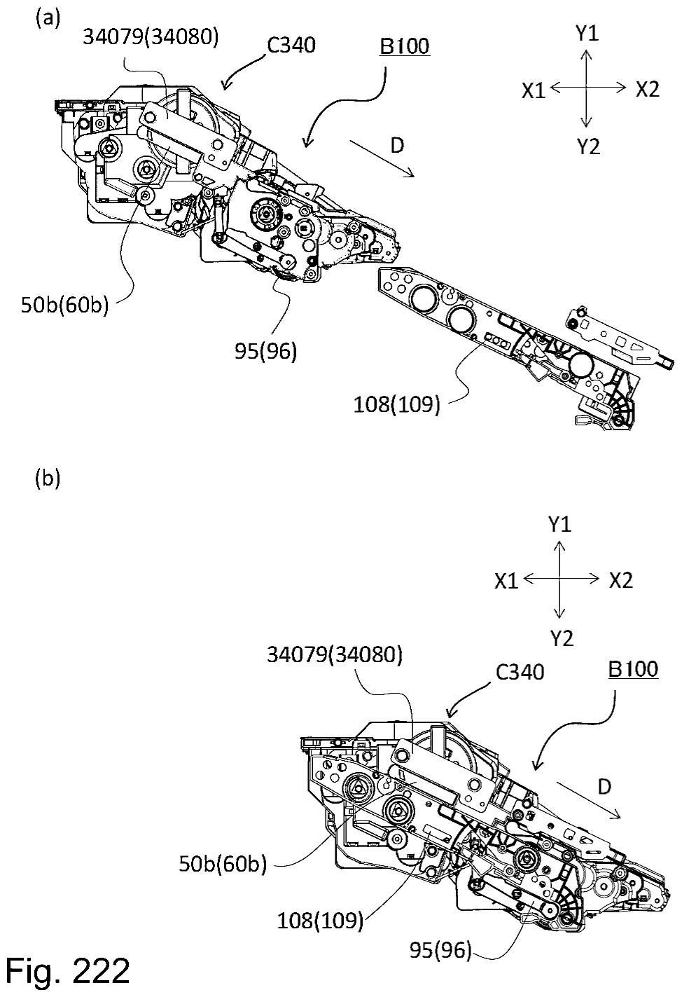

The unit (combined unit) in which the toner cartridge C340 and the process cartridge B100 are fixed together can be mounted in the printer main assembly A in the mounting direction D (X2 direction) in the same manner as in Embodiment 1 described in the foregoing. Referring to FIG. 222, the operation of mounting and dismounting the combined unit to the printer main assembly A will be described. FIG. 222 is an illustration of an example of a method of mounting and dismounting the unit in a state in which the process cartridge B100 and the toner cartridge C340 are connected to each other into the printer main assembly A according to Embodiment 3 of the present invention. Part (a) of FIG. 222 and part (b) of FIG. 222 are partial side views of the unit in which the process cartridge B100 and toner cartridge C340 are connected together and the printer main assembly A as viewed in the Z2 direction, showing the states before and after the mounting, respectively.

The method of mounting the process cartridge B100 and the toner cartridge C340 in this embodiment into the printer main assembly A is the same as in Embodiment 1 described in the foregoing. More specifically, as shown in part (a) of FIG. 222 and part (b) of FIG. 222, the process cartridge B100 is provided with lower bosses 95, 96 as guide members, and the toner cartridge C340 is provided with guided portions 50b, 60b as guide members. As the combined unit is being mounted to the printer main assembly A (moved in direction D), it is guided, while the first guide portion 108 and second guide portion 109 of the printer main assembly A are being sandwiched by the lower bosses 95, 96 and the guided portions 50b, 60b.

As described above, also in a structure in which the process cartridge B100 and toner cartridge C340 in this embodiment are mounted in the printer main assembly A in a combined (connected) state, each unit can be accurately mounted and dismounted, as in the previously described Embodiment 1. In addition, with the process cartridge B100 and toner cartridge C340 according to this embodiment, if a paper jamming occurs inside the printer main assembly A, for example, there is no need to remove the toner cartridge C340 and the process cartridge B100 separately. Further, with the process cartridge B100 and the toner cartridge C340 according to this embodiment, it is possible to prevent the leakage of toner that occurs when the cartridges are separated, for example. In other words, by employing the toner cartridge C340 and the process cartridge B100 according to this embodiment, it is possible to prevent a decrease in the user's operability.

In addition, the functions, the materials, the shapes, the relative arrangements, and so on of the components described in the above-described embodiments are not intended to limit the scope of the present invention to those disclosed in the embodiments, unless otherwise specified. For example, in the above-described Embodiment 1, the shutter member 34 provided on the toner cartridge C is structured to be rotatable about the rotation axis R3, but the present invention is not limited to such an example. For example, if the shutter member 34 has a structure in which the toner feeding direction and discharging direction components include the same directions as those in the above-described embodiment, the shutter member 34 may be non-rotatable. In this case, it will suffice if the opening of the toner discharge opening 34a of the shutter member 34 is provided so as to face the opening of the supply opening 21c provided in the process cartridge B. In this case, at one end (first end) of the axis G, the pump-screw coupling portion 39a engages with the coupling on the printer main assembly (A) side, and the opening of the toner discharge opening 34a faces the other end (second end) opposite thereto.

### <Examples of Structures (or Concepts) Corresponding to the Disclosure of the Embodiments>

The following is examples of structures (or concepts) corresponding to the disclosure of the above-described embodiments.

However, the disclosure of the above-mentioned embodiment is not limited to the following examples, and also discloses structures not stated below.

### <<Structures Aa>>

### [Structure Aa1]

A toner cartridge detachably mountable to an apparatus main assembly of an image forming apparatus to which a developing cartridge is mountable, the toner cartridge being mountable to the apparatus main assembly by being inserted into the apparatus main assembly in a first direction, the toner cartridge comprising:
a frame;
a cartridge side coupling engageable with a main assembly side coupling provided on the apparatus main assembly, wherein the cartridge side coupling engages with the main assembly side coupling to receive a driving force from the apparatus main assembly in a state that the toner cartridge is mounted to the apparatus main assembly with the developing cartridge mounted to the main assembly;
a toner feeding member operable based on the driving force received by the cartridge coupling; and a toner discharge member provided with a discharge opening for discharging toner fed by the toner feeding member to an outside of the toner cartridge,
wherein the cartridge side coupling is rotatable about a first axis intersecting the first direction, and in a state that the toner cartridge is mounted to the developing cartridge, the discharge opening is capable of discharging the toner to the developing cartridge side in a direction parallel to the first axis away from the cartridge side coupling.

### [Structure Aa2]

The toner cartridge according to structure Aa1, wherein the toner discharge member includes a hollow feeding passageway through which the toner passes, between a frame side and the discharge opening.

### [Structure Aa3]

The toner cartridge according to structure Aa2, wherein a direction of the feeding passageway includes at least a component in a direction away from the first axis.

### [Structure Aa4]

The toner cartridge according to structure Aa3, wherein the direction of the feeding passageway includes at least a component in the first direction.

### [Structure Aa5]

The toner cartridge according to structure Aa3 or Aa4, wherein the direction of the feeding passageway includes at least a component in a direction perpendicular to the first axis.

### [Structure Aa6]

A toner cartridge according to any one of structures Aa3 to Aa5, wherein the direction of the feeding passageway includes at least a component in a direction parallel to the first axis.

### [Structure Aa7]

The toner cartridge according to structure Aa2, wherein a central axis of the feeding passageway extends along at least a direction away from the first axis.

### [Structure Aa8]

The toner cartridge according to structure Aa7, wherein the direction parallel to the central axis of the feeding passageway includes at least a component in the first direction.

### [Structure Aa9]

The toner cartridge according to structure Aa7 or Aa8, wherein the direction parallel to the central axis of the feeding passageway includes at least a component in a direction perpendicular to the first axis.

### [Structure Aa10]

The toner cartridge according to any one of structures Aa7 to Aa9, wherein the direction parallel to the central axis of the feeding passageway includes at least a component in a direction parallel to the first axis.

### [Structure Aa11]

The toner cartridge according to structure Aa2, wherein the feeding passageway includes, between the frame and the discharge opening, a first region and a second region, wherein a direction parallel with a central axis of the second region is different from that of the first region.

### [Structure Aa12]

The toner cartridge according to structure Aa11, wherein the second area is provided continuous with the discharge opening of the feeding passageway.

### [Structure Aa13]

The toner cartridge according to structure Aa12, wherein in the first region, the feeding passageway extends along a direction away from the first axis.

### [Structure Aa14]

The toner cartridge according to structure Aa13, wherein the first region extends at least along the first direction.

### [Structure Aa15]

The toner cartridge according to any one of structures Aa13 to Aa14 wherein the first region extends along a direction perpendicular to the first axis.

### [Structure Aa16]

The toner cartridge according to any one of structures Aa13 to Aa15, wherein the second region extends along a direction away from the coupling.

### [Structure Aa17]

The toner cartridge according to structure Aa16, wherein the second region extends in a direction including at least a component parallel to the first axis.

### [Structure Aa18]

The toner cartridge according to any one of structures Aa11 to Aa17, wherein the first region of the toner discharge member is inclined at a predetermined angle with respect to the second region.

### [Structure Aa19]

The toner cartridge according to structure 18, wherein the second region of the toner discharge member is substantially perpendicular to the first region, in the feeding passageway.

### [Structure Aa20]

The toner cartridge according to any one of structures Aa11 to Aa19, wherein a normal direction of the discharge opening with respect to a two-dimensional projection plane perpendicular to the first axis is parallel to a central axis of the feeding passageway corresponding to the second area.

### [Structure Aa21]

The toner cartridge according to any one of structures Aa11 to Aa20, wherein the discharge opening has a cross-sectional area which is smaller than that of the hollow portion of the feeding passageway.

### [Structure Aa22]

The toner cartridge according to structure Aa21, wherein the discharge opening has a wall portion provided in a direction intersecting a central axis of the feeding passageway corresponding also to the second region, and the wall portion provides a cross-sectional area smaller than that of the hollow portion of the feeding passageway.

### [Structure Aa23]

The toner cartridge according to any one of Aa2 to Aa22, wherein the toner discharge member is L-shaped.

### [Structure Aa24]

The toner cartridge according to any one of structures Aa2 to Aa10, wherein the toner discharge member includes a flexible pipe.

### [Structure Aa25]

The toner cartridge according to any one of structures Aa2 to Aa24, wherein the toner is discharged through the discharge opening in a direction substantially parallel to the first axis.

### [Structure Aa26]

The toner cartridge according to any one of structures Aa2Aa25 wherein the toner discharge member rotatable about a second axis intersecting the first axis.

### [Structure Aa27]

The toner cartridge according to structure Aa26, wherein the second axis is perpendicular to the first axis.

### [Structure Aa28]

The toner cartridge according to structure Aa26 or 27, wherein the direction of the feeding passageway includes at least a component in a direction parallel to the first axis and a component in a direction parallel to the second axis.

### [Structure Aa29]

The toner cartridge according to any one of structures Aa26 to Aa28, wherein the direction of the feeding passageway includes at least a component in a second direction parallel to the first axis and facing in a direction away from the coupling.

### [Structure Aa30]

The toner cartridge according to structure Aa29, wherein the direction of the region of the feeding passageway which communicates with the discharge opening includes a component in the second direction.

### [Structure Aa31]

The toner cartridge according to any one of structures Aa26 to Aa30, wherein the first axis is substantially parallel to a rotation axis of the toner feeding member.

### [Structure Aa32]

The toner cartridge according to any one of structures Aa28 to Aa31, wherein the feeding passageway extends in a direction including a component in a direction away from the rotation axis of the toner feeding member in a region extending in a direction including a component in a direction parallel to the second axis.

### [Structure Aa33]

The toner cartridge according to any one of structures Aa2 to 28, wherein the frame is provided with a supply opening for supplying the toner to the toner discharge member, the toner discharge member is provided with a receiving opening for receiving the toner from a frame side, and a direction in which the receiving opening faces is changeable in accordance with movement of the toner discharge member.

### [Structure Aa34]

The toner cartridge according to structure Aa33, wherein the toner discharge member is movable between a first position in which the discharge opening faces in the second direction and a second position in which the discharge opening faces in a third direction different from the second direction, and the discharge opening faces in the second direction when the toner cartridge is mounted to the developing cartridge.

### [Structure Aa35]

The toner cartridge according to structure Aa34, wherein the receiving opening faces the supply opening, when the toner discharge member is placed in the first position.

### [Structure Aa36]

The toner cartridge according to structure Aa34 or Aa35, wherein the receiving opening faces in a direction different from the direction facing the supply opening, when the toner discharge member is placed in the second position.

### [Structure Aa37]

The toner cartridge according to any one of structures Aa34 to Aa36, wherein when the toner discharge member is placed in the second position, in an attitude at the time when the toner cartridge is mounted to the apparatus main assembly, the discharge opening faces in a direction toward a top side of the toner cartridge as the third direction.

### [Structure Aa38]

The toner cartridge according to any one of structures Aa34 to Aa37, wherein when the toner discharge member is placed in the second position, in an attitude at the time when the toner cartridge is mounted to the apparatus main assembly, the discharge opening faces in a direction different from a direction of gravity.

### [Structure Aa39]

The toner cartridge according to structure Aa37 or Aa38, wherein when the toner discharge member is positioned in the first position, in an attitude at the time when the toner cartridge is mounted to the apparatus main assembly, the supply opening is open in a direction of gravity.

### [Structure Aa40]

The toner cartridge according to structure Aa39, wherein when the toner discharge member is placed in the second position in an attitude at the time when the toner cartridge is mounted to the apparatus main assembly, the supply opening is open in a direction different from the direction of gravity.

### [Structure Aa41]

The toner cartridge according to any one of structures Aa33 to Aa40, wherein the toner discharge member is in the first position in a state that the toner cartridge is mounted to the developing cartridge.

### [Structure Aa42]

The toner cartridge according to structure Aa41, wherein the toner discharge member is in the second position when the toner cartridge is removed from the developer cartridge.

### [Structure Aa43]

The toner cartridge according to any one of structures Aa2 to Aa42, further comprising an electrical contact portion exposed to outside of the cartridge, wherein in a direction parallel to the first axis, the electrical contact portion is disposed between the coupling and the discharge opening of the toner feeding member.

### [Structure Aa44]

The toner cartridge according to structure Aa43, wherein the electrical contact portion is above the discharge opening in a vertical direction of the toner cartridge perpendicular to the first axis.

### [Structure Aa45]

The toner cartridge according to structure Aa43 or 44, wherein the electrical contact portion is disposed in a position closer to the coupling than the toner discharge member in a direction parallel to the first axis.

### [Structure Aa46]

The toner cartridge according to any one of structures Aa43 to Aa45, wherein the discharge opening is capable of being oriented away from the electrical contact portion in a direction parallel to the first axis.

### [Structure Aa47]

The toner cartridge according to any one of structures Aa2 to Aa39, wherein the toner discharge member is provided with a projection projecting in a direction away from the first axis, and the toner discharge member is movable by an external force applied to the projection.

### [Structure Aa48]

The toner cartridge according to structure Aa47, wherein the projection is movable by an external force in a direction including a component parallel to the first axis.

### [Structure Aa49]

The toner cartridge according to structure Aa48, wherein the projection is rotatable about an axis perpendicular to the first axis by an external force.

### [Structure Aa50]

The toner cartridge according to any one of structures Aa47 to Aa49, wherein the projection is engageable with a receiving member provided on the developing cartridge in a state that the toner cartridge is mounted to the developing cartridge.

### [Structure Aa51]

The toner cartridge according to structure Aa50, wherein the developing cartridge is provided with an opening for receiving toner from a toner cartridge side, the receiving member is movable between a closed position for closing the opening and an open position for exposing the opening, and when the toner cartridge is mounted to the developing cartridge, the receiving member moves from the closed position to the open position by engaging with the projection.

### [Structure Aa52]

The toner cartridge according to any one of structures Aa2 to Aa50, further comprising a pump unit for feeding the toner, the pump unit being driven based on the driving force received by the coupling.

### [Structure Aa53]

The toner cartridge according to structure Aa52, wherein the discharge opening is provided with a filter through which the toner passes when the pump unit is driven.

### [Structure Aa54]

The toner cartridge according to any one of structures Aa2 to Aa53, wherein the frame is provided with a mounting portion to which a toner container unit is detachably mountable, and the toner feeding member feeds the toner supplied from the toner container unit.

### [Structure Aa55]

The toner cartridge according to any one of structures Aa2 to Aa54, further comprising a waste toner storage portion for storing waste toner, wherein the discharge opening of the toner discharge member is disposed between the coupling and the waste toner storage portion in a direction parallel to the first axis.

### [Structure Aa56]

The toner cartridge according to structure Aa55, wherein the waste toner storage portion includes a waste toner feeding member for feeding the waste toner from the developing cartridge to the toner cartridge, and the waste toner feeding member is driven by a driving force received by a coupling other than the cartridge side coupling.

### [Structure Aa57]

The toner cartridge according to any one of structures Aa2 to Aa56 wherein the discharge opening is formed by removing a manually removable portion.

### [Structure Aa58]

The toner cartridge according to in any one of structures Aa2 to Aa57, wherein the toner discharge member is movable between a retracted position in which a part thereof having the discharge opening is retracted inside the feeding passageway and an operating position in which the part projects out of the feeding passageway.

### [Structure Aa59]

The toner cartridge according to any one of structures Aa1 to 58, further comprising a shutter opening/closing member for opening and closing a shutter covering a laser scanner provided in the apparatus main assembly, wherein the shutter opening/closing member is operable to open the shutter from a closed state, in interrelation with an action of inserting the toner cartridge into the apparatus main assembly, not by way of the developing cartridge.

### [Structure Aa60]

The toner cartridge according to any one of structures Aa1 to Aa59, wherein the toner cartridge is detachably mountable to the apparatus main assembly in a state that the toner cartridge is mounted to the developing cartridge, and the toner cartridge comprising a connecting portion for connecting a connecting member for connecting the developing cartridge to the toner cartridge.

### <<Structures Ab>>

### [Structure Ab1]

A toner cartridge detachably mountable to an apparatus main assembly of an image forming apparatus to which a developing cartridge is mountable, the toner cartridge being mountable to the apparatus main assembly by being inserted into the apparatus main assembly in a first direction, the toner cartridge comprising:
a frame;
a cartridge side coupling engageable with a main assembly side coupling provided on the apparatus main assembly, the main assembly side coupling being rotatable about a first axis intersecting the first direction, wherein the cartridge side coupling engages with the main assembly side coupling to receive a driving force from the apparatus main assembly in a state that the toner cartridge is mounted to the apparatus main assembly with the developing cartridge mounted to the main assembly;
a toner feeding member operable based on the driving force received by the cartridge coupling; and a toner discharge member provided with a discharge opening for discharging toner fed by the toner feeding member to an outside of the toner cartridge,
wherein in a state that the toner cartridge is mounted to the developing cartridge, the discharge opening is capable of discharging the toner to the developing cartridge side in a direction parallel to the first axis away from the cartridge side coupling.

### [Subordinate Structure of Structure Ab1]

The structure of the structure Ab1 may incorporate the structures properly selected from the structures dependent from the structure Aa1 or other structures disclosed in the foregoing embodiments.

### <<Structures Ba>>.

A toner cartridge detachably mountable to an apparatus main assembly of an image forming apparatus to which a developing cartridge is mountable, the toner cartridge being mountable to the apparatus main assembly by being inserted into the apparatus main assembly in a first direction, the toner cartridge comprising:
a frame;
a cartridge side coupling engageable with a main assembly side coupling provided on the apparatus main assembly, wherein the cartridge side coupling engages with the main assembly side coupling to receive a driving force from the apparatus main assembly in a state that the toner cartridge is mounted to the apparatus main assembly with the developing cartridge mounted to the main assembly;
a toner feeding member operable based on the driving force received by the cartridge coupling; and
a toner discharge member provided with a discharge opening for discharging toner fed by the toner feeding member to an outside of the toner cartridge,
wherein the cartridge side coupling is rotatable about a first axis intersecting the first direction, and
wherein in a state that the toner cartridge is mounted to the developing cartridge, and the discharge opening is connected with an opening provided in the developing cartridge, and an orientation of the cartridge side coupling exposed out of the frame is the same as the orientation of the opening of the developing cartridge.

### [Structure Ba2]

The toner cartridge according to structure Ba1, wherein the toner discharge member includes a hollow feeding passageway through which the toner passes, between a frame side and the discharge opening.

### [Structure Ba3]

The toner cartridge according to structure Ba2, wherein a direction of the feeding passageway includes at least a component in a direction away from the first axis.

### [Structure Ba4]

The toner cartridge according to structure Ba3, wherein the direction of the feeding passageway includes at least a component in the first direction.

### [Structure Ba5]

The toner cartridge according to structure Ba3 or Ba4, wherein the direction of the feeding passageway includes at least a component in a direction perpendicular to the first axis.

### [Structure Ba6]

The toner cartridge according to any one of structures Ba3 to Ba5, wherein the direction of the feeding passageway includes at least a component in a direction parallel to the first axis.

### [Structure Ba7]

The toner cartridge according to structure Ba2, wherein the central axis of the feeding passageway extends along at least in a direction away from the first axis.

### [Structure Ba8]

The toner cartridge according to structure Ba7, wherein the direction parallel to the central axis of the feeding passageway includes at least a component in the first direction.

### [Structure Ba9]

The toner cartridge according to structure Ba7 or Ba8, wherein the direction parallel to the central axis of the feeding passageway includes at least a component in a direction perpendicular to the first axis.

### [Structure Ba10]

The toner cartridge according to any one of structures Ba7 to Ba9, wherein the direction parallel to the central axis of the feeding passageway includes at least a component in a direction parallel to the first axis.

### [Structure Ba11]

The toner cartridge according to structure Ba2, wherein the feeding passageway includes, between the frame and the discharge opening, a first region and a second region, wherein a direction parallel with a central axis of the second region is different from that of the first region.

### [Structure Ba12]

The toner cartridge according to structure Ba11, wherein the second area is provided contiguous with the discharge opening of the feeding passageway.

### [Structure Ba13]

The toner cartridge according to structure Ba12, wherein in the first region, the feeding passageway extends along a direction away from the first axis.

### [Structure Ba14]

The toner cartridge according to structure Ba13, wherein the first region extends at least along the first direction.

### [Structure Ba15]

The toner cartridge according to any one of structures Ba13 to Ba15, wherein the first region extends along a direction perpendicular to the first axis.

### [Structure Ba16]

The toner cartridge according to any one of structures Ba12 to Ba15, wherein the second region extends along a direction away from the coupling.

### [Structure Ba17]

The cartridge according to structure Ba16, wherein the second region extends in a direction including at least a component parallel to the first axis.

### [Structure Ba18]

The toner cartridge according to any one of structures Ba11 to 17, wherein the first region of the toner discharge member is inclined at a predetermined angle with respect to the second region.

### [Structure Ba19]

The toner cartridge according to structure Ba18, wherein the second region of the toner discharge member is substantially perpendicular to the first region, in the feeding passageway.

### [Structure Ba20]

The toner cartridge according to any one of structures Ba11 to Ba19, wherein a normal direction of the discharge opening with respect to a two-dimensional projection plane perpendicular to the first axis is parallel to a central axis of the feeding passageway corresponding to the second area.

### [Structure Ba21]

The toner cartridge according to any one of structures Ba11 to Ba20, wherein the discharge opening has a cross-sectional area which is smaller than that of the hollow portion of the feeding passageway.

### [Structure Ba22]

The toner cartridge according to structure Ba21, wherein the discharge opening has a wall portion provided in a direction intersecting a central axis of the feeding passageway corresponding also to the second region, and the wall portion provides a cross-sectional area smaller than that of the hollow portion of the feeding passageway.

### [Structure Ba23]

The toner cartridge according to any one of structures Ba2 to 22, wherein the toner discharge member is L-shaped.

### [Structure Ba24]

The toner cartridge according to any one of structures Ba2 to Ba10, wherein the toner discharge member includes a flexible pipe.

### [Structure Ba25]

The toner cartridge according to any one of structures Ba2 to Ba24, wherein the toner is discharged through the discharge opening in a direction substantially parallel to the first axis.

### [Structure Ba26]

The toner cartridge according to any one of structures Ba2 to Ba25, wherein the toner discharge member rotates about a second axis intersecting the first axis.

### [Structure Ba27]

The toner cartridge according to structure Ba26, wherein the second axis is perpendicular to the first axis.

### [Structure Ba28]

The toner cartridge according to structure Ba26 or Ba27, wherein the direction of the feeding passageway includes at least a component in a direction parallel to the first axis and a component in a direction parallel to the second axis.

### [Structure Ba29]

The toner cartridge according to any one of structures Ba26 to 28, wherein the direction of the feeding passageway includes at least a component in a second direction parallel to the first axis and facing in a direction away from to the coupling.

### [Structure Ba30]

The toner cartridge according to structure Ba29, wherein the direction of the region of the feeding passageway which communicates with the discharge opening includes a component in the second direction.

### [Structure Ba31]

The toner cartridge according to any one of structures Ba84 to Ba88, wherein the first axis is substantially parallel to a rotation axis of the toner feeding member.

### [Structure Ba32]

The toner cartridge according to any one of structures Ba28 to Ba31, wherein the feeding passageway extends in a direction including a component in a direction away from the rotation axis of the toner feeding member in a region extending in a direction including a component in a direction parallel to the second axis.

### [Structure Ba33]

The toner cartridge according to structure Ba28 or Ba32, wherein the frame is provided with a supply opening for supplying the toner to the toner discharge member, the toner discharge member is provided with a receiving opening for receiving the toner from a frame side, and a direction in which the receiving opening faces is changeable in accordance with movement of the toner discharge member.

### [Structure Ba34]

The toner cartridge according to structure Ba33, wherein the toner discharge member is movable between a first position in which the discharge opening faces in the first direction and a second position in which the discharge opening faces in the second direction different from the first direction.

### [Structure Ba35]

The toner cartridge according to structure Ba34, wherein the receiving opening faces the supply opening when the toner discharge member is placed in the first position.

### [Structure Ba36]

The toner cartridge according to structure Ba34 or Ba35, wherein the receiving opening faces in a direction different from the direction facing the supply opening, when the toner discharge member is placed in the second position.

### [Structure Ba37]

The toner cartridge according to any one of structures Ba34 to Ba36, wherein when the toner discharge member is placed in the second position, in an attitude at the time when the toner cartridge is mounted to the apparatus main assembly, the discharge opening faces upward.

### [Structure Ba38]

The toner cartridge according to any one of structures Ba34 to Ba37, wherein when the toner discharge member is placed in the second position, in an attitude at the time when the toner cartridge is mounted to the apparatus main assembly, the discharge opening faces in a direction different from a direction of gravity.

### [Structure Ba39]

The toner cartridge according to structure Ba37 or Ba38, wherein when the toner discharge member is positioned in the first position, in an attitude at the time when the toner cartridge is mounted to the apparatus main assembly, the supply opening is open in a direction of gravity.

### [Structure Ba40]

The toner cartridge according to structure Ba39, wherein when the toner discharge member is placed in the second position in an attitude at the time when the toner cartridge is mounted to the apparatus main assembly, the supply opening is open in a direction different from the direction of gravity.

### [Structure Ba41]

The toner cartridge according to any one of structures Ba32 to Ba40, wherein the toner discharge member is in the first position in a state that the toner cartridge is mounted to the developing cartridge.

### [Structure Ba42]

The toner cartridge according to structure Ba41, wherein the toner discharge member is in the second position when the toner cartridge is removed from the developer cartridge.

### [Structure Ba43]

The toner cartridge according to any one of structures Ba2 to Ba42, further comprising an electrical contact portion exposed to outside of the cartridge, wherein in a direction parallel to the first axis, the electrical contact portion is disposed between the coupling and the discharge opening of the toner feeding member.

### [Structure Ba44]

The toner cartridge according to structure Ba43, wherein the electrical contact portion is above the discharge opening in a vertical direction of the toner cartridge perpendicular to the first axis.

### [Structure Ba45]

The toner cartridge according to structure Ba43 or Ba44, wherein the electrical contact portion is disposed in a position closer to the coupling than the toner discharge member in a direction parallel to the first axis.

### [Structure Ba46]

The toner cartridge according to any one of structures Ba43 to 45, the discharging opening is capable of being oriented away from the electrical contact portion in a direction parallel to the first axis.

### [Structure Ba47]

The toner cartridge according to any one of structures Ba2 to Ba46, wherein the toner discharge member is provided with a projection projecting in a direction away from the first axis, and the toner discharge member is movable by an external force applied to the projection.

### [Structure Ba48]

The toner cartridge according to structure Ba47, wherein the projection is movable by an external force in a direction including a component parallel to the first axis.

### [Structure Ba49]

The toner cartridge according to structure Ba48, wherein the projection is rotatable about an axis perpendicular to the first axis by an external force.

### [Structure Ba50]

The toner cartridge according to any one of structures Ba47 to Ba49, wherein the projection is engageable with a receiving member provided on the developing cartridge in a state that the toner cartridge is mounted to the developing cartridge.

### [Structure Ba51]

The toner cartridge according to structure Ba50, wherein the developing cartridge is provided with an opening for receiving the toner from a toner cartridge side, the receiving member is movable between a closed position for closing the opening and an open position for exposing the opening, and when the toner cartridge is mounted to the developing cartridge, the receiving member moves from the closed position to the open position by engaging with the projection.

### [Structure Ba52]

The toner cartridge according to any one of structures Ba2 to Ba51, further comprising a pump unit for feeding the toner, the pump unit being driven based on the driving force received by the coupling.

### [Structure Ba53]

The toner cartridge according to structure Ba52, wherein the discharge opening is provided with a filter through which toner passes when the pump unit is driven.

### [Structure Ba54]

The toner cartridge according to any one of structures Ba2 to Ba53, wherein the frame is provided with a mounting portion to which a toner container unit is detachably mountable, and the toner feeding member feeds the toner supplied from the toner container unit.

### [Structure Ba55]

The toner cartridge according to any one of structures Ba2 to Ba54, further comprising a waste toner storage portion for storing waste toner, wherein the discharge opening of the toner discharge member is disposed between the coupling and the waste toner storage portion in a direction parallel to the first axis.

### [Structure Ba56]

The toner cartridge according to structure Ba55, wherein the waste toner storage portion includes a waste toner feeding member for feeding the waste toner from the developing cartridge to the toner cartridge, and the waste toner feeding member is driven by a driving force received by a coupling other than the cartridge side coupling.

### [Structure Ba57]

The toner cartridge according to any one of structures Ba2 to Ba56, wherein the discharge opening is formed by removing a manually removable portion.

### [Structure Ba58]

The toner cartridge according to any one of structures Ba2 to Ba57, wherein the toner discharge member is movable between a retracted position in which a part thereof having the discharge opening is retracted inside the feeding passageway and an operating position in which the part projects out of the feeding passageway.

### [Structure Ba59]

The toner cartridge according to any one of structures Ba1 to Ba58, further comprising a shutter opening/closing member for opening and closing a shutter covering a laser scanner provided in the apparatus main assembly, wherein the shutter opening/closing member is operable to open the shutter from a closed state, in interrelation with an action of inserting the toner cartridge into the apparatus main assembly, not by way of the developing cartridge.

### [Structure Ba60]

The toner cartridge according to any one of structures Ba1 to 59, wherein the first axis is substantially parallel to a longitudinal direction of the toner cartridge, and the frame has a first surface on which the toner discharge member is provided, and a second surface which is substantially perpendicular to the longitudinal direction and on which the cartridge side coupling is exposed.

### [Structure Ba61]

The toner cartridge according to structure Ba60, wherein the cartridge side coupling is provided with an engaging portion projecting in the longitudinal direction, and the direction in which the engaging portion projects is substantially perpendicular to the first direction.

### [Structure Ba62]

The toner cartridge according to any one of structures Ba1 to Ba61, wherein the discharge opening faces a direction different from a direction of the cartridge side coupling exposed out of the frame from start of mounting the toner cartridge to the developing cartridge to completion of the mounting.

### [Structure Ba63]

The toner cartridge according to structure Ba61, wherein when viewed along the direction of a rotation axis of the developing member, a tangent to the surface of the developing member at an intersection point which is more remote from the rotation center of the coupling member among intersection points between a straight line connecting the rotation center of the coupling member and the rotation center of the developing member and the surface of the developing member is defined as another predetermined tangent;, and when an area is divided by said another predetermined tangent as a boundary, the area in which the rotation center of the coupling member is not provided is defined as another predetermined area;.

Wherein the contact force receiving portion is disposed in said another predetermined area, as viewed along the direction of the rotation axis of the developing member when the second unit is in the separated position.

### [Structure Ba64]

The toner cartridge according to any one of structures Ba1 to Ba63, wherein the toner cartridge is detachably mountable to the apparatus main assembly in a state where the toner cartridge is mounted to the developing cartridge, the toner cartridge comprising a connecting portion for connecting a joining member for joining the developing cartridge to the toner cartridge.

### <<Structures Bb>>

### [Structure Bb1]

A toner cartridge detachably mountable to an apparatus main assembly of an image forming apparatus to which a developing cartridge is mountable, the toner cartridge being mountable to the apparatus main assembly by being inserted into the apparatus main assembly in a first direction, the toner cartridge comprising:
a frame;
a cartridge side coupling engageable with a main assembly side coupling provided on the apparatus main assembly, the main assembly side coupling being rotatable about a first axis intersecting the first direction, wherein the cartridge side coupling engages with the main assembly side coupling to receive a driving force from the apparatus main assembly in a state that the toner cartridge is mounted to the apparatus main assembly with the developing cartridge mounted to the main assembly;
a toner feeding member operable based on the driving force received by the cartridge coupling; and
a toner discharge member provided with a discharge opening for discharging toner fed by the toner feeding member to an outside of the toner cartridge,
wherein in a state that the toner cartridge is mounted to the developing cartridge, and the discharge opening is connected with an opening provided in the developing cartridge, and an orientation of the cartridge side coupling exposed out of the frame is the same as the orientation of the opening of the developing cartridge.

### [Subordinate Structure of Structure Bb1]

The structure of the structure Bb1 may incorporate the structures properly selected from the structures dependent from the structure Ba1 or other structures disclosed in the foregoing embodiments.

### <<Structures Ca>>

### [Structure Ca1]

An image forming apparatus to which the toner cartridge according to any one of structures Aa1 to Aa59, Ab1, Ba1 to Ba63, and Bb1 is detachably mountable.

### [Subordinate Structure of Structure Ca1]

The structure of the structure Ca1 may incorporate the structures properly selected from the structures dependent from the structure Aa1, Ab1, Ba1, or Bb1 or other structures disclosed in the foregoing embodiments.

### <<Structures Da>>

### [Structure Da1]

A developing cartridge to which a toner cartridge according to any one of structures a1 to Aa59, Ab1, Ba1 to Ba63, and Bb1 is detachably mountable, the developing cartridge provided with an opening facing the discharge opening of the toner cartridge when the toner cartridge is mounted to the developing cartridge; and a developing unit carrying the toner supplied through the opening.

### [Subordinate Structure of Structure Da1]

The structure of the structure Da1 may incorporate the structures properly selected from the structures dependent from the structure Aa1, Ab1, Ba1, or Bb1 or other structures disclosed in the foregoing embodiments.

### <<Structures Ea>>

### [Structure Ea1]

A cartridge comprising: a frame;
a coupling rotatable about a first axis;
a toner feeding member which is operable based on a driving force received by the coupling; and
a toner discharge member provided with a discharge opening through which the toner fed by the toner feeding member is discharged to outside of the toner cartridge,
wherein the toner discharge member is movable relative to the frame so as to change orientation of the discharge opening, and the discharge opening is capable of facing in a first direction away from the coupling in a direction parallel to the first axis.

### [Structure Ea2].

The cartridge according to structure Ea1, wherein the toner discharge member includes a hollow feeding passageway through which the toner passes, between a frame side and the discharge opening.

### [Structure Ea3]

The cartridge according to structure Ea2, wherein a direction of the feeding passageway includes at least a component in a direction away from the first axis.

### [Structure Ea4]

The cartridge according to structure Ea3, wherein the direction of the feeding passageway includes at least a component in a direction perpendicular to the first axis.

### [Structure Ea5]

The cartridge according to structure Ea3 or Ea4, wherein the direction of the feeding passageway includes at least a component in a direction parallel to the first axis.

### [Structure Ea6]

The cartridge according to structure Ea2, wherein the feeding passageway extends along at least a direction away from the first axis.

### [Structure Ea7]

The cartridge according to structure Ea6, wherein the direction parallel to the central axis of the feeding passageway includes at least a component in a direction perpendicular to the first axis.

### [Structure Ea8]

The cartridge according to structure Ea6 or Ea7, wherein the direction parallel to the central axis of the feeding passageway includes at least a component in a direction parallel to the first axis.

### [Structure Ea9]

The cartridge according to structure Ea2, wherein the feeding passageway includes, between the frame and the discharge port, a first region and a second region which has a central axis different from that of the first region.

### [Structure Ea10]

The cartridge according to structure Ea9, wherein the second area is provided continuous with the discharge opening of the feeding passageway.

### [Structure Ea11]

The cartridge according to structure Ea10, wherein in the first region, the feeding passageway extends along a direction away from the first axis.

### [Structure Ea12]

The cartridge according to structure Ea11, wherein the first region extends along a direction perpendicular to the first axis.

### [Structure Ea13]

The cartridge according to any one of structures Ea10 to Ea12, wherein the second region extends along a direction away from the coupling.

### [Structure Ea14]

The cartridge according to structure Ea13, wherein the second region extends in a direction including at least a component parallel to the first axis.

### [Structure Ea15]

The cartridge according to any one of structures Ea12 to Ea15, wherein the first region of the toner discharge member is inclined at a predetermined angle with respect to the second region.

### [Structure Ea16]

The cartridge according to structure Ea15, wherein the second region of the toner discharge member is substantially perpendicular to the first region, in the feeding passageway.

### [Structure Ea17]

The cartridge according to any one of structures Ea10 to Ea16, wherein a normal direction of the discharge opening with respect to a two-dimensional projection plane perpendicular to the first axis is parallel to a central axis of the feeding passageway corresponding to the second area.

### [Structure Ea18]

The cartridge according to any one of structures Ea10 to Ea17, wherein the discharge opening has a cross-sectional area which is smaller than that of the hollow portion of the feeding passageway.

### [Structure Ea19]

The cartridge according to any one of structures Ea1 to Ea58, wherein the discharge opening has a wall portion provided in a direction intersecting a central axis of the feeding passageway corresponding also to the second region, and the wall portion provides a cross-sectional area smaller than that of the hollow portion of the feeding passageway.

### [Structure Ea20]

The cartridge according to any one of structures Ea2 to Ea19, wherein the toner discharge member is L-shaped.

### [Structure Ea21]

The cartridge according to any one of structures Ea2 to Ea8, wherein the toner discharge member includes a flexible pipe.

### [Structure Ea22]

The cartridge according to any one of structures Ea2 to Ea21, wherein the toner is discharged through the discharge opening in a direction substantially parallel to the first axis.

### [Structure Ea23]

The cartridge according to any one of structures Ea2 to Ea22 wherein the toner discharge member rotates about a second axis intersecting the first axis.

### [Structure Ea24]

The cartridge according to structure Ea23, wherein the second axis is perpendicular to the first axis.

### [Structure Ea25]

The cartridge according to structure Ea23 or Ea24, wherein the direction of the feeding passageway includes at least a component in a direction parallel to the first axis and a component in a direction parallel to the second axis.

### [Structure Ea26]

The cartridge according to any one of structures Ea23 to Ea25, wherein the direction of the feeding passageway includes at least a component in a first direction parallel to the first axis and facing in a direction away from the coupling.

### [Structure Ea27]

The cartridge according to structure Ea26, wherein the direction of the region of the feeding passageway which communicates with the discharge opening includes a component in the first direction.

### [Structure Ea28]

The cartridge according to any one of structures Ea25 to Ea27, wherein the first axis is substantially parallel to a rotation axis of the toner feeding member.

### [Structure Ea29]

The cartridge according to any one of structures Ea25 to Ea28, wherein the feeding passageway extends in a direction including a component in a direction away from the rotation axis of the toner feeding member in a region extending in a direction including a component in a direction parallel to the second axis.

### [Structure Ea30]

The cartridge according to any one of structures Ea2 to Ea29, wherein the frame is provided with a supply opening for supplying the toner to the toner discharge member, the toner discharge member is provided with a receiving opening for receiving the toner from a frame side, and a direction in which the receiving opening faces is changeable in accordance with movement of the toner discharge member.

### [Structure Ea31]

The cartridge according to structure Ea32, wherein the toner discharge member is movable between a first position in which the discharge opening faces in a first direction and a second position in which the discharge opening faces in a second direction different from the first direction.

### [Structure Ea32]

The cartridge according to structure Ea31, wherein the receiving opening faces the supply opening, when the toner discharge member is placed in the first position.

### [Structure Ea33]

The cartridge according to structure Ea31 or Ea32, wherein the receiving opening faces in a direction different from the direction facing the supply opening, when the toner discharge member is placed in the second position.

### [Structure Ea34]

The cartridge according to any one of structures Ea2 to Ea33, further comprising an electrical contact portion exposed to outside of the cartridge, wherein in a direction parallel to the first axis, the electrical contact portion is disposed between the coupling and the discharge opening of the toner discharge member.

### [Structure Ea35]

The cartridge according to structure Ea34, wherein the electrical contact portion is above the discharge opening in a vertical direction of the toner cartridge perpendicular to the first axis.

### [Structure Ea35]

The cartridge according to structure Ea33 or Ea34, wherein the electrical contact portion is disposed in a position closer to the coupling than the toner discharge member in a direction parallel to the first axis.

### [Structure Ea36]

The cartridge according to any one of structures Ea33 to Ea35, wherein the discharge opening is capable of being oriented away from the electrical contact portion in a direction parallel to the first axis.

### [Structure Ea37]

The cartridge according to any one of structures Ea2 to Ea34, wherein the toner discharge member is provided with a projection projecting in a direction away from the first axis, and the toner discharge member is movable by an external force applied to the projection.

### [Structure Ea38]

The cartridge according to structure Ea37, wherein the projection is movable by an external force in a direction including a component parallel to the first axis.

### [Structure Ea39]

The cartridge according to structure Ea38, wherein the projection rotates about an axis perpendicular to the first axis by receiving an external force.

### [Structure Ea40]

The cartridge according to any one of structures Ea2 to Ea39, further comprising a pump unit for feeding the toner, the pump unit being driven based on the driving force received by the coupling.

### [Structure Ea41]

The cartridge according to structure Ea40, wherein the discharge opening is provided with a filter through which the toner passes when the pump unit is driven.

### [Structure Ea42]

The cartridge according to any one of structures Ea2 to Ea41, wherein the frame is provided with a mounting portion to which a toner container unit is detachably mountable, and the toner feeding member feeds the toner supplied from the toner container unit.

### [Structure Ea43]

The cartridge according to any one of structures Ea2 to Ea43, further comprising a waste toner storage portion for storing waste toner, wherein the discharge opening of the toner discharge member is disposed between the coupling and the waste toner storage portion in a direction parallel to the first axis.

### [Structure Ea44]

The cartridge according to any one of structures Ea2 to Ea43, wherein the discharge opening is formed by removing a manually removable portion.

### [Structure Ea45]

The cartridge according to any one of structures Ea2 to Ea44, wherein the toner discharge member is movable between a retracted position in which a part thereof having the discharge opening is retracted inside the feeding passageway and an operating position in which the part projects out of the feeding passageway.

### <<Structures Eb>>

### [Structure Eb1]

A cartridge detachably mountable to a main assembly of an image forming apparatus, cartridge comprising:
a frame;
a coupling provided in the main assembly and engageable with a main assembly side coupling member rotatable about a first axis;
a toner feeding member which is operable based on a driving force received by the coupling; and
a toner discharge member provided with a discharge opening through which the toner fed by the toner feeding member is discharged to outside of the toner cartridge,
wherein the toner discharge member is movable relative to the frame so as to change orientation of the discharge opening, and the discharge opening is capable of facing in a first direction away from the coupling in a direction parallel to the first axis.

### [Subordinate Structure of Structure Eb1]

The structure of the Structure Eb1 may incorporate the structures properly selected from the structures dependent from the structure Ea1 or other structures disclosed in the foregoing embodiments.

### <<Structures Fa>>

### [Structure Fa1]

A cartridge comprising:
a frame;
a drive input member;
a toner feeding member operable based on the drive force received by the coupling; and
a toner discharge member provided with a discharge opening through which the toner transported by the toner feeding member is discharged to outside of the cartridge,
wherein the discharge opening is capable of facing in a direction away from to a side on which the drive input member is provided, in the longitudinal direction of the cartridge.

### [Structure Fa2].

The cartridge according to structure Fa1, wherein the toner discharge member includes a hollow feeding passageway through which the toner passes, between a frame side and the discharge opening.

### [Structure Fa3]

The cartridge according to structure Fa2, wherein the drive input member is rotatable about a first axis substantially parallel to a longitudinal direction of the cartridge.

### [Structure Fa4]

The cartridge according to structure Fa3, wherein a direction of the feeding passageway includes at least a component in a direction away from the first axis.

### [Structure Fa5]

The cartridge according to any one of structures Fa3 to Fa5, wherein the direction of the feeding passageway includes at least a component in a direction perpendicular to a longitudinal direction of the cartridge.

### [Structure Fa6]

The cartridge according to structure Fa4 or Fa5, wherein the direction of the feeding passageway includes at least a component in a direction parallel to the longitudinal direction of the cartridge.

### [Structure Fa7]

The cartridge according to structure Fa6, wherein a central axis of the feeding passageway extends along at least a direction away from the first axis.

### [Structure Fa8]

The cartridge according to structure Fa7, wherein the direction parallel to the central axis of the feeding passageway includes at least a component perpendicular to the first axis.

### [Structure Fa9]

The cartridge according to any one of structures Fa7 to Fa8, wherein the direction parallel to the central axis of the feeding passageway includes at least a component in a direction parallel to the first axis.

### [Structure Fa10]

The cartridge according to structure Fa9, wherein the feeding passageway includes, between the frame and the discharge opening, a first region and a second region, wherein a direction parallel with a central axis of the second region is different from that of the first region.

### [Structure Fa11]

The cartridge according to structure Fa10, wherein the second area is provided continuous with the discharge opening of the feeding passageway.

### [Structure Fa12]

The cartridge according to structure Fa11, wherein the first region is aligned along a direction in which the feeding passageway moves away from the rotational axis of the drive input member.

### [Structure Fa13]

The cartridge according to structure Fa12, wherein the first region extends along a direction perpendicular to the first axis axis.

### [Structure Fa14]

The cartridge according to any one of structures Fa11 to Fa13, wherein the second region is aligned in a direction away from the drive input member.

### [Structure Fa15]

The cartridge according to structure Fa14, wherein the second region includes at least a component in a direction parallel to the longitudinal direction of the cartridge.

### [Structure Fa16]

The cartridge according to any one of structures Fa10 to Fa15, wherein the first region of the toner discharge member is inclined at a predetermined angle with respect to the second region.

### [Structure Fa17]

The cartridge according to structure Fa16, wherein the second region of the toner discharge member is substantially perpendicular to the first region, in the feeding passageway.

### [Structure Fa18]

The cartridge according to structure Fa16 or Fa17, wherein a normal direction of the discharge opening with respect to a two-dimensional projection plane perpendicular to the first axis is parallel to a central axis of the feeding passageway corresponding to the second area.

### [Structure Fa19]

The cartridge according to any one of structures Fa10 to Fa18, wherein the discharge opening has a cross-sectional area which is smaller than that of the hollow portion of the feeding passageway.

### [Structure Fa20]

The cartridge according to structure Fa19, wherein the discharge opening has a wall portion provided in a direction intersecting a central axis of the feeding passageway corresponding also to the second region, and the wall portion provides a cross-sectional area smaller than that of the hollow portion of the feeding passageway.

### [Structure Fa21]

The cartridge according to any one of structures Fa2 to Fa20, wherein the toner discharge member is L-shaped.

### [Structure Fa22]

The cartridge according to any one of structures Fa2 to Fa9, wherein the toner discharge member includes a flexible pipe.

### [Structure Fa23]

The cartridge according to any one of structures Fa2 to Fa22, wherein the toner is discharged through the discharge opening in a direction substantially parallel to the first axis.

### [Structure Fa24]

The cartridge according to any one of structures Fa2 to Fa23 wherein the toner discharge member rotatable about a second axis intersecting the longitudinal direction of the cartridge.

### [Structure Fa25]

The cartridge according to structure Fa24 wherein the second axis is perpendicular to the longitudinal direction of the cartridge.

### [Structure Fa26]

The cartridge according to any one of structures Fa24 to Fa25, wherein the direction of the feeding passageway includes at least a component in a direction parallel to the longitudinal direction of the cartridge and a component in a direction parallel to the second axis.

### [Structure Fa27]

The cartridge according to any one of structures Fa24 to Fa26, wherein the direction of the feeding passageway includes at least a component in a first direction away from the drive input member in the longitudinal direction of the cartridge.

### [Structure Fa28]

The cartridge according to structure Fa27, wherein the direction of the region of the feeding passageway which communicates with the discharge opening includes a component in the first direction.

### [Structure Fa29]

The cartridge according to any one of structures Fa26 to Fa28, wherein the longitudinal direction of the cartridge is substantially parallel to a rotation axis of the toner feeding member.

### [Structure Fa30]

The cartridge according to any one of structures Fa26 to Fa29, wherein the feeding passageway extends in a direction including a component in a direction away from the rotation axis of the toner feeding member in a region extending in a direction including a component in a direction parallel to the second axis.

### [Structure Fa31]

The cartridge according to any one of structures Fa2 to Fa26, wherein the frame is provided with a supply opening for supplying the toner to the toner discharge member, the toner discharge member is provided with a receiving opening for receiving the toner from a frame side, and a direction in which the receiving opening faces is changeable in accordance with movement of the toner discharge member.

### [Structure Fa32]

The cartridge according to structure Fa31, wherein the toner discharge member is movable between a first position in which the discharge opening faces in a first direction and a second position in which the discharge opening faces in a second direction different from the first direction.

### [Structure Fa33]

The cartridge according to structure Fa32, wherein the receiving opening faces the supply opening, when the toner discharge member is placed in the first position.

### [Structure Fa34]

The cartridge according to structure Fa32 or Fa33, wherein the receiving opening faces in a direction different from the direction facing the supply opening, when the toner discharge member is placed in the second position.

### [Structure Fa35]

The cartridge according to any one of structures Fa2 to Fa34, further comprising an electrical contact portion exposed to outside of the cartridge, wherein in the longitudinal direction, the electrical contact portion is disposed between the drive input member and the discharge opening of the toner feeding member.

### [Structure Fa36]

The cartridge according to structure Fa35, wherein the electrical contact portion is above the discharge opening in a vertical direction of the toner cartridge perpendicular to the longitudinal direction.

### [Structure Fa37]

The cartridge according to structure Fa35 or Fa36, wherein the electrical contact portion is disposed in a position closer to the drive input member than the toner discharge member in the longitudinal direction of the cartridge.

### [Structure Fa38]

The cartridge according to any one of structures Fa35 to Fa37, wherein the discharge opening is capable of being oriented away from the electrical contact portion in the longitudinal of the cartridge.

### [Structure Fa39]

The cartridge according to any one of structures Fa2 to Fa38, wherein the toner discharge member is provided with a projection projecting in a direction away from the first axis which is a rotation axis of the drive input member, and the toner discharge member is movable by an external force applied to the projection.

### [Structure Fa40]

The cartridge according to structure Fa39, wherein the projection is movable by an external force in a direction including a component parallel to the first axis.

### [Structure Fa41]

The cartridge according to structure Fa42, wherein the projection is rotatable about an axis perpendicular to the first axis by an external force.

### [Structure Fa42]

The cartridge according to any one of structures Fa2 to Fa41, further comprising a pump unit for feeding the toner, the pump unit being driven based on the driving force received by the drive input member.

### [Structure Fa43]

The cartridge according to structure Fa42, wherein the discharge opening is provided with a filter through which the toner passes when the pump unit is driven.

### [Structure Fa44]

The cartridge according to any one of structures Fa2 to Fa43, wherein the frame is provided with a mounting portion to which a toner container unit is detachably mountable, and the toner feeding member feeds the toner supplied from the toner container unit, and the projection is rotatable about an axis perpendicular to the first axis by an external force.

### [Structure Fa45]

The cartridge according to any one of structures Fa2 to Fa44, further comprising a waste toner storage portion for storing waste toner, wherein the discharge opening of the toner discharge member is disposed between the drive input member and the waste toner storage portion in the longitudinal direction of the cartridge.

### [Structure Fa46]

The cartridge according to any one of structures Fa2 to Fa45, wherein the discharge opening is formed by removing a manually removable portion.

### [Structure Fa47]

The cartridge according to any one of structures Fa2 to Fa46, wherein the toner discharge member is movable between a retracted position in which a part thereof having the discharge opening is retracted inside the feeding passageway and an operating position in which the part projects out of the feeding passageway.

### [Structure Fa48]

The cartridge according to structure Fa1, wherein a free end portion of the drive input member in a direction parallel to the longitudinal direction of the cartridge has rubber elasticity and is deformable.

### [Structure Fa49]

The cartridge according to structure Fa1, further comprising a shutter member movable relative to the frame, wherein the frame is provided with a supply opening for supplying the toner to the toner discharge member, and the toner discharge member is provided with a receiving opening for receiving the toner from a frame side, wherein the shutter member is movable between a closed state in which the supply opening is closed and an open state in which the supply opening is open.

### [Structure Fa50]

The cartridge according to structure Fa49, wherein the shutter member includes a flat member parallel to the surface of the frame in which the supply opening is provided, and the shutter member is movable between the closed state and the open state by the flat member moving relative to the supply opening.

### [Structure Fa51]

The cartridge according to any one of structures Fa49 or Fa50, wherein the shutter member is provided with an actuating portion, and the shutter member is movable in interrelation with the actuating portion.

### [Structure Fa52]

The cartridge according to structure Fa53, wherein the cartridge is detachably mountable to the main assembly of an image forming apparatus, the actuating portion is in contact with an abutment surface provided in the main assembly of the apparatus when the cartridge is mounted to the main assembly of the apparatus, and the actuating portion is in abutment against the abutment surface in the open state of the shutter member.

### [Structure Fa53]

The cartridge according to structure Fa52, wherein, the shutter member has the actuating portion spaced apart from the abutment surface in the closed state.

### [Structure Fa54]

The cartridge according to structure Fa53, wherein the actuating portion is capable of abutting against the abutment surface provided on a movable door provided on the main assembly of the apparatus.

### [Structure Fa55]

The cartridge according to structure Fa54, wherein the cartridge is a toner cartridge detachably mountable to a developing cartridge, the actuating portion is capable of abutting against an abutment portion provided on the developing cartridge in a state that the toner cartridge is mounted to the developing cartridge, and in the open state, the actuating portion is in abutment with the abutment portion.

### [Structure Fa56]

The cartridge according to structure Fa57, wherein in the closed state, the actuating portion is spaced apart from the abutment portion.

### [Structure Fa57]

The cartridge according to any one of structures Fa56, wherein the actuating portion is capable of abutting against the abutment surface provided on a movable door provided on the apparatus main assembly.

### [Structure Fa58]

The cartridge according to structure Fa51, wherein the cartridge is a toner cartridge detachably mountable to a developing cartridge, and, the actuating portion is capable of abutting against an abutment portion provided on the developing cartridge when the toner cartridge is mounted to the developing cartridge, and wherein in a state that the shutter member is in the open state, the actuating portion abuts against the abutment portion.

### [Structure Fa59]

The cartridge according to structure Fa58, wherein in a state that the shutter member is in the closed state, the actuating portion is spaced apart from the abutment portion.

### [Structure Fa60]

The cartridge according to structure Fa59, wherein the actuating portion has a slope inclined along the longitudinal direction of the cartridge, and when the toner cartridge is mounted to the developing cartridge, the abutment portion abuts against the slope of the actuating portion, causing the shutter member to move in the longitudinal direction of the cartridge.

### [Structure Fa61]

The cartridge according to structure Fa60, wherein the shutter member is provided with a hole portion which communicates with the supply opening in the open state of the shutter member.

### [Structure Fa62]

The cartridge according to structure Fa49, further comprising a driving force transmission member which engages with the driving force input member to transmit a driving force to the toner feeding member, wherein the toner feeding member is rotatable about an axis parallel to the longitudinal direction of the cartridge in a state of being in engagement with the driving force transmission member, and the shutter member operates in interrelation with the rotation of the toner feeding member.

### [Structure Fa63]

The cartridge according to structure Fa62, wherein the shutter member is in the closed state when no driving force is transmitted to the toner feeding member by the driving force transmission member, and is in the open state when a driving force is transmitted to the toner feeding member by the driving force transmission member.

### [Structure Fa64]

The cartridge according to structure Fa49, wherein the shutter member is driven by a battery mounted on the cartridge.

### [Structure Fa65]

The cartridge according to structure Fa64, further comprising a depressible switch portion, wherein the shutter member is brought into the open state when the switch portion is pressed.

### [Structure Fa66]

The cartridge according to structure Fa1, further comprising a pump unit for feeding the toner; and an openable/closable discharge valve inside the toner discharge member, wherein the pump unit is driven based on the driving force received by the drive input member, and a gap formed in the discharge valve is larger when the pump unit is driven than when the pump unit is not driven.

### [Structure Fa67]

The cartridge according to structure Fa1, wherein the cartridge is a toner cartridge which is detachably mountable to the developing cartridge, the developing cartridge provided with a communication opening which is capable of communicating with the discharge opening when the toner cartridge is mounted, and a shutter member movable in a closing direction for closing the communication opening and movable in an opening direction for opening the communication opening,
wherein the shutter member moves in the opening direction by an attachment member when the toner cartridge is mounted to the developing cartridge by way of the attachment member, and the discharge opening communicates with the communication opening as a result of the shutter member moving in the opening direction.

### [Structure Fa68]

The cartridge according to structure Fa1, wherein the cartridge is a toner cartridge detachably mountable to a developing cartridge, the cartridge comprising a connecting portion projecting from the frame in the same direction as the toner discharge member projects, and the developing cartridge provided with a communication opening which is capable of communicating with the discharge opening when the toner cartridge is mounted, and a shutter member movable in a closing direction to close the communication opening and movable in an opening direction to open the communication opening, and wherein the connecting portion moves the shutter member in the opening direction when the toner cartridge is mounted to the developing cartridge, and the discharge opening communicates with the communication opening by movement of the shutter member in the opening direction.

### [Structure Fa69]

The cartridge according to structure Fa68 or Fa69, wherein the shutter member is movable in a direction substantially the same as the mounting direction of the toner cartridge relative to the developing cartridge.

### [Structure Fa70]

The cartridge according to structure Fa1 comprising a link member rotatable in response to a driving force received by the driving force input member; and a cylinder movable in the longitudinal direction of the cartridge in response to the rotation of the link member; wherein the toner discharge member uses the cylinder to discharge air and the toner from the discharge opening.

### [Structure Fa71]

The cartridge according to structure Fa70, wherein the cylinder is arranged at one end of the frame in the longitudinal direction of the cartridge, and the cylinder is movable toward the inside of the frame in the longitudinal direction of the cartridge, thereby communicating with the inside of the frame and discharging compressed air into the frame.

### [Structure Fa72]

The cartridge according to structure Fa1, further comprising a pump unit for feeding the toner; a battery; and a motor which is capable of being driven based on power provided by the battery, wherein the driving force input member is provided with a gear portion engageable with a motor side gear provided on a driving shaft of the motor, and the pump unit is driven by receiving the driving force inputted by rotation of the motor side gear by way of the gear portion.

### [Structure Fa73]

The cartridge according to structure Fa72, wherein the cartridge is detachably mountable to the main assembly of the image forming apparatus, the cartridge including a cartridge side coupling engageable with a main assembly side coupling provided in the main assembly of the apparatus, and a detection member operable in interrelation with rotation of the cartridge side coupling, wherein the motor is driven in response to detection of rotation of the main assembly side coupling by the detection member.

### [Structure Fa74]

The cartridge according to structure Fa1, wherein the cartridge is detachably mountable to the main assembly of the image forming apparatus, the cartridge comprising a driving force receiving portion engageable with the driving force input member, wherein the driving force receiving portion is engageable with a main assembly side coupling provided on the main assembly of the apparatus and rotates about a first rotation axis inclined with respect to the longitudinal direction of the cartridge, and the driving force input member rotates about a second rotation axis parallel to the longitudinal direction of the cartridge in response to rotation of the driving force receiving portion.

### [Structure Fa75]

The cartridge according to structure Fa237, wherein the driving force receiving portion includes a coupling portion engageable with the main assembly side coupling, at one end in a direction parallel to the first rotation axis, and a gear portion engageable with the driving force input member at the other end.

### [Structure Fa76]

The cartridge according to structure Fa1, wherein the driving force input member includes a coupling movable in the longitudinal direction of the cartridge.

### [Structure Fa77]

The cartridge according to structure Fa76, further comprising a link member, and a conversion gear connected to the drive input member by way of the link member, wherein the conversion gear rotatable continuously in one direction by way of the link member as the coupling moves back and forth in the longitudinal direction of the cartridge.

### [Subordinate Structure of Structure Fa1]

The structure of the structure Fa1 may incorporate the structures properly selected from the structures dependent from the structure Aa1, Ab1, Ba1, Bb1, Ca1, or Da1 or other structures disclosed in the foregoing embodiments.

### <<Structures Ga>>

### [Structure Ga1]

A cartridge which is detachably mountable to a main assembly of an image forming apparatus, the apparatus including a main assembly-side coupling member in a direction perpendicular to the drive axis of the main assembly side coupling member, the cartridge comprising:
a frame;
a first driving force receiving member rotatably supported by the frame, the driving force receiving member including a first driving force receiving portion being rotatable about a first rotation axis, and engageable with the main assembly-side coupling member to receive a driving force for feeding toner; and
a toner discharge member supported by the frame, the toner discharge member including has a feeding portion capable of feeding the toner in a first direction which intersects the first rotation axis and has a component in a direction away from the first rotation axis, and a discharge portion capable of discharging the fed toner,
wherein the discharge portion is capable of discharging the toner in a second direction which includes a component in a direction parallel to the first rotation axis.

### [Structure Ga2].

The cartridge according to structure Ga1, wherein an opening of the discharge portion opens in the second direction.

### [Structure Ga3]

The cartridge according to structure Ga1 or Ga2, wherein the feeding portion includes a first region parallel to the first direction and a second region parallel to the second direction.

### [Structure Ga4]

The cartridge according to structure Ga3, wherein the feeding portion is L-shaped.

### [Structure Ga5]

The cartridge according to any one of structures Ga1 to Ga4, wherein the toner discharge member rotatable about a second rotation axis substantially parallel to the first direction in interrelation with the action of the cartridge into the main assembly of the apparatus.

### [Structure Ga6]

The cartridge according to structure Ga5, wherein the first direction is substantially the same as the direction in which the cartridge is inserted into the main assembly of the apparatus.

### [Structure Ga7]

The cartridge according to structure Ga5 or Ga6, wherein when the cartridge is inserted into the main assembly of the apparatus installed with the bottom surface facing in the direction of gravity, the discharge portion faces in a direction different from the direction of gravity by rotation of the toner discharge member.

### [Structure Ga8]

The cartridge according to structure Ga7, wherein before the cartridge is inserted into the main assembly of the apparatus installed with the bottom surface facing in the direction of gravity, the discharge portion faces in a direction opposite from the direction of gravity, and when the cartridge is inserted into the main assembly of the apparatus, the discharge portion faces in a direction perpendicular to the direction of gravity by rotation of the toner discharge member.

### [Structure Ga9]

The cartridge according to any one of structures Ga5 to Ga8, wherein the cartridge is a toner cartridge, and the cartridge mountable to the main assembly of the apparatus with a developing cartridge including a developing unit is mounted in the main assembly of the apparatus, wherein the toner discharge member is provided with an abutment member capable of abutting against a guide surface provided adjacent to a supply opening for supplying the toner into the developing cartridge, wherein when the cartridge is inserted into the main assembly of the apparatus, the toner discharge member is rotated about the second rotation axis by change of an abutment state between the abutment member and the guide surface.

### [Structure Ga10]

The cartridge according to structure Ga9, wherein the abutment member is disposed downstream of the discharge portion in an inserting direction when the cartridge is inserted into the main assembly of the apparatus.

### [Structure Ga11]

The cartridge according to structure Ga9 or Ga10, wherein the toner discharge member is disposed adjacent to the supply opening of the main assembly of the developing cartridge and is provided with an actuating member for opening and closing a shutter member for the supply opening, and wherein when the cartridge is inserted into the main assembly of the apparatus, the actuating member engages with a receiving portion provided on the developing cartridge, thereby bringing the supply opening into an open state.

### [Structure Ga12]

The cartridge according to structure Ga11, wherein as the toner discharge member is viewed in the axial direction of the second rotation shaft, the abutment member and the actuating member are arranged in positions which are in point-symmetric with respect to the second rotation shaft.

### [Structure Ga13]

The cartridge according to any one of structures Ga1 to Ga8, wherein the cartridge is a toner cartridge, and the cartridge mountable to the main assembly of the apparatus with a developing cartridge including a developing unit is mounted in the main assembly of the apparatus, wherein the toner discharge member is provided adjacent to a supply opening of a body of the developing cartridge and is provided with an actuating member to open and close a shutter member for the supply opening, and wherein when the cartridge is inserted into the main assembly of the apparatus, the actuating member engages with a receiving portion provided on the developing cartridge, thereby bringing the supply opening into an open state.

### [Structure Ga14]

The cartridge according to structure Ga13, wherein the first driving force receiving member engages with the main assembly side coupling at a first end side of the first rotating shaft, and the discharge portion faces an opening corresponding to the supply opening at a second end side opposite the first end of the first rotating shaft.

### [Structure Ga15]

The cartridge according to any one of structures Ga9 to Ga14, further comprising a waste toner storage portion for receiving waste toner from the developing cartridge, the waste toner storage portion being supported at a position opposite the first driving force receiving member of the frame in a direction parallel to the axis of the first rotation shaft.

### [Structure Ga16]

The cartridge according to structure Ga15, further comprising a second driving force receiving member including a second driving force receiving portion engageable with a coupling member different from the main assembly side coupling member provided on the main assembly of the apparatus to receive a driving force for stirring the toner inside the cartridge, wherein the second driving force receiving portion is supported on the same side of the frame as the first driving force receiving portion in a direction parallel to the axis of the first rotation shaft.

### [Structure Ga17]

The cartridge according to structure Ga18, wherein the waste toner storage portion has a waste toner feeding member for feeding waste toner from the developing cartridge to the cartridge, and the waste toner feeding member is driven by the driving force received by the second driving force receiving portion.

### [Structure Ga18]

The cartridge according to any one of structures Ga9 to Ga17, further comprising a shutter opening/closing member, provided on a second surface of the frame intersecting the first surface, for opening and closing a shutter covering a laser scanner provided in the main assembly of the apparatus, wherein the shutter opening/closing member operable to open the shutter from a closed state, not by way of the developing cartridge, in interrelation with the action of inserting the cartridge into the main assembly of the apparatus.

### [Structure Ga19]

The cartridge according to any one of structures Ga1 to Ga18, further comprising a first contact capable of electrically connecting to a main assembly side contact provided on the main assembly of the apparatus, the first contact facing in a direction different from the second direction.

### [Structure Ga20]

The cartridge according to structure Ga19, wherein the first contact point is disposed between the first driving force receiving portion and the discharge portion in a direction parallel to the first rotation axis.

### <<Structures Gb>>

### [Structure Gb1]

The cartridge which is detachably mountable to a main assembly of an image forming apparatus, the apparatus including a main assembly side coupling member in a direction perpendicular to the drive axis of the main assembly side coupling member, the cartridge comprising:
a frame;
a first driving force receiving member rotatably supported by the frame, the driving force receiving member including a first driving force receiving portion being rotatable about a first rotation axis, and engageable with the main assembly-side coupling member to receive a driving force for feeding toner; and
a toner discharge member supported by the frame, the toner discharge member including a feeding portion capable of feeding the toner in a first direction, and a discharge portion capable of discharging the fed toner,
wherein the discharge portion is capable of discharging the toner in a second direction which includes a component away from the driving force receiving member, the second direction is different from a direction in which the cartridge is inserted into the main assembly of the apparatus.

### [Subordinate Structure of Structure Gb1]

The structure of the structure Gb1 may incorporate the structures properly selected from the structures dependent from the structure Ga1 or other structures disclosed in the foregoing embodiments.

### <<Structures Ha>>

### [Structure Ha1]

An image forming apparatus to which the cartridge according to any one of structures Ga1 to Ga20 and Gb1 is detachably mountable.

[Subordinate structure of structure Ha1]

The structure of the structure Ha1 may incorporate the structures properly selected from the structures dependent from the structure Ga1, Gb1 or other structures disclosed in the foregoing embodiments.

### <<Structures Ia>>

### [Structure Ia1]

A developing cartridge comprising a developing unit which carries toner supplied from the cartridge according to any one of structures Ga1 to Ga20 and structure Gb1, wherein the developing cartridge has a supply opening for receiving the toner supply from the discharge portion.

### [Subordinate Structure of Structure Ia1]

The structure of the structure Ia1 may incorporate the structures properly selected from the structures dependent from the structure Ga1 or other structures disclosed in the foregoing embodiments.

### <<Structures Ja>>

### [Structure Ja1]

A cartridge comprising:
a frame;
a driving force input member rotatable about a first rotation axis to input a driving force for feeding toner from inside of the frame; and
a toner discharging member for discharging toner from inside of the frame to outside in response to the driving force received by the driving force input member,
wherein the toner discharge member includes a feeding portion having at least a portion which projects in a direction intersecting with the first rotation axis,
wherein the feeding portion is capable of feeding the toner in a first direction intersecting the first rotation axis and including a component in a direction away from the first rotation axis, and feeding in a second direction including a component in a direction parallel to the first rotation axis, and
wherein the toner after being fed along the second direction is discharged to the outside.

### [Structure Ja2]

The cartridge according to structure Ja1, wherein the feeding portion includes a first feeding portion extending along the first direction and a second feeding portion extending along the second direction.

### [Structure Ja3]

The cartridge according to structure Ja2, wherein the first direction is a direction perpendicular to the first rotational axis, and the second direction is a direction parallel to the first rotational axis.

### [Structure Ja4]

The cartridge according to structure Ja1, wherein the feeding portion includes a flexible pipe bendable in the first direction and the second direction.

### [Structure Ja5]

The cartridge according to structure Ja1, wherein the feeding portion is capable of feeding the toner in a third direction inclined at a predetermined angle relative to the first rotation axis, the third direction being different from the first direction and from the second direction.

### [Structure Ja6]

The cartridge according to structure Ja1, wherein the feeding portion is divisible into a first feeding portion and a second feeding portion, the first feeding portion is capable of feeding the toner supplied from inside the frame in the first direction, and the second feeding portion is connectable to the first feeding portion on a side opposite from the frame and is capable of feeding the toner in the first direction and the second direction.

### [Structure Ja7]

The cartridge according to any one of structures Ja1 to Ja6, wherein the feeding member is provided with a discharge opening for discharging the toner to outside of the cartridge.

### [Structure Ja8]

The toner cartridge according to structure Ja7, wherein the discharge opening discharges the toner in the second direction.

### [Structure Ja9]

The toner cartridge according to the structure Ja7 or Ja8, wherein the discharge opening has a cross-sectional area smaller than that of the feeding portion.

### [Structure Ja10]

The cartridge according to structure Ja9, wherein the discharge opening has a wall portion provided in a direction intersecting the second feed direction, the wall portion provides a cross-sectional area smaller than that of the feeding portion.

### [Structure Ja11]

The cartridge according to structure Ja7, wherein the discharge opening is provided with a filter.

### [Structure Ja12]

The cartridge according to structure Ja11, further comprising a pump unit for feeding the toner, the filter through which the toner passes when the pump unit is driven.

### [Structure Ja13]

The cartridge according to structure Ja7, wherein the discharge opening is formed by removing a removable portion provided on the feeding portion which is removable by a user.

### [Structure Ja14]

The cartridge according to any one of structures Ja1 to Ja6, further comprising a projection provided with the discharge opening, the projection being supported by the feeding portion so as to be movable in the second direction of the feeding portion between a retracted position retracted inside the feeding portion and an operating position projecting from the feeding portion.

### [Structure Ja15]

The cartridge according to structure Ja14, wherein the projection is hollow and capable of feeding the toner along the second direction, and the discharge opening discharges the toner in a direction different from the second direction.

### [Structure Ja16]

The cartridge according to structure Ja1, wherein the toner discharging member is supported on the frame rotatably about a second axis perpendicular to the first axis.

### [Structure Ja17]

The cartridge according to structure Ja1, further comprising an accommodating portion for accommodating the toner, wherein the toner discharge member receives a supply of the toner from the accommodating portion and feeds the toner to outside.

### [Structure Ja18]

The cartridge according to structure Ja1, wherein the frame is provided with a mounting portion to which a toner container unit is detachably mountable, and the toner discharge member receives a supply of the toner from the toner container unit and feeds the toner to outside.

### [Structure Ja19]

The cartridge according to structure Ja1, wherein the cartridge is detachably mountable to the main assembly of an image forming apparatus including a main assembly side coupling member, and the driving force input member receives the driving force by way of an attachment connected to the main assembly side coupling member.

### [Structure Ja20]

The cartridge according to structure Ja19, wherein the driving force input member includes a coupling member, and the attachment is provided with an attachment side coupling member engageable with the coupling member.

### [Structure Ja21]

The cartridge according to structure Ja20, wherein the coupling member is disposed more inside the cartridge in a direction parallel to the first axis than a position where the toner feeding member is provided.

### [Structure Ja22]

The cartridge according to structure Ja19, wherein the driving force input member includes a gear portion, and the attachment includes an attachment gear portion which meshes with the gear portion.

### [Structure Ja23]

The cartridge according to structure Ja22, wherein the attachment includes an attachment side coupling portion engageable with the main assembly side coupling member, and the attachment side coupling member has an elastically deformable portion contactable to the main assembly side coupling member, the elastically deformable portion having rubber elasticity.

### [Structure Ja24]

The cartridge according to structure Ja23, wherein the attachment side coupling portion has an inner diameter larger than an outer diameter centered on the rotational axis of the main assembly side coupling portion.

### [Structure Ja25]

The cartridge according to structure Ja22, wherein the attachment is provided with a third gear portion capable of meshing engagement with the second gear portion, the second gear portion is rotatable about a second axis which is substantially perpendicular to the first axis, the third gear portion is rotatable about a third axis which is substantially perpendicular to the second axis, and an attachment side coupling portion engageable with the main assembly side coupling portion is provided on an inner circumference of the third gear portion based on the third axis.

### [Structure Ja26]

The cartridge according to structure Ja1, wherein a free end portion of the driving force input member in a direction parallel to the first axis has rubber elasticity and is deformable.

### [Structure Ja27]

The cartridge according to structure Ja26, wherein the cartridge is detachably mountable to a main assembly of an image forming apparatus including a main assembly side coupling member, and the driving force input member is capable of receiving the driving force by contact of a side surface of the free end portion with a side surface of the main assembly side coupling member.

### [Structure Ja28]

The cartridge according to structure Ja1, wherein the cartridge is detachably mountable to the developing cartridge which is detachably mountable to the main assembly of the image forming apparatus including a main assembly side coupling member, wherein the developing cartridge is provided with a cartridge side coupling member which is connectable to the main assembly side coupling member when mounted to the image forming apparatus, and the driving force input member is capable of receiving the driving force by way of the cartridge side coupling member.

### <<Structures Jb>>

### [Structure Jb1]

A cartridge comprising:
a frame;
a driving force input member rotatable about a first rotation axis to input a driving force for feeding toner;
a toner discharging member for discharging the toner from inside of the frame to outside in response to the driving force received by the driving force input member; and
a waste toner storage for accommodating used toner,
wherein the toner discharge member includes at least a projected portion projecting in a direction parallel to the second rotation axis perpendicular to the first rotation axis,
wherein the feeding portion is capable of feeding the toner in a first direction intersecting the first rotation axis and including a component in a direction away from the first rotation axis, and feeding in a second direction including a component in a direction parallel to the first rotation axis, and
wherein the toner after being fed along the second direction is discharged to the outside.

### [Subordinate Structure of Structure Jb1].

The structure of the structure Jb1 may incorporate the structures properly selected from the structures dependent from the structure Ja1 or other structures disclosed in the foregoing embodiments.

### <<Structures Ka>>

### [Structure Ka1]

An image forming apparatus to which the cartridge according to any one of structures Ja1 to Ja28 is detachably mountable.

[Subordinate structure of structure Ka1]

The structure of the structure Ka1 may incorporate the structures properly selected from the structures dependent from the structure Ja1 or other structures disclosed in the foregoing embodiments.

### <<Structures La>>

### [Structure La1]

A developing cartridge comprising a developing unit for carrying toner supplied from a cartridge according to any one of structures Ja1 to Ja28, the developing cartridge provided with a supply opening for receiving the toner supply.

### [Subordinate Structure of Structure La1]

The structure of the structure La1 may incorporate the structures properly selected from the structures dependent from the structure Ja1 or other structures disclosed in the foregoing embodiments.

### <<Structures Ma, Mb>>

### [Structure Ma1]

A toner discharge member connectable to a supply opening provided on a cartridge accommodating toner, the toner discharge member comprising a feeding portion and a discharge opening, wherein the feeding portion is capable of receiving a driving force from a driving force input member provided on the cartridge to feed the toner, when the toner discharge member is mounted to the cartridge, the driving force input member is rotatable about a first rotation axis, the feeding portion being capable of feeding the toner in direction of a component intersecting the first rotation axis and away from the first rotation axis and in a direction parallel to the first rotation axis, and the discharge opening is capable of discharging the toner fed along the feeding portion to outside.

### [Structure Ma2]

The toner discharge member according to structure Ma1, wherein the discharge opening is provided at an end of the feeding portion, and the feeding portion is flexible.

### [Structure Ma3]

The toner discharging member according to structure Ma1, wherein the feeding portion is a flexible pipe bendable in the first direction and in the second direction.

### INDUSTRIAL APPLICABILITY

According to the present invention, there are provided a toner cartridge capable of properly discharging the toner to the outside and an image forming apparatus including the toner cartridge.

The present invention is not limited to the above-described embodiments, and various modifications and variations are possible without departing from the spirit and scope of the present invention.

Therefore, to publicize the scope of the invention, the following claims are attached.

This application claims priority based on Japanese Patent Application No. 2022-101481 filed on Jun. 24, 2022 and Japanese Patent Application No. 2022-171767 filed on Oct. 26, 2022, the entire contents of which are incorporated herein by reference.

1.-123. (canceled)

124. A cartridge comprising:
a frame;
a coupling rotatable about a first axis;
a toner feeding member that is operable based on a driving force received by the coupling; and
a toner discharge member provided with a discharge opening through which the toner fed by the toner feeding member is discharged to outside of the toner cartridge,
wherein the toner discharge member is movable relative to the frame so as to change orientation of the discharge opening, and the discharge opening is capable of facing in a first direction away from the coupling in a direction parallel to the first axis.

125. The toner cartridge according to claim 123, wherein the toner discharge member includes a hollow feeding passageway through which the toner passes, between a frame side and the discharge opening.

126. The cartridge according to claim 125, wherein a direction of the feeding passageway includes at least a component in a direction away from the first axis.

127. The cartridge according to claim 126, wherein the direction of the feeding passageway includes at least a component in a direction perpendicular to the first axis.

128. The cartridge according to claim 126, wherein the direction of the feeding passageway includes at least a component in a direction parallel to the first axis.

129. The cartridge according to claim 125, wherein the feeding passageway extends along at least in a direction away from the first axis.

130. The cartridge according to claim 129, wherein the direction parallel to the central axis of the feeding passageway includes at least a component in a direction perpendicular to the first axis.

131. The cartridge according to claim 129, wherein the direction parallel to the central axis of the feeding passageway includes at least a component in a direction parallel to the first axis.

132. The cartridge according to claim 125, wherein the feeding passageway includes, between the frame and the discharge port, a first region and a second region that has a central axis different from that of the first region.

133. The cartridge according to claim 132, wherein the second area is provided continuous with the discharge opening of the feeding passageway.

134. The cartridge according to claim 133, wherein in the first region, the feeding passageway extends along a direction away from the first axis.

135. The cartridge according to claim 134, wherein the first region extends along a direction perpendicular to the first axis.

136. The cartridge according to claim 133, wherein the second region extends along a direction away from the coupling.

137. The cartridge according to claim 136, wherein the second region extends in a direction including at least a component parallel to the first axis.

138. The cartridge according to claim 132, wherein the first region of the toner discharge member is inclined at a predetermined angle with respect to the second region.

139. The cartridge according to claim 136, wherein the second region of the toner discharge member is substantially perpendicular to the first region, in the feeding passageway.

140. The cartridge according to claim 132, wherein a normal direction of the discharge opening with respect to a two-dimensional projection plane perpendicular to the first axis is parallel to a central axis of the feeding passageway corresponding to the second area.

141. The cartridge according to claim 132, wherein the discharge opening has a cross-sectional area which that is smaller than that of the hollow portion of the feeding passageway.

142. The cartridge according to claim 141, wherein the discharge opening has a wall portion provided in a direction intersecting a central axis of the feeding passageway corresponding also to the second region, and the wall portion provides a cross-sectional area smaller than that of the hollow portion of the feeding passageway.

143. The cartridge according to claim 125, wherein the toner discharge member is L-shaped.

144. The cartridge according to claim 125, wherein the toner discharge member includes a flexible pipe.

145. The cartridge according to claim 125, wherein the toner is discharged through the discharge opening in a direction substantially parallel to the first axis.

146. The cartridge according to claim 125, wherein the toner discharge member rotates about a second axis intersecting the first axis.

147. The cartridge according to claim 146, wherein the second axis is perpendicular to the first axis.

148. The cartridge according to claim 146, wherein the direction of the feeding passageway includes at least a component in a direction parallel to the first axis and a component in a direction parallel to the second axis.

149. The cartridge according to claim 146, wherein the direction of the feeding passageway includes at least a component in a first direction parallel to the first axis and facing in a direction away from the coupling.

150. The cartridge according to claim 149, wherein the direction of the region of the feeding passageway that communicates with the discharge opening includes a component in the first direction.

151. The cartridge according to claim 148, wherein the first axis is substantially parallel to a rotation axis of the toner feeding member.

152. The cartridge according to claim 148, wherein the feeding passageway extends in a direction including a component in a direction away from the rotation axis of the toner feeding member in a region extending in a direction including a component in a direction parallel to the second axis.

153. The cartridge according to claim 125, wherein the frame is provided with a supply opening for supplying the toner to the toner discharge member, the toner discharge member is provided with a receiving opening for receiving the toner from a frame side, and a direction in which the receiving opening faces is changeable in accordance with movement of the toner discharge member.

154. The cartridge according to claim 153, wherein the toner discharge member is movable between a first position in which the discharge opening faces in a first direction and a second position in which the discharge opening faces in a second direction different from the first direction.

155. The cartridge according to claim 153, wherein the receiving opening faces the supply opening, when the toner discharge member is placed in the first position.

156. The cartridge according to claim 153, wherein the receiving opening faces in a direction different from the direction facing the supply opening, when the toner discharge member is placed in the second position.

157. The cartridge according to claim 125, further comprising an electrical contact portion exposed to outside of the cartridge, wherein in a direction parallel to the first axis, the electrical contact portion is disposed between the coupling and the discharge opening of the toner discharge member.

158. The cartridge according to claim 157, wherein the electrical contact portion is above the discharge opening in a vertical direction of the toner cartridge perpendicular to the first axis.

159. The cartridge according to claim 157, wherein the electrical contact portion is disposed in a position closer to the coupling than the toner discharge member in a direction parallel to the first axis.

160. The cartridge according to claim 157, wherein the discharge opening is capable of being oriented away from the electrical contact portion in a direction parallel to the first axis.

161. The cartridge according to claim 125, wherein the toner discharge member is provided with a projection projecting in a direction away from the first axis, and the toner discharge member is movable by an external force applied to the projection.

162. The cartridge according to claim 161, wherein the projection is movable by an external force in a direction including a component parallel to the first axis.

163. The cartridge according to claim 162, wherein the projection rotates about an axis perpendicular to the first axis when receiving an external force.

164. The toner cartridge according to claim 125, further comprising a pump unit for feeding the toner, the pump unit being driven based on the driving force received by the coupling.

165. The cartridge according to claim 164, wherein the discharge opening is provided with a filter through which the toner passes when the pump unit is driven.

166. The cartridge according to claim 125, wherein the frame is provided with a mounting portion to which a toner container unit is detachably mountable, and the toner feeding member feeds the toner supplied from the toner container unit.

167. The cartridge according to claim 125, further comprising a waste toner storage portion for storing waste toner,
wherein the discharge opening of the toner discharge member is disposed between the coupling and the waste toner storage portion in a direction parallel to the first axis.

168. The cartridge according to claim 125, wherein the discharge opening is formed by removing a manually removable portion.

169. The cartridge according to claim 125, wherein the toner discharge member is movable between a retracted position in which a part thereof having the discharge opening is retracted inside the feeding passageway and an operating position in which the part projects out of the feeding passageway.

170-302. (canceled)
